(19) United States
(12) Patent Application Publication
(10) Pub. No.: US 2025/0008057 A1
(43) Pub. Date: Jan. 2, 2025

(54) SYSTEMS AND METHODS FOR MANAGING DISPLAY OF PARTICIPANTS IN REAL-TIME COMMUNICATION SESSIONS

(71) Applicant: Apple Inc., Cupertino, CA (US)

(72) Inventors: Shih-Sang CHIU, San Francisco, CA (US); Jason D. RICKWALD, Santa Cruz, CA (US); Rupert BURTON, San Francisco, CA (US); Giancarlo YERKES, San Francisco, CA (US); Stephen O. LEMAY, Palo Alto, CA (US); Jonathan PERRON, Felton, CA (US); Wei WANG, Santa Clara, CA (US)

(21) Appl. No.: 18/732,533

(22) Filed: Jun. 3, 2024

Related U.S. Application Data
(60) Provisional application No. 63/506,106, filed on Jun. 4, 2023.
(60) Provisional application No. 63/506,117, filed on Jun. 4, 2023.
(60) Provisional application No. 63/515,113, filed on Jul. 23, 2023.

(51) Int. Cl. H04N 7/15; G06T 19/00; H04S 7/00

(52) U.S. Cl. CPC H04N 7/157; G06T 19/006; H04S 7/302

(57) ABSTRACT

In some embodiments, a computer system changes visual appearance of visual representations of participants moving within a simulated threshold distance of a user of the computer system. In some embodiments, a computer system arranges representations of users according to templates. In some embodiments, a computer system arranges representations of users based on shared content. In some embodiments, a computer system changes a spatial arrangement of participants in accordance with a quantity of participants that are a first type of participant. In some embodiments, a computer system changes a spatial arrangement of elements of a real-time communication session to join a group of participants. In some embodiments, a computer system facilitates interaction with groups of spatial representations of participants of a communication session. In some embodiments, a computer system facilitates updates of a spatial arrangement of participants based on a spatial distribution of the participants.

### CROSS-REFERENCE TO RELATED APPLICATIONS

This application claims the benefit of U.S. Provisional Application No. 63/506,106, filed Jun. 4, 2023, U.S. Provisional Application No. 63/506,117, filed Jun. 4, 2023, and U.S. Provisional Application No. 63/515,113, filed Jul. 23, 2023, the contents of which are herein incorporated by reference in their entireties for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”) or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system changes a visual appearance of participants engaged in a real-time communication session when moving within a simulated threshold distance of a user of the computer system. In some embodiments, the computer system arranges representations and/or viewpoints of participants in a real-time communication session according to templates and based on the quantity of participants. In some embodiments, the computer system arranges representations and/or viewpoints of participants in a real-time communication session based on content shared in a real-time communication session. In some embodiments, the computer system updates a spatial arrangement of elements of a real-time communication session in accordance with a quantity of participants of the real-time communication session of a respective type. In some embodiments, the computer system updates a spatial arrangement of elements of a real-time communication session to correspond to a group of participants of the real-time communication session. In some embodiments, the computer system updates a spatial arrangement of participants in a real-time communication session in a three-dimensional environment based on a spatial distribution of the participants. In some embodiments, the computer system updates a spatial arrangement of participants in a real-time communication session in a three-dimensional environment based on shared content in the real-time communication session.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7J illustrate examples of a computer system facilitating interaction with spatial representations of participants of a communication session, in accordance with some embodiments of the disclosure.

FIG. 8 is a flowchart illustrating a method of facilitating interaction with spatial representations of participants of a communication session, in accordance with some embodiments of the disclosure.

FIGS. 9A-9Q illustrate examples of a computer system arranging representations of participants based on templates, in accordance with some embodiments of the disclosure.

FIG. 10 is a flowchart illustrating a method of arranging representations of participants based on templates.

FIGS. 11A-11Y illustrate examples of a computer system arranging representations of participants based on shared content, in accordance with some embodiments of the disclosure.

FIG. 12 is a flowchart illustrating a method of arranging representations of participants based on shared content, in accordance with some embodiments of the disclosure.

FIGS. 13A-1-FIG. 13L illustrate examples of a computer system updating spatial arrangements of elements of a real-time communication session based on a quantity of participants of a respective type, in accordance with some embodiments of the disclosure.

FIG. 14 is a flowchart illustrating a method of updating spatial arrangements of elements of a real-time communication session based on a quantity of participants of a respective type, in accordance with some embodiments of the disclosure.

FIGS. 15A-15L illustrate examples of a computer system facilitating interaction with groups of spatial representations of participants of a communication session, in accordance with some embodiments of the disclosure.

FIG. 16 is a flowchart illustrating a method of facilitating interaction with groups of spatial representations of participants of a communication session, in accordance with some embodiments of the disclosure.

FIGS. 17A-17P illustrate examples of a computer system facilitating updates of a spatial arrangement of participants in a real-time communication session in a three-dimensional environment based on a spatial distribution of the participants in accordance with some embodiments.

FIG. 18 is a flowchart illustrating a method of facilitating updates of a spatial arrangement of participants in a real-time communication session in a three-dimensional environment based on a spatial distribution of the participants in accordance with some embodiments.

FIGS. 19A-19L illustrate examples of a computer system facilitating updates of a spatial arrangement of participants in a real-time communication session in a three-dimensional environment based on shared content in accordance with some embodiments.

FIG. 20 is a flowchart illustrating a method of facilitating updates of a spatial arrangement of participants in a real-time communication session in a three-dimensional environment based on shared content in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system displays visual representations of participants engaged in a real-time communication session with the computer system. In some embodiments, while the visual representations are beyond a simulated threshold distance from a viewpoint of a user of the computer system, the visual representations of participants are displayed with a first visual appearance. In some embodiments, the computer system obtain information that the visual representations of participants will move relative to a three-dimensional environment of the computer system. In some embodiments, in accordance with a determination that a portion of a visual representation of a participant is within the simulated threshold distance, the computer system displays the portion with an updated visual appearance. In some embodiments, the computer system changes a visual appearance of multiple portions of the visual representation of participants. In some embodiments, changing the visual appearance includes modifying visual characteristics of the portion within the simulated threshold distance. In some embodiments, the changing includes replacing a first representation with a second representation.

In some embodiments, a computer system arranges representations and/or viewpoints of participants in a real-time communication session according to templates, such as in response to detecting a new arrival to the real-time communication session. In some embodiments, the computer system selects a template for spatially arranging participants based on various criteria that optionally include the quantity of participants in the session and/or whether the participants are sharing content with each other.

In some embodiments, a computer system arranges representations and/or viewpoints of participants in a real-time communication session based on characteristics of content shared by the participants in the real-time communication session. In some embodiments, the computer system selects a template for spatially arranging participants based on the type of shared content, such as selecting a content-viewing template when the participants are viewing shared visual media content and selecting a ring template when the participants are viewing a shared horizontally displayed map.

In some embodiments, a computer system displays visual representations of participants engaged in a real-time communication session with the computer system. In some embodiments, the computer system updates a spatial arrangement of elements in the real-time communication session relative to a viewpoint of the user. In some embodiments, the updating is based on a quantity of participants that are of a first type. In some embodiments, the updating is not based on a quantity of participants that are of a second type. In some embodiments, a spatial arrangement of visual representations of participants are maintained relative to each other, and changed relative to the viewpoint of the user of the computer system. In some embodiments, the quantity of participants corresponds to two, three, four, or more participants.

In some embodiments, a computer system displays visual representations of participants engaged in a real-time communication session with the computer system. In some embodiments, the computer system updates a spatial arrangement of elements in the real-time communication session relative to a viewpoint of the user. In some embodiments, the visual representation of participants are arranged in one or more groups. In some embodiments, the updating is performed by the computer system in response to obtaining information and/or detecting an event, such as one or more participants joining or leaving the real-time communication session, and such as an express input requesting the updating. In some embodiments, the updating the viewpoint of the user includes joining a largest group, a closest group, a group that the user is directing attention to, and/or some combination of such factors. In some embodiments, the groups are defined in accordance with thresholds associated with respective participants. In some embodiments, the thresholds are determined in accordance with one or more country settings associated with the respective participants.

In some embodiments, a computer system updates a spatial arrangement of participants in a real-time communication session in a three-dimensional environment based on a spatial distribution of the participants. In some embodiments, while a user of the computer system is in a real-time communication session with a first participant and a second participant, the computer system displays a first arrangement of elements in the real-time communication session, including displaying a first visual representation of the first participant at a first location and a second visual representation of the second participant at a second location, different from the first location, in the three-dimensional environment. In some embodiments, while displaying the first spatial arrangement of the elements of the real-time communication session in the three-dimensional environment, the computer system detects an event corresponding to a request to reset a spatial distribution of one or more participants in the real-time communication session. In some embodiments, in response to detecting the event, the computer system displays an updated spatial arrangement of elements of the real-time communication session based on a spatial distribution of the first visual representation and the second visual representation from the current viewpoint of the user in the three-dimensional environment.

In some embodiments, the computer system updates a spatial arrangement of participants in a real-time communication session in a three-dimensional environment based on shared content in the real-time communication session. In some embodiments, while a user of the computer system is in a real-time communication session with a first participant, the computer system displays a first arrangement of elements in the real-time communication session, including displaying a first visual representation of the first participant at a first location in the three-dimensional environment. In some embodiments, while displaying the first spatial arrangement of the elements of the real-time communication session in the three-dimensional environment, the computer system detects an event corresponding to a request to reset a spatial distribution of one or more participants in the real-time communication session. In some embodiments, in response to detecting the event, in accordance with a determination that the user of the computer system and the first participant are participating in a shared activity in the real-time communication session associated with a respective object, the computer system displays a first updated spatial arrangement of elements of the real-time communication session. In some embodiments, in accordance with a determination that the user of the computer system and the first participant are not participating in a shared activity in the real-time communication session, the computer system displays a second updated spatial arrangement, different from the first updated spatial arrangement.

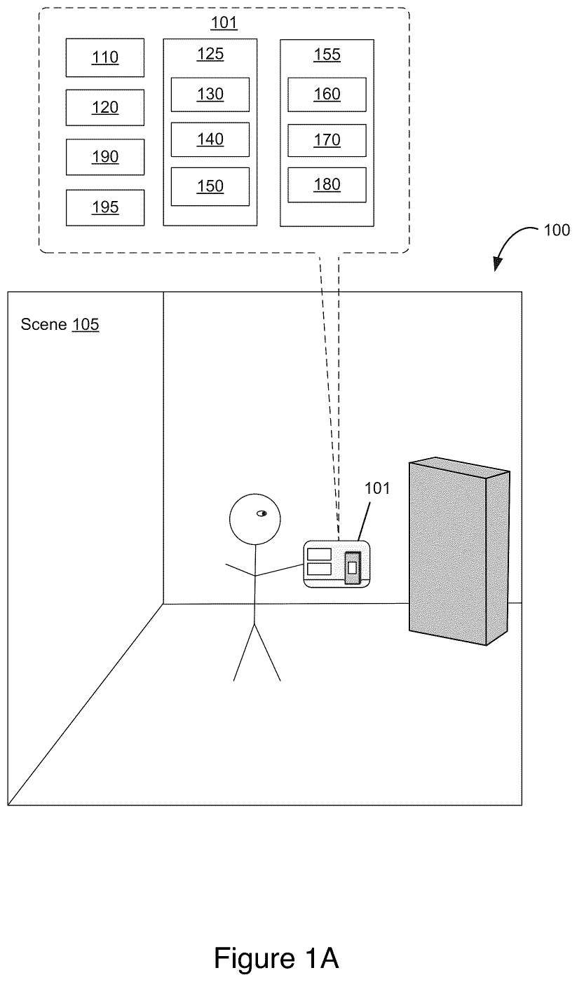

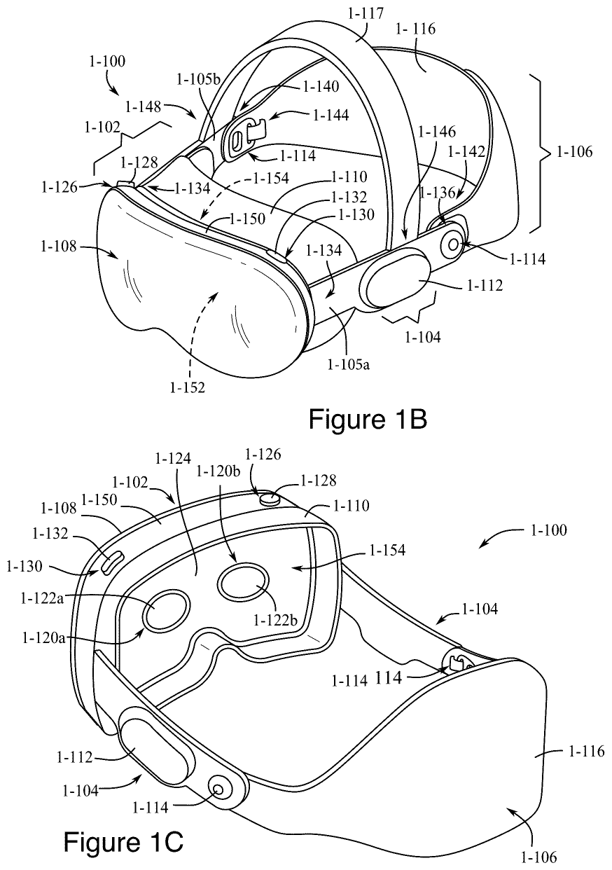

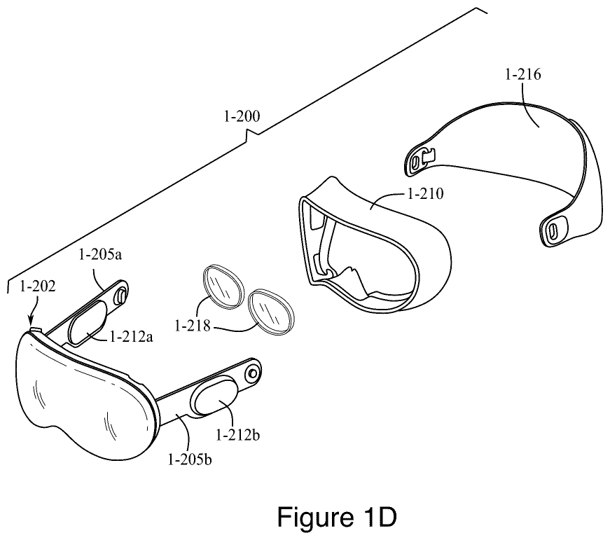

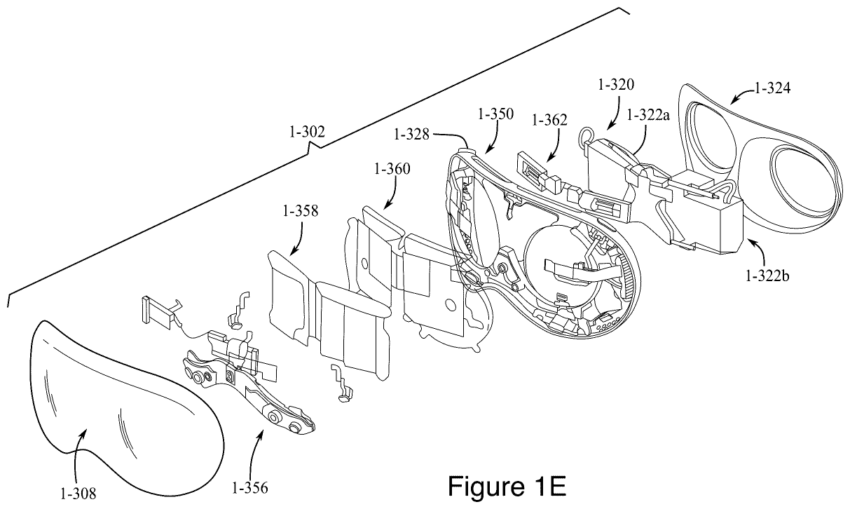

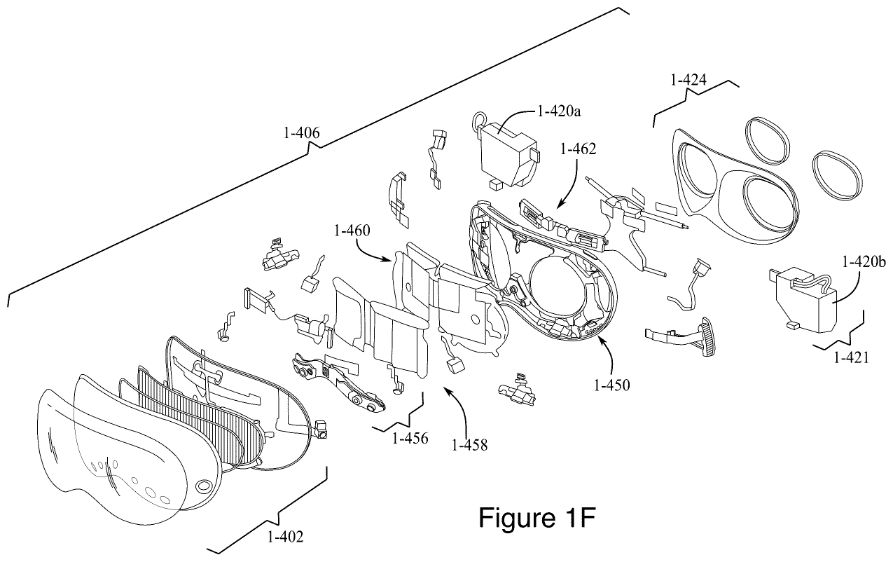

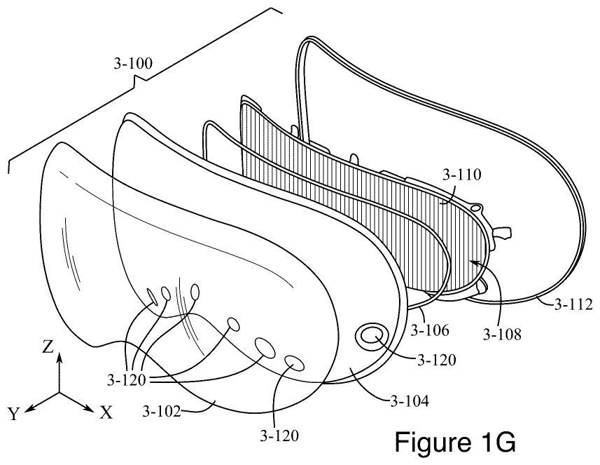

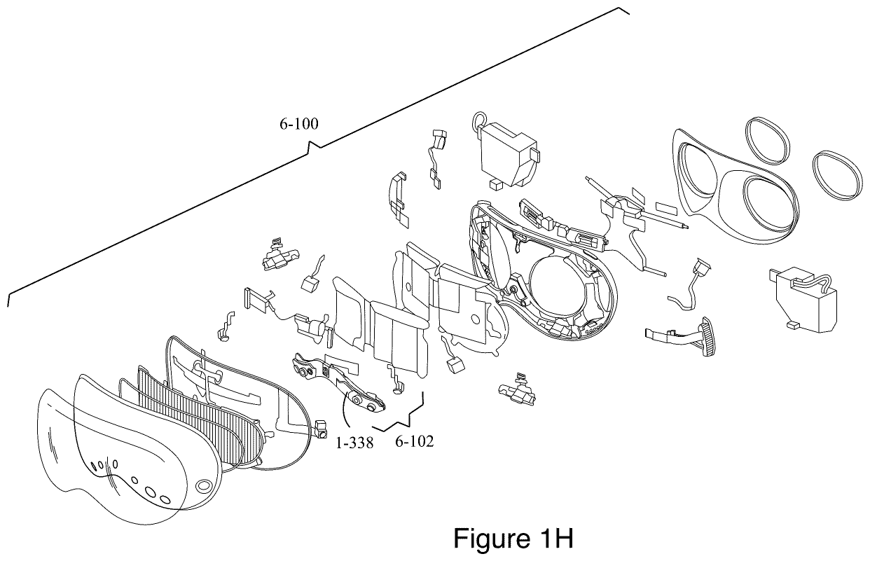

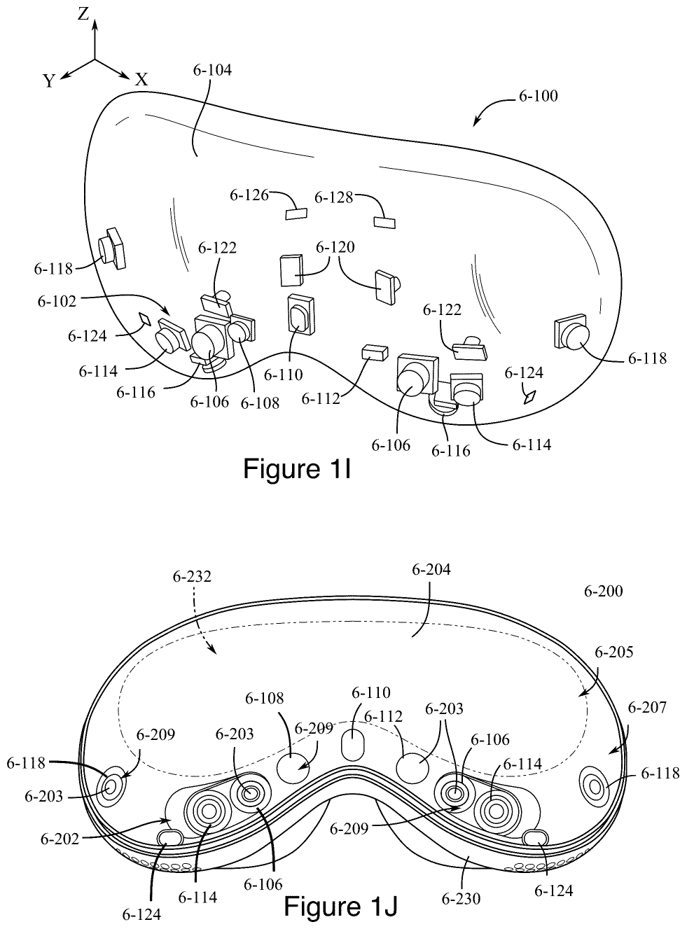

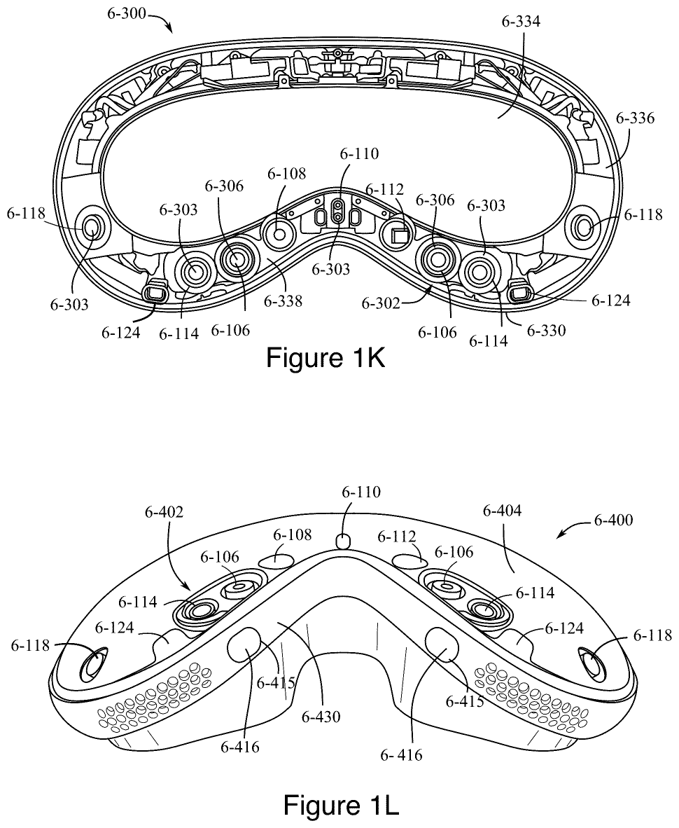

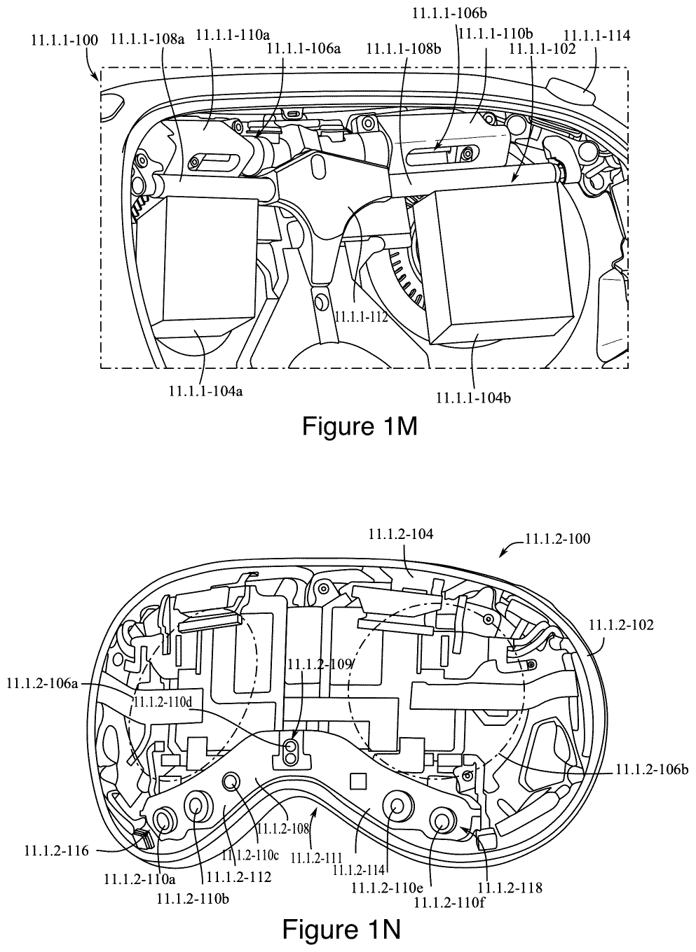

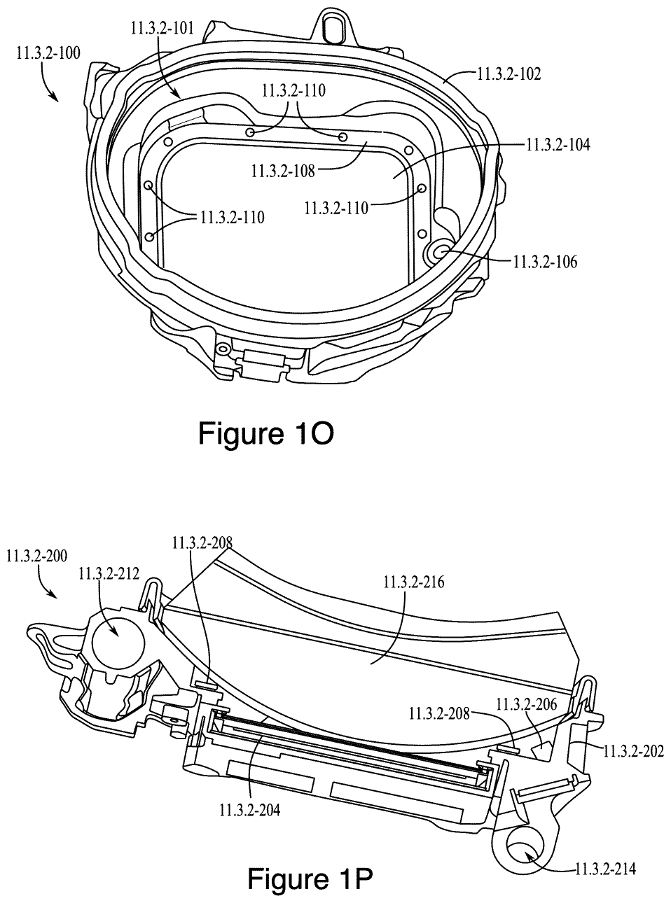

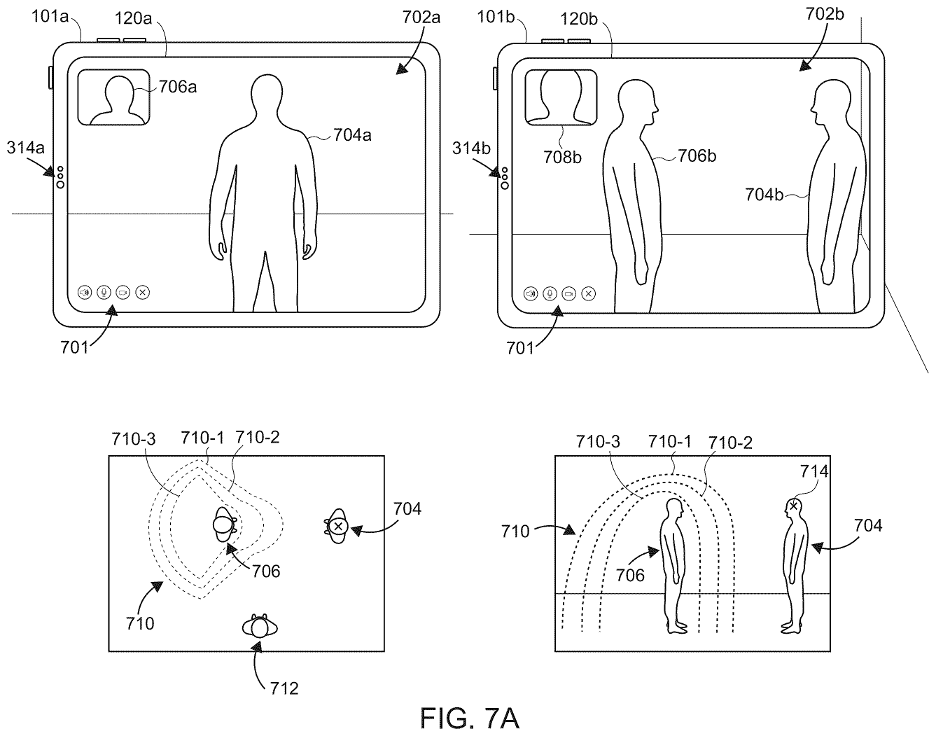

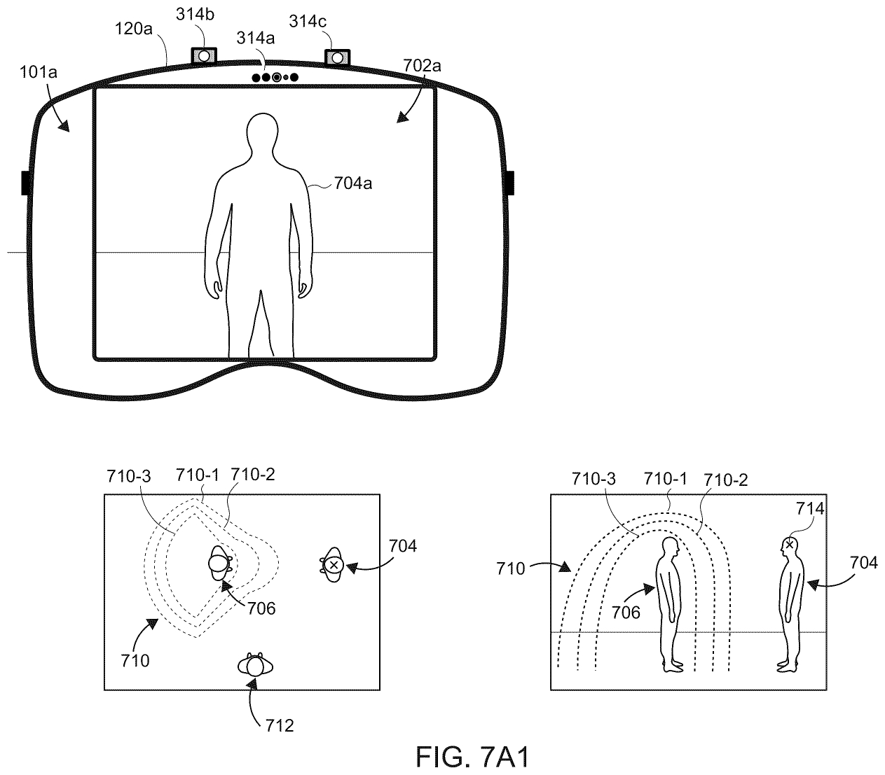

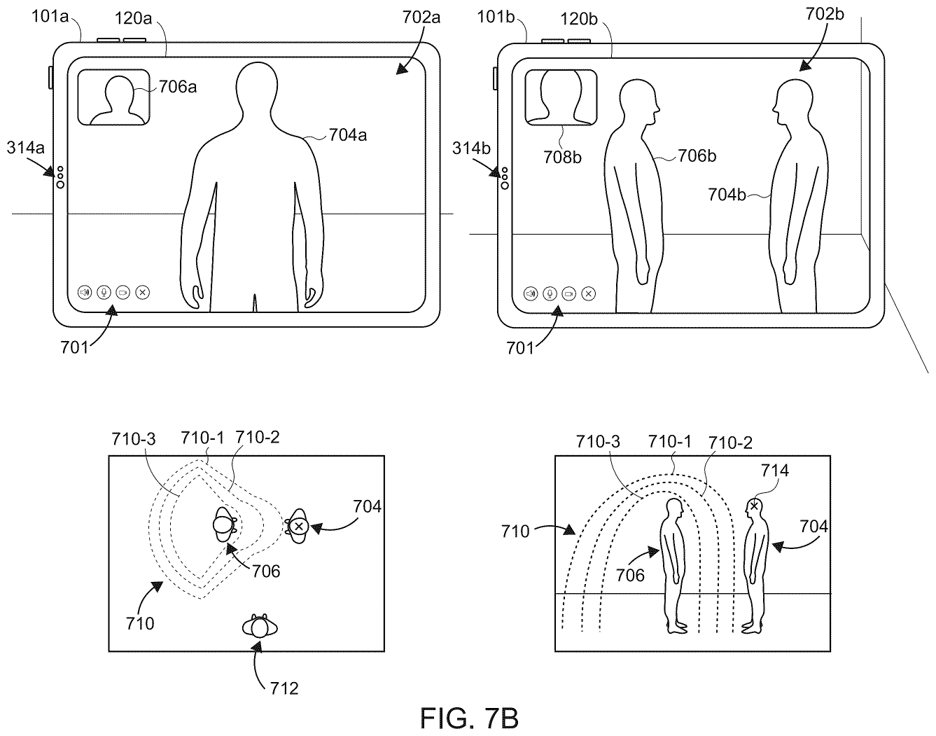

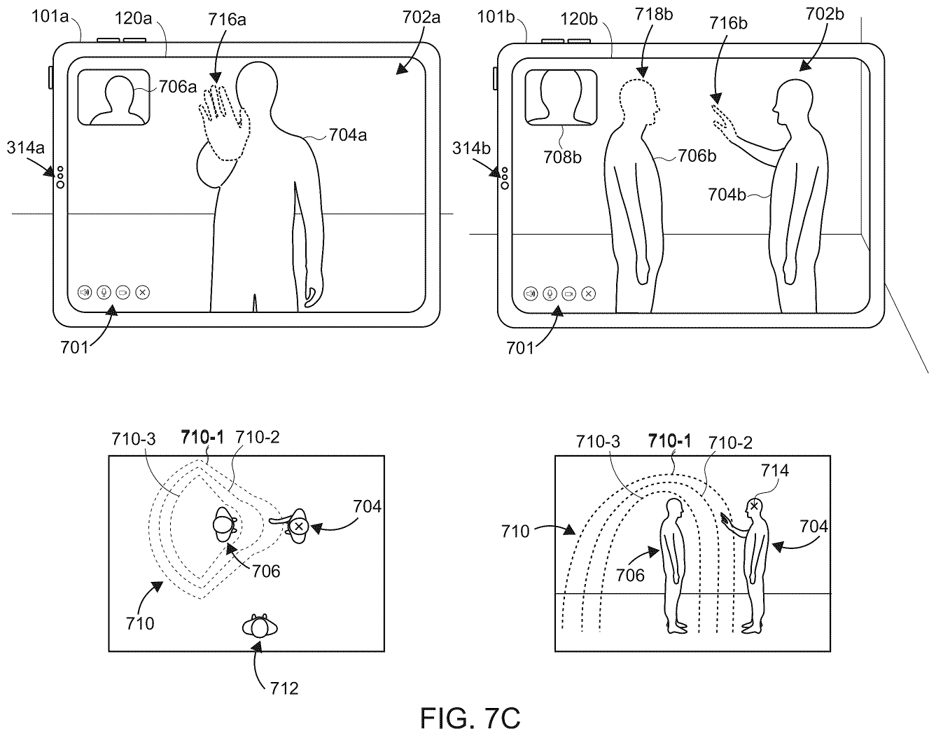

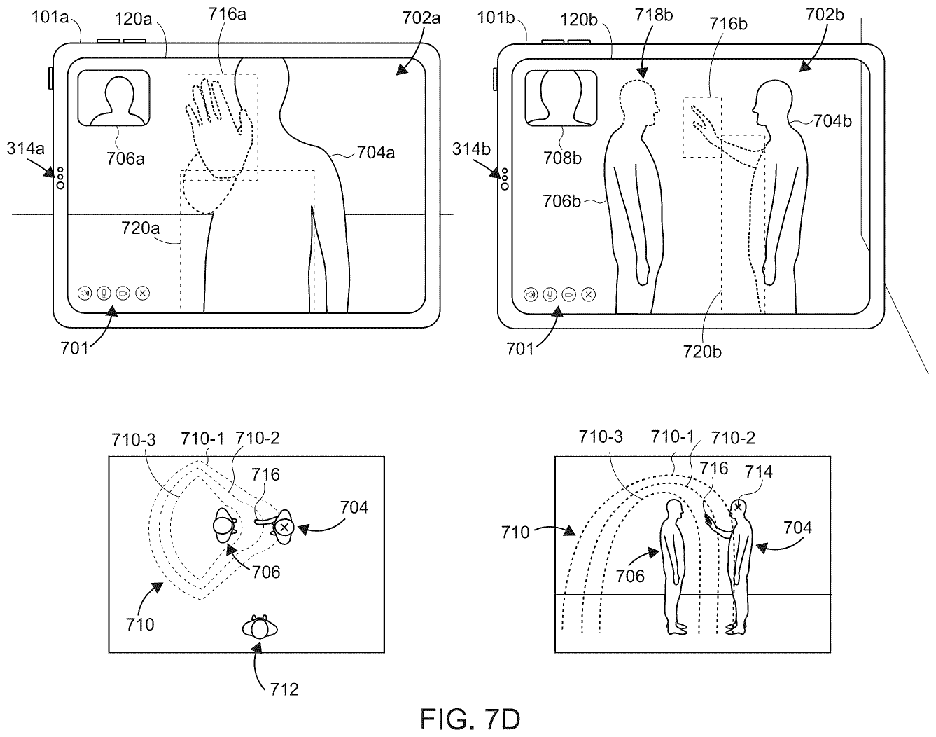

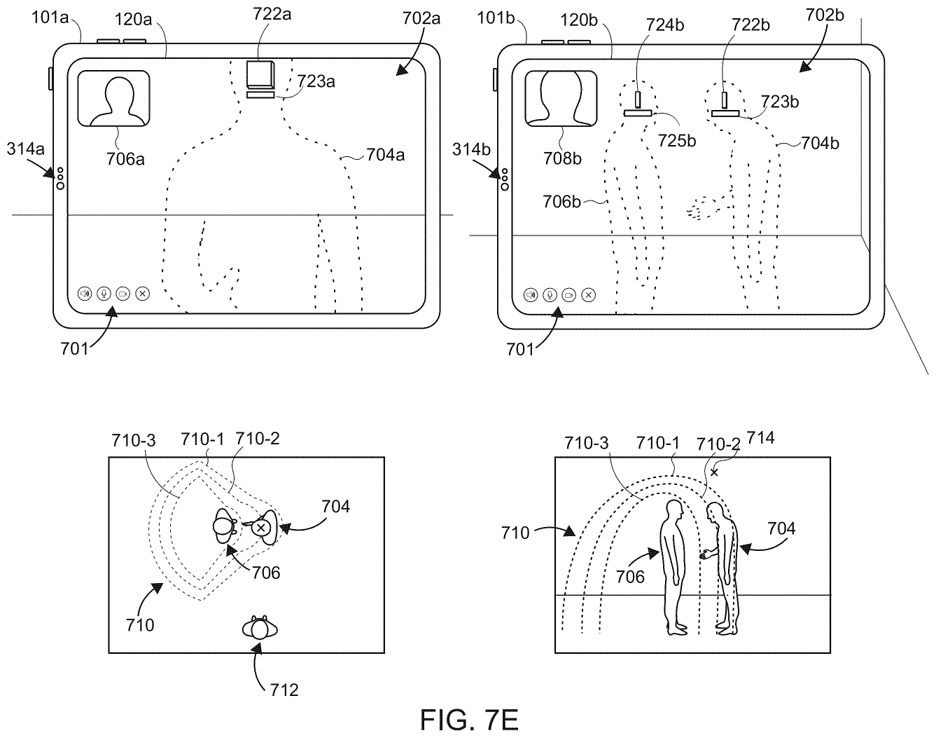

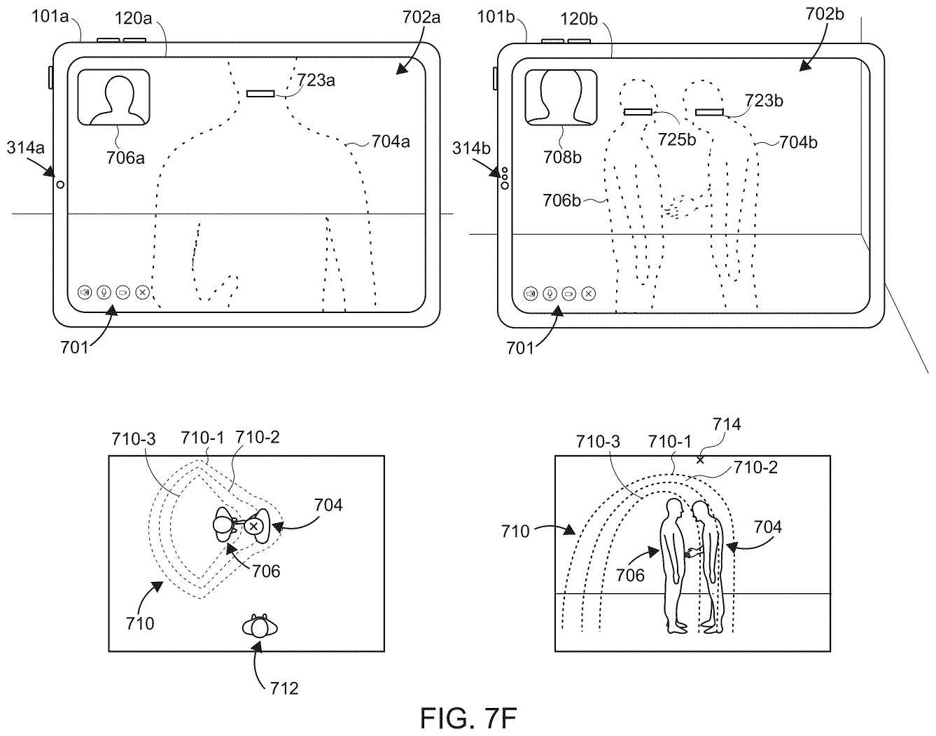

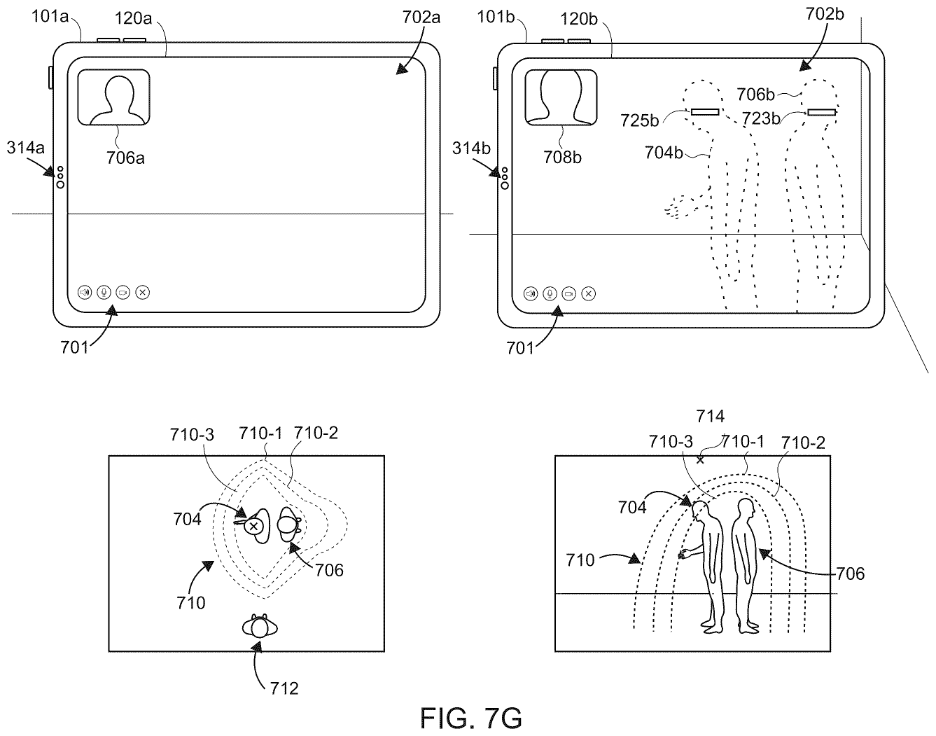

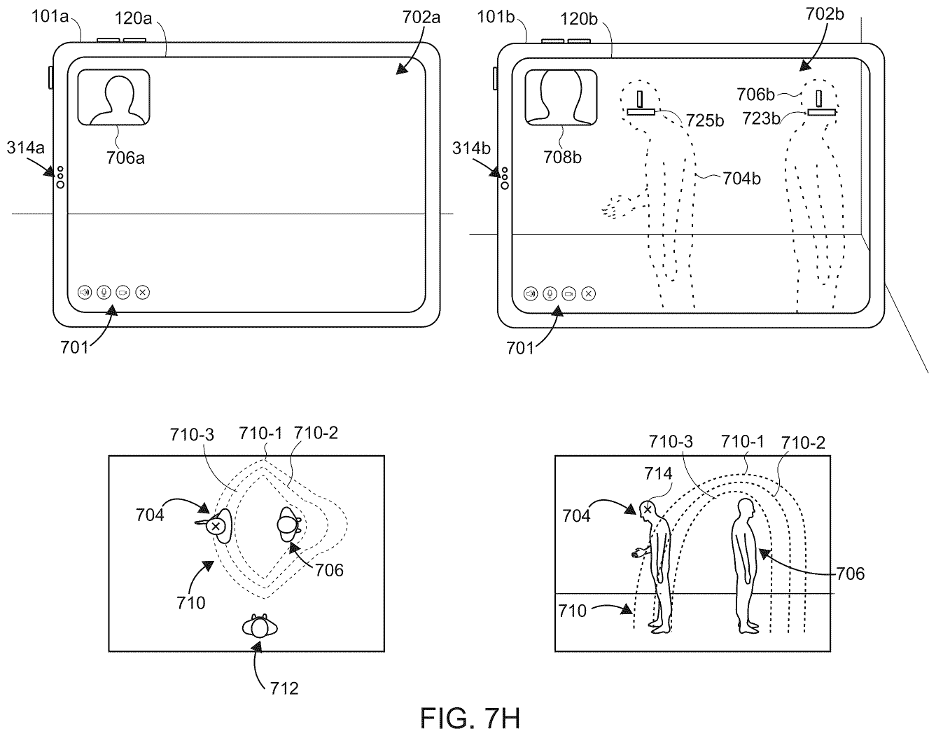

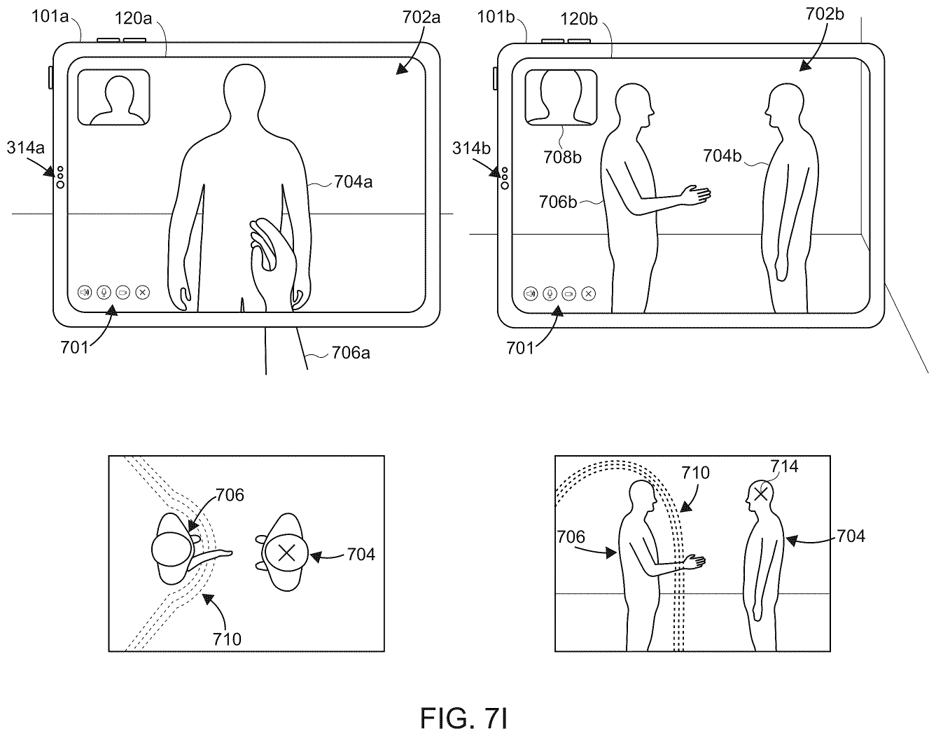

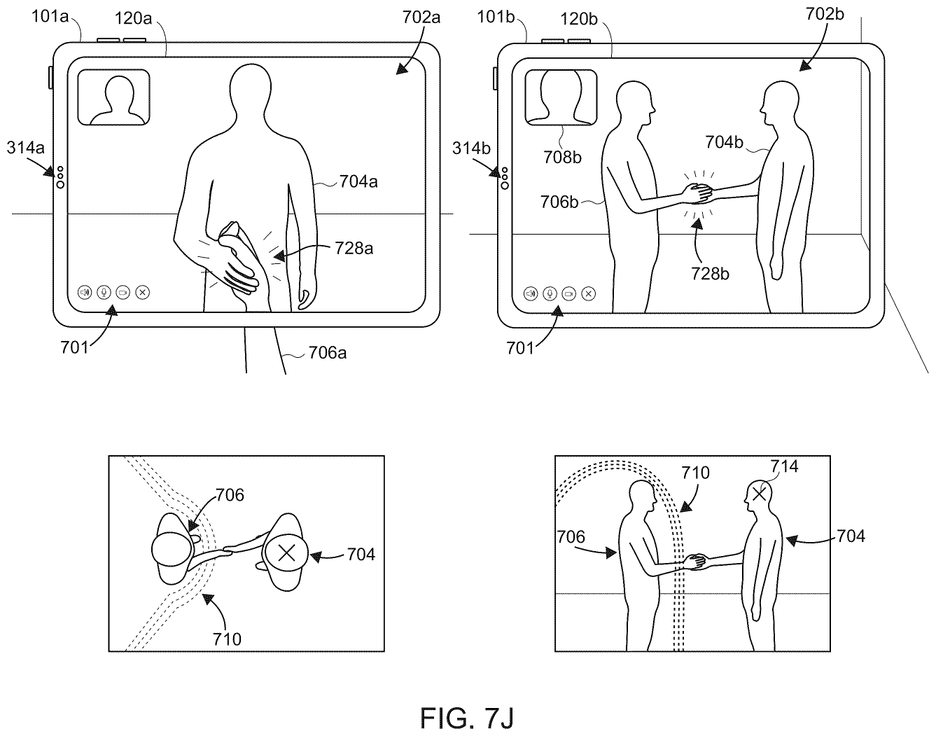

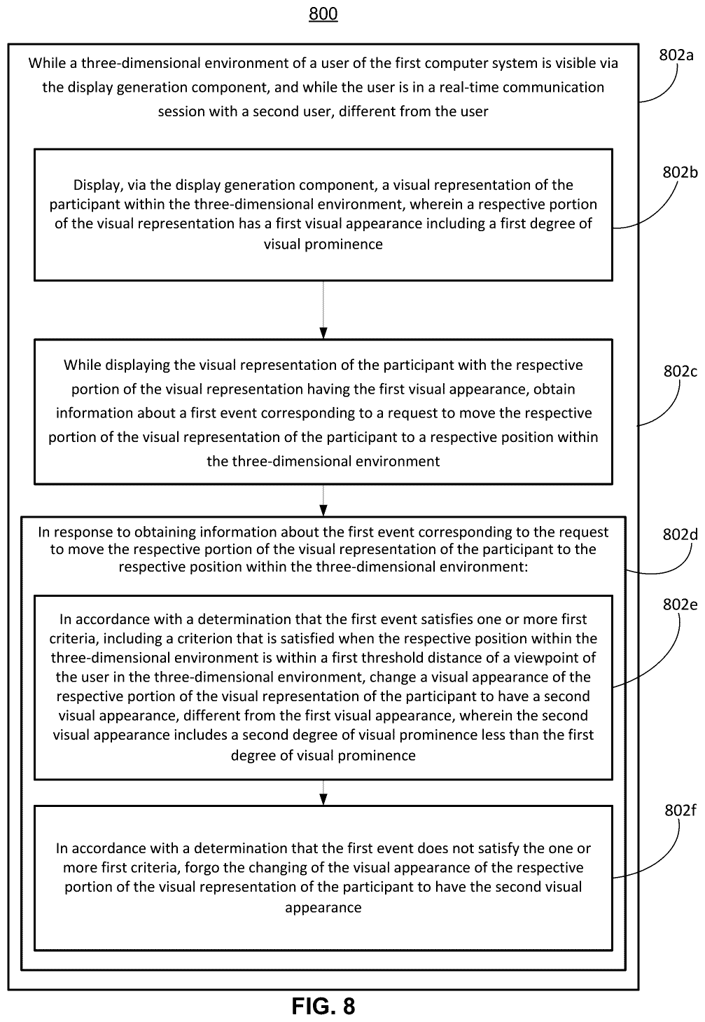

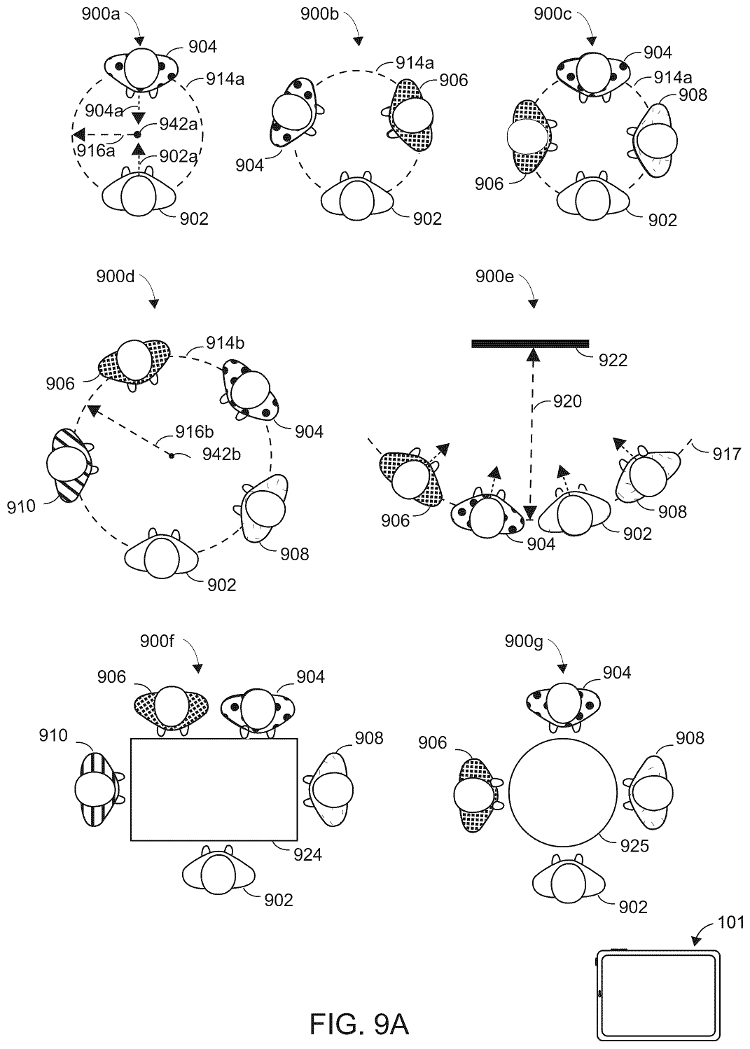

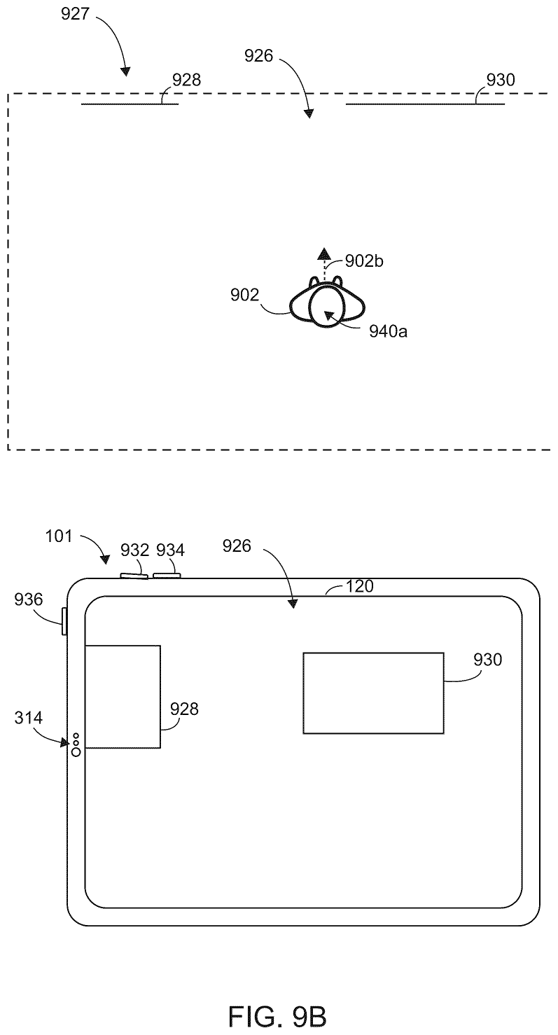

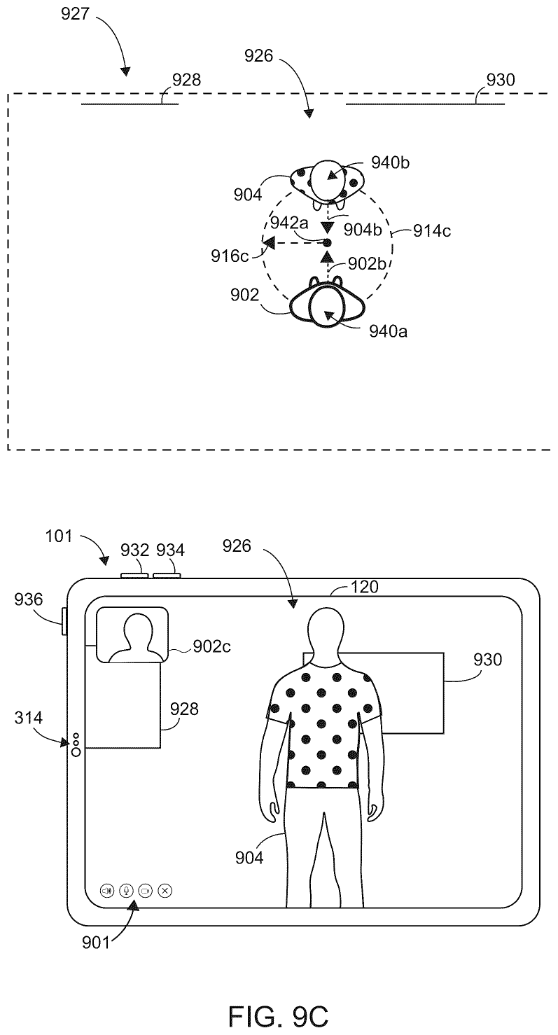

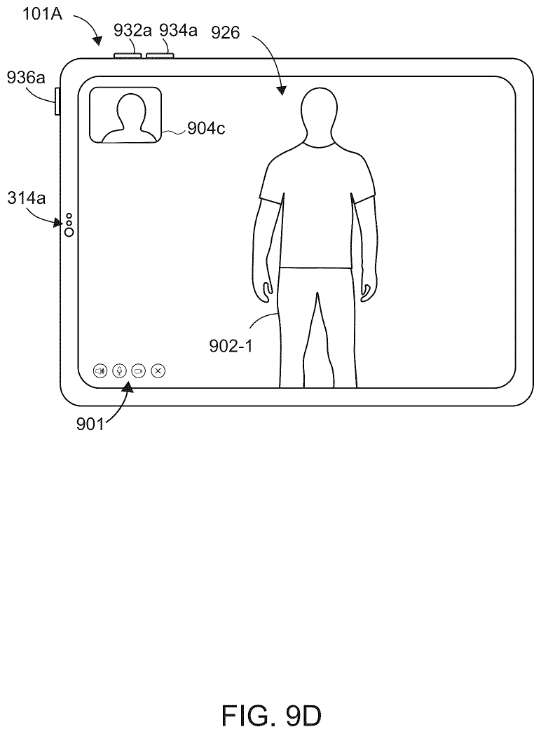

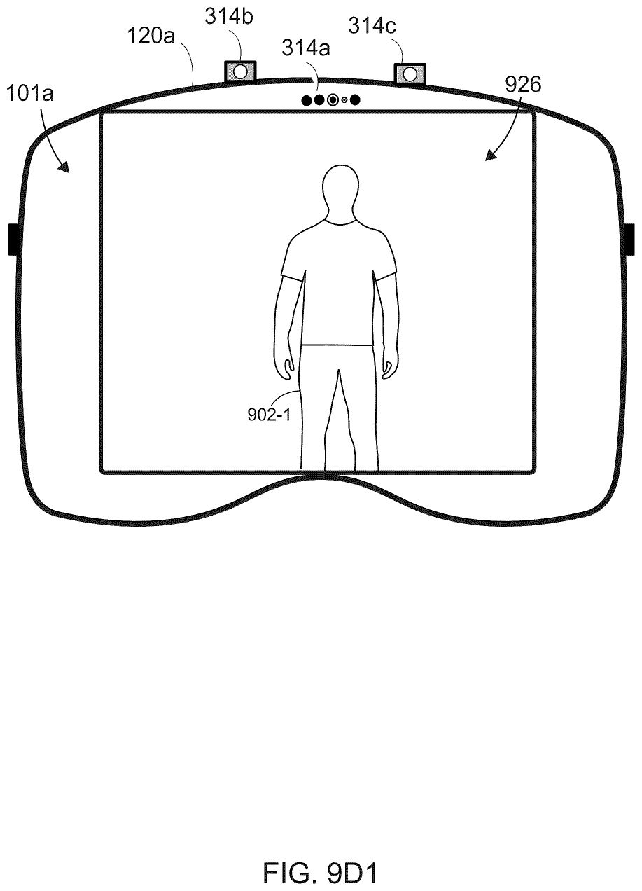

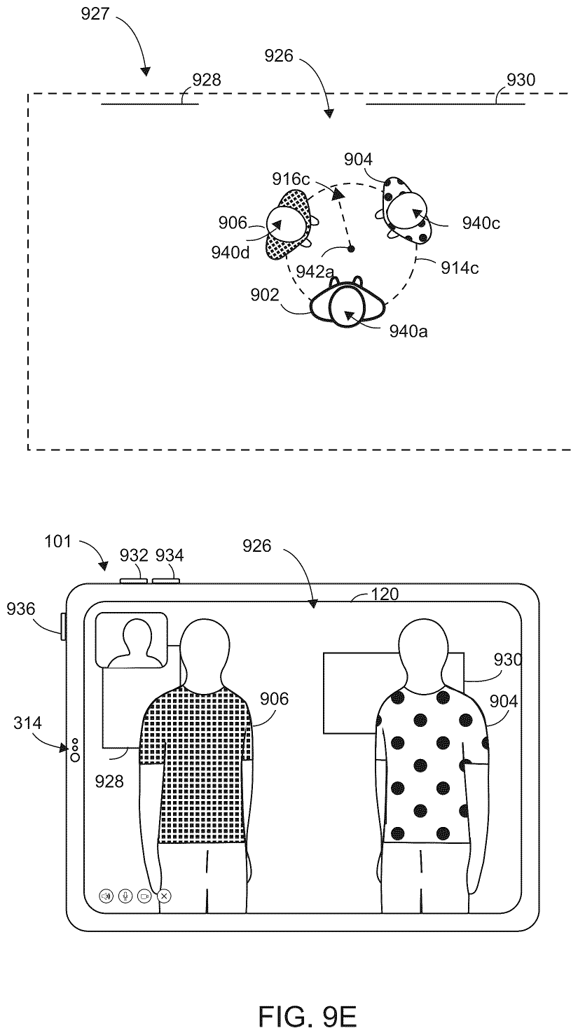

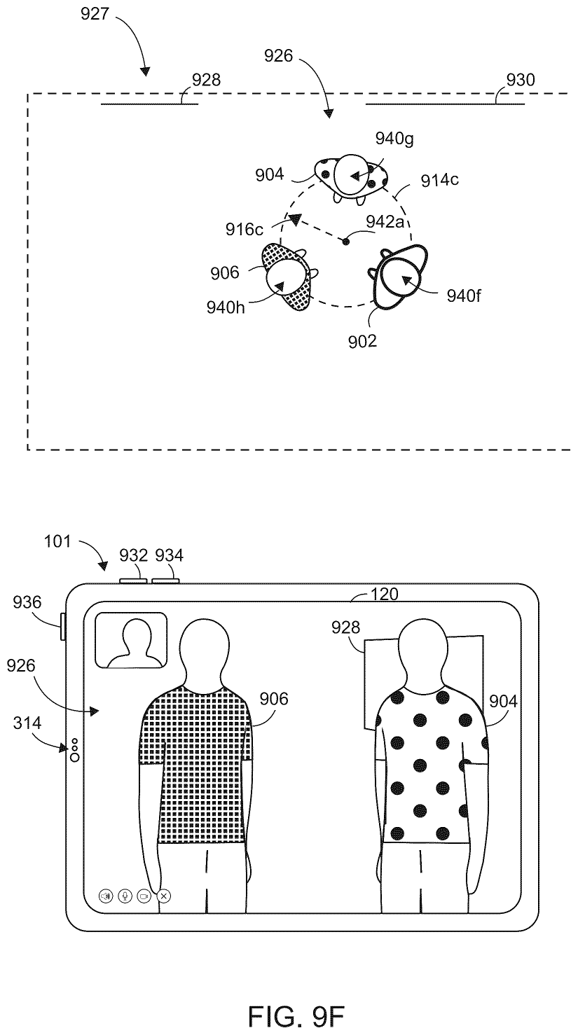

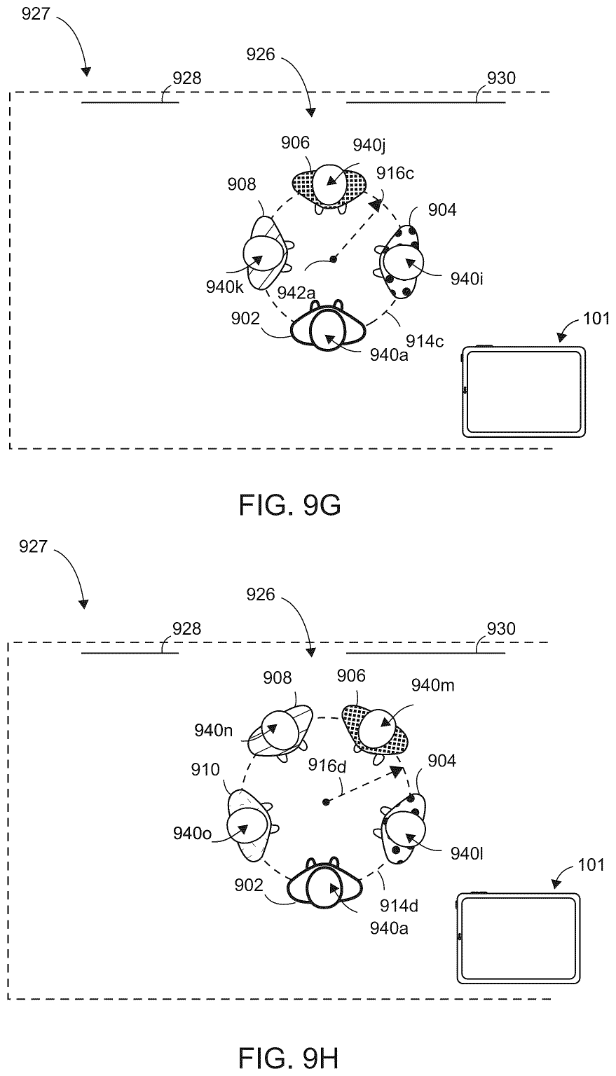

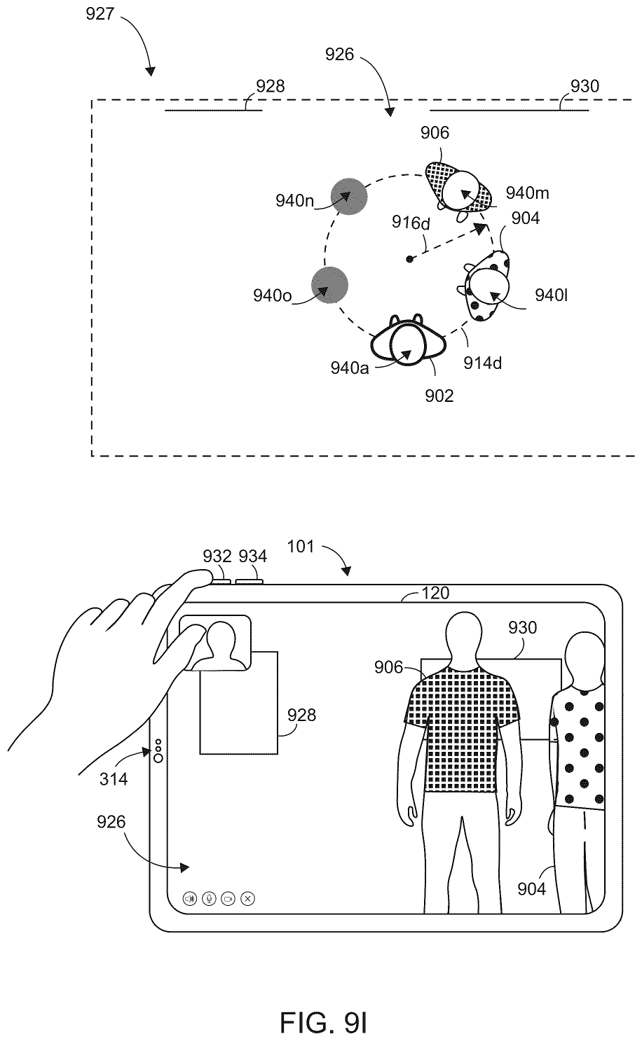

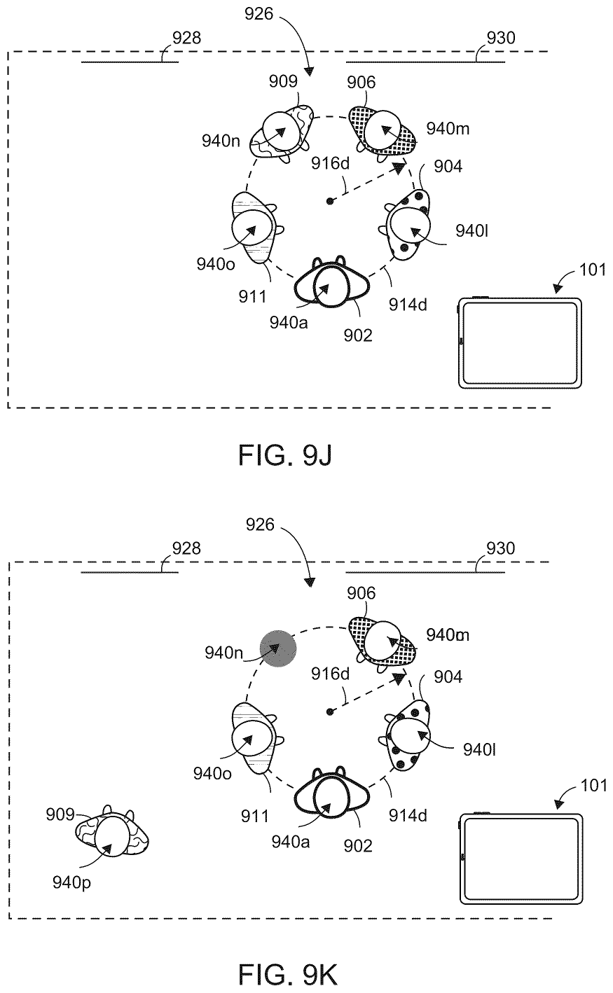

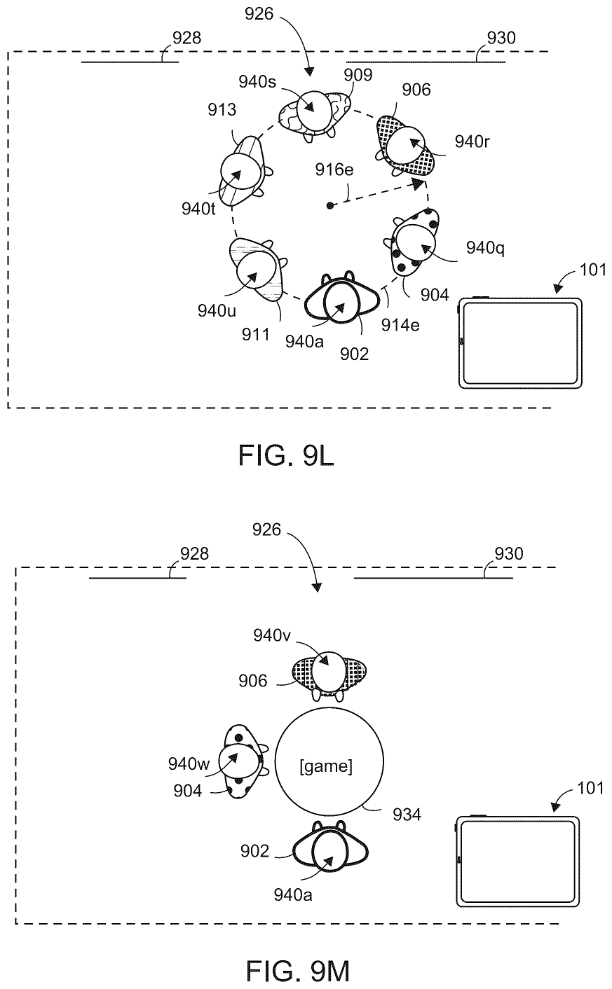

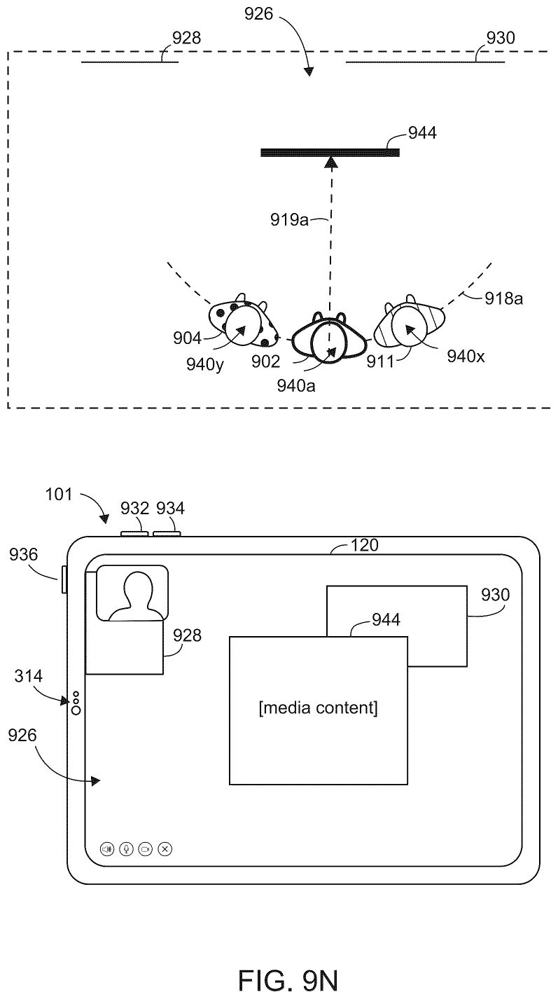

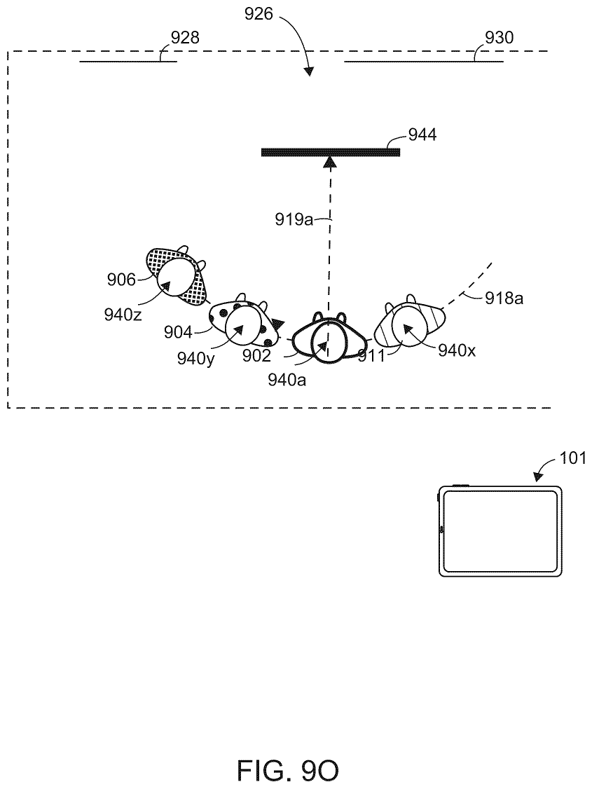

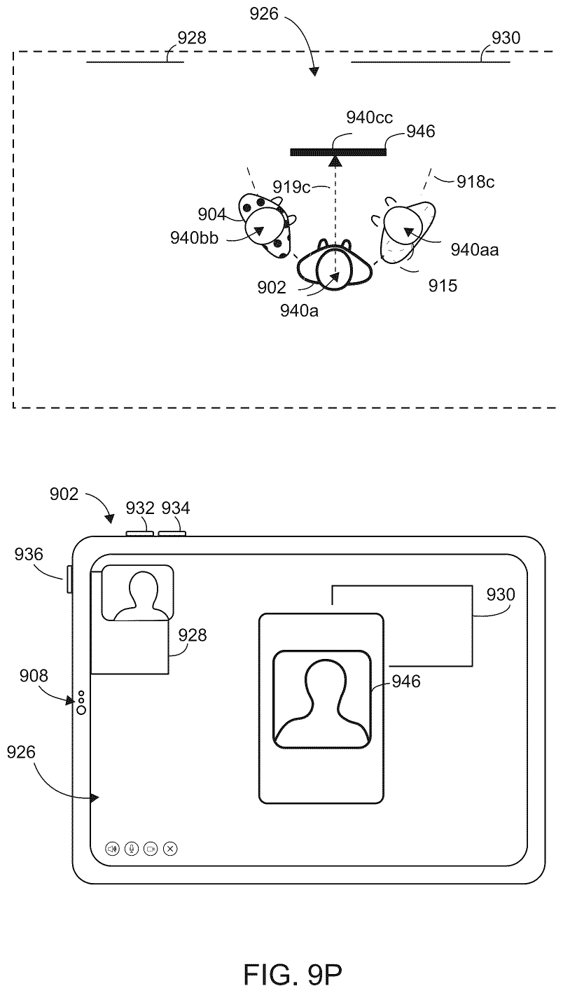

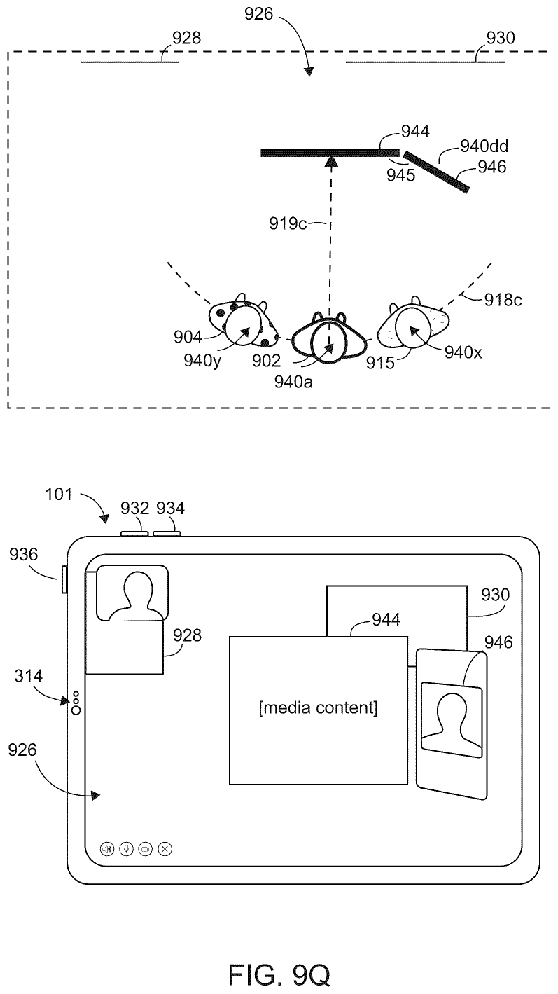

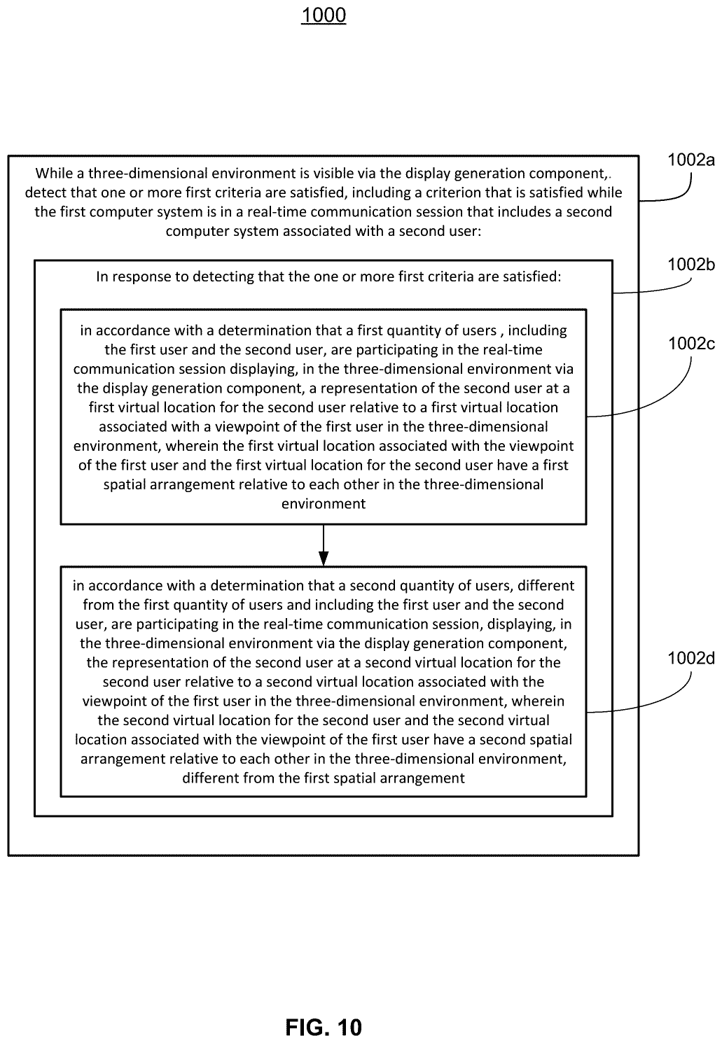

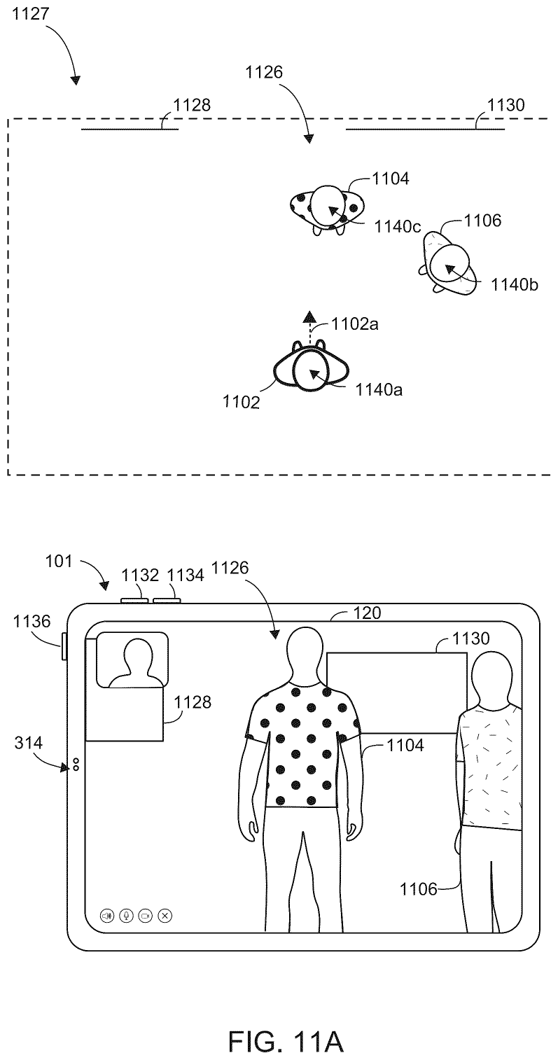

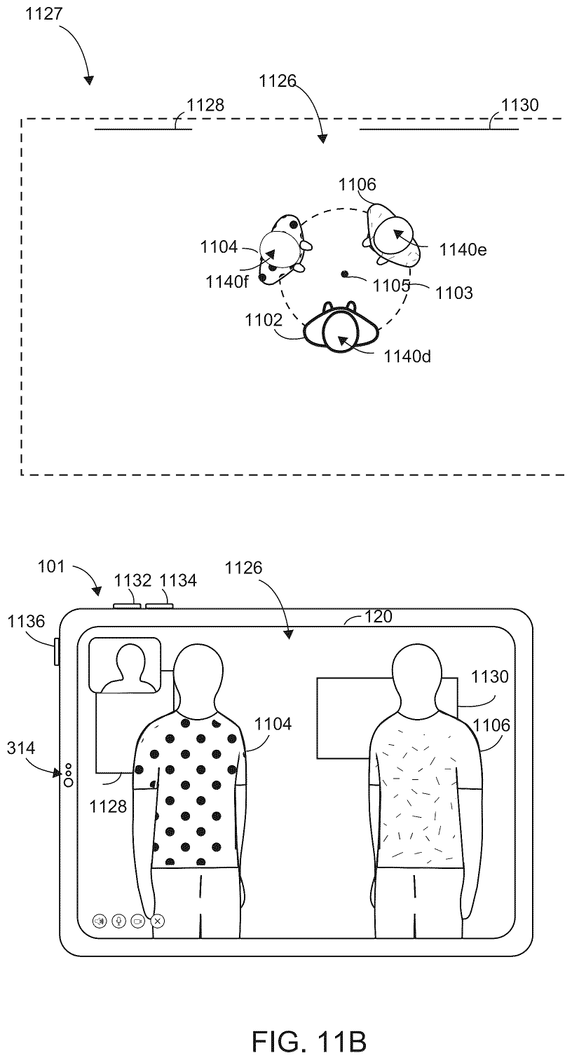

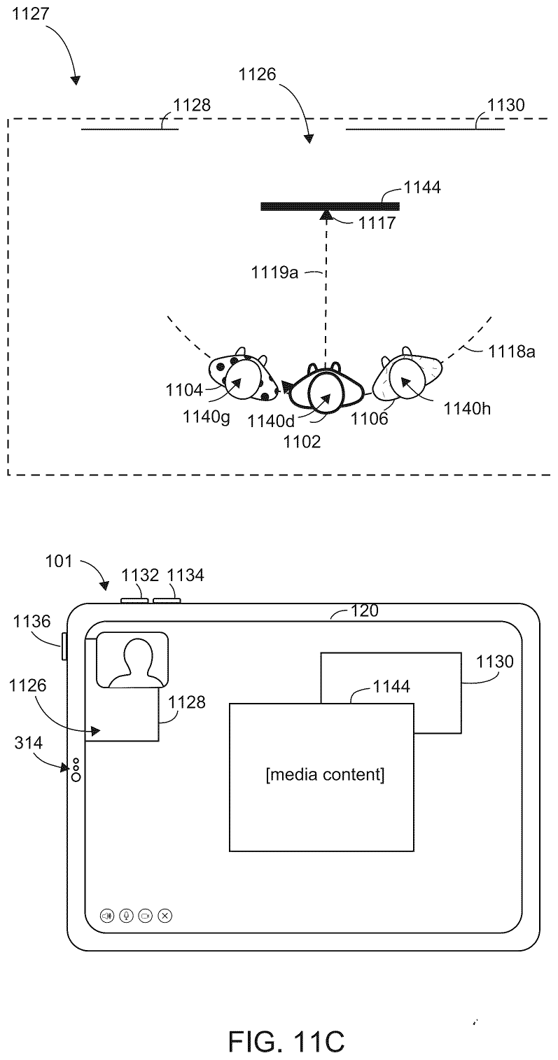

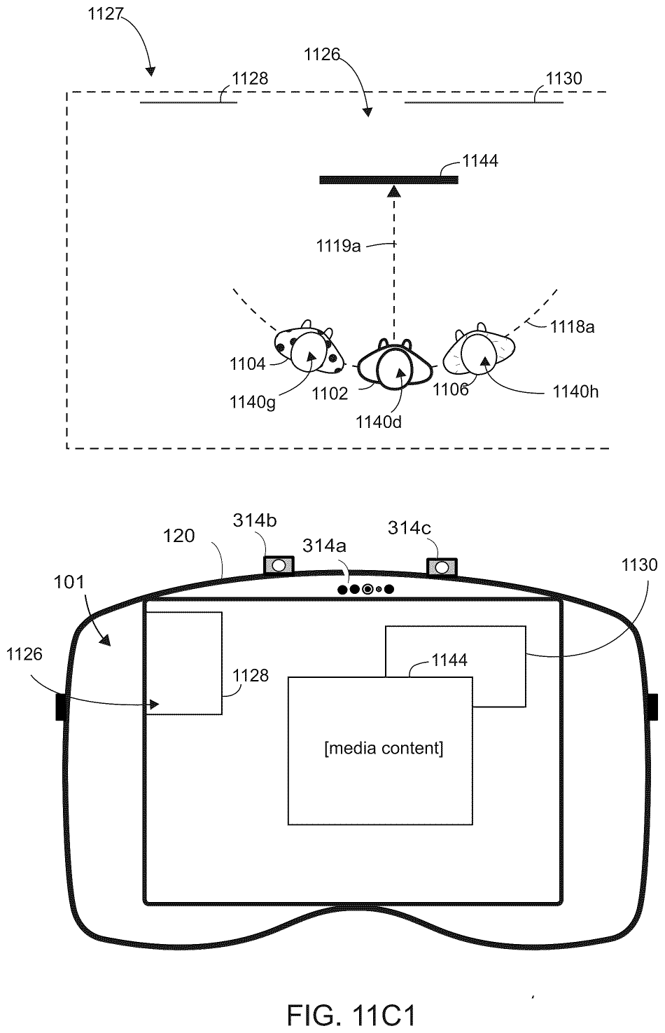

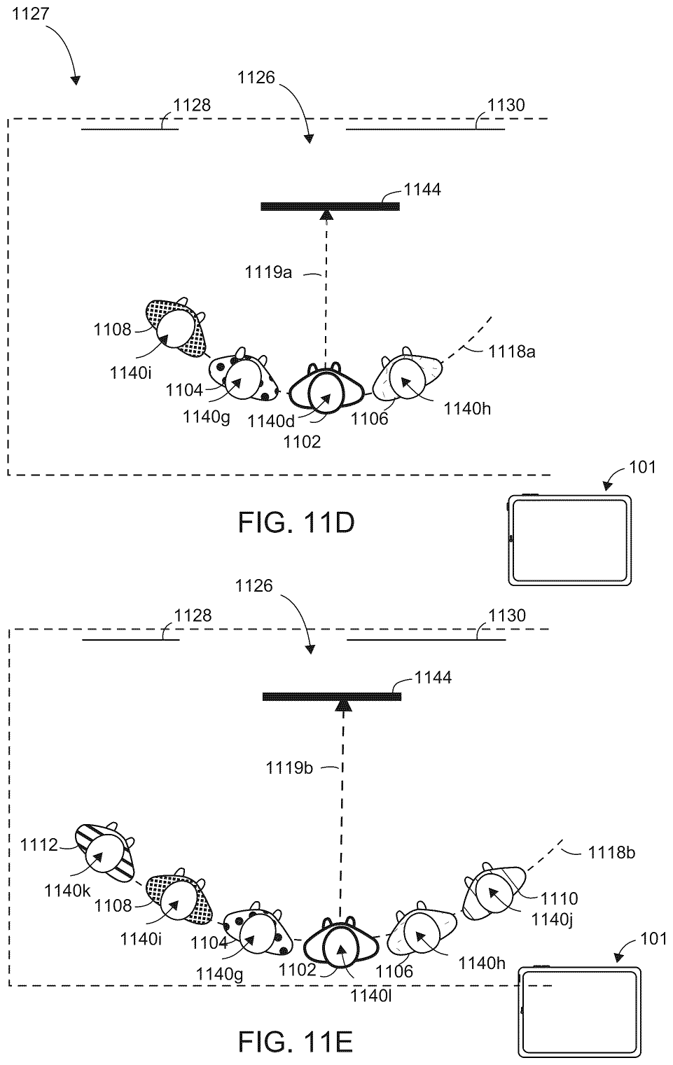

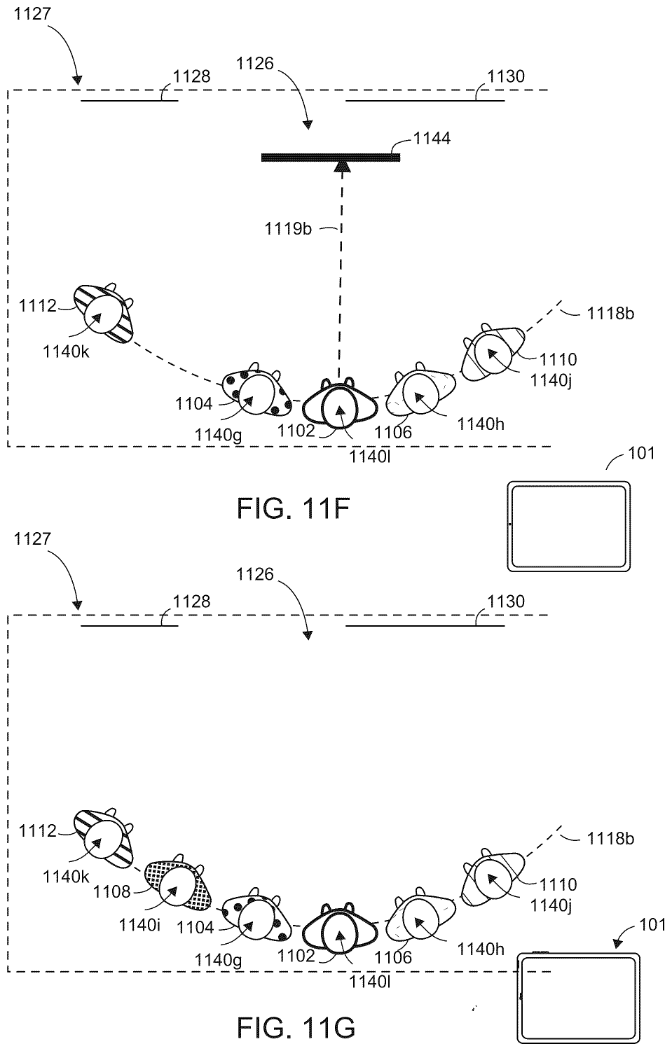

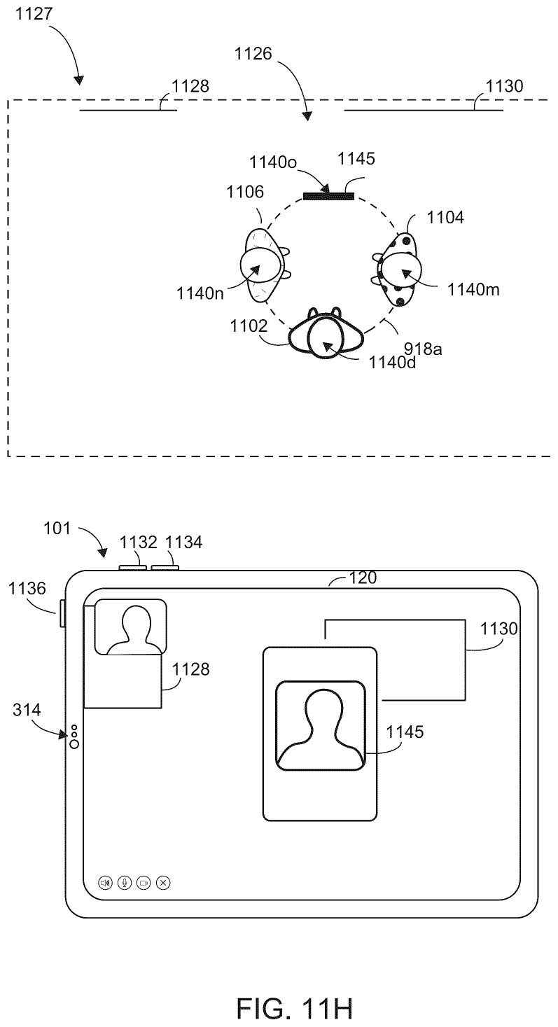

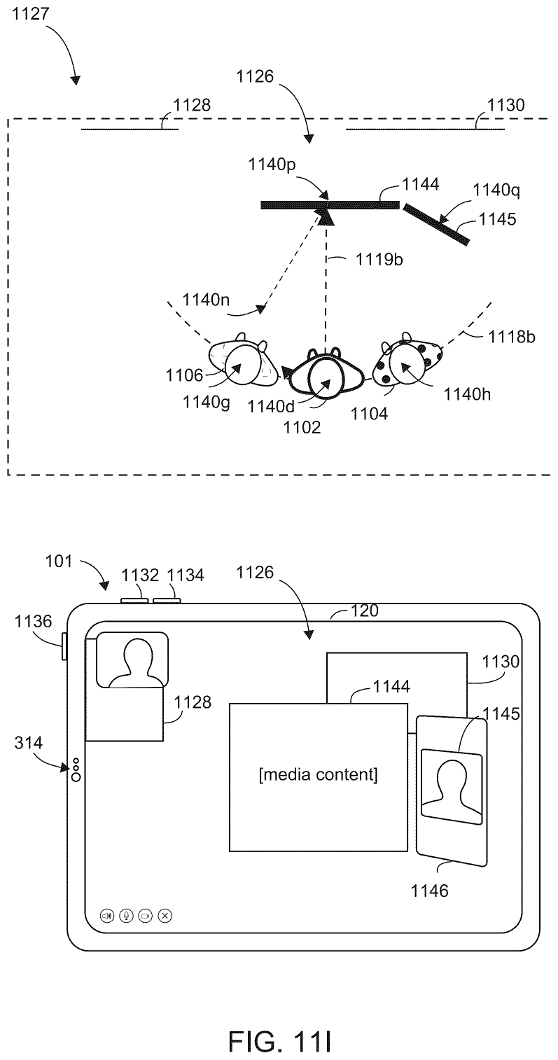

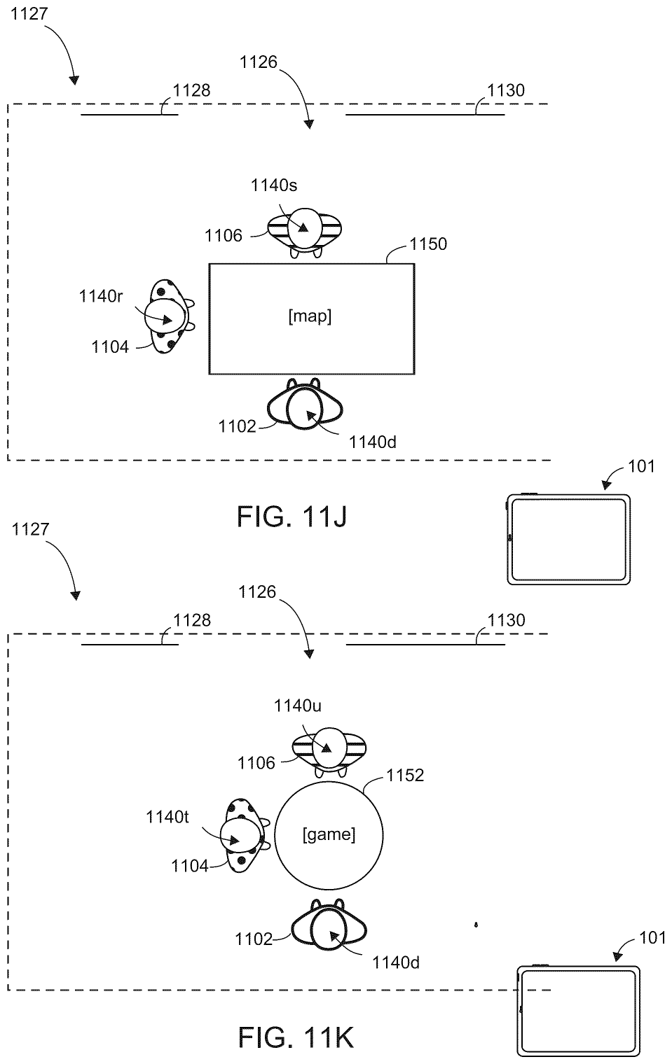

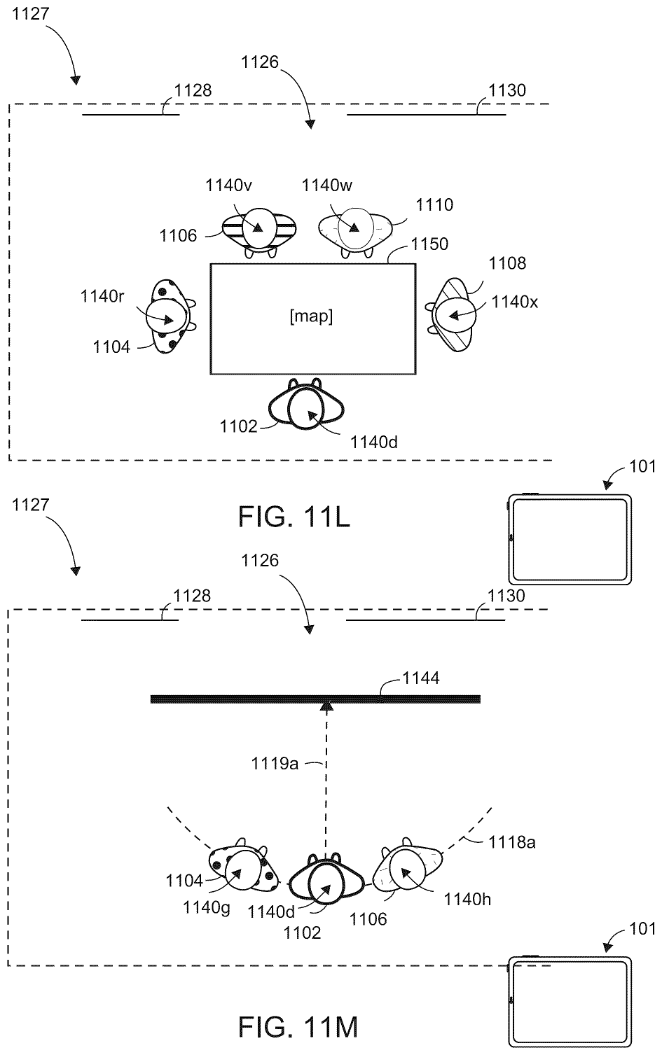

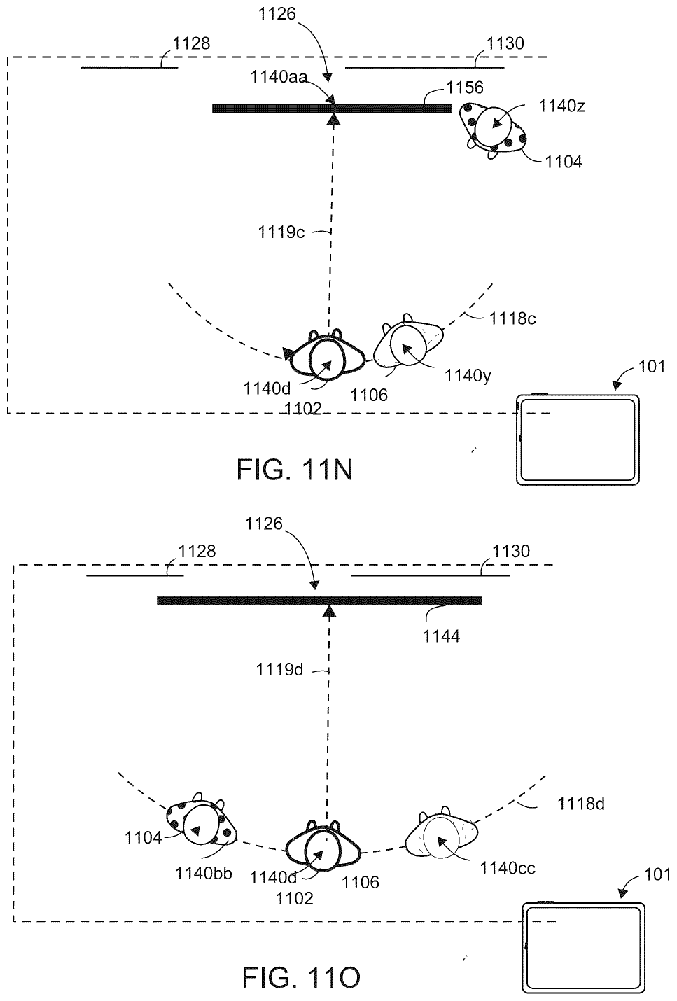

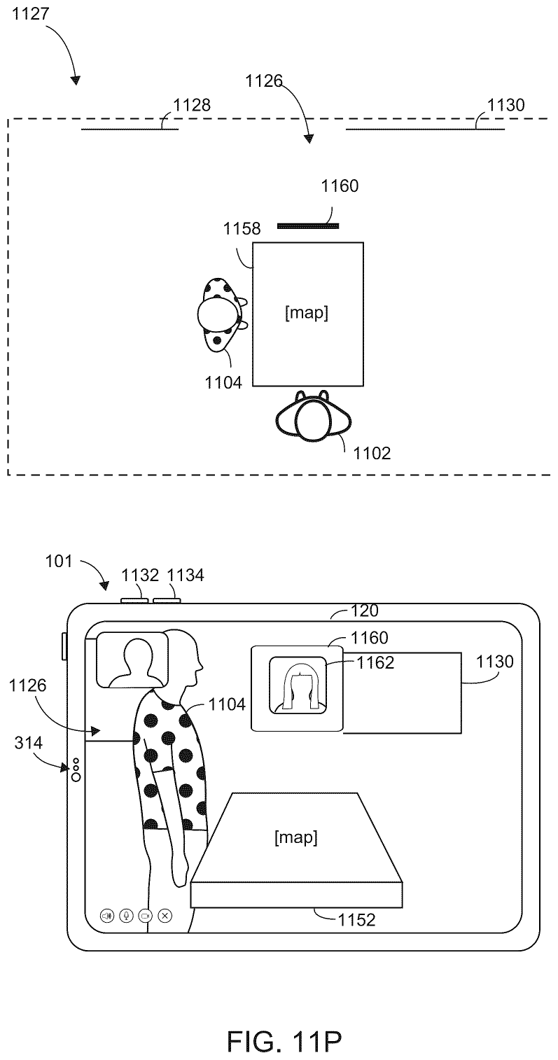

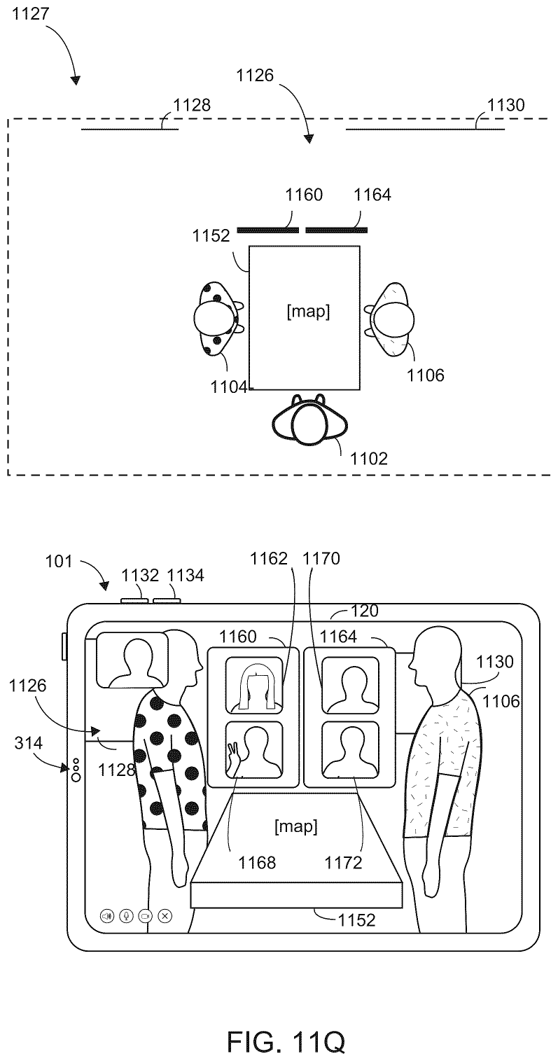

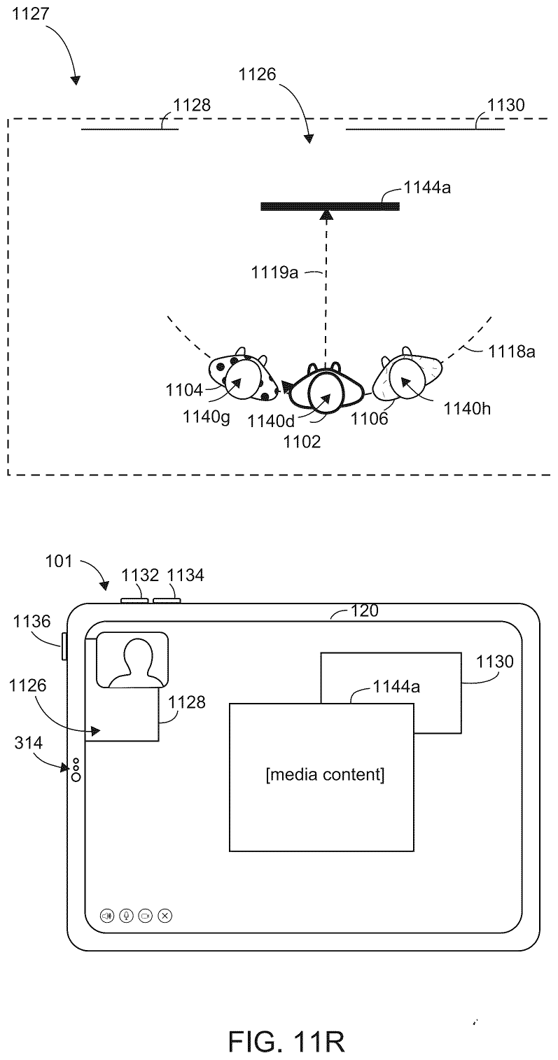

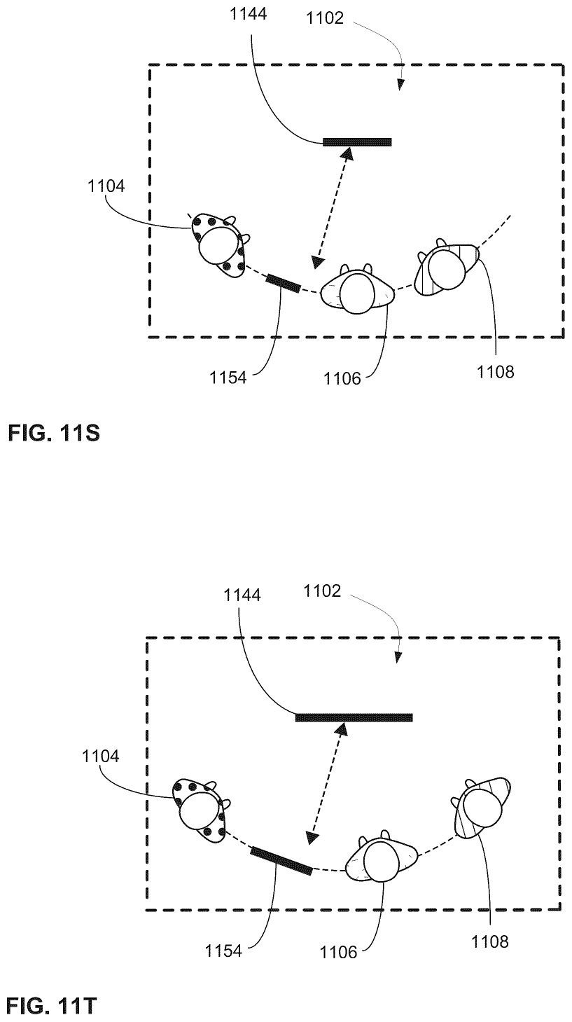

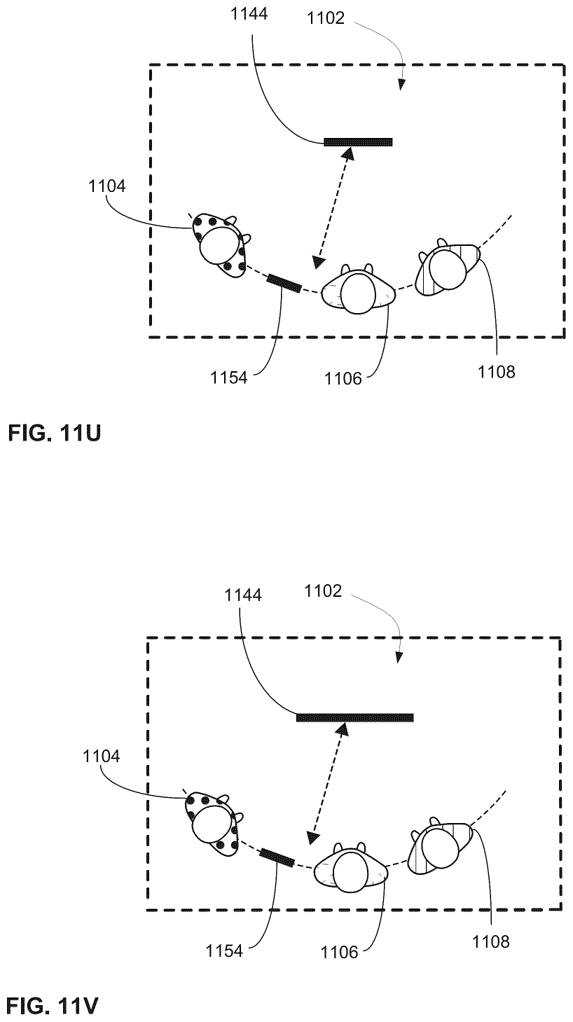

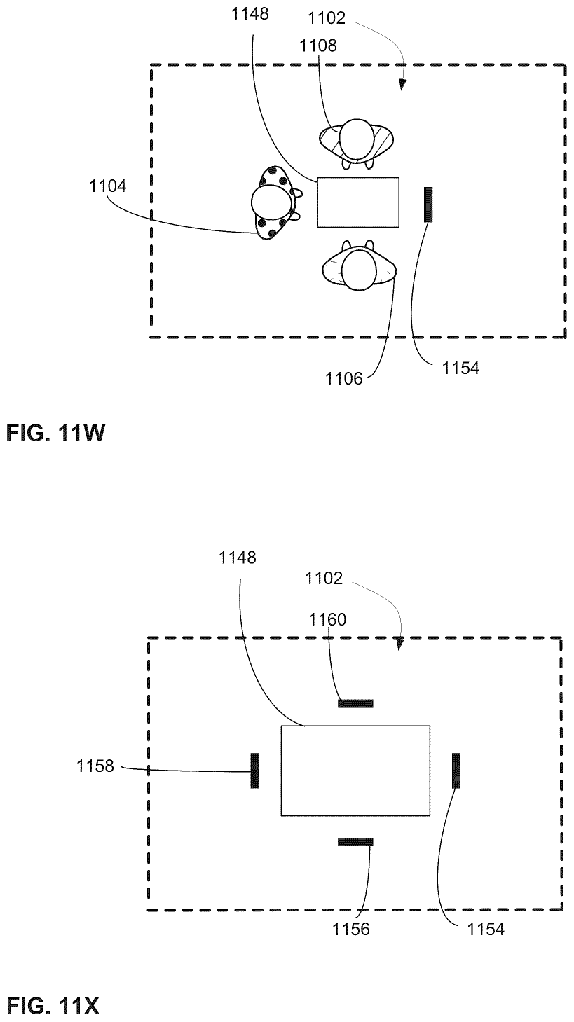

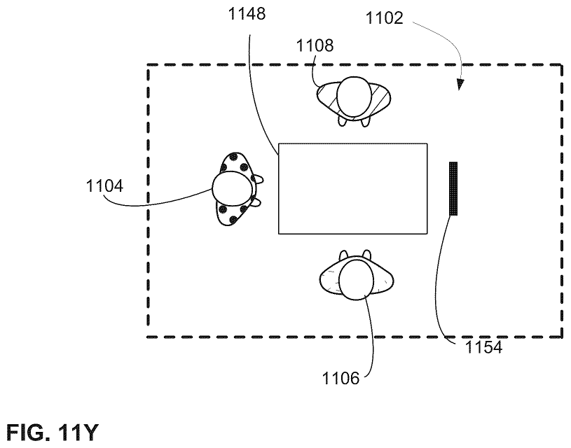

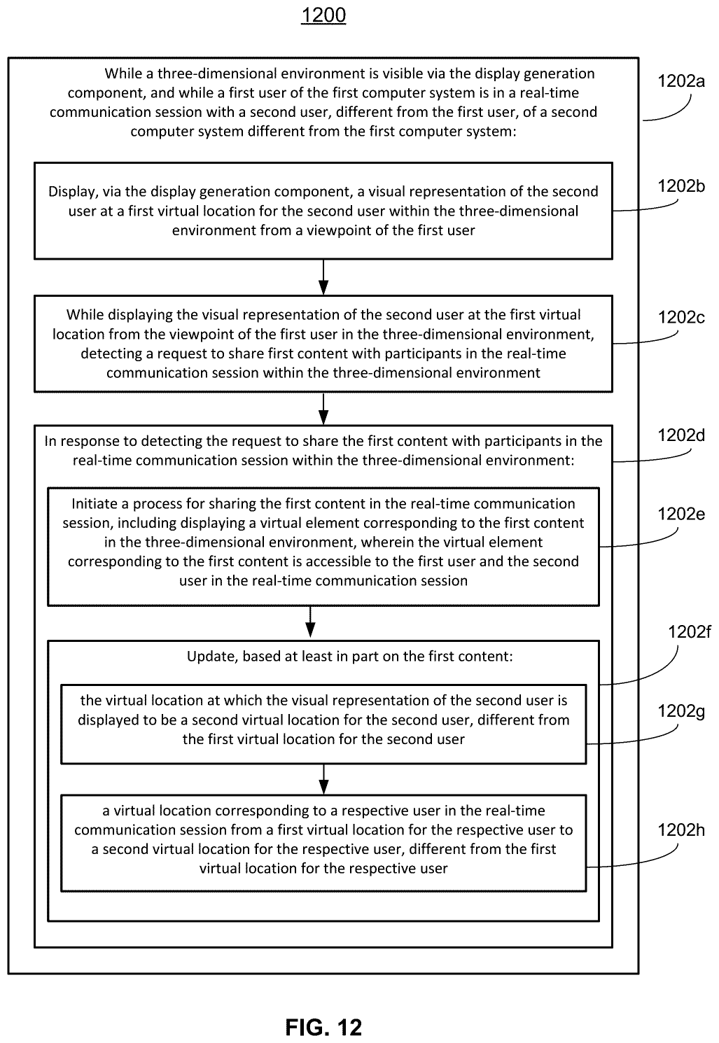

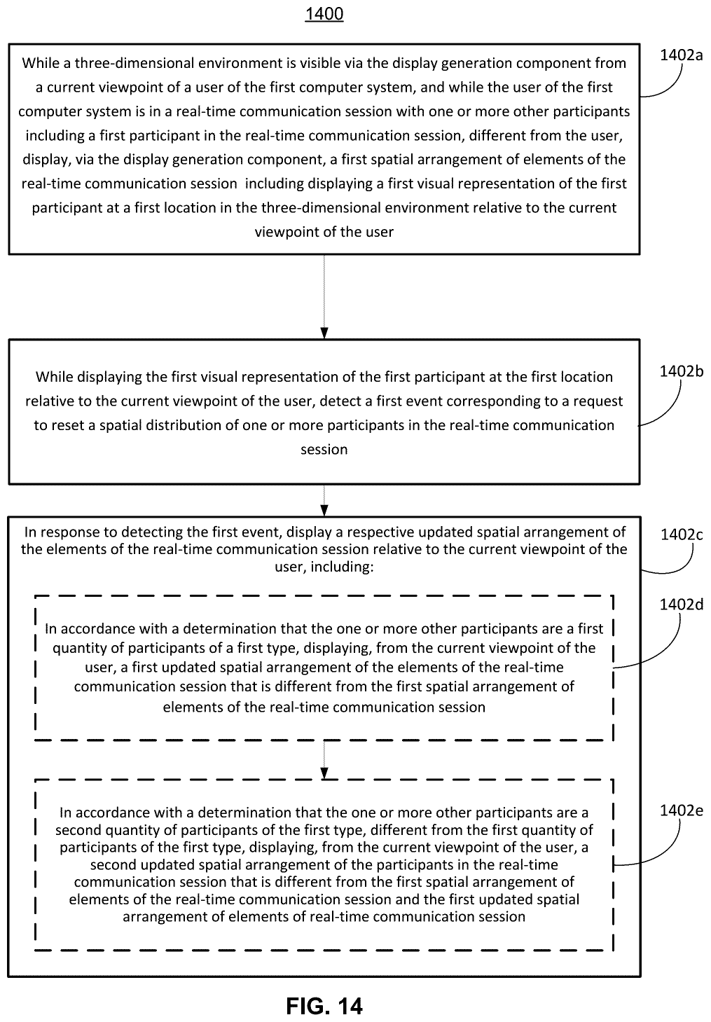

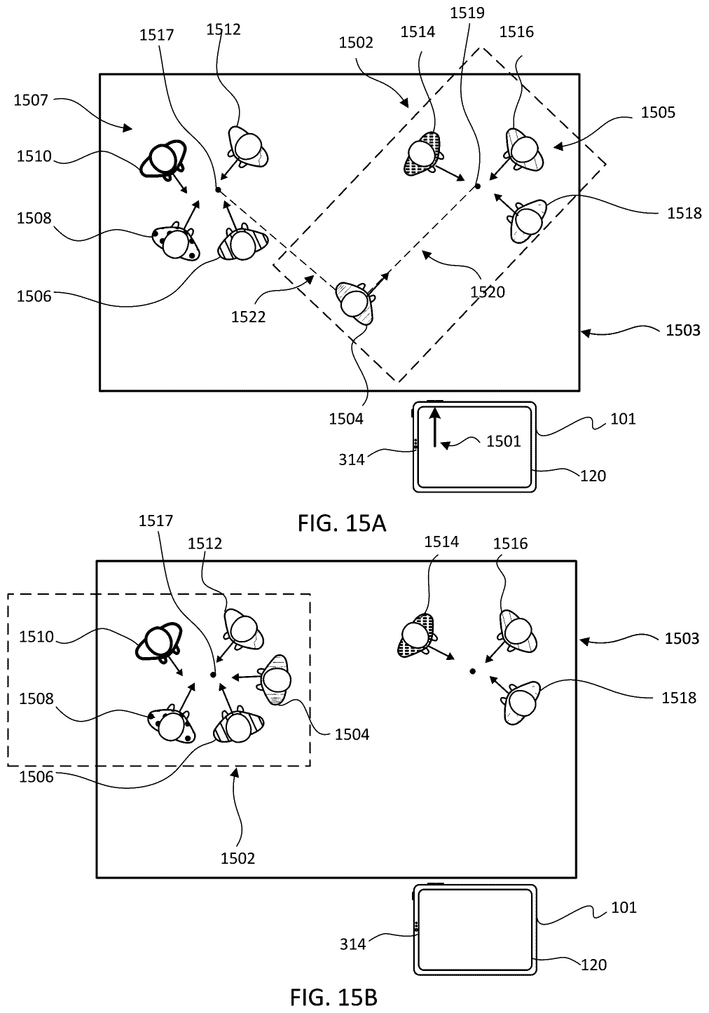

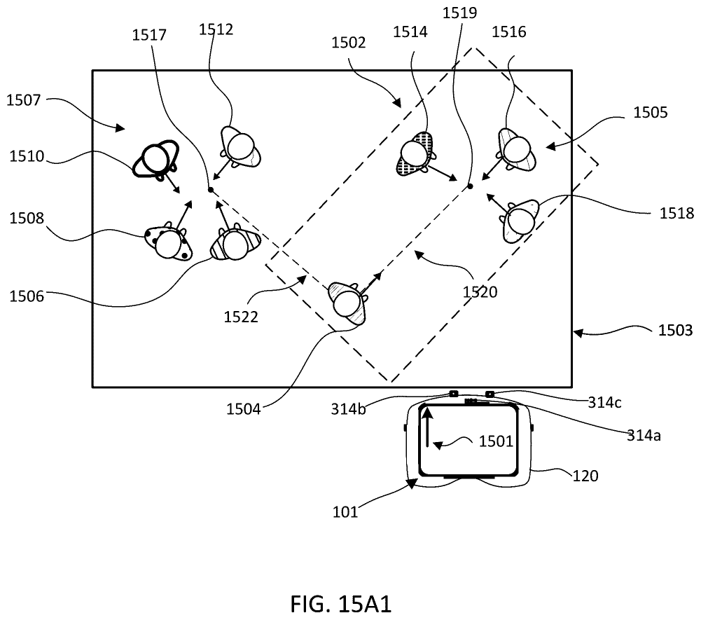

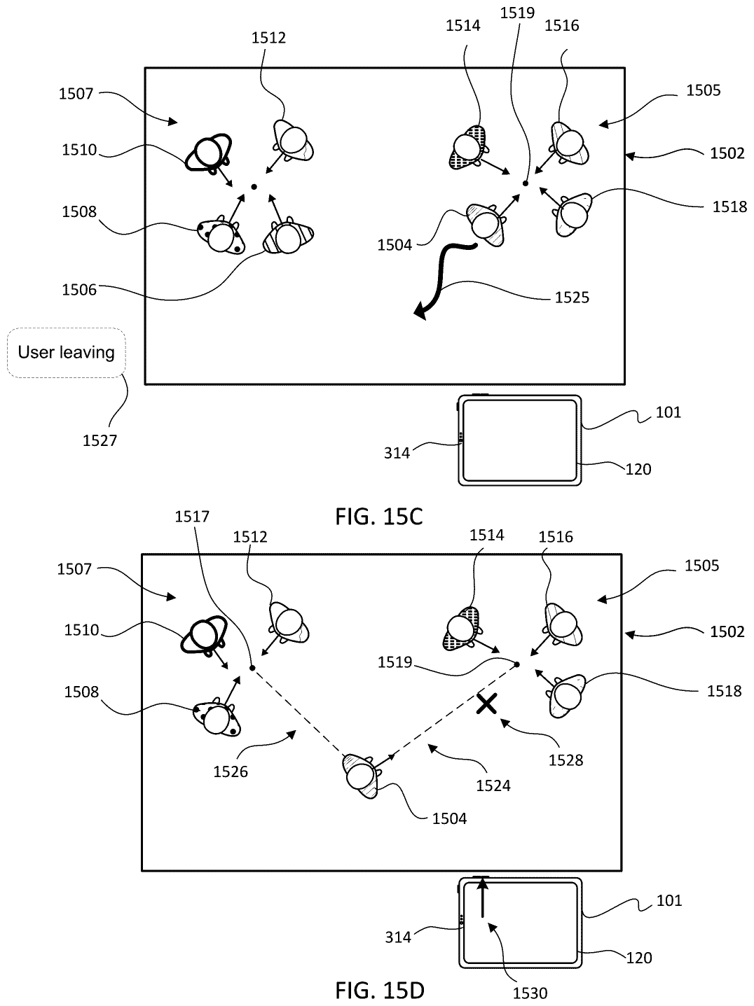

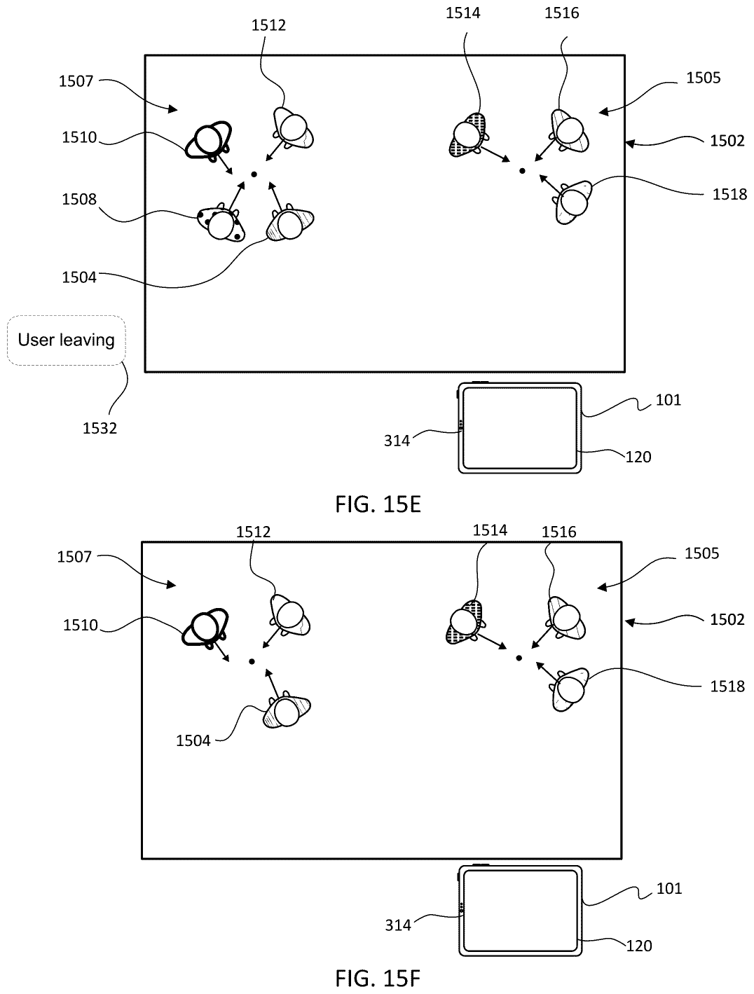

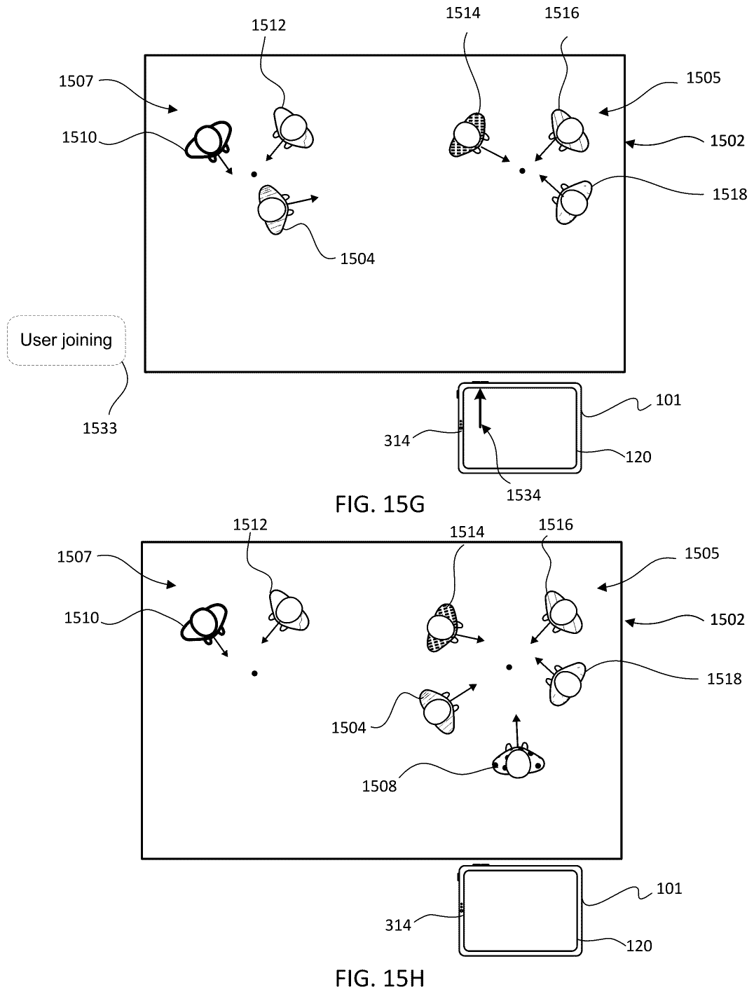

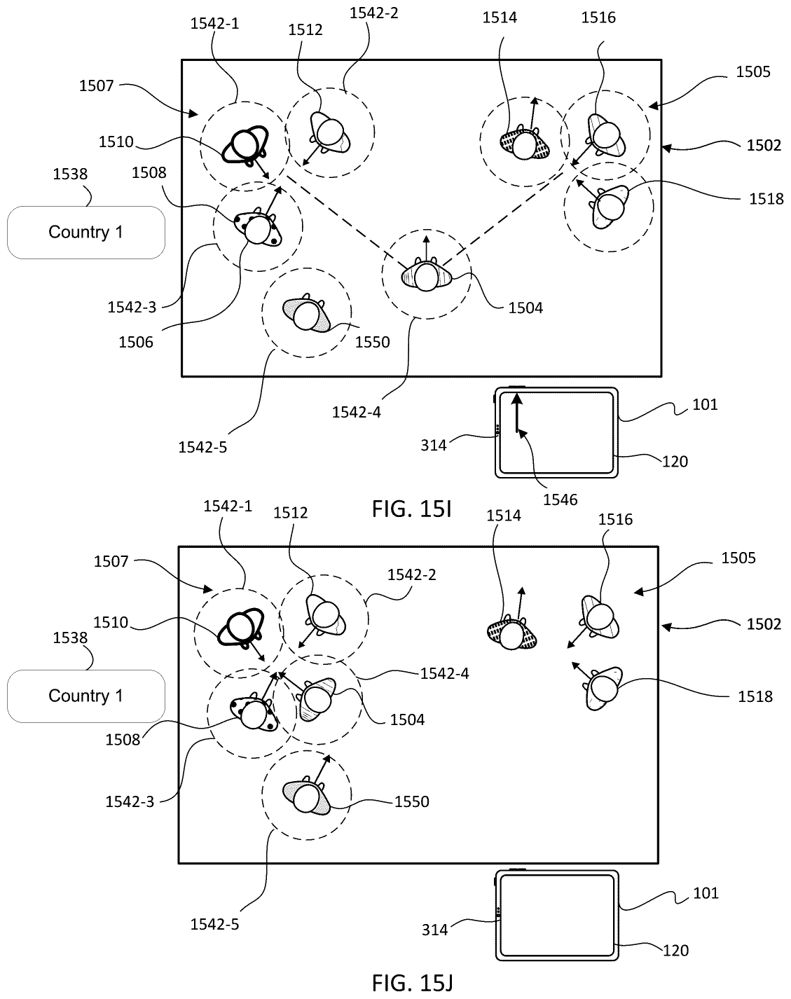

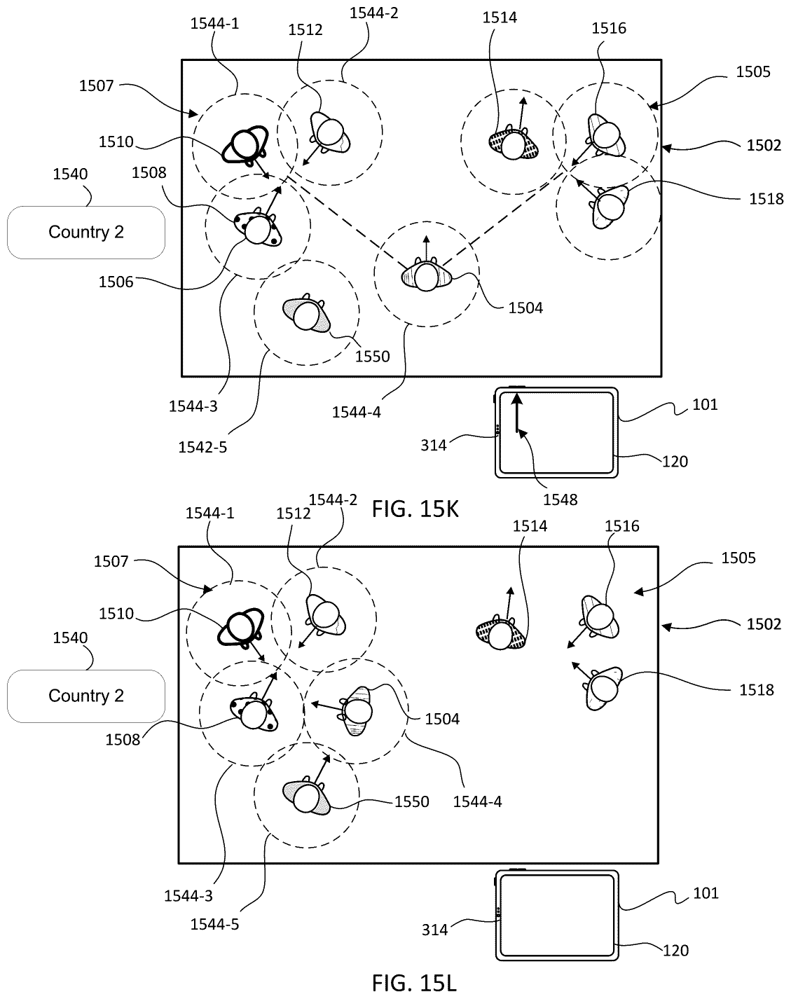

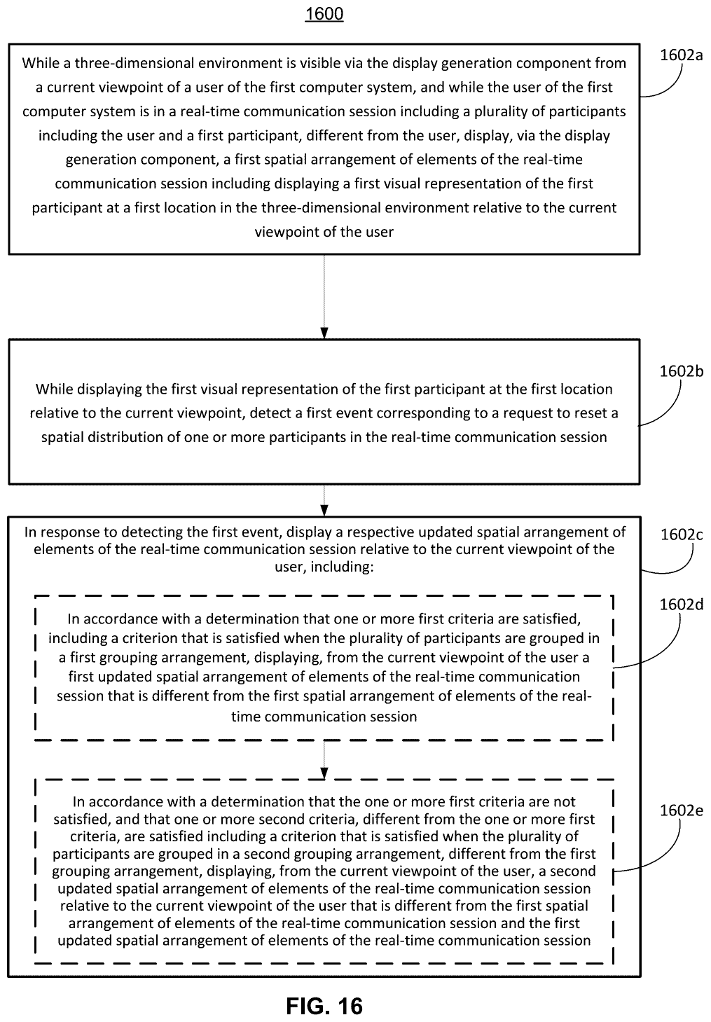

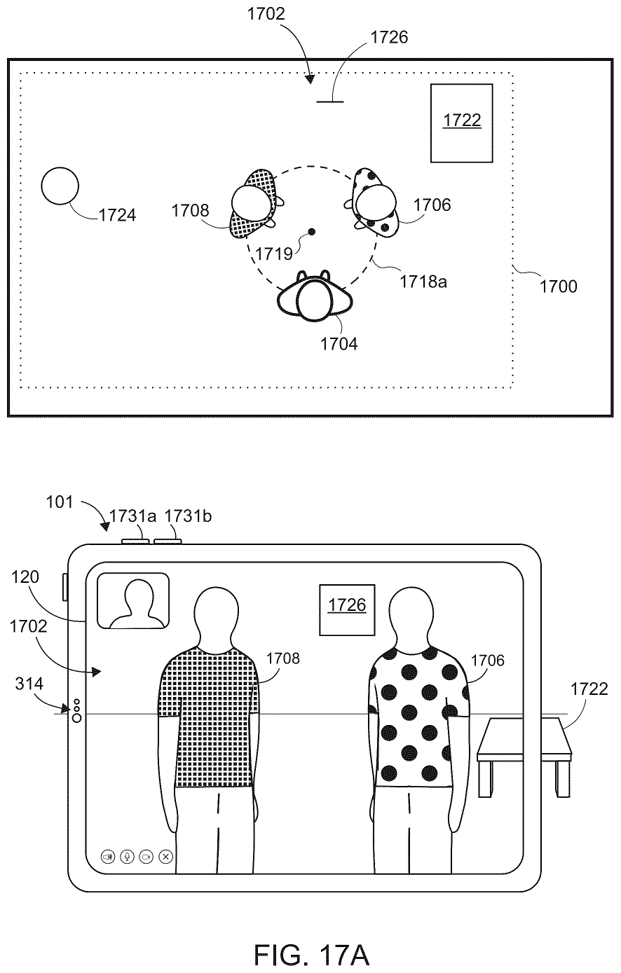

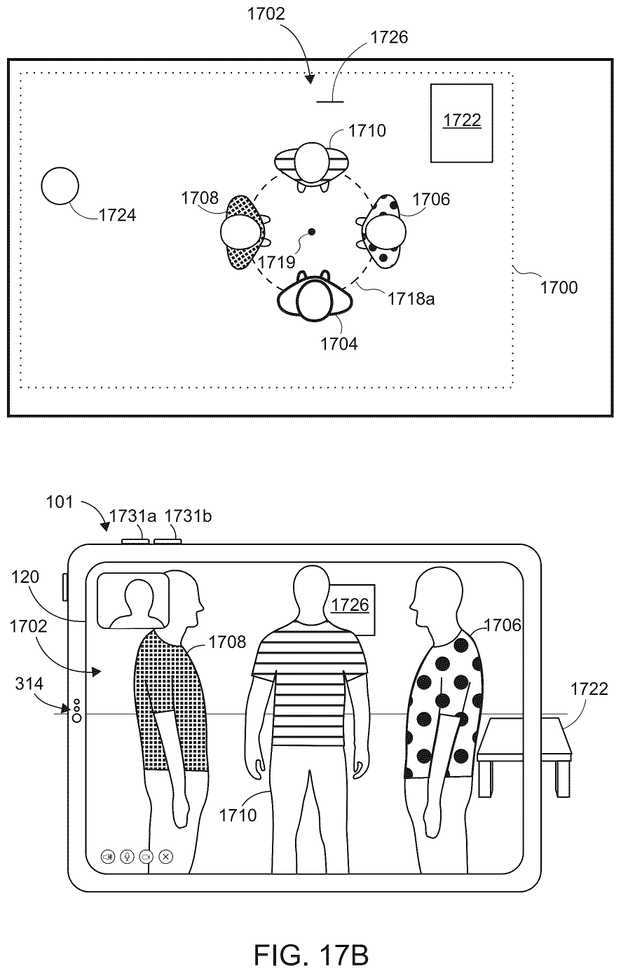

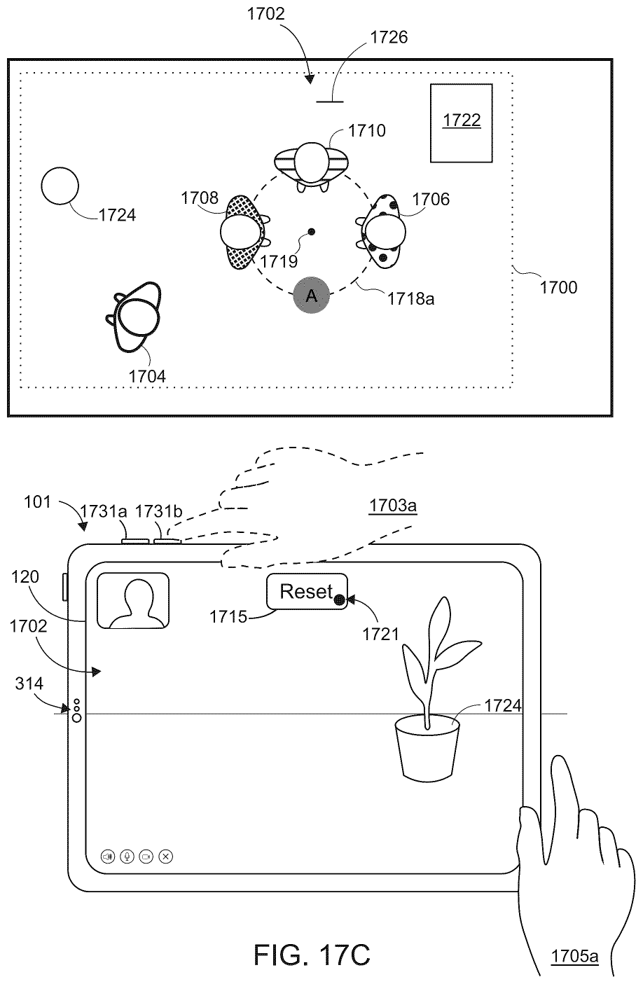

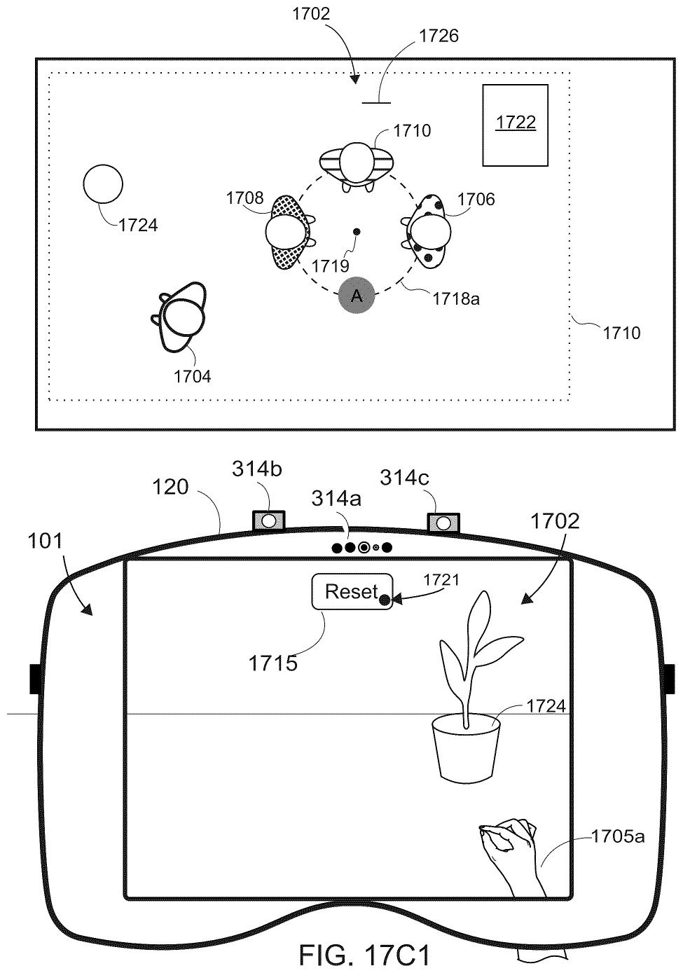

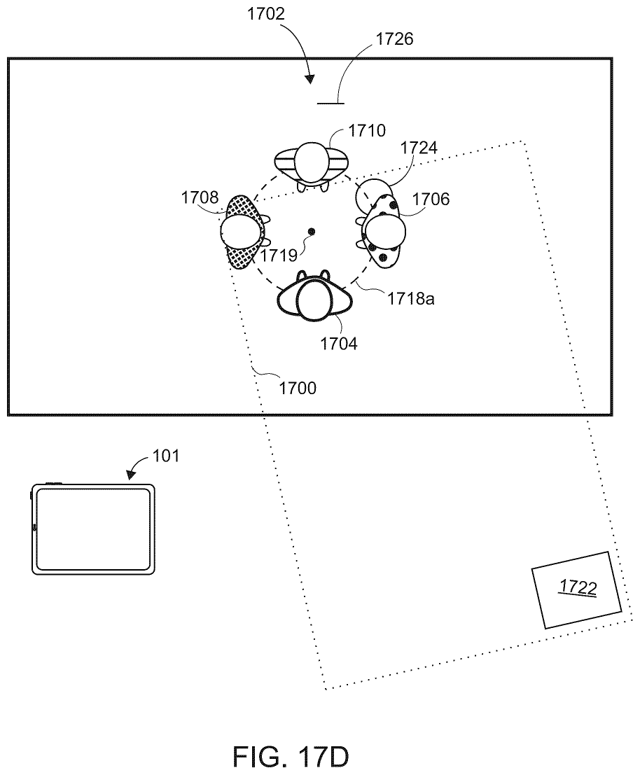

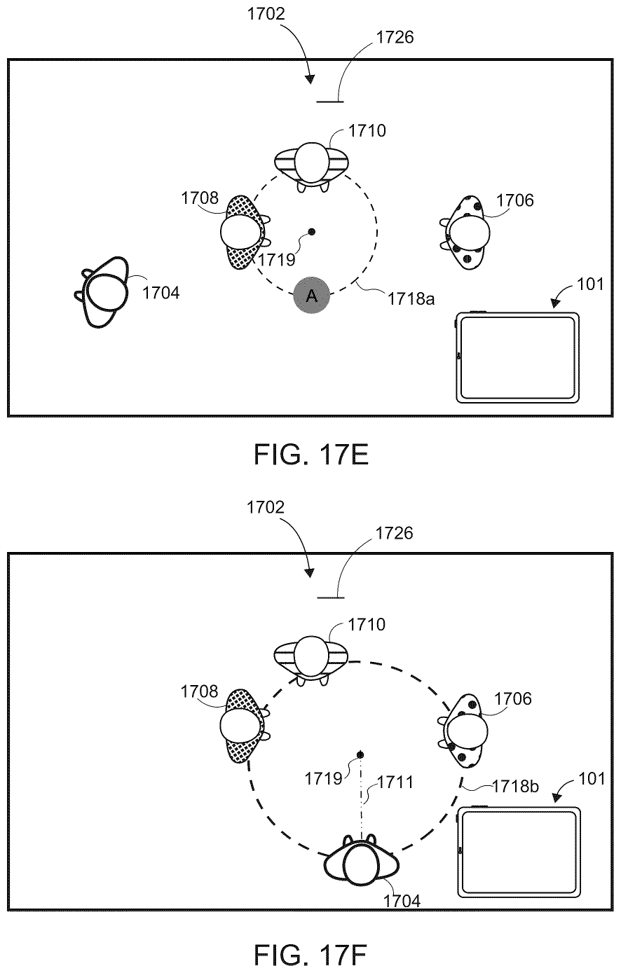

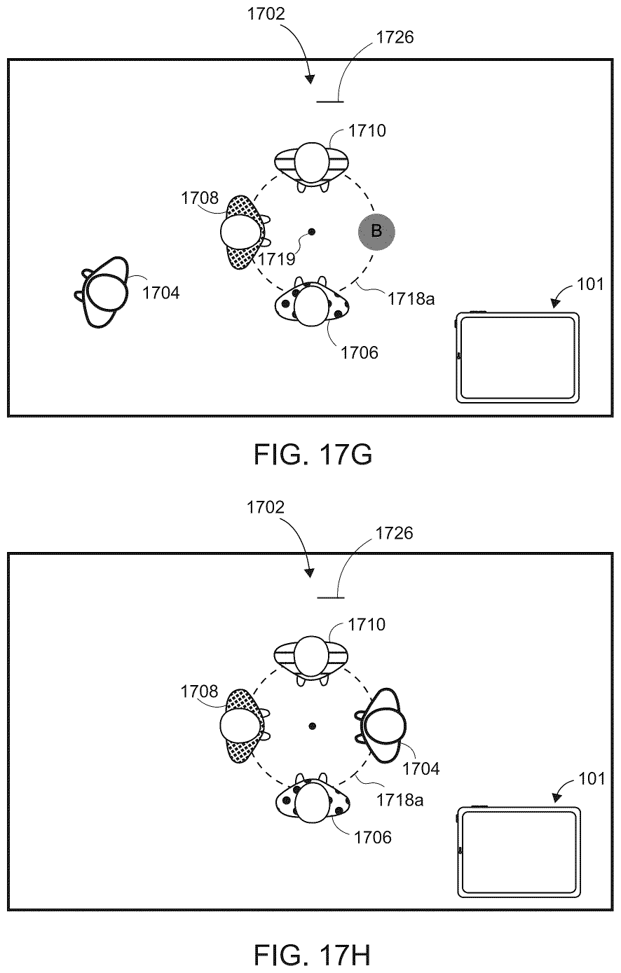

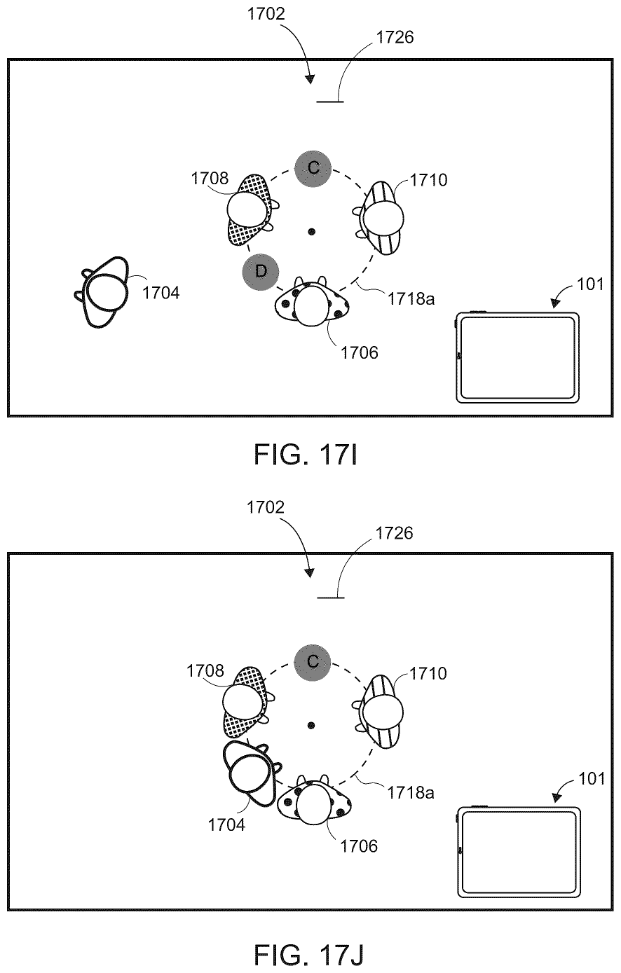

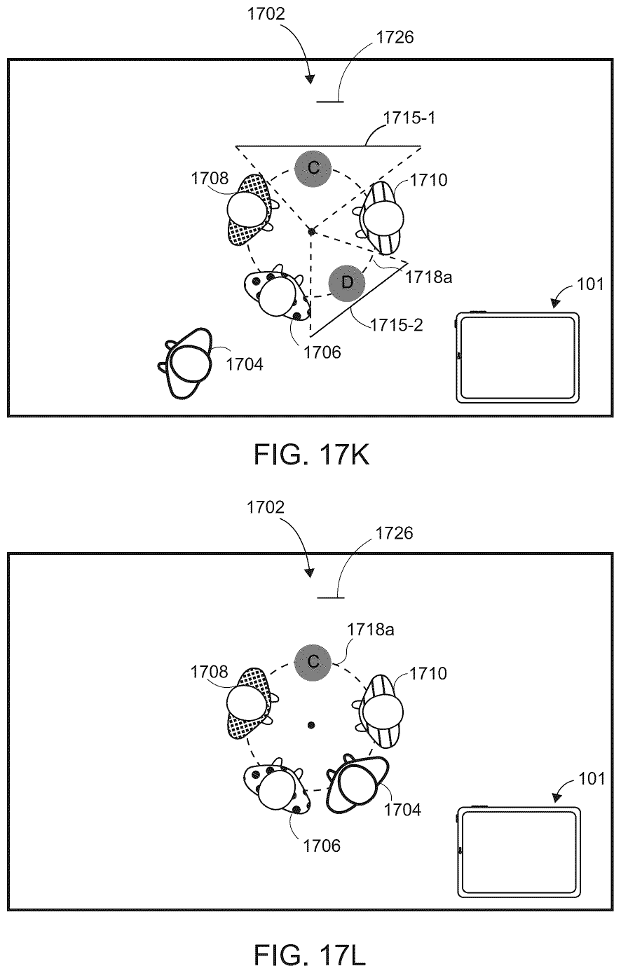

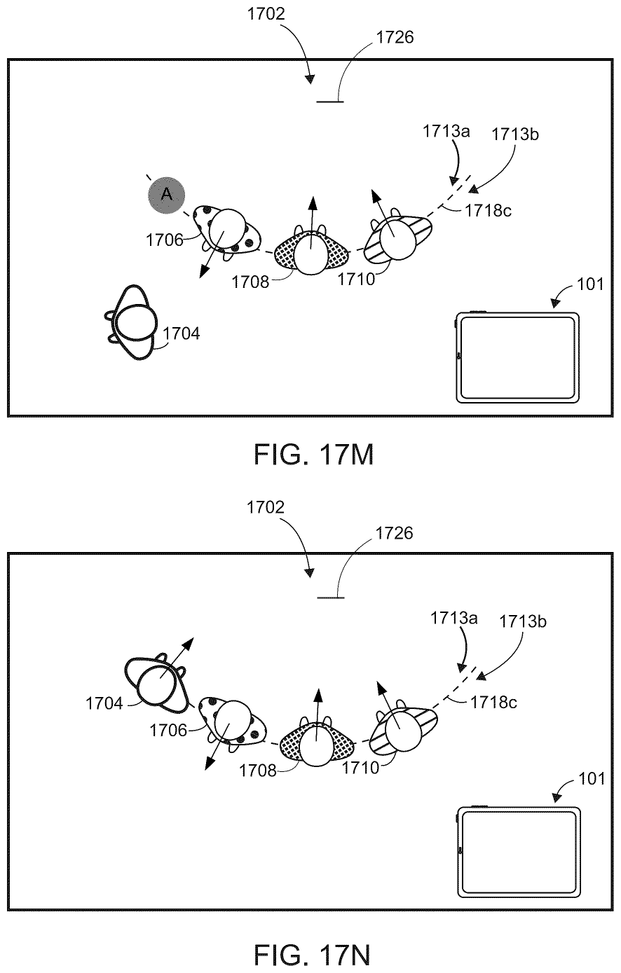

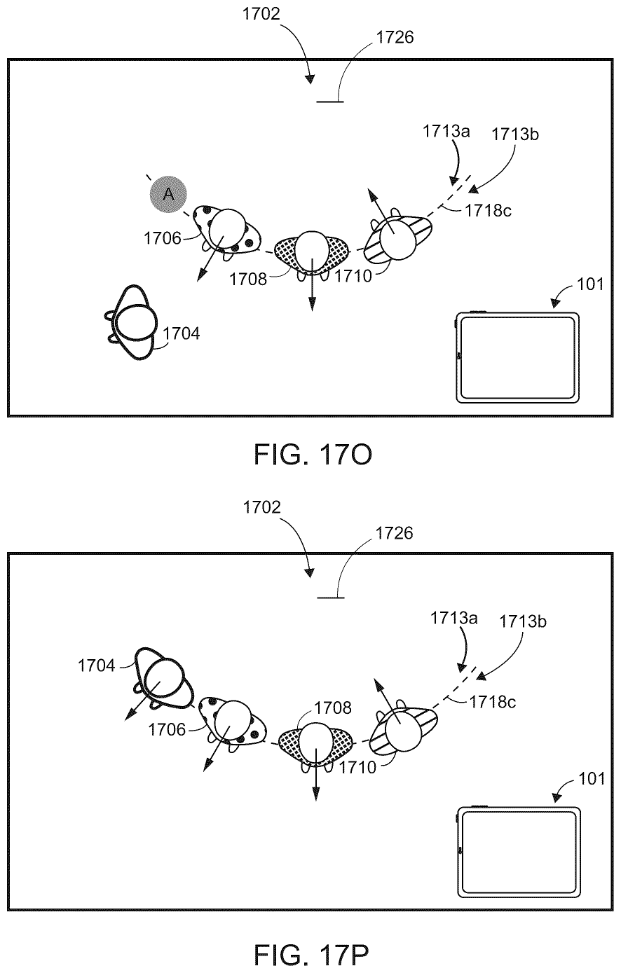

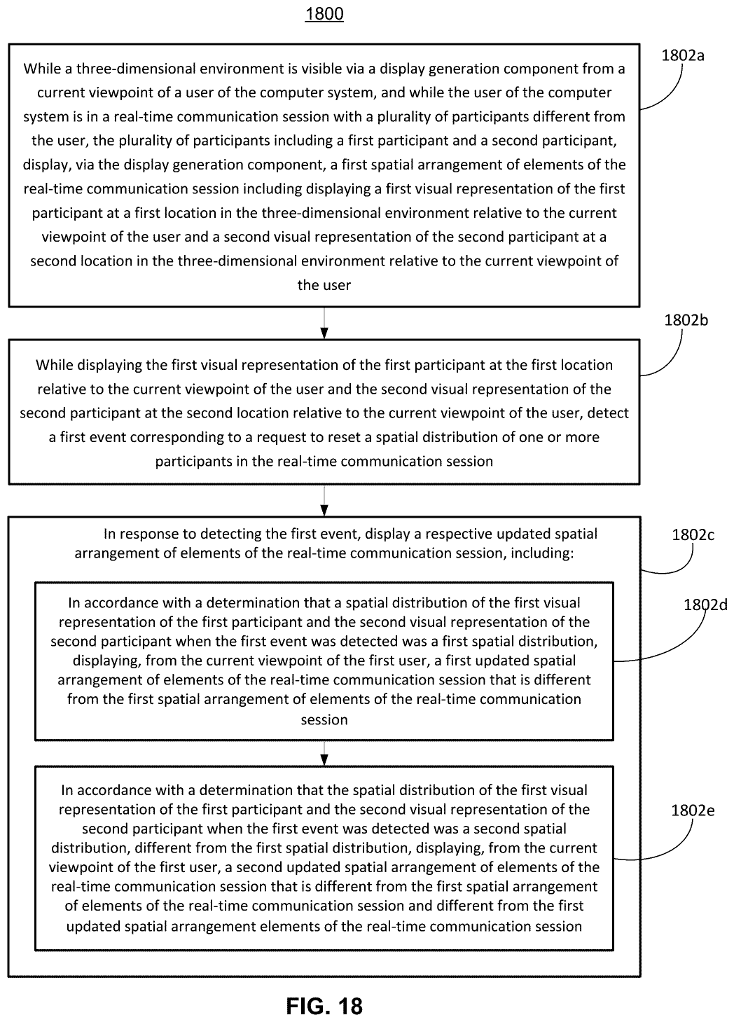

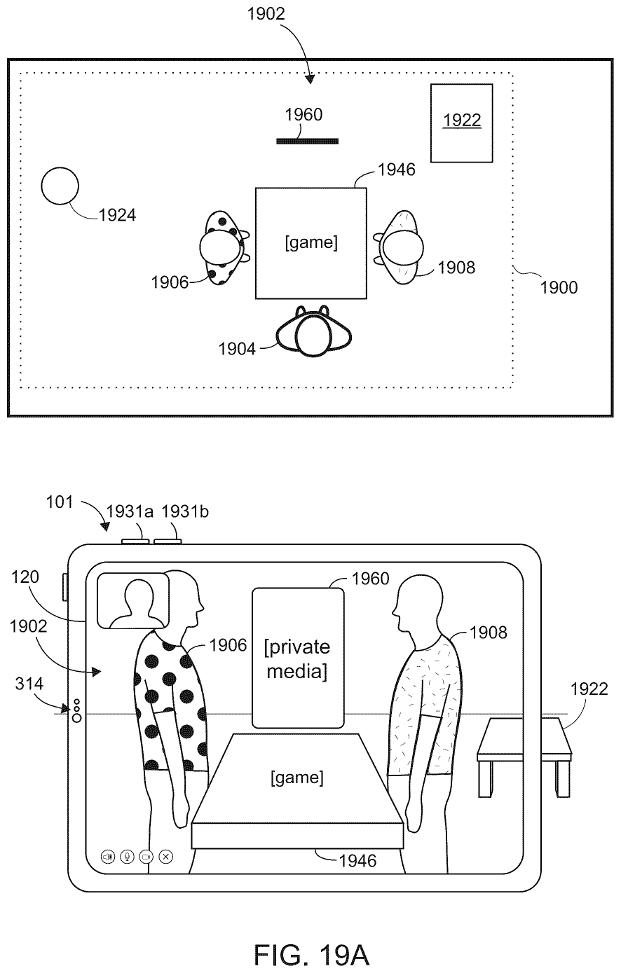

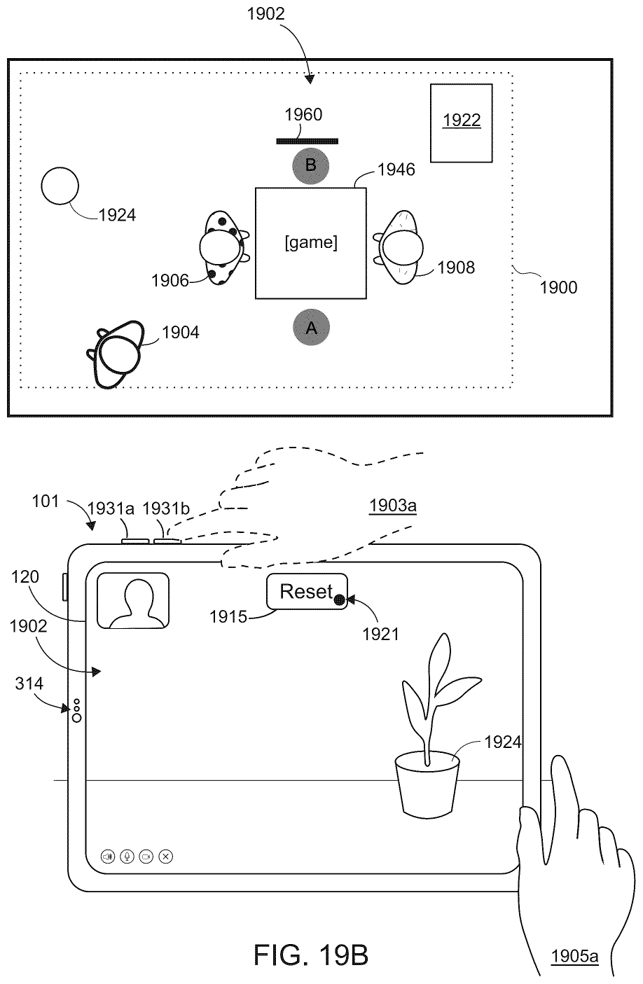

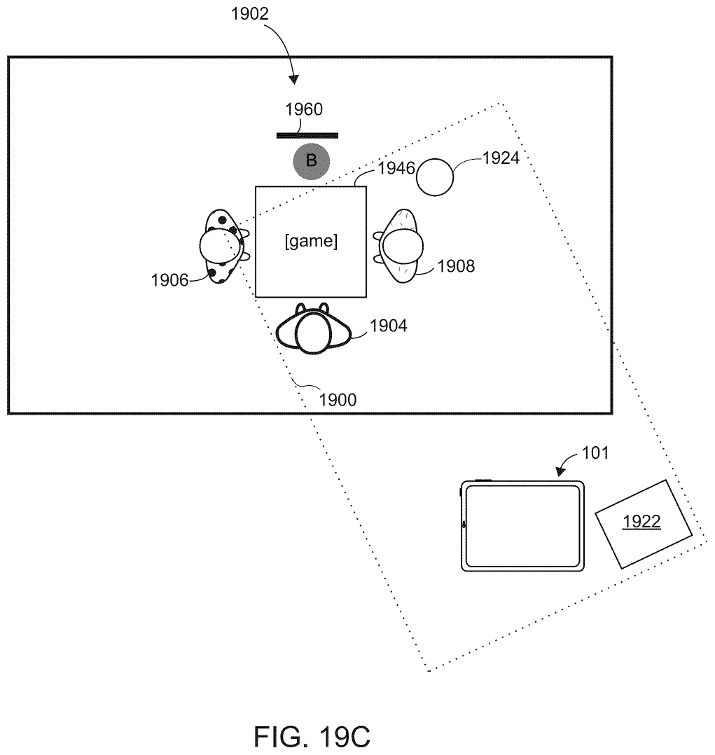

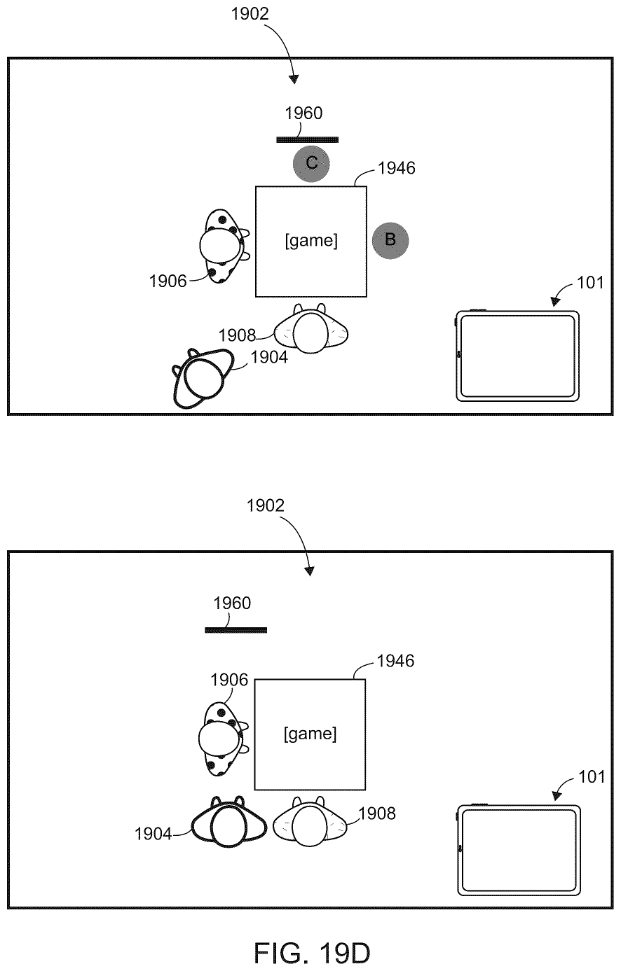

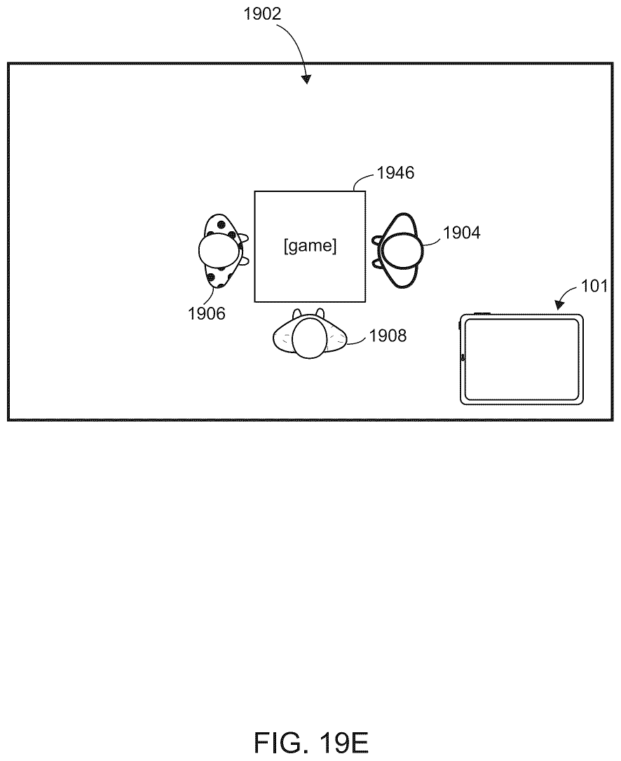

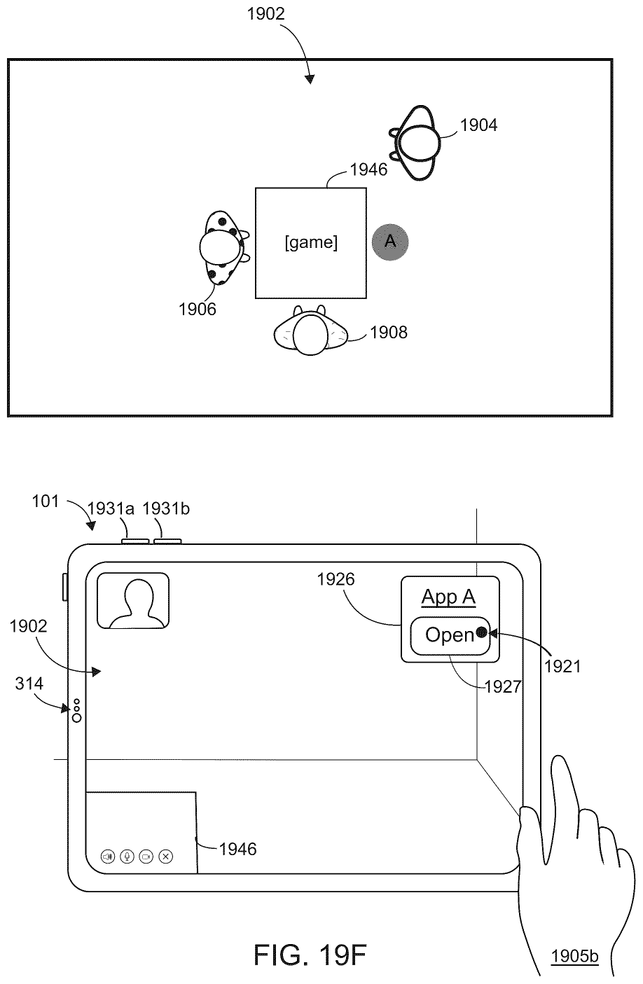

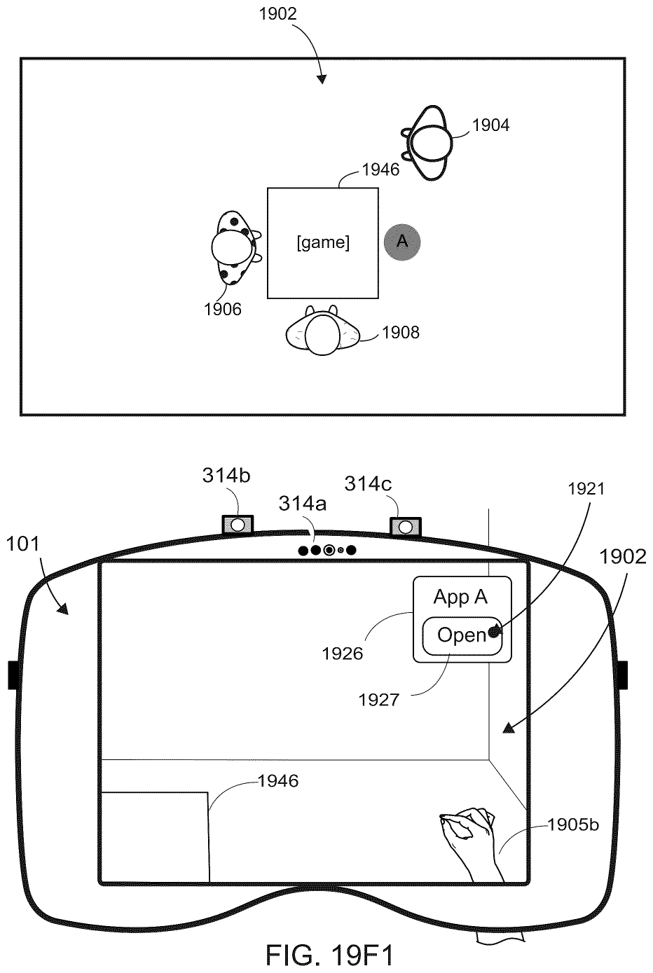

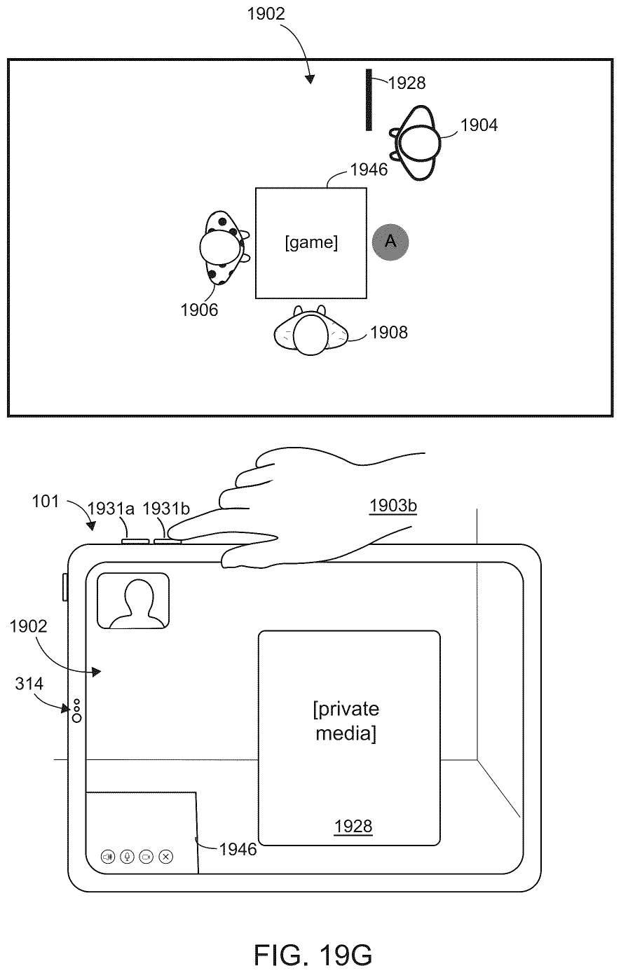

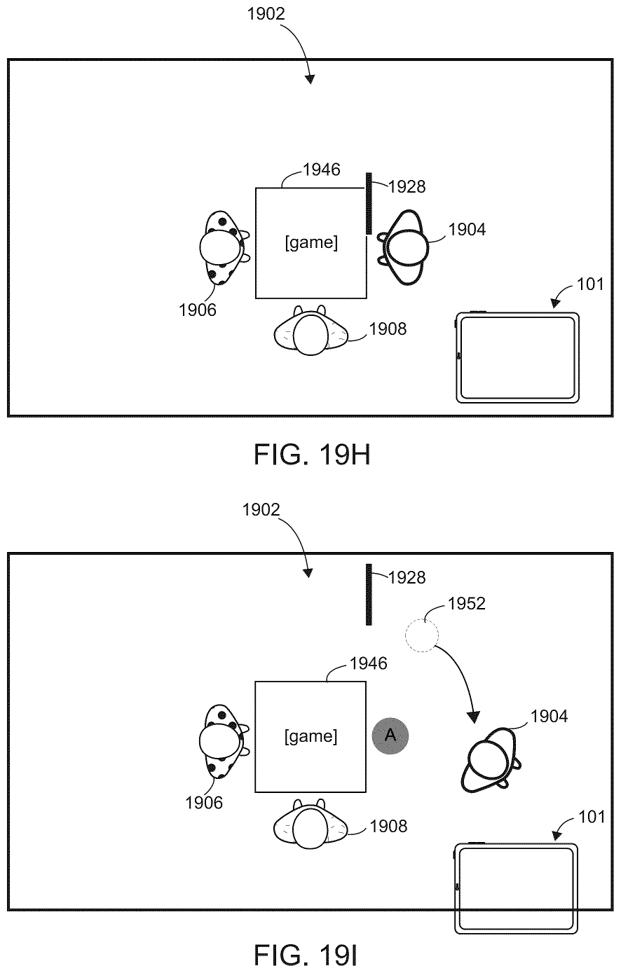

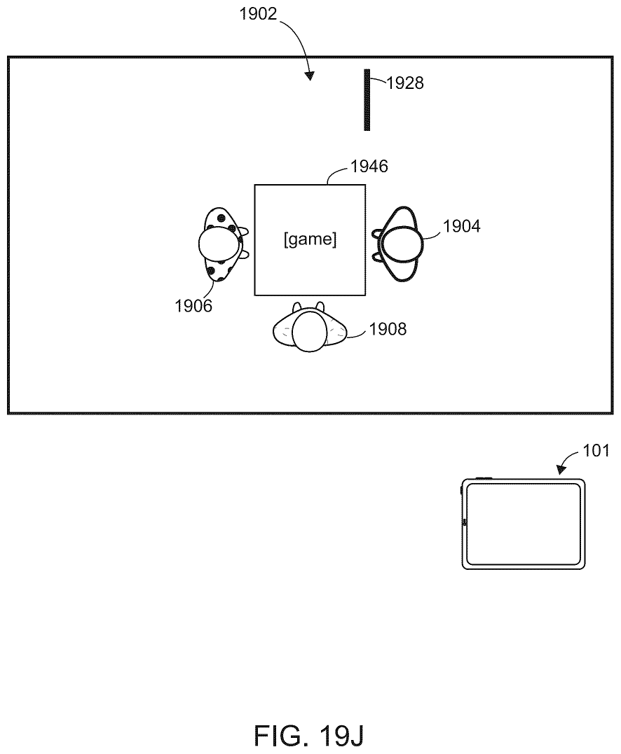

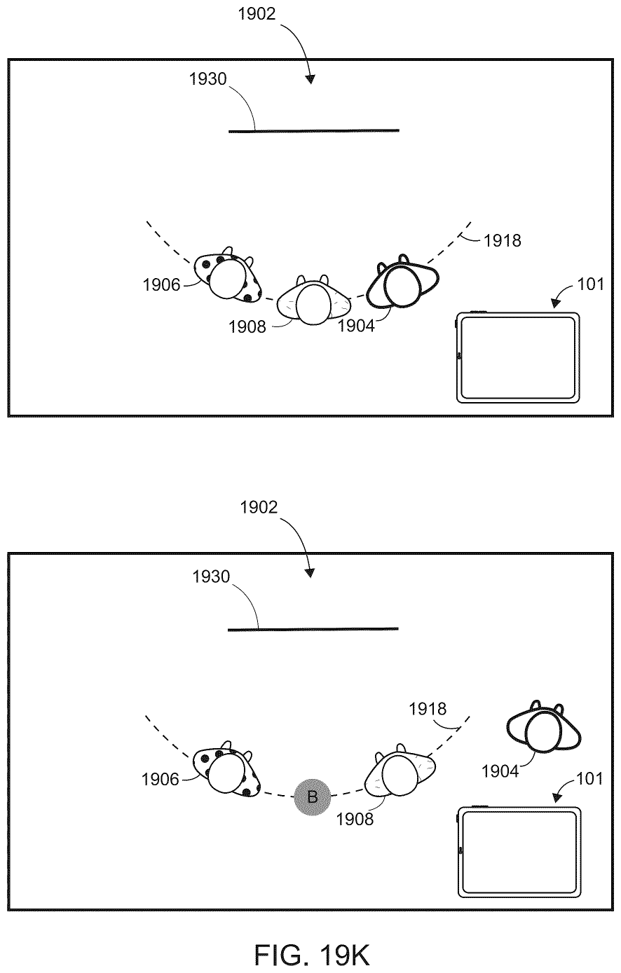

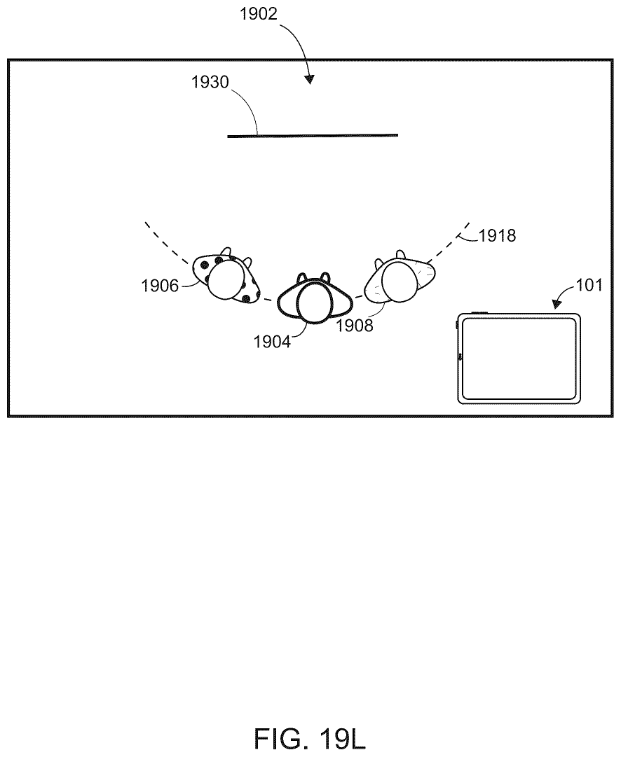

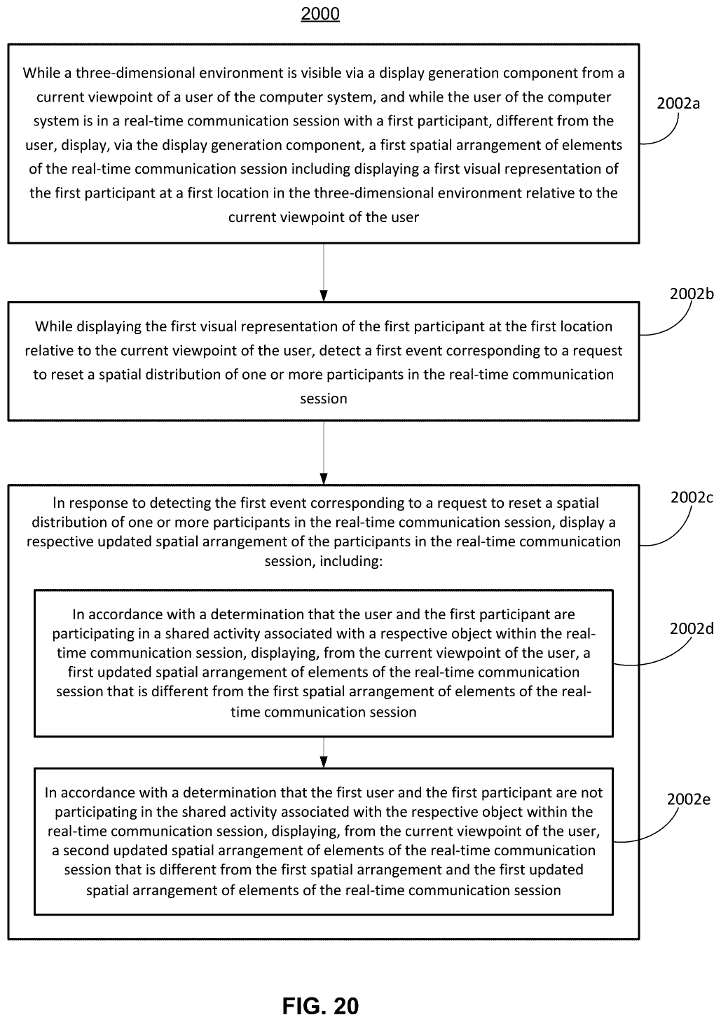

FIGS. 1A-6 provide a description of example computer systems for providing XR experiences to users (such as described below with respect to methods 800, 1000, 1200, 1400, 1600, 1800, and/or 2000). FIGS. 7A-7J illustrate examples of a computer system facilitating interaction with spatial representations of participants of a communication session, in accordance with some embodiments of the disclosure. FIG. 8 is a flow diagram is a flowchart illustrating a method of facilitating interaction with spatial representations of participants of a communication session, in accordance with some embodiments of the disclosure. The user interfaces in FIGS. 7A-7J are used to illustrate the processes in FIG. 8. FIGS. 9A-9Q illustrate example techniques for arranging representations of participants based on templates, in accordance with some embodiments. FIG. 10 depicts a flow diagram of methods of arranging representations of participants based on templates, in accordance with various embodiments. The user interfaces in FIGS. 9A-9Q are used to illustrate the processes in FIG. 10. FIGS. 11A-11Y illustrate example techniques for arranging representations of participants based on shared content. FIG. 12 depicts a flow diagram of methods of arranging representations of participants based on shared content, in accordance with various embodiments. The user interfaces in FIGS. 11A-11Y are used to illustrate the processes in FIG. 12. FIGS. 13A-1-FIG. 13L illustrate examples of a computer system updating spatial arrangements of elements of a real-time communication session based on a quantity of participants of a respective type, in accordance with some embodiments of the disclosure. FIG. 14 is a flowchart illustrating a method of updating spatial arrangements of elements of a real-time communication session based on a quantity of participants of a respective type, in accordance with some embodiments of the disclosure. FIGS. 15A-15L illustrate examples of a computer system facilitating interaction with groups of spatial representations of participants of a communication session, in accordance with some embodiments of the disclosure. FIG. 16 is a flowchart illustrating a method of facilitating interaction with groups of spatial representations of participants of a communication session, in accordance with some embodiments of the disclosure. FIGS. 17A-17P illustrate example techniques for facilitating updates of a spatial arrangement of participants in a real-time communication session in a three-dimensional environment based on a spatial distribution of the participants in accordance with some embodiments. FIG. 18 depicts a flow diagram of methods of facilitating updates of a spatial arrangement of participants in a real-time communication session in a three-dimensional environment based on a spatial distribution of the participants in accordance with some embodiments. The user interfaces in FIGS. 17A-17P are used to illustrate the processes in FIG. 18. FIGS. 19A-19L illustrate example techniques for facilitating updates of a spatial arrangement of participants in a real-time communication session in a three-dimensional environment based on shared content in accordance with some embodiments. FIG. 20 depicts a flow diagram of methods of facilitating updates of a spatial arrangement of participants in a real-time communication session in a three-dimensional environment based on shared content in accordance with some embodiments. The user interfaces in FIGS. 19A-19L are used to illustrate the processes in FIG. 20.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environement or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movment of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

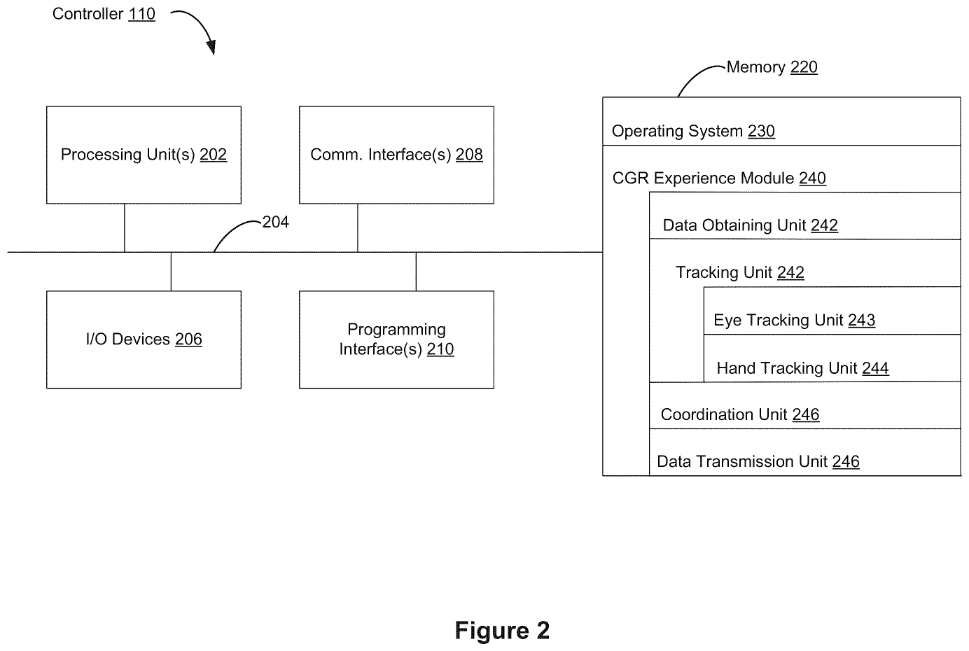

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

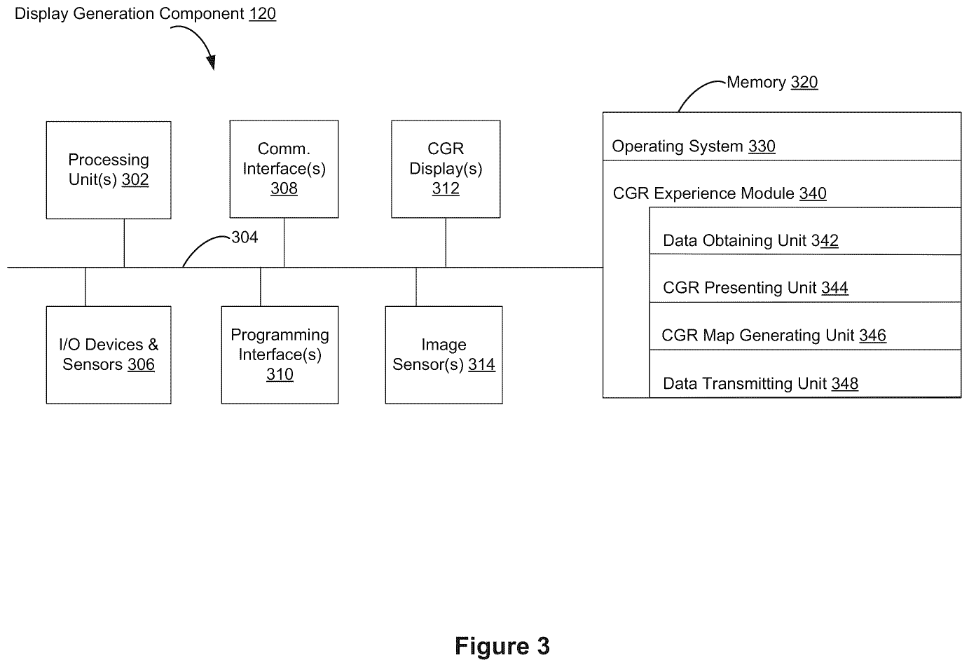

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be clastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, cither alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, cither alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 11 illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the checks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, cither alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

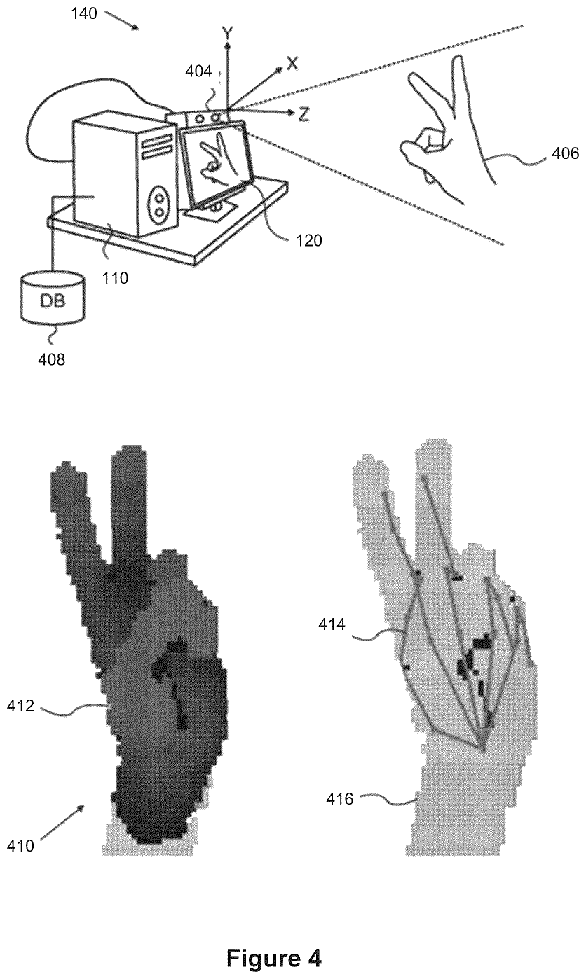

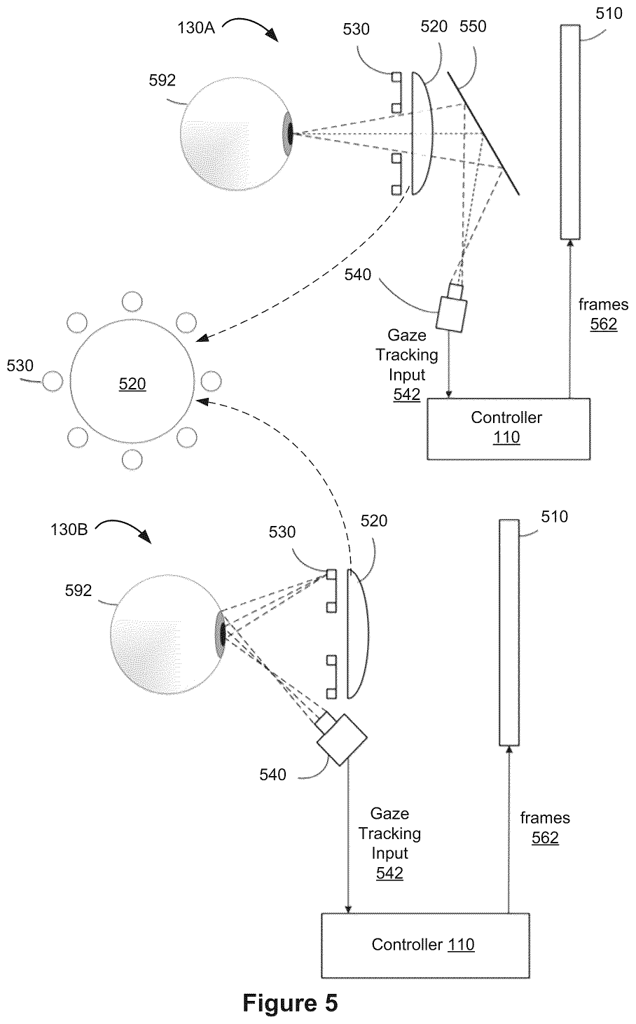

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

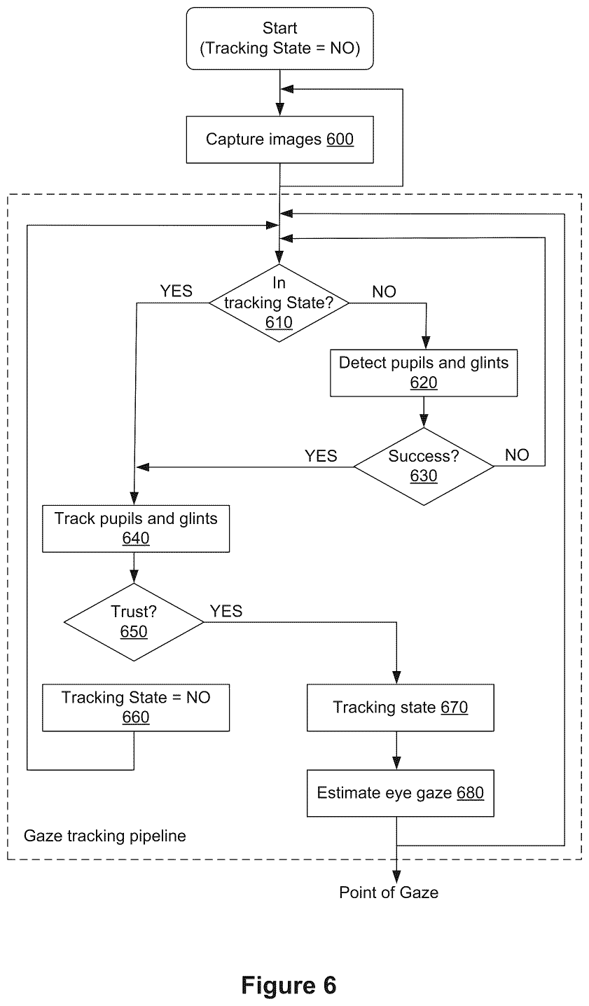

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7J illustrate examples of a computer system facilitating interaction with spatial representations of participants of a communication session, in accordance with some embodiments of the disclosure.

FIG. 7A illustrates a three-dimensional environment 702a (e.g., an AR, AV, VR, MR, or XR environment) visible via a display generation component (e.g., display generation component 120a of FIG. 1 such as a computer display, touch screen, or one or more display modules of a head mounted device) of a computer system 101a (e.g., tablet, smartphone, wearable computer, or head mounted device), the three-dimensional environment 702a visible from a viewpoint 706 of a user of computer system 101a (e.g., tablet, smartphone, wearable computer, or head mounted device) (e.g., a first viewpoint of a first participant of a communication session) illustrated in the overhead legend (e.g., facing a wall of the physical environment in which computer system 101a (e.g., tablet, smartphone, wearable computer, or head mounted device) is located). FIG. 7A also illustrates a three-dimensional environment 702b (e.g., an AR, AV, VR, MR, or XR environment) visible via a display generation component (e.g., display generation component 120b such as a computer display, touch screen, or one or more display modules of a head mounted device) of a computer system 101b (e.g., tablet, smartphone, wearable computer, or head mounted device), the three-dimensional environment 702b visible from a viewpoint 712 of a user of another computer system, other than computer system 101a (e.g., tablet, smartphone, wearable computer, or head mounted device) and computer system 101b (e.g., tablet, smartphone, wearable computer, or head mounted device) (e.g., a second viewpoint of a second participant of the communication session). As described above with reference to FIGS. 1-6, the computer system 101a (e.g., tablet, smartphone, wearable computer, or head mounted device) and/or computer system 101b (e.g., tablet, smartphone, wearable computer, or head mounted device) optionally include a display generation component 120a and/or 120b (e.g., a touch screen) and a plurality of image sensors 314a and/or 314b (e.g., image sensors 314 of FIG. 3). The image sensors optionally include one or more of a visible light camera, an infrared camera, a depth sensor, or any other sensor the computer system 101a (e.g., tablet, smartphone, wearable computer, or head mounted device) and/or computer system 101b (e.g., tablet, smartphone, wearable computer, or head mounted device) would be able to use to capture one or more images of a user or a part of the user (e.g., one or more hands of the user) while the user interacts with the computer system 101a (e.g., tablet, smartphone, wearable computer, or head mounted device) and/or computer system 101b (e.g., tablet, smartphone, wearable computer, or head mounted device). In some embodiments, the user interfaces illustrated and described below could also be implemented on a head-mounted display that includes a display generation component that displays the user interface and/or three-dimensional environment to the user, and sensors to detect the physical environment and/or movements of the user's hands (e.g., external sensors facing outwards from the user), and/or gaze of the user (e.g., internal sensors facing inwards towards the face of the user).

As shown in FIG. 7A, computer system 101a (e.g., tablet, smartphone, wearable computer, or head mounted device) captures one or more images of the physical environment around computer system 101a (e.g., tablet, smartphone, wearable computer, or head mounted device) (e.g., operating environment 100), including one or more objects in the physical environment around computer system 101. In some embodiments, computer system 101a (e.g., tablet, smartphone, wearable computer, or head mounted device) displays representations of the physical environment in three-dimensional environment 702a and/or the physical environment is visible in the three-dimensional environment 702a via the display generation component 120a. For example, three-dimensional environment 702a visible via display generation component 120a includes representations of the physical floor and back and side walls of the room in which computer system 101a (e.g., tablet, smartphone, wearable computer, or head mounted device) is located. Similarly, computer system 101b (e.g., tablet, smartphone, wearable computer, or head mounted device) optionally has one or more characteristics of computer system 101a (e.g., tablet, smartphone, wearable computer, or head mounted device). For example, computer system 101b (e.g., tablet, smartphone, wearable computer, or head mounted device) optionally captures one or more images of the physical environment where computer system 101b (e.g., tablet, smartphone, wearable computer, or head mounted device) is located. In some embodiments, computer system 101a (e.g., tablet, smartphone, wearable computer, or head mounted device) and computer system 101b (e.g., tablet, smartphone, wearable computer, or head mounted device) do not share a physical environment. For example, a physical object included in the three-dimensional environment 702a of computer system 101a (e.g., tablet, smartphone, wearable computer, or head mounted device) is not visible in the three-dimensional environment 702b of computer system 101b (e.g., tablet, smartphone, wearable computer, or head mounted device) when computer system 101a (e.g., tablet, smartphone, wearable computer, or head mounted device) and computer system 101b (e.g., tablet, smartphone, wearable computer, or head mounted device). Additionally, a computer system used by a participant having viewpoint 704, as shown in the overhead view, is optionally in a physical environment that is different from the physical environments of computer system 101a (e.g., tablet, smartphone, wearable computer, or head mounted device) and/or computer system 101b (e.g., tablet, smartphone, wearable computer, or head mounted device), and thus optionally presents visibility of physical objects in the computer system used by the participant having viewpoint 704, without presenting physical objects present in the physical environments of computer system 101a (e.g., tablet, smartphone, wearable computer, or head mounted device) and/or computer system 101b (e.g., tablet, smartphone, wearable computer, or head mounted device).

In FIG. 7A, computer system 101a (e.g., tablet, smartphone, wearable computer, or head mounted device) displays a representation of media captured by image sensors 314a, such as representation 706a, for example using a camera oriented toward the first participant that is using computer system 101a (e.g., tablet, smartphone, wearable computer, or head mounted device). Similarly, computer system 101b (e.g., tablet, smartphone, wearable computer, or head mounted device) displays a representation of media captured by image sensors 314b, such as representation 706b, for example using a camera oriented toward the third participant that is using computer system 101b (e.g., tablet, smartphone, wearable computer, or head mounted device). Such representations are optionally displayed overlaid over respective three-dimensional environments displayed at the respective computer systems, optionally concurrently with virtual content, such as virtual objects, shared virtual content, and virtual representations of participants.

In some embodiments, three-dimensional environment 702a and/or three-dimensional environment 702b also include a virtual object. In some embodiments, the virtual object is optionally a user interface of an application containing content (e.g., a plurality of selectable options), three-dimensional objects (e.g., virtual clocks, virtual balls, virtual cars, etc.) or any other element displayed by computer system 101a (e.g., tablet, smartphone, wearable computer, or head mounted device) and/or computer 101b that is not included in the physical environment of display generation component 120a and/or display generation component 120b. For example, in FIG. 7A, the virtual object is a user interface of a web-browsing application containing website content, such as text, images, video, hyperlinks, and/or audio content, from the website, or a user interface of an audio playback application including a list of selectable categories of music and a plurality of selectable user interface objects corresponding to a plurality of albums of music. It should be understood that the content discussed above is exemplary and that, in some embodiments, additional and/or alternative content and/or user interfaces are provided in the three-dimensional environment 702a and/or three-dimensional environment 702b, such as the content described below with reference to method 800.

In some embodiments, computer system 101a (e.g., tablet, smartphone, wearable computer, or head mounted device) is engaged in a communication session with computer system 101b (e.g., tablet, smartphone, wearable computer, or head mounted device), such as throughout FIGS. 7A-7J. In some embodiments, the communication session is a real-time, or nearly real-time communication session. It is understood that description of embodiments related to a real-time communication session optionally similarly apply to embodiments related to nearly real-time communication sessions, dependent upon the context of the description. In some embodiments, the real-time communication session corresponds to a real-time, or nearly real-time transmitting and/or receiving of audio detected by respective computer systems participating in the real-time communication session. In some embodiments, additional or alternative computer system participate in the real-time communication session.

In some embodiments, the real-time communication session additionally or alternatively includes a simulated sharing of a three-dimensional environment. For example, computer system 101a (e.g., tablet, smartphone, wearable computer, or head mounted device) and computer system 101b (e.g., tablet, smartphone, wearable computer, or head mounted device) optionally present views of a shared three-dimensional environment, similar to as if computer system 101a (e.g., tablet, smartphone, wearable computer, or head mounted device) and computer system 101b (e.g., tablet, smartphone, wearable computer, or head mounted device) were in a same physical space, by presenting a view of virtual content from respective perspectives as if computer system 101a (e.g., tablet, smartphone, wearable computer, or head mounted device) and computer system 101b (e.g., tablet, smartphone, wearable computer, or head mounted device) were positioned and oriented relative to a shared physical environment. To mimic a physical sharing of environments, a respective computer system participating in the real-time communication session optionally determines a range of positions relative to a viewpoint of the respective computer system. While participating in the communication session, respective computer systems optionally exchange information to map the range of positions of the respective computer systems to a range of positions included in a shared, simulated three-dimensional environment, thus providing a correspondence between the physical environment of the respective computer systems and the shared three-dimensional environment. During the real-time communication session, a respective computer system is optionally assigned to a first position having a first orientation relative to the range of simulated positions in the shared three-dimensional environment. In response to detecting a changing of a viewpoint of the computer system (e.g., due to physical movement of the computer system relative to its physical environment, due to virtual movement of the computer system requesting an updating of the position and/or orientation that the respective computer system is assigned relative to the three-dimensional environment, and/or a requesting of an updated arrangement of the elements of the real-time communication session), the computer system optionally communicates and/or is assigned an updated, second position and/or orientation relative to the shared three-dimensional environment. In this way, in response to detecting a changing of viewpoint of a respective computer system, other computer systems participating in the real-time communication session are optionally provided an understanding of the position and/or orientation of the viewpoints corresponding to the respective computer system relative to the shared three-dimensional environment, thus optionally synchronizing an understanding of the viewpoints corresponding to computer systems of the real-time communication session to the shared three-dimensional environment. Some embodiments of the disclosure reference a changing of a viewpoint relative to a shared three-dimensional environment; it is understood that the changing of the viewpoint of a computer system relative to the shared three-dimensional environment optionally includes detecting a changing of the viewpoint relative to its visible three-dimensional environment (including a physical environment), and consequentially, the changing of the viewpoint assigned to the computer system relative to the shared three-dimensional environment. Some embodiments of the disclosure discuss threshold distances and/or angles between the viewpoint of the user and/or visual representations of participants. It is understood that in such embodiments, the threshold distances optionally refer to simulated threshold distances, such as threshold measured relative to the shared three-dimensional environment and the positions and/or orientations of viewpoints of computer systems assigned to the shared three-dimensional environment; similarly, the threshold angles refer to simulated angles based on angles drawn (and optionally not displayed) between vectors (also optionally not displayed) extending between the positions and/or angles of the viewpoints of computer system relative, between the positions and/or angles of content, and/or between viewpoints and positions and/or orientations of visual representations of participants relative to the shared three-dimensional environment.

Some embodiments of the disclosure reference virtual content (e.g., representations of shared media, visual representations of participants, and/or virtual objects) being displayed and/or moved in a first three-dimensional environment of a respective first computer system of a real-communication session (e.g., computer system 101a (e.g., tablet, smartphone, wearable computer, or head mounted device) presenting three-dimensional environment 702a), and describe that corresponding virtual content is displayed and/or moved in a second three-dimensional environment of a respective second computer system of the real-time communication session (e.g., computer system 101b (e.g., tablet, smartphone, wearable computer, or head mounted device) presenting three-dimensional environment 702b); it is understood that such display and movement is optionally based on the correspondence between respective three-dimensional environments of the computer systems and the shared three-dimensional environment. Additionally or alternatively, it is understood that operations performed at computer system 101a (e.g., tablet, smartphone, wearable computer, or head mounted device) and/or computer system 101b (e.g., tablet, smartphone, wearable computer, or head mounted device) while engaged in a real-time communication session, such as operations to display and/or move virtual content, update a viewpoint of a computer system, and/or update a visual representation of a participant in accordance with an updating of the viewpoint of the computer system corresponding to the participant, are optionally are performed at additional or alternative computer systems participating in the real-time communication session, and optionally concurrently, such as the third computer system corresponding to the third participant represent by viewpoint 704 in the overhead view.

In FIG. 7A, three-dimensional environment 702a includes one or more visual representations of participants that are participating in the communication session between computer system 101a (e.g., tablet, smartphone, wearable computer, or head mounted device) and computer system 101b (e.g., tablet, smartphone, wearable computer, or head mounted device). It is understood that dependent upon context of description, “participant” optionally refers to a visual representation of a participant displayed at a respective computer system, in addition to or in the alternative of the physical user that is using a computer system corresponding to the visual representation of the participant. For example, computer system 101a (e.g., tablet, smartphone, wearable computer, or head mounted device) displays a representation 704a of a third participant, corresponding to a user of a computer system other than computer system 101a (e.g., tablet, smartphone, wearable computer, or head mounted device) and computer system 101b (e.g., tablet, smartphone, wearable computer, or head mounted device) (e.g., a third participant using a third computer system to participate in the communication session with computer system 101a (e.g., tablet, smartphone, wearable computer, or head mounted device) and computer system 101b (e.g., tablet, smartphone, wearable computer, or head mounted device)). Representation 704a optionally corresponds to an expressive representation, optionally anthropomorphic (e.g., shaped like a human), and/or having one or more portions that move relative to one another such as limbs of an animal-based avatar. In some embodiments, representation 704a is displayed with an orientation relative to viewpoint 706. For example, the torso and head of representation 704a is facing toward the viewpoint 706, such as if the third participant were standing in front of the first participant that is using computer system 101a (e.g., tablet, smartphone, wearable computer, or head mounted device).

At computer system 101b (e.g., tablet, smartphone, wearable computer, or head mounted device), viewpoint 712 corresponding to the viewpoint of the second participant observing a representation 706b of the first participant and representation 704b of the third participant is displayed within three-dimensional environment 702b. As shown in the overhead view, viewpoint 712 is oriented toward, and includes a portion of a shared three-dimensional environment including representation 706b of the first participant and representation 704b of the third participant, facing one another. In some embodiments, representation 704b and representation 706b are displayed with the first visual appearance, similar or the same to the representation 704a. In some embodiments, representation 704b and representation 706b are displayed overlaid over representations of the physical environment of the second participant (e.g., a user of computer system 101b (e.g., tablet, smartphone, wearable computer, or head mounted device)). In some embodiments, representation 704b and 706b are additionally or alternatively overlaid over an at least partially immersive virtual environment, such as an immersive beach, an immersive forest, and/or an immersive campground, such as a shared immersive virtual environment that is shared between participants of the communication session including computer system 101a (e.g., tablet, smartphone, wearable computer, or head mounted device) and computer system 101b (e.g., tablet, smartphone, wearable computer, or head mounted device).

Turning back to computer system 101a (e.g., tablet, smartphone, wearable computer, or head mounted device), in some embodiments, computer system 101a (e.g., tablet, smartphone, wearable computer, or head mounted device) displays one or more portions of representation 704a with a first visual appearance. The first visual appearance optionally corresponds to a first level of opacity, saturation, brightness, form and/or spatial profile of the one or more portions, and/or other visual characteristics described further with reference to method 800. In some embodiments, computer system 101a (e.g., tablet, smartphone, wearable computer, or head mounted device) displays the portion(s) of representation 704a with the first appearance in accordance with a determination that representation 704a is not within one or more thresholds 710 determined relative to viewpoint 706 of the first participant. For example, computer system 101a (e.g., tablet, smartphone, wearable computer, or head mounted device) determines one or more thresholds, such as a range of threshold distances (described further with reference to method 800), optionally corresponding to a range of distances that comport with a set of cultural norms and/or expressly defined user settings.

In some embodiments, thresholds 710 include a plurality of thresholds. For example, threshold 710-1 is an outermost threshold relative to viewpoint 706 of the first participant (as compared to other thresholds included in thresholds 710), threshold 710-3 is an innermost threshold relative to viewpoint 706, and threshold 710-2 is a threshold intermediate to threshold 710-1 and threshold 710-3. In some embodiments, in accordance with a determination that a portion of another participant, such as representation 704a, is within thresholds 710, the computer system 101a (e.g., tablet, smartphone, wearable computer, or head mounted device) displays the portion and/or additional portions of the other participant with an updated visual appearance, as described further with reference to FIG. 7C. In FIG. 7A, an overhead view is presented, illustrating thresholds 710, viewpoint 706 of the first participant, viewpoint 712 of the second participant, and viewpoint 704 of the first participant, as seen from above the participants relative to the shared three-dimensional environment. Additionally, a profile view similar or the same to the viewpoint 712 of the second participant is presented, including viewpoint 706 of the first participant and viewpoint 704 of the third participant relative to the shared three-dimensional environment. In the profile view, the height of thresholds 710 are illustrated relative to a floor of the shared three-dimensional environment. Additionally, audio 714 corresponds to a position of a simulated audio source, providing audio detected and communicated by the computer system of the third participant having viewpoint 704. In some embodiments, computer system 101a (e.g., tablet, smartphone, wearable computer, or head mounted device) and/or computer system 101b (e.g., tablet, smartphone, wearable computer, or head mounted device) detect and/or generate audio with one or more characteristics to emulate the effect of the third participant placed in the shared three-dimensional environment with the first and/or the second participant, speaking from the position indicated by audio 714. In some embodiments, characteristics of the audio are changed to emulate the directional effect of a physical speaker placed at audio indicator 714 and oriented toward viewpoint 706 of the first participant, described further with reference to method 800.

FIG. 7A1 illustrates similar and/or the same concepts as those shown in FIG. 7A (with many of the same reference numbers). It is understood that unless indicated below, elements shown in FIG. 7A1 that have the same reference numbers as elements shown in FIGS. 7A-7J have one or more or all of the same characteristics. FIG. 7A1 includes computer system 101a, which includes (or is the same as) display generation component 120a. In some embodiments, computer system 101a and display generation component 120a have one or more of the characteristics of computer system 101 shown in FIGS. 7A-7J and display generation component 120 shown in FIGS. 1 and 3, respectively, and in some embodiments, computer system 101 and display generation component 120 shown in FIGS. 7A-7J have one or more of the characteristics of computer system 101a and display generation component 120a shown in FIG. 7A1.

In FIG. 7A1, display generation component 120a includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120a to enable eye tracking of the user's left and right eyes. Display generation component 120a also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 7A-7J.

In FIG. 7A1, display generation component 120a is illustrated as displaying content that optionally corresponds to the content that is described as being displayed and/or visible via display generation component 120 with reference to FIGS. 7A-7J. In some embodiments, the content is displayed by a single display (e.g., display 510 of FIG. 5) included in display generation component 120a. In some embodiments, display generation component 120a includes two or more displays (e.g., left and right display panels for the left and right eyes of the user, respectively, as described with reference to FIG. 5) having displayed outputs that are merged (e.g., by the user's brain) to create the view of the content shown in FIG. 7A1.

Display generation component 120a has a field of view (e.g., a field of view captured by external image sensors 314b and 314c and/or visible to the user via display generation component 120a) that corresponds to the content shown in FIG. 7A1. Because display generation component 120a is optionally a head-mounted device, the field of view of display generation component 120a is optionally the same as or similar to the field of view of the user.

In some embodiments, computer system 101a responds to user inputs as described with reference to FIGS. 7A-7J.

It is understood than one or more or all aspects of the present disclosure as shown in, or described with reference to FIGS. 7A-7J and/or described with reference to the corresponding method(s) are optionally implemented on computer system 101a and display generation unit 120a in a manner similar or analogous to that shown in FIG. 7A1.

From FIG. 7A to FIG. 7B, the third computer system detects a change in viewpoint of the third participant moving closer to viewpoint 706 of the first user, and communicates information associated with the change in viewpoint to communication session participants. For example, computer system 101a (e.g., tablet, smartphone, wearable computer, or head mounted device) and/or computer system 101b (e.g., tablet, smartphone, wearable computer, or head mounted device) optionally detect an indication of the change in viewpoint, and respectively display representation 704a and representation 704b at updated positions relative to the shared three-dimensional environment. For example, the third computer system optionally communicates a magnitude and/or direction of movement relative to the shared three-dimensional environment moving straight towards viewpoint 706 of the first participant; in response to detecting an indication of the magnitude and/or direction, computer system 101a (e.g., tablet, smartphone, wearable computer, or head mounted device) displays representation 704b at a relatively closer position, as if the third participant were physically walking toward viewpoint 706. Similarly, computer system 101b (e.g., tablet, smartphone, wearable computer, or head mounted device) optionally moves representation 704b leftward, corresponding to as if the third participant were physically walking toward the third participant as observed from viewpoint 712 of the second participant. In FIG. 7B, the representations of the third participant (e.g., representations 704a and 704b) are displayed with the first visual appearance, the same as the representations were displayed in FIG. 7A.

From FIG. 7B to FIG. 7C, the third computer system detects movement of an arm of the third participant to a position that is within threshold 710 of the viewpoint 706 of the first participant. In some embodiments, in response to obtaining information indicating that the hand 716a of representation 704a corresponds to an updated position (e.g., from the third computer system), and in accordance with a determination that the updated position of the arm is within threshold 710-1, computer system 101a (e.g., tablet, smartphone, wearable computer, or head mounted device) displays the hand 716a with a second visual appearance, different from the first visual appearance, indicating that the hand 716a is relatively too close to viewpoint 706 in view of the set of cultural norms of the first participant in FIG. 7C. For example, displaying hand 716a with the second visual appearance includes displaying hand 716a with a relatively lower level of opacity, saturation, brightness, with an increased level of blurring effect and/or with a border, as described with reference to method 800. In some embodiments, in accordance with a determination that portions of the representation 704a are not within threshold 710-1, computer system 101a (e.g., tablet, smartphone, wearable computer, or head mounted device) maintains display of such portions with the first visual appearance.

At computer system 101b (e.g., tablet, smartphone, wearable computer, or head mounted device) in FIG. 7C, in response to obtaining the information indicating that the hand 716a of representation 704a corresponds to the updated position within threshold 710-1 of viewpoint 706, computer system 101b (e.g., tablet, smartphone, wearable computer, or head mounted device) displays the hand 716b with the second visual appearance, similar to as described with reference to hand 716a. In some embodiments, thresholds 710 and/or threshold 710-1 are associated with a portion of a representation of the first participant, such as a head 718b of representation 706b. For example, thresholds 710 and/or threshold 710-1 optionally correspond to a range of positions measured relative to head 718b of representation 706b, corresponding to the current viewpoint 706 of the first participant in FIG. 7C. In some embodiments, threshold 710-1 is a non-uniform range of positions. For example, the range of positions relatively in front of viewpoint 706 of the first participant are optionally less in magnitude that the range of positions relatively to the side and/or behind viewpoint 706 of the first participant. Thus, threshold 710-1 is optionally analogous to an asymmetrical bubble surrounding viewpoint 706 as illustrated in FIG. 7C. In some embodiments, to convey that hand 716b is within threshold 710-1 of head 718b of representation 706b, computer system 101b (e.g., tablet, smartphone, wearable computer, or head mounted device) displays head 718b with an updated visual appearance in FIG. 7C. For example, computer system 101b (e.g., tablet, smartphone, wearable computer, or head mounted device) optionally displays the head 718b with the second visual appearance, optionally the same as the visual appearance of hand 716b. Thus, from the viewpoint 712 of the second participant, the proximity between hand 716b and head 718b is visually emphasized. In FIG. 7C, audio indicator 714 continues to correspond to a position of a head of representation 704b.

From FIG. 7C to FIG. 7D, the third computer system detects movement of the third participant such that a position of multiple portions of the representation of the third participant are within the thresholds 710 of the first participant having viewpoint 706. For example, in the overhead view in FIG. 7D, hand 716 (e.g., hand 716a) is within threshold 710-2 of viewpoint 706 of the first participant, and additionally, a portion of the torso of the third participant (e.g., portion 720a) is within threshold 710-1 of viewpoint 706, similar to as displayed in computer system 101a (e.g., tablet, smartphone, wearable computer, or head mounted device). At computer system 101a (e.g., tablet, smartphone, wearable computer, or head mounted device) in FIG. 7D, hand 716a is optionally displayed with a third visual appearance, different from the first visual appearance and the second visual appearance, to convey that hand 716a is within threshold 710-2 relative to viewpoint 706. As described further with reference to method 800, hand 716a is optionally displayed with a relatively decreased level of visual prominence relative to three-dimensional environment 702a, compared to the visual appearance of hand 716 in FIG. 7C, such as with a further reduced level of opacity, saturation, brightness, with a further increased level of blurring effect, and/or without a border. In some embodiments, computer system 101a (e.g., tablet, smartphone, wearable computer, or head mounted device) ceases display of hand 716a when moved within threshold 710-2, such as in FIG. 7D. In FIG. 7D, portion 720a of representation 704a is displayed with the second visual appearance that was described previously, and/or another visual appearance different from the third visual appearance to convey that the portion 720a of representation 704a is within the threshold 710-1. In some embodiments, portions of representation 704a not within thresholds 710 are displayed with a maintained visual appearance, such as the first visual appearance. In some embodiments, in accordance with a determination that a particular portion of representation 704a such as a head of representation 704a is within thresholds 710, computer system 101a (e.g., tablet, smartphone, wearable computer, or head mounted device) displays other portions of representation 704a with the visual appearance of the particular portion. For example, as shown in the overhead view in FIG. 7D, the head corresponding to representation 704a is within threshold 710-1; accordingly, computer system 101a (e.g., tablet, smartphone, wearable computer, or head mounted device) optionally displays some or all remaining portions of representations 704a with the visual appearance of the head (e.g., the second visual appearance), except the portions of representation 704a that are within the threshold 710-2 (e.g., with the third visual appearance) and/or threshold 710-3 (e.g., with a fourth visual appearance). At computer system 101b (e.g., tablet, smartphone, wearable computer, or head mounted device), similar to as described with reference to computer system 101a (e.g., tablet, smartphone, wearable computer, or head mounted device), hand 716b is displayed with the third visual appearance (e.g., is no longer displayed, or reduced in visual prominence relative to the second visual appearance), and portion 720b of representation 704b is optionally displayed with the third visual appearance. To indicate that hand 716b is moved within threshold 710-2 of head 718b, computer system 101b (e.g., tablet, smartphone, wearable computer, or head mounted device) optionally displays head 718b with the third visual appearance (e.g., ceases display of head 718b, and/or reduces visual prominence of head 718b) in FIG. 7D.

From FIG. 7D to FIG. 7E, the third computer system detects movement of the third participant such that a position of head of the third participant is within the threshold 710-2 of viewpoint 706 of the first participant. In some embodiments, in accordance with a determination that the position of the head of the user is within threshold 710-2, as illustrated in the overhead view in FIG. 7E, computer system 101a (e.g., tablet, smartphone, wearable computer, or head mounted device) replaces display of an expressive representation 704a with a non-expressive representation, such as a representation 722a that is optionally a polygonal shape. In some embodiments, representation 722a is displayed at a position relative to three-dimensional environment 702a corresponding to a position of a particular portion (e.g., a head) of the viewpoint 704 of the third participant. In some embodiments, a portion of representation 722a includes respective information, indicating an orientation of the third participant relative to three-dimensional environment 702a. For example, representation 722a is optionally a rectangular prism, including a first face that includes an icon, text, and/or video corresponding to the third participant.

In some embodiments, due to the movement of a particular portion (e.g., a head) of the third participant to within threshold 710-2, the computer system 101a (e.g., tablet, smartphone, wearable computer, or head mounted device) and computer system 101b (e.g., tablet, smartphone, wearable computer, or head mounted device) changes the visual appearance of the visual representation of the third participant, including replacing of the form of the representation 704a and/or representation 704b with representation 722a and representation 722b, respectively such as in FIG. 7E. In some embodiments, in accordance with a determination that an alternative portion of the third participant (e.g., the hand) moves within threshold 710-2, as described previously, the computer system changes the visual appearance of the alternative portion, while maintaining a form of the representation 704a and/or 704b.

In some embodiments, representation 722a is relatively more abstract and/or not as expressive as representation 704a, such that one or more portions of representation 722a are fixed relative to one another. For example, in FIG. 7E, although representation 704b—optionally not displayed—has a posture including a downward tilting of the head corresponding to a physical posture of the physical third participant, computer system 101b (e.g., tablet, smartphone, wearable computer, or head mounted device) displays representation 722b with a fixed position and/or orientation, not displaying visual feedback that the head and/or neck of the third participant is physically bending, beyond optionally moving the position and/or orientation of representation 722b in its entirety. In some embodiments, representation 722a and representation 722b are displayed indicating an orientation and/or height relative to a floor of three-dimensional environment 702a and three-dimensional environment 702b of the third participant. For example, at computer system 101a (e.g., tablet, smartphone, wearable computer, or head mounted device), a face of representation 722a with a largest surface area is displayed oriented toward viewpoint 706 of the first participant. In some embodiments, the face includes information, graphics, and/or video representative of the first participant. At computer system 101b (e.g., tablet, smartphone, wearable computer, or head mounted device), the face with the largest surface area is displayed oriented toward viewpoint 706. Thus, due to the viewpoint 712 of the second participant observing a profile view of viewpoint 706 of the first participant in close proximity with viewpoint 704 of the third participant, computer system 101b (e.g., tablet, smartphone, wearable computer, or head mounted device) displays a profile of the representation 722b, such as a second face having a relatively smaller surface area on the side of the rectangular prism-shaped visual representation.

In some embodiments, in accordance with a determination that the particular portion of the third participant is within threshold 710-2 of viewpoint 706 of the first user, computer system 101b (e.g., tablet, smartphone, wearable computer, or head mounted device) replaces display of representation 706b of the first participant with representation 724b. In some embodiments, representation 724b has one or more characteristics of representation 722b, such as having an abstracted and/or non-expressive form, and/or having a position and/or orientation relative to the three-dimensional environment representation of the position and/or orientation of the viewpoint 706 of the first participant.

In some embodiments, representation 722a and/or representation 722b includes information accompanying and/or identifying the third participant. For example, in FIG. 7E representation 722a is displayed concurrently with information 723a and representation 722b is displayed concurrently with information 723b. In some embodiments, the information includes a name of the third participant, a communication address (e.g., e-mail) associated with the third participant, an identifier such as a screen name associated with the third participant, a nickname associated with the third participant, initials of the third participant, and/or additional or alternative information described with reference to method 800. In some embodiments, the information is displayed at an angle relative to a computer system viewpoint (e.g., perpendicular to such viewpoint) such that the information is able to be seen, independently of an orientation of a corresponding visual representation of the participant, such as the face of the rectangular prisms described previously.

In some embodiments, computer system 101a (e.g., tablet, smartphone, wearable computer, or head mounted device) and/or computer system 101b (e.g., tablet, smartphone, wearable computer, or head mounted device) change one or more characteristics of the audio presented corresponding to the third participant, to emulate the effect of a sound source providing the audio moving to a modified position. For example, the computer systems optionally change characteristics of the audio, such that the audio is perceived by a user of a computer device as if emanating from a position outside the thresholds 710. For example, because the particular portion (e.g., head) of the third participant is within threshold 710-2 in FIG. 7E, the computer system moves audio 714 to an updated position that is different from the viewpoint 704 of the third participant (e.g., away from the head of the third participant). In some embodiments, the perceived movement of the audio source is moved along a first dimension relative to the shared three-dimensional environment (e.g., vertically, above the head of the third participant), such as to a simulated threshold distance outside of thresholds 710 (e.g., 0.01, 0.05 0.1, 0.5, 1, 1.5, 2, or 3 m) as shown in FIG. 7E.

From FIG. 7E to FIG. 7F, the third computer system detects movement of the third participant such that a position of hand of the third participant is within the threshold 710-3 of viewpoint 706 of the first participant. In some embodiments, in accordance with a determination that a respective portion of the user is within threshold 710-3, computer system 101a (e.g., tablet, smartphone, wearable computer, or head mounted device) and computer system 101b (e.g., tablet, smartphone, wearable computer, or head mounted device) changes a visual appearance of the visual representation of the third participant, such as ceasing display of the visual representation of the third participant as shown in FIG. 7F. For example, representation 704a and representation 704b, and representation 722a, representation 722b, and representation 724b are optionally not displayed in FIG. 7F. In some embodiments, information 723b and information 725b continue to be displayed while other visual representation of the third participant are not displayed, such as in FIG. 7F. In some embodiments, in accordance with a determination that any portion of the third participant is moved within the threshold 710-3 (e.g., the head, the hand, and/or the torso), the computer system 101a (e.g., tablet, smartphone, wearable computer, or head mounted device) and computer system 101b (e.g., tablet, smartphone, wearable computer, or head mounted device) ceases display of the avatars corresponding to the third participant. As shown in the profile view in FIG. 7F audio 714 is moved (e.g., further upwards relative to the floor of the shared three-dimensional environment) in accordance with an updated position of the head of the third participant.

From FIG. 7F to FIG. 7G, viewpoint 706 of the first participant changes relative to the shared three-dimensional environment and three-dimensional environment 702a (e.g., an AR, AV, VR, MR, or XR environment). For example, at computer system 101a (e.g., tablet, smartphone, wearable computer, or head mounted device), a visual representation of the third participant is not displayed based on the viewpoint 704 of the third participant no longer being within a field of view corresponding to the viewpoint 706 of the first participant in FIG. 7G. In particular, in FIG. 7G, viewpoint 704 of the third participant corresponds to a range of positions within a portion of thresholds 710 that are relatively behind viewpoint 706 of the first participant. At computer system 101b (e.g., tablet, smartphone, wearable computer, or head mounted device), information 723b and information 725b are moved to updated position in accordance with movement of viewpoint 706, and other visual representations (e.g., expressive avatars, polygonal avatars) are not displayed in accordance with a determination that the third participant is at least partially within threshold 710-3 (e.g., viewpoint 704 of the third participant, and/or a portion of the third participants body relative to viewpoint 704) in FIG. 7G. In some embodiments, in accordance with a determination that a respective representation of a respective participant is not displayed and/or will not be displayed, a respective computer system additionally forgoes display of respective information (e.g., information 723b and information 725b). In FIG. 7G, audio 714 is modified to emulate a corresponding audio source moved above the viewpoint 704 of the third participant. In some embodiments, the audio 714 is modified to emulate a sound source hovering a distance (e.g., 0.1, 0.25, 0.5, 0.75, 1, 1.25, or 1.5 m) above thresholds 710, such as vertically elevated above a position of viewpoint 704 (e.g., gradually elevating and/or descending to remain the distance above thresholds 710).

From FIG. 7G to FIG. 7H, the third computer system detects movement of the third participant outside of threshold 710-3, as shown in the overhead view. In accordance with a determination that viewpoint 704 corresponds to threshold 710-2 and not within threshold 710-3, computer system 101b (e.g., tablet, smartphone, wearable computer, or head mounted device) displays the representation 722b alongside information 723b and representation 724b alongside information 725b again, similar to as described previously. In FIG. 7H, characteristics of audio 714 are changed to emulate a corresponding audio source placed at the head of the third participant, in accordance with a determination that the head of the third participant is not within thresholds 710.

From FIG. 7H to FIG. 7I, viewpoint 706 of the first participant and viewpoint 704 of the third participant are changed, such that representation 706b and representation 704b are facing one another. In FIG. 7I-7J, thresholds 710 have a relatively different spatial profile, correspond to different threshold distances, and/or have a different respective spacing than thresholds 710 illustrated in FIGS. 7A-7H. In some embodiments, the thresholds 710 have one or more characteristics of thresholds 711. In some embodiments, thresholds 711 have one or more characteristics of thresholds 710. For example, the visual treatments described and illustrated with reference to FIGS. 7A-7H and thresholds 710 are optionally performed in accordance with a determination that the third participant is within the thresholds 711 of the first participant. Additionally or alternatively, the relative dimensions, spatial profile, and/or relative separation of thresholds 710 optionally are similar or the same to the relative dimensions, spatial profile, and/or relative separation of thresholds 711.

In some embodiments, the threshold distances defining thresholds 711 are relatively smaller than a length of an arm of a participant of the communication session. For example, computer system 101a (e.g., tablet, smartphone, wearable computer, or head mounted device), displays a representation 706a of a hand of the first participant extending toward representation 704a. As shown in the overhead view, the hand of the first participant corresponding to viewpoint 706 extends outside of thresholds 711, toward viewpoint 704 of the third participant. Computer system 101b (e.g., tablet, smartphone, wearable computer, or head mounted device), corresponding to a viewpoint (e.g., viewpoint 712 of the second participant described previously), presents a view of representation 706b corresponding to the first participant extending a hand outward toward representation 704b. In FIG. 7I, audio 714 is presented corresponding to a position of viewpoint 704 (e.g., the head of the third participant), and representations 704a, 704b, and 706b are displayed with the first visual appearance described previously (e.g., with a nominal level of opacity, brightness, saturation, without a blurring effect, and/or without a border).

From FIG. 7I to FIG. 7J, computer system 101a (e.g., tablet, smartphone, wearable computer, or head mounted device) and computer system 101b (e.g., tablet, smartphone, wearable computer, or head mounted device) detect the hand of the first and the third participants engage in a simulated handshake. For example, the hand of the third participant and the hand 706a of the first participant are moved to correspond to a similar and/or same set of positions within the shared three-dimensional environment, similar to a physical handshake of the first participant and the third participants physical hands. In some embodiments, the computer systems display expressive visual feedback indicating that a simulated handshake is detected. For example, indication 728a and indication 728b are displayed, including an animated flashing of simulated light, several lines emanating from the representations of hands meeting, and/or text describing a “high-five” and/or a “handshake.” In some embodiments, based on viewpoint 704 and/or the third participant remaining outside of thresholds 711, computer system 101a (e.g., tablet, smartphone, wearable computer, or head mounted device) and computer system 101b (e.g., tablet, smartphone, wearable computer, or head mounted device) maintain display of the representations 704a, 704b, and 706b with the first visual appearance described previously (e.g., with a nominal level of opacity, brightness, saturation, without a blurring effect, and/or without a border).

FIG. 8 is a flowchart illustrating a method of facilitating interaction with spatial representations of participants of a communication session, in accordance with some embodiments of the disclosure. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, method 800 is performed at a first computer system, such as computer system 101a (e.g., tablet, smartphone, wearable computer, or head mounted device) in FIGS. 7A and 7A1 in communication (e.g., included in and/or communicatively linked) with one or more inputs devices, such as image sensors 314a in FIGS. 7A and 7A1, and a display generation component, such as display generation component 120a in FIGS. 7A and 7A1. For example, a mobile device (e.g., a tablet, a smartphone, a media player, or a wearable device), or a computer or other electronic device. In some embodiments, the display generation component is a display integrated with the electronic device (optionally a touch screen display), external display such as a monitor, projector, television, and/or a hardware component (optionally integrated or external) for projecting a user interface or causing a user interface to be visible to one or more users. In some embodiments, the one or more input devices include an electronic device or component capable of receiving a user input (e.g., capturing a user input, detecting a user input) and transmitting information associated with the user input to the computer system. Examples of input devices include a touch screen, mouse (e.g., external), trackpad (optionally integrated or external), touchpad (optionally integrated or external), remote control device (e.g., external), another mobile device (e.g., separate from the computer system), a handheld device (e.g., external), a controller (e.g., external), a camera, a depth sensor, an eye tracking device and/or a motion sensor (e.g., a hand tracking device, a hand motion sensor). In some embodiments, the computer system is in communication with a hand tracking device (e.g., one or more cameras, depth sensors, proximity sensors, touch sensors (e.g., a touch screen, or trackpad)). In some embodiments, the hand tracking device is a wearable device, such as a smart glove. In some embodiments, the hand tracking device is a handheld input device, such as a remote control or stylus.

In some embodiments, while a three-dimensional environment of a user of the first computer system is visible via the display generation component (e.g., the three-dimensional environment is generated, displayed, or otherwise caused to be viewable by the device (e.g., a computer-generated reality (CGR) environment such as a virtual reality (VR) environment, a mixed reality (MR) environment, and/or an augmented reality (AR) environment)), such as three-dimensional environment 702a (e.g., an AR, AV, VR, MR, or XR environment) in FIGS. 7A and 7A1, and while the user is in a real-time communication session with a second user (e.g., of a second computer system, different from the first computer system), different from the user (802a), such as a user of computer system 101b (e.g., tablet, smartphone, wearable computer, or head mounted device) in FIGS. 7A and 7A1, the computer system displays (802b), via the display generation component, a visual representation of the participant within the three-dimensional environment, such as representation 704a in FIGS. 7A and 7A1, wherein a respective portion of the visual representation has a first visual appearance including a first degree of visual prominence, such as visual appearance of a hand of representation 704a in FIGS. 7A and 7A1. The user and the participant (e.g., another user participating in the real-time communication session with the user of the first computer system), for example, optionally are in communication via the first computer system and/or the second computer system. In some embodiments, the real-time communication with the participant includes a real-time, or nearly real-time communication of voice and/or representations of the participant. For example, the first computer system optionally initiates and/or receives a request to initiate and/or join real-time communication session, and in response, initiates display of virtual content (e.g., an at least partially immersive virtual environment) to facilitate communication with the participant within a joint virtual environment. The visual representation optionally includes one or more virtual avatars corresponding to the participant (e.g., having one more visual characteristics corresponding to one or more physical characteristics of the participant, such as the user's height, posture, skin color, eye color, hair color, relative physical dimensions, facial features and/or position within the three-dimensional environment). In some embodiments, the computer system displays the representation of the participant with visual appearance having a degree of visual prominence relative to the three-dimensional environment. The degree of visual prominence optionally corresponds to a form of the representation of the participant (e.g., an avatar having a human-like form and/or appearance or an abstracted avatar including less human-like form (e.g., corresponding to a generic two-dimensional or three-dimensional object, such as a virtual coin or a virtual sphere)). Additionally or alternatively, one or more portions of the representation of the participant are optionally displayed with visual characteristic(s) (e.g., with a level of opacity, saturation, brightness, contrast, a blurring effect, and/or a radius of a blurring effect) corresponding to the first degree of visual prominence.

As referred to herein, visual prominence of virtual content optionally refers to display of one or more portions of the virtual content with one or more visual characteristics such that the virtual content is optionally distinct and/or visible relative to a three-dimensional as perceived by a user of the computer system. For example, the computer system optionally displays respective virtual content with one or more visual characteristics having respective values, such as a virtual content that is displayed with a level of opacity and/or brightness. The level of opacity, for example, optionally is 0% opacity (e.g., corresponding to virtual content that is not visible and/or fully translucent), 100% opacity (e.g., corresponding to virtual content that is fully visible and/or not translucent), and/or other respective percentages of opacity corresponding to a discrete and/or continuous range of opacity levels between 0% and 100%. Reducing visual prominence of a portion of virtual content, for example, optionally includes decreasing an opacity of one or more portions of the portion of virtual content to 0% opacity or to an opacity value that is lower than a current opacity value. Increasing visual prominence of the portion of the virtual content, for example, optionally includes increasing an opacity of the one or more portions of the portion of virtual content to 100% or to an opacity value that is greater than a current opacity value. Similarly, reducing visual prominence of virtual content optionally includes decreasing a level of brightness (e.g., toward a fully dimmed visual appearance at a 0% level of brightness or another brightness value that is lower than a current brightness level), and increasing visual prominence of virtual content optionally includes increasing the level of brightness (e.g., toward a fully brightened visual appearance at a 100% level of brightness or another brightness value that is higher than a current brightness level) of one or more portions of the virtual content. It is understood that additional or alternative visual characteristics optionally are included in modification of visual prominence (e.g., saturation, where increased saturation increases visual prominence and decreased saturation decreases visual prominence; blur radius, where an increased blur radius decreases visual prominence and a decreased blur radius increases visual prominence; contrast, where an increased contrast value increases visual prominence and a decreased contrast value decreases visual prominence). Changing the visual prominence of an object can include changing multiple different visual properties (e.g., opacity, brightness, saturation, blur radius, and/or contrast). Additionally, when visual prominence of a first object is increased relative to visual prominence of a second object, the change in visual prominence could be generated by increasing the visual prominence of the first object, or decreasing the visual prominence of the second object, increasing the visual prominence of both objects with the first object increasing more than the second object, or decreasing the visual prominence of both objects with the first object decreasing less than the second object.

In some embodiments, while a three-dimensional environment, such as three-dimensional environment 702a in FIGS. 7A and 7A1, of a user of the first computer system is visible via the display generation component (e.g., the three-dimensional environment is generated, displayed, or otherwise caused to be viewable by the device (e.g., a computer-generated reality (CGR) environment such as a virtual reality (VR) environment, a mixed reality (MR) environment, and/or an augmented reality (AR) environment)), and while the user is in a real-time communication session with a second user (e.g., of a second computer system, different from the first computer system), different from the user, such as the user of computer system 101b (e.g., tablet, smartphone, wearable computer, or head mounted device) in FIGS. 7A and 7A1, while displaying the visual representation of the participant with the respective portion of the visual representation having the first visual appearance, the computer system obtains (802c) information about a first event corresponding to a request to move the respective portion of the visual representation of the participant to a respective position within the three-dimensional environment (e.g., based on movement of the participant as detected by a computer system being used by the participant to participate in the real-time communication session), such as an information corresponding to movement of a participant corresponding to representation 704a in FIGS. 7A and 7A1. For example, while a current viewpoint of the user is maintained, the computer system optionally obtains information about the first event, including receiving an indication of movement of the participant (e.g., from a second computer system corresponding to the participant), and in response to obtaining the information about the first event, optionally initiates a process to change or maintain the degree of visual prominence of the portion(s) of the representation of the participant based on satisfaction of one or more criteria, such as described below. In some embodiments, the information about the first event includes detecting movement of the participant within a shared physical environment. In some embodiments, the information about the first event includes receiving (e.g., from the second computer system) an indication that one or more portions of the participant have moved within the physical environment of the participant (e.g., detected by the second computer system) that is different from a physical environment of the user. For example, the user and the participant are optionally located in different physical rooms, and the second computer system optionally communicates an indication of movement of one or more portions of the participant's body throughout the physical room of the participant. In some embodiments, the movement of the participant corresponds to movement of the viewpoint of the participant relative to the three-dimensional environment (e.g., a rotation of a head along one or more axes). In some embodiments, the indication of movement of the participant corresponds to a request to move the representation of the participant (e.g., displayed by the first computer system), without detecting physical movement of the participant, such as movement input directed to a joystick or trackpad.

In some embodiments, while a three-dimensional environment of a user of the first computer system is visible via the display generation component (e.g., the three-dimensional environment is generated, displayed, or otherwise caused to be viewable by the device (e.g., a computer-generated reality (CGR) environment such as a virtual reality (VR) environment, a mixed reality (MR) environment, and/or an augmented reality (AR) environment)), such as three-dimensional environment 702a (e.g., an AR, AV, VR, MR, or XR environment) in FIGS. 7A and 7A1, and while the user is in a real-time communication session with a second user (e.g., of a second computer system, different from the first computer system), different from the user, in response to obtaining information about the first event corresponding to the request to move the respective portion of the visual representation of the participant to the respective position within the three-dimensional environment (802d), in accordance with a determination that the first event satisfies one or more first criteria, including a criterion that is satisfied when the respective position within the three-dimensional environment is within a first threshold distance (e.g., 0.001, 0.01, 0.1, 0.25, 0.5, 0.75, or 1 m) of a viewpoint of the user in the three-dimensional environment, such as simulated threshold distance corresponding to threshold 710-1 in FIG. 7B, the computer system changes (802c) a visual appearance of the respective portion of the visual representation of the participant to have a second visual appearance, different from the first visual appearance, wherein the second visual appearance includes a second degree of visual prominence less than the first degree of visual prominence, such as the visual appearance and degree of visual prominence of hand 716a in FIG. 7C. For example, the one or more criteria include a criterion that is satisfied when the computer system obtains information and/or receives an indication that the respective position corresponding to the respective portion (e.g., representative of an arm, a leg, a hand, a finger, and/or a head of the participant) of the visual representation of the participant is within the first threshold distance of the user (e.g., within the first threshold distance of a respective portion of the user's body and/or a respective portion of the computer system). In accordance with a determination the first event satisfies the one or more first criteria, the computer system optionally decreases the degree of visual prominence of the respective portion of the representation of the participant. As an example, the first computer system optionally decreases a level of opacity, saturation, brightness, contrast, a magnitude of a blurring effect, and/or a radius of a blurring effect of the respective portion of the representation of the participant-alone or in some combination-relative to the three-dimensional environment.

In some embodiments, the degree of visual prominence of other portions than the respective portion of the representation of the participant are maintained while the respective portion is displayed with the second visual appearance (e.g., because the other portions to not correspond to respective positions within the three-dimensional environment within the threshold distance of the viewpoint of the user). In some embodiments, displaying the respective portion with the second visual appearance includes reducing a degree of visual prominence of a first sub-portion of the respective portion, while maintaining a degree of visual prominence of a second sub-portion of the respective portion (e.g., changing prominence of fingers while maintaining prominence of a palm). In some embodiments, the computer system concurrently displays a plurality of portions of the representation of the participant with the second visual appearance in accordance with a determination that the respective portions of the representation of the participant satisfy the one or more first criteria while a second plurality of portions of the representations are displayed with the first visual appearance when the second plurality of the representations do not satisfy the one or more first criteria. In some embodiments, the respective portion is displayed with a progressively reduced degree of visual prominence (e.g., gradually reduced in degree of visual prominence as an increasing proportion of the respective portion moves within the first threshold distance). In some embodiments, the respective portion is abruptly displayed with the reduced degree of visual prominence.

In some embodiments, while a three-dimensional environment of a user of the first computer system is visible via the display generation component (e.g., the three-dimensional environment is generated, displayed, or otherwise caused to be viewable by the device (e.g., a computer-generated reality (CGR) environment such as a virtual reality (VR) environment, a mixed reality (MR) environment, and/or an augmented reality (AR) environment)), and while the user is in a real-time communication session with a second user (e.g., of a second computer system, different from the first computer system), different from the user, in response to obtaining information about the first event corresponding to the request to move the respective portion of the visual representation of the participant to the respective position within the three-dimensional environment, in accordance with a determination that the first event does not satisfy the one or more first criteria, the computer system forgoes (802f) the changing of the visual appearance of the respective portion of the visual representation of the participant to have the second visual appearance, such as the forgoing of changing visual appearance of a hand of representation 704a that is not within thresholds 710 in FIG. 7B. For example, when the first computer system does not obtain information and/or receive an indication that the respective portion is within the first threshold distance of the current viewpoint of the user of the computer system, the computer system optionally forgoes reducing the degree of visual prominence of the respective portion of the representation of the participant. Displaying the respective portion of the visual representation of the participant with a respective visual appearance in accordance with a determination that the respective portion corresponds to a position within a threshold distance of the user's viewpoint provides visual feedback about the proximity of the visual representation of the participant, thus guiding the user to provide input such as movement to improve visibility of and interactivity with the representation of the participant, mitigating the risk of apparent spatial conflicts between the user and the representation of the participant, and improving visibility of the three-dimensional environment, and thereby increasing the information exchanged during real-time communication with the participant.

In some embodiments, in response to obtaining the information about the first event, and in accordance with the determination that the first event does not satisfy the one or more first criteria, the computer system maintains the visual appearance of the respective portion of the visual representation of the participant as having the first visual appearance such as the maintaining of visual appearance of a hand of representation 704a that is not within thresholds 710 in FIG. 7B. For example, in accordance with a determination that a portion of the visual representation of the participant is not within the first threshold distance of the current viewpoint of the user, the computer system forgoes modification of visual appearance of one or more portions or all of the visual representation, such as the respective portion. In some embodiments, in accordance with a determination that a plurality of portions of the visual representation of the participant is outside of the first threshold distance, the computer system maintains the visual appearance of the plurality of portions. It is understood that maintaining the visual appearance of a respective portion of the visual representation of the participant optionally includes maintaining a degree of visual prominence (e.g., opacity, saturation, brightness, and/or blurring effect) of the respective portion, while optionally changing a scale and/or position of the respective portion. For example, a hand of an avatar moving outside of the first threshold distance of the current viewpoint of the user optionally is displayed with a same level of opacity and/or saturation while moving outside of the first threshold distance, while a size, orientation, and/or position of the hand changes in accordance with information received from the participant. Maintaining the visual prominence of the respective portion reduces the likelihood that the user erroneously changes their current viewpoint to a position that is relatively too close to the current viewpoint of the user, thus reducing erroneous changes to the current viewpoint suboptimal for viewing the respective portion of the visual representation of the participant, thereby reducing processing of inputs required to correct the erroneous changes.

In some embodiments, in response to obtaining the information about the first event corresponding to the request to move the respective portion of the visual representation of the participant to the respective position within the three-dimensional environment and in accordance with a determination the respective position satisfies the one or more first criteria, such as the event including movement of representation 704a to where hand 716a or a head of representation 704a is within threshold 710-1 in FIG. 7C, in accordance with a determination that the respective portion of the visual representation of the participant is a first portion of the visual representation of the participant, the computer system maintains a visual appearance of a second portion of the visual representation of the participant, different from the first portion of the visual representation, such as a torso of representation 704a in FIG. 7C, as having the first visual appearance, wherein the second portion of the visual representation is further than the first threshold distance of the viewpoint of the user in the three-dimensional environment, such as the torso of representation 704a in FIG. 7C. For example, when one or portions, such as the respective portion, of the visual representation are within the first threshold distance of the current viewpoint of the user. For example, the first portion that is within the first threshold distance of the viewpoint is displayed with the second visual appearance, and a second, different portion that is not within the first threshold distance before, in response to, and/or after the first event is detected is displayed with the first visual appearance before, in response to, and/or after the first event is detected. In some embodiments, one or more portions that are outside of the first threshold distance maintain their respective visual appearance before, in response to, and/or after the visual representation of the participant and/or the viewpoint of the user changes in accordance with a determination that the one or more portions remain outside of the first threshold distance relative to the viewpoint of the user. In some embodiments, the first portion is contiguous with the second portion, such as a hand of human-shaped avatar that is contiguous with a forearm of the human-shaped avatar. In some embodiments, the first portion is not contiguous with the second portion, such as the hand of the avatar that is non-contiguous with a torso of the human-shaped avatar. In some embodiments, the maintaining of visual appearance of the second portion occurs concurrently with the changing of the visual appearance of the first portion.

In some embodiments, in response to obtaining the information about the first event corresponding to the request to move the respective portion of the visual representation of the participant to the respective position within the three-dimensional environment and in accordance with a determination the respective position satisfies the one or more first criteria, in accordance with a determination that the respective portion of the visual representation of the participant is the second portion of the visual representation of the participant, such as a second hand of a participant corresponding to representation 704a in FIG. 7C, the computer system maintains the visual appearance of the first portion of the visual representation of the participant as having the first visual appearance, wherein the first portion of the visual representation is further than the first threshold distance of the viewpoint of the user in the three-dimensional environment. For example, as described above, a visual appearance portion of the visual representation of the participant outside of the first threshold distance is optionally maintained in accordance with a determination that the portion is outside of the first threshold distance. For example, in response to obtaining information corresponding to a request to move a first hand of an avatar within the first threshold distance, the computer system optionally changes the visual appearance of respective portion(s) of the first hand (e.g., decreasing an opacity of the respective portion(s) while maintaining the visual appearance of a second hand of the avatar that is outside of the first threshold distance. It is understood that embodiments of the disclosure herein described with reference to a “visual representation of the participant” and/or a “visual representation of the first participant” optionally applies to additional and/or alternative participants and/or visual representations of such participants, optionally concurrently or in succession. For example, when respective hands of avatars are within the first threshold distance of the viewpoint of the user simultaneously, the computer system optionally displays the respective hands with a modified visual appearance (e.g., a decreased opacity, and/or another visual modification as described further herein). Displaying a first or a second portion of the visual representation of the participant with a modified visual appearance in accordance with a determination that the first or second portion are respectively within the first threshold distance provides visual feedback suggestive of what portion of the visual representation of the participant is relatively too close to optimally view the visual representation, thus guiding the user to efficiently correct for the suboptimal proximity and thereby reducing processing of erroneous user input that does not resolve the suboptimal proximity.

In some embodiments, in response to obtaining the information about the first event corresponding to the request to move the respective portion of the visual representation of the participant to the respective position within the three-dimensional environment and in accordance with the determination that the one or more first criteria are satisfied (For example, as described with reference to step(s) 802), in accordance with a determination that the respective portion of the visual representation of the participant is a first portion of the visual representation of the participant, such as a head of representation 704a in FIG. 7D the computer system changes a visual appearance of a second portion of the visual representation of the participant, different from the first portion of the visual representation of the participant, such as a left hand of representation 704a in FIG. 7D, to have the second visual appearance, wherein the second portion of the visual representation is further than the first threshold distance from the viewpoint of the user in the three-dimensional environment (concurrently with the changing of the visual appearance of the first portion), such as the visual appearance of a head of representation 704a in FIG. 7E and/or the visual appearance of hand 716a in FIG. 7D. In some embodiments, when the particular portions of the visual representation of the participant are respectively within the first threshold distance of the viewpoint of the user, a plurality of portions of the user are changed in visual appearance, and when other portions of the visual representation of the participant are within the first threshold distance, the other portions of the visual representation of the participant are changed in visual appearance while alternative portions of the visual representation outside of the first threshold distance are maintained. In some embodiments, the particular portions of the visual representation of the participant-such as a head of a virtual avatar, a torso of a virtual avatar, and/or a corner, body, and/or edge of a visual representation other than a human-shaped avatar-change visual appearance concurrently with a plurality of portions of portions of the visual representation of the participant. For example, in response to obtaining information corresponding to a request to move a head of a virtual avatar within the first threshold distance of the viewpoint of the user, the computer system optionally displays the head and one or more limbs and/or a torso of the virtual avatar with the second visual appearance. In some embodiments, when the information indicates the head is within the first threshold distance, the head of the visual representation is displayed with the second visual appearance, and the one or more limbs and/or torso are displayed with a third visual appearance, having one or more characteristics of the second visual appearance. For example, the second visual appearance includes displaying the head with the second degree of visual representation prominence described with reference to step(s) 802, and the third visual appearance includes displaying the limb(s) and/or torso with the third degree of visual prominence (e.g., a modified opacity, brightness, saturation, and/or magnitude of blurring effect) different from the first degree of visual prominence.

In some embodiments, in response to obtaining the information about the first event corresponding to the request to move the respective portion of the visual representation of the participant to the respective position within the three-dimensional environment and in accordance with the determination that the one or more first criteria are satisfied (For example, as described with reference to step(s) 802), in accordance with a determination that the respective portion of the visual representation of the participant is the second portion of the visual representation of the participant, the computer system maintains the visual appearance of the first portion of the visual representation of the participant as having the first visual appearance, such as maintaining the visual appearance of a left hand of the representation 704a FIG. 7D, wherein the first portion of the visual representation is further than the first threshold distance from the viewpoint of the user in the three-dimensional environment. For example, as described further below, the computer system optionally changes the visual appearance of portion(s) of the visual representation of the participant that are within the first threshold distance while maintaining the visual appearance of the portion(s) of the visual representation of the participant outside of the first threshold distance. Changing a visual appearance of multiple portions of a visual representation of the participant in accordance with a determination that the first portion is within the first threshold distance provides visual feedback indicating a portion of the visual representation of particular interest is relatively too close to optimally view the visual representation, thus guiding the user to efficiently correct for the suboptimal proximity and thereby reducing processing of erroneous user input that does not resolve the suboptimal proximity.

In some embodiments, before obtaining the information about the first event, the visual representation of the user is a first visual representation, such as the representation 704a in FIG. 7D. For example, the first visual representation is and/or includes a virtual avatar having a spatial profile (e.g., shape and/or volume) relative to the three-dimensional environment, such as a spatial profile to a physical body of the participant, a representation of the participant having a different spatial profile, such as a polygonal prism, and/or an expressive avatar having a shape and/or spatial profile that the user optionally selects and/or defines (e.g., an animal-shaped avatar, a character avatar, and/or an avatar corresponding to a fictional creature). In some embodiments, the computer system displays the visual representation as the first visual representation in accordance with a determination that one or more portions are not within the first threshold distance of the viewpoint of the user.

In some embodiments, changing the visual appearance of the first portion and the second portion of the visual representation of the participant to have the second visual appearance includes replacing the first visual representation with a second visual representation, different from the first visual representation, such as replacing representation 704a in FIG. 7D with representation 723a in FIG. 7E. For example, the computer system optionally ceases display of the first visual representation, such as the avatar, and optionally displays the second visual representation, such as the visual representation having a spatial profile other than a human-shaped avatar. For example, the second visual representation is a polygonal shape, that has a size and/or spatial profile relative to the three-dimensional environment that is independent of user preferences, and/or is selected in accordance with user preferences, and is not additionally customizable (e.g., in proportions, in colors, and/or in scale). In some embodiments, the second visual representation includes customizable text corresponding to the participant, such as the participants name and/or a name of a user account (e.g., an electronic address, like an email), initials corresponding to the participants, name, a monogram corresponding to the participant, and/or a color (e.g., a color fill and/or a color of a simulated glowing visual effect) corresponding to the participant, different from another color corresponding to another visual representation of another participant. In some embodiments, the replacing includes changing a visual prominence of the first visual representation, such as a gradually decreasing level of opacity of the first visual representation. In some embodiments, the replacing includes a changing of visual prominence of the second visual representation, such as an increasing of a level of opacity of the second visual representation. In some embodiments, the changing of levels of visual prominence of the first and second visual representations occur concurrently. In some embodiments, the respective visual representations are displayed and/or cease to be displayed abruptly, and/or in rapid succession. Replacing the first visual representation with the second visual representation provides visual feedback and draws user attention to the proximity between the viewpoint of the user and the visual representation of the visual representation of the second user, thus guiding the user to provide input such as a change in the viewpoint to resolve a proximity between the visual representation and the viewpoint that is suboptimal for viewing the visual representation and thereby reducing the likelihood the computer system processes user input not resolving the suboptimal proximity.

In some embodiments, the first visual representation has a first degree of spatial fidelity, such as representation 704a in FIG. 7D and the second visual representation has a second degree of spatial fidelity, relatively less than the first degree of spatial fidelity, such as representation 723a in FIG. 7E. In some embodiments, a degree of spatial fidelity corresponds to how faithfully the respective visual representations (e.g., the first and the second) correspond corresponds to a physical body of the participant represented by the visual representation, and/or corresponds to a generic physical body. In some embodiments, a higher degree of spatial fidelity corresponds to a visual representation that more faithfully corresponds to the physical body of the corresponding participant and/or the generic physical body. For example, the first visual representation includes one or more limbs corresponding to the body of the physical participant, and the second visual representation does not include one or more of the one or more limbs. As an additional example, the first visual representation is optionally the human-shaped avatar described with reference to the anthropomorphic visual representations, and the second visual representation is optionally a geometric representation corresponding to (e.g., display at) a same position as the first visual representation. Displaying the first and the second visual representations with different degrees of spatial fidelity visually indicates the proximity between the viewpoint of the user and the representation of the user, thus improving visibility of the three-dimensional environment while displayed with the second, lesser degree of spatial fidelity and providing feedback concerning suboptimal proximity between the viewpoint and the visual representation, thereby guiding the user to provide input to correct for the suboptimal proximity and reducing the likelihood the computer system needlessly processes input erroneously exacerbating the suboptimal spatial relationship between the viewpoint and the visual representation.

In some embodiments, the first visual representation includes a plurality of different representations of different body parts corresponding to a plurality of body parts of the participant, such as representation 704a in FIG. 7D and the second visual representation does not include representations of different body parts, such as representation 723a in FIG. 7E. In some embodiments, the first visual representation includes virtual body parts, and the second visual representation does not include the virtual body parts or does not include any body parts. For example, the first visual representation optionally includes one or more hands, feet, arms, legs, a torso, a head, a neck, and/or one or more facial features, and the second visual representation optionally excludes one or more of the body parts described previously, completely or in some combination. Replacing the first visual representation with the second visual representation provides visual feedback and draws user attention to the proximity between the viewpoint of the user and the visual representation of the visual representation of the second user, thus guiding the user to provide input such as a change in the viewpoint to resolve a proximity between the visual representation and the viewpoint that is suboptimal for viewing the visual representation and thereby reducing the likelihood the computer system processes user input not resolving the suboptimal proximity.

In some embodiments, while the visual representation is the first visual representation, such as representation 704a, and in response to obtaining the information about the first event, the computer system changes a spatial relationship between the first portion of the first visual representation of the participant and the second portion of the first visual representation of the participant in accordance with the information about the first event, such as the changing of spatial relationship between a hand of representation 704a in from FIG. 7B to FIG. 7C. In some embodiments, the visual representation is the first visual representation described with reference to anthropomorphic avatars (e.g., before the first event is detected, while the first event is being detected, and/or while performing one or more operations in accordance with the information obtained). In some embodiments, the first portion of the user (e.g., a first body part of an avatar) and the second portion of the user (e.g., a second body part of the avatar) have a spatial relationship relative to the three-dimensional environment, such as before the first event is detected. In accordance with a determination that information indicates movement of the first portion and/or the second portion, such as a moving of a hand of the avatar away from a torso of the avatar, the computer system optionally changes the spatial relationship between the first portion and the second portion. Thus, similar to the appearance of physical body parts moving and changing a spatial relationship relative to one another, the computer system optionally displays a changing of the spatial relationship of portions of the first visual representation of the participant. In some embodiments, the first visual representation is a visual representation other than a human and/or anthropomorphic visual representation, and the constituent portions of the visual representation optionally change relative to one another in accordance with the information about the first event. For example, the first visual representation is optionally a geometric prism and/or a representation including abstracted features similar to body parts (e.g., a dome representative of a torso and/or head, and cylinders extending from the dome representative of arms), and portions of such representations move relative to other portions of another.

In some embodiments, while the visual representation of the participant is the second visual representation, such as representation 722a in FIG. 7E, wherein the first portion and the second portion of the second visual representation of the participant have a first spatial relationship, such as a spatial relationship between portions of representation 722a in FIG. 7E, the computer system obtains information about a second event, different from the first event, corresponding to a second request, different from the first request, to move the second visual representation of the participant to an updated position within the three-dimensional environment, such as a request to move the representation 722a in FIG. 7E. For example, the second event optionally includes a request to move a portion of the visual representation of the participant and/or the visual representation of the participant as a whole.

In some embodiments, in response to the obtaining of the information about the second event, the computer system moves the second visual representation of the participant in accordance with the information about the second event while maintaining the first spatial relationship between the first portion and the second portion of the second visual representation of the participant, such as a moving of representation 722a in FIG. 7E to an updated position while maintaining the spatial relationship of portions of representation 722a in FIG. 7E. For example, a geometric prism as a whole moves relative to the three-dimensional environment to an updated position while the geometric prism maintains its shape in accordance with the information by a magnitude and/or in a direction corresponding to a direction and/or magnitude (e.g., distance) of physical movement of the participant, detected by a second computer system detecting movement of the participant. Displaying movement of the visual representation while maintaining a spatial relationship between portions of the visual representation and/or changing the spatial relationship provides visual feedback about a relative proximity of the visual representation relative to the viewpoint when maintaining the spatial relationship and/or provides visual feedback about granular movement of the participant when changing the spatial relationship, thus indicating what portion(s) of the visual representation are relatively too close to the viewpoint of the user, suggesting future user input required to resolve suboptimal proximity to view and/or interact with the visual representation, and thereby reducing user input erroneously not resolving the suboptimal proximity.

In some embodiments, while the visual representation is the second visual representation and while the viewpoint of the user is a first viewpoint, the computer system detects, via the one or more input devices, a second event, different from the first event, including a change of the viewpoint of the user within the three-dimensional environment from the first viewpoint to a second viewpoint, different from the first viewpoint, such as an event including movement of representation 723b in FIG. 7H. For example, the change includes movement of the user to an updated position relative to the three-dimensional environment and/or to an updated orientation relative to the three-dimensional environment, optionally while maintaining a position of the viewpoint of the user.

In some embodiments, in response to detecting the second event, in accordance with a determination that the second event does not satisfy the one or more first criteria based on the second viewpoint being further than the first threshold distance from the respective portion of the visual representation of the participant, such as movement of representation 723b and/or movement of a viewpoint corresponding to representation 723b in FIG. 7G the computer system changes the visual representation of the participant to be the first visual representation, such as representation 704a in FIGS. 7A and 7A1. For example, the one or more first criteria include a criterion that is satisfied when the viewpoint of the user and respective portion of the visual representation are not within the first threshold distance of one another—in addition to or in the alternative to one or more of the first criteria described with reference to step(s) 802—and in response to detecting the second event, the computer system changes the visual representation of the participant to be the first visual representation described with reference to step(s) 802. In some embodiments, the changing the visual representation has one or more characteristics of replacing the first visual representation with the second visual representation, relative, such as an animation including cross-fading of opacity of the respective visual representation, and/or displaying the respective visual representation in rapid succession and/or abruptly.

In some embodiments, in response to detecting the second event, in accordance with a determination that the second event satisfies the one or more criteria, the computer system maintains the visual representation of the participant as the second visual representation, such as movement where viewpoint 704 in the profile view in FIG. 7G remains within threshold 710-2. For example, when the changed viewpoint remains within the first threshold distance of the respective portion of the visual representation of the participant, the computer system maintains display of the second visual representation, optionally at an updated scale relative to the three-dimensional environment in accordance with the changing of the viewpoint. Reverting to displaying the visual representation of the participant as the first visual representation visually indicates that the viewpoint presents an improved viewing and/or interaction distance between the viewpoint of the user and the visual representation of the participant, thereby reducing unnecessary user input further attempting to resolve a suboptimal proximity between the viewpoint and the visual representation.

In some embodiments, while the visual representation is the second visual representation, such as representation 723a in FIG. 7e, and the viewpoint of the user is a first viewpoint, such as viewpoint 706 in FIG. 7E, the computer system obtains information about a second event, different from the first event, corresponding to a second request, different from the request, to move the respective portion of the visual representation of the participant to an updated position within the three-dimensional environment, such as a request to move to change viewpoint 706 in FIG. 7D For example, while displaying the second visual representation described with reference to an anthropomorphic and/or polygonal visual representation, the computer system obtain information including and/or corresponding to a request to move the respective portion to an updated position (e.g., from the respective position or another position).

In some embodiments, in response to obtaining the information about the second event, in accordance with a determination that the second event does not satisfy the one or more criteria, based on the updated position being further than the first threshold distance from the first viewpoint of the user, the computer system changes the visual representation of the participant to be the first visual representation, such as movement of viewpoint 706 backwards away from representation 704a from as illustrated in FIG. 7E. For example, the computer system replaces display of the second visual representation with display of the first visual representation, optionally at a same position within the three-dimensional environment. In some embodiments, the replacing has one or more characteristics described previously with reference to the anthropomorphic and/or polygonal visual representations, such as being displayed with an animation.

In some embodiments, in response to obtaining the information about the second event, in accordance with a determination that the second event satisfies the one or more criteria, the computer system maintains the visual representation of the participant as the second visual representation, such as maintain display of representation 704a in FIG. 7E. For example, if the updated position of the respective portion remains within the first threshold distance, the computer system maintains display of the visual representation of the participant as the second visual representation. Reverting to displaying the visual representation of the participant as the first visual representation visually indicates that the viewpoint presents an improved viewing and/or interaction distance between the viewpoint of the user and the visual representation of the participant, thereby reducing unnecessary user input further attempting to resolve a suboptimal proximity between the viewpoint and the visual representation.

In some embodiments, while displaying the visual representation of the participant that is the second visual representation with a respective degree of visual prominence, such as representation 723a in FIG. 7E the computer system detects, via the one or more input devices, a second event, different from the first event, including a change of the viewpoint of the user relative to the three-dimensional environment from a first viewpoint to a second viewpoint, different from the first viewpoint, such as movement of viewpoint 706 from as shown in FIG. 7E. For example, as described further with reference to the anthropomorphic and/or polygonal visual representations, the computer system optionally displays the visual representation with the second visual representation, optionally with a degree of visual prominence (e.g., opacity, blurring effect, saturation, and/or with a border) relative to three-dimensional environment. In some embodiments, the computer system detects an event such as a change in viewpoint of the user, including a change in position and/or orientation relative to three-dimensional environment.

In some embodiments, in response to detecting the second event, in accordance with a determination that the second event satisfies one or more second criteria, including a criterion that is satisfied when the respective portion of the visual representation of the participant is within a second threshold distance (e.g., 0.01, 0.05, 0.1, 0.25, 0.5, or 0.75 m), different from the first threshold distance, such as threshold 710-3 in FIG. 7E, of the second viewpoint of the user, the computer system reduces the degree of visual prominence of the respective portion of the visual representation of the participant, such as the reducing in visual prominence of a hand of representation 723a in FIG. 7F. For example, similarly as described previously, when the computer system detects that the respective portion of the visual representation is within the first threshold distance of the viewpoint of the user (e.g., in response detecting the changed viewpoint and/or in response to detecting the respective portion move), the computer system optionally changes the degree of visual prominence of the respective portion of the visual representation, such as a decreasing in opacity, saturation, increasing of a magnitude of a blurring effect, and/or initiating display of a border or ceasing display of the border. In some embodiments, the reducing includes ceasing display of the respective portion. In some embodiments, a change in the degree of visual prominence corresponds to an amount of the visual representation of the participant that is within the first threshold distance. For example, as greater amounts of the visual representation move further within the first threshold distance, the computer system progressively reduces the degree of visual prominence of the portion(s) of the visual representation of the participant within the first threshold distance.

In some embodiments, in response to detecting the second event, in accordance with a determination that the second event does not satisfy the one or more criteria, the computer system forgoes reducing the visual prominence of the respective portion of the visual representation of the participant, such as movement of viewpoint 706 from as shown in FIGS. 7A and 7A1 to as shown in FIG. 7B. For example, the visual characteristics described previously are maintained in response to the second event. Displaying the respective portion with a decreased level of visual prominence provides visual feedback that the respective portion is moved too close to the user for improved interaction and viewing, thus suggesting user input to improve interactivity and/or visibility of the respective portion, and thereby reducing the likelihood that user input erroneously exacerbates the suboptimal proximity of the respective portion and the viewpoint of the user.

In some embodiments, the first threshold distance is less than a length corresponding to a length a physical arm of a human, such as thresholds 711 that are less than a length of an arm of a user in FIG. 7I. For example, the first threshold distance is measured relative to a distance of the physical arm of a human (e.g., the user, and/or a statistically determined distance based on data corresponding to a plurality of physical arms) determined by the electronic device and/or entered into the electronic device. In some embodiments, the first threshold distance is a standardized and/or genericized distance based on one or more characteristics of the user, such as a height, age, and/or weight of the user. In some embodiments, the first threshold distance is a standard distance set by the electronic device, independent of any determinations and/or measurements detected by and/or received at the electronic device. In some embodiments, in accordance with a determination that a length of a first physical arm of a first user of the first computer system is a first length, the threshold distance is a first distance, and in accordance with a determination that the length of the physical arm of the first user (or a second, different user) of the first computer system is a second length, different (e.g., greater or lesser) than the first length, the threshold distance is a second length, different from (e.g., greater or lesser than) the first threshold. Using a threshold distance less than a length of a physical arm of the user reduces the likelihood that the visual appearance of the visual representation of the participant is unnecessarily changed when displayed far away enough from the viewpoint of the user for convenient viewing and/or interacting with the visual representation, thereby reducing the need for user input and processing of the user input to improve visibility of the visual representation.

In some embodiments, in accordance with a determination that an orientation between an orientation of the viewpoint of the user and the respective position within the three-dimensional environment is within a first range of orientations, such as range of orientations relatively to the side and/or the front of the viewpoint 706 in FIG. 7F the first threshold distance is a first distance, such as a distance included in thresholds 710 at the side and/or front of viewpoint 706 in FIG. 7F. For example, the first threshold distance is optionally variable in accordance with an orientation of the viewpoint of the user relative to the respective position that the respective portion of the visual representation of the participant moves to. The viewpoint of the user, for example, is optionally a first vector extending from a portion of the user's viewpoint (e.g., a center of the user's viewpoint, such as a center of the user's head and/or eyes) outward toward the three-dimensional environment, optionally extending parallel to a floor of the three-dimensional environment. In some embodiments, the orientation additionally is determined relative to an angle formed by projecting a second vector extending from the portion of the user's viewpoint to the respective position onto a plane parallel to a plane of that is parallel to the first vector. In some embodiments, the computer system determines additional or alternative vector(s) along other dimensions and/or planes relative to the viewpoint of the user and/or the three-dimensional environment, and determines the orientation in accordance with a combination of one or more vectors and/or angle measured relative to the other dimensions and/or planes, in addition to or in the alternative to the first vector and the second vector. The computer system thus determines a relative orientation between the respective position and the viewpoint of the user, and optionally changes the first threshold distance if the relative orientation is within a range of orientations. For example, the range of orientations optionally correspond to a range of orientations in front of the viewpoint of the user, and determines the first threshold distance dictating changing of visual appearance of the visual representation of the participant is the first distance.

In some embodiments, in accordance with a determination that the orientation between the viewpoint of the user and the respective position is within a second range of orientations, such as range of orientations relatively to the side and/or behind the viewpoint 706 in FIG. 7F, different from the first range of orientations, the first threshold distance is a second distance, different from the first distance, such as one or more of the distances defining the side and/or rear portion of thresholds 710 in FIG. 7F. In some embodiments, the second range of orientations include respective orientations that are relatively peripheral and/or behind the viewpoint of the user. For example, if the orientation of the user is outside of a threshold angle of the center of the viewpoint of the user (e.g., 45, 60, 75, 80, and/or 85 degrees away from a vector extending from the center of the user's viewpoint), the computer system optionally determines that the first threshold distance is the second distance, different from (e.g., greater than) the first distance. For example, if a hand of an avatar is a respective distance from the viewpoint of the user that is greater than the first distance and less than the second distance, the computer system displays the hand of the avatar with the first visual appearance while the viewpoint of the user is within the first range of orientations, and in response to detecting a change in viewpoint such that the orientation between the viewpoint and the respective position is within the second range of orientations (e.g., when the hand position is maintained), the computer system displays the hand with the second visual appearance. Assigning different distances to the first threshold distance mimics social customs and/or preferences of the user and reduces the likelihood that the viewpoint of the user incidentally moves too close to the visual representation of the participant in violation of their social customs, thereby reducing the likelihood that the user provides erroneous input inconsistent with their social customs, and preventing processing of such erroneous user input.

In some embodiments, while displaying a first portion of the visual representation of the participant with a respective degree of visual prominence (e.g., the first or the second degree of visual prominence and/or another degree of visual prominence), such as the visual prominence of a hand of representation 704a in FIG. 7I, wherein the first portion of the visual representation of the participant corresponds to a representation of a physical hand of the participant, such as a hand of representation 706a in FIG. 7J the computer system obtains information about a second event corresponding to relative movement between a representation of a physical hand of the user and the respective portion of the representation of the participant, such as moving of the hand of representation 704a and/or movement of hand of representation 706a in FIG. 7I. For example, the computer system optionally presents a view of the physical hand via a passive and/or optical passthrough included in the computer system. In some embodiments, the representation of the physical hand is a digital representation captured by a camera and/or a virtual texture overlaid over the form of the user's physical hand. In some embodiments, the computer system detects and/or receives an indication of the second event, such as from the computer system of the participant, that the first portion of the visual representation of the participant has moved and/or detects movement of the hand of the user. As described previously with reference to step(s) 802, the visual representation is optionally an avatar, such as an anthropomorphic avatar, including a hand corresponding to a physical hand of the participant.

In some embodiments, in response to obtaining the information about the second event, in accordance with a determination that in response to the relative movement between the representation of the physical hand of the user and the first portion of the representation of the participant, the representation of the physical hand of the user has a spatial conflict with the respective portion of the representation of the participant, the computer system maintains display of the first portion of the visual representation of the participant with the respective degree of visual prominence, such as the maintaining of display and visual prominence of the hands of representation 704a and representation 706a in FIG. 7J. For example, the computer system optionally determines that the physical hand of the user and the respective portion of the visual representation correspond to a similar and/or same position in the three-dimensional environment, similar to a shaking of physical hands of the user, and referred to herein as a “virtual handshake.” In some embodiments, such an embodiment presents an apparent spatial conflict between the representation of the user's hand and the respective portion of the visual representation of the participant, similar to if two physical objects attempted to occupy a same place and/or meet at a same place in a physical environment. In some embodiments, in response to detecting the second event, the computer system displays a visual indication of the virtual handshake, such as an animation and/or a graphic, and/or maintains a respective degree of visual prominence of the respective portion of the visual representation of the participant (e.g., maintains a level of opacity). Maintaining a degree of visual prominence of the respective portion of the visual representation of the participant maintains visibility of the respective portion of the visual representation, thus indicating where the position of the respective portion is relative to the three-dimensional environment, and thereby reducing user input and processing of the user input erroneously moving too close to the respective portion.

In some embodiments, while displaying the visual representation of the participant including displaying the respective portion of the visual representation of the participant with the first visual appearance, the computer system detects, via the one or more input devices, a second event, different from the first event, including a change of the viewpoint of the user, such as viewpoint 706 in FIG. 7E, relative to the three-dimensional environment from a first viewpoint to a second viewpoint, different from the first viewpoint, such as a changing of viewpoint 706 as shown from FIG. 7E to FIG. 7F. For example, as described herein with reference to movement of the viewpoint of the user of the computer system.

In some embodiments, in response to detecting the second event, in accordance with a determination that the second event satisfies the one or more first criteria, because the second viewpoint is within the first threshold distance from the respective portion of the visual representation of the participant, such as movement of viewpoint 706 causing hand 716a in FIG. 7C to be within threshold 710-1 in FIG. 7C. the computer system changes the visual appearance of the respective portion of the visual representation of the participant to have the second visual appearance, such as the visual appearance of hand 716a in FIG. 7C. For example, the computer system detects the user viewpoint move relatively closer to the respective portion of the participant, optionally within the first threshold distance of the respective portion of the participant. Thus, the one or more first criteria are optionally satisfied (e.g., including a criterion satisfied when the viewpoint of the user is within the first threshold distance of a respective portion of the visual representation) in response to detecting the second event, and the computer system optionally changes the visual appearance of the respective portion, described further with reference to step(s) 802.

In some embodiments, in response to detecting the second event, in accordance with a determination that the second event does not satisfy the one or more first criteria, because the second viewpoint is outside of the first threshold distance from the respective portion of the visual representation of the participant, such as movement of viewpoint 706 to a position such that representation 704a is not within in FIG. 7B the computer system forgoes the changing of the visual appearance of the respective portion of the visual representation of the participant to have the second visual appearance, such as forgoing the display of hand 716a in FIG. 7C with the modified visual appearance. For example, when the viewpoint and the respective portion are not within the first threshold distance, the computer system maintains the previous visual appearance of the respective portion in response to obtaining the information. Changing the visual appearance of the visual representation of the participant reduces the likelihood that the user erroneously moves too close to the visual representation, thereby reducing user input and processing of the user input to correct for erroneous movement.

In some embodiments, before obtaining the information about the second event, such as before detecting movement of viewpoint 706 and/or representation 704a to an arrangement shown in FIG. 7E, the visual representation of the user is a first visual representation, such as representation 704a in FIGS. 7A and 7A1. For example, as described with reference movement of the viewpoint of the user and/or obtaining information that representation 704a will correspond to an updated position within the three-dimensional environment.

In some embodiments, changing the visual appearance of the respective portion of the visual representation of the participant to have the second visual appearance includes replacing the first visual representation with a second visual representation, different from the first visual representation, such as replacing representation 704aa with representation 722a in FIG. 7E. For example, as described with reference to movement of the viewpoint of the user and/or obtaining information that representation 704a will correspond to an updated position within the three-dimensional environment. Thus, the computer system changes the visual appearance of the respective portion in accordance with a determination that the viewpoint of the user moves within the first threshold distance of the respective portion of the user and/or in accordance with a determination that the respective portion moves within the first threshold distance of the viewpoint. Replacing the first visual representation with the second visual representation provides visual feedback and draws user attention to the proximity between the viewpoint of the user and the visual representation of the visual representation of the second user, thus guiding the user to provide input such as a change in the viewpoint to resolve a proximity between the visual representation and the viewpoint that is suboptimal for viewing the visual representation and thereby reducing the likelihood the computer system processes user input not resolving the suboptimal proximity.

In some embodiments, in response to obtaining the information about the second event (For example, as described with reference to step(s) 802 and/or movement of the viewpoint of the user and/or obtaining information that representation 704a will correspond to an updated position within the three-dimensional environment), in accordance with a determination that the one or more first criteria are satisfied and the respective portion of the visual representation of the participant is a first portion of the visual representation of the participant, such as a head of representation 704a in FIG. 7E, the computer system changes a visual appearance of a second portion of the visual representation of the participant, different from the first portion of the visual representation of the participant, such as torso 720a in FIG. 7D, to have the second visual appearance, wherein the first portion of the visual representation is further than the first threshold distance of the viewpoint of the user in the three-dimensional environment (concurrently with the changing of the visual appearance of the first portion), such as the position of torso a 720a in FIG. 7D. In some embodiments, as described further herein, the computer system changes a visual appearance of a plurality of portions of the visual representation of the participant in accordance with particular portion(s) of the visual representation are within the first threshold distance of the viewpoint of the user. For example, in accordance with a determination that a head, neck, and/or torso of a human-like avatar moves within the first threshold distance of the viewpoint of the user and/or the viewpoint of the user moves within the first threshold distance of such portions of the avatar while one or more alternative portions (e.g., a back, arm(s), and/or leg(s)) are not within the first threshold distance, the computer system optionally changes the visual appearance of the portion(s) violating the first threshold distance, and additionally changes the portion(s) not violating the first threshold distance. As an example, when the head of the avatar is decreased in opacity, some or all of the avatar (e.g., the arms and/or body) are decreased in opacity concurrently and/or soon after.

In some embodiments, in response to obtaining the information about the second event, in accordance with a determination that the one or more first criteria are satisfied and the respective portion of the visual representation of the participant is the second portion of the visual representation of the participant, such as torso 720a in FIG. 7D, the computer system maintains the visual appearance of the first portion of the visual representation of the participant as having the first visual appearance, wherein the first portion of the visual representation is further than the first threshold distance of the viewpoint of the user in the three-dimensional environment, such as maintaining the visual appearance of a hand of representation 704a in FIG. 7C that is not within thresholds 710 when torso 720a is within thresholds 710 in FIG. 7D. For example, in accordance with a determination that a hand of the avatar and/or the viewpoint of the user move within the first threshold distance of each other, the computer system optionally changes the visual appearance of the hand, and forgoes changing the visual appearance of another portion of the avatar (e.g., another hand, the torso, the head) that otherwise changes in visual appearance when the first portion of the visual representation of the participant is moved within the first threshold distance. Changing a visual appearance of multiple portions of the visual representation of the participant provides visual feedback that a particularly important portion of the visual representation is within the first threshold distance, thus guiding the user away from inputs erroneously moving closer to the visual representation, and thereby reducing processing required to handle the erroneous inputs.

In some embodiments, while displaying the visual representation of the participant in the three-dimensional environment, the computer system presents spatialized audio, such as audio 714 in FIG. 7D, corresponding to respective audio obtained from the participant as if emanating from a respective position within the three-dimensional environment, wherein the respective position corresponds to a position of the visual representation of the participant, such as the position of a head of viewpoint 704 in FIG. 7D. In some embodiments, the computer system presents (e.g., plays back) audio corresponding to audio that is detected by the computer system of the participant, and is communicated to the computer system of the user. In some embodiments, the audio is acoustically processed to provide a simulated localization of sound source(s) providing the audio to the user, to mimic the effect of sound emanating from one or more respective positions of three-dimensional environment. For example, the audio is optionally configured to sound as if the visual representation of the participant is speaking, such as from a position relative to a floor of the three-dimensional environment and the viewpoint of the user corresponding to where the visual representation is displayed. In some embodiments, the spatialized audio is modified to sound as if the spatialized audio was emanating from a head and/or a center of a body of an avatar. Presenting audio as if emanating from a position corresponding to the position of the visual representation of the participant provides audible feedback about proximity to the visual representation, thereby reducing erroneous user input moving to positions within the three-dimensional environment that interfere with visibility and/or interactivity with the visual representation.

In some embodiments, while displaying the visual representation of the participant in the three-dimensional environment at a first position within the three-dimensional environment, such as the position of representation 704a in FIG. 7D, and the respective position of the spatialized audio is a second position corresponding to the first position within the three-dimensional environment, such as a position of audio 714 in FIG. 7D, the computer system obtains information about a second event, different from the first event, including a change in proximity between the viewpoint of the user and the visual representation of the participant, such as information about movement of viewpoint 704 in FIG. 7E. For example, as described with reference with reference to spatialized audio, the computer system optionally plays spatialized audio that is processed to mimic the audible behavior as if the visual representation of the participant was in a physical room of the user and speaking from the first position. In some embodiments, the information about the second event includes detecting a change in viewpoint of the user and/or the information includes an indication of movement of some or all of the visual representation of the participant.

In some embodiments, in response to obtaining the information about the second event, in accordance with a determination that the change in proximity satisfies one or more second criteria, including a criterion that is satisfied when the viewpoint of the user is within a second threshold distance of a position corresponding to the visual representation of the participant in the three-dimensional environment, such as threshold 710-1 in FIG. 7E, the computer system forgoes presenting the spatialized audio corresponding to the participant as if emanating from a third position in the three-dimensional environment corresponding to the position corresponding to the visual representation of the participant. For example, forgoes presenting audio 714 as if emanating from a head of representation 704a in FIG. 7E. For example, in response to detecting the viewpoint of the user and visual representation of the participant draw closer and remain outside of the second threshold distance (e.g., 0.05, 0.1, 0.5, 1, or 2.5 m) of one another, optionally different than or the same as the first threshold distance, the computer system presents the spatialized audio at a position of the visual representation of the participant (e.g., at the third position). In some embodiments, the third position is the same as the second position when the representation of the participant is not moving relative to the three-dimensional environment. In some embodiments, in response to detecting the viewpoint of the user and visual representation of the participant draw closer and within the three-dimensional environment, the computer system determines and or acts in accordance with a determination that playing the spatialized audio to mimic the effect of sound emanating from the position of the visual representation is too close for optimal hearing and/or is inconsistent with user preferences, the computer system forgoes playing the spatialized audio at the position of the visual representation of the participant, thus forgoing presenting of the audio as if emanating from the third position, and presents the spatialized audio corresponding to a position outside the second threshold distance as described further below. In some embodiments, the second threshold distance is measured relative to a portion of the viewpoint of the user, such as from a position corresponding to a center, a top, a bottom, a front, and/or a back of a head of the user within the three-dimensional environment.

In some embodiments, in response to obtaining the information about the second event, in accordance with a determination that the viewpoint of the user is outside of the second threshold distance of the position corresponding to the visual representation of the participant in the three-dimensional environment, such as viewpoint 704 in FIG. 7C outside of thresholds 710, the computer system presents the spatialized audio corresponding to the participant as if emanating from the third position in the three-dimensional environment corresponding to the position corresponding to the visual representation of the participant, such as the position of audio 714 as shown in FIG. 7C. For example, as described previously, in accordance with a determination that the viewpoint of the user is not within the second threshold distance, the computer system present the spatialized audio as if it were emanating from the third position (e.g., a position of a head and/or a center) of the visual representation of the participant. Presenting audio as if emanating from a position not corresponding to the position of the visual representation of the participant provides audible feedback about proximity to the visual representation and reduces the likelihood that the simulated closeness of spatialized audio causes erroneous user input moving to positions within the three-dimensional environment that interfere with visibility and/or interactivity with the visual representation, thereby reducing processing required to handle such erroneous user input.

In some embodiments, the second event includes movement of the viewpoint of the user, such as movement of viewpoint 706 in FIG. 7D, and forgoing presenting the spatialized audio corresponding to the participant as if emanating from the third position in the three-dimensional environment includes changing a position of the spatialized audio to an updated position outside of the second threshold distance of the viewpoint of the user, such as forgoing presenting of audio 714 at a position of a head of representation 704a to be outside of thresholds 710. For example, the computer system optionally raises the position of the spatialized audio (e.g., moving above) relative to the visual representation of the participant and/or the floor of the three-dimensional environment, thus optionally vertically raising the position of the spatialized audio relative to the floor. In some embodiments, the spatialized audio is additionally or alternatively moved relative to a depth relative to the viewpoint of the user. In some embodiments, the updated position of the spatial audio is greater than or equal to the second threshold distance. Changing the position of the spatialized audio reduces the likelihood that the user is unable to identify proximity with the visual representation of the user due to the position corresponding to the spatialized audio being relatively too close for optimal identification of proximity, thereby reducing processing required to handle user input erroneously moving closer to the visual representation of the user.

In some embodiments, the updated position of the spatialized audio is further away from a floor of the three-dimensional environment of the user than a position of the spatialized audio before obtaining the information about the second event, such as the position of audio 714 in FIG. 7E. For example, as described further with reference to the changing of the position of the spatialized audio illustrated in FIG. 7E. Changing the position of the spatialized audio reduces the likelihood that the user is unable to identify proximity with the visual representation of the user due to the position corresponding to the spatialized audio being relatively too close for optimal identification of proximity, thereby reducing processing required to handle user input erroneously moving closer to the visual representation of the user.

In some embodiments, the forgoing of presenting the spatialized audio corresponding to the participant as if emanating from the third position in the three-dimensional environment such as audio 714 in FIG. 7E, includes changing a position of the spatialized audio to an updated position outside of the second threshold distance of the viewpoint of the user, such as the position of audio 714 in FIG. 7E. For example, as described above with reference to the spatialized audio, the computer system optionally modifies one or more characteristics of audio captured by a second computer system used by the participant to participate in the real-time communication session to present the audio as if it were being played from a position within a physical environment of the user (e.g., from a position with the three-dimensional environment, optionally including an XR environment). In some embodiments, the computer system determines that the position of the spatialized audio is relatively too close to the viewpoint of the user for optimal interaction and/or hearing, and does not present the spatialized audio as emanating from a position with the second threshold distance of the viewpoint, as described previously, and in such embodiments, the computer system moves the position of the spatialized audio outside the second threshold distance.

In some embodiments, while the proximity between the viewpoint of the user and the visual representation of the participant satisfy the one or more second criteria, such as while the viewpoint 706 and viewpoint 704 are arranged where representation 704a is at least partially within thresholds 710, and while forgoing the presenting of the spatialized audio corresponding to the participant as if emanating from the third position in the three-dimensional environment, such as forgoing presenting audio 714 as corresponding to a head of representation 704a in FIG. 7E, the computer system obtains information about a third event, different from the first event and the second event, including a reduction in proximity between the viewpoint of the user and the visual representation of the participant, such as moving of viewpoint 706 of the user and/or movement of representation 704a in FIG. 7E. For example, the third event optionally includes a moving of the viewpoint of the user to an updated position and/or orientation relative to the three-dimensional environment and/or a moving of the representation of the participant. In some embodiments, the third event includes a changing of orientation of the viewpoint of the user, without detecting a change in position of the viewpoint and/or a change in position of the representation of the participant.

In some embodiments, in response to obtaining the information about the third event, in accordance with a determination that the third event satisfies the one or more second criteria, the computer system changes the position of the spatialized audio to a second updated position outside of the second threshold distance of the viewpoint of the user in accordance with the reduction in proximity, such as changing the position of audio 714 to the position as shown in FIG. 7E. For example, in response to detecting that a spatial relationship has changed between the viewpoint user and the representation of the participant has changed and/or is requested to be changed, and that an originally requested position of the spatialized audio is within the second threshold distance and/or a range of threshold distance relative to the user's viewpoint (e.g., a center, a front, a back, a bottom, and/or a top of a head of the user or a body of the user), the computer system optionally determines an updated position of the spatialized audio, such as a position displaced along one or more axes extending through the originally requested position (e.g., a vertical axis extending from the floor of the three-dimensional environment through the originally requested position, a depth axis extending from the viewpoint of the user through the originally requested position, and/or a horizontal axis extending parallel to the floor of the three-dimensional environment and/or normal to the depth axis). In some embodiments, the updated position is a distance (e.g., a predetermined distance) relative to a respective portion of the threshold. For example, the if the second threshold distance and/or range of distances have a spatial profile similar to an ellipsoid and/or spherical bubble at least partially surrounding the viewpoint of the user, the updated position is the distance outside of the bubble, along the one or more axes. In some embodiments, the changed position is non-overlapping with a position corresponding to the visual repreparation of the participant. For example, the changed position is not overlapping with a position of the three-dimensional environment where a head, body, and/or center of the visual representation of the participant is displayed.

In some embodiments, in response to obtaining the information about the third event, in accordance with a determination that the third event does not satisfy the one or more criteria, the computer system forgoes the changing of the position of the spatialized audio to the second updated position outside of the second threshold distance of the viewpoint of the user, such as forgoing changing the position of audio 714 to the position as shown in FIG. 7E. For example, when the requested position of the spatialized audio is not within the second threshold distance and/or range of distances, the computer system forgoes the modification of the position of the spatialized audio to a position outside of the second threshold distance, such as presenting the spatialized audio as emanating from the head of an avatar representing the participant. Changing the position of the spatialized audio reduces the likelihood that the user is unable to identify proximity with the visual representation of the user due to the position corresponding to the spatialized audio being relatively too close for optimal identification of proximity, thereby reducing processing required to handle user input erroneously moving closer to the visual representation of the user.

In some embodiments, forgoing presenting the spatialized audio corresponding to the participant as if emanating from the third position in the three-dimensional environment includes presenting the spatialized audio with reduced fidelity, such as a reduced fidelity of the audio 714 to the position as shown in FIG. 7E. For example, the computer system optionally changes one or more characteristics of the spatialized audio, such as changing of (e.g., applying one or more digital filters to) the frequency content of the spatialized audio attenuating the spatialized audio, adding noise to the spatialized audio, and/or otherwise modifying the spatialized audio. In some embodiments, the changed one or more characteristics result in audio that is presented with a relatively lower level of fidelity than if the same audio were presented as if emanating from a position beyond a threshold distance and/or range of distances relative to the viewpoint of the user. For example, when an audio clip is presented from a first position outside the threshold distance, the computer system optionally plays and/or causes playing of the audio clip with a first level of audible fidelity, and if the same audio clip is presented from a second position within the threshold distance and/or range of distances, the computer system optionally plays and/or causes playing of the audio clip with a second level of audible fidelity, less than the first level, such as muffling, distorting, and/or attenuating the audio clip. Presenting the spatialized audio with reduced fidelity provides audible feedback about the spatial relationship between the viewpoint of the user and the visual representation of the participant, thus guiding the user to resolve a suboptimal spatial relationship for viewing and/or interacting with the visual representation of the participant, thereby reducing processing required to handle user inputs erroneously exacerbating the suboptimal spatial relationship.

In some embodiments, in a view of the real-time communication session from a perspective of a second participant, that includes a second three-dimensional environment, such as from viewpoint 712 and the three-dimensional environment 1302b (e.g., an AR, AV, VR, MR, or XR environment) in FIG. 7F, in response to (e.g., in response to detecting or in response to occurrence of) the second event and in accordance with the determination that the change in proximity satisfies the one or more second criteria, such as when viewpoint 704 is within thresholds 710 relative to viewpoint 706 in FIG. 7F, the spatialized audio corresponding to the participant is presented as if emanating from a position in the second three-dimensional environment corresponding to a position corresponding to the visual representation of the participant in the second three-dimensional environment, such as a position of representation 723b in FIG. 7E, wherein the position corresponding to the spatialized audio in the second three-dimensional environment and the position corresponding to the visual representation of the participant in the second three-dimensional environment are within the second threshold distance of each other, such as when the spatialized audio corresponds to a head of representation 704b and/or to representation 722b. For example, when the user of the first computer system is viewing two visual representations of participants move within a threshold distance of one another, the first computer system optionally presents respective spatialized audio corresponding to a respective participant at respective positions corresponding to a position of the respective participant (e.g., a head, a center, and/or a body of the visual representation of the participant), and forgoes changing of the positions of the respective spatialized audio. Similarly, a third computer system used by a second participant, observing a visual representation corresponding to the user of the computer system and the visual representation of the participant move closer to one another optionally presents spatialized audio at position corresponding to visual representation corresponding to the user of the computer system and the visual representation of the participant, even when moving within the second threshold distance and/or range of distances of one another. Thus, in some embodiments, the computer system changes one or more characteristics of the spatialized audio in accordance with a determination that requested position of the spatialized audio are within a threshold from a viewpoint of the user, and forgoes the changes of the one or more characteristics of the spatialized audio to be perceived as if emanating from the position in the second three-dimensional environment corresponding to the position corresponding to the visual representation of the participant in accordance with a determination that the change in proximity does not satisfy the one or more second criteria (e.g., the requested position is not within the threshold of the viewpoint of the user). Presenting spatialized audio at positions corresponding to visual representations of participants in a communication session provides audible feedback about the positions of the visual representations, thereby reducing processing required to handle inputs where the user viewpoint moves too close and/or too far away to see and/or hear the visual representations.

In some embodiments, the first threshold distance, such as threshold 710-1 in FIGS. 7A and 7A1, is one of a plurality of threshold distances, such as thresholds 710 in FIGS. 7A and 7A1, associated with changing the visual appearance of the respective portion of the visual representation of the participant, such as representation 704a in FIGS. 7A and 7A1. For example, the computer system optionally establishes a plurality of thresholds relative to the viewpoint of the user, defining ranges of positions relative to the viewpoint. The plurality of thresholds optionally have a similar or same spatial profile relative to the three-dimensional environment, such as a plurality of spheres at least partially surrounding the viewpoint of the user, a plurality of ellipsoids, and/or one or more hybrid shapes including a variety of geometric shapes. In some embodiments, the thresholds are defined by one or more three-dimensional contours relative to the three-dimensional environment and/or the viewpoint of the user, the one or more three-dimensional contours intersecting with one another to form a hybrid shape at least partially surrounding the viewpoint of the user. For example, a first portion of a first threshold optionally comprises a portion of a sphere, corresponding to a range of positions extending in front of a head of the user and/or within a threshold distance of the head of the user, and/or optionally comprises a portion of a wedge, corresponding to a range of positions within a threshold range of positions extending behind the head of the user. In some embodiments, the plurality of thresholds respectively share the same spatial profile, and respectively have a different scale. For example, the first threshold optionally corresponds to a first threshold distance surrounding the viewpoint of the user (e.g., 0.005, 0.01, 0.05, 0.1, 0.5, or 1 m), a second threshold optionally corresponds to a second threshold distance (e.g., 0.01, 0.05, 0.1, 0.5, 1, or 1.25 m), and/or a third threshold optionally corresponds to a third threshold distance (e.g., 0.05, 0.1, 0.5, 1, 1.25, or 1.5 m), respectively different from one another (e.g., separated by intervals of 0.01, 0.05, 0.1, 0.5, or 1 m from an adjacent threshold). In some embodiments, in response to detecting that the respective portion of the visual representation of the participant moves within the respective thresholds, the computer system changes the visual appearance of the respective portion in accordance with a determination of which threshold is violated. It is understood that description of such thresholds relative to the visual representation of the participant additionally or alternatively apply to one or more other visual representations of other participants in the first communication session, and/or in other communication sessions. In some embodiments, the user of the computer system is associated with a range of positions, corresponding to the plurality of thresholds, at which participants are likely too close to the current viewpoint of the user relative to the user's preferences. For example, the thresholds optionally define a range of positions that are relatively too close for the user to view and/or interact with the majority of the visual representation of the participant. Additionally or alternatively as described further below, the thresholds optionally define a range of positions at which participants are relatively too close to the user's social preference, akin to an individual standing too close to the user of the user and thereby causing social discomfort. In some embodiments, the different respective thresholds are associated with different visual treatments (e.g., changes in visual appearance) of one or more portions of the visual representation to indicate that the participant is progressively moving closer, or further away from the user, thus providing visual feedback that such changes are consistent or inconsistent with the user's preferences. In some embodiments, the different visual treatments provide different levels of visibility of the three-dimensional environment not consumed by the visual representation of the participant, such as displaying a hand of the visual representation of the participant with a 0% opacity level.

In some embodiments, the plurality of threshold distances includes a second threshold distance and a third threshold distance, such as thresholds 710-2 and 710-3, respectively in FIGS. 7A and 7A1. For example, as described above. Determining a plurality of thresholds relative to the viewpoint of the user provides different layers of visual feedback to indicate where the viewpoint of the user is relative to the visual representation of the participant, thus guiding the user

In some embodiments, the first threshold distance corresponds to a furthest threshold distance of the plurality of threshold distances relative to the viewpoint of the user, such as threshold 710-1 relative to viewpoint 706 in FIGS. 7A and 7A1, and the second degree of visual prominence includes less opacity of the respective portion of the visual representation of the participant than the first degree of visual prominence, such as an opacity of hand 716a in FIG. 7C. For example, as described above with respect to the plurality of distances, in some embodiments, the computer system determines one or more thresholds relative to the viewpoint of the user, and when visual representation of participant(s) move within the one or more thresholds, visual prominence of offending portion(s) of the visual representation are changed. For example, an outermost threshold relative to the viewpoint of the user is optionally determined (e.g., 0.005, 0.01, 0.05, 0.1, 0.5, or 1 m from the viewpoint that is a further threshold compared to other thresholds of the plurality of thresholds), and in response to determining that a respective portion of a visual representation of a participant of the communication session moves within the outermost threshold, the computer system optionally changes a visual appearance of the offending, respective portion. The changing of the visual appearance optionally includes changing a level of opacity, brightness, saturation, a magnitude of a blurring effect, and/or opacity of a border surrounding the respective portion. In some embodiments, the offending portion(s) are decreased in a degree of visual prominence relative to the three-dimensional environment, such as decreasing in the level of opacity, brightness, saturation, and/or opacity of the border, and/or an increase in a magnitude of the blurring effect. Thus, the computer system optionally changes the visual appearance of offending portion(s) of visual representation(s) in accordance with a determination that the offending portion(s) move within the furthest threshold relative to the viewpoint of the user, optionally in a first manner. Determining a furthest threshold distance at which the computer system initiates changing of degree(s) of visual prominence of portion(s) of the visual representation of the participant provides an early visual cue that the visual representation of the participant is moving within non-preferred distance(s) of the viewpoint, thus suggesting user input to resolve the non-preferred spatial arrangement between the viewpoint and the threshold distance, thereby reducing user input erroneously failing to improve the non-preferred spatial arrangement.

In some embodiments, the visual representation of the participant is a first visual representation before obtaining the information about the first event, such as representation 704a in FIG. 7D. For example, the computer system optionally displays a first form of the visual representation of the participant, such as an anthropomorphic avatar having a human-like shape, dimensions, and/or body parts before the first event is detected and/or while the visual representation of the participant is outside of a threshold of the viewpoint of the user.

In some embodiments, in response to obtaining information about the first event corresponding to the request to move the respective portion of the visual representation of the participant to the respective position within the three-dimensional environment, such as movement of hand 716 in FIG. 7C, and, in accordance with a determination that the first event satisfies one or more second criteria, including a criterion that is satisfied when the respective position within the three-dimensional environment is within a second threshold distance of a viewpoint of the user in the three-dimensional environment, such as threshold 710-2 in FIG. 7D, wherein the second threshold distance is a threshold distance of the plurality of threshold distances that is smaller than the first threshold distance, the computer system replaces the first visual representation of the participant with a second visual representation of the participant, different from the first visual representation, such as replacing representation 704a with representation 722a in FIG. 7E. For example, the computer system optionally detects and/or detects an indication of the viewpoint of the user and/or the visual representation move relative to the three-dimensional environment, such as an arm of the visual representation of the first form moving throughout the three-dimensional environment. In some embodiments, the first event is detected while the visual representation of the participant is the first visual representation described above. For example, the computer system detects an indication that the participant has moved their hand (e.g., communicated from a second computer system used by the participant), requesting that a corresponding portion of the visual representation of the participant displayed in the real-time communication session move within a threshold of the viewpoint of the user, at times referred to herein as an intermediate threshold (e.g., different from the furthest threshold, such as closer to the viewpoint of the user than the furthest threshold described previously). In response to detecting the indication, the computer system optionally changes the form of the visual representation as a whole, and/or forgoes changing of a visual appearance of a respective portion of the visual representation that is moved to the respective position that is within the intermediate threshold. For example, the second, replacement form is optionally a second visual representation, such as a visual representation having one or more characteristics as described with reference to the representation having “abstracted features” and/or the representation having a modified “spatial fidelity,” previously. Additionally or alternatively, the second visual representation is optionally a three-dimensional coin, including two circular faces indicating a direction of the orientation of the participant relative to the three-dimensional environment. In some embodiments, the second visual representation is oriented relative to the three-dimensional environment based on an orientation of the participant. For example, a face of a geometric representation of the participant, such as a rectangular face of a rectangular prism, is optionally displayed replacing an anthropomorphic representation of the participant, where the rectangular face has an orientation that mirrors the orientation of a face of the anthropomorphic representation before moving within the intermediate threshold. In some embodiments, the intermediate threshold corresponds to a threshold distance and/or range of distances less than a furthest threshold, as described previously. Replacing the first visual representation with the second visual representation provides easily recognizable visual feedback about a changed spatial relationship between the viewpoint of the user and the visual representation of the participant, thus changing visibility of the three-dimensional environment that does not present an apparent obscuring of the three-dimensional environment and guiding the user to further change the spatial relationship, thereby reducing user input required to change visibility of the three-dimensional environment manually and/or reducing erroneous user input undesirably changing the spatial relationship between the viewpoint of the visual representation.

In some embodiments, in response to obtaining information about the first event corresponding to the request to move the respective portion of the visual representation of the participant to the respective position within the three-dimensional environment, such as movement of a head of representation 722a in FIG. 7D (For example, as described above), in accordance with a determination that the first event satisfies one or more second criteria, including a criterion that is satisfied when the respective position within the three-dimensional environment is within a second threshold distance of a viewpoint of the user in the three-dimensional environment, such as threshold 710-3 in FIG. 7E, wherein the second threshold distance is a threshold distance of the plurality of threshold distances that is smaller than the first threshold distance, such as threshold 7102—in FIG. 7E, the computer system ceases display of the visual representation of the participant, such as illustrated in FIG. 7F. For example, the computer system optionally determines a threshold that is closest to the viewpoint of the user than other thresholds included in the plurality of thresholds. As an additional example, the threshold distance and/or the range of threshold distances defining the closest threshold have magnitude(s) that are less than other thresholds distances corresponding to other threshold(s). In some embodiments, the ceasing of display of the visual representation includes completely decreasing the opacity of the visual representation. In some embodiments, while the first computer system ceases display of the visual representation, another computer system observing a visual representation of the user and move closer to a visual representation of the participant move within the closest threshold of each other maintains display of the respective visual representation (e.g., with a second form of the respective visual representations, as described previously). Ceasing display of the visual representation of the participant moving within the closest threshold of the plurality of thresholds improves visibility of the three-dimensional environment, thus allowing the user to direct user input toward portions of the three-dimensional environment without requiring manual input to improve the visibility, thus reducing processing performed by the first computer system. In some embodiments, the first computer system displays representations of a plurality of participants of the real-time communication session, including the previously described visual representation of the participant, at time referred to herein as a first avatar, and understood as referring to various embodiments not strictly limited to displaying and/or changing an avatar.

In some embodiments, while displaying, via the display generation component, a visual representation of a second participant, different from the participant, within the three-dimensional environment concurrently with the visual representation of the participant, the computer system obtains information about a second event, different from the first event, corresponding to a request to move the visual representation of the participant relative to the visual representation of the second participant in the three-dimensional environment, such as information corresponding to movement of representation 706b and/or representation 704b in FIG. 7B. For example, the computer system optionally displays a second avatar, different from the first avatar, corresponding to a third computer system other than the second computer system (described previously), that the participant corresponding to the second avatar is using to participate in the real-time communication session. In some embodiments, while displaying the first and/or the second avatar, and/or before displaying the first and/or second avatars (e.g., while the first and/or second avatars correspond to position in the three-dimensional environment outside a field of view presented via the display generation component at the first computer system), the computer system obtains information (e.g., from the second and/or third computer systems) requesting movement of the first and/or second avatars. In some embodiments, the second event is detected while the first and second avatars are outside of a respective threshold distance of one another (e.g., 0.05, 0.1, 0.25, 0.4, 0.5, 0.75, and/or 1 m). In some embodiments, the second event includes a changing of a user viewpoint to an updated orientation relative to the three-dimensional environment that includes the first and the second avatar, and does not include obtaining information corresponding to requests to move the first and/or second avatars (e.g., the first and second avatars are within the threshold distance of one another). In some embodiments, the respective threshold distance is a same magnitude and/or range of distances as the first threshold distance and/or a range of threshold differences, and determined relative to the first and/or second avatar, instead of relative to the viewpoint of the user of the first computer system.

In some embodiments, in response to obtaining the information about the second event, in accordance with a determination that the second event satisfies one or more second criteria, including a criterion that is satisfied when the visual representation of the participant and the visual representation of the second participant are within a second threshold distance of one another (e.g., the same and/or similar as the first threshold distance and/or range of distances), such as representation 704b being within thresholds 710 of representation 706b, the computer system changes a visual appearance of a first portion of the visual representation of the participant, such as a head of representation 704b in FIG. 7C, and changes a visual appearance of a first portion of the visual representation of the second participant, such as head 718b of representation 706b in FIG. 7C. For example, the changing of the visual appearance of the first portion of the first avatar has one or more characteristics of the changing of the visual appearance of the first portion described previously, and the changing of the visual appearance of the first portion of the second avatar (e.g., the visual representation of the second participant). In some embodiments, the changing of respective portions share one or more characteristics. For example, the changing of both first portions optionally includes changing of a degree of visual prominence—as described previously—optionally by a same magnitude (e.g., decreasing or increasing a same level of opacity, brightness, saturation, a magnitude of blurring effect, and/or display of a border).

In some embodiments, in response to obtaining the information about the second event, in accordance with a determination that the second event does not satisfy the one or more second criteria, the computer system forgoes the changing of the visual appearance of the first portion of the visual representation of the participant and the visual appearance of the first portion of the visual representation of the second participant, such as forgoing the changing of visual appearance of head 718b and hand 716b in FIG. 7C. For example, similarly as described previously with reference to forgoing changing of the visual appearance of the first portion of the visual representation of the participant (e.g., of the first avatar), the first computer system optionally forgoes the changing of the visual appearance of the first portion of the visual representation of the second participant (e.g., of the second avatar). Changing the visual appearance of portions of respective visual representations of participants provides visual feedback about proximity of the visual representation of the participants, thus reducing the likelihood that the user provides user input under an inaccurate understanding of the spatial relationship between the respective visual representations, thereby reducing processing required to handle such user input.

In some embodiments, changing the visual appearance of the first portion of the visual representation of the second participant includes ceasing display of the first portion of the visual representation of the participant, such as ceasing display of head 718b in FIG. 7E. For example, the first computer system optionally stops displaying the first portions of the visual representations of the first avatar and/or second avatar, as described previously. In some embodiments, the ceasing is performed abruptly or in rapid succession. In some embodiments, the ceasing is animated, presenting a gradual ceasing of the first portions and/or ceasing display of gradually increasing, respective sub-portions of the first portions. In some embodiments, when ceasing display of the first portions, the computer system maintains display of other portions of the respective avatars not within the second threshold distance of one another. In some embodiments, while displaying the first or the second avatar, and while the other (e.g., the second or the first avatar) correspond to a position outside of the three-dimensional environment visible within field-of-view of the display generation component, the computer system detects a second event described previously, and changes the visual appearance of the first portion of the currently displayed avatar moving within the second threshold distance of the not currently displayed avatar, such as when a hand of the currently displays avatar extends toward a periphery of the field-of-view and within the second threshold distance of the not currently displayed avatar. In some embodiments, the changing of visual appearance of the first portions occurs concurrently.

In some embodiments, changing the visual appearance of the first portion of the visual representation of the second participant includes ceasing display of the first portion of the visual representation of the second participant, such as ceasing display of hand 716b in FIG. 7E. For example, as described above. Changing the visual appearance of portions of respective visual representations of participants provides visual feedback about proximity of the visual representation of the participants, thus reducing the likelihood that the user provides user input under an inaccurate understanding of the spatial relationship between the respective visual representations, thereby reducing processing required to handle such user input.

In some embodiments, changing the visual appearance of the first portion of the visual representation of the participant includes reducing a degree of visual prominence of the first portion of the visual representation of the participant, such as changing visual appearance of head 718b in FIG. 7D. In some embodiments, the computer system changes the degree of visual prominence of portions of the first and/or second avatars, as described previously. In some embodiments, the computer system reduces the visual prominence of the intersecting portions of the respective avatars.

In some embodiments, changing the visual appearance of the first portion of the visual representation of the second participant includes reducing a degree of visual prominence of the first portion of the visual representation of the second participant, such as changing visual prominence of hand 716b in FIG. 7D. In some embodiments, the computer system changes the visual prominence of the first portions of the first and second avatars by a same degree. In some embodiments, the avatars have a same form, and the respective first portions are different portions of the form. For example, the computer system optionally detects a hand of the first avatar move within the second threshold distance of the second avatar, and optionally changes the visual appearance (e.g., degree of visual prominence) of the hand of the first avatar and the head of the second avatar. Changing the visual appearance of portions of respective visual representations of participants provides visual feedback about proximity of the visual representation of the participants, thus reducing the likelihood that the user provides user input under an inaccurate understanding of the spatial relationship between the respective visual representations, thereby reducing processing required to handle such user input.

In some embodiments, changing the visual appearance of the first portion of the visual representation of the second includes replacing the visual representation of the participant with a replacement visual representation of the participant, such as replacing representation 706b with representation 724b in FIG. 7E. For example, similar to as described when the respective portion of the visual representation of the participant moves within the first threshold distance of the viewpoint of the user, the computer system optionally displays the first avatar and/or the second avatar as first visual representations (e.g., first forms) when outside of the second threshold distance of one another. In response to obtaining information indicative of movement within the second threshold distance of one another, the computer system optionally changes the visual representations to be a second form. In some embodiments, when a plurality of visual representation of participants are in proximity to one another, the visual representation of a respective participant is a visual representation is dictated by the closest proximity of respective visual representations. For example, when the first avatar and the second avatar are within the second threshold distance of one another, optionally corresponding to the intermediate threshold described previously, and a third avatar is within a third threshold distance of the first avatar that is the furthest threshold of a plurality of threshold determined relative to a position of the first avatar, the computer system displays the first avatar and the second avatar with the second visual representation and the third avatar with the first visual representation.

In some embodiments, changing the visual appearance of the first portion of the visual representation of the second participant includes replacing the visual representation of the second participant with a replacement visual representation of the second participant, such as replacing representation 704b with representation 722b in FIG. 7E. For example, as described above. Replacing respective visual representations of participants provides visual feedback about proximity of the visual representation of the participants, thus reducing the likelihood that the user provides user input under an inaccurate understanding of the spatial relationship between the respective visual representations, thereby reducing processing required to handle such user input.

In some embodiments, the one or more first criteria include a criterion that is satisfied when a user setting included in a user account associated with the electronic device is enabled, such as a user setting included in a user count registered to computer system 101a (e.g., tablet, smartphone, wearable computer, or head mounted device) in FIGS. 7A and 7A1. For example, the computer system optionally maintains one or more user settings associated with the real-time communication session and/or an operating system of the computer system, including one or more settings to enable the changing of the visual appearance of portion(s) of visual representation of participants. In response to detecting one or more inputs request display of the one or more user settings, the computer system optionally displays a control user interface, including one or more selectable options that are respectively selectable to initiate a process to modify the one or more user settings. Such a process optionally includes toggling the changing of the visual appearance of the portion(s) of the visual representation of the participants. Accordingly, in response to detecting a respective portion of the visual representation move within a threshold distance of the current viewpoint, the computer system optionally forgoes modification of visual appearance of the respective portion in accordance with a determination that the user setting is not enabled. In some embodiments, when the user setting is not enabled, the one or more first criteria are not satisfied due to the lack of satisfaction of the criterion that is satisfied when the user setting is enabled, and in response to detecting a portion of the visual representation of the participant move to the respective position with a threshold distance of the viewpoint of the user, the computer system forgoes changing of the visual appearance of the portion of the visual representation (e.g., maintains the visual appearance of the portion of the visual representation). Providing user setting(s) to enable the changing of the visual appearance of offending portion(s) of visual representation(s) moving within the first threshold distance of the viewpoint allows the user to dictate whether or not the visual appearance is able to be changed, thus providing visual feedback in accordance with user preference, thereby reducing the likelihood that the user provides erroneous input based on mistaken understandings of proximity between the viewpoint and the offending portion(s).

In some embodiments, the first threshold distance is adjustable in response to user input, such as user input detected by computer system 101a (e.g., tablet, smartphone, wearable computer, or head mounted device) in FIGS. 7A and 7A1. For example, the one or more user settings described previously optionally include a respective settings that is configurable. As an example, the computer system optionally detects one or more inputs directed to the user interface including the one or more settings, and optionally thereafter determines visual appearance of portion(s) of visual representation of participants in accordance with the one or more inputs. While the first threshold distance is set to a first magnitude and the visual representation of the participant is within the first threshold distance, for example, the computer system optionally displays the first portion of the visual representation the participant (e.g., a hand, arm, and/or finger) with the second visual appearance described previously. In response to detecting one or more inputs changing the first threshold distance to be a second magnitude, less than the first, such that the first portion of the visual representation is outside of the second magnitude of the viewpoint of the user, the computer system optionally displays the first portion of the visual representation of the participant with the first visual appearance. In some embodiments, the one or more user settings optionally include a setting affect a magnitude of a plurality of thresholds (e.g., the closest, intermediate, and/or further thresholds described previously). In some embodiments, the computer system maintains separate user settings to individually define the plurality of thresholds. In some embodiments, the computer system maintains one or more user settings including a regional preference. For example, in addition to or in the alternative to the express setting of magnitude, the computer system optionally determines the magnitude of the first threshold distance based on a current country setting. The current country setting optionally implicates a cultural preference for proximity of another person (e.g., corresponding to the visual representation of the participant), and thereby changes the magnitude of the first threshold distance. Providing one or more settings to define the magnitude of the first threshold distance allows the user to define where visual representation of participants are changed relative to the user's preference, thereby reducing the likelihood that the user experiences cognitive discomfort and is provided visual feedback in time to prevent cognitive discomfort and/or burden.

In some embodiments, the computer system obtains information about a second event, different from the first event, including movement of a hand of the user of the computer system, such as a hand included in representation 706a in FIG. 7I, or corresponding to a request to move the respective portion of the visual representation of the participant, such as a hand of representation 704a in FIG. 7I, such that a position corresponding to the hand of the user and a position of the respective portion of the visual representation of the participant correspond to a same position within the three-dimensional environment, such as the position of representations of such hands in FIG. 7J. For example, as described previously, the computer system optionally detects movement of the hand of the user and/or obtains information corresponding to a request to move a portion (e.g., hand, finger, and/or arm) of the visual representation of the participant. In accordance with a determination that the hand of the user and the portion of the visual representation correspond to a same and/or close positions within the three-dimensional environment, the computer system optionally provides expressive visual feedback, such as an animation indicating a shaking of hands and/or a simulated contact with an avatar corresponding to the participant.

In some embodiments, in response to obtaining the information about the second event, the computer system displays, via the display generation component, an animation in the three-dimensional environment visually indicating a simulated contact between the hand of the user and the respective portion of the visual representation of the participant, such as indication 728a in FIG. 7J, wherein animation is different from an animation of movement of the respective portion of the visual representation of the participant (and optionally different from an animation of movement of a representation of the hand of the user), such as different from an animated movement of representation 706a from FIG. 7I to FIG. 7J. For example, the computer system optionally displays a series of lines surrounding and concentrically arranged hands of the user and the representation of the participant that gradually or suddenly appear, a shape and/or volume having a fill pattern surrounding the hands, a visual effect emanating from a location of where the hands meet (e.g., a flash of simulated light), and/or text indicating the animation. In some embodiments, the animation is similarly displayed at a second computer system of the participant in response to obtaining information about the simulated contact. In some embodiments, a third computer system viewing the visual representation of the participant and a visual representation of the user also displays the animation. Providing an animation indicating simulated contact provides visual feedback about virtual interactions analogous to physical interactions, thereby reducing cognitive burden of the user attempting to make simulated contact. It should be understood that the particular order in which the operations in method 800 have been described is merely exemplary and is not intended to indicate that the described order is the only order in which the operations could be performed. One of ordinary skill in the art would recognize various ways to reorder the operations described herein.

FIGS. 9A-9Q illustrate examples of a computer system arranging representations and/or viewpoints of users that are participating in a real-time communication session (e.g., “participants” in the session), where the users are placed at virtual locations according to a spatial template that is selected, by the computer system, based on various criteria, including the quantity of user participating in the real-time communication session and optionally, the activity in which they are engaged.

In some embodiments, a computer system (e.g., computer system 101) presents (e.g., displays or otherwise makes visible to a user of the computer system, such as via optical passthrough) a three-dimensional environment that optionally includes virtual objects, a virtual environment, and/or a representation of a physical environment of the computer system, such as a three-dimensional environment discussed with reference to methods 800, 1000, 1200, 1400, 1600, and/or 1800. For example, the computer system optionally presents a VR, AR, MR, and/or passthrough environment as previously described.

In some embodiments, a user of computer system 101 (e.g., tablet, smartphone, wearable computer, or head mounted device) can participate in a multi-user real-time communication session (e.g., a co-presence session) with one or more additional users by establishing the real-time communication session with one or more additional computer systems of the one or more additional users. Such real-time communication sessions enable interaction between the participants and/or enable sharing of virtual content between the participants within the three-dimensional environment, such as described in more detail with reference to methods 800 and 1200. In some embodiments, when computer system 101 (e.g., tablet, smartphone, wearable computer, or head mounted device) is participating in a real-time communication session with one or more other users, computer system 101 (e.g., tablet, smartphone, wearable computer, or head mounted device) displays representations of the one or more other users (such as three-dimensional avatars, two-dimensional live video images, or other representations) within the three-dimensional environment to facilitate more-realistic interactions between users.

In some embodiments, the viewpoint of the user of computer system 101 (e.g., tablet, smartphone, wearable computer, or head mounted device) is optionally associated with a virtual location within the three-dimensional environment and/or a physical location of the user in a physical environment of the user, and the computer system 101 (e.g., tablet, smartphone, wearable computer, or head mounted device) optionally emulates the field of view of the user by presenting the three-dimensional environment as though the user was standing at that virtual location (e.g., the representations of the additional users and/or virtual content are displayed as seen from the perspective of that virtual location).

As described herein, in some embodiments, when a new user joins the real-time communication system, the computer system 101 (e.g., tablet, smartphone, wearable computer, or head mounted device) optionally arranges (and/or re-arranges) the representations and/or viewpoints of the participants in response to detecting the new user's arrival and based on a quantity of users participating in the real-time communication session. (To simplify the subsequent discussion, the term “arranges” should be interpreted to include arranges and/or rearranges.)

In some embodiments, computer system 101 (e.g., tablet, smartphone, wearable computer, or head mounted device) arranges the representations and/or viewpoints of users in accordance with a template (e.g., a pre-defined spatial template) that is selected, by computer system 101, based at least in part on a quantity of users participating in the multi-user communication system (e.g., including the first user and the one or more additional users) and optionally based on other criteria, as discussed herein. In some embodiments, a template specifies a particular quantity of virtual locations (which are optionally referred to as “slots” in the template) arranged in a particular closed-form or open-form shape, such as slots along the perimeter of a circle, ellipse, square, arc, line, U-shape, or other shape. In some embodiments, computer system 101 (e.g., tablet, smartphone, wearable computer, or head mounted device) arranges representations and/or viewpoints of users at virtual locations corresponding to slots in a template. For example, the computer system 101 (e.g., tablet, smartphone, wearable computer, or head mounted device) selects, in accordance with the template, virtual locations in the three-dimensional environment at which the representations of the users are displayed and/or at which viewpoints of the users are located (e.g., locations at which they are automatically placed by computer system 101, without user inputs selecting the locations). In some embodiments, computer system 101 (e.g., tablet, smartphone, wearable computer, or head mounted device) selects the template based on additional criteria, such as based on whether a participant is a spatial or non-spatial participant (e.g., as described with reference to method 1200), and/or whether a participant has shared virtual content with other participants (e.g., as described with reference to method 1200).

FIG. 9A depicts illustrative examples of templates 900a-g that computer system 101 (e.g., tablet, smartphone, wearable computer, or head mounted device) optionally uses to arrange representations (e.g., avatars) and/or viewpoints of users within a three-dimensional environment during a multi-user real-time communication session in response to detecting that various criteria are satisfied (e.g., that a new user has joined the session, that a user has requested to rearrange participants, and/or that a user has shared virtual content with the other users, among other possibilities).

In these and subsequently discussed templates, the viewpoint of the first user 902 (e.g., the user of computer system 101) is represented by an avatar without patterning on the shirt (e.g., with a solid white shirt). In some embodiments, the computer system 101 (e.g., tablet, smartphone, wearable computer, or head mounted device) does not display a representation of the first user (e.g., the user of computer system 101). For example, the first user optionally does not see their own avatar via a display of computer system 101, though an avatar of the first user is optionally displayed by computer systems of other users participating in the real-time communication session.

Template 900a depicts an arrangement of the viewpoint of the first user 902 and a representation of a second user 904 participating in the real-time communication session. Template 900a is optionally selected by computer system 101 (e.g., tablet, smartphone, wearable computer, or head mounted device) when there are two participants in the real-time communication session, optionally when neither participant has shared (and/or or is currently sharing) virtual content. The viewpoint of the first user 902 is located at a first virtual location in a three-dimensional environment and the representation of the second user 904 is displayed at a second virtual location in the three-dimensional environment relative to the viewpoint of the first user 902. The first virtual location and the second virtual location are located along a perimeter of a first circle 914a having a first radius 916a and are separated from each other by a virtual distance that is equal to twice the first radius 916a. (The circle 914a shown in FIG. 9B is for illustrative purposes and is not necessarily displayed in the three-dimensional environment.) Template 900a can optionally be described as a ring template (e.g., a template having a closed-form shape, such as a circle or ellipse) that arranges participants around a circle 914a of radius 916a having two slots (e.g., two virtual locations distributed along the perimeter of circle 914a). In some embodiments, the first radius 916a is selected, by computer system 101, based on having fewer than a threshold quantity of participants in the real-time communication session, such as fewer than 3, 4, 5, 6, or 7 participants. In some embodiments, the computer system 101 (e.g., tablet, smartphone, wearable computer, or head mounted device) selects a smaller radius (e.g., by selecting a ring template having a smaller circle) when fewer users are participating in the real-time communication session and selects a larger radius when more users are participating in the session to maintain appropriate spacing between participants and mimic real-world spatial arrangements.

As shown in the example of template 900a, the viewpoint of the first user 902 and the representation of the second user 904 are each facing toward each other (e.g., as described with reference to methods 1000 and 1200) and/or are facing towards the center 942a of the first circle 914a, as indicated by gaze directions 902a (associated with the first user) and 904a (associated with the second user). Such a spatial arrangement relative to the viewpoint of the first user (including the facing direction) facilitates communication between the first user and the second user.

Template 900b depicts an arrangement that includes the viewpoint of the first user 902, the representation of the second user 904, and a representation of a third user 906 that are all participating in the real-time communication session. Template 900b is optionally selected by computer system 101 (e.g., tablet, smartphone, wearable computer, or head mounted device) when there are three participants in the real-time communication session, optionally when none of the participants has shared (and/or or is currently sharing) virtual content. As in template 900a, the viewpoint of the first user 902, the representation of a second user 904, and the representation of a third user 906 are all located at respective virtual locations along a perimeter of the first circle 914a having the first radius 916a, facing the center 942a of first circle 914a, and uniformly spaced along the perimeter of the first circle 914a.

Template 900c depicts an arrangement that includes the viewpoint of the first user 902, the representation of a second user 904, the representation of the third user 906, and a representation of a fourth user 908 that are all participating in the real-time communication session. Template 900c is optionally selected by computer system 101 (e.g., tablet, smartphone, wearable computer, or head mounted device) when there are four participants in the real-time communication session, optionally when none of the participants has shared (and/or or is currently sharing) virtual content. As in templates 900a and 900b, the viewpoint of the first user 902, the representation of a second user 904, the representation of a third user 906, and the representation of the fourth user 908 are all located at respective virtual locations 922a-d along a perimeter of the circle 924a and are facing the center of first circle 924a.

Template 900d depicts an arrangement that includes the viewpoint of the first user 902, the representation of the second user 904, the representation of the third user 906, the representation of the fourth user 908, and a representation of a fifth user 910 that are all participating in the real-time communication session. Template 900d is optionally selected by computer system 101 (e.g., tablet, smartphone, wearable computer, or head mounted device) when there are five participants in the real-time communication session, optionally when none of the participants has shared (and/or or is currently sharing) virtual content. As in templates 900a-c, the viewpoint of the first user 902, the representation of a second user 904, the representation of the third user 906, the representation of the fourth user 908, and the representation of the fifth user are all located at respective virtual locations along a perimeter of a circle 914b and facing the center 942b of the circle, but in this case the circle has a larger (e.g., longer) radius 916b than first circle 914a to maintain appropriate spacing between the participants. In some embodiments, the second radius 916b is selected, by computer system 101 (e.g., tablet, smartphone, wearable computer, or head mounted device) (e.g., by selecting template 900d), based on having more than a threshold quantity of participants in the real-time communication session (in this example, more than four), such as described with reference to method 1000.

Template 900e depicts an arrangement that includes the viewpoint of the first user 902, the representation of a second user 904, the representation of the third user 906, and the representation of the fourth user 908. Template 900e is optionally selected by computer system 101 (e.g., tablet, smartphone, wearable computer, or head mounted device) when there are four participants in the real-time communication session and one of the participants has shared a first type of virtual content (e.g., media content, such as a movie). In this case, the viewpoint of the first user 902, the representation of the second user 904, the representation of the third user 906, and the representation of the fourth user 908 are located at respective virtual locations (e.g., with uniform inter-location spacing) along a perimeter of an open-form shape, in this case an arc 917, and are facing the virtual content 922 at a distance 920 from virtual content 922. Such an arrangement (e.g., a content-viewing template) facilitates group viewing of media content or other virtual content (such as an application window) that is displayed in a vertical orientation within the three-dimensional environment.

Template 900f depicts an arrangement that includes the viewpoint of the first user 902, the representation of the second user 904, the representation of the third user 906, the representation of the fourth user 908, and the representation of the fifth user 910. Template 900f is optionally selected by computer system 101 (e.g., tablet, smartphone, wearable computer, or head mounted device) when there are five participants in the multi-user communication system and one of the participants has shared a second type of virtual content (e.g., a horizontally displayed rectangular map or game). In this case, the viewpoint of the first user 902, the representation of the second user 904, the representation of the third user 906, the representation of the fourth user 908, and the representations of the fifth are located at respective virtual locations around the perimeter of the shared content (e.g., along the sides of a rectangle) facing the shared content 924. Such an arrangement facilitates group viewing of rectangular shared content that is displayed in a horizontal orientation within the three-dimensional environment, such as a map displayed on a floor plane of the three-dimensional environment. In this example, participants are arranged non-uniformly around the perimeter (e.g., with varying space between participants, to mimic arrangements that users would be likely to select in the real world).

Template 900g depicts an arrangement that includes the viewpoint of the first user 902, the representation of the second user 904, the representation of the third user 906, and the representation of the fourth user 908. Template 900g is optionally selected by computer system 101 (e.g., tablet, smartphone, wearable computer, or head mounted device) when there are four participants in the multi-user communication system and one of the participants has shared a third type of virtual content (e.g., a virtual board game). In this case, the viewpoint of the first user 902, the representation of the second user 904, the representation of the third user 906, and the representation of the fourth user 908 are located at respective virtual locations 922f-i around the shared content 925 and facing the shared content 925. Such an arrangement facilitates group viewing of circular shared content that is displayed in a horizontal orientation within the three-dimensional environment, such as a virtual board game displayed on virtual circular table.

Additional details regarding the selection of templates in response to various criteria are described with reference to FIGS. 9B-9Q.

FIG. 9B illustrates a computer system 101 (e.g., tablet, smartphone, wearable computer, or head mounted device) (e.g., an electronic device) displaying, via a display generation component (e.g., display generation component 120 of FIG. 1), a three-dimensional environment 926 (e.g., an AR, AV, VR, MR, or XR environment) from a viewpoint of the user of the computer system 101 (e.g., tablet, smartphone, wearable computer, or head mounted device) (e.g., facing the back wall of the physical environment in which computer system 101 (e.g., tablet, smartphone, wearable computer, or head mounted device) is located). FIG. 9B illustrates an overhead (schematic) view relative of three-dimensional environment 926, and a view of the three-dimensional environment presented by computer system 101 (e.g., tablet, smartphone, wearable computer, or head mounted device) (e.g., an electronic device) via a display generation component 120 (e.g., as described with reference to FIG. 1).

In some embodiments, computer system 101 (e.g., tablet, smartphone, wearable computer, or head mounted device) includes and/or is communicatively linked with the display generation component 120, one or more physical buttons 932, 934, and 936, and/or one or more image sensors 314 (e.g., image sensors 314 of FIG. 3). The image sensors optionally include one or more of a visible light camera, an infrared camera, a depth sensor, or any other sensor the computer system 101 (e.g., tablet, smartphone, wearable computer, or head mounted device) would be able to use to capture one or more images of a user of computer system 101 (e.g., tablet, smartphone, wearable computer, or head mounted device) or a part of the user (e.g., one or more hands of the user) while the user interacts with the computer system 101. In some embodiments, the three-dimensional environments illustrated and described below could also be implemented on (e.g., presented by) a head-mounted display that includes a display generation component that presents the three-dimensional environment to the user, and sensors to detect the physical environment and/or movements of the user's body and/or hands (e.g., external sensors facing outwards from the user), and/or attention (e.g., including gaze) of the user (e.g., internal sensors facing inwards towards the face of the user).

The figures herein illustrate views of three-dimensional environment 926 (e.g., an AR, AV, VR, MR, or XR environment) presented to the user by computer system 101 (e.g., tablet, smartphone, wearable computer, or head mounted device) (e.g., a virtual environment displayed via the display generation component 120 of computer system 101) and schematic views of the three-dimensional environment (such as overhead view 927 of FIG. 9B) to illustrate the spatial relationships between representations and/or viewpoints of participants (e.g., the virtual locations of representations and/or viewpoint of participants within three-dimensional environment 926 relative to the viewpoint of the first user 902 (e.g., the user of computer system 101) and relative to virtual objects within the three-dimensional environment 926). In the examples herein, the overhead views and/or the views presented by computer system 101 (e.g., tablet, smartphone, wearable computer, or head mounted device) optionally do not depict physical objects that may be within the physical environment in the field of view of computer system 101 (e.g., tablet, smartphone, wearable computer, or head mounted device) (e.g., from the viewpoint of the user of computer system 101); e.g., for simplicity, the views optionally depict the shared virtual environment of the users without showing details regarding the physical environment of computer system 101. In some embodiments, the positions and/or orientations of users relative to their physical environment have one or more of the characteristics and/or behaviors discussed with reference to method 800.

Furthermore, for brevity, in some of the figures herein, only an overhead view of the three-dimensional environment is shown without showing the corresponding view of the three-dimensional environment that would be presented by computer system 101. It should be understood that, in these cases, computer system 101 (e.g., tablet, smartphone, wearable computer, or head mounted device) would present the view of the three-dimensional environment as it would be visible to the first user via computer system 101 (e.g., tablet, smartphone, wearable computer, or head mounted device) (e.g., from the perspective of the viewpoint of the first user as shown in the overhead view).

As shown in FIG. 9B, three-dimensional environment 926 (e.g., an AR, AV, VR, MR, or XR environment) includes virtual objects 928 and 930, which optionally represent virtual media content, virtual application windows, virtual representations of real-world objects, animated virtual elements (e.g., waving grass or rippling water), and/or other types of virtual objects. Overhead view 927 depicts the viewpoint of the first user 902 at a first virtual location 940a in the three-dimensional environment 926 (e.g., the viewpoint of the first user 902 is roughly centered on first virtual location 940a).

FIG. 9B also depicts three-dimensional environment 926 as presented via display generation component 120. The view of three-dimensional environment 926 corresponds to the viewpoint of the first user 902. For example, the view of three-dimensional environment 926 depicts what is visible to the first user (via display generation component 120) when the viewpoint of the first user 902 is located as shown in the overhead view 927 and the first user is looking in the direction indicated by gaze direction 902b. For example, virtual objects 928 and 930 are displayed, via display generation component 120, at a viewing angle and orientation based on the viewpoint of the user 902 being located at first virtual location 940a and the first user looking in the indicated gaze direction 902b.

FIG. 9B depicts an example in which the first user is not currently participating in a real-time communication session with other users. Thus, there are no representations of other users (e.g., avatars) shown in overhead view 927 or displayed via display generation component 120.

FIG. 9C depicts an example in which a second user is participating in (e.g., has joined and/or arrived in) a real-time communication session with the first user. In some embodiments, in response to detecting the arrival of the second user in the real-time communication session and based on a determination that there are a total of two users participating in the real-time communication session (e.g., the first user and the second user), computer system 101 (e.g., tablet, smartphone, wearable computer, or head mounted device) selects a virtual location at which to display a representation of the second user 904 relative to the viewpoint of the first user 902 (and, optionally, selects a virtual location at which to place the viewpoint of the first user 902) in accordance with a first template, such as in accordance with template 900a described with reference to FIG. 9A. For example, computer system 101 (e.g., tablet, smartphone, wearable computer, or head mounted device) displays the representation of the second user 904 at a second virtual location 940b relative to a first virtual location 940a of the viewpoint of the first user 902, such as directly across from the viewpoint of the first user 902 and along a perimeter of a circle 914c upon which the viewpoint of the first user 902 is located. In the example of FIG. 9B, computer system 101 (e.g., tablet, smartphone, wearable computer, or head mounted device) displays the representation of the second user 904 with a facing direction towards the center 942a of the circle 914c and towards the viewpoint of the first user 902 (as indicated by gaze direction 904b). (For simplicity, gaze directions are not depicted in subsequent figures but can be inferred from facing directions of the representations of users.)

In some embodiments, in response to detecting that various criteria are satisfied as described herein, computer system 101 (e.g., tablet, smartphone, wearable computer, or head mounted device) places representations and/or viewpoints of users at virtual locations (and/or updates their virtual locations) in accordance with a template automatically (e.g., without receiving an indication of movement of the users within their physical environments). For example, unless a user is described as moving in their physical environment, it should be understood that the user's relative position and/or orientation in their physical environment does not change when their virtual location is set and/or updated (e.g., arranged or rearranged) as described herein. In some embodiments, when computer system 101 (e.g., tablet, smartphone, wearable computer, or head mounted device) sets and/or updates the virtual locations of representations and/or viewpoints of one or more users other than the first user, computer system 101 (e.g., tablet, smartphone, wearable computer, or head mounted device) transmits an indication of the set and/or updated respective virtual locations of the users to the respective computer systems of the users, such as to enable the respective computer systems to render representations and/or viewpoints of the users in their new virtual locations.

Optionally, computer system 101 (e.g., tablet, smartphone, wearable computer, or head mounted device) displays representation 902c (e.g., concurrently with presenting the three-dimensional environment), which is optionally video and/or an image of the first user 902 that is captured by a camera of computer system 101 (e.g., tablet, smartphone, wearable computer, or head mounted device) that is oriented toward the first user, such as described with reference to representation 706a of FIGS. 7A and 7A1.

In some embodiments, computer system 101 (e.g., tablet, smartphone, wearable computer, or head mounted device) presents, via display generation unit 120, the three-dimensional environment 926 and the representation of the second user 904 based on (relative to) first virtual location 940a of the viewpoint of the first user 902, which is optionally the virtual location at which the viewpoint of the first user 902 was located when the second user joined the session. For example, the representation of the second user 904 is displayed as being located directly in front of the first user (e.g., at a virtual distance of twice the radius 916b), without changing (e.g., while maintaining) the location of the viewpoint of the first user 902 (e.g., at virtual location 940a).

FIG. 9D depicts an example of three-dimensional environment 926 (e.g., an AR, AV, VR, MR, or XR environment) as displayed by a second computer system 101a (e.g., tablet, smartphone, wearable computer, or head mounted device) (e.g., a computer system associated with the second user participating in the real-time communication session) based on the viewpoint (and representation) of the second user 904 being at the second virtual location 940b relative to the virtual location 940a of the viewpoint of the first user 902, such as shown in FIG. 9C. In this case, a representation of the first user 902-1 is displayed by the second computer system 101a (e.g., tablet, smartphone, wearable computer, or head mounted device) to enable the second user to see and/or interact with, for example, the first user. Optionally, computer system 101a (e.g., tablet, smartphone, wearable computer, or head mounted device) displays representation 904c (e.g., concurrently with presenting the three-dimensional environment), which is optionally video and/or an image of the second user that is captured by a camera of computer system 101a (e.g., tablet, smartphone, wearable computer, or head mounted device) that is oriented toward the second user.

Thus, FIGS. 9C-9D depict an example of how computer system 101 (e.g., tablet, smartphone, wearable computer, or head mounted device) (and/or computer system 101a (e.g., tablet, smartphone, wearable computer, or head mounted device)) select virtual locations (e.g., in accordance with a template) for displaying representations of the first user and/or the second user and/or for determining the locations of the respective viewpoints of the first user and/or the second user.

FIG. 9D1 illustrates similar and/or the same concepts as those shown in FIG. 9D (with many of the same reference numbers). It is understood that unless indicated below, elements shown in FIG. 9D1 that have the same reference numbers as elements shown in FIGS. 9A-9Q have one or more or all of the same characteristics. FIG. 9D1 includes computer system 101a, which includes (or is the same as) display generation component 120a. In some embodiments, computer system 101a and display generation component 120a have one or more of the characteristics of computer system 101 shown in FIGS. 9A-9Q and display generation component 120 shown in FIGS. 1 and 3, respectively, and in some embodiments, computer system 101 and display generation component 120 shown in FIGS. 9A-9Q have one or more of the characteristics of computer system 101a and display generation component 120a shown in FIG. 9D1.

In FIG. 9D1, display generation component 120a includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120a to enable eye tracking of the user's left and right eyes. Display generation component 120a also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 9A-9Q.

In FIG. 9D1, display generation component 120a is illustrated as displaying content that optionally corresponds to the content that is described as being displayed and/or visible via display generation component 120 with reference to FIGS. 9A-9Q. In some embodiments, the content is displayed by a single display (e.g., display 510 of FIG. 5) included in display generation component 120. In some embodiments, display generation component 120a includes two or more displays (e.g., left and right display panels for the left and right eyes of the user, respectively, as described with reference to FIG. 5) having displayed outputs that are merged (e.g., by the user's brain) to create the view of the content shown in FIG. 9D1.

Display generation component 120a has a field of view (e.g., a field of view captured by external image sensors 314b and 314c and/or visible to the user via display generation component 120a) that corresponds to the content shown in FIG. 9D1. Because display generation component 120a is optionally a head-mounted device, the field of view of display generation component 120a is optionally the same as or similar to the field of view of the user.

In some embodiments, computer system 101a responds to user inputs as described with reference to FIGS. 9A-9Q.

It is understood than one or more or all aspects of the present disclosure as shown in, or described with reference to FIGS. 9A-9Q and/or described with reference to the corresponding method(s) are optionally implemented on computer system 101a and display generation unit 120a in a manner similar or analogous to that shown in FIG. 9D1.

FIG. 9E depicts an example in which a third user has joined a real-time communication session with the first user and the second user, either after the second user has already joined or at the same time as the second user. In some embodiments, in response to detecting the arrival of the third user in the real-time communication session and based on a determination that there are a total of three users participating in the real-time communication session (e.g., the first, second, and third user), computer system 101 (e.g., tablet, smartphone, wearable computer, or head mounted device) selects a first virtual location 940d at which to display a representation of the third user 906 and a second virtual location 940c at which to display a representation of the second user 904 (e.g., different from virtual location 940b of FIG. 9D) relative to virtual location in accordance with a second template, such as in accordance with template 900b described with reference to FIG. 9A. For example, computer system 101 (e.g., tablet, smartphone, wearable computer, or head mounted device) displays the representation of the third user 906 at a virtual location 940d and representation of the second user 904 at a virtual location 940c along the perimeter of circle 914c upon which the viewpoint of the first user 902 is located. In the example of FIG. 9E, computer system 101 (e.g., tablet, smartphone, wearable computer, or head mounted device) displays the representation of the third user 906 and the representation of the second user 904 with respective facing directions towards the center of the circle 914c rather than directly towards each other (or toward the viewpoint of the first user).

In some embodiments, displaying the representation of the second user 904 at virtual location 940c includes moving the representation of the second user 904 to from a different virtual location (such as virtual location 940b or another virtual location) to virtual location 940c. For example, representation of second user 904 was optionally displayed at different virtual location (e.g., different from virtual location 940c) prior to the third user joining the real-time communication session and is moved to virtual location 940c in response to the third user joining the session (e.g., without receiving an indication of a corresponding movement of the second user in a physical environment of the second user). Optionally, moving the second user from the initial virtual location to virtual location 940c also changes the viewpoint of the second user, such that a computer system of the second user (e.g., computer system 101a (e.g., tablet, smartphone, wearable computer, or head mounted device) of FIG. 9D) displays a different view of three-dimensional environment 926 corresponding to the move in the virtual location of the viewpoint of the second user. Optionally, moving the viewpoint of the second user includes transmitting an indication of the move in the viewpoint of the second user to the second computer system 101a (e.g., tablet, smartphone, wearable computer, or head mounted device).

In some embodiments, rather than maintaining the same virtual location of the viewpoint of the first user when a new user(s) joins the real-time communication session (e.g., as shown in FIG. 9E relative to FIG. 9C), the computer system 101 (e.g., tablet, smartphone, wearable computer, or head mounted device) changes the virtual location of the viewpoint of the first user in response to detecting a new arrival(s) to the real-time communication session. FIG. 9F depicts an alternative example to FIG. 9E, in which the virtual location of the viewpoint of the first user is changed from virtual location 940a to virtual location 940f in response to detecting the arrival of the third user. In this case, the view of some or all of the three-dimensional environment 926 (e.g., an AR, AV, VR, MR, or XR environment) (e.g., a virtual environment of three-dimensional environment 926 and/or virtual objects in three-dimensional environment 926), as visible to the first user via computer system 101, has changed such that virtual object 930 is no longer in the field of view of the first user and virtual object 928 is displayed at an oblique viewing angle rather than head-on as in FIG. 9E. In this scenario, computer system 101 (e.g., tablet, smartphone, wearable computer, or head mounted device) optionally selects the virtual locations 940g and 940h of the representation of the second user and the representation of the third user, respectively, based on (e.g., relative to) the (changed) virtual location of the first user (e.g., virtual location 940f), such as in accordance with a template that is a rotated version of the template user in FIG. 9E.

FIG. 9G depicts an example of an overhead view 927 in which a fourth user has joined a real-time communication session with the first, second, and third users, either after the other users have already joined or at the same time as one or more of the other users. In some embodiments, in response to detecting the arrival of the fourth user in the real-time communication session and based on a determination that there are a total of four users participating in the real-time communication session (e.g., the first, second, third, and fourth user), computer system 101 (e.g., tablet, smartphone, wearable computer, or head mounted device) selects a first virtual location 940k at which to display a representation of the fourth user 908, a second virtual location 940j at which to display a representation of the third user 906, and a third virtual location 940i at which to display a representation of the second user 904 relative to the virtual location 940a of the viewpoint of the first user and in accordance with a third template, such as in accordance with template 900c described with reference to FIG. 9A. In the example of FIG. 9G, computer system 101 (e.g., tablet, smartphone, wearable computer, or head mounted device) displays the representation of the fourth user 908, the representation of the third user 906, and the representation of the second user 904 with facing directions towards the center of the circle 914c The viewpoint of the first user 902 is similarly oriented with a facing direction toward the center of circle 914a. Moreover, the representation of fourth user 908 is directly facing representation of second user 904, and representation of third user 906 is directly facing the viewpoint of the first user 902.

In the examples of FIGS. 9B-9G, representations of users are arranged symmetrically around a circle (circle 914c) having a radius (radius 916c) that is optionally selected, by computer system 101, based on the total quantity of participants. For example, computer system 101 (e.g., tablet, smartphone, wearable computer, or head mounted device) optionally selects a radius that provides a socially appropriate amount of distance between participants (e.g., a shoulder-to-shoulder distance between adjacent participants and/or a crosswise distance between facing participants). In some embodiments, computer system 101 (e.g., tablet, smartphone, wearable computer, or head mounted device) increases the radius of the circle around which the participants are arranged if more than a threshold quantity of users join the real-time communication session (e.g., serially, in groups, or simultaneously). In some embodiments, the computer system increases the radius each time an additional user joins the real-time communication session, or in response to detecting the arrival of additional users and in accordance with a determination that the total quantity of users participating in the real-time communication session exceeds one or more thresholds (e.g., such as when there are more than 2, 3, 4, 5, 6, 7, and/or 10 users).

In the examples of FIGS. 9B-9G, the radius of the circle around which the representations of the users are arranged is the same when there are two, three, and four participants in the real-time communication session.

FIG. 9H depicts an example in which there are five participants in the real-time communication session, and where a first threshold for increasing the radius of the circle (around which participants are arranged) is four users. In this case, in response to detecting the arrival of a fifth user, computer system 101 (e.g., tablet, smartphone, wearable computer, or head mounted device) arranges the representations of the second user 904, third user 906, fourth user 908, and fifth user 910 at virtual locations 940l, 940m, 940n, and 940o (respectively) relative to the virtual location 940a of the viewpoint of the first user, where the representations and/or viewpoints of the participants are symmetrically distributed around a circle 914d having a second radius 916d that is longer than the first radius 916c to maintain appropriate spacing between participants.

In some embodiments, when new users are added to the real-time communication session (such as a fifth user joining, shown in FIG. 9H), computer system 101 (e.g., tablet, smartphone, wearable computer, or head mounted device) rearranges the representations of the participants as previously discussed (by moving the representations to different virtual locations), while maintaining some or all of the right-left spatial relationships of the existing participants (e.g., the participants that were already participating in the multi-user communication system prior to the arrival of new participants). For example, in FIG. 9G, representation of second user 904 is to the right of the viewpoint of the first user 902, and representation of third user 906 is to the right of the representation of the second user 904. When the fifth user joins the real-time communication session and the participants are rearranged as shown in FIG. 9H, representation of second user 904 is still to the right of the viewpoint of the first user 902, and representation of third user 906 is still to the right of the representation of the second user 904. By maintaining some or all of the left-right spatial relationships of representations of users, computer system 101 (e.g., tablet, smartphone, wearable computer, or head mounted device) reduces the likelihood of user confusion or surprise based on sudden changes in spatial relationships.

In some embodiments, after computer system 101 (e.g., tablet, smartphone, wearable computer, or head mounted device) has arranged participants according to a template (e.g., in response to detecting the arrival of a new user(s) or in response to other triggers), one or more users may exit (e.g., quit) the real-time communication session, either by providing a user input requesting to exit the session or when a user's computer has an error (e.g., crashes) that causes the user to exit the session. In this case, as shown in FIG. 9I relative to FIG. 9H (in which the fourth and fifth user have left the real-time communication session), the computer system 101 (e.g., tablet, smartphone, wearable computer, or head mounted device) optionally maintains the current virtual locations of the remaining representations of users (e.g., at virtual locations 940a, 940l, and 940m) and leaves open the slots (e.g., virtual locations 940n and 940o) in the template that were formerly occupied by representations of the users that left the session (e.g., representation of the fourth user 908 and the representation of the fifth user 910), thus leaving two empty slots in the template. In this example, there are fewer participants than slots in the current template (e.g., the template most recently asserted by computer system 101) after the two participants exit the session.

Optionally, in response to detecting a user input corresponding to a request to rearrange the representations of participants the computer system rearranges some or all of the representations and/or viewpoints of the remaining users (e.g., representations of users 904 and 906 and/or viewpoint of first user 902) based on the remaining total quantity of users participating in the real-time communication session, such as by arranging the two remaining representations of users 904 and 906 and/or the viewpoint of the first user 902 according to a template associated with the current quantity of participants, such as by rearranging the participants into the arrangement shown in FIG. 9E (e.g., based on there being three participants remaining in the session). The user input optionally includes a selection of an affordance, a press or rotation of a physical button on computer system 101 (e.g., tablet, smartphone, wearable computer, or head mounted device) (such as depicted in FIG. 9I), or another type of user input, such as those described with reference to methods 800, 1000, 1200, 1400, 1600, and/or 1800.

Optionally, when there are empty slots in a template such as shown in FIG. 9I (as a result of one or more users exiting the real-time communication session), and one or more new users subsequently join the real-time communication session while the empty slots remain (and optionally, while the remaining users continue to be located in other slots of the template, such as shown in FIG. 9I), the computer system places representations and/or viewpoints of the one or more new users are in the empty slots in the template. For example, if the same quantity of new users joins the real-time communication session as there are empty slots, representations of the new users are optionally placed in the empty slots (e.g., in virtual locations 940n and 9040 of FIG. 9I), optionally without moving the representations and/or viewpoints of the other participants. Optionally, if a smaller quantity of new users joins the real-time communication session than there are empty slots, representations of the new users may be placed in a subset of the empty slots and the remaining empty slots are optionally left open, without rearranging the representations of the participants. Alternatively, if a smaller quantity of new users joins the real-time communication session than there are empty slots, representations of the existing users (e.g., those that were already placed in the template) and new users may be rearranged according to the total quantity of users. For example, if there are two empty slots (as shown in FIG. 9I) and one user joins the session (such that there are four total users), the computer system optionally arranges the participants according to a template associated with four users, such as shown in FIG. 9G. Optionally, if a larger quantity of new users joins the real-time communication session than there are empty slots, representations of the existing users (e.g., those that were already placed in the template) and representations of the new users are rearranged according to the total quantity of users. For example, if three users joined the session while there were two empty slots and three remaining participants (e.g., as shown in FIG. 9I), computer system 101 (e.g., tablet, smartphone, wearable computer, or head mounted device) optionally arranges the representations and/or viewpoints of the users according to a template associated with six users, such as shown in FIG. 9L.

In some embodiments, after representations and/or viewpoints of users are placed at locations within a template, users are free to move their representations and/or viewpoints away from their location in the template while remaining in the real-time communication session. Such a scenario is depicted in the example sequence of FIG. 9J to FIG. 9K, in which representation of a fifth user 909 has moved away from the virtual location 940n in the template at which representation of fifth user 909 was previously displayed (e.g., shown as an empty slot at virtual location 940n in FIG. 9K), yet remains in the real-time communication session (e.g., at virtual location 940p shown in FIG. 9K). In some embodiments, if a new user joins the session while the slot is empty but while there are the same quantity of other participants (e.g., not including the new participant) as the quantity of slots in the current template (e.g., the template in which participants were most recently placed), the computer system arranges the representations and/or viewpoints of the users according to a different template that corresponds to the quantity of participants after the new user joins the session. For example, if a new user joins the session while representations and/or viewpoints of existing participants are arranged as shown in FIG. 9K, the computer system arranges representations and/or viewpoints of users according to a template corresponding to the current quantity of participants as shown in FIG. 9L, in which representations and/or viewpoints of users 902, 904, 906, 909, 913, and 911 are arranged at virtual locations 940a and 940q-u (respectively) along the perimeter of circle 914c having radius 916e, which is optionally longer than radius 916d of FIG. 9K (e.g., to maintain appropriate spacing in the context of having more participants).

In some embodiments, computer system 101 (e.g., tablet, smartphone, wearable computer, or head mounted device) selects templates for arranging participants based on whether virtual content is shared in the real-time communication session, and/or in response to detecting a request, by a participant in the session, to share virtual content.

FIG. 9M depicts an example in which a participant in the real-time communication session (e.g., one of three participants, such as shown in FIG. 9F) requests to share virtual content that is a first content type, such as a first game having a circular shape and that is displayed in a horizontal plane of the three-dimensional environment. In some embodiments, in response to detecting that the participant has requested to share media content, the computer system 101 (e.g., tablet, smartphone, wearable computer, or head mounted device) initiates a process to share the virtual content (e.g., such as described with reference to method 1200) and arranges representations and/or viewpoints of participants (optionally, including the participant that requested to share the virtual content) at virtual locations according to a template associated with the virtual content (and/or based on the content type of the virtual content).

For example, if one of the participants shown in FIG. 9F requests to share game 935, computer system optionally displays game 935 (and/or makes game 935 accessible to other participants) and arranges representations and/or viewpoints of users 902, 906, and 904 in virtual locations 940a, 940v, and 940w around game 935 (e.g., based on a shape of game 935 being circular, and/or based on other characteristics of game 935) and facing game 935, as shown in FIG. 9M. In some embodiments, the computer system 101 (e.g., tablet, smartphone, wearable computer, or head mounted device) selects a template with which to arrange participants when a participant shares virtual content based on a type of the virtual content. For example, game 935 is optionally a first type of virtual content corresponding to a circular game that is displayed in a horizontal plane relative to three-dimensional environment, and based on a determination that game 935 is the first type of virtual content (and optionally, based on the quantity of participants in the real-time communication session), the computer system selects a circular template with the appropriate radius and quantity of slots for arranging the participants around game 935. In some embodiments, the virtual locations in a template that corresponds to shared content are not uniformly distributed; for example, in FIG. 9M, the virtual locations at which the representations and/or viewpoint of the participants have been placed are not uniformly distributed around game 935, and instead are located at virtual locations that are based on the particular game being shared (e.g., to provide participants with appropriate perspectives of the game).

FIG. 9N depicts an example in which a participant in the real-time communication session requests to share virtual media content (e.g., a movie or video). In some embodiments, in response to detecting that a user has requested to share media content, the computer system 101 (e.g., tablet, smartphone, wearable computer, or head mounted device) arranges representations and/or viewpoints of participants (optionally, including a participant that requested to share the virtual content) at virtual locations 940a, 940y, and 940x according to a content-viewing template in which participants are arranged along an arc 918a facing the media content (e.g., at a distance 919a from the media content), such as previously discussed with reference to template 900c of FIG. 9A. For example, as shown in FIG. 9N, if three users are participating in the real-time communication session and one of the users requests to share media content 944 (e.g., with the other users), the computer system 101 (e.g., tablet, smartphone, wearable computer, or head mounted device) optionally initiates a process to share the media content 944 and arranges representations and/or viewpoints of the participants at virtual locations 940a, 940y, and 940x along arc 918a facing media content 944, optionally with uniform spacing between the participants (e.g., between slots in the template). Optionally, an amount of curvature of the arc and/or distance 919a is based on the size of the media content 944; for example, larger-sized media content optionally is associated with an arc with less curvature and/or a longer distance from the media than smaller-sized media content. Such an arrangement allows participants to view the media content 944 from appropriate distances and angles depending on the size of the media content.

Optionally, when participants are arranged according to a content-viewing template along am arc, line, or other open shape facing the virtual content (such as shown in FIG. 9N) and a new participant joins the real-time communication session (optionally, while the virtual content is currently being shared), the computer system places a representation and/or viewpoint of the new user at a virtual location that lies along the open shape of the existing template without rearranging the other participants (e.g., without changing their virtual locations). For example, if participants are arranged along arc 918a as shown in FIG. 9N and another user joins the real-time communication session, computer system 101 (e.g., tablet, smartphone, wearable computer, or head mounted device) optionally places a representation of the new user 906 along arc 918a, such as immediately adjacent to representation of user 904, without changing the virtual locations 940y, 940a, and 940x of representations of users 904, 902, or 911 (respectively), as show in FIG. 9O.

In some embodiments, when a non-spatial user joins the real-time communication session (e.g., a as described with reference to method 1200), computer system 101 (e.g., tablet, smartphone, wearable computer, or head mounted device) arranges participants (optionally, including the non-spatial participant) differently (e.g., according to a different template) than if a spatial participant joins (e.g., as described with reference to method 1200). In the example of FIG. 9P, in response to a non-spatial user joining the session, the computer system 101 (e.g., tablet, smartphone, wearable computer, or head mounted device) arranges representations of (spatial) users 902, 904, 915 at virtual locations 940a, 940b, and 940aa along a parabolic (U) shape 918c (e.g., rather than arranging participants according to a ring template, such as shown in FIG. 9G) facing a representation of the non-spatial participant 946, optionally at a shorter distance 919c relative to the distance at which media content of the same size as the representation of the non-spatial participant 946 would be displayed according to a content-viewing template. Optionally, the representation of the spatial participant 946 is displayed at a virtual location 940cc that is at the open (e.g., unconnected) end of the U-shape and facing one or more of the representations and/or viewpoints of the (spatial) users 902, 904, 915 (e.g., facing the viewpoint of the first user 902). Alternatively, in response to detecting that a non-spatial user has joined the group, the computer system 101 (e.g., tablet, smartphone, wearable computer, or head mounted device) arranges representations and/or viewpoints of spatial participants according to a content-viewing template, such as shown in FIG. 9O, where a representation of the non-spatial participant (e.g., representation 946 as shown in FIG. 9P), is displayed in place of media content 944. For example, the representation of the non-spatial participant is optionally treated by computer system 101 (e.g., tablet, smartphone, wearable computer, or head mounted device) as virtual content for the purposes of selecting a template and arranging participants.

Optionally, in response to detecting a request to share virtual content (e.g., as described with reference to FIGS. 9M-9N) while a representation of a non-spatial participant (e.g., representation 946 of FIG. 9P) is displayed (e.g., by computer system 101) the computer system 101 (e.g., tablet, smartphone, wearable computer, or head mounted device) arranges representations and/or viewpoints of spatial participants according to a content-viewing template (such as described with reference to FIG. 9O) and changes the virtual location of the representation and/or viewpoint of the non-spatial participant (e.g., from virtual location 940cc to virtual location 940dd) such that it is adjacent to the displayed virtual content and angled (e.g., at an angle 945 relative to the virtual content) towards the representations and/or viewpoints of the spatial participants, such as shown in FIG. 9Q and described in more detail with reference to methods 1000 and 1200.

FIG. 10 is a flowchart illustrating a method of arranging representations of participants based on templates, in accordance with some embodiments of the disclosure. In some embodiments, the method 1000 is performed at a computer system (e.g., computer system 101 (e.g., tablet, smartphone, wearable computer, or head mounted device) in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1000 is governed by instructions that are stored in a non-transitory computer-readable storage medium and that are executed by one or more processors of a computer system, such as the one or more processors 202 of computer system 101 (e.g., tablet, smartphone, wearable computer, or head mounted device) (e.g., control unit 110 in FIG. 1A). Some operations in method 1000 are, optionally, combined and/or the order of some operations is, optionally, changed.

In some embodiments, method 1000 is performed at a first computer system in communication with (e.g., including and/or communicatively linked with) a display generation component, the first computer system associated with a first user. In some embodiments, the first computer system has one or more of the characteristics of the computer system(s) described with reference to methods 800, 1200, 1400, 1600, 1800, and/or 2000. In some embodiments, the input device(s) has one or more of the characteristics of the input device(s) described with reference to methods 800, 1200, 1400, 1600, 1800, and/or 2000. In some embodiments, the display generation unit has one or more of the characteristics of the display generation component described with reference to methods 800, 1200, 1400, 1600, 1800, and/or 2000.

In some embodiments, while a three-dimensional environment is visible (to the first user) via the display generation component (e.g., three-dimensional environment 926 as shown in FIG. 9B), the computer system detects (1002a) that one or more first criteria are satisfied, including a criterion that is satisfied while the first computer system is in a real-time communication session that includes a second computer system associated with a second user, such as a second user described with reference to FIG. 9C (users participating in a real-time communication session are optionally referred to as participants in the real-time communication session). In some embodiments, the three-dimensional environment has one or more of the characteristics of the three-dimensional environments described with reference to methods 800, 1200, 1400, 1600, 1800, and/or 2000. In some embodiments, the second computer system has one or more of the characteristics of the computer system(s) described with reference to methods 800, 1200, 1400, 1600, 1800, and/or 2000. In some embodiments, the real-time communication session has one or more of the characteristics of the real-time communication session described with reference to methods 800, 1200, 1400, 1600, 1800, and/or 2000. In some embodiments, the first criteria include a criterion that is satisfied when the first computer system receives a request to join the second computer system in a real-time communication session and/or the first computer system accepts (e.g., authenticates) the request to join the real-time communication session. In some embodiments, the first criteria include a criterion that is satisfied when a user participating in the real-time communication session requests that the virtual locations of the users participating in the real-time communication session be reset to a virtual locations within a pre-defined template associated with the current quantity of users participating in the real-time communication session. In some embodiments, the first criteria include a criterion that is satisfied when a representation of the second user is not currently presented (e.g., displayed) within the three-dimensional environment when the request is received. In some embodiments, the first criteria include a criterion that is satisfied when the second user and/or second computer system join the real-time communication session.

In some embodiments, in response to detecting that the one or more first criteria are satisfied (1020b), and in accordance with a determination that a first quantity of users (e.g., 2, 3, 4, 5, 10, 15, 20, or 40), including the first user and the second user, are participating in the real-time communication session (e.g., are participants in the session, such as when a first quantity of computer systems associated with the first quantity of users, including the first computer system and the second computer system, are participating in the real-time communication session.) the computer system displays (1002c), in the three-dimensional environment via the display generation component, a representation of the second user at a first virtual location for the second user relative to a first virtual location associated with a viewpoint of the first user in the three-dimensional environment, such as shown in FIG. 9C, in which there are two users and the representation of second user 904 is displayed at virtual location 940b relative to virtual location 940a of viewpoint of first user 902. Optionally, representations of one or more of the first quantity of users, excluding the second user, are displayed within the three-dimensional environment when the detection of the satisfaction of the first criteria occurs. Optionally, two or more of the first quantity of users, including the second user, are not displayed within the three-dimensional environment when the detection of the satisfaction of the first criteria occurs. In some embodiments, the three-dimensional environment includes one or more representations (e.g., avatars or other representations, such as described with reference to methods 800, 1200, 1400, 1600, 1800, and/or 2000) of one or more of the users participating in the real-time communication session. In some embodiments, the representation the second user has one or more of the characteristics of the representation of the second user described with reference to methods 800 and/or 1200. In some embodiments, displaying the representation of the second user at the first virtual location includes assigning the first virtual location to the viewpoint of the second user such that the three-dimensional environment is presented to the second user from this viewpoint. In some embodiments, the computer system selects the first virtual location for the second user and the first virtual location associated with the viewpoint of the first user within the three-dimensional environment based on the first quantity. In some embodiments, the first virtual location associated with the viewpoint of the first user defines a location and/or field of view of the three-dimensional environment (e.g., as visible via the display generation component) from the first virtual location associated with the viewpoint of the first user. Optionally, a representation of the first user is not displayed via the display generation component; e.g., a representation of the first user is not visible via the display generation component. In some embodiments, the first virtual location associated with the viewpoint of the first user and the first virtual location for the second user have a first spatial arrangement (e.g., orientation and/or position) relative to each other in the three-dimensional environment, such as the spatial arrangement shown in overhead view 927 of FIG. 9C. In some embodiments, the first spatial arrangement includes an arrangement of the representation(s) of users participating in the multi-user communication session relative to each other, optionally corresponding to slots in a first pre-defined template that specifies a first quantity of virtual locations (e.g., slots at which respective users of the first quantity of users are placed) within the three-dimensional environment. In some embodiments, a template is associated with a shape (e.g., a circle having a particular radius, a square having sides of a particular length, an arc of a circle having a particular radius, a line, or another shape) having a perimeter on which a particular quantity of slots (e.g., virtual locations) are arranged and at which representations and/or viewpoints of users can be placed (e.g., automatically, by the computer system). For example, a first ring template optionally is associated with a circle of a first radius that includes a first quantity of slots (e.g., virtual locations) that can optionally be used to arrange a first quantity of representations and/or viewpoints of users along the perimeter of the circle. A second ring template optionally is associated with a circle of a second radius and/or a different quantity of slots virtual that can optionally be used to arrange a different quantity of representations and/or viewpoints of users. In some embodiments, the spatial arrangement includes a distance and/or facing direction of the representation of the second user relative to the viewpoint of the first user and/or relative to any additional users in the multi-communication session. For example, the first virtual location for the second user is optionally a first virtual distance from the first virtual location associated with the viewpoint of the first user, and/or the representation of the second user is optionally facing the viewpoint of the first user such that the representation of the second user appears to be facing the first user (e.g., as displayed via the display generation component of the first computer system). Optionally, the representation of the second user is not facing the representation of the first user but is instead facing the same virtual location (e.g., a focal point and/or center of the template) as the viewpoint of the first user. Optionally, the computer system associates (e.g., assigns) the first virtual location associated with the viewpoint of the first user with a first physical location of the first user in a physical environment of the first user (e.g., a physical location of the user when the representation of the second user is initially displayed). For example, at the time when the computer system initiates display of the representation of the second user at the first virtual location for the second user and selects and/or changes the first virtual location associated with the viewpoint of the first user according to the first spatial arrangement, the computer system optionally associates the first virtual location associated with the viewpoint of the first user with the current physical location of the first user such that when the first user changes physical locations (e.g., by walking to another physical location) the viewpoint of the first user changes from the first virtual location associated with the viewpoint of the first user to a different virtual location based on the change in physical location.

In some embodiments, in response to detecting that the one or more first criteria are satisfied (1020b), and in accordance with a determination that a second quantity of users (e.g., 2, 3, 4, 5, 10, 15, 20, 30, or 40), different from the first quantity of users and including the first user and the second user, are participating in the real-time communication session, the computer system displays (1002d), in the three-dimensional environment via the display generation component, the representation of the second user at a second virtual location for the second user relative to a second virtual location associated with the viewpoint of the first user in the three-dimensional environment, such as show in FIG. 9E, in which there are three users and the representation of the second user 904 is placed at virtual location 940c. In some embodiments, the second virtual location for the second user is different than the first virtual location for the second user (e.g., the representation of the second user is displayed at a different virtual location and/or a different orientation relative to the viewpoint of the first user when there is a second quantity of users than when there is a first quantity of users). In some embodiments, the second virtual location associated with the viewpoint of the first user is the same as the first virtual location associated with the viewpoint of the first user (e.g., the viewpoint of the first user is the same and/or maintained when there is a second quantity of users as when there is a first quantity of users). In some embodiments, the second virtual location associated with the viewpoint of the first user is different than the first virtual location associated with the viewpoint of the first user (e.g., the viewpoint of the first user is different when there is a second quantity of users than when there is a first quantity of users). In some embodiments, the second virtual location for the second user and the second virtual location associated with the viewpoint of the first user have a second spatial arrangement (e.g., corresponding to slots in a second pre-defined template different from the first pre-defined template and optionally having a different quantity of slots and/or of a different template type) relative to each other in the three-dimensional environment, different from the first spatial arrangement, such as shown in the overhead view 927 of FIG. 9E relative to FIG. 9C. In some embodiments, the second spatial arrangement has one or more of the characteristics of the first spatial arrangement, such as corresponding to slots in a pre-defined template that specifies a second quantity of virtual locations (e.g., corresponding to respective users of the second quantity of users) within the three-dimensional environment. Automatically arranging representations of participants in a multi-user communication session based on the number of participants facilitates communication among the participants by enabling the participants to continue to face towards each other, to face towards a common item of interest (e.g., towards shared media content, a map, a shared application, and/or to other content), and/or to maintain a natural-feeling separation between participants as more participants are added to the session, mimicking spatial arrangements people may choose in real-world interactions. Such automated arrangement also reduces the inputs needed to properly locate representations of participants and reduces the risk of spatial conflicts between representations of participants. Automatically rearranging the viewpoints and/or representations (e.g., avatars) of participants in a real-time communication session based on the quantity of participants enables the participants to view and/or interact with each other from perspectives that are appropriate to the size of the group without requiring them to provide additional inputs to relocate their viewpoint and negotiate spatial positioning relative to each other while avoiding spatial conflicts.

In some embodiments, the one or more first criteria include a criterion that is satisfied when the computer system detects the second user joining the real-time communication session, such as described with reference to FIG. 9C. In some embodiments, the computer system detects the second user joining the real-time communication system when the computer system receives a request, from the second computer system associated with the second user, to join the real-time communication session and/or after establishing a communication link with the second computer system, optionally after performing an authentication procedure to authenticate the second user and/or after a time period has elapsed (e.g., a waiting period, a delay) after the computer system receives the request and/or establishes the communication link. Optionally, the computer system detects the second user joining the real-time communication system concurrently with one or more additional users joining the real-time communication session. For example, the second user optionally joins the real-time communication session as part of a group of users, optionally based on a single request to join the real-time communication session (e.g., for the group) or based on multiple requests to join (e.g., corresponding to multiple users). Optionally, the computer system does not display the representation of the second user and/or does not change (e.g., maintains) the locations of other participants in the session before (e.g., until) the computer system detects the second user joining the real-time communication session. Automatically arranging the viewpoints and/or representations (e.g., avatars) of participants in a real-time communication session when a new user joins the session allows the participants to view and/or interact with each other from perspectives that are appropriate to the size of the group when the group size changes, without requiring them to provide additional inputs to relocate their viewpoint and negotiate spatial positioning relative to each other while avoiding spatial conflicts.

In some embodiments, before detecting that the one or more first criteria are satisfied (e.g., as described with respect to step 1002a), the computer system displays a representation of a third user (e.g., the second user or a different user) at a first virtual location for the third user relative to the viewpoint of the first user in the three-dimensional environment. For example, the computer system optionally displays representation of third user 906 of FIG. 9E somewhere in the three-dimensional environment 926 (e.g., optionally at a different virtual location than shown in FIG. 9E). In some embodiments, the representation the third user has one or more of the characteristics of the representation of the second user described earlier. In some embodiments, the first virtual location for the third user is anywhere within the three-dimensional environment (e.g., any virtual location that is not currently occupied by a representation of another user), such as a virtual location selected by the third user (e.g., by the third user moving within a physical environment of the third user). In some embodiments, the first virtual location for the third user corresponds to a virtual location within a pre-defined template corresponding to a current quantity of users participating in the real-time communication session.

In some embodiments, in response to detecting that the one or more first criteria are satisfied (e.g., as described with reference to step 1002a), the computer system moves (e.g., changes) the display of the representation of the third user from the first virtual location for the third user to a second virtual location for the third user (e.g., automatically and/or without receiving an indication of movement of the third user), different from the first virtual location for the third user, relative to the viewpoint of the first user in the three-dimensional environment. For example, the computer system optionally moves the representation of the third user to virtual location 940d from another virtual location in the three-dimensional environment 926. In some embodiments, the second virtual location for the third user corresponds to a virtual location within a pre-defined template that is associated with a current quantity of users participating in the real-time communication session after the computer system detects that the one or more first criteria are satisfied (such as after one or more users join or leave the real-time communication session, or after a user requests to reset the spatial arrangement). In some embodiments, moving the display of the representation of the third user from the first virtual location for the third user to the second virtual location for the third user includes displaying an animation of the representation of the third user moving (e.g., walking, running, rolling, or otherwise moving) from the first virtual location for the third user to the second virtual location for the third user. In some embodiments, moving the display of the representation of the third user from the first virtual location for the third user to the second virtual location for the third user includes associating the current physical location of the third user (e.g., within the physical environment of the third user) with the second virtual location for the third user. For example, if the third user moves within the physical environment of the third user after the representation of the third user is moved to the second virtual location for the third user, the computer system moves the representation of the third user away from the second virtual location of the third user in accordance with the movement of the third user. Automatically rearranging (e.g., changing the locations of) viewpoint and/or representation of a participant in a real-time communication session when a new user (or users) joins the session allows the participants to view and/or interact with each other from perspectives that are appropriate to the new size of the group without requiring them to provide additional inputs to relocate their viewpoint and negotiate spatial positioning relative to each other while avoiding spatial conflicts.

In some embodiments, before detecting that the one or more first criteria are satisfied (e.g., as described with reference to step 1002a), the computer system displays a representation of a fourth user (e.g., different from the third user, such as representation of fourth user 908 in FIG. 9G) at a first virtual location for the fourth user relative to the viewpoint of the first user in the three-dimensional environment (e.g., such as at virtual location 940k as shown in FIG. 9G). In some embodiments, the representation the fourth user has one or more of the characteristics of the representation of the second user described with reference to step 1002a. In some embodiments, the first virtual location for the fourth user is anywhere within the three-dimensional environment (e.g., any virtual location that is not currently occupied by a representation of another user), such as a virtual location selected by the fourth user (e.g., by the fourth user moving within a physical environment of the fourth user). In some embodiments, the first virtual location for the third user corresponds to a virtual location within a pre-defined template corresponding to a current quantity of users participating in the real-time communication session.

In some embodiments, in response to detecting that the one or more first criteria are satisfied (e.g., as described with reference to step 1002a), the computer system moves (e.g., changes the location of) the display of the representation of the fourth user from the first virtual location for the fourth user to a second virtual location for the fourth user (e.g., automatically and/or without receiving an indication of movement of the fourth user), different from the first virtual location for the fourth user, relative to the viewpoint of the first user in the three-dimensional environment, such as by moving the representation of fourth user 908 from virtual location 940K in FIG. 9G to virtual location 904n in FIG. 9H. In some embodiments, the second virtual location for the fourth user corresponds to a virtual location within a pre-defined template (e.g., a spatial arrangement) that is associated with a current quantity of users participating in the real-time communication session (e.g., including the third user and the fourth user) after and/or when the computer system detects that the one or more first criteria are satisfied (such as after and/or when one or more users join or leave the real-time communication session, or after and/or when a user requests to reset the spatial arrangement). In some embodiments, moving the display of the representation of the fourth user from the first virtual location for the fourth user to a second virtual location for the fourth user includes displaying an animation of the representation of the fourth user moving (e.g., walking, running, rolling, or otherwise moving) from the first virtual location for the fourth user to a second virtual location for the fourth user. In some embodiments, moving the display of the representation of the fourth user from the first virtual location for the fourth user to a second virtual location for the fourth user includes associating the current physical location of the fourth user (e.g., within the physical environment of the fourth user) with the second virtual location for the fourth user. For example, if the fourth user moves within the physical environment of the fourth user after the representation of the fourth user is moved to the second virtual location for the fourth user, the computer system moves the representation of the fourth user away from the second virtual location of the fourth user in accordance with the movement of the fourth user. In some embodiments, when the computer system moves multiple participants (e.g., rearranges participants into slots in a template) the computer system maintains an order of the participants relative to an order in which they were previously arranged. For example, if a respective participant is to the left of and immediately adjacent to a different participant before rearranging, the respective participant is still to the left of and/or immediately adjacent to the different participant after the rearranging, thereby maintaining aspects of the initial spatial arrangement such that participants are not overly surprised or confused by the new locations of other participants. Automatically rearranging (e.g., changing the locations of) the viewpoints and/or representations (e.g., avatars) of multiple (e.g., some or all of the) participants in a real-time communication session when a new user (or users) joins the session allows the participants to view and/or interact with each other from perspectives that are appropriate to the new size of the group without requiring them to provide additional inputs to relocate their viewpoint and negotiate spatial positioning relative to each other while avoiding spatial conflicts.

In some embodiments, in response to detecting that the one or more first criteria are satisfied (e.g., as described with reference to step 1002a), the computer system maintains (e.g., refrains from changing) a virtual location associated with the viewpoint of the user at a same virtual location (e.g., the first virtual location associated with the viewpoint of the first user or a different virtual location associated with the viewpoint of the first user) with which the viewpoint of the first user was associated at the time the computer system detects that the one or more criteria are satisfied. For example, the viewpoint of first user 902 is maintained at virtual location 940a from FIG. 9E to 9G. In some embodiments, the virtual location associated with the viewpoint of the first user does not change when the computer system detects that the one or more first criteria are satisfied; for example, the virtual location associated with the viewpoint of the first user optionally serves as an anchor location around (and/or near) which representations of other users are arranged in a spatial arrangement (e.g., corresponding to being placed in slots in a template that is associated with the quantity of users participating in the real-time communication session). Maintaining the viewpoint (e.g., perspective and/or virtual location) of the user of the computer system (e.g., the first user) while the representations and/or viewpoints of other participants are rearranged (e.g., around the user) provides better viewing stability for the user of the computer system, thereby reducing the likelihood of errors in interaction with the computer system.

In some embodiments, the computer system detects that at least one user (e.g., the second user or another user) participating in the real-time communication session has left (e.g., quit and/or exited) the real-time communication session, such as described with reference to FIG. 9I (e.g., a computer system of the at least one user is no longer linked in the real-time communication session due to the user's request to exit or due to a failure of the at least one user's computer system).

In some embodiments, after detecting that the at least one user has left the real-time communication session, (e.g., in response to, immediately after, and/or until additional user inputs are detected corresponding to movement of one or more of the remaining users) the computer system maintains (e.g., refrains from changing) respective virtual locations of the display of representations of remaining users participating in the real-time communication session, such as by maintaining the virtual locations of the viewpoint of first user 902, representation of second user 904, and representation of third user 906 in FIG. 9I. For example, if four users (including the first user, the second user, a third user, and a fourth user) are participating in the real-time communication session and have representations and/or viewpoints located at respective virtual locations when the third user leaves the real-time communication session, the representations and/or viewpoints of the remaining users (e.g., the second user, fourth user, and/or first user) are optionally maintained at the same virtual locations and are not moved to new virtual locations (e.g., until such time as a new input and/or event causes them to be moved) in response to detecting that the third user has left the session. Optionally, the respective virtual locations of the display of representations of remaining users are virtual locations (e.g., slots) in a pre-defined template associated with the quantity of users before detecting that the at least one user has left the real-time communication session. Optionally, one or more or all of the respective virtual locations of the display of representations of remaining users are not virtual locations in a pre-defined template and are located anywhere in the three-dimensional environment, such as if a participant had moved away from their slot in the template before the at least one user left the real-time communication session. Maintaining the locations of representations and/or viewpoints of participants when a participant leaves the real-time communication session (e.g., rather than rearranging the remaining participants based on the reduced quantity of participants) provides better viewing stability for the user of the computer system, thereby reducing the likelihood of errors in interaction with the computer system.

In some embodiments, the one or more first criteria (e.g., as described with reference to step 1002a) include a criterion that is satisfied when the computer system detects a user input corresponding to a request to reset a spatial arrangement of representations of users participating in the real-time communication session (e.g., such as shown in FIG. 9I and described with reference to one or more of methods 800, 1200, 1400, 1600, 1800, and/or 2000). In some embodiments, the user input is a touch input (e.g., on a touch screen), a press and/or rotation of a physical button, an air gesture (e.g., an air pinch gesture or another gesture), a verbal request (e.g., detected using a microphone), a gaze direction (e.g., detected by an eye-tracking camera(s)), or another type of user input. In some embodiments, resetting the spatial arrangement includes setting or resetting the virtual locations for representations and/or for the viewpoints of users participating in the real-time communication session according to a template associated with the quantity of users participating in the real-time communication session. In some embodiments, displaying the representation of the second user at the first virtual location for the second user or the second virtual location for the second user (as described with reference to step 1002c and 1002d) includes moving the representation of the second user from a third virtual location to the first virtual location or the second virtual location (e.g., in a manner similar to that described earlier with reference to moving the display of the representation of the third user or the fourth user), such that the representation of the second user is displayed at a slot in a template corresponding to the current quantity of participants. Allowing a participant to manually reset the locations of other participants into a template corresponding to the current quantity of participants (e.g., rather than waiting for another event that causes the locations to be automatically reset into template locations, such as when a new user joins the session) provides an easy mechanism by which multiple participants can be arranged at perspectives that are appropriate to the current size of the group without requiring each user to separately provide inputs to relocate their viewpoint and negotiate spatial positioning relative to each other while avoiding spatial conflicts.

In some embodiments, after detecting that the one or more first criteria are satisfied and in accordance with the determination that the first quantity of users are participating in the real-time communication session (e.g., as described with reference to step 1002c), and while displaying the representation of the second user at the first virtual location, such as by displaying the representation of fifth user 909 at virtual location 940n in FIG. 9J (e.g., as described with reference to 1002c, at a virtual location corresponding to a slot in a pre-defined template associated with the first quantity of users, optionally while the viewpoint associated with the first user is located at the first virtual location for the viewpoint associated with the first user), the computer system obtains (e.g., receives and/or detects) information corresponding to movement of the representation of the second user (e.g., information that provides an indication of a change in the physical location of the second user within a physical environment of the second user, such as location, speed, orientation, and/or acceleration information, and/or an indication of a requested change in the virtual location of the representation of the second user). Optionally, the information is obtained from a computer system of the second user and/or from one or more input devices of the computer system.

In some embodiments, in response to obtaining the information corresponding to movement of the representation of the second user, the computer system updates (e.g., changes or sets) a virtual location of the display of the representation of the second user in accordance with the obtained information. For example, the virtual location of the representation of fifth user 909 has moved to virtual location 940p in FIG. 9K. In some embodiments updating the virtual location of the display of the representation of the second user includes updating a virtual location of the display of the representation of the second user from the first virtual location for the second user, which corresponds to a slot in a pre-defined template, to a different virtual location for the second user that does not correspond to a slot in a pre-defined template. In some embodiments, updating the virtual location of the display of the representation of the second user in accordance with the obtained information includes moving the representation of the second user based on the obtained information. For example, if the obtained information includes information indicating that the second user has moved to the left in the physical environment of the second user, the computer system optionally moves the representation of the second user to the left in the three-dimensional environment, optionally away from a template in which the representation of the second user was previously displayed.

In some embodiments, in response to obtaining the information corresponding to movement of the representation of the second user, the computer system maintains (e.g., refrains from changing) the display of the representations of the remaining users participating in the real-time communication session at the respective virtual locations according to the first spatial arrangement, such as by maintaining the locations of the remaining users in FIG. 9K. In some embodiments, if participants are arranged within a template and one or more users leaves (moves away from) their respective location(s) within the template, the remaining users are not automatically moved (e.g., to a different template and/or to a different slot within the same template). Instead, an empty slot(s) is left in the template (e.g., corresponding to the slot previously occupied by a participant). Maintaining the locations of representations and/or viewpoints of participants when a participant moves away from their slot in the template (e.g., rather than rearranging the remaining participants) provides better viewing stability for the user of the computer system and eliminates the need to re-determine whether other participants are located within the three-dimensional environment, thereby reducing the likelihood of errors in interaction with the computer system or with each other.

In some embodiments, the first spatial arrangement corresponds to slots in a first template (e.g., a template such as those shown in FIG. 9A and optionally corresponding to the first quantity of users, the second quantity of users, or a different quantity of users).

In some embodiments, while the first quantity of users are participating in the real-time communication session and while the virtual location associated with the viewpoint of the first user corresponds to a first virtual location in the first template (e.g., viewpoint of first user 902 is located at virtual location 940a in FIGS. 9H and 9I) and representations of the remaining user of the first quantity of users are displayed at respective virtual locations of the first template (e.g., as described earlier, and shown in FIGS. 9H and 9I), the computer system detects that a third user (e.g., different from the first user and the second user) has joined the real-time communication session (e.g., in a manner similar to that described earlier with reference to the second user), wherein a quantity of users participating in the real-time communication session after the third user joins the real-time communication session is a third quantity (e.g., different from the first quantity and the second quantity).

In some embodiments, in response to detecting that the third user has joined the real-time communication session and in accordance with a determination that there is a virtual location that is empty in the first template (e.g., such as virtual location 940n in FIG. 9I) (e.g., an empty slot in the template, such as a slot at which a representation and/or viewpoint of a participant was previously located and/or displayed) the computer system displays a representation of the third user (e.g., in a manned similar to that described with reference to displaying the representation of the second user in 1002c and 1002d) at the virtual location that was empty, such as shown in FIG. 9J (e.g., filling the empty slot with a representation and/or viewpoint of the third user), and maintains the virtual locations in the first template at which respective representations of one or more additional users are displayed (e.g., keeping representations and/or viewpoints of other participants at the same slots in the template).

In some embodiments, in response to detecting that the third user has joined the real-time communication session and in accordance with a determination that there is not a virtual location that is empty in the first spatial arrangement, such as in FIG. 9H (e.g., all of the slots in the template are filled with viewpoints and/or representations of other participants), the computer system displays the representation of the third user at a second virtual location for the third user according to a third spatial arrangement associated with the third quantity of users, such as shown in FIG. 9L (e.g., where the third spatial arrangement corresponds to slots in a second template different than the first template), and updates the respective virtual locations at which respective representations of one or more additional users of the third quantity of users according to the third spatial arrangement, such as by updating the virtual locations of the other users in FIG. 9L relative to FIG. 9H (e.g., arranging representations and/or viewpoints of the other participants into slots in the second template). In some embodiments, when a participant joins the real-time communication session, the participant is placed into an empty slot in an existing template if available, and if an empty slot is not available, some or all of the participants are rearranged according to a new template (e.g., a template corresponding to the quantity of users participating in the session after the new participant joins the session).

Placing a representation and/or viewpoint of a new participant in an empty template slot if one is available reduces the need to rearrange the other participants, thereby providing better viewing stability for the other participants and reducing the likelihood of errors in interaction with the computer system or with each other.

In some embodiments, while a fifth quantity of user are participating in the real-time communication session and while displaying representations of the fifth quantity of users excluding the first user (e.g., the user of the computer system, for which a representation is optionally not displayed) at respective virtual locations according to a first template (e.g., at slots in the first template) associated with a larger quantity of users than the fifth quantity of users such that a plurality of virtual locations in the first template associated with the larger quantity of users are empty virtual locations, such as shown in FIG. 9H, where the template corresponds to five users but only three users are participating in the session (e.g., after a fifth quantity of participants were arranged at slots in the first template and one or more users subsequently left the real-time communication session, leaving one or more empty slots in the first template), the computer system detects an arrival of a plurality of additional users (e.g., 2, 3, 4, 5, or 10 additional users) in the real-time communication session (optionally arriving as a group, such as based on a single request to join the real-time communication session).

In some embodiments, in response to detecting the arrival of the plurality of additional users and in accordance with a determination that a quantity of empty virtual locations matches a quantity of the plurality of additional users, the computer system displays representations of the plurality of additional users at respective locations corresponding to the respective empty virtual locations, such as by placing representations of one or two users at one or two empty slots in FIG. 10H, such as shown in FIG. 10J (e.g., in a manner similar to that described with reference to displaying the representation of the second user in step 1002c, and filling in the empty slots with representations of the new participants).

In some embodiments, in response to detecting the arrival of the plurality of additional users and in accordance with a determination that the quantity of empty virtual locations does not match the quantity of the plurality of additional users (e.g., the quantity of empty virtual locations is greater than or less than the quantity of new participants), the computer system displays representations of the plurality of additional users and the fifth quantity of users excluding the first user at respective virtual locations according to a second template associated with a total quantity of users participating in the real-time communication session after detecting the arrival of the plurality of additional users. For example, if there are two empty slots as shown in FIG. 9I and three users join the session, the computer system optionally rearranges representations of all of the participants based on the total quantity of users such as shown in FIG. 9L (optionally while maintaining or changing the virtual location of the viewpoint of the first user). In some embodiments, when a new group of users joins the real-time communication session, the new participants are placed into empty slots in the existing template if there are the correct number of empty slots (e.g., if the existing template is associated with the total quantity of users participating in the real-time communication session after detecting the arrival of the plurality of additional users), and if not, all of the participants are arranged (or rearranged) in a template that is associated with the total quantity of users participating in the real-time communication session in response to detecting the arrival of the new group of additional users. Placing representations and/or viewpoints of a group of new participants in empty template slots if there are the correct quantity of empty slots available reduces the need to rearrange the other participants, thereby providing better viewing stability for the other participants and reducing the likelihood of errors in interaction with the computer system or with each other.

In some embodiments, the quantity of empty virtual locations is larger than the quantity of the plurality of additional users. For example, if there were two empty slots such as shown in FIG. 9I and one user joined the session, the computer system optionally arranges the participants as shown in FIG. 9G. For example, if two users join the real-time communication session and there are three or more empty slots in the existing template, the viewpoints and/or representations of participants are rearranged according to a different template that is associated with the total quantity of participants after the new participants join the session. Rearranging participants in response to new users joining when there are too many empty slots (relative to the quantity of new participants) results in better spacing between participants, thereby reducing the likelihood of errors in interaction with the computer system or with each other.

In some embodiments, the quantity of empty virtual locations is smaller than the quantity of the plurality of additional users, such as described above with reference to FIGS. 9I and 9L. For example, if two users join the real-time communication session and there is one empty slot in the existing template, the viewpoints and/or representations of participants are rearranged according to a different template that is associated with the total quantity of participants after the new participants join the session. Rearranging participants in response to new users joining when there are too few empty slots (relative to the quantity of new participants) results in an appropriate arrangement of participants, thereby reducing the likelihood of errors in interaction with the computer system or with each other.

In some embodiments, after displaying the representation of the second user at the second virtual location or the third virtual location in response to detecting that the one or more first criteria are satisfied (e.g., as described with reference to steps 1002c and 1002d), the computer system detects an arrival of a third user in the real-time communication session (e.g., in a manner similar to that described earlier with reference to detecting the arrival of the second user).

In some embodiments, in response to detecting the arrival of the third user and in accordance with a determination that the total quantity of users participating in the real-time communication session, including the first user, the second user, and the third user, is a third quantity of users, the computer system displays representations of the second user and the third user at respective virtual locations according to a second template associated with the third quantity of users (e.g., in slots of the second template) independently of a virtual location at which the representation of the second user was displayed when the arrival of the third user was detected. For example, in FIG. 9K, representation of fifth user 909 has moved away from virtual location 940n, leaving an empty slot. If another user joins the session, the computer system rearranges the participants (including the fifth user) as shown in FIG. 9L (e.g., rather than placing the new user in the empty slot). In some embodiments, when a new user joins the real-time communication session, the computer system resets the template based on the total quantity of users whether or not any participants have moved away from template slots at which they were previously displayed. For example, if a representation of the second user was previously displayed at a slot of a first template and subsequently moved away from that slot (e.g., before the third user joined the session), the representation of the second user is optionally placed into a slot in the second template when the third user joins. Resetting participants into template slots when a new user joins, regardless of where in the three-dimensional environment the representations and/or viewpoints of the participants are located at the time the new user joins, alerts the participant that a new user has joined and places them in an appropriate location for interacting with the new user (and with each other).

In some embodiments, while displaying the representation of the second user at the second virtual location or the third virtual location, such as representation of second user 904 shown in FIG. 9N (e.g., as described with reference to step 1002c), the computer system detects an arrival of a third user in the real-time communication session (e.g., as described above).

In some embodiments, in response to detecting the arrival of the third user (and optionally in response to a determination that the first user and the second user are arranged in slots of first template that is a first type of template, such as a content-viewing template), the computer system displays a representation of the third user at a fifth virtual location (e.g., in a slot of the first template, optionally immediately adjacent to a representation and/or viewpoint of the first user, the second user, and/or another participant, such as along a line or arc) without changing the virtual location associated with the viewpoint of the first user and without changing the virtual location at which the representation of the second user is displayed, such as shown in FIG. 9O, in which representation of user 906 is displayed without changing the locations of representations of other users. For example, the viewpoint of the first user and the representation of the second user remain at the same virtual locations (e.g., in the same template) after the third user joins, and a representation of the third user is displayed next to the other participants in the template, optionally without leaving intervening empty template slots between participants. Maintaining the locations of representations and/or viewpoints of participants in the template when a new participant joins the session (e.g., when participants are viewing content and/or are arranged in a content-viewing template) provides better viewing stability for participants and reduces disruptions in viewing the content.

In some embodiments, the first template corresponds to a first arrangement of virtual locations distributed (optionally, with uniform spacing) along a first perimeter of a first closed shape (e.g., in a ring template shaped as a circle having points along a perimeter that are equidistant from the center or as an oval having points along a perimeter that are not equidistant from the center) having a first radius that is determined (e.g., selected (such as based on a list of values), obtained, received, calculated, and/or identified), by the first computer system, based on the first quantity of users, such as circle 914c having radius 916c in FIG. 9C based on there being three users. For example, the radius of the closed shape is optionally larger when the quantity of users is larger, such that there is sufficient room around the closed shape to place a larger quantity of participants. Optionally, the template is shaped as an oval, which can have different distances between points along the perimeter and a center. Optionally, the computer system selects a closed shape (e.g., a circle, an oval, or another closed shape) based on various criteria, such as based on a configuration setting of the computer system, a quantity of users participating in the real-time communication session, a type of virtual content being shared among the users, and/or spatial conflicts with other elements in the three-dimensional environment.

In some embodiments, the second spatial arrangement corresponds to a second arrangement of virtual locations distributed along a second perimeter of a second closed shape (e.g., an elliptical or circular shape having one or more characteristics of the first closed shape) having a second radius, different from the first radius, that is determined, by the first computer system, based on the second quantity of users, such as circle 914d having radius 916d in FIG. 5H based on there being five users, where radius 916d is longer than radius 916c. In some embodiments, the radius is a first radius if the quantity of users is less than a threshold quantity (e.g., less than 3, 4, 5, 7, 9, 10, 20, or 30 users) and the radius is a second radius, larger than the first radius, if the quantity of users is greater than or equal to the threshold quantity. In some embodiments, the computer system may use multiple thresholds to determine the radius. For example, the computer system optionally uses a first radius when there are fewer than 5 users, a second (larger) radius when there are 5-8 users, and a third radius (larger than the first and second radii) when there are 9-12 users. Other ranges are possible (corresponding to other radii). In some embodiments, if the first closed shape and/or second closed shape are not circles, such as if they are elliptical, the computer system optionally selects a major radius and/or minor radius based on the quantity of participants in a manner similar to described with respect to that when the first closed shape and/or second closed shape are circular. In some embodiments, the computer system switches from a circular template having a single radius to a non-circular (oval) template having multiple radii based on the quantity of participants, such as when there are more than a threshold quantity of participants (e.g., more than 5, 8, 10, 15, or 20 participants).

In some embodiments, displaying the representation of the second user (e.g., as described with reference to steps 1002c and 1002d) comprises displaying the representation of the second user facing (e.g., with a viewpoint oriented towards) a center (e.g., a focal point) of the first closed shape or the second closed shape, such as displaying representations of users in FIG. 9C facing the center 942a of circle 914c. In some embodiments, a representation or viewpoint of a user is facing a center of a closed shape if a vector extending perpendicularly from the viewpoint of the user is within a threshold distance (such as within 0.001, 0.01, 0.1, 0.5, 1, 1.5, 5, or 10 m) of intersecting the center of the closed shape (or directly intersects the center of the closed shape).

In some embodiments, the viewpoint of the first user is facing the center of the first closed shape or the second closed shape, such as the viewpoint of first user 902 facing the center 942a of circle 914c in FIG. 9C (e.g., as described above with reference to the second user facing the center of the first oval or the second oval). Optionally, the viewpoint of the first user is facing the representation of the second user, and/or the viewpoint of the second user is facing the viewpoint of the first user, such as when there are a total of two users (the first user and the second user) participating in the real-time communication session. Arranging representations and/or viewpoints of participants in a ring template (circular or oval-shaped) having a radius that increases as the quantity of participants increases allows the participants to easily see and/or interact with each other at distances that are appropriate to the quantity of users participating in the session, such that they are not too close or too far from each other.

In some embodiments, in accordance with the determination that the first quantity of users (e.g., 2, 3, 4, 5, 10, 15, 20, or 40) are participating in the real-time communication session, displaying the representation of the second user comprises displaying the representation of the second user facing (e.g., oriented towards, such as described earlier with respect to a representation of a user facing the center of an oval) the first virtual location, and the viewpoint of the first user is facing the second virtual location, such as shown in FIG. 9C. For example, if there are a total of two users, the representations and/or viewpoints of the users are optionally arranged such that they are facing each other. For example, if there are four users, pairs of users are optionally arranged such that they are facing each other.

In some embodiments, in accordance with the determination that the second quantity of users (e.g., 2, 3, 4, 5, 10, 15, 20, or 40) are participating in the real-time communication session, displaying the representation of the second user comprises displaying the representation of the second user facing a center region (e.g., a center point or area or a focal point that lies between the participants) of the second template (e.g., a center of a circle or oval of a ring template) without facing the first virtual location (e.g., without directly facing each other), and the viewpoint of the first user is facing the center region of the second template without facing the third virtual location, such as shown in FIG. 9E. For example, if there are an odd number of users, or greater than four users, the representations and/or viewpoints of the users are optionally arranged (e.g., according to a ring template) such that they face a center of a circle or oval rather than directly facing each other. Arranging participants such that they directly face each other when possible and face a central region between the participants in other cases allows the participants to easily see and/or interact with each other.

In some embodiments, the one or more first criteria include a criterion that is satisfied when users in the real-time communication session are participating in a first type of shared activity, such as watching media content as shown in FIG. 9N. In some embodiments, a shared activity includes an activity in which virtual content—such as a movie, game, map, image, application window, or other content—is accessible to (e.g., visible to, audible to, and/or capable of being viewed, heard, and/or interacted with) multiple participants in the session, such as content that has been shared by one or more of the participants (e.g., as described with reference to method 1200). In some embodiments, the first type of shared activity corresponds to an activity in which participants are viewing and/or interacting with content that is vertically displayed, such as media content or an application window. In some embodiments, the first type of shared activity corresponds to an activity in which participants are viewing and/or interacting with content that is horizontally displayed, such as a board game or horizontal map. In some embodiments, the computer system selects the first template and/or the second template (e.g., for arranging participants) based on the type of shared activity. For example, if the first type of shared activity corresponds to viewing a movie (e.g., vertically displayed content), the computer system optionally selects a content-viewing template that arranges participants in a line or arc facing the movie. For example, if the first type of shared activity corresponds to playing a horizontally displayed game, the computer system optionally selects a ring template that arranges participants around the game. In some embodiments, if the second criteria are not satisfied because the participants are not participating in a shared activity (e.g., there is no shared virtual content) or the participants are participating in a second type of shared activity different from the first type of shared activity, the participants are arranged in different virtual locations corresponding to slots in a different template, such as slots of a ring template and/or slots of a template corresponding to the second type of shared activity. Arranging participants according to the type of activity in which they are participating allows the participants to view and/or interact with shared content of the activity from locations that are appropriate to the particular type of content being shared.

In some embodiments, the first type of shared activity corresponds to viewing virtual content in a vertical plane (e.g., media content or an application window) within the three-dimensional environment, and the first spatial arrangement and second spatial arrangement correspond to arrangements of virtual locations in a line (e.g., a straight or curved line (arc), optionally side-by-side) facing (e.g., having viewpoints oriented towards) the virtual content, such as shown in FIG. 9N. Arranging participants in a line facing shared virtual content enables the participants to easily view and/or interact with the virtual content.

In some embodiments, the first type of shared activity corresponds to viewing virtual content oriented in a horizontal plane (e.g., a horizontally displayed map or game) within the three-dimensional environment, and the first spatial arrangement and second spatial arrangement correspond to arrangements of virtual locations around a perimeter of the virtual content and facing the virtual content, such as shown in FIG. 9M (e.g., corresponding to placing participants in a ring template as described earlier or in another closed-form template shape, such as a square or rectangle). Arranging participants along a perimeter of the shared content and facing the shared virtual content enables the participants to easily view and/or interact with the virtual content.

In some embodiments, virtual locations in the first spatial arrangement are associated with first virtual content (e.g., the virtual locations correspond to slots in a first template associated with the virtual content and that are based on the first virtual content, such as corresponding to seats at a rectangular game, such as optionally shown in template 900F of FIG. 9A) and virtual locations in the second spatial arrangement are associated with second virtual content (e.g., the virtual locations are slots in a second template associated with the second virtual content and that are based on the second virtual content, such as corresponding to seats at a circular game, such as optionally shown in template 900g of FIG. 9A and FIG. 9M). Arranging participants based on the shape and/or size of the virtual content enables the participants to easily view and/or interact with the virtual content.

In some embodiments, while the three-dimensional environment is visible via the display generation component, (e.g., as described with reference to step 1002a) the computer system detects that one or more second criteria are satisfied, including a first criterion that is satisfied while the first computer system is in a real-time communication session that includes a third computer system associated with a third user (e.g., as described earlier). In some embodiments, the second criteria have one or more of the characteristics of the first criteria described with reference to step 1002b. In some embodiments, the second criteria include a criterion that is satisfied when the first computer system receives a request to join the third computer system in a real-time communication session and/or the first computer system accepts (e.g., authenticates) a request from the third computer system to join the real-time communication session. In some embodiments, the second criteria include a criterion that is satisfied when a representation of the third user is not currently presented (e.g., displayed) within the three-dimensional environment when the request is received. In some embodiments, the second criteria include a criterion that is satisfied when the third user and/or third computer system join the real-time communication session.

In some embodiments, in response to detecting that the one or more second criteria are satisfied and in accordance with a determination that a first quantity (e.g., 2, 3, 4, 5, 10, 15, 20, or 40) of spatial participants (e.g., spatial participants as described with reference to method 1200) are participating in the real-time communication session independent of a quantity of non-spatial participants (e.g., non-spatial participants as described with reference to method 1200) that are participating in the real-time communication session, the computer system displays, in the three-dimensional environment via the display generation component, a representation of the third user at a first virtual location for the third user relative to a third virtual location associated with the viewpoint of the first user in the three-dimensional environment (where the third virtual location associated with the viewpoint of the first user is optionally the same as or different from the first virtual location associated with the viewpoint of the first user or the second virtual location associated with the viewpoint of the first user). For example, representation of second user 904 is optionally placed at virtual location 940y in FIG. 9N or at virtual location 940bb in FIG. 9P (if there is at least one non-spatial participant) independent of how many non-spatial users are participating in the session.

In some embodiments, in response to detecting that the one or more second criteria are satisfied and in accordance with a determination that the second quantity (e.g., 2, 3, 4, 5, 10, 15, 20, or 40) of spatial participants, different from the first quantity of spatial participants, are participating in the real-time communication session independent of a quantity of non-spatial participants that are participating in the real-time communication session (e.g., as described above), the computer system displays, in the three-dimensional environment via the display generation component, the representation of the third user at a second virtual location, different from the first virtual location, for the third user relative to the third virtual location associated with the viewpoint of the first user in the three-dimensional environment. For example, representation of second user 904 is optionally placed according to a different template than in FIG. 9P based on there being a different quantity of spatial users, such as along a different arc facing representation of non-spatial user 946. In some embodiments, non-spatial participants are treated differently than spatial participants for the purpose of arranging representations and/or viewpoints of participants according to templates. For example, optionally, representations of non-spatial participants do not consume (e.g., are not displayed at virtual locations corresponding to) slots in templates and are instead displayed as two-dimensional application windows in the three-dimensional environment, around which representations and/or viewpoints of spatial participants are arranged. For example, representations and/or viewpoints of spatial users are optionally arranged according to templates associated with the quantity of spatial users participating in the real-time communication session without considering the quantity of non-spatial participants. Optionally, representations and/or viewpoints of spatial users are arranged according to a different template if there is a non-spatial participant than if there are no non-spatial participants (but independently of the actual quantity of the non-spatial participants), such as by being arranged with a facing direction (e.g., as described earlier with reference to facing a center of an oval) towards a representation(s) of a non-spatial participant(s). Treating non-spatial participants differently for purposes of arranging participants allows the representations and/or viewpoints of spatial participants and non-spatial participants (if any) to provides participants with better visibility of other participants.

In some embodiments, the second user is a spatial participant (e.g., as described with reference to method 1200) and the one or more first criteria include a criterion that is satisfied when the second user joins the real-time communication session (e.g., when a second computer system associated with the second user establishes a communication link with the computer system of the first user and/or when the computer system is determining where to display a representation of the second user in the three-dimensional environment).

In some embodiments, while the three-dimensional environment is visible via the display generation component, (e.g., as described with reference to step 1002a) the computer system detects that one or more second criteria are satisfied, including a first criterion that is satisfied while the first computer system is in a real-time communication session that includes a third computer system associated with a third user and a second criterion that is satisfied when the third user joins the real-time communication session (e.g., when the computer system is determining where to display a representation of the third user in the three-dimensional environment).

In some embodiments, in response to detecting that the one or more second criteria are satisfied and in accordance with a determination that the third user is a spatial participant in the real-time communication session (e.g., a spatial participant as described with reference to method 1200), the computer system displays a representation of the third user at a first virtual location for the third user (e.g., corresponding to a slot in a first template.) relative to a third virtual location associated with the viewpoint of the first user in the three-dimensional environment. For example, representation of second user 904 is optionally placed at virtual location 940bb in FIG. 9N based on being a spatial participant.

For example, the representation of the third (spatial) user is optionally displayed at a virtual location corresponding to a slot in a ring template, as previously described, or at a virtual location corresponding to a slot in an open horseshoe or U-shaped template, where representation(s) of one or more non-spatial users are displayed at the head (e.g., the open end) of the horseshoe or U-shaped template. Optionally, the representation of the third user is a three-dimensional representation if the third user is a spatial participant and a two-dimensional representation if the third user is a non-spatial participant. Optionally, the first template is associated with the total quantity of users participating in the real-time communication session, optionally excluding non-spatial participants, and is optionally selected based on the presence or absence of non-spatial participants. The third virtual location associated with the viewpoint of the first user is optionally the same as or different from the first virtual location associated with the viewpoint of the first user and/or the second virtual location associated with the viewpoint of the first user.

In some embodiments, in response to detecting that the one or more second criteria are satisfied and in accordance with a determination that the third user is a non-spatial participant in the real-time communication session (e.g., a non-spatial participant as described with reference to method 1200), the computer system displays the representation of the third user at a second virtual location, different from the first virtual location, for the third user (e.g., corresponding to a slot in a second template) relative to the third virtual location associated with the viewpoint of the first user in the three-dimensional environment. For example, representation of non-spatial participant 946 is optionally placed at virtual location 940cc in FIG. 9N based on being a non-spatial user. For example, the representation of the third (non-spatial) user is optionally displayed at the head of an open horseshoe or U-shaped template, where representation(s) of one or more spatial users are displayed at respective slots along the perimeter of the horseshoe or U-shaped template. Optionally, the second template is associated with the total quantity of users participating in the real-time communication session and selected based on the presence of one or more non-spatial participants. Displaying representations of spatial participants in different virtual locations than representations of non-spatial participants provides participants with better visibility of other participants. For example, because representations of non-spatial participants are (optionally) two-dimensional representations (e.g., planar representations), placing the representation of the third user at a different location if the third user is a non-spatial participant than if the user is a spatial participant allows other participants to view two-dimensional representations from appropriate viewing perspectives (e.g., substantially facing the front of the two-dimensional representation rather than viewing it from a side angle, such as may be more appropriate if the user is a spatial user with a three-dimensional representation).

In some embodiments, while displaying the representation of the second user (e.g., where the second user is optionally a non-spatial participant) at the second virtual location for the second user or the third virtual location for the second user in response to detecting that the one or more first criteria are satisfied (e.g., as described with reference to step 1002b), the computer system detects an arrival of a third user in the real-time communication session (e.g., as described above). For example, the representation of the second user 904 is optionally displayed at virtual location 940c in FIG. 9E.

In some embodiments, in response to detecting the arrival of the third user and in accordance with a determination that the third user is a spatial participant (e.g., as described above and with reference to method 1200), the computer system updates a virtual location of the display of the representation of the second user (e.g., as described earlier with respect to updating virtual locations for users) from the second virtual location for the second user or the third virtual location for the second user to a fourth virtual location for the second user relative to a virtual location associated with the viewpoint of the first user, such as by updating the virtual location of the representation of the second user 904 to virtual location 940i as shown in FIG. 9G (e.g., a virtual location associated with the viewpoint of the first user at the time the arrival of the third user is detected or a virtual location that is associated with the viewpoint of the first user after the arrival of the third user is detected and the viewpoint of the user is optionally updated to a new virtual location based on the arrival), the fourth virtual location corresponding to a slot in a first template. For example, the representation of the second user is optionally displayed at a virtual location corresponding to a slot in a ring template, as previously described. Optionally, the first template is associated with the total quantity of users participating in the real-time communication session, optionally excluding non-spatial participants, and is optionally selected based on the absence of non-spatial participants. Optionally, a representation of the third user is displayed at a second slot in the first template.

In some embodiments, in response to detecting the arrival of the third user and in accordance with a determination that the third user is a non-spatial participant (e.g., as described above and with reference to method 1200), the computer system updates a virtual location of the display of the representation of the second user from the second virtual location for the second user or the third virtual location for the second user to a fifth virtual location for the second user relative to the virtual location associated with the viewpoint of the first user (e.g., as described above with reference to the virtual location associated with the viewpoint of the first user), different from the fourth virtual location, the fifth virtual location for the second user corresponding to a slot in a second template different from the first template, such as by updating the virtual location of the representation of the second user 904 to virtual location 940bb in FIG. 9P. For example, the representation of second user is optionally displayed at a slot along a perimeter of an open horseshoe or U-shaped template, where a representation of the third (non-spatial) user is optionally displayed at the head (e.g., an open portion) of the horseshoe or U-shaped template, optionally along with representations of one or more other non-spatial participants (e.g. within a virtual canvas, as described with referent to method 1200). Optionally, the second template is associated with the total quantity of users participating in the real-time communication session and selected based on the presence of one or more non-spatial participants. Arranging representations of spatial participants based on the presence or absence of non-spatial participants provides participants with better visibility of other participants, for reasons described above with reference to displaying representations of participants at different virtual locations depending on whether they are spatial participants or non-spatial participants.

It should be understood that the particular order in which the operations in method 1000 have been described is merely exemplary and is not intended to indicate that the described order is the only order in which the operations could be performed. One of ordinary skill in the art would recognize various ways to reorder the operations described herein.

FIGS. 11A-11Y illustrate examples of a computer system arranging representations and/or viewpoints of users that are participating in a real-time communication session (e.g., “participants” in the session) when one of the participants shares virtual content, where the user are placed at virtual locations according to a spatial template that is selected, by the computer system, based on various criteria, including characteristics of the virtual content being shared.

As previously discussed, in some embodiments, a user of computer system 101 (e.g., tablet, smartphone, wearable computer, or head mounted device) can participate in a multi-user real-time communication session (e.g., a co-presence session) with one or more additional users (participants), such as described with reference to methods 800, 1000, 1200, 1400, 1800, and/or 2000. Users can optionally share virtual content with each other in the real-time communication session. Additional details regarding sharing of content and the types of virtual content that can be shared are described with reference to method 1200.

As described herein, in some embodiments, when a participant requests to share virtual content, the computer system 101 (e.g., tablet, smartphone, wearable computer, or head mounted device) optionally arranges (and/or re-arranges) the representations and/or viewpoints of the participants in response to the request to share the content to enable participants to view and/or interact with the virtual content from perspectives that are appropriate to the particular content being shared. In some embodiments, computer system 101 (e.g., tablet, smartphone, wearable computer, or head mounted device) arranges the representations and/or viewpoints of users in accordance with a template (e.g., as described in more detail with reference to FIG. 9A and method 1000) that is selected, by computer system 101, based on characteristics of the virtual content being shared (e.g., the type of content, the size of the content, and/or other characteristics) and optionally on a quantity of users participating in the multi-user communication system at the time the request to share the virtual content is detected, among other criteria. Additional details regarding the selection of templates in response to detecting a request to share virtual content are described below with reference to FIGS. 11A-11Y.

FIG. 11A illustrates a computer system 101 (e.g., tablet, smartphone, wearable computer, or head mounted device) (e.g., an electronic device) displaying, via a display generation component (e.g., display generation component 120 of FIG. 1 such as a computer display, touch screen, or one or more display modules of a head mounted device), a three-dimensional environment 1126 (e.g., an AR, AV, VR, MR, or XR environment) from a viewpoint of the user of the computer system 101 (e.g., tablet, smartphone, wearable computer, or head mounted device) (e.g., facing the back wall of the physical environment in which computer system 101 (e.g., tablet, smartphone, wearable computer, or head mounted device) (e.g., an electronic device) is located. FIG. 11A illustrates an overhead (schematic) view relative of three-dimensional environment 1126 (e.g., an AR, AV, VR, MR, or XR environment) and a view of the three-dimensional environment presented by computer system 101 (e.g., tablet, smartphone, wearable computer, or head mounted device) via a display generation component 120 (e.g., display generation component 120 as described with reference to FIG. 1). In some embodiments, computer system 101 (e.g., tablet, smartphone, wearable computer, or head mounted device) includes and/or is communicatively linked with the display generation component 120, one or more physical buttons 1132, 1134, and 1136, and/or one or more image sensors 314 (e.g., image sensors 314 of FIG. 3). The image sensors optionally include one or more of a visible light camera, an infrared camera, a depth sensor, or any other sensor the computer system 101 (e.g., tablet, smartphone, wearable computer, or head mounted device) would be able to use to capture one or more images of a user of computer system 101 (e.g., tablet, smartphone, wearable computer, or head mounted device) or a part of the user (e.g., one or more hands of the user) while the user interacts with the computer system 101. In some embodiments, the three-dimensional environments illustrated and described below could also be implemented on (e.g., presented by) a head-mounted display that includes a display generation component that presents the three-dimensional environment to the user, and sensors to detect the physical environment and/or movements of the user's body and/or hands (e.g., external sensors facing outwards from the user), and/or attention (e.g., including gaze) of the user (e.g., internal sensors facing inwards towards the face of the user).

The figures herein illustrate views of three-dimensional environment 1126 (e.g., an AR, AV, VR, MR, or XR environment) presented to the user by computer system 101 (e.g., tablet, smartphone, wearable computer, or head mounted device) (optionally including a virtual environment displayed via the display generation component 120 of computer system 101) and schematic views of the three-dimensional environment (such as overhead view 1127 of FIG. 11A) to illustrate the spatial relationships between representations and/or viewpoints of participants (e.g., the virtual locations of representations and/or viewpoint of participants within three-dimensional environment 1126 relative to the viewpoint of the first user 1102 (e.g., the user of computer system 101) and relative to virtual objects within the three-dimensional environment 1126). In the examples herein, the overhead views and/or the views presented by computer system 101 (e.g., tablet, smartphone, wearable computer, or head mounted device) optionally do not depict physical objects that may be within the physical environment in the field of view of computer system 101 (e.g., tablet, smartphone, wearable computer, or head mounted device) (e.g., from the viewpoint of the user of computer system 101); e.g., for simplicity, the views optionally depict the shared virtual environment of the users without showing details regarding the physical environment of computer system 101. In some embodiments, the positions and/or orientations of users relative to their physical environment have one or more of the characteristics and/or behaviors discussed with reference to method 800. For example, unless a user is described as moving in their physical environment, it should be understood that the user's relative position and/or orientation in their physical environment does not change when their virtual location is set and/or updated (e.g., arranged or rearranged) as described herein. In some embodiments, when computer system 101 (e.g., tablet, smartphone, wearable computer, or head mounted device) sets and/or updates the virtual locations of representations and/or viewpoints of one or more users other than the first user, computer system 101 (e.g., tablet, smartphone, wearable computer, or head mounted device) transmits an indication of the set and/or updated respective virtual locations of the users to the respective computer systems of the users, such as to enable the respective computer systems to render representations and/or viewpoints of the users in their new virtual locations.

For brevity, in some of the figures herein, only an overhead view of the three-dimensional environment is shown without showing the corresponding view of the three-dimensional environment that would be presented by computer system 101. It should be understood that, in these cases, computer system 101 (e.g., tablet, smartphone, wearable computer, or head mounted device) would present the view of the three-dimensional environment as it would be visible to the first user via computer system 101 (e.g., tablet, smartphone, wearable computer, or head mounted device) (e.g., from the perspective of the viewpoint of the first user as shown in the overhead view).

FIG. 11A depicts an example in which three users are participating in the real-time communication session. Thus, the spatial arrangement of FIG. 11A includes a viewpoint of the first user 1102 (e.g., the user of computer system 101) located at a first virtual location 1140a, a representation of a second user 1104 located at a second virtual location 1140b, and a representation of a third user 1106 located at a third virtual location 1140c. As shown in FIG. 11A, three-dimensional environment 1126 includes virtual objects 1128 and 1130, which optionally represent virtual media content, virtual application windows, virtual representations of real-world objects, animated virtual elements (e.g., waving grass or rippling water), and/or other types of virtual objects.

The view of three-dimensional environment 1126 shown by computer system 101 (e.g., tablet, smartphone, wearable computer, or head mounted device) (e.g., visible to the first user) corresponds to the viewpoint of the first user 1102. For example, the view of three-dimensional environment 1126 depicts what is visible to the first user (via display generation component 120) when the viewpoint of the first user 1102 is located as shown in the overhead view 1127 and the first user is looking in the direction indicated by gaze direction 1102a. For example, representation of second user 1104, the representation of the third user 1106, and virtual objects 1128 and 1130 are displayed, via display generation component 120, at a viewing angle and orientation based on the viewpoint of the user 1102 being located at first virtual location 1140a and the first user looking in the indicated gaze direction 1102a.

In the example of FIG. 11A, the participants are optionally not arranged according to a template (e.g., they are not arranged by computer system 101), and are instead at respective locations within the three-dimensional environment that have been chosen by the respective participants, such as by the participants moving within their respective physical environments (e.g., as detected by their respective computer systems) and/or by otherwise providing inputs to their respective computer systems.

FIG. 11B depicts an alternative example in which the participants have been arranged by computer system 101 (e.g., tablet, smartphone, wearable computer, or head mounted device) according to a ring template (e.g., as described with reference to method 1000, around circle 1103 having center 1105), such as in response to the second user and/or third user joining the real-time communication session. In this case, representations and/or viewpoints of the participants are located at different virtual locations relative to FIG. 11A, where the virtual locations are selected by the computer system 101 (e.g., tablet, smartphone, wearable computer, or head mounted device) (e.g., corresponding to slots in a template, such as described with reference to method 1000) rather than chosen by (e.g., moved to by) the participants. For example, the viewpoint of the first user 1102 is located at virtual location 1140d (e.g., at the same virtual location as in FIG. 11A), the representation of the second user 1104 is located at virtual location 1140f, and the representation of the third user 1106 is located at virtual location 1140e. The view of the representation of the second user 1104 and the representation of the third user 1106 shown by computer system 101 (e.g., tablet, smartphone, wearable computer, or head mounted device) in FIG. 11B is different from that shown in FIG. 11A, corresponding to the change in location of the representations of the second and third users 1104 and 1106 (respectively).

From FIG. 11A or 11B to FIG. 11C, a user (optionally, the first user, the second user, or the third user) has requested to share first virtual media content with the other users in the session. For example, the first, second, or third user has requested to share a first type of virtual content (media content), such as described with reference to methods 1000 and 1200. In response to detecting the request to share the first virtual content and in accordance with a determination that the first virtual content is media content, computer system 101 (e.g., tablet, smartphone, wearable computer, or head mounted device) initiates a process for sharing the media content (e.g., as described with reference to method 1200), including displaying a first virtual element 1144 corresponding to the media content (e.g., including the media content itself and/or a user interface associated with the media content) in the three-dimensional environment 1126, and arranges the participants facing the first virtual element 1144 according to a content-viewing template, such as template 900e of FIG. 9A and further described with reference to method 1200. In the example of FIG. 11C, the template corresponds to an arc shape with three slots (e.g., three virtual locations 1140d, 1140h, and 1140g) distributed symmetrically around an apex of the arc and at which representations and/or viewpoints of the three users are placed, optionally by moving them (e.g., automatically rather than in response to user inputs) from the virtual locations at which the representations and/or viewpoints of the users were located before the virtual content was shared, such as from the virtual locations depicted in FIGS. 11A and 11B. The three slots are optionally arranged with uniform side-to-side spacing along the arc, with a center of the arc (and/or a virtual location of the viewpoint of the first user 1102) located a first distance 1119b from a focal point (e.g., a center or central region) of the first virtual element 1144. In some embodiments, computer system 101 (e.g., tablet, smartphone, wearable computer, or head mounted device) selects first distance 1119b based on a size of the first virtual element 1144 (e.g., including a display size of the media content and/or a display size of a user interface associated with the media content). Optionally, if an even quantity of users are participating in the session, a different template (e.g., including different virtual locations corresponding to slots of the template) is used than if an odd quantity of users are participating in the session (e.g., viewpoint of first user 1102 would optionally be placed next to an apex of arc 1118a rather than centered on the apex of arc 1118a, such that the viewpoints and/or representations of users are arranged symmetrically around the apex of arc 1118 (e.g., as depicted in template 900c of FIG. 9A).

Optionally, computer system 101 (e.g., tablet, smartphone, wearable computer, or head mounted device) selects a location for displaying the virtual element 1144 based on the location of the user that requested to share the content. For example, computer system 101 (e.g., tablet, smartphone, wearable computer, or head mounted device) optionally displays the virtual element 1144 at the same virtual location (or a nearby virtual location) as the representation of the user that requested to share the virtual content. For example, if the second user in FIG. 11A requested to share the virtual content, the computer system 101 (e.g., tablet, smartphone, wearable computer, or head mounted device) optionally displays virtual element 1144 at a virtual location that is near virtual location 1104c (e.g., the virtual location of the representation of the second user in FIG. 11A), in a manner such as shown in FIG. 11C. Optionally, the computer system 101 (e.g., tablet, smartphone, wearable computer, or head mounted device) displays an animation of the virtual element arriving from the virtual location of the participant that requested to share the content, as described with reference to method 1200.

In some embodiments, computer system 101 (e.g., tablet, smartphone, wearable computer, or head mounted device) displays the first virtual element 1144 at a virtual location that is selected by computer system 101 (e.g., tablet, smartphone, wearable computer, or head mounted device) based on a virtual location associated with the first user (e.g., the user of computer system 101), such as at a virtual location that is in front of the viewpoint of the first user 1102 and is the first distance 1119b from the virtual location at which the viewpoint of the first user was located when the participant (optionally, the first user) requested to share the virtual content. For example, the computer system 101 (e.g., tablet, smartphone, wearable computer, or head mounted device) optionally displays the media content in front of the viewpoint of the first user without changing the location of the viewpoint of the first user, such as shown in the sequence of FIG. 11B to 11C. In some embodiments, computer system 101 (e.g., tablet, smartphone, wearable computer, or head mounted device) changes the location of the viewpoint of the first user (e.g., along with changing the virtual locations of the representations and/or viewpoints of one or more of the other users, as shown in, for example, the sequence of FIG. 11A to 11C.

In some embodiments, if a participant shares second virtual content that is the same type of content as the first virtual content (e.g., if the first virtual content and second virtual content are both movies or videos, and/or are both displayed with the same size and/or shape), computer system 101 (e.g., tablet, smartphone, wearable computer, or head mounted device) displays a second virtual element (e.g., similarly to first virtual element 1144) and does not rearrange the representations and/or viewpoints of the participants.

FIG. 11C1 illustrates similar and/or the same concepts as those shown in FIG. 11C (with many of the same reference numbers). It is understood that unless indicated below, elements shown in FIG. 11C1 that have the same reference numbers as elements shown in FIGS. 11A-11Y have one or more or all of the same characteristics. FIG. 11C1 includes computer system 101, which includes (or is the same as) display generation component 120. In some embodiments, computer system 101 and display generation component 120 have one or more of the characteristics of computer system 101 shown in FIGS. 11A-11Y and display generation component 120 shown in FIGS. 1 and 3, respectively, and in some embodiments, computer system 101 and display generation component 120 shown in FIGS. 11A-11Y have one or more of the characteristics of computer system 101 and display generation component 120 shown in FIG. 11C1.

In FIG. 11C1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 11A-11Y.

In FIG. 11C1, display generation component 120 is illustrated as displaying content that optionally corresponds to the content that is described as being displayed and/or visible via display generation component 120 with reference to FIGS. 11A-11Y. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 11C1.

Display generation component 120 has a field of view (e.g., a field of view captured by external image sensors 314b and 314c and/or visible to the user via display generation component 120) that corresponds to the content shown in FIG. 11C1. Because display generation component 120 is optionally a head-mounted device, the field of view of display generation component 120 is optionally the same as or similar to the field of view of the user.

In some embodiments, computer system 101 responds to user inputs as described with reference to FIGS. 11A-11Y.

It is understood than one or more or all aspects of the present disclosure as shown in, or described with reference to FIGS. 11A-11Y and/or described with reference to the corresponding method(s) are optionally implemented on computer system 101 and display generation unit 120 in a manner similar or analogous to that shown in FIG. 11C1.

In some embodiments, when participants are arranged according to a content-viewing template (such as shown in FIG. 11C) and a new user joins the real-time communication session, a representation and/or viewpoint of the new user is placed, by computer system 101, next to a representation of another user without changing the locations of representations and/or viewpoints of the users that were participating in the real-time communication session before the new user joined. For example, in FIG. 11D, a fourth user has joined the session while representations and/or viewpoints of the first, second, and third users are arranged at virtual locations 1140d, 1140g, and 1140h (respectively) according to a content-viewing template (and optionally are watching the shared media content on virtual element 1144), and a representation of the fourth user 1108 is placed at virtual location 1140i, next to the representation of the second user 1104 (e.g., next to virtual location 1140g), without moving the representations and/or viewpoints of the first, second, and third users (e.g., while maintaining their respective virtual locations). Virtual location 1140i optionally corresponds to a fourth slot (e.g., a fourth virtual location) in a content-viewing template that is, optionally, considered a different content-viewing template than used in FIG. 11C because it has four slots instead of three, but is associated with the same arc 1118a shape and distance 1119 from the virtual element 1144). Optionally, as users join the session, representations and/or viewpoints of the users are placed in slots along arc 1118a at alternating left-right virtual locations. (Although a view of three-dimensional environment 1126 on computer system 101 (e.g., tablet, smartphone, wearable computer, or head mounted device) (e.g., from the perspective of the first user) is not depicted in FIG. 11D as it is in FIGS. 11A through 11C, a representation of computer system 101 (e.g., tablet, smartphone, wearable computer, or head mounted device) is depicted in the corner of FIG. 11D and in subsequent figures to indicate that that it is computer system 101 (e.g., tablet, smartphone, wearable computer, or head mounted device) that arranges and optionally displays the representations and/or viewpoints of the users that are shown in the overhead views 1127.)

As shown in FIG. 11E, in some embodiments, if more than a threshold quantity of users (e.g., a threshold quantity as described with reference to method 1200) are participating in the session when a user requests to share virtual content, and/or if more than a threshold quantity of users join the session while virtual content is being shared, computer system 101 (e.g., tablet, smartphone, wearable computer, or head mounted device) arranges representations and/or viewpoints of one or more of the users (optionally including the first user) according to a content-viewing template associated with a different arc 1118b (e.g., having less curvature relative to arc 1118a) and/or a different distance 1119b relative to a focal point of the virtual element 1144 (e.g., longer than distance 1119a). In the example of FIG. 11E, six users are participating in (e.g., have joined) the real-time communication session when and/or while the virtual content is shared (e.g., virtual element 1144 is displayed), and representations and/or viewpoints of the first user, second user, third user, fourth user, fifth user, and sixth user 1102, 1104, 1106, 1008, 1110, and 1112, respectively, are placed at virtual locations 11401, 1140g, 1140h, 1140i, 1140j, and 1140k, respectively, corresponding to slots in the content-viewing template.

In some embodiments, if a user exits the real-time communication session (e.g., as described with reference to method 1200) while participants are arranged according to a content-viewing template (e.g., as shown in FIG. 11E) and/or while virtual content is shared, computer system 101 (e.g., tablet, smartphone, wearable computer, or head mounted device) does not move or rearrange the representations and/or viewpoints of the other users (e.g., in response to detecting that one of the users has exited the real-time communication session) and instead maintains them at their current virtual locations in the template. For example, in the sequence of FIG. 11E to 11F, the fourth user exits the real-time communication session. In response to detecting that the fourth user has exited the session, computer system 101 (e.g., tablet, smartphone, wearable computer, or head mounted device) ceases to display the representation of the fourth user (e.g., representation of fourth user 1108 of FIG. 11E) and does not change the virtual locations of the representations and/or viewpoints of the other users.

In some embodiments, if the virtual content ceases to be displayed in the three-dimensional environment 1126 (e.g., as described with reference to method 1200) while participants are arranged according to a content-viewing template (e.g., as shown in FIG. 11E), computer system 101 (e.g., tablet, smartphone, wearable computer, or head mounted device) does not move or rearrange the representations and/or viewpoints of the other users (e.g., at the time when computer system 101 (e.g., tablet, smartphone, wearable computer, or head mounted device) ceases to display the virtual content) and instead maintains them at their current virtual locations in the template. For example, in the sequence of FIG. 11E to 11G, virtual element 1144 ceases to be displayed the virtual locations of the representations and/or viewpoints of the users are not changed.

FIG. 11H depicts an example in which a fourth user who is a non-spatial user (e.g., a non-spatial user as described with reference to method 1200, as compared to a spatial user described with reference to method 1200) joins the real-time communication session such that there are a total of four users participating in the real-time communication session after the non-spatial user joins. In response to detecting the arrival of the non-spatial user and in accordance with a determination that there are four participants, computer system 101 (e.g., tablet, smartphone, wearable computer, or head mounted device) arranges representations and/or viewpoints of the users at virtual locations 1140d, 1140m, 1140n and 1140o according to a ring template (e.g., such as described with reference to methods 1000 and 1200, with the representation of the non-spatial user 1145 optionally displayed as a two-dimensional video representation (e.g., rather than a three-dimensional avatar, such as are optionally used to represent spatial participants). The example of FIG. 11H illustrates the idea that representations and/or viewpoints of spatial users (e.g., viewpoint of first user 1102, representation of second user 1104, and representation of third user 1106) are optionally arranged differently (e.g., by computer system 101) when the computer system 101 (e.g., tablet, smartphone, wearable computer, or head mounted device) displays a representation of a non-spatial fourth user 1145 than when computer system 101 (e.g., tablet, smartphone, wearable computer, or head mounted device) displays media content (e.g., as shown in FIG. 11C). For example, representations and/or viewpoints of spatial user are optionally arranged to be closer to (e.g., at a shorter virtual distance from) representations of non-spatial users than to media content.

In the example of FIG. 11H, representations and/or viewpoints of the (non-spatial) fourth user and the (spatial) first, second, and third users are arranged in the same manner (e.g., at the same virtual locations) as when all four of the users are spatial users, such as according to the same ring template (e.g., they are arranged in a similar manner as that shown in FIG. 9G). In some embodiments, representations of non-spatial users and/or representations of spatial users are arranged differently when there is at least one non-spatial user than when all of the users are spatial users, such as described with reference to method 1200. For example, in accordance with a determination that a non-spatial participant has joined the session, the computer system 101 (e.g., tablet, smartphone, wearable computer, or head mounted device) optionally arranges the representations and/or viewpoints of the spatial users according to a U-shaped or horseshoe-shaped template facing the representation and/or viewpoint of the non-spatial user, with the representation and/or viewpoint of the non-spatial user placed at an open (unconnected) end of the U-shape or horseshoe (such as illustrated by FIG. 9P).

In some embodiments, representations and/or viewpoints of spatial users within the three-dimensional environment 1126 can be moved by the spatial users, such as by moving within their respective physical environments (e.g., as detected by their respective computer system). In some embodiments, spatial users can move their representations and/or viewpoints within the three-dimensional environment 1126 either before or after being arranged in virtual locations (e.g., according to a template) by computer system 101. For example, the second user in FIG. 11H can optionally move their avatar (e.g., the representation of the second user 1104) within the three-dimensional environment 1126 (such as to location 1140c shown in FIG. 11A) by moving within a physical environment of the second user. In contrast, in some embodiments, non-spatial users cannot move their representations and/or viewpoints within the three-dimensional environment 1126. For example, the representation of the fourth user 1145 optionally remains at virtual location 1140o (e.g., the location at which computer system 101 (e.g., tablet, smartphone, wearable computer, or head mounted device) placed the representation of fourth user 1145, such as according to a template) independent of any movement of the fourth user in a physical environment of the fourth user and/or independent of any movement of the representations and/or viewpoints of the spatial users.

In some embodiments, if a participant in the real-time communication session requests to share virtual content (e.g., media content) with other participants while a representation of a non-spatial participant is displayed (e.g., as shown in FIG. 11H), the computer system 101 (e.g., tablet, smartphone, wearable computer, or head mounted device) updates the virtual locations of the spatial participants and non-spatial participant(s) in accordance with a template that is similar to a content-viewing template but in which the representation and/or viewpoint of the non-spatial participant is shifted to a virtual location that is adjacent to the virtual location at which the media content is displayed, such as illustrated by FIG. 11I.

FIG. 11I depicts an example in which a participant has requested to share media content (e.g., in FIG. 11H), and in response, the computer system 101 (e.g., tablet, smartphone, wearable computer, or head mounted device) displays virtual element 1144 (e.g., including the media content) at a distance 1119b from the viewpoint of the first user 1102 and updates the virtual locations of the representations and/or viewpoints of the second user and third user from 1140m and 1140n (respectively) to 1140g and 1140h while maintaining the virtual location 1140d of the viewpoint of the first user 1102. In the example of FIG. 11I, virtual locations 1140g, 1140d, and 1140h correspond to slots along arc 1118b such as described with reference to arranging participants according to content-viewing templates. In addition to updating the virtual locations of the representation of the second user 1104 and the representation of the third user 1106, the computer system 101 (e.g., tablet, smartphone, wearable computer, or head mounted device) updates (e.g., shifts) the virtual location of the representation of the non-spatial fourth user 1145 from 1140o to 1140p such that the representation of the fourth user 1145 is displayed adjacent to the location at which virtual element 1144 is displayed and is angled towards the representations and/or viewpoints of the spatial users such it is visible to the spatial users (e.g., via their respective computer systems).

In some embodiments, in response to detecting the request to share the virtual content, the computer system displays an animation showing the virtual element 1144 arriving from the direction of the virtual location of the representation and/or viewpoint of the user that requested to share the virtual content, such as to provide an indication of the identity of the user that requested to share the virtual content. For example, if in FIG. 11H the third user requested to share the virtual content, the computer system optionally initially displays virtual element 1144 at virtual location 1140n (e.g., corresponding to the virtual location of the representation of the third user 1106 at the time the third user requested to share the virtual content) and displays an animation of virtual element 1144 moving from virtual location 1140n to virtual location 1140p (e.g., indicated by the arrow between the two virtual locations in FIG. 11I).

In some embodiments, in response to detecting the request to share the virtual content while a representation of a non-spatial user is displayed, the computer system 101 (e.g., tablet, smartphone, wearable computer, or head mounted device) shifts the representation of the non-spatial user to either the left side or the right side of the virtual content depending on which participant requested to share the content (e.g., the location of the representation of the sharing participant relative to location of the representation of the non-spatial participant). In the example depicted by the sequence of FIGS. 11H to 11I, the representation of the fourth user 1145 is shifted to the right of the representation of the fourth user 1145 because the representation of the third user 1106 (e.g., the user that requested to share the content) is to the left of the representation of the fourth user 1145 (e.g., from the perspective of the viewpoint of the first user 1102) at the time the request to share the virtual content is received; e.g., the virtual content is displayed on the same side of the representation of the non-spatial user as the representation of the sharing user). For example, the virtual element 1144 optionally visually arrives from the direction of the virtual location 1140n of the representation of the third user 1106 and occupies some or all of the area formerly occupied by the representation of the fourth user 1145 (e.g., in FIG. 11H) and the representation of the fourth user 1145 shifts to the right to make room for the display of the virtual element 1144 (while remaining visible to the spatial users). Optionally, the representation of the fourth user 1145 is displayed adjacent to the virtual element 1144 within a threshold distance of virtual element 1144 and without intervening virtual objects and/or representations of users.

If instead the second user had requested to share the virtual content, for example, the representation of the fourth user 1145 would optionally have been shifted to the left of the virtual element 1144 instead of to the right. If instead the first user had requested to share the virtual content, for example, the representation of the fourth user 1145 would optionally have been shifted to either the left or the right, as selected by computer system 101 (e.g., tablet, smartphone, wearable computer, or head mounted device) based on various other criteria.

As previously discussed, in some embodiments, in response to detecting a request to share virtual content, the computer system 101 (e.g., tablet, smartphone, wearable computer, or head mounted device) determines the type of virtual content to be shared and selects a template for arranging participants based on the type of content. For example, in FIG. 11C, the type of content was a first content type (e.g., corresponding to media content), and in accordance with a determination that the type of content was the first type, the computer system 101 (e.g., tablet, smartphone, wearable computer, or head mounted device) selected a content-viewing template (e.g., associated with the media content) for arranging the participants.

FIG. 11J depicts an example in which one of three participants in the real-time communication session (e.g., the first user or the second user) has requested to share a second (different) type of virtual content (e.g., different from a type of virtual content corresponding to media content), such as a map that is displayed by computer system 101 (e.g., tablet, smartphone, wearable computer, or head mounted device) in a horizontal plane relative to the three-dimensional environment 1126. In response to detecting the request to share the virtual content and in accordance with a determination that the virtual content is the second type of content (e.g., a horizontally displayed map rather than vertically displayed media content), computer system 101 (e.g., tablet, smartphone, wearable computer, or head mounted device) displays virtual element 1150 (e.g., a map) and arranges the representations and/or viewpoints of the first user 1102, second user 1104, and/or third user 1106 at virtual locations 1140d, 1140r, and 1140s (respectively) around virtual element 1150 according to a template that is associated with the map, such as at different virtual locations (e.g., for one or more of the participants) than those that would be used if the virtual content were media content (e.g., such as those shown in FIG. 11C). In some embodiments, virtual locations 1140d, 1140r, and 1140s correspond to slots in a template associated with virtual element 1150 when the quantity of participants is three participants.

FIG. 11K depicts an alternative to FIG. 11J in which a different type of virtual content is shared (e.g., a game rather than a map). In response to detecting the request to share the virtual content and in accordance with a determination that the virtual content is a third type of content (e.g., game rather than a map or media content), computer system 101 (e.g., tablet, smartphone, wearable computer, or head mounted device) displays virtual element 1152 (e.g., a game) arranges the representations and/or viewpoints of the first user 1102, the second user 1104, and/or the third user 1106 at virtual locations 1140d, 1140t, and 1140u (respectively) around virtual element 1152 according to a template that is associated with virtual element 1152 such as at different virtual locations (e.g., for one or more of the participants) than those that would be used if the virtual content were media content or a map.

In some embodiments, when additional users join a real-time communication session while current participants are arranged according to a template, the computer system shifts one or more of the participants to make room for the new participant(s) without changing the virtual locations of the other participants. For example, from FIG. 11J to FIG. 11L, two additional participants have joined the real-time communication session such that there are a total of five participants. In response to detecting the arrival of the fifth participant (e.g., where the fifth user arrives serially or concurrently with the fourth participant) the computer system shifts the representation of the third user 1106 (e.g., by updating the virtual location of the representation of the third user 1106 from 1140s to 1140v) without updating the virtual locations of the viewpoint of the first user 1102 and the representation of the second user 1104. Computer system 101 (e.g., tablet, smartphone, wearable computer, or head mounted device) places the representation of the fifth user 1110 at virtual location 1140w (e.g., adjacent to the representation of the third user 1106) and places the representation of the fourth user 1108 at virtual location 1140x. In some embodiments, virtual locations 1140d, 1140r, 1140v, 1140w, and 1140x correspond to slots in a template associated with virtual content 1150 when the quantity of participants is five participants. For example, the template selected by computer system 101 (e.g., tablet, smartphone, wearable computer, or head mounted device) in FIG. 11L includes some of the same slots as the template used in FIG. 11J.

From FIG. 11C to FIG. 11M depicts an example in which a participant has manually resized first virtual element 1144 such that it is a larger size in FIG. 11M relative to the size shown in FIG. 11C (e.g., the size in FIG. 11C is optionally the size when the virtual element 1144 was initially displayed and/or launched by computer system 101). For example, a participant optionally selects an affordance to resize virtual element 1144, drags a corner of virtual element 1144 (e.g., using a touch and drag input on a touch screen, an air drag gesture, or another input). In response to a participant manually resizing the first virtual element 1144, the computer system 101 (e.g., tablet, smartphone, wearable computer, or head mounted device) maintains the virtual locations of the participants (e.g., representations and/or viewpoints of first user 1102, second user 1104, and third user 1106) at the same virtual locations as depicted in FIG. 11C. For example, the computer system 101 (e.g., tablet, smartphone, wearable computer, or head mounted device) optionally does not rearrange participants in response to detecting that a participant has resized the virtual content.

In some embodiments, a participant may want to present virtual content to other participants, such as by presenting a slide deck or a video. FIG. 11N depicts an example of computer system 101 (e.g., tablet, smartphone, wearable computer, or head mounted device) arranging representations and/or viewpoints of participants according to a presenter template, in which the viewpoint and/or representation of the user that requested to share the virtual content is placed adjacent to the virtual content (e.g., in a location similar to that described with reference to FIG. 11I for the representation of the non-spatial participant). For example, in FIG. 11Q, the second user requests to share the virtual content, and in response, computer system 101 (e.g., tablet, smartphone, wearable computer, or head mounted device) displays virtual element 1156 (e.g., corresponding to the shared virtual content) at virtual location 1140aa in three-dimensional environment 1126 (e.g., an AR, AV, VR, MR, or XR environment) and arranges representations and/or viewpoints of the first user 1102, the second user 1104, and the third user 1106 at virtual locations 1140d, 1140z, and 1140y (respectively), such that the representations and/or viewpoints of the first user and the third user are displayed along arc 1118c and a distance 1119c from the virtual element 1156, and representation of second user 1104 is displayed at a virtual location 1140z that is adjacent to virtual element 1156 (e.g., within a threshold distance of virtual element 1156 and/or without intervening virtual objects and/or representations of users) and angled toward (e.g., facing) the viewpoints and/or representations of the first user 1102 and/or third user 1106.

In some embodiments, computer system 101 (e.g., tablet, smartphone, wearable computer, or head mounted device) selects a template for arranging participants based on the size of the virtual content being shared (e.g., the size at which is initially presented). Optionally, the size at which shared virtual content is initially displayed corresponds and/or is determined by a content type of the virtual content (e.g., movie content is optionally displayed at a larger size than a shared application window) and/or a configuration setting of computer system 101. FIG. 11O depicts a scenario in which computer system 101 (e.g., tablet, smartphone, wearable computer, or head mounted device) displays virtual element 1144 in response to detecting a participant's request to share content in a manner similar to that described with reference to FIG. 11C, but in this case computer system 101 (e.g., tablet, smartphone, wearable computer, or head mounted device) initially displays virtual element 1144 at the larger size shown in FIG. 11O rather than at the smaller size shown in FIG. 11C. In this case, in response to detecting the request to share the virtual content (and optionally, based on the size and/or type of the virtual content), computer system 101 (e.g., tablet, smartphone, wearable computer, or head mounted device) displays virtual element 1144 (e.g., at the larger size relative to FIG. 11C) and optionally arranges viewpoints and/or representations of participants according to a different template than used in FIG. 11C, such as a template that optionally includes virtual locations that are at a longer distance 1119d from the virtual element 1144 than distance 1119a shown in FIGS. 11C and 11M, are optionally arranged along an arc 1118d with less curvature relative to arc 1118a shown in FIGS. 11C and 11C, and optionally have different side-to-side spacing (e.g., increased side-to-side spacing along arc 1118d between representations and/or viewpoints of participants, such as shown in FIG. 11O relative to FIGS. 11C and 11M, such as to provide the participants with a better viewing angle for the larger virtual content). For example, representations and/or viewpoints of the first user, second user, and third user 1102, 1104, and 1106 (respectively) are optionally arranged at virtual locations 1140d, 1140v, and 1140w (respectively), which are different from the virtual locations depicted in FIGS. 11C and 11L. In this example, the virtual location of the viewpoint of the first user 1102 remains at virtual location 1140d (the same virtual location as in FIG. 11C and FIG. 11L, and the virtual element 1144 id displayed at a farther distance 1119c relative to virtual location 1140d (e.g., the virtual element 1114 is at a greater spatial depth relative to virtual location 1140d). As previously discussed, in some embodiments, in response to detecting the request to share the virtual content, computer system 101 (e.g., tablet, smartphone, wearable computer, or head mounted device) updates the virtual location of the viewpoint of the first user (e.g., in addition to updating the virtual locations of other participants in the real-time communication session).

In some embodiments, when non-spatial participants join the real-time communication session (e.g., as described with reference to method 1200), they are grouped together within a virtual canvas. For example, FIG. 11P depicts an example in which there is a single non-spatial user participating in the real-time communication session. In response to detecting the arrival of the first non-spatial participant, computer system 101 (e.g., tablet, smartphone, wearable computer, or head mounted device) displays a representation of the first non-spatial participant 1162 within a first virtual canvas 1160 and arranges the representations and/or viewpoints of the spatial participants (e.g., representations and/or viewpoints of the first user 1102, the second user 1104, and the third user 1106) and the virtual canvas 1160 according to a template associated with the shared virtual content, such as described with reference to previous figures (in the example of FIG. 11P, the shared virtual content is a horizontally displayed map)

In some embodiments, when computer system 101 (e.g., tablet, smartphone, wearable computer, or head mounted device) detects the arrival of additional non-spatial users and/or detects that a quantity of non-spatial users has exceeded one or more thresholds, computer system expands virtual canvas 1160 and/or displays one or more additional virtual canvases (e.g., by splitting and/or replicating virtual canvas 1160) to accommodate the display of representations of additional non-spatial users. For example, from FIG. 11P to FIG. 11Q, the computer system 101 (e.g., tablet, smartphone, wearable computer, or head mounted device) detects the arrival of three additional non-spatial users (a second, third, and fourth non-spatial user), and in response, expands virtual canvas 1160 to include representation of first non-spatial user 1162 and representation of second non-spatial user 1168 and displays second virtual canvas 1164, which includes representation of third non-spatial user 1170 and representation of fourth non-spatial user 1172. In the example of FIG. 11P, the computer system 101 (e.g., tablet, smartphone, wearable computer, or head mounted device) shifts the virtual location of virtual canvas 1160 to the left (from the perspective of the viewpoint of the first user) to make room for second virtual canvas 1164 without updating the virtual locations of the representations and/or viewpoints of the first user 1102, second user 1104, and third user 1106.

FIG. 11R depicts an example in which, after and/or while participants are arranged according to a template as shown in FIG. 11C or are located in another spatial arrangement such as in FIG. 11A, computer system 101 (e.g., tablet, smartphone, wearable computer, or head mounted device) detects a request to share second content that is the same type as the first content. For example, in FIG. 11C, the shared first content is optionally visual media content, and in FIG. 11R, the second content is also visual media content (e.g., different visual media content than in FIG. 11C). In response to detecting the request to share the second content, and based on the second content being the same content type as the first content, the computer system 101 (e.g., tablet, smartphone, wearable computer, or head mounted device) displays second virtual element 1140a (optionally, virtual element 1140a is the same as virtual element 1140 in FIG. 11C but includes different content) and arranges the participants at the same virtual locations as those depicted in FIG. 11C based on the second content being the same type of content as the first content (and optionally based on the quantity of users being the same quantity of users as in FIG. 11C). For example, the computer system 101 (e.g., tablet, smartphone, wearable computer, or head mounted device) places the representations and/or viewpoints of the first, second, and third users 1102, 1104, and 1106 (respectively) at the same virtual locations 1140d, 1140g, 1140h as depicted in FIG. 11C.

FIGS. 11S-11Y illustrate examples of a computer system changing characteristics of a virtual canvas in accordance with changes to a virtual element.

In FIG. 11S, virtual element 1144 is displayed at an initial position and with a first size within three-dimensional environment 1102. Second user 1104, third user 1106, and fourth user 1108 are displayed at respective slots within a current template (e.g., a first template), the current template including a slot (e.g., seat) for virtual canvas 1154. In some embodiments, computer system 101 determines a size of a slot in accordance with the current size of virtual element 1144. For example, from FIG. 11S to FIG. 11T, the computer system 101 optionally detects one or more inputs and/or detects an indication from another computer system requesting a change of the virtual element 1144 to a relatively bigger size (e.g., a greater height and/or width relative to three-dimensional environment 1102). In response to detecting the one or more inputs and/or detecting the indication requesting scaling of the virtual element 1144, the computer system 101 optionally updates the current template, dictating a spatial arrangement of elements of a real-time communication session including the users (e.g., second user 1104, third user 1106, fourth user 1108, and users represented by virtual canvas 1154), to positions relatively further apart from one another and at updated orientations relative to virtual element 1144. In particular, the slot that virtual canvas 1154 occupies enlarges in view of the relatively further apart spacing of the users of the real-time communication session, and computer system 101 optionally increases the size (e.g., width and/or height relative to three-dimensional environment) of virtual element 1154.

In some embodiments, the computer system 101 forgoes changing of the size of the virtual canvas 1154 in accordance with a determination that a current template including the users of the real-time communication session is a category of template. For example, FIG. 11U illustrates a current template that is similar or the same as described with reference to FIG. 11S, and/or is associated with maintaining a constant size of the virtual canvas 1154. From FIG. 11U to FIG. 11V, computer system 101 optionally detects one or more inputs and/or detects an indication from another computer system requesting a change of the virtual element 1144 to a relatively bigger size (e.g., a greater height and/or width relative to three-dimensional environment 1102). In response to detecting the one or more inputs and/or detecting the indication requesting scaling of the virtual element 1144, the computer system 101 optionally maintains the current template, instead of changing the current template, maintaining the relative spacing of the users of the real-time communication session and/or the virtual canvas. Additionally or alternatively, because the spatial arrangement of users does not change, computer system 101 forgoes changing a size of virtual canvas 1154. In some embodiments, the forgoing in changing of size of the virtual canvas 1154 is performed in accordance with a determination that the current template includes display of virtual element 1144 with a spatial relationship (e.g., position and/or orientation) relative to the three-dimensional environment 1102, and accordingly is included in the first category of templates. For example, virtual element 1144 optionally is displayed vertically, or nearly vertically, relative to a floor of the three-dimensional environment 1102, and computer system 101 optionally forgoes changing of the current template. In some embodiments, in accordance with a determination that the current template is one of the first category of templates, the computer system updates a spatial arrangement of elements of the real-time communication session (e.g., updates the position and/or orientation of seats of the current template), and forgoes changing the size of virtual canvas 1154.

FIGS. 11W-11Y illustrate changes in a spatial arrangement of elements of the real-time communication session in accordance with a determination that a current template of users of the real-time communication session is a second category of template. For example, in FIG. 11W, computer system 101 displays virtual element 1148 with a spatial relationship (e.g., position and/or orientation) relative to three-dimensional environment 1102 where virtual element 1148 is parallel, or nearly parallel to a floor of the three-dimensional environment 1102. In FIG. 11W, the users of the real-time communication session (e.g., second user 1104, third user 1106, fourth user 1108, and users represented by virtual canvas 1154) are arranged around edges of virtual element 1148. In FIG. 11W, users of the real-time communication session (e.g., second user 1104, third user 1106, and fourth user 1108) are optionally represented by a visual representation of the users that is a first type of visual representation. For example, the first type of visual representation has one or more characteristics of an expressive visual representation described further with reference to method 800. From FIG. 11W to FIG. 11X, the computer system 101 optionally detects one or more inputs and/or detects an indication from another computer system requesting a change of the virtual element 1148 to a relatively bigger size (e.g., a greater height and/or width relative to three-dimensional environment 1102). In response to detecting the one or more inputs and/or detecting the indication requesting scaling of the virtual element 1148, the computer system 101 optionally updates the current template, dictating a spatial arrangement of elements of a real-time communication session including the users (e.g., second user 1104, third user 1106, fourth user 1108, and users represented by virtual canvas 1154), to positions relatively further apart from one another and at updated orientations relative to virtual element 1148. In FIG. 11X, the one or more inputs and/or indication of requests of scaling of the virtual element 1148 are ongoing, such that virtual element 1148 is larger than as shown in FIG. 11W, and continues to change in size as input (e.g., air gestures, cursor gestures, and/or voice commands) continue to change the size of virtual element 1148. In some embodiments, while such scaling inputs directed to virtual element 1148 are ongoing, computer system 101 displays visual representations of users of the real-time communication session with a second type of visual representation. For example, visual representation 1158, 1156, and 1160 optionally correspond to the second type of visual representation (e.g., described further with reference to method 800, such as polygonal representation that are not as expressive as the first type of visual representations), and optionally respectively correspond to the second user, third user, and the fourth user. From FIG. 11X to FIG. 11Y, computer system 101 detects a termination of the one or more inputs and/or indication(s) of requests scaling virtual element 1148. In response to detecting the termination, the computer system 101 replaces display of visual representation 1158, 1156, and 1160, with corresponding visual representation of the first type. Additionally, in FIG. 11Y, virtual canvas 1154 is displayed with an updated size (e.g., corresponding to the updated size of virtual element 1148), and second user 1104, third user 1106, and fourth user 1108 are displayed with an updated spatial arrangement relative to three-dimensional environment 1102, corresponding to an update to the current template of the real-time communication session. It is understood that in some embodiments, the size of virtual elements changes (e.g., decreasing or increasing), and in response, computer system 101 changes a size of a virtual canvas 1154 (e.g., decreasing or increasing in response to increasing the size of the virtual canvas, or increasing or decreasing in response to decreasing the size of the virtual canvas).

FIG. 12 is a flowchart illustrating a method of arranging representations of participants based on shared content, in accordance with some embodiments of the disclosure. In some embodiments, the method 1200 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1200 is governed by instructions that are stored in a non-transitory computer-readable storage medium and that are executed by one or more processors of a computer system, such as the one or more processors 202 of computer system 101 (e.g., tablet, smartphone, wearable computer, or head mounted device) (e.g., control unit 110 in FIG. 1A). Some operations in method 1200 are, optionally, combined and/or the order of some operations is, optionally, changed.

In some embodiments, method 1200 is performed at a first computer system in communication with (e.g., including and/or communicatively linked with) a display generation component. In some embodiments, the first computer system has one or more of the characteristics of the computer system(s) described with reference to methods 800, 1000, 1400, 1600, 1800, and/or 2000. In some embodiments, the input device(s) has one or more of the characteristics of the input device(s) described with reference to methods 800, 1000, 1400, 1600, 1800, and/or 2000. In some embodiments, the display generation unit has one or more of the characteristics of the display generation component described with reference to methods 800, 1000, 1400, 1600, 1800, and/or 2000.

In some embodiments, while a three-dimensional environment is visible (e.g., to a first user) via the display generation component (1202a), such as three-dimensional environment 1126 (e.g., an AR, AV, VR, MR, or XR environment) shown in FIG. 11A, and while a first user of the first computer system is in a real-time communication session with a second user, different from the first user, of a second computer system different from the first computer system (e.g., while the first user, second user, and third user represented in FIG. 11A are participating in a real-time communication session), the computer system displays (1202b), via the display generation component, a visual representation of the second user (e.g., representation of second user 1104 in FIG. 11A) at a first virtual location for the second user (e.g., virtual location 1104c) within the three-dimensional environment from a viewpoint of the first user (e.g., from viewpoint of first user 1102). In some embodiments, the three-dimensional environment has one or more of the characteristics of the three-dimensional environments of methods 800, 1000, 1400, 1600, 1800, and/or 2000. The first user and the second user optionally are in communication via the first computer system and/or the second computer system. In some embodiments, the real-time communication with the second user includes a real-time, or nearly real-time communication of voice and/or indications of the location, position, and/or movement of the second user within the second user's physical environment and/or within a three-dimensional environment shared by the participants in the real-time communication session. In some embodiments, the first computer system initiates the real-time communication session with the second user by transmitting a request (e.g., to the second computer system) to initiate a real-time communication session with the second user. In some embodiments, the first computer system initiates a real-time communication session with the second user in response to receiving a request, from the second user, to initiate and/or join the real-time communication session (e.g., a request from the second computer system of the second user). In some embodiments, after communication is established between the first computer system and the second computer system, the first computer system displays virtual content (e.g., an at least partially immersive virtual environment) to facilitate communication with the second user within a joint virtual environment. In some embodiments, the real-time communication session has one or more of the characteristics of the communication sessions of methods 800, 1000, 1400, 1600, 1800, and/or 2000.

In some embodiments, the visual representation of the second user has one or more of the characteristics of the visual representation of the second user described with reference to methods 800 and/or 1000. In some embodiments, the first virtual location from the viewpoint of the first user is a virtual location at which the visual representation of the second user is visible, via the display generation component, within the three-dimensional environment, such that the first user sees the visual representation of the second user as being present at the first virtual location within the three-dimensional environment. In some embodiments, the first virtual location of the second user is associated, by the first computer system, with a first physical location of the second user within the second user's physical environment.

In some embodiments, while displaying the visual representation of the second user at the first virtual location from the viewpoint of the first user in the three-dimensional environment (e.g., as shown in FIG. 11A), the computer system detects (1202c) a request to share first content with participants in the real-time communication session within the three-dimensional environment. For example, a user in FIG. 11A requests to share virtual content with the other users in FIG. 11A. In some embodiments, the content is virtual content that includes visual and/or audio content associated with an application, such as media content (e.g., still images or audio and/or video content that changes over time during playback), a slide deck, a spreadsheet, a text message conversation, social media content, a game, or a map. In some embodiments, the content includes a two-dimensional representation of a non-spatial participant in the real-time communication session. In some embodiments, the first computer system detects the request to share content from the first user or from another user participating in or joining the real-time communication session. For example, in some embodiments, the request to share content is a request from the first user that is detected via one or more input devices of the first computer system (e.g., as described with reference to method 800), such as one or more cameras, microphones, touch screens, accelerometers, and/or other input devices/sensors. For example, the first computer system optionally detects an input from the first user requesting to share the content, such as by detecting a selection of an affordance associated with the content and/or with an application associated with the content. In some embodiments, detecting the selection of the affordance includes detecting an input from a hand of the user, such as a touch input on a touch screen, an input on a mouse or trackpad, and/or an air gesture (e.g., an air pinch or hand raise detected by a camera and/or hand-tracking sensors). In some embodiments, detecting the selection of the affordance includes detecting a gaze of the user directed towards the affordance (e.g., via eye-tracking sensors or other sensors). In some embodiments, the request to share the content is a request from a different user (e.g., different from the first user) that is participating in and/or joining the multi-user communication session with the first user (e.g., the request detected by the second computer system), and the first computer system detects the request to share the content by receiving (e.g., from the second computer system) the request to share the content. For example, a spatial or non-spatial participant in the multi-user communication system (optionally, represented by a three-dimensional or two-dimensional representation of the participant) optionally requests to share the content while participating in the real-time communication session. For example, a non-spatial participant optionally requests to join the real-time communication session, in which case the content that is requested to be shared is optionally a two-dimensional representation of the non-spatial participant, such as a live video of the non-spatial participant, a still image of the non-spatial participant, or a two-dimensional avatar of the non-spatial participant.

In some embodiments, in response to detecting the request to share the first content with participants in the real-time communication session within the three-dimensional environment (1202d), the computer system initiates (1202e) a process for sharing the first content in the real-time communication session (e.g., by downloading, launching, and/or playing the first content and/or downloading, launching, activating, or maintaining activation of an application associated with the first content), including displaying a virtual element (e.g., virtual element 1144 shown in FIG. 11C) corresponding to the first content (e.g., the first content itself and/or a user interface associated with the first content) in the three-dimensional environment, wherein the virtual element corresponding to the first content is accessible to (e.g., visible to, audible to, and/or capable of being viewed, heard, and/or interacted with) the first user and the second user in the real-time communication session (e.g., virtual element 1144 in FIG. 11C is visible to and/or interactable with by the first, second, and third users in FIG. 11C). In some embodiments, the virtual element corresponding to the content is not displayed at the time when the request to share the content is received. In some embodiments, initiating the process for sharing the content includes providing access to the content to the second computer system, such as by making private content accessible to the first user and/or the second user.

In some embodiments, in response to detecting the request to share the first content with participants in the real-time communication session within the three-dimensional environment (1202d), the computer system updates (1202f), based at least in part on the first content (e.g., based on the virtual content shared by the participant and optionally displayed in virtual element 1144) (e.g., based on one or more characteristics of the first content, such as a content type of the first content, an orientation of the first content, a size of the first content, or another characteristic of the first content, and/or based on a template associated with the first content (e.g., a template as described with reference to method 1000) that specifies a spatial arrangement of representations and/or viewpoints of participants) the virtual location at which the visual representation of the second user (e.g., representation of second user 1104) is displayed (1202g) to be a second virtual location for the second user (e.g., the virtual location for the representation of the second user is updated from virtual location 1140c in FIG. 11A to virtual location 1140g in FIG. 11C), different from the first virtual location for the second user. In some embodiments, updating the virtual location at which the visual representation of the second user is displayed includes displaying the visual representation of the second user at the second virtual location in the three-dimensional environment and/or updating the viewpoint of the second user from the first virtual location to the second virtual location. In some embodiments, the first computer system selects the second virtual location in accordance with a pre-defined template of virtual locations that is associated with the content and, optionally, with the number of users participating in the multi-user communication session (e.g., such as described with reference to method 1000). For example, if the content is media content, the first computer system optionally selects the second virtual location such that the visual representation of the second user is displayed as facing the media content and is displayed at an appropriate viewing distance (e.g., 0.1, 0.5, 1.0, 1.5, 2.5, 5, or 15 meters) from the media content. For example, if the content is a map, the first computer system optionally selects the second virtual location such that the visual representation of the second user is facing the map and is located within a threshold virtual distance (e.g., 0.001, 0.01, 0.05, 0.1, 0.2, 0.5, 1, 2, or 5 meters) of the map. In some embodiments, the virtual location at which the visual representation of the second user is displayed is updated based on the request to share the content, without additional user inputs and/or without detecting (or receiving an indication of) a change in the physical location of the second user and/or without receiving, from the second computer system, an indication of a change in the virtual location at which the visual representation of the second user should be displayed. In some embodiments, updating the virtual location at which the visual representation of the second user is displayed includes displaying an animation of the visual representation of the second user moving from the first virtual location to the second virtual location. In some embodiments, updating the virtual location at which the visual representation of the second user is displayed includes transmitting, to the second computer system, an indication of the second virtual location and/or an indication of the shared content (and/or the type of the shared content).

In some embodiments, in response to detecting the request to share the first content with participants in the real-time communication session within the three-dimensional environment (1202c), the computer system updates, based at least in part on the first content, a virtual location corresponding to a respective user (e.g., a virtual location of the viewpoint and/or of the displayed representation of the first user or of another user, such as viewpoint of first user 1102 and/or representation of third user 1106 in FIG. 11A, in the real-time communication session (1202h) from a first virtual location for the respective user (e.g., virtual location 1140a for the viewpoint of the first user or virtual location 1140b for the representation of the third user 1106) to a second virtual location for the respective user (e.g., virtual location 1140d for the viewpoint of the first user or virtual location 1140h for the representation of the third user 1106), different from the first virtual location for the respective user. Optionally, the respective user is the first user, and updating the virtual location corresponding to the respective user includes updating the virtual location of the viewpoint of the first user from the third virtual location (e.g., the location associated with the first user's viewpoint displayed when the first computer system detected the request to share the content) to the fourth virtual location. In some embodiments, updating the virtual location corresponding to the respective user from a third virtual location to a fourth virtual location includes displaying a visual representation of the respective user at the fourth virtual location in the three-dimensional environment. In some embodiments, the virtual location corresponding to the respective user is updated based on the request to share the content and/or without detecting (or receiving an indication of) a change in the physical location of the respective user and/or without receiving, from a computer system of the respective user, an indication of a change in the virtual location corresponding to the respective user. In some embodiments, the respective user is a different user than the first user and the second user, and the third virtual location is a virtual location in the three-dimensional environment at which a visual representation of the respective user was displayed when the first computer system detected the request to share the content. In some embodiments, the first computer system selects the fourth virtual location in accordance with a pre-defined template of virtual locations that is associated with the content and, optionally, with the number of users participating in the multi-user communication session (e.g., such as described with reference to method 1000). In some embodiments, updating the virtual location corresponding to the respective user includes displaying a changing viewpoint of the three-dimensional environment corresponding to moving from the third virtual location to the fourth virtual location. In some embodiments, updating the virtual location corresponding to the respective user includes displaying an animation of a visual representation of the respective user moving from the third virtual location to the fourth virtual location. In some embodiments, updating the virtual location corresponding to the respective user includes transmitting, to a third computer system (e.g., a computer system associated with the respective user), an indication of the fourth virtual location and/or an indication of the shared content (and/or the type of the shared content). Automatically rearranging the viewpoints and/or representations (e.g., avatars) of participants in a multi-user communication session based on the content when one of the participants requests to share the content allows the participants to view and share the content from perspectives that are appropriate to the particular content being shared without requiring them to provide additional inputs to relocate their viewpoint and negotiate spatial positioning relative to each other and/or relative to the content while avoiding spatial conflicts.

In some embodiments, the updating of the virtual location at which the visual representation of the second user is displayed to be the second virtual location for the second user (e.g., as shown in FIG. 11C and described with reference to step 1202g) and the updating of the virtual location corresponding to the respective user (e.g., the first user or another user) in the real-time communication session from the first virtual location for the respective user to the second virtual location for the respective user (e.g., as described with reference to step 1202h) are performed in accordance with a determination that the content type is a first content type. For example, in FIG. 11C, the content type optionally corresponds to visual media content. In some embodiments, the content type is optionally a vertical content type in which content is displayed in a vertical plane relative to the three-dimensional environment (e.g., an application window, media content, a vertically displayed map, or another type of vertical content, which optionally correspond to a first vertical content type, a second vertical content type, or another vertical content type) or a horizontal content type in which content is displayed in a horizontal plane relative to the three-dimensional environment (e.g., a horizontally displayed board game, a horizontally displayed map, or another type of horizontal content, which optionally correspond to a first horizontal content type, a second horizontal content type, or another horizontal content type).

In some embodiments, in response to detecting the request to share the first content with participants in the real-time communication session within the three-dimensional environment and in accordance with a determination that the content type is a second content type different from the first content type (e.g., the second content type is a map content type rather than a visual media content type), the computer system updates, based at least in part on the first content, the virtual location at which the visual representation of the second user is displayed to be a third virtual location for the second user, different from the first virtual location for the second user and the second virtual location for the second user. For example, the computer system optionally updates the virtual location for the representation of the second user 1104 from virtual location 1140c in FIG. 11A to FIG. 1140r in FIG. 11J. In some embodiments, updating the virtual location at which the visual representation of the second user is displayed includes displaying the visual representation of the second user at the second virtual location in the three-dimensional environment and/or updating the viewpoint of the second user from the first virtual location to the second virtual location. In some embodiments, the first computer system selects the second virtual location in accordance with a pre-defined template of virtual locations that is associated with the content and, optionally, with the number of users participating in the multi-user communication session (e.g., such as described with reference to method 1000). For example, if the content is media content, the first computer system optionally selects the second virtual location such that the visual representation of the second user is displayed as facing the media content and is displayed at an appropriate viewing distance (e.g., 0.1, 0.5, 1.0, 1.5, 2.5, 5, or 15 meters) from the media content. For example, if the content is a horizontally displayed map, the first computer system optionally selects the second virtual location such that the visual representation of the second user is facing the map and is located within a threshold virtual distance (e.g., 0.001, 0.01, 0.05, 0.1, 0.2, 0.5, 1, 2, or 5 meters) of the map. In some embodiments, the virtual location at which the visual representation of the second user is displayed is updated based on the request to share the content, without additional user inputs and/or without detecting (or receiving an indication of) a change in the physical location of the second user and/or without receiving, from the second computer system, an indication of a change in the virtual location at which the visual representation of the second user should be displayed. In some embodiments, updating the virtual location at which the visual representation of the second user is displayed includes displaying an animation of the visual representation of the second user moving from the first virtual location to the second virtual location. In some embodiments, updating the virtual location at which the visual representation of the second user is displayed includes transmitting, to the second computer system, an indication of the second virtual location and/or an indication of the shared content (and/or the type of the shared content).

In some embodiments, in response to detecting the request to share the first content with participants in the real-time communication session within the three-dimensional environment and in accordance with a determination that the content type is a second content type different from the first content type, the computer system updates, based at least in part on the first content, the virtual location corresponding to the respective user (e.g., a virtual location associated with the viewpoint and/or displayed representation of the first user or another user) in the real-time communication session from the first virtual location for the respective user to a third virtual location for the respective user, different from the first virtual location for the respective user and the second virtual location for the respective user. For example, the computer system updates the virtual location for the representation of the third user 1106 from 1140b in FIG. 11A to 1140S in FIG. 11J. Automatically selecting different arrangements for representations and/or viewpoints of participants based on the type of content being shared allows the participants to view and/or interact with the content from perspectives that are appropriate to the particular type of content being shared without requiring them to provide additional inputs to relocate their viewpoint and negotiate spatial positioning relative to each other and/or relative to the content while avoiding spatial conflicts. For example, if the content is vertically displayed content, viewpoints and/or representations of users are optionally arranged such that they can comfortably view the vertically displayed content as they would in a physical environment, such as in a side-by-side arrangement. For example, if the content is horizontally displayed content, such as a virtual board game, viewpoints and/or representations of users are optionally arranged such that they can comfortably view and/or interact with the horizontally displayed content as they would in a physical environment, such as being arranged around a perimeter of the horizontally displayed content.

In some embodiments, in response to detecting the request to share the first content with participants in the real-time communication session within the three-dimensional environment (e.g., as described with reference to step 1202d) and in accordance with a determination that the content type is a third content type different from the first content type and the second content type (e.g., the content type is a game content type rather than a map or visual media content type), the computer system updates, based at least in part on the first content (e.g., based on a characteristic of the first content and/or based on a template associated with the first content, such as described above) the virtual location at which the visual representation of the second user is displayed to be a fourth virtual location for the second user, different from the first virtual location for the second user, the second virtual location for the second user, and the third virtual location for the second user. For example, the computer system optionally updates the virtual location for the representation of the second user 1104 from virtual location 1140c in FIG. 11A to FIG. 1140t in FIG. 11K. For example, the first content type is optionally a first vertical content type, such as a content type corresponding to vertically displayed media content, the second content type is optionally a second vertical content type, such as a content type corresponding to a vertically displayed application window, and the third content type is optionally a first horizontal content type, such as a horizontally displayed board game (other combinations are possible).

In some embodiments, in response to detecting the request to share the first content with participants in the real-time communication session within the three-dimensional environment (e.g., as described with reference to step 1202d) and in accordance with a determination that the content type is a third content type different from the first content type and the second content type (e.g., the content type is a game content type rather than a map or visual media content type), the computer system updates, based at least in part on the first content the virtual location corresponding to the respective user (e.g., the first user or another user) in the real-time communication session from the first virtual location for the respective user to a fourth virtual location for the respective user, different from the first virtual location for the respective user, the second virtual location for the respective user, and the third virtual location for the respective user. For example, the computer system updates the virtual location for the representation of the third user 1006 from 1140b in FIG. 11A to 1140u in FIG. 11K. In some embodiments, the virtual location at which the representation of the second user is displayed and the virtual location corresponding to the respective user are updated in a manner similar to that described earlier. Supporting different arrangements for representations and/or viewpoints of participants based on multiple (e.g., three or greater) types of content being shared allows the participants to view and/or interact with the content from perspectives that are more customized to the particular content being shared, thereby automatically providing the user with better visibility and/or ability to interact with the shared content (e.g., without requiring further inputs from the user).

In some embodiments, the first content type corresponds to vertically displayed media content (e.g., displayed on a virtual movie screen, such as is optionally depicted in FIG. 11C) and the second content type corresponds to a vertically displayed two-dimensional representation of a non-spatial participant (e.g., as described earlier) in the real-time communication session (e.g., such as depicted by representation of non-spatial user 1145 in FIG. 11H). In some embodiments, a non-spatial participant is a participant who joins the real-time communication session using a different type of application and/or a different type of computer system than is used by spatial participants. For example, spatial participants optionally join the real-time communication session using an AR/VR application and/or AR/VR hardware (e.g., optionally including eye-tracking hardware, cameras, accelerometers, hand-tracking hardware, or other types of hardware that enable collection of three-dimensional spatial data of the user) and are optionally represented by three-dimensional avatars based on three-dimensional spatial data associated with the participant and detected by the AR/VR application and/or AR/VR hardware. Non-spatial participants optionally join the real-time communication session using a non-AR/VR application and/or non-AR/VR hardware, such using as a video messaging or video-calling application on a cell phone or tablet, and are optionally represented by two-dimensional avatars based on two-dimensional data (e.g., video data) associated with the participant and detected by the non-AR/VR application. In some embodiments, when the content type corresponds to a vertically displayed two-dimensional representation of a non-spatial participant, the viewpoints and/or representations of the other (spatial) participants are arranged in an arc, U-shape, or horseshoe shape facing the representation of the non-spatial participant such that the spatial participants can easily view and/or interact with the representation of the non-spatial participant. In some embodiments, when the content type corresponds to a vertically displayed media content, such as a movie, the viewpoints and/or representations of the participants (e.g., spatial and optionally non-spatial) are arranged side-by-side in an arc or line facing the media content such that the participants can easily view and/or interact with the media content. Allowing non-spatial participants (e.g., participants who do not have access AR/VR hardware) to join the real-time communication session, and displaying a corresponding two-dimensional representation of the non-spatial participant(s) within the three-dimensional environment, provides greater accessibility to a broader range of users. Automatically arranging the viewpoints and/or representations of non-spatial participants and spatial participants differently when the spatial participants are viewing media content relative to the case when they are viewing and interacting with representations of non-spatial participants allows the participants to view and/or interact with media content and non-spatial participants from perspectives that are more customized to those types of content, thereby providing the user with better visibility and/or ability to interact with the shared content (e.g., without requiring further inputs from the user).

In some embodiments, the second virtual location for the second user and the second virtual location for the respective user are longer virtual distances from the virtual element corresponding to the first content than the third virtual location for the second user and the third virtual location for the respective user. For example, the virtual locations of the representations of the second user 1004 and the representation of the third user 1106 are optionally a longer distance from virtual content 1144 in FIG. 11E than from the representation of the non-spatial participant 1145 in FIG. 11H, or from the virtual content 1144 in FIG. 11D. In some embodiments, when the content type corresponds to a vertically displayed two-dimensional representation of a non-spatial participant, the viewpoints and/or representations of the other (spatial) participants are arranged relatively close to the representation of the non-spatial participant (e.g., within a threshold virtual distance, such as 0.01, 0.1, 0.5, 1, 1.5, 3, 5, or 10 m) such that the spatial participants can easily view and/or interact with the representation of the non-spatial participant. In some embodiments, when the content type corresponds to a vertically displayed media content, such as a movie, the viewpoints and/or representations of the other (spatial) participants are arranged farther away from the media content then when the content type corresponds to the vertically displayed two-dimensional representation of a non-spatial participant (e.g., at a longer virtual distance from the media content, such as 0.1, 0.5, 1, 1.5, 3, 5, 10, 15, or 30 m) such that the participants can comfortably view and/or interact with the media content. Automatically arranging the viewpoints and/or representations of spatial participants closer to representations of non-spatial participants than to media content allows the participants to view and/or interact with media content and with non-spatial participants from distances that are appropriate to those types of content, thereby providing the user with better visibility and/or ability to interact with the shared content (e.g., without requiring further inputs from the user).

In some embodiments, the second virtual location for the second user and the second virtual location corresponding to the respective user correspond to a first slot and a second slot, (e.g., first and second virtual locations at which representations and/or viewpoints of users can be placed by computer system 101, in a template (as described herein)) respectively, in a first template (e.g., a template that includes multiple slots, such as described with reference to method 1000 and depicted in FIG. 9A) associated with the first content. For example, the virtual location 1140g for the representation of the second user 1104 and the virtual location 1140h for the representation of the third user 1106 in FIG. 11C optionally correspond to slots in a first content-viewing template.

In some embodiments, after updating the virtual location at which the visual representation of the second user is displayed and the virtual location corresponding to the respective user in the real-time communication session (e.g., as described with reference to step 1202g) and after the sharing of the first content (e.g., while the first content is still being shared and/or displayed, such as shown in FIG. 11C, or after the first content has ceased to be shared and/or displayed), the computer system detects a request to share second content with the participants in the real-time communication session within the three-dimensional environment (e.g., as described with reference to detecting the request to share first content and as described with reference to FIG. 11R), where the second content is different from the first content, and the first content is content of the first type and the second content is content of the first type (e.g., both the first content and the second content are the same type of content and/or are associated with the same template, such as when both the first content and the second content are movies or when they are both a particular type of board game, such as a rectangular board game for which participants are arranged around the rectangular perimeter of the game).

In some embodiments, in response to detecting the request to share the second content, the computer system initiates a process for sharing the second content in the real-time communication session (e.g., by downloading, launching, and/or playing the second content and/or downloading, launching, activating, or maintaining activation of an application associated with the second content), including displaying a second virtual element (e.g., second virtual element 1140a in FIG. 11R) corresponding to the second content (e.g., displaying the second content itself and/or displaying a user interface associated with the second content, which is optionally the same user interface as the user interface associated with the first content) in the three-dimensional environment, wherein the second virtual element corresponding to the second content is accessible to the first user and the second user in the real-time communication session (e.g., as described earlier with respect to the first content being accessible to the users). In some embodiments, the second virtual element corresponding to the second content is (or was) not displayed at the time when the request to share the second content is (or was) received. In some embodiments, initiating the process for sharing the second content includes providing access to the second content to the second computer system, such as by making private content accessible to the first user and/or the second user.

In some embodiments, in response to detecting the request to share the second content, the computer system updates, based at least in part on the second content (e.g., based on one or more characteristics of the second content and/or based on a template associated with the second content, such as described earlier with reference to the first content) the virtual location at which the visual representation of the second user is displayed to be a third virtual location for the second user, such as updating the virtual location of the representation of the second user 1104 to virtual location 1140g as depicted in FIG. 11R (e.g., updating the virtual location to the third virtual location from a different virtual location, such as from the first virtual location for the second user, the second virtual location for the second user, or another virtual location for the second user). In some embodiments, updating the virtual location at which the visual representation of the second user is displayed includes displaying the visual representation of the second user at the third virtual location in the three-dimensional environment and/or setting the viewpoint of the second user to the third virtual location. In some embodiments, the first computer system selects the third virtual location for the second user in accordance with the first template of virtual locations that is associated with the second content and the first content, such as described earlier and with reference to method 1000. In some embodiments, updating the virtual location at which the visual representation of the second user is displayed includes displaying an animation of the visual representation of the second user moving from a different virtual location to the third virtual location. In some embodiments, updating the virtual location at which the visual representation of the second user is displayed to the third virtual location includes transmitting, to the second computer system, an indication of the third virtual location.

In some embodiments, in response to detecting the request to share the second content, the computer system updates, based at least in part on the second content, the virtual location corresponding to the respective user (e.g., corresponding to a viewpoint and/or a displayed representation of the first user or another user) in the real-time communication session to a third virtual location corresponding to the respective user, such as updating the virtual location of the representation of the third user 1106 to virtual location 1140h as shown in FIG. 11R (e.g., updating the virtual location to the third virtual location corresponding to the respective user from a different virtual location corresponding to the respective user, such as from the first virtual location corresponding to the respective user, the second virtual location corresponding to the respective user, or another virtual location corresponding to the respective user in a manner similar to that described earlier). In some embodiments, the first computer system selects the third virtual location corresponding to the respective user in accordance with a pre-defined template of virtual locations that is associated with the second content (and with the first content), such as described earlier and with reference to method 1000. In some embodiments, the third virtual location for the second user and the third virtual location corresponding to the respective user correspond to a third slot and a fourth slot (optionally the same as the first and second slots) in the first template, such as being the same slots in the same content-viewing template as used for FIG. 11C. Using the same template for arranging the representations and/or viewpoints of participants when different content of the same content type is shared results in predictable locations of participants, thereby reducing unexpected relocations within the three-dimensional environment and reducing the likelihood of erroneous interactions with the computer system.

In some embodiments, the second virtual location for the second user and the second virtual location corresponding to the respective user correspond to a first slot and a second slot, respectively, in a first template (e.g., slots in a template such as described with reference to method 1000 and depicted in FIG. 9A) associated with the first content. For example, in FIG. 11C, virtual location 1140g of representation of second user 1104 and virtual location 1140h of representation of third user 1106 optionally correspond to slots in a content-viewing template.

In some embodiments, after updating the virtual location at which the visual representation of the second user is displayed and the virtual location corresponding to the respective user in the real-time communication session (e.g., as described with reference to step 1202g and shown in, for example, FIG. 11C) and while the first content is shared (e.g., while the first content is still being shared and/or displayed or after the first content has ceased to be shared and/or displayed), the computer system detects a request to share second content (e.g., as described above with reference to detecting a request to share second content) with the participants in the real-time communication session within the three-dimensional environment, wherein the second content is different from the first content, and the first content is content of the first type and the second content is content of the second type (e.g., the first content and the second content are different types of content and/or are associated with different templates, such as when the first content is a movie and the second content is a particular type of board game, such as a rectangular board game for which participants are arranged around the rectangular perimeter of the game).

In some embodiments, in response to detecting the request to share the second content, the computer system initiates a process for sharing the second content in the real-time communication session (e.g., as described with respect to initiating the process for sharing the first content), including displaying a second virtual element corresponding to the second content (e.g., the second content itself and/or a user interface associated with the second content) in the three-dimensional environment, wherein the second virtual element corresponding to the second content is accessible to (e.g., visible to, audible to, and/or capable of being viewed, heard, and/or interacted with) the first user and the second user in the real-time communication session. For example, computer system displays virtual element 1150 in FIG. 11J in response to detecting a request to share map content, where virtual element 1150 (including the second content) is accessible to the first user, the second user, and the third used.

In some embodiments, in response to detecting the request to share the second content, the computer system, the computer system updates, based at least in part on the second content (e.g., based on a characteristic of the second content and/or based on a template associated with the second content, such as based on a characteristic of a map shared in FIG. 11J) the virtual location at which the visual representation of the second user is displayed to be a third virtual location for the second user, such as by updating the virtual location of representation of second user 1104 to virtual location 1140r as shown in FIG. 11J (e.g., updating the virtual location to the third virtual location from a different virtual location, such as from the first virtual location for the second user, the second virtual location for the second user, or another virtual location for the second user). In some embodiments, updating the virtual location at which the visual representation of the second user is displayed includes displaying the visual representation of the second user at the third virtual location in the three-dimensional environment and/or setting the viewpoint of the second user to the third virtual location. In some embodiments, the first computer system selects the third virtual location for the second user in accordance with a second template of virtual locations that is associated with the second content (and not with the first content), such as described earlier and with reference to method 1000. In some embodiments, updating the virtual location at which the visual representation of the second user is displayed includes displaying an animation of the visual representation of the second user moving from a different virtual location to the third virtual location. In some embodiments, updating the virtual location at which the visual representation of the second user is displayed to the third virtual location includes transmitting, to the second computer system, an indication of the third virtual location.

In some embodiments, in response to detecting the request to share the second content, the computer system, the computer system updates, based at least in part on the second content the virtual location corresponding to the respective user (e.g., corresponding to a viewpoint and/or a displayed representation of the first user or another user) in the real-time communication session to a third virtual location corresponding to the respective user, such as by updating the virtual location of representation of third user 1106 to virtual location 1140s as shown in FIG. 11J (e.g., updating the virtual location to the third virtual location corresponding to the respective user from a different virtual location corresponding to the respective user, such as from the first virtual location corresponding to the respective user, the second virtual location corresponding to the respective user, or another virtual location corresponding to the respective user in a manner similar to that described earlier). In some embodiments, the first computer system selects the third virtual location corresponding to the respective user in accordance with a pre-defined template of virtual locations that is associated with the second content (and with the first content), such as described earlier and with reference to method 1000. Automatically changing the template used to arrange participants when different types of content are shared allows the participants to view and/or interact with the content from perspectives that are appropriate to the particular content being shared, thereby automatically providing the user with better visibility and/or ability to interact with the shared content (e.g., without requiring further inputs from the user).

In some embodiments, the second virtual location for the second user and the second virtual location corresponding to the respective user correspond to a first slot and a second slot in a first template associated with the first content (e.g., as described earlier, such as a content-viewing template shown in FIG. 11C). In some embodiments, after updating the virtual location at which the visual representation of the second user is displayed and the virtual location corresponding to the respective user (e.g., as described with reference to step 1202g) in the real-time communication session and while the visual representation of the second user is displayed at the second virtual location for the second user and the virtual location corresponding to the respective user is the second virtual location corresponding to the respective user (e.g., as described earlier), the computer system detects a request to share second content with the participants in the real-time communication session within the three-dimensional environment, wherein the second content is different from the first content, and the first content is content of the first type and the second content is content of the first type (e.g., the computer system detects a request to share second content in a manner similar to that described earlier with reference to detecting a request to share the first content and/or to share the second content). For example, while the representation of second user 1104 is displayed at virtual location 1140g as shown in FIG. 11C, the computer system detects a request to share a different content of the same type as is shared in FIG. 11C.

In some embodiments, in response to detecting the request to share the second content, the computer system initiates a process for sharing the second content in the real-time communication session, including displaying a second virtual element corresponding to the second content in the three-dimensional environment, such as by displaying second virtual element 1144a in FIG. 11R (e.g., as described earlier with reference to initiating the process for sharing the first content and/or for sharing the second content), where the second virtual element corresponding to the second content is accessible the first user and the second user in the real-time communication session (e.g., as described earlier with reference to content being accessible to users).

In some embodiments, in response to detecting the request to share the second content, the computer system maintains (e.g., refrains from changing) the virtual location at which the visual representation of the second user is displayed at the second virtual location for the second user, such as by maintaining the representation of the second user 1104 at virtual location 1140g from FIG. 11C to FIG. 11R (e.g., keeping the representation of the second user at the virtual location at which the representation of the second user was placed when the first content was shared).

In some embodiments, in response to detecting the request to share the second content, the computer system maintains the virtual location corresponding to the respective user (e.g., the first user or another user) in the real-time communication session at the second virtual location for the respective user, such as by maintaining the virtual location of the representation of the third user 1106 at virtual location 1140h from FIG. 11C to FIG. 11R (e.g., keeping the virtual location corresponding to the respective user at the location selected for the respective user when the first content was shared). Maintaining the spatial arrangement of participants viewing first content when second content of the same type is shared maintains consistency in the arrangement of the participants. For example, if participants are viewing a first movie and a participant requests to share a second movie, the participants are not rearranged (e.g., the template remains the same), thereby maintaining consistency and reducing unexpected relocations within the three-dimensional environment and reducing the likelihood of erroneous interactions with the computer system.

In some embodiments, the second virtual location for the second user and the second virtual location corresponding to the respective user correspond to a first slot and a second slot in a first template associated with the first content (e.g., as described earlier). In some embodiments, after updating the virtual location at which the visual representation of the second user is displayed (such as described with reference to step 1202g and optionally while the visual representation of the second user continues to be displayed at the updated virtual location) and the virtual location corresponding to the respective user (e.g., the first user or another user) in the real-time communication session, the computer system detects a request to share second content with the participants in the real-time communication session within the three-dimensional environment, where the second content is different from the first content. For example, while participants are arranged as shown in FIG. 11C, the computer system detects a request to share different content.

In some embodiments, in response to detecting the request to share the second content, the computer system initiates a process for sharing the second content in the real-time communication session, including displaying a second virtual element (such as virtual element 1150 of FIG. 11J or virtual element 1144a of FIG. 11R) corresponding to the second content in the three-dimensional environment, wherein the second virtual element corresponding to the second content is accessible to the first user and the second user in the real-time communication session (e.g., as described earlier with reference to initiating the process for sharing the first content and/or for sharing the second content).

In some embodiments, in response to detecting the request to share the second content and in accordance with a determination that the second content is content of a different type than the first content (e.g., the second content is content of a second type and the first content is content of a first type, such as described earlier) the computer system updates, based at least in part on the second content (e.g., based on a characteristic of the second content and/or based on a template associated with the second content) and in accordance with (e.g., based on) a second template (e.g., a template as described with reference to method 1000) associated with the second content (e.g., a second template different from the first template associated with the first content), the virtual location at which the visual representation of the second user is displayed (e.g., such that the visual representation of the second user is displayed at a virtual location corresponding to a first slot in the second template). For example, the computer system updates the virtual location of the representation of the second user 1104 from FIG. 11C to FIG. 11J. Optionally, in accordance with the determination that the second content is content of a different type than the first content, the virtual location corresponding to the respective user (e.g., the first user or another user) is updated such that the respective user has a virtual location that corresponds to a second slot in the second template, different from the first slot. For example, a representation of the respective user is displayed at the updated virtual location corresponding to the second slot, and/or the viewpoint of the respective user corresponds to the updated virtual location. Optionally, in accordance with the determination that the second content is content of a different type than the first content, the virtual location corresponding to the respective user (e.g., the first user or another user) is maintained at the current virtual location (e.g., not updated).

In some embodiments, in response to detecting the request to share the second content and in accordance with a determination that the second content is content of a same type as the first content (e.g., the first content type, the second content type, or another content type), the computer system maintains (e.g., refrains from updating) the virtual location at which the visual representation of the second user is displayed at the second virtual location for the second user, such as by maintaining the virtual location of the representation of the second user 1104 from FIG. 11C to FIG. 11R. For example, if the second content is content of the same type as the first content (e.g., is associated with the same template (the first template) as the first content), representations of participants optionally continue to be displayed at same slots in the first template (e.g., the virtual locations at which the representations were displayed when the second content was shared).

In some embodiments, in response to detecting the request to share the second content and in accordance with a determination that the second content is content of a same type as the first content, the computer system maintains the virtual location corresponding to the respective user (e.g., the first user or another user) in the real-time communication session at the second virtual location for the respective user, such as by maintaining the virtual location of the representation of the third user 1106 from FIG. 11C to FIG. 11R. For example, if the second content is content of the same type as the first content (e.g., is associated with the same template (the first template) as the first content), the virtual location corresponding to the respective user remains at the same slot in the first template. Automatically maintaining or changing the arrangement of participants based on whether the content shared is the same type of content as previously shared content or is a different type of content (respectively) provides the user with better visibility and/or ability to interact with the shared content (e.g., without requiring further inputs from the user).

In some embodiments, detecting the request to share the first content (e.g., as described with reference to step 1202c) comprises detecting, via one or more input devices of the first computer system, an input from a user of the first computer system. For example, the first user of FIG. 11A provides an input to computer system 101 (e.g., tablet, smartphone, wearable computer, or head mounted device) requesting to share the first content. The input optionally includes a touch input, a press and/or rotation of a physical button or a solid state button, a verbal input, an air hand gesture, and/or a gaze input (e.g., a gaze of the user directed to the first content). In some embodiments, the request to share the first content includes a request to sharing the content (e.g., for making private content accessible to other participants), optionally while the content is already visible to (e.g., displayed) and/or accessible to the respective user requesting to share the content. For example, the input from the user optionally corresponds to a selection of a user interface element for sharing the content, where the user interface element is displayed with the content. In some embodiments, the request to share the first content includes a request to display the first content and/or to launch an application associated with the first content (e.g., a request received while the first content is not currently displayed). Allowing the user of the computer system to share content with other participants within the real-time communication session enables the user to efficiently share content without exiting the real-time communication session.

In some embodiments, detecting the request to share the first content (e.g., as described with reference to step 1102a) comprises obtaining information (e.g., information that specifies the content to be shared, the identity of the participant sharing the content, or other types of information) corresponding to the request from the second computer system. For example, the second or third user of FIG. 11A provides an input to their respective computer system requesting to share the first content. For example, the computer system optionally receives and/or retrieves the information from another computer system (e.g., a computer system of another participant in the real-time communication session) at which a participant provided input to share the first content in the communication session, or detects the information using, for example, one or more input devices of the computer system, such as by detecting a verbal request from another participant. Allowing other participants in a real-time communication session to share content enables the user to efficiently receive, view, and/or interact with content of other participants without exiting the real-time communication session.

In some embodiments, while the first content is shared (e.g., after initiating the process to share the first content and before ceasing to share the first content), the computer system obtains information corresponding to a request to cease the sharing of the first content, such as obtaining information corresponding to a request of a user depicted in FIG. 11E to cease sharing the first content (e.g., from the participant that requested to share the first content or from another participant). Optionally, the request to cease sharing the first content includes a request to exit the first content without exiting an application associated with the first content. Optionally, the request to cease sharing the content includes a request to exit an application associated with the first content. Optionally, the request to cease sharing the first content includes a request to share different content. Optionally, the request to cease sharing the first content includes a request to make the first content private (e.g., not viewable by some or all of the participants).

In some embodiments, in response to obtaining the information corresponding to the request to cease the sharing of the first content, the computer system ceases to share the first content, including ceasing to display the virtual element, such as shown in FIG. 11G, in which virtual element 1144 is no longer displayed. Optionally, ceasing to share the first content includes displaying and/or making visible a portion of the three-dimensional environment that was occluded by the virtual element.

In some embodiments, in response to obtaining the information corresponding to the request to cease the sharing of the first content, the computer system, the computer system maintains (e.g., refraining from changing) the virtual location at which the visual representation of the second user is displayed, and maintains the virtual location corresponding to the respective user in the real-time communication session. For example, the virtual locations of the participants in FIG. 11G are the same as the virtual locations of the participants in FIG. 11E. In some embodiments, when shared content ceases to be shared, representations and/or viewpoints of participants are not rearranged (e.g., according to a template, or according to the virtual locations associated with the participants when the first content was initially shared) when the content ceases to be shared (e.g., they are not moved or rearranged in response to obtaining the information corresponding to the request to cease the sharing of the first content). Maintaining the virtual locations of representations and/or viewpoints of participants in the real-time communication session when content stops being shared provides a less jarring and more realistic user experience.

In some embodiments, while the first content is shared, the computer system detects a change in the quantity of users participating in the real-time communication session, such as by detecting, in FIG. 11F, that the fourth user has left the real-time communication session (e.g., relative to FIG. 11E) (e.g., that a third user participating in the real-time communication session has left (e.g., exited or quit) the real-time communication session (e.g., a computer system associated with the third user has ceased to be linked to the real-time communication session), or that a fourth user has joined the real-time communication session (e.g., as described with reference to a third user joining the real-time communication session), or both (e.g., either simultaneously or sequentially).

In some embodiments, in response to detecting the change in the quantity of users participating in the real-time communication session, the computer system maintains the virtual location at which the visual representation of the second user is displayed (e.g., as described earlier), and maintains the virtual location corresponding to the respective user in the real-time communication session (e.g., as described earlier). For example, the virtual locations of the remaining participants in FIG. 11F are the same as the virtual locations of those participants in FIG. 11E. For example, if, in response to detecting the request to share the first content, where the first content is a movie, the representations and/or viewpoints of participants are optionally arranged according to a template associated with watching a movie (e.g., in an arc or line facing the movie). If one or more participants subsequently exit the real-time communication session (e.g., while the movie is shared), the remaining participants remain at the locations in the template at which they were initially placed when the movie was shared. If another user joins the real-time communication session (e.g., to watch the movie), a representation and/or viewpoint of the new user is optionally placed at a different slot in the same template (e.g., the template associated with the movie) without moving the other participants (e.g., placed next to the other participants in the arc or line facing the movie). Maintaining the virtual locations of representations and/or viewpoints of participants in the real-time communication session when users join and/or leave the real-time communication session provides a less jarring and more realistic user experience.

In some embodiments, displaying the virtual element corresponding to the first content (e.g., the content itself and/or a user interface associated with the content, as described with reference to step 1202e comprises displaying the virtual element at a respective virtual location in the three-dimensional environment that is selected based on a virtual location associated with a respective participant that requested to share the first content at the time the respective participant requested to share the first content. For example, if the second user in FIG. 11A requests to share the content, the computer system optionally displays the virtual element at or near virtual location 1140c (e.g., the virtual location of the representation of second user 1104). For example, if a first participant in the real-time communication session requests to share the first content, the virtual element is optionally displayed at a first virtual location associated with the first participant (e.g., next to a virtual location of a viewpoint of the first participant and/or a virtual location at which a representation of the first participant is displayed). In some embodiments, the virtual element is displayed with a respective spatial arrangement (distance and/or orientation) relative to the virtual location of the viewpoint and/or representation of the first participant. For example, if a second participant in the real-time communication session requests to share the first content, the virtual element is optionally displayed at the second virtual location associated with the second participant (e.g., different from the first virtual location), where the second virtual location has one or more of the characteristics of the first virtual location described above, modified to be relative to the second participant. Displaying the virtual element at a location that is based on which participant requested to share the content helps the other participants determine the identity of the participant who requested to share the content, thereby reducing the potential for confusion and/or erroneous interactions with the computer system.

In some embodiments, the respective virtual location is within a threshold virtual distance (e.g., 0.01, 0.05, 0.1, 0.5, 1, 1.5, 3, 5, or 10 m) of the virtual location associated with the respective participant, such as depicted by the presenter template shown in FIG. 11N. For example, the virtual element is optionally displayed next to (e.g., horizontally or vertically adjacent to, without intervening representations of other participants and/or other virtual content) the virtual location associated with the respective participant that requested to share the first content at the time the respective participant requested to share the first content. Displaying the virtual element near (e.g., next to) a virtual location of the participant who requested to share the content helps the other participants determine the identity of the participant who requested to share the content, thereby reducing the potential for confusion and/or erroneous interactions with the computer system.

In some embodiments, displaying the virtual element at the respective virtual location (e.g., as described earlier) comprises displaying an animation of the virtual element moving to the respective virtual location from a virtual location near (e.g., within a threshold virtual distance such as 0, 0.01, 0.05, 0.1, 0.5, 1, 1.5, 3, 5, or 10 m) the virtual location associated with the respective participant that requested to share the first content at the time the respective participant requested to share the first content, such as described with reference to FIG. 11C. In some embodiments, the animation is displayed automatically (e.g., without additional user inputs after the request to share the content). In some embodiments, displaying the animation of the virtual element moving to the respective virtual location from the virtual location associated with the respective participant includes initially displaying the virtual element at the virtual location associated with the respective participant (e.g., overlaid on or near a representation of the respective participant). Displaying an animation of the virtual element moving to the respective virtual location from a virtual location near the virtual location associated with the respective participant that requested to share the first content provides an additional indication of the identity of the participant that requested to share the content.

In some embodiments, a first participant in the real-time communication session is a non-spatial participant (e.g., as described earlier), and the first content is two-dimensional content (e.g., vertically displayed two-dimensional content, such as a movie or application window). In some embodiments, displaying the virtual element corresponding to the first content comprises displaying the virtual element at a respective virtual location that is within a threshold distance (e.g., 01, 0.05, 0.1, 0.5, 1, 1.5, 3, 5, or 10 m) of a virtual location of a representation (e.g., a two-dimensional representation) of the non-spatial participant, such as depicted in FIG. 11I. For example, if there is a non-spatial participant at the time the content is shared and a representation of the non-spatial participant is located at a first virtual location, the virtual element is optionally displayed next to the first virtual location (e.g., next to the representation of the non-spatial participant), optionally oriented to face the representations and/or viewpoints of the other participants in the real-time communication session. For example, if there is a non-spatial participant at the time the content is shared and a representation of the non-spatial participant is located at a second virtual location, the virtual element is optionally displayed next to the second virtual location (e.g., next to the representation of the non-spatial participant), optionally oriented to face the representations and/or viewpoints of the other participants in the real-time communication session. In some embodiments, if there is not a non-spatial participant at the time the content is shared, the virtual content is optionally displayed in a different virtual location than when there is a non-spatial participant, such as displayed at a farther distance from the representations and/or viewpoints of participants than the threshold distance. Displaying the virtual element near the representation of a non-spatial participant allows other participants to easily view both the shared content and the representation of the non-spatial participant.

In some embodiments, in response to detecting the request to share the first content (e.g., as described with reference to step 1202c), the computer system updates the virtual location of the representation of the non-spatial participant to shift the virtual location of the representation of the non-spatial participant away (e.g., to the left or right by a virtual distance of 01, 0.05, 0.1, 0.5, 1, 1.5, 3, 5, or 10 m) from the respective virtual location at which the virtual element is displayed, such as shown in FIGS. 11H to 11I, in which the representation of non-spatial participant 1145 is shifted away from the virtual location 1140p at which virtual element 1144 is displayed. In some embodiments, the respective virtual location at which the virtual element is displayed corresponds to the virtual location of the representation of the non-spatial participant before the virtual location of the representation of the non-spatial participant is updated; for example, the virtual element is optionally displayed in place of the representation of the non-spatial participant and the non-spatial participant is shifted to the side of the virtual element. In cases where spatial participants are arranged facing a representation of a non-spatial participant at the time when content is requested to be shared, displaying the content in the same location as the representation of the non-spatial participant maintains the visibility of the representation of the non-spatial participant in the field of view of the other participants while enabling them to view the shared content in a central location.

In some embodiments, shifting the virtual location of the representation of the non-spatial participant (e.g., as described above and shown in FIG. 11I) includes, in accordance with a determination that a spatial relationship between the virtual location associated with the respective participant (e.g., the participant requesting to share the content) and the virtual location of the representation of the non-spatial participant when the request to share the first content is detected is a first spatial relationship (e.g., a representation and/or viewpoint of the participant requesting to share the content is to the left of the virtual location of the representation of the non-spatial participant), shifting the virtual location of the representation of the non-spatial participant in a first direction (e.g., a direction that is away from the virtual location associated with the respective participant, such as in a direction that is the opposite of a direction towards the virtual location associated with the respective participant, such as rightwards relative to the virtual element); and in accordance with a determination that the spatial relationship between the virtual location associated with the respective participant and the virtual location of the representation of the non-spatial participant when the request to share the first content is detected is a second spatial relationship (e.g., a representation and/or viewpoint of the participant requesting to share the content is to the right of the virtual location of the representation of the non-spatial participant), different from the first spatial relationship, shifting the virtual location in a second direction (e.g., a direction that is away from the virtual location associated with the respective participant, such as in a direction that is the opposite of a direction towards the virtual location associated with the respective participant, such as leftwards relative to the virtual element). For example, as described in more detail with reference to FIG. 11I, representation of non-spatial participant 1145 is shifted to the right based on the location of the participant that requested to share the content. Shifting the representation of a non-spatial participant in a direction (e.g., left or right) that is based on the location associated with the participant who requested to share the content relative to the location of the representation of the non-spatial participant keeps the representation of the non-spatial participant relatively centered in front of the viewpoints and/or representations of the other participants after the virtual element is displayed where the representation of the non-spatial participant was previously located.

In some embodiments, updating of the virtual location at which the visual representation of the second user is displayed (e.g., as described earlier) comprises updating the virtual location at which the visual representation of the second user is displayed from a virtual location associated with a first slot of a first template, such as shown in FIG. 11B (e.g., a virtual location (slot) in a ring template in which slots are arranged in a circle or oval, such as in a non-content-viewing template) to a virtual location associated with a first slot of a second template, such as shown in FIG. 11C (e.g., a virtual location in a content-viewing template in which slots are arranged in an arc or line, such as in a content-viewing template), different from the first template, wherein the first template consists of a plurality of slots that are symmetrically distributed about a focal point (e.g., equidistant from the focal point and with uniform spacing between slots in the template, as shown in by the virtual locations of FIG. 11B being distributed around the center 1105 of circle 1103) in the first template (e.g., a center of a circle or oval), and wherein the second template consists of a plurality of slots that are asymmetrically distributed about a focal point in the second template, such as focal point 1117 of the content-viewing template in FIG. 11C (e.g., different distances from the focal point and optionally uniform or non-uniform spacing between slots).

In some embodiments, updating of the virtual location corresponding to the respective user in the real-time communication session comprises updating the virtual location corresponding to the respective user from a virtual location associated with a second slot of the first template (e.g., different from the first slot of the first template) to a virtual location associated with a second slot of the second template, such as updating the virtual location of the representation of the second user 1104 from 1140f in FIG. 11C to 1140g in FIG. 11D (e.g., different from the first slot of the second template). In some embodiments, participants are arranged in the first template before the content is shared (e.g., in response to detecting a user joining the communication session while no content is being shared) and are arranged in the second template after the content is shared. Changing the arrangement of participants from a ring template (e.g., before content is shared) to a content-viewing template (e.g., after and/or while content is shared) allows participants to be arranged in a manner conducive to interpersonal communication (when no content is shared) and conducive to content viewing (when content is shared).

In some embodiments, in accordance with the determination that the content type is the first content type (e.g., vertically displayed content, such as a movie or application window) the updating, based at least in part on the second content, of the virtual location at which the visual representation of the second user is displayed (e.g., as described with reference to step 1202g) comprises updating the virtual location at which the visual representation of the second user is displayed from a virtual location associated with a first slot of a first template (e.g., a template as described with reference to method 1000), the first template a first type of template (e.g., a ring template as described earlier and shown in FIG. 11B), to a virtual location associated with a first slot of a second template, the second template a second type of template (e.g., a content-viewing template, as described earlier and shown in FIG. 11C) different from the first type template. For example, the virtual location of the representation of the second user 1104 is updated from virtual location 1104f in FIG. 11B to virtual location 1104g in FIG. 11C.

In some embodiments, in accordance with the determination that the content type is the first content type the updating, based at least in part on the second content, of the virtual location corresponding to the respective user in the real-time communication session comprises updating the virtual location corresponding to the respective user from a virtual location associated with a second slot of the first template (e.g., a second slot in a ring template) to a virtual location associated with a second slot of the second template (e.g., a second slot in a content-viewing template). For example, the virtual location of the representation of the third user 1106 is updated from virtual location 1104c in FIG. 11B to virtual location 1104h in FIG. 11L.

In some embodiments, in accordance with the determination that the content type is the second content type, (e.g., horizontally displayed content, such as a board game) the updating, based at least in part on the second content, of the virtual location at which the visual representation of the second user is displayed comprises updating the virtual location at which the visual representation of the second user is displayed from a virtual location associated with the first slot of the first template (e.g., a first slot in a first ring template) to a virtual location associated with a first slot of a third template, (e.g., a first slot in a second ring template); wherein the third template is the first type of template (e.g., a ring template as described earlier). For example, the virtual location of the representation of the third user 1106 is updated from virtual location 1104s in FIG. 11J to virtual location 1104v in FIG. 11L.

In some embodiments, the updating, based at least in part on the second content, of the virtual location corresponding to the respective user in the real-time communication session comprises updating the virtual location corresponding to the respective user from a virtual location associated with the second slot of the first template to a virtual location associated with a second slot of the third template. For example, if there were another participant in FIG. 11L, the viewpoint of the first user 1102 would optionally be updated in a similar manner as shown for the representation of the third user 1106. Optionally the first template and the third template are both ring templates having either the same or different distances between the slots and a respective focal point of the first template and the third template. For example, the first template is optionally a first ring template with a first radius, and the third template is optionally a second ring template with a second radius. Optionally, the slots in the first template are more closely spaced than the slots in the third template, such that viewpoints and/or representations of some or all of the participants arranged in the third template are farther apart (e.g., 0.01, 0.1, 0.5 1, 2, 5, or 10 m farther) than viewpoints and/or representations of users arranged in the first template. Optionally, the slots in the first template are more widely spaced than the slots in the third template, such that viewpoints and/or representations of some or all of the participants arranged in the third template are closer together (e.g., 0.01, 0.1, 0.5, 1, 2, 5, or 10 m closer) than viewpoints and/or representations of users arranged in the first template. Changing the arrangement of participants either to a template that is a different type of template (if the content shared is associated with a different type of template) or to a template that is the same type of template but has different spacing between the slots and/or a different quantity of slots (e.g., if the content shared is associated with the same type of template but with different inter-slot spacing) allows participants to be arranged in a manner conducive to viewing and/or interacting with the particular content that is shared.

In some embodiments, the second user is a first non-spatial participant (e.g., as described earlier) and the visual representation of the second user comprises a two-dimensional representation of the second user displayed within a virtual canvas, such as shown by representation 1162 and virtual canvas 1160 of FIG. 11P (e.g., a two-dimensional area in the three-dimensional environment that is optionally bounded by a displayed border). Optionally, the representation of the second user and/or the virtual canvas is displayed at a virtual location corresponding to a first slot of a template.

In some embodiments, while the first user of the first computer system is in the real-time communication session with the second user (e.g., as described earlier), the computer system detects an arrival of a third user to the real-time communication session (e.g., as described earlier). For example, from FIG. 11P to FIG. 11Q, the computer system detects the arrival of multiple non-spatial users and one spatial user.

In some embodiments, in response to detecting the arrival of the third user, and in accordance with a determination that the third user is a second non-spatial participant, concurrently displaying a two-dimensional representation of the third user and the two-dimensional representation of the second user within the virtual canvas (e.g., vertically or horizontally adjacent within the virtual canvas), such as shown by representation 1162 and representation 1168 being displayed in virtual canvas 1160.

In some embodiments, in response to detecting the arrival of the third user, and in accordance with a determination that the third user is a spatial participant (e.g., as described earlier), the computer system displays a three-dimensional representation of the third user outside of (e.g., not within) the virtual canvas in the three-dimensional environment, such as by displaying representation of third user 1106 in FIG. 11Q. In some embodiments, the representation of the third user is displayed at a virtual location corresponding to a second slot of the template. Grouping non-spatial participants into a virtual canvas allows other participants to easily view multiple representations of non-spatial participants from an appropriate angle.

In some embodiments, concurrently displaying a two-dimensional representation of the third user and the two-dimensional representation of the second user within the virtual canvas (e.g., as described earlier) includes expanding (e.g., enlarging the area vertically, horizontally, or both) the virtual canvas to accommodate the two-dimensional representation of the second non-spatial participant (e.g., the third user), such as shown by the larger virtual canvas in FIG. 11Q relative to FIG. 11P. Expanding the virtual canvas to accommodate additional representations of non-spatial participants enables grouping non-spatial participants into a single virtual canvas, which allows other participants to easily view multiple representations of non-spatial participants from an appropriate angle.

In some embodiments, displaying the visual representation of the second user with the two-dimensional representation of the second user within the virtual canvas includes, in accordance with a determination that an arrangement of the participants of the real-time communication session corresponds to a first template, such as a template of users of the real-time communication session such as shown in FIG. 11S, displaying the virtual canvas having a first size, such as a size of virtual canvas 1154 as shown in FIG. 11S. For example, the computer system optionally changes the size, dimension(s), and/or orientation of the virtual canvas in accordance with changes to a current template (e.g., similar or the as described with reference to method 1000) of representations of participants in the real-time communication session, the current template including the virtual canvas. For example, in accordance with a determination that a distance between a virtual location (e.g., slot) where the virtual canvas is assigned (e.g., corresponds to) and the first content shared in the real-time communication session is a first distance, the computer system optionally displays the virtual canvas at a first size (e.g., width spanning across an axis parallel to a floor of the three-dimensional environment, and/or height spanning across an axis perpendicular to the floor of the three-dimensional environment). Additionally or alternatively, in accordance with a determination that a spatial relationship between the location that the virtual canvas is assigned to satisfies one or more criteria, such as including a criterion when a portion (e.g., a center, a point along an edge, and/or a point along a body of the virtual canvas) is within a virtual threshold distance (e.g., 0.05, 0.1, 0.25, 0.5, 1, 1.5, or 2 m) of an adjacent location (e.g. slot in a template) assigned to another one or more participants (e.g., a spatial participant or a second virtual canvas), the computer system optionally displays the virtual canvas with the first size or a size configured to prevent or minimize simulated spatial conflicts between the virtual canvas and a representation of one or more participants assigned to the adjacent location.

In some embodiments, displaying the visual representation of the second user with the two-dimensional representation of the second user within the virtual canvas includes, in accordance with a determination that the arrangement of participants of the real-time communication session corresponds to a second template, different from the first template, such as the template of users as shown in FIG. 11T, displaying the virtual canvas having a second size, different from the first size such as a size of virtual canvas 1154 as shown in FIG. 11T. For example, the computer system optionally displays the virtual canvas with a second width and/or height, different from the first width and/or height (e.g., greater than or less than the first width and/or height) in accordance with the determination that the current template is the second template. In some embodiments, when slots in a template (e.g., the first or second template) are relatively further away from each other, the virtual canvas is relatively larger in size. For example, in accordance with a determination that a distance between a slot assigned to the virtual canvas and a slot assigned to another participant is a first distance, the computer system optionally displays the virtual canvas at the first size, and in accordance with a determination that the distance between the slots is a second distance, greater than the first distance, the computer system optionally displays the virtual canvas at the second size, greater than the first size.

In some embodiments, the first template has one or more characteristics of the second template. For example, the first template and the second template optionally include placing and/or orienting visual representation of participants (e.g., including the virtual canvas) with a same sequence of participants assigned to respective locations in the current template (e.g., from left to right and/or front to back of the current template), with a same angular relationship (e.g., based on angles such as angles formed between a vector extending from a center of the visual representation of participants and a vector extending normal to share content), and/or with a same distance between adjacent participants. Displaying a size of the virtual canvas based on the arrangement of participants reduces user input required to manually change the size of the virtual canvas as the arrangement changes, thereby reducing processing and power consumption required to detect such user input.

In some embodiments, while displaying the two-dimensional visual representation of the second user within the virtual canvas, wherein the virtual canvas is displayed having a first size, the computer system detects, via the one or more input devices, user input corresponding to a request to modify a size of the virtual canvas, such as input directed to virtual canvas 1154 having a size as shown in FIG. 11S. For example, the computer system optionally detects, via the one or more input devices, one or more inputs requesting removal of a participant from a current template defining a spatial arrangement of participants of the real-time communication session including the virtual canvas, and/or optionally detects one or more inputs changing (e.g., scaling) the virtual canvas. As an example, the one more inputs optionally include a voice command, an air gesture as described with reference to step(s) 1202 (optionally while attention (e.g., gaze)) of the user is directed to a portion of the virtual canvas (e.g., a corner, an edge, and/or a body of the virtual canvas), and/or input(s) provided via a peripheral device or computing system in communication with the computer system (e.g., a mouse, stylus, an air pointing device (e.g., a device having a housing similar in profile to the stylus used to indicate a spatial position in accordance with a position and/or orientation of the air pointing device), and/or a trackpad) requesting a scaling of the virtual canvas. Additionally or alternatively, the computer system optionally detects information indicating that one or more participants will join or exit the virtual canvas (e.g., in response to detecting information indicating that a participant represented in the virtual canvas has converted representation from a spatial representation to a two-dimensional representation, information indicating a participant has converted from a spatial representation to a two-dimensional representation, information indicating that a participant has exited the real-time communication session, and/or information indicating that a participant has joined the real-time communication session), and optionally changes the size of the virtual canvas in response to obtaining such information (e.g., increasing the size of the virtual canvas to accommodate one or more additional participants or decreasing the size of the virtual canvas to accommodate one or more fewer participants in the virtual canvas).

In some embodiments, in response to detecting the user input corresponding to the request to modify the size of the virtual canvas, the computer system changes the size of the virtual canvas from the first size to a second size, different than the first size, in accordance with the user input, for example, changing a size of virtual canvas 1154 from as shown in FIG. 11S to as shown in FIG. 11T. For example, in accordance with a determination that the user input includes a net magnitude and direction corresponding to a first magnitude and direction, the computer system optionally scales (e.g., increases or decreases) one or more dimensions of the virtual canvas to assume the second size. In accordance with a determination that the user input includes a net magnitude and direction corresponding to a second magnitude (e.g., different or the same as the first magnitude) and a second direction (e.g., different or the same as the first direction), the computer system optionally scales the virtual canvas to be a third size, different from the first size. For example, when an air pinch is directed to an upper-left corner and/or a region surrounding the upper-left corner of a front face of the virtual canvas (e.g., a portion of the virtual canvas where the two-dimensional representation of the participant(s) of the communication session are visible), and moves leftward by a first magnitude and upward by a second magnitude (e.g., relative to the current viewpoint of the user), the computer system optionally increases the size of the virtual canvas based on the first and the second magnitude (e.g., increases a height and width of the virtual canvas, relative to the three-dimensional environment). When the air pinch is directed to the upper-left corner and/or a region surrounding the upper-left corner of a front-face of the virtual canvas, and moves rightward by a third magnitude and downward by a fourth magnitude (e.g., relative to the current viewpoint of the user), the computer system optionally decreases the size of the virtual canvas based on the third magnitude and the fourth magnitude (e.g., decreases the height and width of the virtual canvas relative to the three-dimensional environment). Thus, in some embodiments, the computer system scales the virtual canvas in accordance with a direction and/or magnitude of user input directed to the virtual canvas from the first size to the second size. In some embodiments, the computer system maintains a spatial relationship between the virtual canvas and the three-dimensional environment in response to the user input changing the scale of the virtual canvas. For example, in response to detecting the user input, the computer system optionally increases or decreases the scale of the virtual canvas, while maintaining alignment between a portion of the virtual canvas (e.g., a point or line intersecting with the virtual canvas, optionally not displayed) and a position within the three-dimensional environment (e.g., maintaining a center of the virtual canvas relative to a floor of the three-dimensional environment and/or a depth relative to the current viewpoint of the user). Changing the size of the virtual canvas in response to detecting user input reduces future user input required to move the virtual canvas and/or the current viewpoint of the user to view portions of the three-dimensional environment obscured by the virtual canvas and/or to enhance visibility of the virtual canvas, thereby reducing processing and power consumption required to perform future moving and/or detecting changing of the current viewpoint of the user.

In some embodiments, the second user is a first non-spatial participant (e.g., as described earlier) and the visual representation of the second user comprises a two-dimensional representation of the second user displayed within a first virtual canvas (e.g., as described earlier and shown in FIG. 11P).

In some embodiments, while the first user of the first computer system is in the real-time communication session with the second user (e.g., as described earlier), the computer system detects the arrival of a third user to the real-time communication session (e.g., as described earlier).

In some embodiments, in response to detecting the arrival of the third user and in accordance with a determination that the third user is a second non-spatial participant, in accordance with a determination that there are fewer than a threshold quantity of non-spatial participants having corresponding two-dimensional representations displayed within the first virtual canvas (e.g., fewer than 2, 3, 5, 10, 15, or 20), the computer system concurrently displays a two-dimensional representation of the third user and the two-dimensional representation of the second user within the first virtual canvas (e.g., as described earlier, optionally while displaying, in the first virtual canvas, one or more two-dimensional representations of one or more additional non-spatial participants). For example, In FIG. 11Q, representation of first non-spatial user 1162 is displayed in the same virtual canvas 1160 as representation of second non-spatial user 1168. In some embodiments, the representation of the third user and/or the first virtual canvas is displayed at a virtual location corresponding to a first slot of a template.

In some embodiments, in response to detecting the arrival of the third user and in accordance with a determination that there are more than or the same as the threshold quantity of non-spatial participants having corresponding two-dimensional representations displayed within the first virtual canvas (e.g., more than or the same as 2, 3, 5, 10, 15, or 20), the computer system displays a two-dimensional representation of the third user within a second virtual canvas (e.g., having some or all of the characteristics previously described with reference to the virtual canvas), different from the first virtual canvas, while maintaining display of the two-dimensional representation of the second user within the first virtual canvas. For example, in FIG. 11Q, representation of third non-spatial user 1170 is displayed in a second virtual canvas 1164, along with representation of fourth non-spatial user 1172 (e.g., concurrently with displaying virtual canvas 1160). In some embodiments, the representation of the third user and/or the second virtual canvas is displayed at a virtual location corresponding to a second slot of the template (e.g., a second slot of the same template in which the first virtual canvas is displayed). Optionally, the first virtual canvas and the second virtual canvas are displayed in adjacent slots of the same template. Optionally, the first virtual canvas and the second virtual canvas are displayed horizontally or vertically adjacent to each other and in the same plane. Optionally, the first virtual canvas and the second virtual canvas are displayed at an angle to each other, such as at a 3, 5, 7, 10, 15, 30, 45, 60, or 90-degree angle to each other.

Splitting the canvas when there are more than a threshold number of non-spatial participants keeps the canvas from becoming so large that it is difficult for the non-spatial participants to view or to identify different non-spatial participants.

In some embodiments, while displaying the visual representation of the second user at the second virtual location for the second user in response to detecting the request to share the first content with participants in the real-time communication session within the three-dimensional environment (e.g., as described earlier and shown in FIG. 11C), the computer system receives (e.g., from a computer system of the second user and/or from one or more input devices of the computer system of the first user) an indication corresponding to movement of the visual representation of the second user away from the second virtual location (e.g., an indication of movement of the second user in a physical environment of the second user, or an indication of a request, from the second user, to move the representation of the second user).

In some embodiments, in response to receiving the indication of the movement of the visual representation of the second user, the computer system updates the virtual location for the second user from the second virtual location for the second user (e.g., the virtual location shown in FIG. 11C) to a third virtual location for the second user in accordance with (e.g., by an amount and in a direction that is based on) the movement (e.g., to a different virtual location within three-dimensional environment 1126 of FIG. 11C). For example, if the second user moves a first physical distance to the left in the physical environment of the second user, the computer system optionally moves the representation of the second user to the left and away from the second virtual location by a virtual distance that is analogous to the first physical distance. Allowing spatial participants to move their representations within the three-dimensional environment, such as based on their own movements in the physical environment, provides a more immersive and realistic user experience for the user.

In some embodiments, the second user is a non-spatial participant (e.g., as described earlier) and the visual representation of the second user is a two-dimensional visual representation of the user that is displayed at the second virtual location for the second user independent of any indication of movement associated with second user. For example, representation of fourth user 1145 in FIG. 11H remains at the same virtual location 1140o regardless of any movement of the fourth user. For example, if the second user moves within the physical environment of the second user, the computer system does not update the virtual location of the representation of the second user, and instead continues to display the representation of the second user at the same virtual location. Maintaining the location of the representation of a non-spatial user regardless of movement associated with the second user provides maintains the visibility and viewing angle of the representation of the non-spatial user, which otherwise might move to an angle or position from which it is not as visible to the other participants (because of being a two-dimensional representation rather than a three-dimensional representation).

In some embodiments, the updating of the virtual location at which the visual representation of the second user is displayed to be the second virtual location for the second user (e.g., as described earlier) and the updating of the virtual location corresponding to the respective user in the real-time communication session from the first virtual location for the respective user to the second virtual location for the respective user (e.g., as described earlier) are performed in accordance with a determination that a size (e.g., a height, width, and/or area) of the virtual element is a first size (e.g., in accordance with a first template that is associated with the content). For example, participants are arranged at virtual locations as shown in FIG. 11C based on a size of virtual element 1144 in FIG. 11C.

In some embodiments, in response to detecting a request to share second content with participants in the real-time communication session within the three-dimensional environment (e.g., as described earlier), and in accordance with a determination that a size of a virtual element corresponding to the second content is a second size, different from the first size (e.g., is a different width, height, and/or area, such as being larger or smaller), the computer system updates, based at least in part on the second content (e.g., in accordance with a second template that is associated with the second content), the virtual location at which the visual representation of the second user is displayed to be a third virtual location for the second user, different from the first virtual location for the second user and the second virtual location for the second user, (e.g., in a manner similar to that described earlier with reference to updating the virtual location at which the visual representation of the second user is displayed) and the virtual location corresponding to the respective user (e.g., the first user or another user) in the real-time communication session from the first virtual location for the respective user to a third virtual location for the respective user, different from the first virtual location for the respective user and the second virtual location for the respective user (e.g., in a manner similar to that described earlier with reference to updating the virtual location corresponding to the respective user). For example, participants are arranged at virtual locations as shown in FIG. 11O based on a size of virtual element 1144 in FIG. 11O (e.g., based on the virtual element 1144 being larger in FIG. 11O than in FIG. 11C).

In some embodiments, updating the virtual location at which the visual representation of the second user is displayed and/or updating the virtual location corresponding to the respective user includes changing their location(s) such there is a different side-to-side spacing between participants and/or a different distance of the participants relative to the shared content. Selecting the locations for the viewpoints and/or representations of participants based on the size of the shared content provides the participants with an appropriate viewing location and/or angle relative to the size of the content being displayed.

In some embodiments, the second virtual location for the second user and the second virtual location corresponding to the respective user are separated from each other (e.g., within the three-dimensional environment, in terms of side-to-side distance and/or facing distance) by a first virtual distance (e.g., 0.001, 0.01, 0.1, 0.5, 1, 1.5, 3, 5, or 10 m), (e.g., in accordance with the first template) and wherein the third virtual location for the second user and the third virtual location corresponding to the respective user are separated from each other by a second virtual distance (e.g., 0.001, 0.01, 0.1, 0.5, 1, 1.5, 3, 5, or 10 m) different from the first virtual distance, such as shown by the different separations of participants in FIG. 11O relative to FIG. 11C (e.g., in accordance with the second template). For example, in a ring template, participants are optionally spaced farther from participants across from them (e.g., the radius of the circle or oval around which participants are arranged is larger) when there are a larger quantity of participants such that participants don't feel crowded together. For example, participants are optionally placed with a larger or smaller side-to-side distance depending on the quantity of participants. For example, if two participants are arranged in a ring template and a third participant joins, the computer system optionally rearranges the participants on a circle or oval of the same radius, thereby potentially decreasing the side-to-side spacing (e.g., along an arc of the circle or oval) between participants, or arranges the participants on a circle or oval with a larger radius, thereby potentially increasing the side-to-side spacing along the circle or oval. In some embodiments, if there are multiple other participants (e.g., in addition to the first user and the second user), the representations and/or viewpoints of the other participants are optionally arranged with uniform or non-uniform side-to-side spacing, and/or uniform or non-uniform crosswise (e.g., perpendicular) spacing. For example, the representation of the second user is optionally farther away from the representation of a first participant (e.g., perpendicularly) than from a representation of a second participant. Changing the spacing between participants depending on the quantity of participants maintains appropriate spacing such that participants are close enough to view and/or interact with each other without having the perception of being crowded together.

In some embodiments, the second virtual location for the second user and the second virtual location corresponding to the respective user are separated from the virtual element corresponding to the content by a third virtual distance (e.g., 0.01, 0.1, 0.5, 1, 1.5, 3, 5, 10, or 25 m), and wherein the third virtual location for the second user and the third virtual location corresponding to the respective user are separated from the virtual element corresponding to the second content by a fourth virtual distance (e.g., 0.01, 0.1, 0.5, 1, 1.5, 3, 5, 10, or 25 m), different from the third virtual distance. For example, participants are arranged farther from virtual element 1144 in FIG. 11O than in FIG. 11C. For example, the computer system optionally places participants farther away from virtual content that is displayed with a larger size than from content that is displayed with a smaller size, such as by placing participants according to different templates that specify different distances from the participants to a focal point (e.g., to the content). Changing the distance of participants from virtual content provides the participants with an appropriate viewing location and/or angle relative to the size of the content being displayed.

In some embodiments, while displaying the virtual element (e.g., as shown in FIG. 11C), the computer system detects a change in a size of the virtual element, such as shown in FIG. 11M (e.g., detecting that the content has been automatically resized or that a participant in the session has resized the content, such as a request to enlarge or shrink the displayed size of the content). For example, the computer system optionally detects a user input corresponding to a request to enlarge or shrink the displayed size of the content, such as a selection of an affordance and/or a drag input (e.g., an air drag gesture, a drag contact on a touch screen, or another type of drag input).

In some embodiments, after (or, optionally, in response to) detecting the change in the size of the virtual element, and in accordance with a determination that one or more criteria are satisfied, the computer system maintains (e.g., refrains from changing) the virtual location of the second user and the virtual location corresponding to the respective user (and, optionally, the virtual locations associated with any additional participants in the session). For example, the virtual locations of the participants in FIG. 11M (e.g., after virtual element is resized) are the same as those of the participants in FIG. 11C. For example, the one or more first criteria include a criterion that is satisfied when a setting associated with the size of the virtual element is enabled, a criterion that is satisfied when the virtual element is associated with first one or more applications, and/or when elements of the real-time communication session are arranged in a particular spatial template that is not associated with changing a slot of representations of participants of the real-time communication session in accordance with changes in the size of the virtual element Maintaining the location of the representations and/or viewpoints of participants when the content is resized maintains visual continuity and minimizes disruptions to content viewing.

In some embodiments, after (e.g., in response to) detecting the change in the size of the virtual element, in accordance with a determination that the one or more first criteria are not satisfied, the computer system updates the virtual location of the second user and the virtual location corresponding to the respective user in accordance with the change in the size of the virtual element, such as criteria not satisfied when changing virtual element 1144 from as shown in FIG. 11S to as shown in FIG. 11T, and updating in virtual locations of users displayed from FIG. 11S to FIG. 11T. For example, the computer system optionally changes the size of the virtual element, such as changing one or more dimensions of the virtual element, in accordance with a determination that the one or more first criteria described herein with respect to “maintaining” the virtual location of the second user, in response to detecting a change in the size of the virtual element. For example, the virtual element is optionally associated with one or more second applications, different from the one or more first applications, associated with updating the virtual location of the user second user when the virtual element (e.g., a virtual object including a media window, a virtual game board, a virtual object presented for inspection, and/or a representation of a miniaturized at least partially virtual three-dimensional environment) is changed. After (e.g., in response to) detecting the change in the size of the virtual element, the computer system optionally updates the virtual location to be an updated distance and/or angle, different from an initial distance and/or angle of the location of the second user when the change in the size of the virtual element is detected. For example, in response to detecting an increase in size of the virtual element, the computer system optionally updates the location of the second user to be an updated distance, greater than an initial distance, relative to a portion of the virtual element (e.g., an edge, body, or center of the virtual element), and optionally along a line extending between the initial location of the second user to the portion of the virtual element. Additionally or alternatively, the computer system optionally rotates the location of the second user along an axis (e.g., extending vertically from a floor of the three-dimensional environment and through the portion of the virtual element). In some embodiments, the updating of the location of the second user is based on the change in size of the virtual element. For example, the computer system optionally moves the virtual element closer to, further away from, rotates the virtual element by a first amount, and/or rotates the virtual element by a second amount, in accordance with a determination that the virtual element has changed in size (e.g., scale) in a first direction and by a first second amount, and/or opposes the movement and/or rotation relative to the virtual element in accordance with a determination that the virtual element has changed in size in a second direction, and by a second amount, different from the first direction and first amount, respectively. In some embodiments, in response to detecting the change in size of the virtual element, the computer system changes an assignment of users to respective slots within a template without changing a spatial relationship between the slots and the virtual element. Changing the virtual locations corresponding to the participants in the communication session in accordance with changes in size of the virtual element reduces processing and power consumption required to otherwise detect input and perform operations to cause the changing of the virtual locations, and provides flexibility to either change or not change the virtual locations corresponding to the participants based on characteristics of a currently displayed virtual element.

In some embodiments, the updating of the virtual location of the second user includes updating the virtual location of the second user to be a third virtual location. In some embodiments, after (e.g., in response to) detecting the change in the size of the virtual element, such as input detected in FIG. 11W, in accordance with the determination that the one or more first criteria are not satisfied, and before displaying the three-dimensional environment with the updated virtual location of the second user and the updated virtual location corresponding to the respective user, ceasing display of the visual representation of the second user at the location of the second user, such as ceasing of display of the first type of visual representation of users in FIG. 11W. For example, in response to detecting the changing in size of the virtual element, the computer system gradually or abruptly changes a level of opacity of the virtual element from an initial level of opacity (e.g., greater than 0% opacity) to an intermediate or final level of opacity (e.g., 0% opacity). In some embodiments, after (e.g., in response to) changing the size of the virtual element, the computer system moves the visual representation of the second user away from the location of the second user, thus ceasing display of the visual representation of the second user at the location of the second user.

In some embodiments, after ceasing display of the visual representation of the second user, the computer system displays, via the display generation component, the visual representation of the second user at a third virtual location, different from the first virtual location for the second user, such as displaying visual representation 1158, 1156, and 1160 in FIG. 11X. For example, after (e.g., in response to, and optionally without requiring direct user input requesting additional movement of the visual representation of the second user) ceasing display of the visual representation of the second user, the computer system optionally displays the visual representation at an updated (e.g., third) virtual location, different from the first virtual location, thus moving the visual representation of the second user to the third virtual location. In some embodiments, the moving includes animating the movement from an initial location to and updated location. In some embodiments, the moving includes a ceasing (e.g., gradually or abruptly) of the visual representation, and includes a displaying (gradually or abruptly) of the visual representation at the third virtual location. Ceasing display of the visual representation of the second user reduces visual clutter, thus reducing the likelihood the computer system detects erroneous input provided based on an obscuring of the three-dimensional environment consumed by the visual representation of the second user.

In some embodiments, the visual representation of the second user is a first type of visual representation when ceasing display of the visual representation of the first type of the second user at the location of the second user is initiated, such as the type of visual representation of users shown in FIG. 11W. In some embodiments, the virtual representation of the first type is an avatar associated with the user of the second computer system (e.g., optionally created and/or customized by the user of the second computer system and/or corresponding to one or more physical characteristics of the user of the second computer system). For example, the user of the second computer system customizes one or more visual characteristics (e.g., including one or more visual characteristics different from color (e.g., including size, shape, physical features (e.g., facial features), and/or clothing) of the virtual representation of the first type.

In some embodiments, after (e.g., in response to) detecting the change in the size of the virtual element, after (e.g., in response to) ceasing the display of the visual representation of the second user at the location of the second user, such as ceasing display of visual representations of the first type in FIG. 11X, and before displaying the visual representation of the second user at the third virtual location, the computer system displays, via the display generation component, a visual representation of the second user of a second type, different from the first type, at the location of the second user, such as visual representations 1158, 1156, and 1160 in FIG. 11X. In some embodiments, the visual representation of the second user includes a virtual representation of a shape, such as a circle (e.g., a coin), oval, square, diamond, triangle, sphere, cylinder, cube, cone or cuboid. For example, the shape of the visual representation of the second user includes three dimensions (e.g., length, width and depth relative to the three-dimensional environment). In some embodiments, the visual representation of the second user has one or more standard visual characteristics (e.g., shape and/or size) used by the computer system to represent one or more different users in the three-dimensional environment (e.g., the size, shape, color and/or brightness of the visual representation of the second user is not different based on, and/or customizable to, different users in the communication session (e.g., the communication session includes the first user, second user and optionally one or more additional users)). In some embodiments, displaying the visual representation of the second user includes displaying an annotation adjacent to (e.g., above, below or to the side of) the visual representation of the second user. For example, the annotation includes the name of the second user of the second computer system. In some embodiments, the first pose of the visual representation of the second user corresponds to a pose (e.g., including location and/or orientation) of the current viewpoint of the second user of the computer system relative to the three-dimensional environment. For example, the position of the visual representation of the second user includes an orientation (e.g., based on spherical or polar coordinates) relative to the three-dimensional environment (e.g., relative to a reference location in the three-dimensional environment) that is based on the orientation of the pose of the current viewpoint of the second user of the second computer system relative to the three-dimensional environment. For example, the position of the visual representation of the second user includes an orientation relative to the current viewpoint of the first user of the first computer system that is based on the orientation of the pose of the current viewpoint of the second user of the second computer system relative to the current viewpoint of the first user of the first computer system. In some embodiments, movement of the virtual representation of the first type and/or the second type includes displaying the virtual representation of the first type with one or more dynamic visual characteristics during the movement of the virtual representation of the first type from the first pose to the second pose (e.g., the virtual representation of the first type is an avatar including one or more visual characteristics based on one or more physical characteristics (e.g., face, head, torso, arms and/or legs) of a person and/or animal, and the one or more visual characteristics move during the movement of the virtual representation from the first pose to the second pose (e.g., arms and/or legs of the avatar move as the virtual representation is moved from the first pose to the second pose, and/or the avatar changes facial expression as the virtual representation is moved from the first pose to the second pose). Thus, in some embodiments, the computer system replaces display of the visual representation of the first type with a visual representation of the second type. Changing a type of visual representation of the second user reduces processing required to display a more expressive form of a visual representation with a simplified version of the visual representation, thereby decreasing power consumption.

In some embodiments, the one or more first criteria include a criterion that is satisfied when a current template corresponding to a spatial arrangement of elements of the real-time communication session when the change in size of the virtual element is detected is a first template, such as a template of users as shown in FIG. 11W, and is not satisfied when the current template corresponding to the spatial arrangement of elements of the real-time communication session when the change in size of the virtual element is detected is a second template, different from the first template, such as a template of users as shown in FIG. 11S. In some embodiments, the current template has one or more characteristics of the templates described herein, such as with reference to method 1000. In some embodiments, the computer system determines and/or receives an indication of a spatial arrangement of elements of the real-time communication session (e.g., the virtual element, visual representations of participants of the real-time communication session, and/or virtual objects in the three-dimensional environment). In some embodiments, the computer system detects one or more user inputs changing the size of the virtual element, and changes (or does not change) the spatial arrangement of elements of the real-time communication session in accordance with the changes in size of the virtual element and/or in accordance with a determination that the current template is of a first category of template, such as the first template. For example, the computer system optionally determines and/or receives an indication that the current template—having one or more characteristics of template(s) described with reference to method 1000—is a first category of template, such as a virtual game board template, a conversational template, a template at least partially surrounding a virtual table, and/or a template oriented around a portion of the three-dimensional environment (e.g., a portion of a floor of the three-dimensional environment, such as a floor including virtual content for viewing and interaction). In response to detecting the changing of the size, and because the current template is the first category of template when the size-changing user input is detected, the computer system optionally changes the position and/or orientation of the users (e.g., modifying the position and/or orientation of the slots of the template, while maintaining a similar spatial arrangement and a same seating arrangement, and/or changing a seating arrangement of the current template). In some embodiments, the current template is the second template, such as a template where the virtual element is displayed with an orientation such that viewing and/or interaction with the template is not necessarily improved with a modification to the current template. For example, the computer system and/or an application associated with the virtual element optionally determines and/or indicates that the changes in size of the virtual element are able to be performed independently, without modifying the current template that is the second category of template, and in response to user input and/or other events changing the size of the virtual element, the computer system optionally forgoes modification of the current template. Changing the current template in accordance with size changes of the virtual element when the current template is the first category of template reduces the likelihood that users are placed at suboptimal positions to view and/or interact with the virtual element, thus reducing user input to resolve such suboptimal positions and thereby reducing power consumption of the computer system.

In some embodiments, in accordance with a determination that virtual element is a first virtual element that has a first orientation relative to the three-dimensional environment, the current template is the second template, such as the template of users as shown in FIG. 11W. For example, the first orientation of the virtual element optionally satisfies one or more criteria, and when such one or more criteria are satisfied, the computer system optionally determines and/or obtains an indication that the current template is the second template. For example, the one or more criteria include a criterion that is satisfied when a plane associated with the virtual element (e.g., parallel to a surface of the virtual element and/or an optionally not displayed bounding volume (e.g., a surface of a rectangular prism, and/or bisecting an ellipsoid surrounding the virtual element)) is within a first threshold angle of a floor of the three-dimensional environment (e.g., 0, 0.1, 0.25, 0.5, 1, 1.5, 2, 3, 5, 10, or 15 degrees of the floor). Thus, in some embodiments, the computer system determines the current template is the second template (and/or fits in the second category of template) in accordance with a determination that the virtual content is parallel, or close to parallel of the floor of the three-dimensional environment.

In some embodiments, in accordance with a determination that virtual element is a second virtual element that has a second orientation, different from the first orientation, relative to the three-dimensional environment, the current template is the first template, such as the template of users as shown in FIG. 11S. For example, the computer system optionally determines that the plane associated with the virtual element is not within the first threshold angle of the floor of the three-dimensional environment, and/or is within a second threshold angle of perpendicular to the floor of the three-dimensional environment (e.g., 0, 0.1, 0.25, 0.5, 1, 1.5, 2, 3, 5, 10, or 15 degrees of perpendicular to the floor). Thus, in some embodiments, the computer system determines that when virtual content is perpendicular, or nearly perpendicular of the floor, the current template is the first template and/or is the first category of template. In some embodiments, the computer system determines the type of template independently of the position and/or orientation of slots of the users of the real-time communication session. Determining that the current template is a type of template based on an orientation of the virtual element relative to the three-dimensional environment reduces the likelihood that the virtual element is difficult to view and/or interact with, thus reducing user input required to improve visibility and/or interactability with the virtual element, thereby reducing processing and power consumption required by the computer system.

It should be understood that the particular order in which the operations in method 1200 have been described is merely exemplary and is not intended to indicate that the described order is the only order in which the operations could be performed. One of ordinary skill in the art would recognize various ways to reorder the operations described herein.

FIG. 13A-1-FIG. 13L illustrate examples of a computer system updating spatial arrangements of elements of a real-time communication session based on a quantity of participants of a respective type, in accordance with some embodiments of the disclosure.

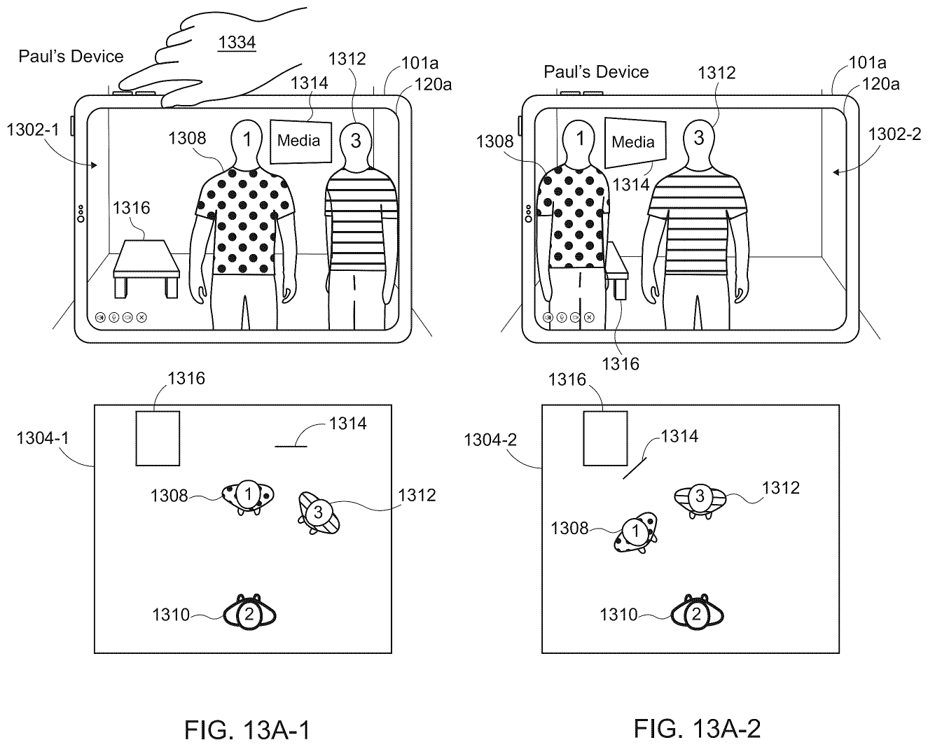

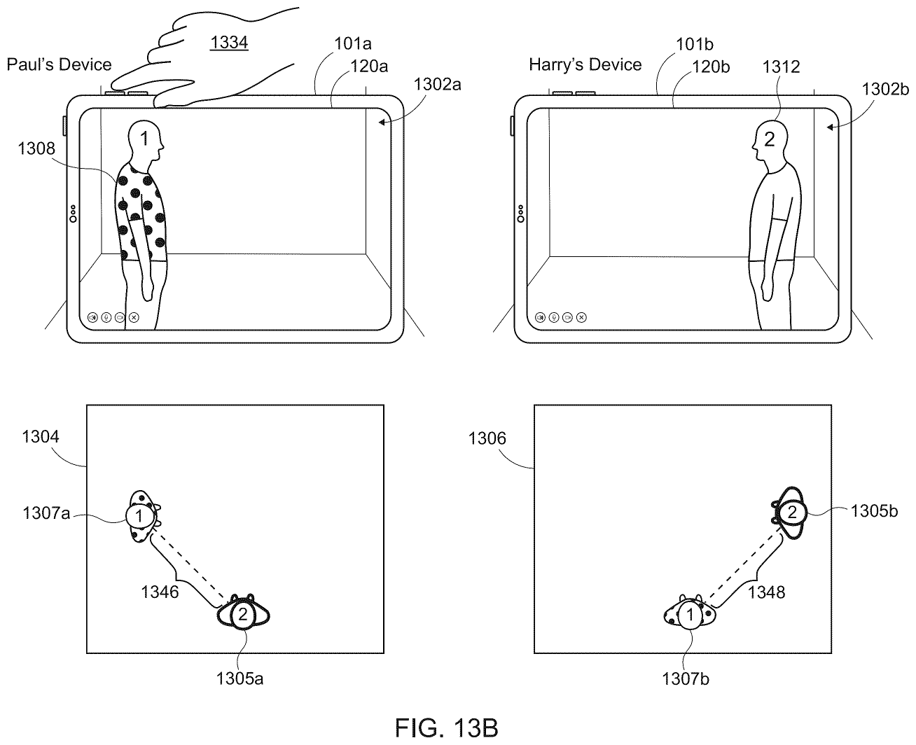

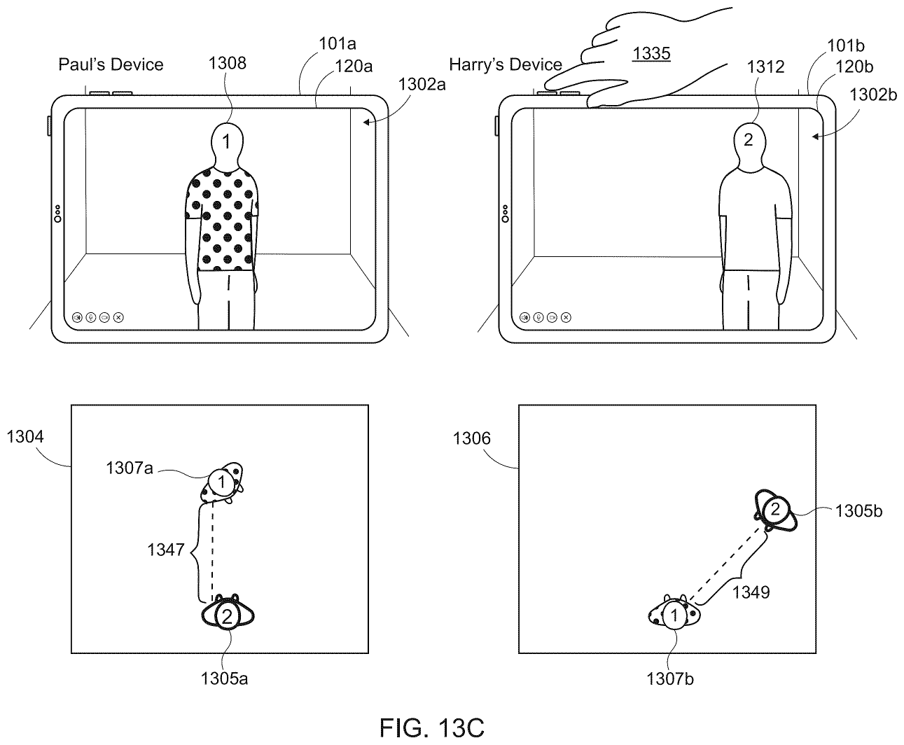

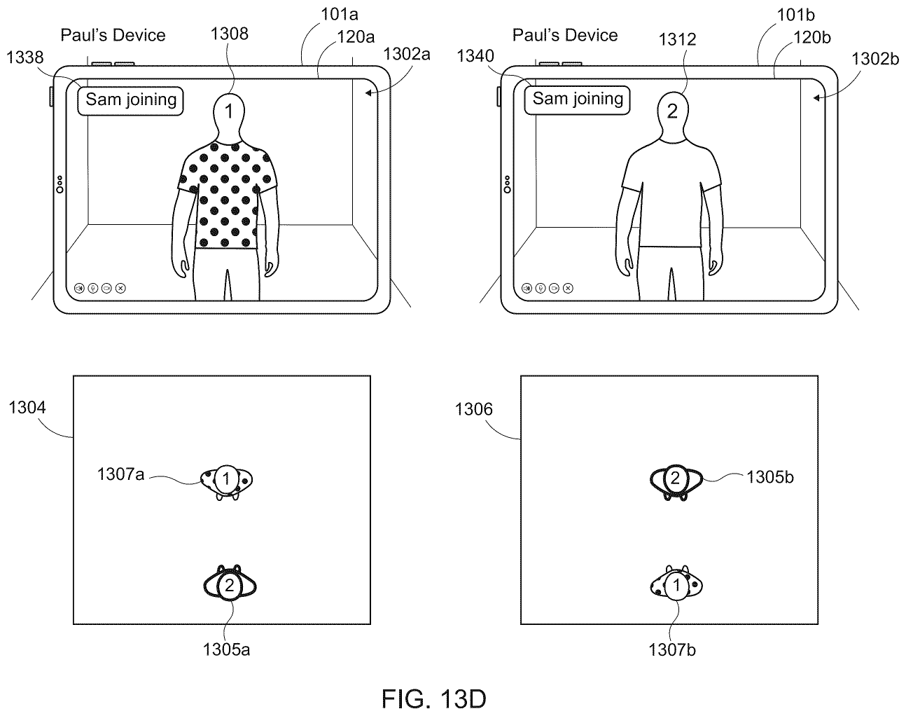

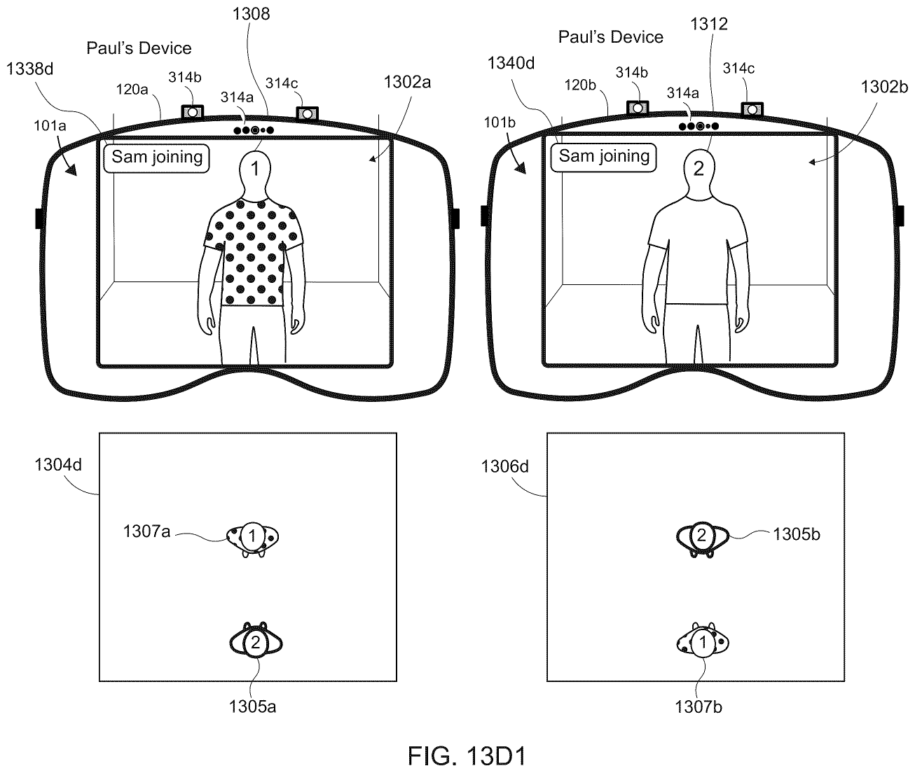

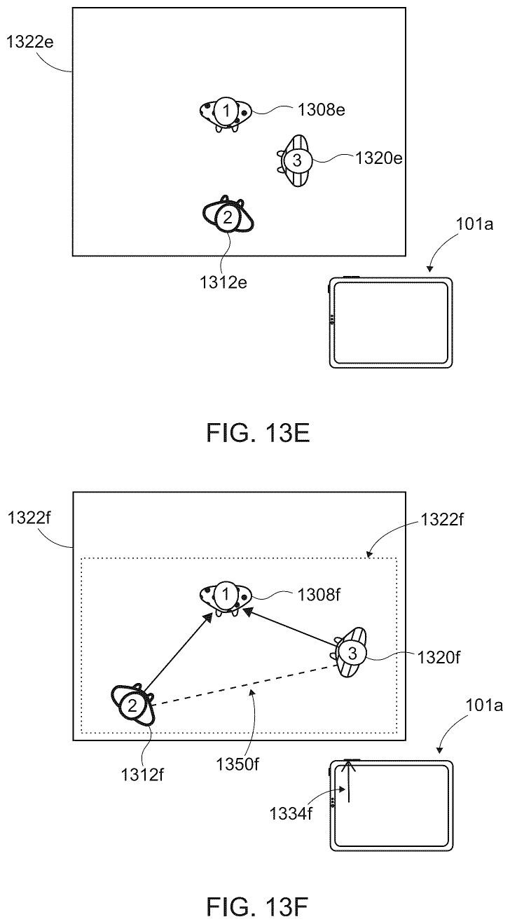

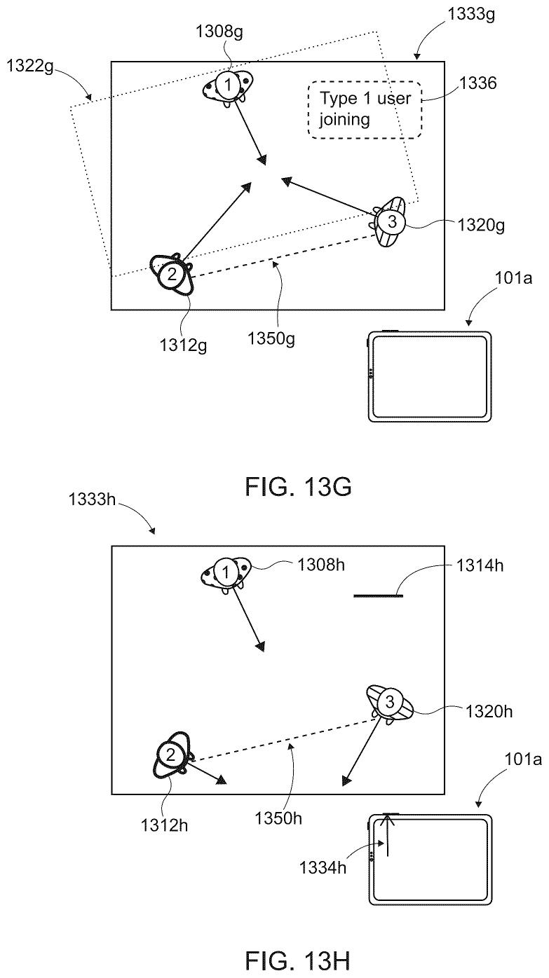

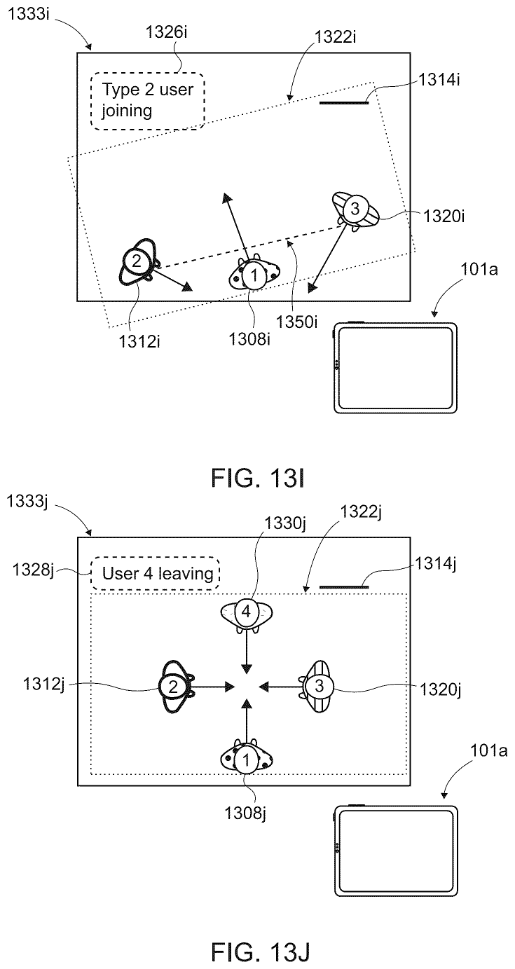

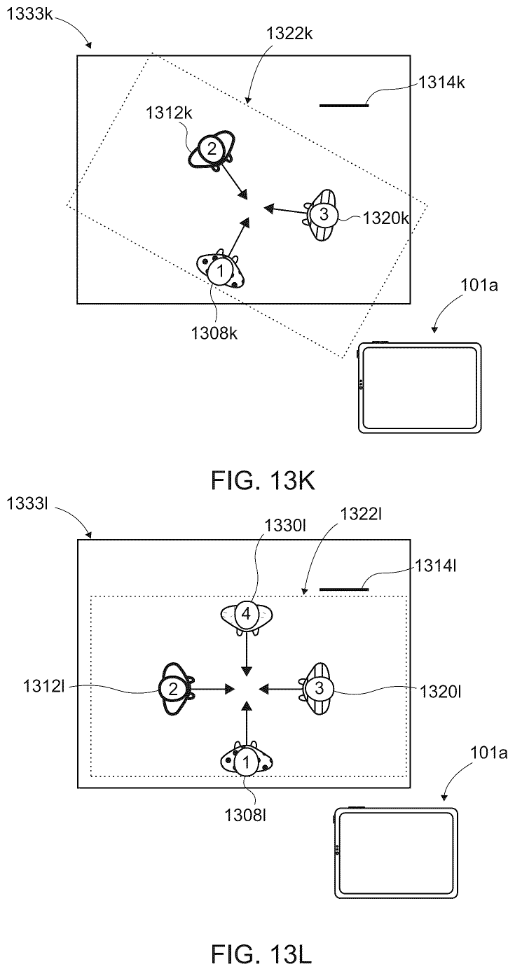

FIG. 13A-1 illustrates a computer system 101a (e.g., tablet, smartphone, wearable computer, or head mounted device) (e.g., an electronic device) displaying, via a display generation component (e.g., display generation component 120a of FIG. 1 such as a computer display, touch screen, or one or more display modules of a head mounted device), a three-dimensional environment 1302-1 (e.g., an AR, AV, VR, MR, or XR environment) from a viewpoint of the user of the computer system 101a (e.g., tablet, smartphone, wearable computer, or head mounted device) (e.g., facing a back wall of the physical environment in which computer system 101 (e.g., tablet, smartphone, wearable computer, or head mounted device) is located). In some embodiments, computer system 101a (e.g., tablet, smartphone, wearable computer, or head mounted device) includes a display generation component (e.g., a computer display, touch screen, or display module of a head mounted device) and a plurality of image sensors (e.g., image sensors 314 of FIG. 3). The image sensors optionally include one or more of a visible light camera, an infrared camera, a depth sensor, or any other sensor the computer system 101a (e.g., tablet, smartphone, wearable computer, or head mounted device) would be able to use to capture one or more images of a user or a part of the user (e.g., one or more hands of the user) while the user interacts with the computer system 101a (e.g., tablet, smartphone, wearable computer, or head mounted device). In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user).

As shown in FIG. 13A-1, computer system 101a (e.g., tablet, smartphone, wearable computer, or head mounted device) captures one or more images of the physical environment around computer system 101a (e.g., tablet, smartphone, wearable computer, or head mounted device), including one or more objects in the physical environment around computer system 101a (e.g., tablet, smartphone, wearable computer, or head mounted device). In some embodiments, computer system 101a (e.g., tablet, smartphone, wearable computer, or head mounted device) displays representations of the physical environment in three-dimensional environment 1302-1. For example, three-dimensional environment 1302-1 includes a table 1316, which is optionally a representation of a table in the physical environment.

In FIG. 13A-1, three-dimensional environment 1302-1 also includes one or more virtual objects. For example, as shown in FIG. 13A-1, the computer system 101a (e.g., tablet, smartphone, wearable computer, or head mounted device) is displaying a virtual object 1360 including shared content 1314 in the three-dimensional environment 1302-1 (e.g., an AR, AV, VR, MR, or XR environment). In some embodiments, the virtual object is or includes one or more of user interfaces of an application (e.g., an application running on the computer system 101a (e.g., tablet, smartphone, wearable computer, or head mounted device)) containing content (e.g., quick look windows displaying photographs, playback user interface displaying content, and/or web-browsing user interface displaying text), three-dimensional objects (e.g., virtual clocks, virtual balls, and/or virtual cars) or any other element displayed by computer system 101a (e.g., tablet, smartphone, wearable computer, or head mounted device) that is not included in the physical environment of display generation component 120a.

In FIG. 13A-1, computer system 101a (e.g., tablet, smartphone, wearable computer, or head mounted device) is engaged in a communication session with other communication session participants. For example, computer system 101a (e.g., tablet, smartphone, wearable computer, or head mounted device) displays representation 1308 of a user of a first computer system, corresponding to a first communication session participant. In some embodiments, the representations of the communication session participants have one or more characteristics described further with reference to methods 800 and/or 1400. For example, the representations optionally are and/or include anthropomorphic avatars, including portions of the avatar's body that move relative to one another (e.g., legs, arms, hands, heads, and/or torsos). In some embodiments, the representations are not anthropomorphic, such as a polygonal shape, where portions of the polygonal shape do not move relative to one another (e.g., a rectangular prism, a thin cylindrical prism similar to a coin, and/or an ellipsoid). A respective user of computer system 101a (e.g., tablet, smartphone, wearable computer, or head mounted device), corresponding to a second communication participant, has a viewpoint 1310, as illustrated in the overhead view 1304-1, corresponding to an overhead view of a spatial arrangement of elements of the real-time communication session. Computer system 101a (e.g., tablet, smartphone, wearable computer, or head mounted device) also displays representation 1312 of a user of a third computer system, corresponding to a third communication session participant. In FIG. 13A-1, computer system 101a (e.g., tablet, smartphone, wearable computer, or head mounted device) detects an event including input 1334a corresponding to a request to recenter elements of the real-time communication session, as described further below. In some embodiments, the event includes additional or alternative aspects, as described further with reference to method 1400.

In FIG. 13A-2, computer system 101 (e.g., tablet, smartphone, wearable computer, or head mounted device) displays an updated spatial arrangement of the elements of the real-time communication session in response to detecting the event including input 1334 in FIG. 13A-1. In some embodiments, the updating—at times referred to a recentering—includes displaying virtual content with updated positions and/or orientations relative to viewpoint 1310 of the user of the computer system 101. As referred to herein, “recenter,” “recentering,” a “recentering input” and/or “recentered” refers to an updating of spatial arrangement of elements of a real-time communication session to improve visibility and or interactability of such elements, that are in some embodiments arranged relative to a current viewpoint of a user of a respective computer system, such as a center of the user's viewpoint.

For example, in overhead view 1302-2, representation 1308 has changed in response to input 1334, turning the shoulders of representation 1308 to a non-parallel angle relative to an axis extending in a perceived lateral direction (e.g., through the shoulders and/or cars) of the user of computer system 101a (e.g., tablet, smartphone, wearable computer, or head mounted device), in contrast with the orientation of representation 1308 in FIG. 13A-1, where the shoulders of representation 1308 are parallel to the axis, and while viewpoint 1310 of the user is fixed relative to three-dimensional environment 1302 from FIG. 13A-1 to FIG. 13A-2. In some embodiments, in response to the event, the distance between representation 1308 and viewpoint 1310 are maintained, such as illustrated from FIG. 13A-1 to FIG. 13A-2. In some embodiments, in response to detecting a recentering input, computer system 101a (e.g., tablet, smartphone, wearable computer, or head mounted device) moves representations of participants relative to viewpoint 1310 and/or three-dimensional environment 1302-2.

In some embodiments, the updated orientation of representation 1308 is determined in accordance with a vector extending toward or away from viewpoint 1310. In some embodiments, a vector extending from the current viewpoint of the user of viewpoint 1310 (e.g., the second participant) relative to a target position of the visual elements of the real-time communication session is determined. For example, the computer system 101a (e.g., tablet, smartphone, wearable computer, or head mounted device) optionally determines (and optionally does not display) a vector with an origin positioned at a head of the user, a torso of the user, and/or from between eyes of the user and terminating at the target position within three-dimensional environment 1302. The target position is optionally based on one or more factors and/or or criteria, described further with reference to methods 1000, 1200, 1400, 1600, 1800 and/or 2000. For example, the target position is optionally based on a vacancy or “gap” in a spatial arrangement of visual representations (e.g., a gap in a circle of participants interacting with each other), and/or is optionally based on a desired, updated spatial arrangement of the visual representations (e.g., a triangle formed between participants, a square formed between participants, and/or an arc formed between the participants). In some embodiments, computer system 101 (e.g., tablet, smartphone, wearable computer, or head mounted device) displays representation 1308 at the updated position, and rotates representation 1308 by a first angle formed between a vector extending outwards and parallel to viewpoint 1310 (e.g., from the center of the user's head, torso, and/or eyes, optionally parallel to a floor of three-dimensional environment 1302), and the vector extending toward the updated position, such as the rotation of representation 1308 in FIG. 13A-2 in response to the input 1334 in FIG. 13A-1. In some embodiments, additional virtual content is additionally rotated by the first angle. For example, in FIG. 13A-2, representation 1312 is rotated by the first angle, and shared content 1314 is rotated by the first angle, optionally concurrently with the rotation of representation 1308, in response to the event including input 1334 in FIG. 13A-1.

In some embodiments representation 1308 is displayed at the updated position relative to the viewpoint 1310. In some embodiments, a respective vector is determined and not shown between the initial position of representation 1308 before the event in FIG. 13A-1 is detected, and the updated position of representation 1308 in FIG. 13A-2, relative to three-dimensional environment 1304-2 and/or viewpoint 1310. In some embodiments, representation 1312 and shared content 1314 are moved from respective initial positions—as illustrated in FIG. 13A-1—to respective updated positions—as illustrated in FIG. 13A-2, where the respective updated positions are offset from the respective initial positions by the respective vector relative to three-dimensional environment 1304-2 and/or viewpoint 1310. Thus, in some embodiments, elements of the real-time communication session are moved by a same angle relative to viewpoint 1310, and/or a same distance relative to viewpoint 1310, thereby maintaining a spatial arrangement of elements of the real-time communication session relative to each other while updating the spatial arrangement of elements relative to the viewpoint 1310 of the second participant. It is understood that as described further with reference to methods 1000, 1200, 1400, 1600, 1800, and/or 2000, in some embodiments, recentering includes moving elements of the real-time communication session by different angles and/or distance relative to viewpoint 1310.

It is understood that the angles and/or vectors described with reference to FIGS. 13A-1 to 13A-2 optionally are determined relative to viewpoint 1310, and in some embodiments, are based on angles and/or vectors formed by projecting vectors onto a plane. For example, the plane is optionally parallel to a floor of the three-dimensional environment, and/or is parallel to a respective portion of the user of computer system 101a (e.g., tablet, smartphone, wearable computer, or head mounted device), such as a plane intersecting eyes of the use and/or a plane bisecting a head of the user (e.g., separating the eyes of the user from the chin of the user). Thus, the angles discussed herein optionally correspond to angles drawn between elements of the real-time communication session, similar to as if such angles were formed based on vectors drawn on the overhead view 1304-1 and/or overhead view 1304-2.

In FIG. 13A-2, computer system 101a (e.g., tablet, smartphone, wearable computer, or head mounted device) maintains display of representations of physical objects at fixed positions in response to the event including input 1334 in FIG. 13A-1. For example, the position and/or orientation of table 1316 is maintained from FIG. 13A-1 to FIG. 13A-2, while the virtual content is recentered as described previously. Thus, in some embodiments, computer system 101 (e.g., tablet, smartphone, wearable computer, or head mounted device) recenters virtual content relative to the viewpoint of the user, while not recentering representations of physical objects. Accordingly, unless stated otherwise, rearranging and/or movement of the user (e.g., the viewpoint 1310 of the second participant) shown and described from FIG. 13A-1 to FIG. 13L corresponds to perceived movement of the user relative to a shared and/or virtual three-dimensional environment, while the user's relative position and/or orientation in their physical environment remains unchanged (again, unless stated otherwise). From the perspective of the overhead view 1304-2, virtual content recenters as if such virtual content were placed on a transparent sheet that is rotated and/or moved relative to viewpoint 1310 in response to the input 1334a in FIG. 13A-1, while table 1316 remains anchored in place relative to viewpoint 1310.

FIGS. 13B-13D illustrate the perspectives of two participants engaged in a real-time communication session and respectively providing recentering inputs to modify spatial arrangements of elements of the real-time communication session relative to the viewpoint of the participant providing the recentering inputs.

In FIG. 13B, computer system 101a (e.g., tablet, smartphone, wearable computer, or head mounted device) (e.g., “Paul's Device”) is engaged in a real-time communication session with computer system 101b (e.g., tablet, smartphone, wearable computer, or head mounted device) (e.g., “Harry's Device”). As described further with reference to FIGS. 7A and 7A1, method 800, and/or method 1400, the computer systems optionally display visual representation of other real-time communication session participants. For example, computer system 101a (e.g., tablet, smartphone, wearable computer, or head mounted device) displays representation 1308 within three-dimensional environment 1302a (e.g., an AR, AV, VR, MR, or XR environment), corresponding to a first participant using computer system 101b (e.g., tablet, smartphone, wearable computer, or head mounted device); as also illustrated in the overhead view 1304, viewpoint 1305a of the second participant is an initial distance 1346 and oriented toward representation 1308 (corresponding to what is presented via computer system 101a (e.g., tablet, smartphone, wearable computer, or head mounted device)). Thus, Paul's device optionally presents a representation of Harry, similar to if Paul were looking at Harry, while Paul and Harry share a same physical environment. Similarly, computer system 101b (e.g., tablet, smartphone, wearable computer, or head mounted device) displays representation 1312 within three-dimensional environment 1302b (e.g., an AR, AV, VR, MR, or XR environment), representing a second participant (e.g., Paul) that is using computer system 101a (e.g., tablet, smartphone, wearable computer, or head mounted device), as further illustrated in overhead view 1306, illustrating the first participant's (e.g., Harry's) viewpoint 1307b relative to three-dimensional environment 1318b at an initial distance 1348 from viewpoint 1307b. Thus, Harry's device optionally presents a representation of Paul similar to as if Paul were looking back at Harry while sharing a same physical environment. While representation 1308b (e.g., Harry) has a first orientation relative to the viewpoint 1305a of the second participant, (e.g., Paul), computer system 101b (e.g., tablet, smartphone, wearable computer, or head mounted device) detects input 1334 in FIG. 13B, such as a pressing of an electromechanical crown button, an air gesture (as described further with reference to method 800) such as an air pinching of fingers of a hand of the first participant, and/or a voice command, corresponding to a request to recenter elements of the real-time communication session including representation 1308.

In FIG. 13C, computer system 101a (e.g., tablet, smartphone, wearable computer, or head mounted device) and computer system 101b (e.g., tablet, smartphone, wearable computer, or head mounted device) recenters visual representation of participants in response to detecting the input 1334b in FIG. 13B. For example, at computer system 101a (e.g., tablet, smartphone, wearable computer, or head mounted device) and as illustrated in the overhead view 1304 in FIG. 13C, representation 1308 is displayed aligned with a center of the viewpoint 1305a of Paul, the second participant. As described previously, and shown in the overhead view 1304 in FIG. 13C, representation 1308 remains a distance 1347 (e.g., the same as distance 1346) from the viewpoint 1305a of the second participant before—and in response to—detecting the recentering request. Thus, from the perspective of the second participant, the elements of the real-time communication are displayed at updated positions and/or orientations relative to viewpoint 1305a of the second participant. In response to the input 1334 in FIG. 13B, computer system 101a (e.g., tablet, smartphone, wearable computer, or head mounted device) thus visually indicates that an arrangement of virtual content displayed at computer system 101a (e.g., tablet, smartphone, wearable computer, or head mounted device) has changed, including rotating representation 1308 computer system 101a (e.g., tablet, smartphone, wearable computer, or head mounted device) about an axis extending vertically from a floor of three-dimensional environment 1302a through the viewpoint 1305a of the first participant that is using computer system 101a (e.g., tablet, smartphone, wearable computer, or head mounted device).

In FIG. 13C, computer system 101b (e.g., tablet, smartphone, wearable computer, or head mounted device) updates an orientation and maintains a position of representation 1312 within three-dimensional environment 1302b in response to detecting input 1334 in FIG. 13B. For example, from FIG. 13B to FIG. 13C, representation 1312 is displayed in a same position, as illustrated in the overhead view 1306 illustrating the three-dimensional environment 1302 of the first participant (e.g., Harry). From FIG. 13B to FIG. 13C, the orientation of representation 1312 is changed, from facing a left wall of three-dimensional environment 1302 in FIG. 13B to facing a left-corner of three-dimensional environment 1302, as illustrated in the overhead view, while maintaining a distance 1349 (e.g., the same as distance 1349) between viewpoint 1307b and viewpoint 1305b. As described with reference to computer system 101a (e.g., tablet, smartphone, wearable computer, or head mounted device), the elements of the real-time communication session presented at computer system 101a (e.g., tablet, smartphone, wearable computer, or head mounted device) are updated similar to a rotating of the real-time communication session along an axis extending vertically through the viewpoint 1305a of computer system 101a (e.g., tablet, smartphone, wearable computer, or head mounted device). From the perspective of computer system 101b (e.g., tablet, smartphone, wearable computer, or head mounted device), such a rotation is optionally similar or equivalent to the viewpoint of computer system 101a (e.g., tablet, smartphone, wearable computer, or head mounted device) rotating relative to three-dimensional environment 1302b. Accordingly, in FIG. 13C, computer system 101b (e.g., tablet, smartphone, wearable computer, or head mounted device) rotates representation 1312—representative of the viewpoint 1305b of computer system 101a (e.g., tablet, smartphone, wearable computer, or head mounted device)—in place, and in response to input 1334 in FIG. 13B. Thus, in response to detecting a request to recenter elements of the real-time communication session at computer system 101a (e.g., tablet, smartphone, wearable computer, or head mounted device), computer system 101b (e.g., tablet, smartphone, wearable computer, or head mounted device) modifies display of the elements of the real-time communication presented at computer system 101b (e.g., tablet, smartphone, wearable computer, or head mounted device). In FIG. 13C, an event including a request to recenter the elements of the real-time communication session including input 1335 is detected at computer system 101b (e.g., tablet, smartphone, wearable computer, or head mounted device).

In FIG. 13D, the elements of the real-time communication session presented at computer system 101a (e.g., tablet, smartphone, wearable computer, or head mounted device) and computer system 101b (e.g., tablet, smartphone, wearable computer, or head mounted device) are updated in response to computer system 101b (e.g., tablet, smartphone, wearable computer, or head mounted device) detecting the event including input 1335 in FIG. 13C. Similar to as described with reference to input 1334 received at computer system 101a (e.g., tablet, smartphone, wearable computer, or head mounted device), in response to detecting input 1335 in FIG. 13C, the computer systems 101a and 101b update the spatial arrangement of real-time communication session elements. For example, computer system 101b (e.g., tablet, smartphone, wearable computer, or head mounted device) rotates representation 1312—corresponding to the second participant using computer system 101a (e.g., tablet, smartphone, wearable computer, or head mounted device)—along an axis extending vertically relative to a floor of three-dimensional environment 1302, and extending through viewpoint 1307b of the first participant. Similarly, computer system 101a (e.g., tablet, smartphone, wearable computer, or head mounted device) displays representation 1308 in FIG. 13D with an updated orientation, and at a same position within three-dimensional environment 1302a compared to as illustrated in FIG. 13C. In FIG. 13D, representation 1308 is centered with viewpoint 1305a of the second participant, such that a vector extending from the center of representation of the first participant (e.g., aligned with the head, eyes, and/or nose) is parallel to a vector extending from viewpoint 1305a of the second participant, as illustrated in overhead view 1304. Similarly, representation 1312 at computer system 101b (e.g., tablet, smartphone, wearable computer, or head mounted device) is centered with viewpoint 1307b of the first participant, such that a vector extending from the center of representation 1312 is parallel to a vector extending from a center of viewpoint 1305b of the first participant, as illustrated in the overhead view 1306. Thus, after initially recentering elements of the real-time communication session in response to input detected at computer system 101a (e.g., tablet, smartphone, wearable computer, or head mounted device) from FIGS. 13B-13C, computer system 101b (e.g., tablet, smartphone, wearable computer, or head mounted device) recenters the elements of the real-time communication session in response to input 1335 detected at computer system 101b (e.g., tablet, smartphone, wearable computer, or head mounted device) from FIGS. 13C-13D, resulting in a spatial arrangement where viewpoint 1307a of the first participant is centered and facing viewpoint 1305a of the second participant as illustrated in the overhead view 1304 in FIG. 13D. In FIG. 13D, a notification 1338 and a notification 1340 are displayed at computer system 101a (e.g., tablet, smartphone, wearable computer, or head mounted device) and computer system 101b (e.g., tablet, smartphone, wearable computer, or head mounted device), respectively, in accordance with a determination that an additional participant is joining and/or will join the real-time communication session.

FIG. 13D1 illustrates similar and/or the same concepts as those shown in FIG. 13D (with many of the same reference numbers). It is understood that unless indicated below, elements shown in FIG. 13D1 that have the same reference numbers as elements shown in FIGS. 13A-13L have one or more or all of the same characteristics. FIG. 13D1 includes computer systems 101a/b, which includes (or is the same as) display generation components 120a/b. In some embodiments, computer systems 101a/b and display generation components 120a/b have one or more of the characteristics of computer system 101 shown in FIGS. 13A-13L and display generation component 120 shown in FIGS. 1 and 3, respectively, and in some embodiments, computer system 101 and display generation component 120 shown in FIGS. 13A-13L have one or more of the characteristics of computer systems 101a/b and display generation components 120a/b shown in FIG. 13D1.

In FIG. 13D1, display generation components 120a/b includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation components 120a/b to enable eye tracking of the user's left and right eyes. Display generation components 120a/b also include external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 13A-13L.

In FIG. 13D1, display generation components 120/a are illustrated as displaying content that optionally corresponds to the content that is described as being displayed and/or visible via display generation component 120 with reference to FIGS. 13A-13L. In some embodiments, the content is displayed by a single display (e.g., display 510 of FIG. 5) included in display generation components 120/a. In some embodiments, display generation components 120/a include two or more displays (e.g., left and right display panels for the left and right eyes of the user, respectively, as described with reference to FIG. 5) having displayed outputs that are merged (e.g., by the user's brain) to create the view of the content shown in FIG. 13D1.

display generation components 120/a have a field of view (e.g., a field of view captured by external image sensors 314b and 314c and/or visible to the user via display generation components 120/a) that corresponds to the content shown in FIG. 13D1. Because display generation components 120/a are optionally a head-mounted device, the field of view of display generation components 120/a are optionally the same as or similar to the field of view of the user.

In some embodiments, computer systems 101a/b respond to user inputs as described with reference to FIGS. 13A-13L.

It is understood than one or more or all aspects of the present disclosure as shown in, or described with reference to FIGS. 13A-13L and/or described with reference to the corresponding method(s) are optionally implemented on computer systems 101a/b and display generation unit 120 in a manner similar or analogous to that shown in FIG. 13D1.

In FIG. 13E, in response to obtaining information that an additional participant will join the real-time communication session, the computer systems 101a and/or 101b update a spatial arrangement of elements including representations of other participants of the real-time communication session. It is understood that FIGS. 13E-13L are described with reference to the viewpoint 1307a of the first participant, but additionally applies to the viewpoint and/or perspectives of other participants including the second and the third, newly added participant. In some embodiments, the elements of the real-time communication session are recentered similarly to as described with reference to FIGS. 13A-13L, relative to the viewpoint of the respective participant of the real-time communication session.

In FIG. 13E, the representations of participants are arranged in a triangular shape relative to three-dimensional environment, as illustrated in the overhead view corresponding to three-dimensional environment 1322e. For example, the participants are oriented such that a vector extending from a center of the participants is directed to and intersecting with a relative center of a triangle formed by lines extending between the viewpoint of representation 1308e and representation 1320e, representation 1308e and representation 1312e, and representation 1312e and 1320c. It is understood that the reference numbers described with reference to FIGS. 13E-13L are suffixed with a letter corresponding to a current figure (e.g., “1312e”), and correspond to reference numbers of similar figures having a same number (e.g., representation “1312” corresponds to representation “1312e” and representation “1312f” described below).

In FIG. 13F, representations 1312f and 1320f move apart from one another relative to the viewpoint of representation 1308f, relative to their respective positions illustrated in FIG. 13E. For example, a distance between representation 1312f and representation 1320f emphasized by a line 1350f extending between the representations (and optionally not displayed) is relatively increased, relative to a similar line drawn between the same representations in FIG. 13E. In FIG. 13F, representation 1312f and representation 1320f are oriented toward a first side of the line, the first side including representation 1308f of the first participant, and computer system 101a (e.g., tablet, smartphone, wearable computer, or head mounted device) detects an event including input 1334f, corresponding to a request to recenter the elements of the real-time communication session. In FIG. 13F, the physical three-dimensional environment of the computer system 101a (e.g., tablet, smartphone, wearable computer, or head mounted device) is represented by environment 1322f. It is understood that environment 1322f is representative of the viewpoint of representation 1308f relative to its physical environment, and that in response to detecting recentering events, that the viewpoint of representation 1308f is maintained relative to its environment 1322f, and that virtual content (e.g., representation 1312g, representation 1320g) is displayed with updated positions and/or orientations relative to the viewpoint of representation 1308f.

In FIG. 13G, the representations of participants are displayed with an updated arrangement, corresponding to a relatively larger triangular shape in response to the input 1334f detected in FIG. 13F. For example, as compared to the triangular shaped arrangement illustrated in FIG. 13E, representation 1308g is pushed further upwards while representation 1312g and representation 1320g remain at a same position within three-dimensional environment 1333g, thus increasing a length of legs of the triangular shape drawn between the participants. Additionally, because representations 1312f and 1320f were oriented toward the first side of the line, in response to the input 1334 in FIG. 13F, representation 1308g remains on the first side of the line, rather than the second side of the line. In FIG. 13G, as described previously, environment 1322g represents the physical three-dimensional environment of representation 1308g remaining fixed relative to the viewpoint of representation 1308g, while virtual content moves relative to the viewpoint. Thus, from the perspective of the viewpoint of the first participant, virtual content moves and/or rotates in response to recentering events while the first participant physically remains in place. It is understood that further description of similar illustrations of the first participant that is the user of computer system 101a (e.g., tablet, smartphone, wearable computer, or head mounted device) recentering virtual content occurs while the viewpoint of the first participant (e.g., representation 1308i, representation 1308j, representation 1308k, and representation 1308l) remains fixed relative to its physical three-dimensional environment (e.g., environment 1322i, environment 1322j, environment 1322k, and environment 1322l, respectively). In FIG. 13G, notification 1336 indicates that another participant of a first type (e.g., “Type 1 user”) is joining the real-time communication session.

In FIG. 13H, in response to obtaining information that a new participant of the first type will join the real-time communication session, computer system 101a (e.g., tablet, smartphone, wearable computer, or head mounted device) maintains the spatial arrangement of elements of the real-time communication session. For example, the relative triangular shape of the participants of the real-time communication session are maintained from FIG. 13G to FIG. 13H, and the representation 1314h is displayed within three-dimensional environment 1333h. As described further with reference to method 1400, in some embodiments, the computer system 101a (e.g., tablet, smartphone, wearable computer, or head mounted device) maintains the spatial arrangement of elements of the real-time communication session when the participants that will join and/or will leave the real-time communication session are of the first type. In some embodiments, the type of the representation is based on one or more characteristics of the device used to access the real-time communication session. For example, a fourth participant represented by representation 1314h is usually not configured, optimized, or at all able to display an immersive virtual scene, and/or display an at least partially virtual environment. For example, the device used by the fourth participant is a first type of device such as a mobile phone, a tablet, and/or a laptop, and computer system 101a (e.g., tablet, smartphone, wearable computer, or head mounted device) is a second type of device and/or computer system, such as a wearable device including circuitry to detect depth of the first participant and display an immersive virtual scene, like a head-mounted device.

In some embodiments, computer system 101a (e.g., tablet, smartphone, wearable computer, or head mounted device) updates the spatial arrangement of elements to preferentially display representation of participants of the first type, and does not factor in the representations of the second type, thereby preserving the triangular shape of the spatial arrangement of participants in FIG. 13H. In FIG. 13H, computer system 101a (e.g., tablet, smartphone, wearable computer, or head mounted device) obtains information indicating that the representation 1312h and representation 1320h turn to a second side of line 1350h, that is optionally not displayed, but extends between representation 1312h and representation 1320h, and accordingly rotate representation 1312h and representation 1320h in place. In FIG. 13H, the computer system 101a (e.g., tablet, smartphone, wearable computer, or head mounted device) detects an input 1334h corresponding to a request to recenter the current viewpoint of the first participant.

In FIG. 13I, computer system 101a (e.g., tablet, smartphone, wearable computer, or head mounted device) updates the viewpoint of the first participant 1308i to correspond to the second side of a line extending between representation 1312i and representation 1320i in response to the input detected in FIG. 13H. In some embodiments, when a plurality of participants are arranged in a line, an arc, nearly in a line, and/or nearly in an arc, computer system 101a (e.g., tablet, smartphone, wearable computer, or head mounted device) recenters the viewpoint of representation 1308i to correspond to the side of the line that the participants arranged in the line are facing. For example, because representation 1312h and representation 1320h are facing the second side of the line, opposite of the first side of the line 1350h, when the input 1334h is detected, the viewpoint corresponding to representation 1308i is moved to face the second side of the line 1350i, facing toward representation 1312i and representation 1320i. In FIG. 13I, computer system 101a (e.g., tablet, smartphone, wearable computer, or head mounted device) obtains information, such as indicated (and optionally not displayed) by notification 1326i, that an additional participant of the second type, described previously, will or is joining the real-time communication session.

In FIG. 13J, in response to obtaining the information that a fourth participant will join the real-time communication session, computer system 101a (e.g., tablet, smartphone, wearable computer, or head mounted device) displays an updated spatial arrangement of the participants. In some embodiments, the updated spatial arrangement of participants includes displaying the participants with updated position relative to a viewpoint of the representation 1308j, as described further with reference to methods 1000, 1200, 1800, and/or 2000. For example, the participants are optionally arranged in a square and/or rectangular arrangement, where representation 1312j faces representation 1320j, and representation 1308j faces the representation 1330j (of the fifth, newly added participant). In some embodiments, the computer system 101a (e.g., tablet, smartphone, wearable computer, or head mounted device) keeps representation 1314j of the fourth participant in place relative to three-dimensional environment 1333j. It is understood that in some embodiments, computer system 101a (e.g., tablet, smartphone, wearable computer, or head mounted device) additionally presents the updated spatial arrangement of the participants having alternative shapes relative to the three-dimensional environment 1322j of computer system 101a (e.g., tablet, smartphone, wearable computer, or head mounted device), without departing from the scope of the disclosure.

In FIGS. 13K and 13L, the computer system ceases display of the representation of the fifth participant and/or recenters or maintains a spatial arrangement of elements of the real-time communication session in response to obtaining information that the fifth participant will leave the real-time communication session in FIG. 13L. In FIG. 13K, for example, the participants are displayed with an updated spatial arrangement, as illustrated by orientation of environment 1322k relative to environment 1333k. In FIG. 13L, as an alternative example, computer system 101a (e.g., tablet, smartphone, wearable computer, or head mounted device) ceases display of the fifth participant in response to obtaining the information that the fifth participant will leave the real-time communication session in FIG. 13L, while maintaining display of the representations of the remaining participants at positions and/or orientations as illustrated in FIG. 13J.

FIG. 14 is a flowchart illustrating a method of updating spatial arrangements of elements of a real-time communication session based on a quantity of participants of a respective type, in accordance with some embodiments of the disclosure. In some embodiments, the method 1400 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1400 is governed by instructions that are stored in a non-transitory computer-readable storage medium and that are executed by one or more processors of a computer system, such as the one or more processors 202 of computer system 101 (e.g., tablet, smartphone, wearable computer, or head mounted device) (e.g., control unit 110 in FIG. 1A). Some operations in method 1400 are, optionally, combined and/or the order of some operations is, optionally, changed.

In some embodiments, method 1400 is performed at a first computer system in communication with a display generation component and one or more input devices. For example, the first computer system, the second computer system described further below, the display generation component, and the one or more input devices have one or more characteristics of the computer systems, display generation components, and the one or more input devices described with reference to methods 800, 1000, 1200, 1600, 1800, and/or 2000.

In some embodiments, while a three-dimensional environment is visible via the display generation component from a current viewpoint of a user of the first computer system (e.g., a three-dimensional environment having one or more characteristics of the three-dimensional environments described with reference to methods 800, 1000, 1200, 1600, 1800, and/or 2000), such as three-dimensional environment 1302a visible from viewpoint 1310 in FIG. 13A-1, and while the user of the first computer system, such as a user of computer system 101a (e.g., tablet, smartphone, wearable computer, or head mounted device), is in a real-time communication session (e.g., a real-time communication session having one or more characteristics of the real-time communication sessions described with reference to methods 800, 1000, 1200, 1600, 1800, and/or 2000) with one or more other participants including a first participant in the real-time communication session, different from the user (e.g., a participant who is a user of a second computer system that is different from the first computer system), such as a user of computer system 101b (e.g., tablet, smartphone, wearable computer, or head mounted device) in FIG. 13B, the computer system displays (1402a), via the display generation component, a first spatial arrangement of elements of the real-time communication session (e.g., one or more representations of other participants and/or shared content) including displaying a first visual representation of the first participant at a first location in the three-dimensional environment relative to the current viewpoint of the user, such as a spatial arrangement including representation 1308 at a position relative to viewpoint 1310 in FIG. 13A-1. In some embodiments, the first computer system initiates and/or participates in a real-time communication session including real-time, or nearly real time communication of representations of the participants' voices and/or one or more portions of the participants' bodies, including the user and the first participant. In some embodiments, the real-time communication session is facilitated by communicating within a shared, at least partially virtual environment, displayed by respective computer systems (e.g., a virtual environment included in the three-dimensional environment of the user). In some embodiments, the real-time communication session includes representations of the user's and/or the first participant's body, such as virtual body parts and/or avatars corresponding to the user and the first participant. In some embodiments, in response to detecting movement of the user's body, the first computer system moves the virtual body parts corresponding to the user and/or changes a viewpoint of the user relative to the virtual environment. In some embodiments, the first computer system detects movement of the first participant and/or detects an indication of movement communicated by the second computer system, and moves a virtual avatar corresponding to the first participant in accordance with the movement and/or indication of movement. In some embodiments, the first computer system detects a magnitude and/or direction of movement of a current viewpoint of the user, and communicates such a magnitude and/or direction of movement to the second computer system, and in some embodiments, the second computer system moves a virtual avatar corresponding to the user, and in a direction and/or by a magnitude based on the communication from the first computer system.

In some embodiments, during such a real-time communication session, the three-dimensional environment displayed by the first computer system and a second three-dimensional environment displayed by the second computer system share an understanding of a simulated set of positions within a shared virtual environment, similar to as if the first and the first participant shared a physical environment, such as a shared environment between computer system 101a (e.g., tablet, smartphone, wearable computer, or head mounted device) and computer system 101b (e.g., tablet, smartphone, wearable computer, or head mounted device) in FIG. 13B. In such embodiments, the first computer system displays a virtual avatar corresponding to a position of the first participant (e.g., at the first location) relative to the current viewpoint of the user and the shared virtual environment, and as described further below, in some embodiments, displays a representation of the first participant in accordance with an avatar rearrangement regime in response to detecting events associated with the real-time communication session. As referred to at times herein, a “spatial arrangement of elements” of the real-time communication relative to the current viewpoint of the user optionally includes a relative position and/or orientation of virtual content relative to a current viewpoint of the user. For example, the first spatial arrangement of elements relative to the current viewpoint of the user optionally includes a representation of the first participant displayed at a position and/or orientation relative to the shared virtual environment as observed via display generation component of the computer system. It is understood that the spatial arrangement of elements relative to the current viewpoint of the user optionally includes a spatial arrangement of additional virtual content relative to the current viewpoint of the user, such as additional representation of participants, media content that is shared between participants of the real-time communication session, virtual objects displayed within the shared virtual environment, and/or virtual content overlaid over representations of the user's physical environment, relative to the current viewpoint of the user.

In some embodiments, while displaying the first visual representation of the first participant at the first location relative to the current viewpoint of the user, the computer system detects (1402b) a first event corresponding to a request to reset a spatial distribution of one or more participants in the real-time communication session (e.g., the first event and/or the request having one or more characteristics of similar inputs, requests, and/or events corresponding to request to trigger recentering described with reference to methods 1000, 1200, 1600, 1800, and/or 2000), such as an event including input 1334 in FIG. 13A-1. For example, the first event optionally includes detecting a user input such as a selection input directed to a physical or virtual button (e.g., having one or more characteristics of inputs described with reference to method 800), detecting an indication that one or more other participants have joined or exited the real-time communication session, detecting an indication that one or more other participants have provided an input requesting rearrangement of participants of the real-time communication session, and/or detecting and/or receiving an indication of a request to change virtual content within the three-dimensional environment (e.g., a request to change a shared virtual environment). In some embodiments, in response to detecting the first event, the first computer system updates a spatial arrangement of the participants of the real-time communication session relative to the current viewpoint of the user, such as including a spatial arrangement of avatars corresponding to other participants in the three-dimensional environment. In some embodiments, the first event does not include an express input provided by the user of the first computer system requesting an updating of the spatial arrangement of the participants in the real-time communication session, and such updating occurs automatically (e.g., from the perspective of the user). In some embodiments, the first event is detected when and/or corresponds to when the real-time communication session is initiated (e.g., before a virtual environment is visible, and/or before displaying the representation of the first participant). In some embodiments, the first event is detected while the real-time communication is ongoing.

In some embodiments, in response to detecting the first event, the computer system displays (1402c) a respective updated spatial arrangement of the elements of the real-time communication session relative to the current viewpoint of the user, such as the spatial arrangement of elements as shown in FIG. 13A-2, including, in accordance with a determination that the one or more other participants are a first quantity of participants of a first type, displaying, from the current viewpoint of the user, a first updated spatial arrangement of the elements of the real-time communication session that is different from the first spatial arrangement of elements of the real-time communication session (1402d) (e.g., an updated spatial arrangement that include displaying the first visual representation of the first participant at a first updated location relative to the current viewpoint of the user), such as the spatial arrangement of elements in FIG. 13A-2. In some embodiments, the real-time communication session is ongoing and/or maintained when the first event is detected and/or while the operations performed in response to detecting the first event (e.g., described further below) are performed. In some embodiments, the computer system updates a spatial arrangement of the user, the first participant, and/or other participants participating in the real-time communication session based on a total number of participants of the real-time communication session and in response to the first input. For example, the first computer system optionally detects and/or receives an indication of a number of users (e.g., of other computer systems, at times referred to herein as “participants”) participating in the real-time communication session (e.g., at times referred to herein as a “call” for convenience, and understood as not merely including real-time communication of voice of participants), and displays avatars corresponding to the participants of the call at updated locations relative to the three-dimensional environment at respective positions within an updated spatial arrangement of the participants of the call, and/or relative to the current viewpoint of the user. Display of the avatars and/or changing of the current viewpoint of the user (and/or other virtual content) at updated positions and/or orientations relative to the three-dimensional environment effectively changes a spatial arrangement of the avatars and/or virtual content relative to the current viewpoint of the user. Thus, the computer system optionally displays the avatar(s) and/or virtual content with a first updated spatial arrangement relative to an optionally updated current viewpoint of the user in response to the event and in accordance with a determination that participants of the first type—described further below—are a first quantity of participants. In some embodiments, in response to detecting the first event, the first computer system additionally changes a current viewpoint of the user relative to the three-dimensional environment. For example, the first computer system optionally changes an effective position and/or orientation of the current viewpoint of the user relative to the three-dimensional environment (e.g., relative to a virtual, shared environment) in response to detecting the first event, and optionally concurrently displays the representations of the other participants of the real-time communication session with updated orientations, optionally such that a plurality of (e.g., a subset of or all) participants of the call are facing each other. Such an updated arrangement—referred to herein as “recentered” arrangement of the participants—optionally is predetermined based on the quantity of total participants in the real-time communication session. For example, when the first participant is the only other participant in the real-time communication session, the first computer system optionally changes the orientation of the current viewpoint of the user and/or the virtual avatar representative of the first participant to face one another within the three-dimensional environment. In some embodiments, the first updated spatial arrangement includes the changing of the current viewpoint to an updated position and/or orientation relative to the three-dimensional environment, and/or includes displaying representations of other participants of the call at updated positions and/or orientations corresponding to the updated position and/or orientation of the current viewpoint, such as the updated position and/or orientation of representation 1308 from FIG. 13A-1 to FIG. 13A-2. In some embodiments, the arrangement is dynamically determined, rather than strictly predetermined before the first event is detected. In some embodiments, the computer system determines a type of participant, such as a participant that is using a class of a device (e.g., a mobile device, a wearable device, and/or desktop computing device) that they are using to participate in the call, a participant that has enabled sharing of video and/or audio collected by the device they are using to participate in the call, and/or a participant that has enabled or disabled a sharing of an avatar representative of the computer system. In some embodiments, the computer system determines a recentered arrangements of participants based on a quantity of a first type of participants and/or not based on a quantity of a second type of participants (e.g., based on the number of users participating in the call via a wearable device, excluding a number of users participating via a desktop computing device and/or a mobile device (e.g., a cell phone, a tablet, and/or a smartwatch) and/or based on the quantity of participants that have enabled avatar sharing, excluding a number of participants that have not enabled avatar sharing).

In some embodiments, in response to detecting the first event, displaying a respective updated spatial arrangement of the elements of the real-time communication session relative to the current viewpoint of the user, includes, in accordance with a determination that the one or more other participants are a second quantity of participants of the first type, different from the first quantity of participants of the first type, such as a quantity of participants as shown in FIG. 13B, displaying, from the current viewpoint of the user, a second updated spatial arrangement of the participants in the real-time communication session that is different from the first spatial arrangement of elements of the real-time communication session and the first updated spatial arrangement of elements of real-time communication session (1402e) (e.g., an updated spatial arrangement that includes displaying the first visual representation of the first participant at a second updated location, different from the first updated location, relative to the current viewpoint of the user), such as an arrangement of elements of the real-time communication session including representation 1308 in FIG. 13B. For example, in response to the first event and when there are three participants within the real-time communication session (e.g., of the first type of participants), the first computer system optionally places the current viewpoint of the user at a vertex of a simulated triangle (e.g., relative to a floor of a shared virtual environment), optionally not shown, wherein virtual avatars of the first participant and of a second participant of a third computer system are optionally displayed at the other vertices of the simulated triangle. It is understood that in some embodiments, displaying the second updated spatial arrangement includes the first computer system updating the current viewpoint and/or the positions and/or orientations of virtual avatars corresponding to other participants independent of a relationship between a simulated shape and/or independent of the floor of the shared virtual environment.

In some embodiments, the number of participants is greater than as expressly described herein, and the first computer system arranges respective avatars and places the current viewpoint of the user at respective vertices of simulated polygons, and/or arranged around curved shapes relative to the floor of a shared virtual environment. In some embodiments, the first computer system determines orientations of the current viewpoint and the virtual avatars corresponding to other participants such that a front of a torso and/or a head of the virtual avatars are oriented toward a center of a recentered arrangement of the participants, similar to if physical people stand in a circle while talking to one another. Accordingly, in some embodiments, the position and/or the orientation of the current viewpoint is based on a how the user fits within a spatial arrangement configured to facilitate real-time communication between the participants of the real-time communication session, and/or displaying the second updated spatial arrangement of the elements of the real-time communication includes changing the current viewpoint and/or updating a position and/or orientation of representations of the other participants and/or virtual content, different from the first updated spatial arrangement. Changing the current viewpoint of the user and displaying a representation of the first participant at positions and/or orientations based on a quantity of participants included in a real-time communication session improves visibility of representations of the other users participating in the real-time communication session, thereby improving efficiency of communication between the participants, and further improves the speed of assuming a similar spatial arrangement between the participants and reduces user input required to manually change the current viewpoint of the user and/or the representations of the other users.

In some embodiments, in accordance with the determination that the one or more participants are the first quantity of participants of the first type, such as a quantity of participants as shown in FIG. 13B, the first updated spatial arrangement is determined in accordance with a first set of spatial distribution rules, such as rules that dictate the updated spatial arrangement of representation 1308 in FIG. 13C. For example, the computer system optionally recenters element of the real-time communication in accordance with a set of spatial distribution rules that is based on a number of participants of the first type that are participating in the real-time communication. For example, a first set of spatial distribution rules optionally includes one or more rules determining a spatial distribution of representations of participants displayed in response to a recentering input, as described previously. In some embodiments, the first set of spatial distribution rules and/or the second set of spatial distributions correspond to one or more spatial “templates,” described further with reference to methods 1000 and/or 1200, where a respective one or more templates are used in accordance with the determination that the quantity of participants of the first type is a first or a second quantity. The spatial distribution optionally includes a shape and/or arrangement of the participants, such as a triangular arrangement between the current viewpoint and the participants where respective participants are displayed at vertices of a triangle. In some embodiments, the first set of spatial distribution rules dictate a relative spacing and/or orientation of the participants displayed at an updated spatial arrangement. It is understood that spatial distribution rules “dictating” a spatial arrangement of participants and/or elements of the communication session optionally refers to the computer system detecting, determining, and/or displaying the participants and/or elements in accordance with a set of rules, and optionally not that the rules themselves determinate and/or display the participants and/or elements of a communication session. For example, when recentering the first participant, a second participant, and the user into a triangular arrangement, the computer system optionally determines that the participants are arranged generally facing one another. In such an arrangement, angles formed (and optionally not displayed) between vectors (optionally not displayed and) extending from respective participants (e.g., from a head of the user and/or the participant) optionally are less than or equal to a threshold angle (e.g., 5, 15, 30, 45, 60, 75, 90, or 120, or 150 degrees) from one another, such that similar to a triangle, a sum of the angles between the respective participants equals 180 degrees. In some embodiments, the first set of rules dictate whether a spatial profile of the participants is a first profile (e.g., a triangular arrangement) or is a second profile, different from the first profile (e.g., a line and/or arc of users, optionally facing a same side of a line and/or arc of the participants). Such arrangements are further described with reference to methods 1800 and/or 2000.

In some embodiments, in accordance with the determination that the one or more participants are the second quantity of participants of the first type, the second updated spatial arrangement is determined in accordance with a second set of spatial distribution rules, different from the first set of spatial distribution rules, such as rules that dictate the updated spatial arrangement of representation 1312e and 1320e in FIG. 13E. For example, in accordance with a determination that the quantity of participants is a second number, different from the first number, the computer system optionally uses a second set of spatial distribution rules, such as a second set of rules dictating an arrangement of four participants. In some embodiments, the computer system updates the current viewpoint such that the four participants are optionally arranged in a rectangle relative to the three-dimensional environment, and/or another quadrilateral relative to the three-dimensional environment. In some embodiments, the four participants are arranged in a line, and/or a series of lines (e.g., similar or the same as an arc of the four participants. In some embodiments, the second set of rules dictate the relative orientations of participants, the relative spacing of participants, and/or a spatial profile of the participants relative to the three-dimensional environment and/or the current viewpoint in response to the first event recentering elements of the communication session. It is understood that additional or alternative sets of spatial distributions rules are optionally used to determine recentered arrangements of the participants of the communication session, in accordance with a determination that a corresponding number of participants (e.g., of the first type) are participating in the communication, such as a third set of spatial distribution rules used to determine updated spatial arrangements of participants and/or elements of the communication session that are used in accordance with a determination that a quantity of participants (e.g., of the first type) is a third number, different from the first and/or the second type (e.g., five, six, seven, or more participants). In some embodiments, the set of spatial distributions dictating updated, recentered spatial arrangements are not predicated upon conventional polygons. For example, the set of spatial distribution rules optionally are based on a relative spacing (e.g., distance between) participants, and/or relative angles (e.g., between vectors extending from a participant, such as a head, torso, and/or shoulders, optionally parallel to a floor of the three-dimensional environment), and not strictly speaking based on a shape (e.g., a triangle, a quadrilateral, and/or a pentagon) with vertices corresponding to positions of the participants. In some embodiments, the set of rules additionally or alternatively consider a type of participants and/or shared content of the communication session, described further with reference to methods 1000 and/or 1200. Determining a set of spatial distribution rules based on a quantity of participants of the first type reduces the likelihood that the current viewpoint is recentered facing away from participants and/or content that user is likely to interact with, thus reducing user input required to reorient and reposition the current viewpoint to improve interaction, thereby reducing processing required to detect the user input and perform operations based on the user input.

In some embodiments, displaying the respective updated spatial arrangement of the elements of the real-time communication session relative to the current viewpoint of the user further includes (For example, as described with reference to step(s) 1402) in accordance with a determination that the one or more other participants are a third quantity of participants of the first type, different from the first quantity of participants of the first type and the second quantity of participants of the first type, such as the quantity of participants as shown in FIG. 13J, the computer system displays, from the current viewpoint of the user a third updated spatial arrangement of the participants in the real-time communication session that is different from the first spatial arrangement of elements of the real-time communication session, such as the spatial arrangement of participants as sown in FIG. 13J, the first updated spatial arrangement of elements of real-time communication session, and the second updated spatial arrangement of elements of real-time communication session. For example, as described with reference to step(s) 1402, the computer system optionally determines an updated spatial arrangement of the participants from a plurality of possible spatial arrangements, such as the first and/or the second grouping arrangements described previously, the third updated spatial arrangement described herein, and/or one or more spatial “templates” described further with reference to methods 1000 and/or 1200. Displaying the participants with a third updated spatial arrangement provides additional flexibility in determining an updated spatial arrangement of elements of the real-time communication session, thereby reducing user input required to manually optimize the updated spatial arrangement and consequentially processing to handle the manual user inputs.

In some embodiments, the first event includes obtaining information that a number of the one or more participants participating in the real-time communication session will or has changed, such as information corresponding to notification 1336 in FIG. 13G. For example, another computer system (e.g., of the participant and/or another participant of the real-time communication session) optionally joins and/or leaves the first communication session, and communicates an indication of the joining and/or leaving to the first computer system of the user. In response to detecting the first event, optionally includes detecting the indication, the first computer system optionally initiates the process to display the first updated spatial arrangement of elements of the real-time communication session. In some embodiments, the other computer system inadvertently leaves the communication session without communication such an indication, and the first computer system receives an indication of the inadvertent exiting. In some embodiments, a plurality of participants exits and/or join the call simultaneously and/or in rapid succession, and the computer system updates the spatial arrangement of elements of the real-time communication session in response to the plurality of participants exiting and/or joining. Updating the spatial arrangement of elements of the real-time communication session when one or more participants have and/or will join reduces user input required to display the elements at improved viewing positions and/or angles, thus reducing manual input required to manipulate the elements, and thereby reducing processing required to handle the manual input.

In some embodiments, the first event includes detecting, via the one or more input devices, input provided by the user of the computer system, such as input 1334 detected in FIG. 13A-1. For example, the first event optionally includes detecting input, such as input directed to a hardware control (e.g., circuitry) such as a selection of a button of the computer system, contact with a touch-sensitive surface in communication with the computer system, a voice command detected by the computer system, an air gesture detected by the computer system (e.g., an air pinching including contact of a plurality of fingers of the user, an air pointing of one or more fingers, and/or an air swiping of a hand and/or fingers of the user), and/or similar inputs directed to a selectable option and/or visual indication displayed by the computer system, and/or some combination of such input(s). In some embodiments, the input has one or more characteristics of similar input(s) to reset placement of participants and/or elements of a communication session described with reference to methods 800, 1000, 1200, 1800, and/or 2000. Updating the spatial arrangement of elements of the real-time communication session when the user provides input reduces user input required to manually update the spatial arrangement, thereby reducing processing required to handle the manual input.

In some embodiments, the spatial distribution of the elements of the real-time communication session is a first relative arrangement relative to the three-dimensional environment prior to detecting the first event, such as the spatial distribution of participants as shown in FIG. 13F, and displaying the respective updated spatial arrangement of the elements of the real-time communication relative to the viewpoint includes maintaining the first relative arrangement of the elements of the real-time communication session, such as maintaining the distance between representation 1312f and representation 1320f as shown in FIG. 13G. For example, the computer system optionally determines an arrangement of virtual object(s), visual representation(s) of participants, shared content (e.g., media content, user interface(s) of applications, and/or text) relative to a shared three-dimensional environment that is shared by participants of the real-time communication session. In some embodiments, in response to detecting a recentering event, the computer system updates the current viewpoint to correspond to an updated perspective relative to the arrangement, while maintaining the arrangement of the elements of the real-time communication session. As an example, before the first event is detected, the computer system optionally displays the first visual representation of the participant next to a second visual representation of another participant, and shared media content at a position above the first and the second visual representations. In response to detecting the first event, the computer system optionally updates the current viewpoint to an updated view of the first and the second visual representations and the shared media content, and maintains a previous orientation and/or distance relative to one another. Maintaining a relative arrangement of elements of the real-time communication session reduces manual user input required to arrange the elements when displaying the first updated spatial arrangement of elements of the real-time communication session, thereby reducing processing required to handle the manual user input.

In some embodiments, the respective updated spatial arrangement of the elements of the real-time communication session is based on a respective quantity of users of the first type, such as users that use a computer system similar to computer system 101a (e.g., tablet, smartphone, wearable computer, or head mounted device) in FIG. 13G, and not based on a respective quantity of users of a second type, different from the first type, such as a type of user that is using a device corresponding to representation 1314h. For example, the computer system optionally classifies and/or receives information of classification of elements of the real-time communication session, and determines the updated spatial arrangement of the elements in accordance with a quantity of elements of a first type (e.g., spatial representations of participants, such as avatars corresponding to the participants) and not in accordance with a quantity of elements of the second type (e.g., media content, representation of participants that are not spatial (e.g., non-avatars, such as real-time video provided by a computer system of the participant, a virtual object from which spatialized audio is played, and/or placeholder virtual objects that do not have a spatial profile (e.g., volume) relative to the three-dimensional environment). In some embodiments, the classification is based on type of device or computer system the participant is using to access the real-time communication session. For example, a first type is optionally a head-mounted device that has one or more characteristics of the first computer system, and a second type is optionally a non-wearable device, and/or a device that does not have one or more characteristics of the first computer system (e.g., a mobile phone, a tablet computer, a laptop, and/or a desktop). In some embodiments, in accordance with a determination that a quantity of participants of the second type is a first quantity or is a second quantity, different from the first quantity, the computer system displays the respective updated spatial arrangement based on the respective quantity of user of the first type. Determining the updated spatial arrangement of elements based on a quantity of users of a first type and not of a second type reduces the likelihood that representations of participants that are potentially more interactive and/or expressive are displayed at advantageous viewing/interaction positions and/or orientations relative to the current viewpoint of the user, thus reducing manual input required to arrange the elements to view and/or interact with such representations, thereby reducing processing required to handle the manual input.

In some embodiments, the first quantity of participants corresponds to two participants, including the user and the first participant, such as shown in FIGS. 13D and 13D1 including representation 1308 at computer system 101a (e.g., tablet, smartphone, wearable computer, or head mounted device), and displaying the first updated spatial arrangement of the elements of the real-time communication session includes displaying the first visual representation of the first participant oriented toward the current viewpoint of the user, such as the arrangement as shown in FIGS. 13D and 13D1 when representation 1308 faces viewpoint 1305a. For example, when the first visual representation of the first participant is displayed at a first orientation and/or first position relative to the current viewpoint of the user before the first event is detected, in response to detecting the first event, the computer system optionally displays the first visual representation at a second orientation and/or position, where the second orientation is angled toward the current viewpoint of the user. It is understood that virtual content being oriented “toward” the current viewpoint of the user as described herein optionally refers to displaying the virtual content such that a vector extending from the virtual content toward the current viewpoint (e.g., a vector extending normal and/or perpendicular to a virtual window, and/or a vector extending from a portion of a participant (e.g., a head, a torso, and/or eyes, and/or a face of a polygon representing the participant)) points to, intersects with, and/or passes through the current viewpoint of the user (e.g., through a position in the three-dimensional environment corresponding to simulated location of the head of the user and/or another body part of the user). For example, the second orientation is optionally determined such that a vector extending from the first visual representation (that is optionally not displayed) is parallel to and intersecting a vector extending from the current viewpoint (e.g., extending from a head of the user, such as a center of the head of the user, and optionally parallel to a floor of the three-dimensional environment). Displaying the first visual representation oriented toward the current viewpoint of the user improves visibility of the first visual representation without requiring manual input to change the orientation to align with the current viewpoint, thereby reducing erroneous user input improperly aligning the first visual representation with the current viewpoint and processing to handle the erroneous user input.

In some embodiments, a distance between the first location of the first visual representation of the first participant is a first distance relative to the current viewpoint before the first event is detected, such as the distance 1346 in FIG. 13B, and displaying the first updated spatial arrangement of the elements of the real-time communication session includes displaying the first visual representation at an updated location, different from the first location, wherein the updated location is the first distance from the current viewpoint of the user, such as the position of representation 1308 that is distance 1347 from viewpoint 1305a in FIG. 13C. For example, when a recentering input is detected while the first visual representation is a distance away from the current viewpoint of the user, the computer system optionally displays the first visual representation in response to the first event at another location, and maintains the distance between the first visual representation and the current viewpoint of the user. In some embodiments, the computer system maintains the distance between a plurality of visual representations and the current viewpoint in response to the first event. Maintaining a distance between the first visual representation and the current viewpoint before and after the first event is detected reduces the likelihood that the first visual representation is displayed too far away for optimal viewing and/or interaction, thus reducing user input required to optimize the distance between the first visual representation and the current viewpoint, thereby reducing processing required to handle the user input.

In some embodiments, an orientation of the first visual representation of the first participant is a first orientation relative to the three-dimensional environment while displayed at the first location when the first event is detected, such as the orientation of representation 1308 in FIG. 13B, and displaying the first updated spatial arrangement of the elements of the real-time communication session includes displaying the first visual representation at the updated location, having the first orientation relative to the three-dimensional environment, such as the updated location and the orientation of representation 1308 in FIG. 13C. For example, when a recentering input is detected while the first visual representation is a first orientation relative to the three-dimensional environment, the computer system optionally displays the first visual representation in response to the first event at an updated location, and maintains the orientation of the first visual representation relative to the three-dimensional environment. For example, if a head of a human-shaped visual representation is facing normal and/or perpendicular to a vector extending from the current viewpoint of the user (e.g., from a center of the current viewpoint and parallel to the floor, optionally not displayed), in response to the first event, the computer system optionally displays the human-shaped visual representation with the head also normal and/or perpendicular to the vector, optionally at an updated position relative to the current viewpoint. In some embodiments, in response to the first event, the computer system maintains orientations of a plurality of visual representations in response to the first event. Maintaining an orientation of the first visual representation in response to the first event preserves visual information indicating what the first participant is viewing within the three-dimensional environment, thereby preserving an understanding of what the participants are focused on, and reducing cognitive burden of the user attempting to regain such an understanding after the first event is detected.

In some embodiments, in a view of the real-time communication session from a perspective of the first participant that includes a second three-dimensional environment, such as three-dimensional environment 1302b (e.g., an AR, AV, VR, MR, or XR environment) presented by computer system 101b (e.g., tablet, smartphone, wearable computer, or head mounted device) in FIG. 13B, before a second computer system associated with the first participant obtains information corresponding to the first event, a visual representation of the user is displayed at a respective first location relative to the view of the second three-dimensional environment from the perspective of the first participant, such as the position and orientation of representation 1312b in FIG. 13B, and an orientation of the visual representation of the user is a first orientation relative to the second three-dimensional environment. For example, the first participant uses a second computer system (having one or more characteristics of the first compute system) to access the real-time communication session, the second computer system optionally displaying a second three-dimensional environment (having one or more characteristics of the first three-dimensional environment) corresponding to a shared three-dimensional environment that is shared with the first computer system. In some embodiments, the second computer system uses a respective display generation component to present a view of the real-time communication session, including the second three-dimensional environment. For example, similar as described with reference to the first computer system, the second computer system optionally displays a representation of the user of the first computer system, having one or more characteristics of the visual representation of the participant described previously, and corresponding to the first user rather than the first participant, including an orientation of the visual representation of the user relative to the second three-dimensional environment (e.g., an angle of the visual representation of the user relative to a current viewpoint of the participant).

In some embodiments, in a view of the real-time communication session from a perspective of the first participant that includes a second three-dimensional environment, in response to obtaining information corresponding to the first event, the orientation of the visual representation of the user is a second orientation, different from the first orientation, such as the orientation of representation 1312 in FIG. 13C, relative to the three-dimensional environment while remaining at the respective first location in the second three-dimensional environment, such as the location of representation 1312 in FIG. 13C. For example, the second computer system optionally detects information communicated from the first computer system and/or another computer system (e.g., a server), and optionally initiates a process to display an updated arrangement of elements of the second three-dimensional environment relative to the current viewpoint of the participant (e.g., having one or more characteristics of similar process(es) performed by the first computer system, described previously). In some embodiments, the second computer system changes the orientation of the visual representation of the user to be a second orientation, such as oriented toward the current viewpoint of the participant, while maintaining a location of the visual representation. Presenting a visual representation of the user at a same location in response to obtaining information corresponding to the first event reduces the likelihood that the first computer system receives information from the second computer system caused by inputs erroneously provided while the visual representation of the user is displayed at a suboptimal viewing and/or interaction angle between the visual representation of the user and the viewpoint of the participant, thereby reducing processing required to receive the information.

In some embodiments, while displaying the first updated spatial arrangement of the elements of the real-time communication session, including the first visual representation of the first participant at the updated location with the first orientation relative to the three-dimensional environment (e.g., as described above), such as the location and orientation of representation 1312 in FIG. 13C, the computer system obtains information corresponding to a second event, different from the first event, such as an event including input 1335 in FIG. 13C. For example, the second event optionally correspond to detecting an indication of a request to reset the spatial distribution of elements of the real-time communication session that is detected at the second computer system of the first participant, as described previously.

In some embodiments, in response to obtaining the information corresponding to the second event, and in accordance with a determination that the second event corresponds to a request to reset a spatial distribution of the elements of the real-time communication session relative to a viewpoint of the first participant presented by a second computer system associated with the first participant, such as a request to reset the elements of the real-time communication session relative to viewpoint 1307b in FIG. 13B, the computer system changes the orientation of the first visual representation of the first participant to be a second orientation, different from the first orientation, wherein the second orientation is directed toward the current viewpoint of the user, such as the orientation of the representation 1312 in FIG. 13C. For example, the second computer system optionally detects a recentering input that has one or more characteristics of similar recentering input(s) described with reference to the first computer system, and optionally initiates a process to display an updated spatial arrangement of the elements of the real-time communication session within a second three-dimensional environment presented by the second computer system, corresponding to a shared three-dimensional environment of the real-time communication session. In some embodiments, the first visual representation is changed in orientation (e.g., to face the current viewpoint of the user of the first computer system, as described previously), while maintaining the position of the first visual representation. It is understood that virtual content facing “toward” the current viewpoint of the user as described herein optionally refers to displaying the virtual content such that a vector extending from the virtual content toward the current viewpoint (e.g., a vector extending normal and/or perpendicular to a virtual window, and/or a vector extending from a portion of a participant (e.g., a head, a torso, and/or eyes, and/or a face of a polygon representing the participant)) points to, intersects with, and/or passes through the current viewpoint of the user (e.g., through a position in the three-dimensional environment corresponding to simulated location of the head of the user and/or another body part of the user). Changing an orientation of the first visual representation of the first participant reduces the likelihood that the user provides erroneous input while the first visual representation is displayed with an orientation that is disadvantageous for viewing and interacting with the first visual representation, thereby reducing user input directed toward the first visual representation based on a suboptimal viewing and/or interacting orientation relative to the viewpoint of the user and processing required to handle the user input. In some embodiments, the first quantity of participants corresponds to three participants, including the user of the computer system, such as the quantity of participants in FIG. 13E. For example, as described previously.

In some embodiments, displaying the first updated spatial arrangement of the elements of the real-time communication session includes displaying the first visual representation of the first participant at a first updated location relative to the current viewpoint, such as displaying representation 1312g at a first location in FIG. 13G, and includes displaying a second visual representation of a second participant, different from the first participant, at a second updated location relative to the current viewpoint, as the updated location of representation 1320g in FIG. 13G, wherein the first updated location is a first distance and the second updated location is a second distance relative to the current viewpoint, and a magnitude of the first distance is within a threshold magnitude of a magnitude of the second distance, such as the distance between representation 1308g and representation 1312g and representation 1320g, respectively, in FIG. 13G. For example, the computer system optionally displays the first participant and the second participant at updated positions that are a same distance, or nearly a same distance relative to the current viewpoint. In some embodiments, the distance between the first participant and the current viewpoint is a same distance as between the second participant and the current viewpoint in response to detecting the first event. In some embodiments, the first distance and the second distance are different in magnitude, and within a threshold magnitude of each other (e.g., 0.001, 0.005, 0.01, 0.05, 0.1, 0.25, or 0.5 m). In some embodiments, the updated positions are at a same or nearly same distance from the current viewpoint, at different angles relative to the current viewpoint (e.g., angles and/or magnitudes of angles formed between a vector extending from the current viewpoint of the user and respective vectors extending from the current viewpoint to the updated position of the respective participant. In some embodiments, the first quantity of participants is different from three participants (e.g., four, five, and/or six participants), and the displaying the first updated spatial arrangement of elements includes displaying respective visual representations of participants at a same distance, and/or within a threshold distance of a same distance from the current viewpoint. Displaying the visual representations of participants at a same distance, or nearly same distance, from the current viewpoint reduces the likelihood that the user experiences difficulty viewing and/or interacting with the participants concurrently and/or in succession, thus reducing user input required to rearrange the current viewpoint and/or elements of the real-time communication session to an advantageous viewing and/or interaction positions relative to the current viewpoint, thereby reducing processing required to detect such user input and perform operations in accordance with the input.

In some embodiments, the first quantity of participants corresponds to three participants, including the user of the computer system, such as shown in FIG. 13G, and displaying the first updated spatial arrangement of the elements of the real-time communication session includes displaying the first visual representation of the first participant at a first updated location relative to the current viewpoint, such as displaying representation 1312g as shown in FIG. 13G, and includes displaying a second visual representation of a second participant, different from the first participant, at a second updated location relative to the current viewpoint, such as representation 1320g in FIG. 13G, wherein the current viewpoint of the user is separated from a line between the first updated location and the second updated location by a respective distance, such as line 1350g in FIG. 13G. For example, the computer system optionally displays the first participant and the second participant at updated locations relative to the user's current viewpoint in response to the first event, where one or more lines (that are optionally not displayed) exist, extending between the location of the first participant to the location of the second participant (the initial locations of the participants before the first event is detected and/or the updated locations of the participants after the event is detected). In some embodiments, the updated locations of the first and the second visual representations are a distance apart from each other, the same as their distance apart from one another before the first event is detected, and are displayed such center of the line between the updated positions is a distance from the user's current viewpoint, the distance based on the length of the line between the first and the second user (e.g., at their initial locations or their updated locations). For example, when an initial line between the first and the second visual representations is a first length when the first event is detected, the distance between the current viewpoint an updated line between the first and the second visual representations at their updated locations is a first distance that is based on the first length of the initial line. When the initial line length is greater than the first length, the distance between the current viewpoint and the updated line is second distance that is relatively greater than the first distance, and when the initial line length is less than the first length, the distance between the current viewpoint is a third distance, relatively less than the first distance.

In some embodiments, the line length and/or orientation of the line, such as line 1350g in FIG. 13G, is determined relative to the three-dimensional environment, and/or relative to the current viewpoint of the user. In some embodiments, the first and the second participants have respective orientations relative to such lines (e.g., before a recentering input and/or event are detected, and/or after such an input and/or event are detected). In some embodiments, the current viewpoint corresponds to a side of the line. For example, the line extending between positions of the first and second participants before the first event detected optionally bisects the three-dimensional environment, and the current viewpoint of the user (e.g., a majority of a body of the user, and/or position corresponding to the viewpoint of the user) is optionally on a first side or on a second, opposing side of the line. In some embodiments, in response to detecting the first event, the computer system displays the first and the second visual representations of the participants at updated locations and orientations, as if the current viewpoint is on a same side of a line between the updated locations as the side of line between the initial locations of the first and second visual representations. For example, displaying the visual representations of the participants in response to the first event optionally includes displaying the respective visual representations with a same orientation relative to the updated line as they were displayed relative to the initial line. Displaying the first and the second visual representations of participants at updated positions, wherein the updated positions are determined based on a distance between the current viewpoint and a line extending between the updated positions, preserves visibility of the first and the second visual representation, therefore reducing user inputs required to change the user's current viewpoint, and thereby processing required to handle such user inputs.

In some embodiments, displaying the first visual representation of the first participant at the first updated location relative to the current viewpoint, and displaying the second visual representation of a second participant, different from the first participant, at the second updated location relative to the current viewpoint includes in accordance with a determination that a distance between the first visual representation and the second visual representation when the first event detected is a first distance, the respective distance is the first distance, such as a distance between representation 1312e and representation 1320e in FIG. 13E.

In some embodiments, displaying the first visual representation of the first participant at the first updated location relative to the current viewpoint, and displaying the second visual representation of a second participant, different from the first participant, at the second updated location relative to the current viewpoint includes in accordance with a determination that the distance between the first visual representation and the second visual representation when the first event detected is a second distance, different from the first distance, the respective distance is the second distance, such as the distance between representation 1312f and representation 1320f in FIG. 13F. For example, as described above with reference to the “line” between the first visual representation and the second visual representation. Displaying the first and the second visual representations of participants at updated positions, wherein the updated positions are determined based on a distance between the current viewpoint and a line extending between the updated positions, preserves visibility of the first and the second visual representation, therefore reducing user inputs required to change the user's current viewpoint, and thereby processing required to handle such user inputs.

In some embodiments, before the first event is detected, the current viewpoint is on a first side of a first line extending between the first visual representation and a second visual representation of a second participant, such as the viewpoint of representation 1308f on a first side of line 1350f in FIG. 13F. For example, as described above with reference to the initial line.

In some embodiments, the first quantity of participants corresponds to three participants, such as shown in FIG. 13E, including the user of the computer system, and displaying the first updated spatial arrangement of the elements of the real-time communication session includes displaying the first visual representation of the first participant at a first updated location relative to the current viewpoint, and includes displaying a second visual representation of a second participant, different from the first participant, at a second updated location relative to the current viewpoint, wherein the current viewpoint of the user is on the first side of a second line extending between the first updated location and the second updated location, such as the viewpoint of representation 1308g in FIG. 13G relative to line 1350g. For example, as described above with reference displaying the first visual representation and the second visual representation at respective positions and/or orientations relative to an updated line, and relative to the current viewpoint of the user. It is understood that the second line is optionally the same line as the first line, drawn (and optionally not displayed) based on an updated perspective relative to the current viewpoint of the user and due to the updated spatial arrangement of the elements of the real-time communication session. Displaying the first and the second visual representations of participants at updated positions and/or orientations, such that the current viewpoint of the user remains on a same side of a line extending between the first and the second visual representations of participants, improves consistency of visibility of the first and the second visual representation, therefore reducing user inputs required to change the user's current viewpoint to preserve the consistency of visibility, and thereby processing required to handle such user inputs. In some embodiments, the first quantity of participants corresponds to three participants, including the user of the computer system, such as the participants shown in FIG. 13G. For example, as described previously.

In some embodiments, the first event is detected while attention (e.g., gaze) of the first participant corresponding to the first visual representation has a first orientation relative to the viewpoint of the user, and attention of a second participant (e.g., gaze), different from the first participant, of the real-time communication session corresponding to a second visual representation of the second participant has a second orientation relative to the current viewpoint of the user, such as the attention of representation 1312h and representation 1320h relative to line 1350h in FIG. 13H. For example, the first computer system obtains information, such as detecting an indication, of attention of participants of the real-time communication session. For example, a computer system participating in the real-time communication session optionally detects attention of the user directed to their visible three-dimensional environment, and optionally communicates an indication of the location of the attention and/or correspondence of the attention to elements of the real-time communication session, that is detected by the first computer system, thereby providing an indication of a position—and accordingly an orientation—of attention relative to the visible three-dimensional environment of the first computer system.

In some embodiments, displaying the first updated spatial arrangement of the elements of the real-time communication session includes, in accordance with a determination that the first orientation and the second orientation satisfy one or more first criteria, including a criterion that is satisfied when the first orientation and the second orientation of attention are directed to a first side of a line, such as line 1350h in FIG. 13H, extending between the first visual representation of the first participant and the second visual representation of the second visual representation, displaying the first visual representation and the second visual representation at updated positions, wherein the current viewpoint is on the first side of the line, such as the display of representation 1312i and 1320i in FIG. 13I relative to a viewpoint of representation 1308i. In some embodiments, the computer system updates the spatial arrangement of elements such that the current viewpoint is facing a side of the line between the first visual representation and the second visual representation that matches a side of the line the attention of the first and second participants were directed to. It is understood that a “side” of the line corresponds to some and/or all portions of the three-dimensional environment leading up to, but not past the side of the line (e.g., the portion of the three-dimensional environment “lying” on that side of the line). In some embodiments, the determination of attention orientation is based on a direction of a body of the participants, and/or a head of the participants, relative to the line. For example, in accordance with a determination that the first orientation and the second orientation of attention are within a range of orientations relative to the current viewpoint (e.g., corresponding to a first side of the line), displaying the first updated spatial arrangement of the elements of the real-time communication session includes displaying, via the display generation component, the first visual representation and the second visual representation with a respective first updated spatial relationship relative to the current viewpoint (e.g., where the current viewpoint is on the first side of the line).

In some embodiments, displaying the first updated spatial arrangement of the elements of the real-time communication session includes, in accordance with a determination that the first orientation and the second orientation satisfy one or more second criteria, including a criterion that is satisfied when the first orientation and the second orientation of attention correspond to a second side of the line, such as a side of the line 1350g that representation 1308g is located in FIG. 13G, the displaying the first updated spatial arrangement of the elements of the real-time communication session includes displaying, via the display generation component, the first visual representation and the second visual representation at updated positions, wherein the current viewpoint is on the second side of the line, such as viewpoint 1308h relative to the side of the line 1350h in FIG. 13H. For example, the first computer system displays the first visual representation and the second visual representation with a respective second updated spatial relationship relative to the current viewpoint, different from the respective first updated spatial relationship, such as on the second side of the line (e.g., the same line as the first line, drawn (but, optionally, not displayed) based on the updated spatial arrangement of elements of the real-time communication session). Updating the current viewpoint to mimic a recentering of the current viewpoint to a side of a line extending between the two visual representations places orients the user toward where the visual representations are facing, thus reducing user input required to change the viewpoint to assume such an orientation, and thereby reducing power required to handle the user input.

In some embodiments, the one or more first criteria include a criterion that is satisfied when the current viewpoint of the user is closest to a first side of the line extending between the first visual representation and the second visual representation when the first event is detected, such as representation 1308g relative to line 1350g in FIG. 13G when a recentering input is detected, and the one or more second criteria include a criterion that is satisfied when the current viewpoint of the user is closest to a second side, different from the first side, of the line when the first event is detected, such as the side that representation 1308i is on relative to line 1350i in FIG. 13I. For example, in addition or alternative to orientations of attention of the participants, the computer system displays the first updated spatial arrangement of elements of the real-time communication session in accordance with a determination the first side or the second side of the line—as described previously (e.g., the first and the second line being a same line)—is closest to the viewpoint of the user when the first event is detected. For example, the computer system determines a first candidate distance between a first prospective recentering destination relative to the first side of the line (e.g., a respective distance from the line, as described previously), and determines a second candidate distance between a second prospective destination relative to the first side of the line, and optionally updates the spatial arrangement of elements of the real-time communication as if the current viewpoint is moved to the prospective recentering destination associated with the smaller candidate distance. Updating the spatial arrangement of elements corresponding to a recentering toward a closest side of the line reduces degree of change to the spatial arrangement of elements, thereby reducing cognitive burden of the user when assessing the updated spatial arrangement of elements. In some embodiments, the first quantity of participants corresponds to four participants, including the user of the computer system, such as the quantity of participants shown in FIG. 13L.

In some embodiments, the first event is detected while the first quantity of participants are arranged in a respective grouping arrangement, such as a grouping arrangement between representations 1308l, 1312l, and 1320l in FIG. 13L. For example, the respective grouping arrangement includes a first group of visual representation(s) of participants and a second group of visual representation(s) of visual representations of participants, described further with reference to method 1600.

In some embodiments, displaying the first updated spatial arrangement of the elements of the real-time communication session includes, in accordance with a determination that the respective grouping arrangement corresponds to a first grouping arrangement, such as a first grouping arrangement of representations 1308l, 1312l, and 1320l in FIG. 13L, displaying, via the display generation component, a plurality of visual representations of the participants of the first type with a respective first updated spatial relationship relative to the current viewpoint, such as a first updated arrangement of representations 1308l, 1312l, and 1320l in FIG. 13L. For example, the first grouping arrangement has one or more characteristics of grouping arrangements described with reference to method 1600.

In some embodiments, displaying the first updated spatial arrangement of the elements of the real-time communication session includes, in accordance with a determination that the respective grouping arrangement corresponds to a second grouping arrangement, different from the first grouping arrangement, such as a second grouping arrangement of representations 1308l, 1312l, and 1320l, displaying, via the display generation component, the plurality of visual representations of the participants of the first type with a respective second updated spatial relationship relative to the current viewpoint, different from the respective first updated spatial relationship, such as a different spatial relationship than the first updated arrangement of representations 1308l, 1312l, and 1320l. For example, the second grouping arrangement has one or more characteristics of grouping arrangements described with reference to method 1600. Thus, similar or the same as described with reference to method 1600, the computer system optionally updates the spatial arrangement of elements of the real-time communication session relative to the current viewpoint based on a detected configuration of the group(s) of visual representations of participants detected when the first event is detected. Determining an updated arrangement of the elements of the real-time communication session user based on grouping arrangement of a plurality of participants participating in a real-time communication session with the user reduces user input needed for moving the current viewpoint to a position and/or orientation that improves visibility of relevant representations of the plurality of participants, thereby improving efficiency of communication and reducing computing power required to process manual movement of the current viewpoint.

In some embodiments, the first quantity of participants corresponds to four participants, including the user of the computer system, such as the quantity of participants in FIG. 13L. For example, as described above. In some embodiments, the first event is detected while the four participants included in the first quantity of participants are arranged in a respective spatial distribution when the first event is detected, such spatial distribution of representations 1308l, 1312l, and 1320l in FIG. 13L. For example, as described further with reference to method 1800. In some embodiments, displaying the first updated spatial arrangement of the elements of the real-time communication session includes, in accordance with a determination that the respective spatial distribution is a first spatial distribution when the first event is detected, as a circle with a gap of representations 1308l, 1312l, 1320l, and 1330l in FIG. 13L, displaying a plurality of representations of the participants of the first type with a first updated spatial distribution relative to the current viewpoint of the user, such as a first updated arrangement including representations 1308l, 1312l, 1320l, and 1330l in FIG. 13L. For example, as described further with reference to method 1800.

In some embodiments, displaying the first updated spatial arrangement of the elements of the real-time communication session includes, in accordance with a determination that the respective spatial distribution is a second spatial distribution when the first event is detected, such as an arc including representations 1312l, 1320l, and 1330l in FIG. 13L, different from the first spatial distribution, displaying the plurality of representations of the participants of the first type with a second updated spatial distribution relative to the current viewpoint of the user, different from the second spatial distribution, and the first updated spatial distribution, such as a second updated arrangement including representations 1308l, 1312l, 1320l, and 1330l in FIG. 13L. For example, as described further with reference to method 1800. Thus, in some embodiments, the computer system updates the spatial arrangement of elements of the real-time communication session in accordance with a spatial distribution including a simulated vacancy (e.g., “gap”) corresponding to a respective spatial distribution of the plurality of representations of participants. Determining an updated arrangement of the plurality of visual representations of participants in accordance with a respective spatial distribution of visual representations of participants when the first event is detected reduces user input to assume a similar updated arrangement, and improves the likelihood that visual representations of participants are displayed at easily viewable and/or interactable positions relative to the user viewpoint, thereby reducing processing required to handle such user input.

In some embodiments, the respective updated spatial arrangement is based on the quantity of participants of the first type, such as a type of participating using a computer system similar to computer system 101a (e.g., tablet, smartphone, wearable computer, or head mounted device) in FIG. 13K, and is not based on (and/or is determined without regard to) a quantity of participants of a second type, different from the first type, such as a type of participant using a device used by a participant corresponding to representation 1314l in FIG. 13L. For example, as described further with reference to method 2000. Thus, in some embodiments, the computer system updates the spatial arrangement of elements of the real-time communication session in accordance with a number of participants of the first type, and not based on a number of participants of the second type. Determining an updated arrangement of the plurality of visual representations of participants in accordance with a number of participants of the first type, and not of the second type, when the first event is detected reduces user input to assume a similar updated arrangement, and improves the likelihood that visual representations of participants are displayed at easily viewable and/or interactable positions relative to the user viewpoint, thereby reducing processing required to handle such user input.

It should be understood that the particular order in which the operations in method 1400 have been described is merely exemplary and is not intended to indicate that the described order is the only order in which the operations could be performed. One of ordinary skill in the art would recognize various ways to reorder the operations described herein.

FIGS. 15A-15L illustrate examples of a computer system facilitating interaction with groups of spatial representations of participants of a communication session, in accordance with some embodiments of the disclosure.

FIG. 15A illustrates a computer system 101 (e.g., tablet, smartphone, wearable computer, or head mounted device) (e.g., a tablet, smartphone, wearable computer, or head mounted device) displaying, via a display generation component (e.g., display generation component 120 of FIG. 1 such as a computer display, touch screen, or one or more display modules of a head mounted device), a three-dimensional environment 1502 (e.g., an AR, AV, VR, MR, or XR environment) from a viewpoint of representation 1504 of the user of the computer system 101 (e.g., tablet, smartphone, wearable computer, or head mounted device) (e.g., facing a back wall of the physical environment in which computer system 101 (e.g., tablet, smartphone, wearable computer, or head mounted device) is located). It is understood that three-dimensional environment 1502 optionally corresponds to what is visible via display generation component 120 to the user of computer system 101 (e.g., tablet, smartphone, wearable computer, or head mounted device) (e.g., via an active and/or passive passthroughs). It is also understood that reference to “representation 1504” is at times, dependent upon context of description, optionally used interchangeably to refer to the user of the computer system 101 (e.g., tablet, smartphone, wearable computer, or head mounted device) for convenience and consistency of description. In some embodiments, computer system 101 (e.g., tablet, smartphone, wearable computer, or head mounted device) includes a display generation component (e.g., a computer display, touch screen, or display module of a head mounted device) and a plurality of image sensors (e.g., image sensors 314 of FIG. 3). The image sensors optionally include one or more of a visible light camera, an infrared camera, a depth sensor, or any other sensor the computer system 101 (e.g., tablet, smartphone, wearable computer, or head mounted device) would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user).

As shown in FIG. 15A, computer system 101 (e.g., tablet, smartphone, wearable computer, or head mounted device) captures one or more images of the physical environment around computer system 101, including one or more objects in the physical environment around computer system 101. In some embodiments, computer system 101 (e.g., tablet, smartphone, wearable computer, or head mounted device) displays representations of the physical environment in three-dimensional environment 1502. For example, three-dimensional environment 1502 includes a table, which is optionally a representation of a table in the physical environment that is detected using imaging circuitry include in computer system 101 (e.g., tablet, smartphone, wearable computer, or head mounted device) and presented via the display generation component 120. In some embodiments, as illustrated by the dashed box corresponding to three-dimensional environment 1502, a representation of the user's physical environment remains fixed relative to the viewpoint of the user in response to recentering input(s) and/or operations, as described further herein. Thus, it is understood that although representation 1504 in FIGS. 15B-15L moves relative to a shared environment 1503—described further below—the viewpoint of the user corresponding to representation 1504 optionally remains fixed relative to the user's physical environment, unless expressly described as moving relative to the user's physical environment. Unless stated otherwise, rearranging and/or movement of the user corresponds to perceived movement of the user relative to a shared and/or virtual three-dimensional environment, while the user's relative position and/or orientation in their physical environment remains unchanged.

In FIG. 15A, three-dimensional environment 1502 also includes one or more virtual objects. In some embodiments, the virtual objects are or include one or more of user interfaces of an application (e.g., an application running on the computer system 101) containing content (e.g., quick look windows displaying photographs, playback user interface displaying content, and/or web-browsing user interface displaying text), three-dimensional objects (e.g., virtual clocks, virtual balls, and/or virtual cars) or any other element displayed by computer system 101 (e.g., tablet, smartphone, wearable computer, or head mounted device) that is not included in the physical environment of display generation component 120.

In FIG. 15A, computer system 101 (e.g., tablet, smartphone, wearable computer, or head mounted device) is engaged in a communication session with other communication session participants. As described further with reference to methods 800, 1000, 1200, 1400, 1600, 1800, and/or 2000, the communication session is optionally a real-time, or nearly real-time communication session. For example, computer system 101 (e.g., tablet, smartphone, wearable computer, or head mounted device) optionally displays representation 1514, representation 1516, and representation 1518 in three-dimensional environment 1502. In some embodiments, the representations of the communication session participants have one or more characteristics described further with reference to methods 800 and/or 1600. For example, the representations optionally are and/or include anthropomorphic avatars, including portions of the avatar's body that move relative to one another (e.g., legs, arms, hands, heads, and/or torsos). In some embodiments, the representations are not anthropomorphic, such as a polygonal shape, where portions of the polygonal shape do not move relative to one another (e.g., a rectangular prism, a thin cylindrical prism similar to a coin, and/or an ellipsoid). From the perspective of a first participant—the user of computer system 101 (e.g., tablet, smartphone, wearable computer, or head mounted device) corresponding to representation 1504—a field-of-view presented via the display generation component 120 optionally corresponds to a portion of the three-dimensional environment 1502 that corresponds to spatial representations of the participants, such as when the spatial representations of the participants are assigned and/or mapped to a positions within a shared three-dimensional environment shared between the communication session participants, described further with reference to FIGS. 7A and 7A1, and/or FIGS. 13A-1 to 13A-2. Accordingly, as illustrated in FIG. 15A, representation 1514, representation 1516, and/or representation 1518 are optionally displayed. Additionally, computer system 101 (e.g., tablet, smartphone, wearable computer, or head mounted device) is optionally aware, or made aware of the positions of representation of additional participants, such as representation 1506, representation 1508, representation 1510, and representation 1512, optionally outside the field of view of the computer system while representation 1504 has the viewpoint relative to three-dimensional environment 1502 illustrated in FIG. 15A.

In some embodiments, computer system 101 (e.g., tablet, smartphone, wearable computer, or head mounted device) determines and/or obtains information indicating that a plurality of participants is arranged in groups, as described further with reference to method 1600. For example, computer system 101 (e.g., tablet, smartphone, wearable computer, or head mounted device) determines that a plurality of users is relatively close to one another, facing a similar direction (e.g., based on head direction, body direction, attention (e.g., gaze), and/or some combination thereof), and/or engaged in conversation via the real-time communication session. For example, first group 1507 optionally comprises representation 1506, representation 1508, representation 1510, and representation 1512, due to their respective proximity to one another relative to three-dimensional environment 1502, and second group 1509 optionally comprises representation 1514, representation 1516, and/or representation 1518 in FIG. 15A. In some embodiments, the groups have a simulated center, such that a respective group is assigned a position relative to the three-dimensional environment 1502 by computer system 101 (e.g., tablet, smartphone, wearable computer, or head mounted device) and/or other computer systems engaged in the real-time communication session. For example, first center 1517 is determined by the computer system 101 (e.g., tablet, smartphone, wearable computer, or head mounted device) and/or the other computer systems relative to three-dimensional environment 1502 based on the body direction, head direction, distance(s) between participants, and/or attention of participants of group 1507 in FIG. 15A. Similarly, second center 1519 is optionally determined by the computer system 101 (e.g., tablet, smartphone, wearable computer, or head mounted device) and/or the other computer systems relative to three-dimensional environment 1502 based on similar determinations made relative to participants of second group 1509 in FIG. 15A. In some embodiments, the position of a respective center is based on a coordinate system relative to and/or defining three-dimensional environment 1502, such as a calculated position (e.g., based on an average of coordinates of participants of a respective group, based on a spatial arrangement of the group relative to three-dimensional environment 1502, and/or additionally or alternatively adjusted in accordance with the orientation of the participants and/or attention of the participants relative to three-dimensional environment 1502).

In FIG. 15A, representation 1504 has a first orientation and position relative to three-dimensional environment 1502, and attention of representation 1504 is directed to an initial position relative to three-dimensional environment 1502. For example, representation 1504 is a first distance 1522 from the first group 1507, and a second distance 1520 from the second group 1509, the first distance 1522 equal to the second distance 1520 in FIG. 15A. In some embodiments, computer system 101 (e.g., tablet, smartphone, wearable computer, or head mounted device) detects an input including a request to update a spatial arrangement of elements relative to the viewpoint of the use of the computer system, such as the viewpoint of representation 1504, such as input 1501. At times, such as request is optionally referred to herein as a “recentering” request and/or input, and the resulting updating is optionally referred to a “recentering” of the elements and/or a “recentered” viewpoint and/or arrangement. It is understood that the such recentering requests, and the resulting recentered spatial arrangements of the real-time communication session, and views of the elements of the real-time communication session relative to respective viewpoints of respective communication session participants and/or their respective computer systems have one or more characteristics as described further with reference to FIGS. 13A-1 through FIGS. 13D and 13D1.

FIG. 15A1 illustrates similar and/or the same concepts as those shown in FIG. 15A (with many of the same reference numbers). It is understood that unless indicated below, elements shown in FIG. 15A1 that have the same reference numbers as elements shown in FIGS. 15A-15L have one or more or all of the same characteristics. FIG. 15A1 includes computer system 101, which includes (or is the same as) display generation component 120. In some embodiments, computer system 101 and display generation component 120 have one or more of the characteristics of computer system 101 shown in FIGS. 15A-15L and display generation component 120 shown in FIGS. 1 and 3, respectively, and in some embodiments, computer system 101 and display generation component 120 shown in FIGS. 15A-15L have one or more of the characteristics of computer system 101 and display generation component 120 shown in FIG. 15A1.

In FIG. 15A1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 15A-15L.

In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 15A1.

Display generation component 120 has a field of view (e.g., a field of view captured by external image sensors 314b and 314c and/or visible to the user via display generation component 120) that corresponds to the content shown in FIG. 15A1. Because display generation component 120 is optionally a head-mounted device, the field of view of display generation component 120 is optionally the same as or similar to the field of view of the user.

In some embodiments, computer system 101 responds to user inputs as described with reference to FIGS. 15A-15L.

It is understood than one or more or all aspects of the present disclosure as shown in, or described with reference to FIGS. 15A-15L and/or described with reference to the corresponding method(s) are optionally implemented on computer system 101 and display generation unit 120 in a manner similar or analogous to that shown in FIG. 15A1.

In FIG. 15B, the viewpoint of representation 1504 updates to join the first group 1507 in response to input 1501 detected in FIG. 15A. For example, representation 1504 optionally joins a “gap” or vacancy in the first group 1507, described further with reference to methods 1800 and/or 2000. It is understood that “joining” a group of participants optionally corresponds to updating display of elements of the real-time communication session and/or changing the current viewpoint of the user such that visual representation of participants are arranged at least partially within a field of view of the computer system 101, and/or relatively closer than before joining the group. In FIG. 15B, the viewpoint of the user represented by representation 1504 is maintained relative to its three-dimensional environment 1502 (e.g., an AR, AV, VR, MR, or XR environment) (e.g., and/or to its physical environment), while the elements of the real-time communication session maintain their respective spatial arrangement relative to a shared three-dimensional environment 1503. In some embodiments, positions within the three-dimensional environment 1502 of the user of computer system 101 (e.g., tablet, smartphone, wearable computer, or head mounted device) are at least partially or entirely mapped to positions within shared three-dimensional environment 1503, and positions within respective three-dimensional environments of respective computer systems engaged in the real-communication session with computer system 101 (e.g., tablet, smartphone, wearable computer, or head mounted device) are at least partially or entirely mapped to respective positions within the shared three-dimensional environment 1503. For example, a virtual object assigned to a first position within the shared three-dimensional environment 1503 is optionally displayed at a corresponding, respective position within three-dimensional environment 1502, where the shared three-dimensional environment 1503 is associated with a first coordinate system corresponding to a first set of axes and having a first origin. Further, the three-dimensional environment 1502 of the computer system 101 (e.g., tablet, smartphone, wearable computer, or head mounted device) optionally is associated with a second set of axes, that are different from the first set of axes. In response to the input 1501 in FIG. 15B, computer system 101 (e.g., tablet, smartphone, wearable computer, or head mounted device) updates the spatial arrangement of elements of the real-time communication session such that three-dimensional environment 1502 of the computer system 101 (e.g., tablet, smartphone, wearable computer, or head mounted device) is reoriented and/or repositioned relative to the shared three-dimensional environment 1503.

In some embodiments, the viewpoint of a respective computer system that is participating in the real-time communication session is assigned to a position and/or orientation relative to the shared three-dimensional environment; thus, a first vector (e.g., not displayed) is able to be determined between the position assigned to the viewpoint of a respective computer system and the position of the virtual object (and/or the viewpoint of another computer system engaged in the real-time communication session) and relative to the first set of axes and/or origin of the shared three-dimensional environment 1503. To emulate the behavior of the participants using respective computer systems sharing a physical environment, the respective computer systems thereby optionally display virtual objects (and/or representations of other users of computer systems) at positions relative to the respective viewpoints of users of the respective computer system, based on respective vectors extending between the viewpoint and the virtual objects (and/or the other viewpoints). Turning back to the first vector described previously, computer system 101 (e.g., tablet, smartphone, wearable computer, or head mounted device) optionally determines an amount of translation to align the first set of axes (corresponding to the shared three-dimensional environment 1503) with the second set of axes (corresponding to the three-dimensional environment 1502 of the user of computer system 101), such as the origin of the respective axes, and accordingly translates the first vector by a same amount of translation, to determine a second vector that defines a position of the virtual object relative to the second set of axes (e.g., defines the position relative to the viewpoint of the representation 1504). It is understood that additional or alternative determinations, such as additional scaling, translating, and/or mapping between a coordinate system associated with the shared three-dimensional environment 1503 and a coordinate a system associated with the three-dimensional environment 1502 (e.g., an AR, AV, VR, MR, or XR environment) are possible, without departing from the scope of the disclosure.

Consequentially, in FIG. 15B, the position and/or orientation of the virtual object displayed relative to the three-dimensional environment 1502 of computer system 101 (e.g., tablet, smartphone, wearable computer, or head mounted device) is based on a corresponding to a position and/or orientation of the virtual object relative to the shared three-dimensional environment 1503.

In FIG. 15B, representation 1504 recenters to join the first group 1507 and is oriented toward the center 1517 while the positions and/or orientations of the first group 1507 are maintained (relative to as illustrated in FIG. 15A). In some embodiments, computer system 101 (e.g., tablet, smartphone, wearable computer, or head mounted device) determines a set of rules dictating the recentering “destination” (e.g., where the viewpoint of representation 1504 corresponds to relative to the shared three-dimensional environment 1503), such as a first rule that the computer system moves to a relatively closer group of participants. In some embodiments, the set of rules additionally include a second rule, such as illustrated from FIGS. 15A-15B, such that representation 1504 joins a largest group of the real-time communication session. In some embodiments, the second rule is an overriding rule. For example, because the first distance 1522 and second distance 1520 were equal in FIG. 15A such that representation 1504 was equidistant to the first group 1507 and second group 1509 in FIG. 15A, in response to detecting the input 1501, the computer system 101 (e.g., tablet, smartphone, wearable computer, or head mounted device) recenters the viewpoint of representation 1504 to join the larger, first group 1507. In some embodiments, independent of the closest group relative to representation 1504, computer system 101 (e.g., tablet, smartphone, wearable computer, or head mounted device) recenters representation 1504 to join the largest group (e.g., recenters in accordance with the second rule, disregarding the first rule).

In some embodiments, the positions and/or orientations of second group 1509 are maintained when representation 1504 recenters to join the first group 1507. It is understood that the operations and arrangements when recentering the elements of the real-time communication session described herein are exemplary and non-limiting. For example, in response to recentering to join a group, the participants of the group are optionally moved to updated positions and/or orientations, such as in accordance with a spatial template described with reference to methods 1000 and/or 1200. In some embodiments, when joining a group, computer system 101 (e.g., tablet, smartphone, wearable computer, or head mounted device) forgoes updating a spatial arrangement of the group. Although the embodiments of the disclosure are directed to representation 1504 recentering to join a first group or a second group, it is understood that additional or alternative groups optionally exist in the real-time communication session, and computer system 101 (e.g., tablet, smartphone, wearable computer, or head mounted device) optionally recenters to join a respective group in accordance with the logic and operations described herein. In some embodiments, when joining a group, computer system 101 (e.g., tablet, smartphone, wearable computer, or head mounted device) forgoes updating a spatial arrangement of the group.

In FIG. 15C, an alternative embodiment is illustrated in which representation 1504 recenters to join the second group 1509. For example, in FIG. 15A, attention (e.g., based on gaze, head direction, and/or body direction) is optionally directed to a position intersecting with nearby, and/or within a position that corresponds to the second group 1509 when input 1501 is detected. In some embodiments, the set of rules include a third rule, the third rule dictating that attention of the user is an overriding factor over one or more other rules. For example, despite the relatively larger quantity of participants included in the first group 1507, the computer system 101 (e.g., tablet, smartphone, wearable computer, or head mounted device) recenters representation 1504 to join the second group 1509 in FIG. 15C, due to the attention of representation 1504 targeting second group 1509 in FIG. 15A. In FIG. 15C, computer system 101 (e.g., tablet, smartphone, wearable computer, or head mounted device) obtains information 1527 that a participant (e.g., “user” of a computer system) of the real-time communication session will soon leave the real-time communication session. In some embodiments, in response to obtaining such information, computer system 101 (e.g., tablet, smartphone, wearable computer, or head mounted device) ceases display of a representation corresponding to the leaving participant. For example, in FIG. 15D, representation 1506 is no longer participating in the real-time communication session and thus is no longer displayed. From FIG. 15C to FIG. 15D, representation 1504 moves, in accordance with indicator 1525 (illustrated in FIG. 15C), from an initial position 1528 illustrated in FIG. 15D, to a position within 1502 that is equidistant to centers of the first group 1507 and second group 1509. In some embodiments, in accordance with a determination that a respective participant is joining, will join, is leaving, and/or will leave the real-time communication session, computer system 101 (e.g., tablet, smartphone, wearable computer, or head mounted device) recenters the group that respective participant is associated with. In some embodiments, computer system 101 (e.g., tablet, smartphone, wearable computer, or head mounted device) forgoes recentering of the group that the respective participant is associated with in accordance with such a determination. In some embodiments, in accordance with such a determination, computer system 101 (e.g., tablet, smartphone, wearable computer, or head mounted device) recenters its viewpoint (e.g., relative to a current group the computer system 101 (e.g., tablet, smartphone, wearable computer, or head mounted device) is included in). In some embodiments, in accordance with such a determination, computer system 101 (e.g., tablet, smartphone, wearable computer, or head mounted device) does not recenter the viewpoint of representation 1504. In FIG. 15D, an input 1530 is detected by computer system 101 (e.g., tablet, smartphone, wearable computer, or head mounted device) while representation 1504 is closer to first group 1507 than second group 1509, as indicated by distance 1526 that is smaller than distance 1524.

In FIG. 15E, computer system 101 (e.g., tablet, smartphone, wearable computer, or head mounted device) recenters representation 1504 to join a relatively closer group of participants, in response to input 1530 detected in FIG. 15D. For example, similar to as described previously, computer system 101 (e.g., tablet, smartphone, wearable computer, or head mounted device) optionally recenters to join a closest group of participants. In FIG. 15D, a quantity of participants included in first group 1507 is the same as a quantity of participants included in second group 1509; accordingly, computer system 101 (e.g., tablet, smartphone, wearable computer, or head mounted device) optionally recenters representation 1504 in accordance with a tiebreaking rule that dictates that the representation 1504 joins a relatively closer group of participants in accordance with a determination that the quantity of participants in respective groups equal in FIG. 15E. In some embodiments, independently of a number of participants in a respective group, the computer system 101 (e.g., tablet, smartphone, wearable computer, or head mounted device) recenters the viewpoint of representation 1504 to join a closest group. After joining the closer, first group 1507, the computer system 101 (e.g., tablet, smartphone, wearable computer, or head mounted device) obtains information 1532 that a participant will leave the real-time communication session.

In FIG. 15F, computer system 101 (e.g., tablet, smartphone, wearable computer, or head mounted device) maintains a spatial arrangement of participants in first group 1507 in response to obtaining the information 1532 in FIG. 15E. In some embodiments, in response to a participant leaving the real-time communication session, computer system 101 (e.g., tablet, smartphone, wearable computer, or head mounted device) forgoes recentering of the viewpoint of the user. For example, from FIG. 15E to FIG. 15F, a participant corresponding to representation 1508 leaves the real-time communication session, and computer system 101 (e.g., tablet, smartphone, wearable computer, or head mounted device) ceases display of representation 1508. As illustrated in FIG. 15F, the relative spatial arrangement of the first group 1507 is maintained in response to ceasing display of representation 1508, and the position and/or orientation of representation 1504 is maintained, such that attention of the participant corresponding to representation 1504 is oriented toward a center of first group 1507. From FIG. 15F to FIG. 15G, computer system 101 (e.g., tablet, smartphone, wearable computer, or head mounted device) detects a change in viewpoint of representation 1504, turning and directing attention to the second group 1509. For example, in FIG. 15G, representation 1504 is turned toward second group 1509, and a vector extending from the body of representation 1504 is oriented intersecting with a position correspond to a participant in second group 1509. While attention of representation 1504 is directed to second group 1509, input 1534 is optionally detected requesting a recentering of the viewpoint of representation 1504 in FIG. 15G. At the same time, or nearly the same time, computer system 101 (e.g., tablet, smartphone, wearable computer, or head mounted device) obtains information 1533 indicating that a participant will join the real-time communication session.

In FIG. 15H, representation 1504 recenters to join the second group 1509 in response to the input 1534 detected by computer system 101 (e.g., tablet, smartphone, wearable computer, or head mounted device) in FIG. 15G and/or in response to detecting that the participant joined the real-time communication session. For example, as described previously, in response to obtaining information that a participant will join the real-time communication session, computer system 101 (e.g., tablet, smartphone, wearable computer, or head mounted device) optionally recenters the viewpoint of representation 1504. In some embodiments, representation 1504 joins a new group in accordance with one or more rules described previously. In FIG. 15H, representation 1504 has joined second group 1509 in accordance with a determination that the attention of the user was directed to second group 1509 when recentering input was detected. In some embodiments, as described previously, computer system 101 (e.g., tablet, smartphone, wearable computer, or head mounted device) forgoes recentering the viewpoint of representation 1504 in response to obtaining the information 1533 in FIG. 15G, and performs the recentering in response to detecting the input 1534.

In FIG. 15I, representation 1504 moves and the participants of the real-time communication session move relative to three-dimensional environment 1502 (e.g., an AR, AV, VR, MR, or XR environment) to updated positions and/or orientations, relative to the arrangements shown in FIG. 15H. For example, representation 1504 having a threshold 1542-4 is equidistant to first group 1507 and second group 1509 in FIG. 15I, which comprise equal quantities of participants. In some embodiments, computer system 101 (e.g., tablet, smartphone, wearable computer, or head mounted device) determines groups of users in accordance with one or more cultural settings. For example, as described further with reference to method 1600, computer system 101 (e.g., tablet, smartphone, wearable computer, or head mounted device) in FIG. 15I is configured in accordance with a first country 1538 setting, corresponding to a set of cultural norms associated with first country 1538. For example, in cultures associated with first country 1538, physical users are often situated within a first distance of another physical user when engaging with the other user. Accordingly, computer system 101 (e.g., tablet, smartphone, wearable computer, or head mounted device) determines a threshold corresponding to a representation of a participant that is the first distance (e.g., 0.1, 0.25, 0.5, 0.75, 1, 1.25, 1.5, or 2 m). For example, threshold 1542-1 is optionally centered on a position of representation 1510, threshold 1542-2 is centered on a position of representation 1512, and threshold 1542-3 is centered on a position of representation 1506 relative to three-dimensional environment 1502, respectively having radii that are the first distance. Because threshold 1542-1 intersects with threshold 1542-2, computer system 101 (e.g., tablet, smartphone, wearable computer, or head mounted device) optionally determines that the corresponding representations 1510 and 1512 are likely engaging with one another and/or otherwise associated with one another, and thus add representations 1510 and 1512 to first group 1507 in FIG. 15I. Similarly, because threshold 1542-1 and threshold 1542-3 intersect, computer system 101 (e.g., tablet, smartphone, wearable computer, or head mounted device) optionally determines that representation 1510 and representation 1506 are optionally engaging and/or otherwise associated with one another. In some embodiments, in accordance with a determination that first participants are not within a threshold of one another, and are both within a threshold of a respective participant, the first participants and the respective participant are included in a same group of participants. For example, first group 1507 includes representation 1512 and representation 1506, despite their respective thresholds not intersecting, because the threshold 1542-1 of representation 1510 respectively intersects with threshold 1542-2 and 1542-3. Additionally, representation 1550 is not included in the first group 1507 nor the second group 1509, in accordance with a determination that threshold 1542-5 associated with representation 1550 does not intersect with another threshold.

In some embodiments, groups are additionally or alternatively based on an orientation of participants. For example, second group 1509—comprising representation 1516 and representation 1518, and not representation 1514—optionally includes a similar arrangement as first group 1507 in FIG. 15I. For example, representation 1514, representation 1516, and representation 1518 have respective thresholds that intersect with at least one other threshold of another representation. Representation 1514, however, is oriented away from representation 1516 and representation 1518 (e.g., in head direction, where gaze is oriented, and/or where body direction); accordingly, computer system 101 (e.g., tablet, smartphone, wearable computer, or head mounted device) determines that representation 1514 is not engaging with representation 1516 and representation 1518, and accordingly does not include representation 1514 in second group 1509 in FIG. 15I. In FIG. 15I, input 1546 is detected by computer system 101, corresponding to a request to recenter representation 1504. In FIG. 15J, representation 1504 recenters to join the first group 1507, and not second group 1509, as described previously due to the relatively larger quantity of participants included in first group 1507 in response to the input 1546. In FIG. 15J, the updated position of representation 1504 is configured such that threshold 1542-4 that is associated with and centered on representation 1504 intersects with threshold 1542-2 and threshold 1542-3.

In FIG. 15K, elements of the real-time communication session relative to the viewpoint of representation 1504 is the same as illustrated in FIG. 15I, and the country setting described previously corresponds to a second country 1540, instead of the first country 1538. In some embodiments, individuals from cultures corresponding to the second country 1540 tend to engage with other individuals at relatively larger distances than in the first country 1538 (e.g., based on statistical data of such cultures). Accordingly, in accordance with a determination that the country settings corresponds to the second country 1540, computer system 101 (e.g., tablet, smartphone, wearable computer, or head mounted device) associates respective thresholds with respective participants that are relatively larger than the thresholds associated with the first country 1538. For example, the threshold 1544-1, threshold 1544-2, and threshold 1544-3, threshold 1544-4 and threshold 1544-5 are associated with representation 1510, representation 1512, representation 1506, representation 1504, and representation 1550 respectively, and are relatively larger than similar thresholds associated with the representations described with reference to FIG. 15I. Due to the relatively larger threshold 1544-5 associated with representation 1550 now intersects with threshold 1544-3 associated with representation 1506 (in contrast with threshold 1542-5 in FIG. 15I not intersecting with threshold 1542-3), thus, computer system 101 (e.g., tablet, smartphone, wearable computer, or head mounted device) determines that representation 1550 is associated with the first group 1507. In FIG. 15K, computer system 101 (e.g., tablet, smartphone, wearable computer, or head mounted device) detects input 1548, corresponding to a request a recentering of the viewpoint of representation 1504. In FIG. 15L, the viewpoint of representation 1504 updates in response to the input 1548 to correspond to the first group 1507, because it is relatively greater in quantity of participants than the second group 1509.

FIG. 16 is a flowchart illustrating a method of facilitating interaction with groups of spatial representations of participants of a communication session, in accordance with some embodiments of the disclosure. In some embodiments, the method 1600 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1600 is governed by instructions that are stored in a non-transitory computer-readable storage medium and that are executed by one or more processors of a computer system, such as the one or more processors 202 of computer system 101 (e.g., tablet, smartphone, wearable computer, or head mounted device) (e.g., control unit 110 in FIG. 1A). Some operations in method 1600 are, optionally, combined and/or the order of some operations is, optionally, changed.

In some embodiments, method 1600 is performed at a first computer system in communication with a display generation component and one or more input devices, such as computer system 101a (e.g., tablet, smartphone, wearable computer, or head mounted device) in communication with image sensors 314 and display generation component 120 in FIG. 1A. For example, the first computer system, the second computer system described further below, the display generation component, and the one or more input devices have one or more characteristics of the computer systems, display generation components, and the one or more input devices described with reference to methods 800, 1000, 1200, 1400, 1800, and/or 2000.

In some embodiments, while a three-dimensional environment, such as three-dimensional environment 101 in FIGS. 15A and 15A1, is visible via the display generation component from a current viewpoint of a user of the first computer system (e.g., a three-dimensional environment having one or more characteristics of the three-dimensional environments described with reference to methods 800, 1000, 1200, 1400, 1800, and/or 2000), such as a viewpoint of representation 1504, and while the user of the first computer system is in a real-time communication session including a plurality of participants including the user and a first participant (e.g., a real-time communication session having one or more characteristics of the real-time communication sessions described with reference to methods 800, 1000, 1200, 1400, 1800, and/or 2000), different from the user (e.g., a participant who is a user of a second computer system different from the first computer system), such as representations 1506-1518, the computer system displays (1602a), via the display generation component, a first spatial arrangement of elements of the real-time communication session including displaying a first visual representation of the first participant at a first location in the three-dimensional environment relative to the current viewpoint of the user, such as the spatial representation of the representations 1506-1518d displayed at respective locations relative to a viewpoint of representation 1504a in FIGS. 15A and 15A1. For example, the visual representation of the first participant has one or more characteristics of similar visual representations of other participants described with reference to methods 800, 1000, 1200, 1400, 1800, and/or 2000). For example, the visual representation of the first participant is optionally a virtual avatar displayed within a three-dimensional environment, wherein a virtual environment included in the three-dimensional environment is optionally shared (e.g., the first and the second computer system share a similar understanding of positions of similar virtual objects and/or avatars relative to a shared virtual environment). For example, the virtual environment includes a virtual scene, such as a simulated scene of a campground, a forest, a beach, a desert, an office, and/or a theater. In some embodiments, the first and the first participant participate in a real-time communication session and correspond to respective positions within the virtual environment, similar to as if the first and the first participant were placed in a shared physical environment. In some embodiments, to represent the position of another participant participating in the real-time communication session, the computer system displays a visual representation of the another participant at a corresponding location (e.g., the first visual representation of the first participant at the first location within the three-dimensional environment). It is understood that because the computer system displays elements including, but not limited to representation(s) of other participants and/or virtual content in the three-dimensional environment, there is at least a first spatial arrangement between the current viewpoint of the user and the elements of the real-time communication session, and included in the three-dimensional environment.

In some embodiments, the visual representation of the other participants is displayed with an orientation that corresponds to an orientation of the first participant of the second computer system relative to a three-dimensional environment that is visible via a second display generation component in communication with the second computer system. For example, the first participant is facing a head of a virtual table relative and, the first computer system has a current viewpoint directed toward the head of the virtual table, the first computer system optionally displays a virtual avatar representative of the first participant facing the head of the table. Similarly, the first computer system optionally communicates an indication of its current viewpoint relative to the three-dimensional environment of the first computer system, and the second computer system optionally displays a virtual avatar at a position and with an orientation relative to the three-dimensional environment of the second computer system corresponding to the current viewpoint of the first computer system. It is understood that dynamics of such representations (e.g., avatars) relative to current viewpoints of respective computer system optionally change in accordance with changes to the current viewpoints relative to their respective three-dimensional environment are optionally communicated, and displayed, by a recipient computer system, and that the first computer system optionally displays a plurality of virtual avatars with respective orientations and positions corresponding to viewpoints of respective participants of respective computer system corresponding the respective virtual avatars of the plurality of virtual avatars.

In some embodiments, while displaying the first visual representation of the first participant at the first location relative to the current viewpoint (and optionally while a spatial arrangement of the elements of the real-time communication session is the previously described first spatial arrangement relative to the current viewpoint of the user), the computer system detects (1602b) a first event corresponding to a request to reset a spatial distribution of one or more participants in the real-time communication session, such as an event including input 1501 in FIGS. 15A and 15A1. For example, the first event has one or more characteristics of the events described with reference to methods 800, 1000, 1200, 1400, 1800, and/or 2000. Such an event optionally includes detection of input and/or detection of an indication of input requesting a rearrangement of representations of participants participating in the real-time communication session, optionally while the first visual representation is displayed and included in the previously described first spatial arrangement relative to the current viewpoint of the user. In some embodiments, the event includes detecting and/or detecting a received indication that one or more criteria are satisfied (e.g., relative to attention of the user, relative to an operating system of the computer system and/or of another computer system in communication with the first computer system, relative to the first spatial arrangement of elements included in the real-time communication session, including but not limited to virtual representations of participants of the real-time communication session).

In some embodiments, in response to detecting the first event, the computer system displays (1602c) a respective updated spatial arrangement of elements of the real-time communication session relative to the current viewpoint of the user, such as a spatial arrangement of representations 1506-1518, including in accordance with a determination that one or more first criteria are satisfied, including a criterion that is satisfied when the plurality of participants are grouped in a first grouping arrangement (e.g., when the event is detected and/or while the spatial arrangement of elements of the real-time communication session is the first spatial arrangement), such as an arrangement of first group 1507 and second group 1509 as shown in FIGS. 15A and 15A1, displaying, from the current viewpoint of the user a first updated spatial arrangement of elements of the real-time communication session that is different from the first spatial arrangement of elements of the real-time communication session (e.g., an updated spatial arrangement that include displaying the first visual representation of the first participant at a first updated location relative to the current viewpoint of the user) (1602d), such as an arrangement of elements including the arrangement of representation 1506-1518 in FIG. 15B. In some embodiments, the first event is detected while the real-time communication session is ongoing. In some embodiments, the real-time communication session is ongoing and/or maintained while performing the operations described further below in response to detecting the first event. In some embodiments, in response to the first event, the computer system displays the elements of the real-time communication session with an updated spatial arrangement (e.g., the respective updated spatial arrangement) relative to the current viewpoint of the user that is different from the previously described first spatial arrangement. In some embodiments, the plurality of participants are arranged relative to the three-dimensional environment and/or relative to the current viewpoint of the user in one or more groups of participants of the real-time communication session (e.g., described further with reference to method 1800). Such groups of participants optionally include one or more participants, such as a pair of participants or a trio of participants that are relatively close together, are engaged in conversation, and/or associated with an entity, such as a family or a company. In some embodiments, the computer system determines an arrangement of such groups, such as how many groups there are, how many participants are included in a group, what region(s) of the three-dimensional environment the groups occupy and/or correspond to, a spatial distribution of participants of the group (e.g., the position and/or orientation of participants of the group relative to each other and/or the three-dimensional environment and/or relative to the current viewpoint of the user), and/or what one or more factors were used to determine the groups (e.g., proximity, head direction, eye direction, targets of attention, and/or ongoing conversations between participants of a group). For example, the first grouping arrangement optionally corresponds to a first plurality of participants arranged in a semi-circle in a first region of the three-dimensional environment, and a second plurality of participants arranged in a circle in a second region of the three-dimensional environment beyond a threshold distance (e.g., 0.1, 0.5, 1, 5, 10, 15, 20, 25, 30, 50, or 100 m) from the first region of the three-dimensional environment.

In some embodiments, the first event described herein includes a request to a recenter a viewpoint of the user to correspond to an updated position and/or orientation relative to the three-dimensional environment, such as to engage with a group of virtual avatars within the three-dimensional environment, and the computer system selects the updated viewpoint based on a “grouping arrangement” of the plurality of participants of the real-time communication session, such as an event including input 1501. In some embodiments, the grouping arrangement includes a spatial distribution of the participants relative to one another and/or the three-dimensional environment, such as an arrangement where groups of participants are relatively close together, and/or a spatial profile (e.g., shape) of groups of participants within the three-dimensional environment. It is understood that although the embodiments described herein are described with reference to arrangements, positions, and/or thresholds relative to participants participating in a real-time communication session, that similar operations and logic applies to representations of participants (e.g., avatars representing the participants) relative to the three-dimensional environment of the first computer system. In some embodiments, in response to the first event, the first computer system determines and/or receives an indication of a grouped arrangement of participants participating in the real-time communication session, and initiates a process to display elements of the real-time communication session with an updated spatial arrangement relative to the current viewpoint of the user. For example, optionally included in the process, the computer system updates the current viewpoint of the user at least partially based on a spatial arrangement and/or a total number of the participants, thereby displaying the elements of the real-time communication with the updated spatial arrangement relative to the current viewpoint of the user (e.g., with the first updated spatial arrangement). In some embodiments, the first computer system updates its current viewpoint based on a determined grouping of the participants to facilitate real-time communication with the other participants and/or the representations of the other participants to an updated position within the three-dimensional environment, referred to herein as a “viewpoint recentering destination.” For example, in response to the first event, in accordance with a determination that the plurality of participants is arranged in a circular or in a rounded arrangement relative to one another and the three-dimensional environment, such as the arrangement of first group 1507 in FIGS. 15A and 15A1, the first computer system optionally updates its current viewpoint to fill a vacancy within the circular or similar arrangement, facing the interior of the circle or the similar shape. Thus the viewpoint recentering destination is optionally the vacancy within the arrangement. As an additional example, in accordance with a determination that a first virtual avatar and a second virtual avatar are within a simulated threshold distance (e.g., 0.001, 0.01, 0.1, 1, 10 m) of one another in a first region of the three-dimensional environment, and a third virtual avatar is outside the threshold distance of both the first and the second avatars in a second region of the three-dimensional environment that is different from (e.g., does not include) the first region, the computer system determines that the grouped arrangement of the plurality of participants includes a first group—including the first and the second avatars—and a second group—including the third avatar. In response to the first event, the computer system optionally updates the current viewpoint of the user to mimic the user walking and/or teleporting to a position within and/or proximal to the first region that represents an improved position and/or orientation to communicate with the other participants. Described an additional way, the computer system determines a primary group of participants (e.g., the first group) based on a grouping arrangement of the plurality of representations of participants and determines a viewpoint recentering destination close to and/or based on the primary group. Thus, the computer system optionally displays elements within the real-time communication session—including but not limited to the plurality of representations of the participants and/or virtual content shared with the participants of the call—with an updated spatial arrangement relative to the current viewpoint of the user.

In some embodiments, the computer system displays representations of the other participants at updated positions and/or orientations to reflect the updated viewpoint of the user, such as an arrangement of first group 1507 and second group 1509 as shown in FIG. 15B. For example, in response to detecting a viewpoint recentering event including a selection of a physical or virtual button while a pair of virtual avatars are standing side-by-side and a relatively far apparent distance away from a current viewpoint of the user, the computer system optionally determines that a recentering destination at a position facing the pair of virtual avatars, changes the current viewpoint to match the recentering destination, and displays the virtual avatars side-by-side, and facing the current viewpoint of the user, similar as if the user walked through the three-dimensional environment to stand in front, and relatively centered with the pair of avatars. Thus, in some embodiments, in response to the first event, the first computer system translates and/or rotates representations of other participants participating in the real-time communication session, maintaining a spatial relationship between the plurality of other participants relative to the three-dimensional environment, and updating the displayed spatial. arrangement of elements in the real-time communication session relative to the current viewpoint of the user. In some embodiments, such changes in current viewpoint and the representations of other participants are animated gradually and/or performed concurrently; in some embodiments, such changes are animated with a fading out (e.g., a reducing of opacity of virtual content) from an initial viewpoint, and a subsequent fading in (e.g., an increasing of the opacity of the virtual content) at an updated viewpoint. It is understood that the animation(s) are optionally included in the displaying of the elements of the real-time communication session at an updated spatial arrangement relative to the current viewpoint (e.g., updated viewpoint) of the user.

It is understood that in some embodiments, the spatial arrangement and/or grouping arrangement of the plurality of participants participating in the real-time communication session optionally are known to and/or determined by the computer system prior to detecting the first event, and the rearranging of representations of the plurality of participants optionally occurs in response to the first event and considering the already-known and/or determined spatial and/or grouping arrangement.

In some embodiments, in response to detecting the first event, the computer system displays (1602c) a respective updated spatial arrangement of elements of the real-time communication session relative to the current viewpoint of the user, such as an arrangement of first group 1507 and second group 1509 as shown in FIG. 15B, including in accordance with a determination that the one or more first criteria are not satisfied, and that one or more second criteria, different from the one or more first criteria, are satisfied including a criterion that is satisfied when the plurality of participants are grouped in a second grouping arrangement, different from the first grouping arrangement, such as a grouping arrangement of representations 1506-1518 as shown in FIG. 15G, displaying, from the current viewpoint of the user, a second updated spatial arrangement of elements of the real-time communication session relative to the current viewpoint of the user that is different from the first spatial arrangement of elements of the real-time communication session and the first updated spatial arrangement of elements of the real-time communication session (e.g., an updated spatial arrangement that includes displaying the first visual representation of the first participant at a second updated location, different from the first updated location, relative to the current viewpoint of the user) (1602e), such as an updated spatial arrangement of participants 1506-1518 as shown in FIG. 15H. For example, turning back to the example of the first, second, and third virtual avatars described previously, in accordance with a determination that the first avatar is outside the previously described simulated threshold distance of the second avatar and the third avatar at the first region of the three-dimensional environment, and that the second avatar and third avatar are within the simulated threshold distance of each other at a second region of the three-dimensional environment, the computer system optionally determines that the second and third avatars form a primary group, and determines a viewpoint recentering destination within and/or near the second region to facilitate communication with the primary group. Thus, when displaying the first, second, and/or third virtual avatars relative to the current viewpoint, the computer system optionally displays such avatar(s) and/or other virtual content of the real-time communication session with a second updated spatial arrangement relative to the current viewpoint. Determining an updated viewpoint of the user based on grouping arrangement of a plurality of participants participating in a real-time communication session with the user reduces user input needed for moving the current viewpoint to a position and/or orientation that improves visibility of relevant representations of the plurality of participants, thereby improving efficiency of communication and reducing computing power required to process manual movement of the current viewpoint.

In some embodiments, the first event includes obtaining information that a number of the plurality of participants participating in the real-time communication session will change or have changed, such as information 1527 in FIG. 15C. For example, another computer system (e.g., of the participant and/or another participant of the real-time communication session) optionally joins and/or leaves the first communication session, and communicates an indication of the joining and/or leaving to the first computer system of the user. In response to detecting the first event, optionally includes detecting the indication, the first computer system optionally initiates the process to display the first updated spatial arrangement of elements of the real-time communication session. In some embodiments, the other computer system inadvertently leaves the communication session without communication such an indication, and the first computer system receives an indication of the inadvertent exiting. In some embodiments, a plurality of participants exit and/or join the call simultaneously and/or in rapid succession, and the computer system updates the spatial arrangement of elements of the real-time communication session in response to the plurality of participants exiting and/or joining. Updating the spatial arrangement of elements of the real-time communication session when one or more participants have and/or will join reduces user input required to display the elements at improved viewing positions and/or angles, thus reducing manual input required to manipulate the elements, and thereby reducing processing required to handle the manual input.

In some embodiments, detecting the first event includes detecting, via the one or more input devices, input provided by the user of the computer system, such as input 1501 detected as shown in FIGS. 15A and 15A1. For example, the first event optionally includes detecting input, such as input directed to a hardware control (e.g., circuitry) such as a selection of a button of the computer system, contact with a touch-sensitive surface in communication with the computer system, a voice command detected by the computer system, an air gesture detected by the computer system (e.g., an air pinching including contact of a plurality of fingers of the user, an air pointing of one or more fingers, and/or an air swiping of a hand and/or fingers of the user), and/or similar inputs directed to a selectable option and/or visual indication displayed by the computer system, and/or some combination of such input(s). In some embodiments, the input has one or more characteristics of inputs such as inputs resetting a spatial arrangement of elements described with reference to methods 800, 1000, 1200, 1400, 1800, and/or 2000. Updating the spatial arrangement of elements of the real-time communication session when the user provides input reduces user input required to manually update the spatial arrangement, thereby reducing processing required to handle the manual input.

In some embodiments, displaying the first spatial arrangement of elements of the real-time communication session further includes displaying a second visual representation of a second participant, different from the first visual representation of the first participant, at a second location, different from the first location, in the three-dimensional environment relative to the current viewpoint of the user, such as displaying representation 1510 at a position relative to a viewpoint of representation 1504 in FIG. 15B, and the first visual representation and the second visual representation have a respective spatial distribution before (e.g., and/or at a time when) the first event is detected relative to the current viewpoint of the user, such as a spatial distribution of representation 1510 and representation 1508 in FIGS. 15A and 15A1. For example, as described further with reference to methods 1400 and 1800. In some embodiments, the plurality of visual representations of participants are arranged in one or more groups. In some embodiments, a “group” of participants (e.g., of visual representations of participants) include one or more participants that are within a simulated threshold distance (e.g., 0, 0.001, 0.005, 0.05, 0.01, 0.05, 0.1, 0.5, 1, 1.5, or 3 m) of one another (at times, referred to herein as a threshold distance for convenience). In some embodiments, a group corresponds to a single participant that is not within the threshold distance of another participant. In some embodiments, a group corresponds to a pair of participants within the threshold distance of one another, and does not include a respective participant that is not within the threshold distance of a participant in the group. In some embodiments, a group corresponds to three or more participants, where respective participants are within the threshold distance of at least one other participant included in the group, and does not include a respective participant that is not within the threshold distance of a participant in the group.

In some embodiments, displaying the respective updated spatial arrangement of elements of the real-time communication session relative to the current viewpoint of the user includes, in accordance with a determination that the respective spatial distribution is a first spatial distribution, such as a spatial arrangement as shown in FIG. 15B, displaying, from the current viewpoint of the user a third updated spatial arrangement of elements of the real-time communication session, such as an arrangement of first group 1507 and second group 1509 as shown in FIG. 15C, that is different from the first spatial arrangement of elements of the real-time communication session, from the first updated spatial arrangement of elements of the real-time communication session, and from the second updated spatial arrangement of elements of the real-time communication session. For example, as described further with reference to methods 1400 and 1800. In some embodiments, the first spatial distribution includes a first group, a second group, and/or one or more additional groups. In some embodiments, a respective spatial distribution includes to a number of groups, a number of participants include in the groups, an arrangement (e.g., spatial profile, position, and/or orientation) of the groups relative to the current viewpoint of the user and/or the three-dimensional environment, and/or an arrangement of the participants of respective groups relative to one another.

In some embodiments, displaying the respective updated spatial arrangement of elements of the real-time communication session relative to the current viewpoint of the user includes, in accordance with a determination that the respective spatial distribution is a second spatial distribution, different from the first spatial distribution, such as a spatial distribution as shown in FIG. 15G, displaying, from the current viewpoint of the user a fourth updated spatial arrangement of elements of the real-time communication session, such as a spatial arrangement of representations as shown in FIG. 15H, that is different from the first spatial arrangement of elements of the real-time communication session, from the first updated spatial arrangement of elements of the real-time communication session, from the second updated spatial arrangement of elements of the real-time communication session, and from the third updated spatial arrangement of elements of the real-time communication session. For example, as described further with reference to methods 1400 and 1800. Thus, in some embodiments, the computer system updates the spatial arrangement of elements of the real-time communication session in accordance with a spatial distribution including a simulated vacancy (e.g., “gap”) corresponding to a respective spatial distribution of the plurality of representations of participants. Determining an updated arrangement of the plurality of visual representations of participants in accordance with a respective spatial distribution of visual representations of participants when the first event is detected reduces user input to assume a similar updated arrangement, and improves the likelihood that visual representations of participants are displayed at easily viewable and/or interactable positions relative to the user viewpoint, thereby reducing processing required to handle such user input.

In some embodiments, the plurality of participants includes a first number of a first plurality of visual representations of participants arranged in a first group, such as quantity of representations and the representations included in first group 1507 in FIGS. 15A and 15A1, and includes a second number, different from the first number, of a second plurality of visual representations, different from the first plurality of visual representations, of participants arranged in a second group, different from the first group, such as quantity of representations and the representations included in second group 1509 in FIGS. 15A and 15A1, before the first event is detected. For example, the computer system optionally determines one or more groups of participants, such as the group(s) described with reference to method 1400 and above. In some embodiments, the computer system updates the spatial arrangement of elements of the real-time communication session such that the current viewpoint joins a largest group in the real-time communication session. It is understood that description herein of the current viewpoint “joining” a group corresponds to embodiments where the visual representations of participants of the real-time communication session are displayed at updated position relative to the current viewpoint of the user having a spatial arrangement relative to one another that is the same as a spatial arrangement of the visual representations of participants before an event (e.g., a recentering-based event, such as the first input) is detected. For example, the relative spatial arrangement of the elements of the real-time communication session relative to one another is maintained before and after the first event is detected, and are displayed at updated position and/or orientations in response to the first event to reflect a scenario in which the current viewpoint of the user moved to a respective position relative to the largest group (e.g., to fill a gap in the largest group, described further with reference to method 1800), optionally while a position and/or orientation of the current viewpoint relative to the three-dimensional environment is maintained.

In some embodiments, the one or more first criteria include a criterion that is satisfied when the first number is greater than or equal to the second number, such as when first group 1507a is equal in number to second group 1509a in FIGS. 15A and 15A1. For example, in accordance with a determination that the first group is larger than the second group, the elements of the real-time communication session including plurality of participants are displayed at updated positions and/or orientations relative to the current viewpoint such that the current viewpoint is relatively closer to and oriented toward the one or more participants of the first group than to one or more participants of the second group.

In some embodiments, the one or more second criteria include a criterion that is satisfied the first number is less than the second number, such first group 1507 and second group 1509 as shown in FIG. 15H. For example, in accordance with a determination that the second group is larger than the first group, the elements of the real-time communication session including plurality of participants are displayed at updated positions and/or orientations relative to the current viewpoint such that the current viewpoint is relatively closer to the second group than the first group. Updating the elements of the real-time communication such that the current viewpoint is closer to the relatively largest group reduces the likelihood that the current viewpoint is closest to a relatively less interactive group of participants, thus reducing user input required to change the current viewpoint to join the largest group and thereby reducing processing required to detect and process such user input.

In some embodiments, a distance between the current viewpoint of the user and the first group is a first distance, before the first event is detected, such as distance 1522 in FIGS. 15A and 15A1. For example, the distance is optionally a simulated distance between the current viewpoint and the first group corresponds to a simulated distance between a participant in the first group that is closest to the current viewpoint and the current viewpoint, between a participant in the first group that is furthest away from the current viewpoint in the group and the current viewpoint, and/or between a location associated with the first group (e.g., a center, a point along an outer edge of a shape intersecting with the participants, and/or a calculated location determined based on the distribution of the participants of the first group relative to one another). At times herein, simulated distances are referred to as distances for convenience, dependent upon the context of description. For example, distances between visual representations of participants optionally correspond to a simulated distances between such visual representation representations having a shared spatial arrangement.

In some embodiments, a distance between the current viewpoint of the user and the second group is a second distance, different from the first distance, before the first event is detected, such as distance 1520 in FIGS. 15A and 15A1. For example, the second group is the second distance, similar to as described with reference to the first distance and the first group, relative to the participants of the second group.

In some embodiments, the one or more first criteria include a criterion that is satisfied when the first number and the second number are equal, and include a criterion that is satisfied when the first distance is less than the second distance, such as shown in FIGS. 15A and 15A1 relative to the first group 1507 and second group 1509. For example, the computer system optionally determines and/or receives determination that there are two or more groups of participants having a same number of participants, optionally larger than a number of participants of other groups. In some embodiments, the one or more first criteria include a criterion that is satisfied when the number of participants in the first group is equal to a number of participants of another group (e.g., the second group, and/or additional other groups). In some embodiments, the computer system uses a determination that one or more tiebreaker criteria are satisfied to determine whether the elements of the real-time communication session are updated such that the current viewpoint joins (as described above) a first group or joins the second group. For example, the one or more first criteria include a tiebreaker criterion that is satisfied a distance between the current viewpoint and the first group is less than a distance between the current viewpoint and the second group.

In some embodiments, the one or more second criteria include a criterion that is satisfied when the first number and the second number are equal, and include a criterion that is satisfied when the second distance is less than the first distance, such as similar to as shown in FIGS. 15A and 15A1 relative to the first group 1507 and second group 1509, if distance 1522 was greater than distance 1520. For example, the one or more second criteria additionally include a criterion satisfied when the second group is equally in number of participants to other one or more groups, such as the first group, and a distance-based tiebreaking criterion that is satisfied when a distance between the current viewpoint and the second group is less than a distance between the current viewpoint and the first group when the first event is detected. Changing the arrangement of elements of the real-time communication session to correspond to a relatively closer group of participants when the size of groups of participants are a same size reduces decision making required by the user, and reduces inputs required to move the user viewpoint toward a closer group, thereby reducing cognitive burden of the user and processing required to handle the user inputs.

In some embodiments, displaying the respective updated spatial arrangement of the elements of the real-time communication session relative to the current viewpoint of the user further includes (For example, described with reference to step(s) 1602 of method 1600 above), in accordance with the determination that attention of the user is directed to the first group independent of whether the first group is larger than the second group and independent of whether the first group is closer to the viewpoint of the user than the second group when the first event is detected, such as if representation 1504 were directed toward first group 1507 in FIG. 15D, displaying, from the current viewpoint of the user, a third updated spatial arrangement of elements of the real-time communication session that is different from the first spatial arrangement of elements of the real-time communication session, and that is different from the second updated spatial arrangement of elements of the real-time communication session, such as a spatial arrangement relative to a viewpoint of representation 1504 joining first group 1507 in FIG. 15E. In some embodiments, the computer system determines the updated spatial arrangements of elements in the real time communication session using attention-based tiebreaking criteria as an overriding factor, such that recentered elements of the real-time communication are based on attention of the user, and is independent of the size of respective groups and/or the distance of respective groups (e.g., a simulated distance as described previously). For example, the computer system optionally determines that a second group of participants, as described previously, is relatively closer to the current viewpoint of the user and/or is relatively larger than or equal to a first group of participants, also as described previously. In some embodiments, attention being directed to a first group and/or a second group refers to a position and/or orientation of attention of the user relative to portions of the three-dimensional environment. For example, the computer system optionally determines a vector extending from the current viewpoint of the user (e.g., from the eyes of the user, from the head of the user, and/or from the torso of the user), and in accordance with a determination that the vector intersects with, passes through, and/or is within a threshold distance (e.g., a simulated distance 0.001, 0.005, 0.01, 0.05, 0.1, 0.5, or 1 m) of a position of the three-dimensional environment including a portion of a participant, the computer system determines attention of the user as corresponding to the participant. In some embodiments, attention of the user is determined in accordance with a determination that within a threshold amount of time (e.g., 0.5, 1, 2.5, 5, 10, 15, 30, or 60 seconds) that attention of the user corresponded to one or more participants of a group of participants for a duration of time greater than a duration of time the attention of the user corresponded to one or more participants of alternative group(s). In response to detecting the first event, and in accordance with the determination that attention of the user is directed to the first group of participants when the first event is detected, the computer system optionally displays the updated spatial arrangement of elements of the real time communication system including the first group and the second group, closer to and/or oriented toward the first group. In such an embodiment, if attention of the user was not directed to the first group when the first event was detected, the computer system updates the spatial arrangement such that the current viewpoint is relatively closer to and/or oriented toward the second group, rather than the first group. In some embodiments, the attention of the user is not directed toward the first group when the first event is detected, was last-directed to the first group (without being directed to another group), was directed to the first group within a threshold amount of time (e.g., 0.05, 0.1, 0.5, 1, 5, 10, 30, or 60 seconds) of when the first event is detected, and/or was directed to the first group for a period of time within the threshold amount of time that is greater than was directed to alternative one or more groups for respective periods of time; in such one or more embodiments, the computer system recenters the current viewpoint of the user to correspond to the first group, similar or the same to as if the attention of the user was directed to the first group when the first event was detected. In some embodiments, attention of the user being directed to a respective group of participants includes attention of the user being directed to a portion of a visible three-dimensional environment that corresponds to a location of a visual representation of a participant, and/or within a simulated threshold distance of the visual representation of the participant (e.g., 0.05, 0.1, 0.5, 1, 2.5, or 5 m), and/or within the simulated threshold distance of a spatial profile (e.g., shape) of the respective group of participants, such as a border of a shape corresponding to a determined shape of the respective group. Additional details concerning the manner of updating the current viewpoint of the user and/or the spatial arrangement elements to be closer to and/or oriented toward participants (e.g., groups of participants) are described further with reference to method 1800.

In some embodiments, displaying the respective updated spatial arrangement of the elements of the real-time communication session relative to the current viewpoint of the user further includes (for example, described with reference to step(s) 1602 of method 1600 above), in accordance with the determination that attention of the user is directed to the second group, such as shown by representation 1504 directed toward second group 1509 in FIG. 15D, independent of whether the second group is larger than the first group and independent of whether the second group is closer to the viewpoint of the user than the first group when the first event is detected, displaying, from the current viewpoint of the user, a third updated spatial arrangement of elements of the real-time communication session that is different from the first spatial arrangement of elements of the real-time communication session, and that is different from the second updated spatial arrangement of elements of the real-time communication session, such as a spatial arrangement relative to representation 1504 in FIG. 15H. For example, the computer system recenters the current viewpoint of the user (e.g., updates a spatial arrangement of elements in the real time communication session) similar to as described with reference to attention being directed and/or recently directed to the first group when the first event is detected, relative to attention being directed to the second group of participants (e.g., that are relatively further from the current viewpoint and/or smaller than the first group and/or other groups of participants when the first event is detected). Using attention to change a prospective recentering destination of the current viewpoint of the user, overriding one or more other criteria such as distance of a group and/or size of a group, that are otherwise used to determine the prospective recentering destination provides additional flexibility in recentered arrangements of elements of the real-time communication session, thus reducing user input required to manually rearrange the elements in accordance with the user's preferences, thereby reducing processing required to handle the user input.

In some embodiments, the plurality of participants include a first plurality of visual representations of participants arranged in a first group displayed at a first distance from the current viewpoint, such as first group 1507 relative to representation 1504 in FIGS. 15A and 15A1 at distance 1522, and include a second plurality of visual representations of participants, different from the first plurality of visual representations, arranged in a second group, different from the first group, displayed at second distance from the current viewpoint, before the first event is detected, such as second group 1509 relative to representation 1504 in FIGS. 15A and 15A1 at distance 1520. For example, the first and/or second groups of participants as described previously displayed at respective distances (e.g., simulated distances as described previously) from the current viewpoint before and/or when the first event is detected.

In some embodiments, the one or more first criteria include a criterion that is satisfied when the first distance is less than the second distance, such as distance 1524 relative to distance 1526 in FIG. 15D. For example, as described previously, distance between the current viewpoint and a respective group optionally is used as a criterion to determine where the current viewpoint recenters to, such as to a closest group relative to the current viewpoint when the first input is received. As described previously, such distance-based criteria optionally are a tie-breaking criteria, used to determine which group the current viewpoint will recenter toward in accordance with a determination that multiple groups satisfy one or more criteria, (e.g., a criterion satisfied when a quantity of participants in a respective group are greater than or equal other groups in the real-time communication session). In some embodiments, such distance-based criteria are included in the one or more first criteria, without including a criterion satisfied when a quantity of participants in the first group is greater than or equal to a quantity of participants in the second group. For example, the computer system optionally recenters the current viewpoint of the user (and/or updates the spatial arrangement of elements of the real-time communication session to mimic such changes of the current viewpoint, while maintaining a position and/or orientation of the current viewpoint) to correspond to the first group when the first distance of the first group is less than the second distance of the second group, in response to detecting the first event.

In some embodiments, the one or more second criteria include a criterion that is satisfied when the second distance is less than the first distance, such as if distance 1524 was greater than distance 1526 in FIG. 15D. For example, the computer system optionally recenters the current viewpoint of the user (and/or updates the spatial arrangement of elements of the real-time communication session to mimic such changes of the current viewpoint, while maintaining a position and/or orientation of the current viewpoint) to correspond to the second group when the second distance of the second group is less than the first distance of the first group, in response to detecting the first event. Changing the arrangement of elements of the real-time communication session to correspond to a relatively closer group of participants reduces decision making required by the user and inputs required moving the user viewpoint toward a closer group, thereby reducing cognitive burden of the user and processing required to handle the user inputs.

In some embodiments, attention of the user is directed to a position within the three-dimensional environment when the first event is detected, such as attention corresponding to representation 1504 in FIG. 15D directed to second group 1509. For example, attention of the user has one or more characteristics described previously with respect to attention of a participant, such as gaze of the user, a direction of a head of the user, and/or a position of a body of the user.

In some embodiments, the plurality of participants includes a first plurality of visual representations of participants arranged in a first group, such as first group 1507 in FIG. 15D, and includes a second plurality of visual representations, different from the first plurality of visual representations, of participants arranged in a second group, different from the first group, before the first event is detected, such as second group 1509 in FIG. 15D. For example, the first and/or second groups described previously.

In some embodiments, the one or more first criteria include a criterion that is satisfied when the position of the attention when the first event is detected corresponds to the first group, such as attention of representation 1504 were directed to the first group 1507 in FIG. 15C. For example, as described previously, attention of the user optionally is directed to one or more portions of the three-dimensional environment, optionally corresponding to the first group, when the first event is detected. In such examples, the current viewpoint is recentered to correspond to (e.g., and/or the elements of the real time communication session are displayed at updated positions and orientations relative to the current viewpoint) the first group such the current viewpoint is relatively closer to and/or oriented toward the first group, compared to other groups of participants.

In some embodiments, the one or more second criteria include a criterion that is satisfied when the position of the attention when the first event is detected corresponds to the second group, such as attention of representation 1504 directed to the second group 1509 in FIG. 15D. For example, as described previously, attention of the user optionally is directed and/or corresponds to one or more portions of the three-dimensional environment, optionally corresponding to the second group, when the second event is detected. In such examples, the current viewpoint is recentered to correspond to (e.g., and/or the elements of the real time communication session are displayed at updated positions and orientations relative to the current viewpoint) the second group such the current viewpoint is relatively closer to and/or oriented toward the second group, compared to other groups of participants. Using attention to change a prospective recentering destination of the current viewpoint of the user provides flexibility in recentered arrangements of elements of the real-time communication session, thus reducing user input required to manually rearrange the elements in accordance with the user's likely targets of interaction, thereby reducing processing required to handle the user input.

In some embodiments, while the three-dimensional environment is visible via the display generation component from the current viewpoint of the user, such as viewpoint of representation 1504a in FIGS. 15A and 15A1, while the user is in the real-time communication session, the computer system displays, via the display generation component, a plurality of visual representations of participants, including the first visual representation, wherein respective visual representations of the plurality of visual representations have respective orientations relative to the current viewpoint of the user, displayed at respective positions, the respective positions within a threshold distance of a line extending between the plurality of visual representations of the participants, when the event is detected, such as a line extending between a plurality of representations 1506-1518 that are displayed in FIG. 15D. For example, as described previously with reference to method 1400, and/or described with reference to method 1800, corresponding to a simulated distance to a line.

In some embodiments, the one or more first criteria include a criterion that is satisfied when the respective orientations are within a first range of orientations relative to the current viewpoint when the first event is detected, such as a range of orientations of first group 1507 in FIGS. 15A and 15A1, if such representations included in first group 1507 were arranged in a line, and oriented toward a first side of the line. For example, as described further with reference to methods 1400 and/or 1800, the computer system optionally recenters the current viewpoint of the user (e.g., updates spatial arrangement of elements in the real time communication session relative to the current viewpoint) to correspond to a first side or a second side of the line extending between the visual representations of participants (e.g., a straight line between two or more participants, and/or a curved line extending through three or more participants). In response to the first event, the computer system optionally displays the elements of the real-time communication session, such that the current viewpoint remains on a side of the line extending through the participants before and after the first event is detected, as described further with reference to method 1400. In some embodiments, the side of the line that the current viewpoint is oriented to in response to detecting the first event is dependent upon an orientation of the participants relative to the line. For example, in accordance with a determination that attention of the participants and/or the visual representations of participants correspond to a first side of the line (e.g., because a greater number of participants of a group of participants arranged in the line have attention directed toward a position on the first side of the line than toward positions on the second side of the line, because a particular participant has their attention directed toward a position on the first side of the line, and/or because the orientation of portions of the participants are within a threshold range of orientations relative to the line (e.g., 0, 15, 30, 45, 60, 75, or nearly 90 degrees of one or more vectors extending normal and/or perpendicular to the line)), the computer system recenters the current viewpoint to correspond to the first side of the line.

In some embodiments, the one or more second criteria include a criterion that is satisfied when the respective orientations are within a second range of orientations relative to the current viewpoint when the first event is detected, such as a range of orientations of first group 1507 in FIGS. 15A and 15A1, if such representations included in first group 1507 were arranged in a line, and oriented toward a second side of the line. For example, similar to as described with respect to the first side of the line, but relative to a second side of the line. Updating the spatial arrangement of elements of the computer system to correspond to a respective grouping arrangement in accordance with satisfaction of criteria based on orientations of participants relative to the current viewpoint of the user reduces the likelihood that the current viewpoint is displayed at a disadvantageous position and/or orientation to interact with the participants, thus reducing user input required to assume such a current viewpoint and thereby processing required to handle such user input.

In some embodiments, while the three-dimensional environment is visible via the display generation component from the current viewpoint of the user, while the user is in the real-time communication session, the computer system displays, via the display generation component, a plurality of visual representations of participants, including the first visual representation, before the first event is detected, such as representation 1506-1518 that are displayed, as shown in FIG. 15I. For example, as described above.

In some embodiments, the first grouping arrangement includes a respective arrangement in which the first visual representation of the first participant is within a threshold distance of a second visual representation of a second participant of the real-time communication session, such as representation 1506 relative to representation 1510 in FIG. 15I, and a third visual representation of a third participant of the real-time communication session is not within the threshold distance (e.g., 0.05, 0.1, 0.5, 1, 1.5, 2, or 3 m) of the first visual representation or the second visual representation, such as representation 1550 in FIG. 15I relative to the representations 1506 and 1510 in FIG. 15I. For example, as described above, the respective arrangement of a group of participants optionally includes a relative spatial arrangement of participants of the group. In some embodiments, the computer system determines participants correspond to a same group in accordance with the determination that the participants are within a threshold distance (e.g., simulated threshold) of at least another participant included in the group, such as the first and the second participant, not including the third participant. Thus, a grouping arrangement includes a position of the participants of the group relative to one another that are within a threshold distance of at least one other participant. In some embodiments, the grouping arrangement changes in response to detecting movement of the participants to updated positions within the three-dimensional environment, that are updated to be within the threshold distance of a first group and/or that are updated to be outside of the threshold distance of the first group. For example, in accordance with a determination that the third participant moves within the threshold distance of the first participant and/or of the second participant, the computer system optionally determines that the grouping arrangement is a third group arrangement, different from the first grouping arrangement and/or the second arrangement (described below). Similarly, in accordance with a determination that a new participant joins the real-time communication session within the threshold distance of participants of the first group, and/or a in accordance with a determination that a participant included in the group has exited the group, the computer system determines that the grouping arrangement is different from the first grouping arrangement. In some embodiments, when an intervening participant (e.g., the third participant that is within the threshold distance of the first participant and the second participant, while the first and second participants are not within the threshold distance of each other) moves outside a threshold distance of another participant (e.g., the first participant and/or the second participant), the grouping arrangement changes, similar to removing a link in a link of chains.

In some embodiments, the second arrangement includes a respective arrangement in which the first visual representation of the first participant is within a threshold distance of the third visual representation of the third participant of the real-time communication session, and the second visual representation of the second participant of the real-time communication session is not within the threshold distance of the first visual representation or the third visual representation, such as the relative arrangement of representation 1510, relative to representation 1506 and representation 1512 in FIG. 15I. For example, the second grouping arrangement includes a group comprising the first and the third participant, not including the second participant. Determining an arrangement based on position of participants within threshold distances of one another improves the likelihood that the user viewpoint is updated to a perspective that facilitates interaction with participants that are related to one another, thus reducing user input required to manually identify and/or change the viewpoint and thereby processing required for the user input.

In some embodiments, the threshold is based on a cultural user setting associated with an operating system of the first computer system, such as first country 1538 in FIG. 15I. In some embodiments, the real time communication session and or the first computer system are associated with one or more cultural user settings. The cultural user settings, for example, optionally include a country that participants of the real time communication session are included in, and/or a region of the world the participants are from. For example, the first computer system optionally designates that it is associated with a first country, corresponding to a first set of cultural norms, such as an expected social distance of other participants of the real time communication session. Accordingly, the threshold distance used to determine which participants of the real time communication session are included in a given group is a first threshold distance (e.g., 0.05, 0.1, 0.5, 1, 1.5, 2, 3, or 5 m). In accordance with the determination that the first computer system optionally designates that it is associated with the second country, corresponding to a second set of cultural norms, the threshold distance is optionally a second threshold distance different from (e.g., greater or less than) the first threshold distance (e.g., 0.01, 0.05, 0.1, 0.5, 1, 1.5, 2, or 3). In some embodiments, values of thresholds based on cultural norms are based on one or statistical observations of behavior in corresponding cultures and/or countries associated with the cultural norms. Determining the threshold in accordance with a cultural user setting reduces the likelihood that the user misconstrues participants of the real time communication session as grouped together based on it's a set of cultural norms delete that a set of cultural norms different from the users expected set of cultural norms, thereby reducing cognitive burden and discomfort of the user.

In some embodiments, the first grouping arrangement further includes a fourth visual representation of a fourth participant, that is within the threshold distance of the first visual representation, and not within the threshold distance of the second visual representation and not within the threshold distance of the third visual representation, such as representation 1512 whose threshold 1542-2 is within threshold 1542-1 of representation 1510, and not within threshold 1542-3 associated with representation 1506 in FIG. 15I. In some embodiments, the first participant that is not within a simulated threshold distance of a second participant, and is within the simulated threshold distance of a third participant, or included in a same group as the second participant, in accordance with the determination that the third participant is within the simulated threshold distance of the second participant. For example, the computer system optionally determines a chain proximity linking a plurality of participants to a same group of participants when the respective participants are within the simulated threshold distance of at least one other participant of the same group, as described previously. Determining an arrangement based on position of participants within threshold distances of one another improves the likelihood that the user viewpoint is updated to a perspective that facilitates interaction with participants that are related to one another, such as participants that are spread apart as a whole, but relatively close to and/or in communication with at least one other participant of a group, thus reducing user input required to manually identify and/or change the viewpoint and thereby processing required for the user input.

In some embodiments, displaying, via the display generation component, the first spatial arrangement of elements of the real-time communication session further includes displaying a plurality of visual representations of participants of the real-time communication session, including the first visual representation of the first participant, including a second visual representation, different from the first visual representation, of a second participant of the real-time communication session, different from the first participant, and including a third visual representation, different from the first visual representation and the second visual representation, of a third participant of the real-time communication session, different from the first participant and the second participant, wherein the plurality of visual representations have respective orientations relative to the current viewpoint of the user before the first event is detected, such as representations 1514-1518 having respective orientations as shown in FIG. 15I. For example, as described previously the computer system optionally displays a plurality of representations of participants that are participating in the real time communications session, the participants having respective orientations relative to the current viewpoint, including an orientation of one or more portions of the visual representations such as and orientation of a head and or body of the visual representations relative to the current viewpoint. In some embodiments, the orientation of such portions is used as factors to determine a grouping arrangement of participants in the real time communication session, such as the orientations of heads of the participants, as described previously.

In some embodiments, the first grouping arrangement includes a respective arrangement in which the first visual representation has a first relative orientation relative to the second visual representation that is within a threshold range of orientations, such as an orientation of representation 1516 relative to representation 1518 as shown in FIG. 15I. For example, the computer system optionally determines an angle extending between vector extending from a portion of the first visual representation (e.g., a head, outward from a face of the first visual representation) parallel to a floor of the three-dimensional environment relative to another vector extending from the portion of the second visual representation parallel to a floor of the three-dimensional environment (e.g., a head, outward from a face of the second visual representation). In accordance with a determination that the angle is within a threshold angle (e.g., 5, 15, 30, 45, 60, 75, 90, or 120 degrees), the computer system optionally determines that the first visual representation is grouped with the second visual representation, indicating that that the respective arrangement is the grouping arrangement. In accordance with a determination that the angle is not within the threshold angle, the first and second visual representations are not within a same group, thus indicating that the respective arrangement is a different grouping arrangement (e.g., a second grouping arrangement). In some embodiments, similar angles and/or comparisons are drawn between at least one other visual representation of a group to determine whether respective participants are in the same group, and the orientations and/or angles of multiple participants are used to determine groups, and accordingly, what grouping arrangement the respective arrangement corresponds to.

In some embodiments, the second grouping arrangement includes a respective arrangement in which the first relative orientation of the first visual representation relative to the second visual representation is not within the threshold range of orientations, such as an orientation of representation 1514 relative to representation 1516 in FIG. 15I, and a second relative orientation of the first visual representation relative to the third visual representation is within the threshold range of orientations, such as an orientation of representation 1516 relative to representation 1518 in FIG. 15J. For example, in accordance with a determination that the first visual representation is within the threshold angle of the third visual representation, the computer system optionally determines that the first visual representation and the third visual representation are grouped together, not including the second visual representation in accordance with a determination that the second visual representation is also not within the threshold angle of the third visual representation. Thus, the grouping arrangements are optionally based on orientations of participants, relative to one another. Determining a grouping arrangement in accordance with a determination an orientation of visual representations improves the likelihood that the user viewpoint is updated to a perspective that facilitates interaction with participants that are related to one another, such as participants that are facing toward a similar position in the three-dimensional environment, thus reducing user input required to manually identify and/or change the viewpoint and thereby processing required for the user input. It should be understood that the particular order in which the operations in method 1600 have been described is merely exemplary and is not intended to indicate that the described order is the only order in which the operations could be performed. One of ordinary skill in the art would recognize various ways to reorder the operations described herein.

FIGS. 17A-17P illustrate examples of a computer system facilitating updates of a spatial arrangement of participants in a real-time communication session in a three-dimensional environment based on a spatial distribution of the participants in accordance with some embodiments.

FIG. 17A illustrates a computer system 101 (e.g., tablet, smartphone, wearable computer, or head mounted device) (e.g., an electronic device) displaying, via a display generation component (e.g., display generation component 120 of FIG. 1 such as a computer display, touch screen, or one or more display modules of a head mounted device), a three-dimensional environment 1702 (e.g., an AR, AV, VR, MR, or XR environment) from a viewpoint of the user of the computer system 101 (e.g., tablet, smartphone, wearable computer, or head mounted device) (e.g., facing the back wall of the physical environment in which computer system 101 (e.g., tablet, smartphone, wearable computer, or head mounted device) is located). In some embodiments, computer system 101 (e.g., tablet, smartphone, wearable computer, or head mounted device) includes a display generation component (e.g., a computer display, touch screen, or display module of a head mounted device) and a plurality of image sensors (e.g., image sensors 314 of FIG. 3). The image sensors optionally include one or more of a visible light camera, an infrared camera, a depth sensor, or any other sensor the computer system 101 (e.g., tablet, smartphone, wearable computer, or head mounted device) would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user).

As shown in FIG. 17A, computer system 101 (e.g., tablet, smartphone, wearable computer, or head mounted device) captures one or more images of the physical environment around computer system 101 (e.g., tablet, smartphone, wearable computer, or head mounted device) (e.g., operating environment 100), including one or more objects in the physical environment around computer system 101. In some embodiments, computer system 101 (e.g., tablet, smartphone, wearable computer, or head mounted device) displays representations of the physical environment in three-dimensional environment 1702 (e.g., an AR, AV, VR, MR, or XR environment). For example, three-dimensional environment 1702 includes a representation of a coffee table 1722, which is optionally a representation of a physical coffee table in the physical environment. As shown in the schematic view of the three-dimensional environment 1702, the physical environment also includes a potted plant 1724, which is not currently visible in the three-dimensional environment 1702 from the current viewpoint of the user of the computer system 101.

In FIG. 17A, three-dimensional environment 1702 also includes one or more virtual objects. For example, as shown in FIG. 17A, the computer system 101 (e.g., tablet, smartphone, wearable computer, or head mounted device) is displaying virtual object 1726 in the three-dimensional environment 1702. In some embodiments, the virtual object 1726 is or includes one or more of user interfaces of an application (e.g., an application running on the computer system 101) containing content (e.g., quick look windows displaying photographs, playback user interface displaying content, and/or web-browsing user interface displaying text), three-dimensional objects (e.g., virtual clocks, virtual balls, and/or virtual cars) or any other element displayed by computer system 101 (e.g., tablet, smartphone, wearable computer, or head mounted device) that is not included in the physical environment of display generation component 120.

In some embodiments, the user of the computer system 101 (e.g., tablet, smartphone, wearable computer, or head mounted device) is participating in a real-time communication session with a plurality of users. Details regarding the real-time communication session are provided below with reference to method 1800. In the example of FIG. 17A, the user of the computer system 101 (e.g., tablet, smartphone, wearable computer, or head mounted device) is in the real-time communication session with a first participant (e.g., a second user of a second computer system) and a second participant (e.g., a third user of a third computer system). In some embodiments, as shown in FIG. 17A, while the user of the computer system 101 (e.g., tablet, smartphone, wearable computer, or head mounted device) is in the real-time communication session with the first participant and the second participant, the computer system 101 (e.g., tablet, smartphone, wearable computer, or head mounted device) displays a first visual representation 1706 of the first participant and a second visual representation 1708 of the second participant in the three-dimensional environment 1702. Details regarding the first visual representation 1706 and the second visual representation 1708 are provided below with reference to method 1800. Referring to the schematic view of the three-dimensional environment 1702 in FIG. 17A, the user of the computer system 101 (e.g., tablet, smartphone, wearable computer, or head mounted device) (and thus the viewpoint of the user) is represented by representation of user 1704.

In some embodiments, while the user of the computer system 101, the first participant, and the second participant are in the real-time communication session, the viewpoint of the user of the computer system 101, the first visual representation 1706, and the second visual representation 1708 have a first spatial arrangement 1718a within the three-dimensional environment. For example, as shown in the schematic view of the three-dimensional environment 1702 in FIG. 17A, the first visual representation 1706 is located at a first location relative to the viewpoint of the user 1704 and the second visual representation 1708 is located at a second location, different from the first location, relative to the viewpoint of the user 1704. In some embodiments, as shown in the schematic view of the three-dimensional environment 1702 in FIG. 17A, a (e.g., estimated/calculated) center 1719 of the first spatial arrangement 1718a is determined based on the locations of and/or distances and/or angles between the viewpoint of the user 1704, the first visual representation 1706, and the third visual representation 1710. Additionally, in some embodiments, while the user of the computer system 101, the first participant, and the second participant are in the real-time communication session, the viewpoint of the user of the computer system 101, the first visual representation 1706, and the second visual representation 1708 have a first spatial distribution in the three-dimensional environment 1702. For example, the first visual representation 1706 is located a first distance from the viewpoint of the user and the second visual representation 1708 is located a second distance from the viewpoint of the user. In some embodiments, the location of the viewpoint of the user 1704 is selected to be a location that is offset from a center of a line between the first visual representation 1706 and the second visual representation 1708 (e.g., in a triangular spatial arrangement).

In the schematic view of the three-dimensional environment 1702 of FIG. 17A, the physical environment of the display generation component 120 (and thus the physical environment of the user of the computer system 101) is bounded/represented by rectangle 1700. For example, within the rectangle 1700, the locations of any physical objects in the physical environment and/or orientations of any physical objects, such as the coffee table 1722 and the potted plant 1724, relative to the viewpoint of the user of the computer system 101 (e.g., tablet, smartphone, wearable computer, or head mounted device) are updated as the user of the computer system 101 (e.g., tablet, smartphone, wearable computer, or head mounted device) moves and/or changes orientation within the physical environment. In the example of FIG. 17A, in the physical environment (e.g., represented by the rectangle 1700) of the user, the potted plant 1724 is located to the left of the user 1704 (e.g., outside the field of view of the user 1704) and the coffee table 1722 is located forward and to the right of the user 1704. Accordingly, as illustrated herein, the representation of the user 1704 within the rectangle 1700 reflects the user's physical position and/or orientation relative to the physical environment of the computer system 101.

In some embodiments, the computer system 101 (e.g., tablet, smartphone, wearable computer, or head mounted device) updates a spatial arrangement of the viewpoint of the user of the computer system 101, the first visual representation 1706, and the second visual representation 1708 in response to detecting a change in a number of participants in the real-time communication session. For example, from FIGS. 17A-17B, the computer system 101 (e.g., tablet, smartphone, wearable computer, or head mounted device) detects a third participant (e.g., a fourth user of a fourth computer system) join the real-time communication session, such that the number of participants in the real-time communication session increases from three participants to four participants. In some embodiments, when the third participant joins the real-time communication session, the computer system 101 (e.g., tablet, smartphone, wearable computer, or head mounted device) updates the three-dimensional environment 1702 (e.g., an AR, AV, VR, MR, or XR environment) to include a third visual representation 1710 of the third participant. In some embodiments, when the computer system 101 (e.g., tablet, smartphone, wearable computer, or head mounted device) displays the third visual representation 1710 in the three-dimensional environment 1702 (e.g., an AR, AV, VR, MR, or XR environment), the computer system 101 (e.g., tablet, smartphone, wearable computer, or head mounted device) updates the spatial arrangement 1718a to accommodate the third visual representation 1710. For example, as shown in the schematic view of the three-dimensional environment 1702 (e.g., an AR, AV, VR, MR, or XR environment) in FIG. 17B, the locations of the visual representations are updated when the third visual representation 1710 is displayed. In some embodiments, as shown in FIG. 17B, the first visual representation 1706 is displayed at a first updated location, the second visual representation 1708 is displayed at a second updated location, and the third visual representation 1710 is displayed at a third location in the three-dimensional environment 1702 (e.g., an AR, AV, VR, MR, or XR environment) relative to the current viewpoint of the user 1704. Additionally, as shown in the schematic view of FIG. 17B, the spatial distribution of the participants in the three-dimensional environment 1702 (e.g., an AR, AV, VR, MR, or XR environment) is updated when the third participant joins the real-time communication session. For example, in FIG. 17B, a distance between the first visual representation 1706 and the user 1704 and a distance between the second visual representation 1708 and the user 1704 decreases compared to the spatial distribution shown in FIG. 17A. Finally, as shown in the schematic view of FIG. 17B, when the third participant joins the real-time communication session, the user of the computer system 101 (e.g., tablet, smartphone, wearable computer, or head mounted device) has not changed position and/or orientation within the physical environment as indicated by the unchanged position and/or orientation of the representation of the user 1704 relative to the rectangle 1700.

From FIGS. 17B-17C, the computer system 101 (e.g., tablet, smartphone, wearable computer, or head mounted device) detects movement of the viewpoint of the user of the computer system 101 (e.g., tablet, smartphone, wearable computer, or head mounted device) relative to the three-dimensional environment 1702 (e.g., an AR, AV, VR, MR, or XR environment). For example, as shown in the schematic view in FIG. 17C, the user 1704 has moved (e.g., walked) in the physical environment of the user, such that, in the three-dimensional environment 1702 (e.g., an AR, AV, VR, MR, or XR environment), the viewpoint of the user 1704 is moved/shifted away from the other participants in the real-time communication session (e.g., referred to herein as “the group”). In some embodiments, as similarly discussed above, the user of the computer system 101 (e.g., tablet, smartphone, wearable computer, or head mounted device) has an updated position and/or orientation relative to the physical environment, as indicated by the updated position and/or orientation of the representation of the user 1704 in the rectangle 1700 in FIG. 17C. As shown in FIG. 17C, after the movement of the user, a representation of the potted plant 1724 is visible in the field of view of the user of the computer system 101. Additionally, as shown in the schematic view in FIG. 17C, the location within the spatial arrangement 1718a of the users that was previously occupied by the user 1704 (e.g., prior to the movement of the viewpoint) is indicated by label “A” in the spatial arrangement 1718a.

In some embodiments, as shown in FIG. 17C, when the viewpoint of the user changes in accordance with the movement of the user in the physical environment, the group is no longer visible in the user's field of view. For example, as shown in FIG. 17C, the three-dimensional environment 1702 (e.g., an AR, AV, VR, MR, or XR environment) relative to the current viewpoint of the user no longer includes the visual representations 1706-1710. Accordingly, in some embodiments, it is desirable to provide functionality that enables the user to reset the spatial arrangement 1718a, such that the virtual elements (e.g., the visual representations 1706-1710 and the virtual object 1726) are redisplayed relative to the current viewpoint of the user in the three-dimensional environment 1702.

In FIG. 17C, the computer system 101 (e.g., tablet, smartphone, wearable computer, or head mounted device) detects an event corresponding to a request to reset the spatial arrangement 1718a of the virtual elements in the three-dimensional environment 1702 (e.g., an AR, AV, VR, MR, or XR environment). In some embodiments, as shown in FIG. 17C, detecting the event includes detecting a selection (e.g., a press) of a physical button of the computer system, such as selection of button 1731b provided by hand 1703a. In some embodiments, detecting the event includes detecting a selection of a selectable option displayed via the display generation component 120. For example, as shown in FIG. 17C, the computer system 101 (e.g., tablet, smartphone, wearable computer, or head mounted device) detects an air gesture (e.g., an air pinch gesture, an air tap or touch gesture) provided by hand 1705a while attention (e.g., gaze 1721) is directed toward selectable option 1715 that is selectable to reset the spatial arrangement 1718a relative to the current viewpoint of the user.

FIG. 17C1 illustrates similar and/or the same concepts as those shown in FIG. 17C (with many of the same reference numbers). It is understood that unless indicated below, elements shown in FIG. 17C1 that have the same reference numbers as elements shown in FIGS. 17A-17P have one or more or all of the same characteristics. FIG. 17C1 includes computer system 101, which includes (or is the same as) display generation component 120. In some embodiments, computer system 101 and display generation component 120 have one or more of the characteristics of computer system 101 shown in FIGS. 17A-17P and display generation component 120 shown in FIGS. 1 and 3, respectively, and in some embodiments, computer system 101 and display generation component 120 shown in FIGS. 17A-17P have one or more of the characteristics of computer system 101 and display generation component 120 shown in FIG. 17C1.

In FIG. 17C1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 17A-17P.

In FIG. 17C1, display generation component 120 is illustrated as displaying content that optionally corresponds to the content that is described as being displayed and/or visible via display generation component 120 with reference to FIGS. 17A-17P. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 17C1.

Display generation component 120 has a field of view (e.g., a field of view captured by external image sensors 314b and 314c and/or visible to the user via display generation component 120) that corresponds to the content shown in FIG. 17C1. Because display generation component 120 is optionally a head-mounted device, the field of view of display generation component 120 is optionally the same as or similar to the field of view of the user.

In FIG. 17C1, the user is depicted as performing an air pinch gesture (e.g., with hand 1705a) to provide an input to computer system 101 to provide a user input directed to content displayed by computer system 101. Such depiction is intended to be exemplary rather than limiting; the user optionally provides user inputs using different air gestures and/or using other forms of input as described with reference to FIGS. 17A-17P.

In some embodiments, computer system 101 responds to user inputs as described with reference to FIGS. 17A-17P.

In the example of FIG. 17C1, because the user's hand is within the field of view of display generation component 120, it is visible within the three-dimensional environment. That is, the user can optionally see, in the three-dimensional environment, any portion of their own body that is within the field of view of display generation component 120. It is understood than one or more or all aspects of the present disclosure as shown in, or described with reference to FIGS. 17A-17P and/or described with reference to the corresponding method(s) are optionally implemented on computer system 101 and display generation unit 120 in a manner similar or analogous to that shown in FIG. 17C1.

In some embodiments, as shown in FIG. 17D, in response to detecting the event, the computer system 101 (e.g., tablet, smartphone, wearable computer, or head mounted device) updates the spatial arrangement 1718a of the virtual elements in the three-dimensional environment 1702 (e.g., an AR, AV, VR, MR, or XR environment), such that the group is redisplayed relative to the current viewpoint of the user. For example, as indicated by the rectangle 1700, when the computer system 101 (e.g., tablet, smartphone, wearable computer, or head mounted device) updates the spatial arrangement 1718a, the visual representations 1706-1710 are displayed at updated locations in the three-dimensional environment 1702 from the current viewpoint of the user 1704 within the physical environment. As shown in the schematic view of FIG. 17D, the visual representations 1706-1710 and the virtual object 1726 are moved in the three-dimensional environment 1702 to be located in front of the user 1704, while the user 1704 maintains their same location and orientation relative to the physical objects in the physical environment (e.g., the potted plant 1724 and the coffee table 1722) shown in FIG. 17C, as indicated by the position and/or orientation of user 1704, coffee table 1722 and potted plant 1724 in the rectangle 1700 in FIG. 17D.

In some embodiments, when the computer system 101 (e.g., tablet, smartphone, wearable computer, or head mounted device) updates the spatial arrangement 1718a in the three-dimensional environment 1702 (e.g., an AR, AV, VR, MR, or XR environment), the computer system 101 (e.g., tablet, smartphone, wearable computer, or head mounted device) positions the viewpoint of the user 1704 at a location within the spatial arrangement 1718a that is based on the spatial distribution of the participants (e.g., represented by their visual representations 1706-1710). For example, the computer system 101 (e.g., tablet, smartphone, wearable computer, or head mounted device) selects a reset location for the viewpoint based on spatial gaps/separations in the spatial arrangement 1718a. In FIG. 17C, when the event discussed above is detected by the computer system 101, the largest gap in the spatial arrangement 1718a is the user's previous location in the spatial arrangement 1718a, represented by the label A. Accordingly, as shown in FIG. 17D, when the computer system 101 (e.g., tablet, smartphone, wearable computer, or head mounted device) resets the spatial arrangement 1718a in the three-dimensional environment 1702, the computer system 101 (e.g., tablet, smartphone, wearable computer, or head mounted device) positions the current viewpoint of the user at the user's previous location within the spatial arrangement 1718a (e.g., positioned between the first visual representation 1706 and the second visual representation 1708).

Attention is now directed to additional and/or alternative embodiments of resetting the spatial arrangement of the virtual elements in the real-time communication session based on the spatial distribution of the participants in the real-time communication session. It should be understood that the above description of the physical environment of the user, which is represented by the rectangle 1700 in FIGS. 17A-17D, and changes in the position and/or the orientation of the user 1704 relative to the physical environment applies analogously to the additional and/or alternative embodiments discussed below. Particularly, when the computer system 101 (e.g., tablet, smartphone, wearable computer, or head mounted device) resets the spatial arrangement relative to the viewpoint of the user 1704, the user's position and/or orientation remains unchanged relative to the physical environment, and only physical movements and/or rotations of the user in the physical environment cause the position and/or orientation of the user 1704 to be changed/updated relative to the physical environment (e.g., including the physical objects in the physical environment). For brevity, the full details are not repeated here or in the following examples.

Alternatively to the instance described above, in some embodiments, as shown in FIG. 17E, when the viewpoint of the user changes relative to the three-dimensional environment 1702 (e.g., an AR, AV, VR, MR, or XR environment) (e.g., and the user 1704 has moved away from the group as shown in the schematic view), the computer system 101 (e.g., tablet, smartphone, wearable computer, or head mounted device) detects that the first visual representation 1706 has also moved away from the group in the three-dimensional environment 1702. For example, the second user of the second computer system has moved in their respective physical environment, which causes the first visual representation 1706 to be moved in the three-dimensional environment 1702 accordingly.

In some embodiments, when the computer system 101 (e.g., tablet, smartphone, wearable computer, or head mounted device) detects the event discussed above with reference to FIG. 17C, the computer system 101 (e.g., tablet, smartphone, wearable computer, or head mounted device) selects a reset location for the viewpoint of the user that is based on an updated (e.g., estimated/calculated) center 1719 of the spatial arrangement 1718b. For example, as shown in FIG. 17F, the movement of the first visual representation 1706 in the three-dimensional environment 1702 (e.g., an AR, AV, VR, MR, or XR environment) causes the center 1719 of the spatial arrangement 1718b to change based on the new location of the first visual representation 1706 in the three-dimensional environment 1702 (e.g., an AR, AV, VR, MR, or XR environment). Accordingly, in some embodiments, as shown in FIG. 17F, rather than selecting the user's previous location in the spatial arrangement 1718a, the computer system 101 (e.g., tablet, smartphone, wearable computer, or head mounted device) selects a reset location that is based on the updated center 1719 of the spatial arrangement 1718b. For example, a distance 1711 of the location of the viewpoint of the user 1704 in the spatial arrangement 1718b from the center 1719 is (e.g., approximately) equal to distances of the locations of the visual representations 1706-1710 from the center 1719.

Alternatively, in some embodiments, as shown in FIG. 17G, when the viewpoint of the user changes relative to the three-dimensional environment 1702 (e.g., an AR, AV, VR, MR, or XR environment) (e.g., and the user 1704 has moved away from the group as shown in the schematic view), the computer system 101 (e.g., tablet, smartphone, wearable computer, or head mounted device) detects that the first visual representation 1706 has also moved to a new location within the spatial arrangement 1718a in the three-dimensional environment 1702 (e.g., an AR, AV, VR, MR, or XR environment). For example, the second user of the second computer system has moved in their respective physical environment, which causes the first visual representation 1706 to be moved in the three-dimensional environment 1702 (e.g., an AR, AV, VR, MR, or XR environment) accordingly.

In some embodiments, when the computer system 101 (e.g., tablet, smartphone, wearable computer, or head mounted device) detects the event discussed above with reference to FIG. 17C, the computer system 101 (e.g., tablet, smartphone, wearable computer, or head mounted device) selects a reset location for the viewpoint of the user that is based on the spatial distribution of the participants, as previously discussed above. In some embodiments, as shown in FIG. 17G, when the event is detected, the computer system 101 (e.g., tablet, smartphone, wearable computer, or head mounted device) determines that the user's previous location in the spatial arrangement 1718a is now occupied by the first visual representation 1706 (e.g., caused by the movement of the second user as discussed above). Accordingly, in some embodiments, as shown in FIG. 17H, when the computer system 101 (e.g., tablet, smartphone, wearable computer, or head mounted device) updates the spatial arrangement 1718a, the computer system 101 (e.g., tablet, smartphone, wearable computer, or head mounted device) selects a reset location for the viewpoint of the user 1704 that corresponds to the previous location of the first visual representation 1706 in the spatial arrangement 1718a (e.g., represented by label “B” in FIG. 17G). For example, as shown in the schematic view in FIG. 17H, the computer system 101 (e.g., tablet, smartphone, wearable computer, or head mounted device) positions the viewpoint of the user 1704 adjacent to the third visual representation 1710 in the spatial arrangement 1718a.

Alternatively, in some embodiments, as shown in FIG. 17I, when the viewpoint of the user changes relative to the three-dimensional environment 1702 (e.g., an AR, AV, VR, MR, or XR environment) (e.g., and the user 1704 has moved away from the group as shown in the schematic view), the computer system 101 (e.g., tablet, smartphone, wearable computer, or head mounted device) detects that the first visual representation 1706, the second visual representation 1708 and the third visual representation 1710 have also moved to new locations within the spatial arrangement 1718a in the three-dimensional environment 1702 (e.g., an AR, AV, VR, MR, or XR environment). For example, the second user of the second computer system, the third user of the third computer system, and the fourth user of the fourth computer system have moved in their respective physical environments, which cause the first visual representation 1706, the second visual representation 1708, and the third visual representation 1710, respectively, to be moved in the three-dimensional environment 1702 (e.g., an AR, AV, VR, MR, or XR environment) accordingly.

In some embodiments, when the computer system 101 (e.g., tablet, smartphone, wearable computer, or head mounted device) detects the event discussed above with reference to FIG. 17C, the computer system 101 (e.g., tablet, smartphone, wearable computer, or head mounted device) selects a reset location for the viewpoint of the user that is based on the spatial distribution of the participants, as previously discussed above. In some embodiments, as shown in FIG. 17G, when the event is detected, the computer system 101 (e.g., tablet, smartphone, wearable computer, or head mounted device) determines that, due to the movements of the visual representations 1706-1710, there are currently multiple gaps within the spatial arrangement 1718a. For example, as shown in the schematic view in FIG. 17I, the movement of the visual representations 1706-1710 causes a first gap, represented by label “C”, and a second gap, represented by label “D”, to be created in the spatial arrangement 1718a. Accordingly, in some embodiments, as shown in FIG. 17J, when the computer system 101 (e.g., tablet, smartphone, wearable computer, or head mounted device) updates the spatial arrangement 1718a, the computer system 101 (e.g., tablet, smartphone, wearable computer, or head mounted device) selects a reset location for the viewpoint of the user 1704 from the first gap and the second gap in the spatial arrangement 1718a. In some embodiments, as shown in FIG. 17J, in accordance with a determination that there are multiple gaps in the spatial arrangement 1718a, the computer system 101 (e.g., tablet, smartphone, wearable computer, or head mounted device) positions the viewpoint of the user 1704 at the gap that is closest to the viewpoint of the user when the event described above is detected. As shown in FIG. 17J, because the second gap (e.g., labeled D) in the spatial arrangement 1718a is closer to the viewpoint of the user 1704 than the first gap (e.g., labeled C) in FIG. 17I when the event is detected, the computer system 101 (e.g., tablet, smartphone, wearable computer, or head mounted device) positions the current viewpoint of the user 1704 at the second gap in the spatial arrangement 1718a in the three-dimensional environment 1702 (e.g., an AR, AV, VR, MR, or XR environment).

Alternatively, in some embodiments, as shown in FIG. 17K, when the viewpoint of the user changes relative to the three-dimensional environment 1702 (e.g., an AR, AV, VR, MR, or XR environment) (e.g., and the user 1704 has moved away from the group as shown in the schematic view), the computer system 101 (e.g., tablet, smartphone, wearable computer, or head mounted device) detects that the first visual representation 1706, the second visual representation 1708 and the third visual representation 1710 have also moved to new locations within the spatial arrangement 1718a in the three-dimensional environment 1702. For example, the second user of the second computer system, the third user of the third computer system, and the fourth user of the fourth computer system have moved in their respective physical environments, which cause the first visual representation 1706, the second visual representation 1708, and the third visual representation 1710, respectively, to be moved in the three-dimensional environment 1702 accordingly.

In some embodiments, when the computer system 101 (e.g., tablet, smartphone, wearable computer, or head mounted device) detects the event discussed above with reference to FIG. 17C, the computer system 101 (e.g., tablet, smartphone, wearable computer, or head mounted device) selects a reset location for the viewpoint of the user that is based on the spatial distribution of the participants, as previously discussed above. In some embodiments, as shown in FIG. 17K, when the event is detected, the computer system 101 (e.g., tablet, smartphone, wearable computer, or head mounted device) determines that, due to the movements of the visual representations 1706-1710, there are currently multiple gaps within the spatial arrangement 1718a. For example, as shown in the schematic view in FIG. 17I, the movement of the visual representations 1706-1710 causes a first gap, represented by label “C”, and a second gap, represented by label “D”, to be created in the spatial arrangement 1718a. Accordingly, in some embodiments, as shown in FIG. 17J, when the computer system 101 (e.g., tablet, smartphone, wearable computer, or head mounted device) updates the spatial arrangement 1718a, the computer system 101 (e.g., tablet, smartphone, wearable computer, or head mounted device) selects a reset location for the viewpoint of the user 1704 from the first gap and the second gap in the spatial arrangement 1718a. In some embodiments, as shown in FIG. 17L, in accordance with a determination that there are multiple gaps in the spatial arrangement 1718a and that a largest gap is less than a threshold amount (e.g., threshold angle, such as 0, 1, 2, 5, 10, 15, 20, and/or 30 degrees) larger than the next-largest gap, the computer system 101 (e.g., tablet, smartphone, wearable computer, or head mounted device) positions the viewpoint of the user 1704 at the gap that is closest to the viewpoint of the user when the event described above is detected. In FIG. 17K, when the event is detected, the computer system 101 (e.g., tablet, smartphone, wearable computer, or head mounted device) determines that a size (e.g., angular size) 1715-1 of the first gap (e.g., labeled C) is less than the threshold amount larger than a size 1715-2 of the second gap (e.g., labeled D). For example, the first gap is the largest gap in the spatial arrangement 1718a but is less than the threshold amount larger than the next-largest gap, which is the second gap. Accordingly, as shown in FIG. 17L, because the first gap (e.g. labeled C) is less than the threshold amount larger than the second gap (e.g., labeled D) and because the second gap (e.g., labeled D) in the spatial arrangement 1718a is closer to the viewpoint of the user 1704 than the first gap (e.g., labeled C) in FIG. 17K when the event is detected, the computer system 101 (e.g., tablet, smartphone, wearable computer, or head mounted device) positions the current viewpoint of the user 1704 at the second gap in the spatial arrangement 1718a in the three-dimensional environment 1702 (e.g., an AR, AV, VR, MR, or XR environment).

In some embodiments, if the size 1715-1 of the first gap (e.g. labeled C) were more than the threshold amount larger than the size 1715-2 of the second gap (e.g. labeled D), the computer system 101 (e.g., tablet, smartphone, wearable computer, or head mounted device) would select the first gap as the reset location for the viewpoint of the user 1704 in response to detecting the event. For example, in FIG. 17L, the user 1704 would be positioned at the position of the label C rather than at the position of the label D as shown.

Alternatively, in some embodiments, as shown in FIG. 17M, when the viewpoint of the user changes relative to the three-dimensional environment 1702 (e.g., an AR, AV, VR, MR, or XR environment) (e.g., and the user 1704 has moved away from the group as shown in the schematic view), the group is arranged along a line or arc in the three-dimensional environment. For example, as shown in FIG. 17M, the spatial arrangement 1718c of the visual representations 1706-1710 is arranged linearly or curved along a line or arc in the three-dimensional environment 1702. As similarly discussed above and as shown in FIG. 17M, the user's previous location in the spatial arrangement 1718c is represented by the label A in the schematic view.

In some embodiments, when the computer system 101 (e.g., tablet, smartphone, wearable computer, or head mounted device) detects the event discussed above with reference to FIG. 17C and in accordance with a determination that the participants in the real-time communication session are arranged in a line or arc in the three-dimensional environment 1702 (e.g., an AR, AV, VR, MR, or XR environment), the computer system 101 (e.g., tablet, smartphone, wearable computer, or head mounted device) selects a reset location and/or a reset orientation for the viewpoint of the user that is based on an average orientation of the other participants in the real-time communication session. In some embodiments, as shown in FIG. 17M, when the event is detected, the computer system 101 (e.g., tablet, smartphone, wearable computer, or head mounted device) determines that an average orientation of the other participants in the real-time communication session is a first orientation (e.g., a forward direction (e.g., in the direction of the virtual object 1726 in the three-dimensional environment 1702 (e.g., an AR, AV, VR, MR, or XR environment))). For example, as shown in FIG. 17M, the second visual representation 1708 and the third visual representation 1710 are positioned on a first side 1713a of the arc and are oriented to face in the forward direction toward the virtual object 1726, and the first visual representation 1706 is positioned on a second side 1713b of the arc and is oriented to face in a backward direction away from the virtual object 1726, such that the average orientation of the participants is the first orientation. Accordingly, in some embodiments, as shown in FIG. 17N, when the computer system 101 (e.g., tablet, smartphone, wearable computer, or head mounted device) updates the spatial arrangement 1718a, the computer system 101 (e.g., tablet, smartphone, wearable computer, or head mounted device) selects a reset location for the viewpoint of the user 1704 that is based on the average orientation of the other participants in the real-time communication session. For example, as shown in FIG. 17N, the computer system 101 (e.g., tablet, smartphone, wearable computer, or head mounted device) positions the viewpoint of the user 1704 on the first side 1713a of the arc and orients the viewpoint to be facing toward the forward direction toward the virtual object 1726 in the three-dimensional environment 1702 (e.g., an AR, AV, VR, MR, or XR environment).

Alternatively, in some embodiments, as shown in FIG. 17O, if the average orientation of the participants in the real-time communication session is a second orientation, different from the first orientation above, that is facing in a backward direction and away from the virtual object 1726 when the event discussed above is detected, the computer system 101 (e.g., tablet, smartphone, wearable computer, or head mounted device) updates the spatial arrangement 1718c relative to the viewpoint of the user 1704 based on the second orientation. For example, as shown in FIG. 17O, when the event is detected, the visual representations 1706 and 1708 are positioned on the second side 1713b of the arc and are oriented to face toward in the backward direction and away from the virtual object 1726. Accordingly, in some embodiments, as shown in FIG. 17P, in response to detecting the event, the computer system 101 (e.g., tablet, smartphone, wearable computer, or head mounted device) positions the viewpoint of the user 1704 on the second side 1713b of the arc and orients the viewpoint of the user 1704 to face in the backward direction and away from the virtual object 1726 in accordance with the determination that the average orientation is the second orientation.

FIG. 18 is a flowchart illustrating a method 1800 of facilitating updates of a spatial arrangement of participants in a real-time communication session in a three-dimensional environment based on a spatial distribution of the participants in accordance with some embodiments. In some embodiments, the method 1800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1800 is governed by instructions that are stored in a non-transitory computer-readable storage medium and that are executed by one or more processors of a computer system, such as the one or more processors 202 of computer system 101 (e.g., tablet, smartphone, wearable computer, or head mounted device) (e.g., control unit 110 in FIG. 1A). Some operations in method 1800 are, optionally, combined and/or the order of some operations is, optionally, changed.

In some embodiments, method 1800 is performed at a computer system in communication with a display generation component and one or more input devices. For example, a mobile device (e.g., a tablet, a smartphone, a media player, or a wearable device), or a computer or other electronic device. In some embodiments, the first computer system has one or more characteristics of computer systems in methods 800, 1000, 1200, 1400, 1600, and/or 2000. In some embodiments, the display generation component has one or more characteristics of the display generation component in methods 800, 1000, 1200, 1400, 1600, and/or 2000. In some embodiments, the one or more input devices have one or more characteristics of the one or more input devices in methods 800, 1000, 1200, 1400, 1600, and/or 2000.

In some embodiments, while a three-dimensional environment (e.g., three-dimensional environment 1702 (e.g., an AR, AV, VR, MR, or XR environment) in FIG. 17A) is visible via the display generation component from a current viewpoint of a user of the computer system (e.g., the three-dimensional environment is generated, displayed, or otherwise caused to be viewable by the device (e.g., a computer-generated reality (CGR) environment such as a virtual reality (VR) environment, a mixed reality (MR) environment, and/or an augmented reality (AR) environment)), and while the user of the computer system is in a real-time communication session with a plurality of participants different from the user, the plurality of participants including a first participant and a second participant, the computer system displays (1802a), via the display generation component, a first spatial arrangement of elements of the real-time communication session (e.g., locations of one or more representations of other participants and/or shared content relative to the current viewpoint of the user), including displaying a first visual representation (e.g., first visual representation 1706 in FIG. 17A) of the first participant at a first location in the three-dimensional environment relative to the current viewpoint of the user and a second visual representation (e.g., second visual representation 1708 in FIG. 17A) of the second participant at a second location in the three-dimensional environment relative to the current viewpoint of the user. In some embodiments, the three-dimensional environment has one or more characteristics of the three-dimensional environment in methods 800, 1000, 1200, 1400, 1600, and/or 2000. In some embodiments, the real-time communication session has one or more characteristics of the real-time communication session in methods 800, 1000, 1200, 1400, 1600, and/or 2000. In some embodiments, the first visual representation of the first participant is a virtual avatar corresponding to the first participant and the second visual representation of the second participant is a virtual avatar corresponding to the second participant. In some embodiments, as similarly discussed with reference to methods 1400, 1600, and/or 2000, the first participant corresponds to a user of a second computer system, different from the computer system, and the second participant corresponds to a user of a third computer system, different from the computer system and the second computer system. In some embodiments, the visual representations of the first and second participants have one or more characteristics of the visual representations in methods 800, 1000, 1200, 1400, 1600, and/or 2000.

In some embodiments, while displaying the first visual representation of the first participant at the first location relative to the current viewpoint of the user and the second visual representation of the second participant at the second location relative to the current viewpoint of the user, the computer system detects (1802b) a first event corresponding to a request to reset a spatial distribution of one or more participants in the real-time communication session, such as selection of button 1731b provided by hand 1703a as shown in FIGS. 17C and 17C1. For example, the first computer system detects a first event corresponding to a request to rearrange the three-dimensional environment relative to the first viewpoint of the user (e.g., the current viewpoint of the user), which includes changing the locations at which the first visual representation of the first participant and the second visual representation of the second participant are displayed, such that the user has a new viewpoint within the three-dimensional environment. In some embodiments, detecting the first event includes detecting input provided by the user of the computer system. For example, the computer system detects the input via a hardware control (e.g., a physical button or dial) of the computer system, such as a press, click, and/or rotation of the hardware control. In some embodiments, the computer system detects the input via a user interface element, such as a selectable option, that is displayed in the three-dimensional environment. For example, the computer system detects a selection of a selectable option that is selectable to request to reset the spatial distribution of one or more participants in the real-time communication session, such as an air pinch gesture directed to the selectable option and/or an air tap or touch gesture directed to the selectable option, optionally while attention of the user is directed to the selectable option, and/or interaction with a hardware input device (e.g., a controller including buttons, joysticks, and/or dials) that is in communication with the computer system. In some embodiments, detecting the first event includes detecting a change in a number of the one or more participants in the real-time communication session. For example, the computer system detects an indication that a third participant (e.g., a user of a fourth computer system), different from the user, the first participant, and the second participant, has joined the real-time communication session. In some embodiments, when the third participant joins the real-time communication session, the three-dimensional environment will be updated relative to the current viewpoint of the user with a third visual representation of the third participant. In some embodiments, because the third visual representation of the third participant will be displayed with the first visual representation of the first participant and the second visual representation of the second participant, the spatial distribution of the participants in the real-time communication session will be reset to accommodate the third participant. In some embodiments, the computer system detects an indication that one or more of the first participant and the second participant has left the real-time communication session. In some embodiments, when the first participant or the second participant leaves the real-time communication session, the three-dimensional environment will be updated relative to the current viewpoint of the user to have fewer visual representations. For example, because the first visual representation of the first participant or the second visual representation of the second participant will no longer be displayed in the three-dimensional environment, the spatial distribution of the participants in the real-time communication session will be reset to account for the decreased number of users. In some embodiments, detecting the first event has one or more characteristics of detecting events (e.g., corresponding to requests to reset spatial distributions and/or recenter) as described in methods 800, 1000, 1200, 1400, 1600, and/or 2000.

In some embodiments, in response to detecting the first event, the computer system displays (1802c) a respective updated spatial arrangement of elements of the real-time communication session, including, in accordance with a determination that a spatial distribution of the first visual representation of the first participant and the second visual representation of the second participant when the first event was detected was a first spatial distribution, such as the spatial distribution of the participants shown in the schematic view of the three-dimensional environment 1702 (e.g., an AR, AV, VR, MR, or XR environment) in FIGS. 17C and 17C1, displaying, from the current viewpoint of the first user, a first updated spatial arrangement of elements of the real-time communication session that is different from the first spatial arrangement of elements of the real-time communication session (1802d), such as the spatial arrangement 1718a shown in the schematic view in FIG. 17D. For example, when the computer system detects the first event, the first visual representation of the first participant and the second visual representation of the second participant are located a first distance and a second distance, respectively, from the viewpoint of the user, and/or are located a third distance from one another, and/or possess a first orientation and a second orientation, respectively, relative to the viewpoint of the user. As an example, in the first spatial distribution, the user occupies a first “seat” (e.g., an opening or gap within the spatial distribution at which the first user is positioned in the real-time communication session), the first participant occupies a second seat, and the second participant occupies a third seat in the three-dimensional environment (e.g., where the viewpoint of the user is located at the first seat). In some embodiments, the viewpoint of the user, the first location of the first visual representation and the second location of the second visual representation are arranged according to a first shape having one or more first characteristics (e.g., a circular or oval shape having a first radius) while having the first spatial distribution. In some embodiments, when the computer system detects the reset event discussed above, the viewpoint of the user of the computer system has moved relative to the first participant and the second participant in the three-dimensional environment (e.g., such that the user, the first participant, and the second participant are in the first spatial distribution), which, in response to detecting the reset event, causes the first updated spatial arrangement to be displayed relative to the updated current viewpoint of the user. In some embodiments, when the computer system resets the spatial distribution of the one or more participants in the real-time communication session that results in the first updated spatial arrangement, the computer system updates the seat within the three-dimensional environment which the user occupies. For example, the computer system selects an unoccupied seat, such as a fourth seat, within the three-dimensional environment that causes the first visual representation of the first participant and/or the second visual representation of the second participant to shift locations in the three-dimensional environment relative to a new viewpoint of the user (e.g., as viewed from the user's new seat in the three-dimensional environment, such as the fourth seat discussed above). In some embodiments, the current viewpoint of the first user, the first updated location of the first visual representation, and the second updated location of the second visual representation are arranged according to the first shape having one or more second characteristics (e.g., a circular or oval shape having a second radius, different from the first radius above) or a second shape (e.g., a rectangular, triangular, or other shape), different from the first shape. In some embodiments, the fourth seat to which the first user is moved was previously occupied by a participant who left the real-time communication session, such as the first participant or the second participant, which triggered the first event as discussed previously above. In some embodiments, the fourth seat is selected for the user based on the addition of a new participant, such as the third participant discussed above, in the real-time communication session, which triggered the first event. In some embodiments, in response to detecting the first event, when displaying the one or more participants in the first updated spatial arrangement, the first visual representation of the first participant and the second visual representation of the second participant are located a first updated distance and a second updated distance, respectively, from the current viewpoint of the user, and/or are located a third updated distance from one another. For example, in the first updated spatial arrangement, the first visual representation of the first participant and the second visual representation of the second participant are located closer to or farther from the current viewpoint of the user than in the first spatial arrangement, and/or the first visual representation of the first participant and the second visual representation of the second participant are located closer together or farther apart than in the first spatial arrangement. In some embodiments, in response to detecting the first event, when displaying the one or more users in the first updated spatial arrangement, the first visual representation of the first participant is displayed with a first updated orientation and the second visual representation of the second participant is displayed with a second updated orientation relative to the current viewpoint of the user. For example, in the first updated spatial arrangement, the first visual representation of the first participant and the second visual representation of the second participant are oriented to face in different directions relative to the current viewpoint of the user than in the first spatial arrangement.

In some embodiments, in accordance with a determination that the spatial distribution of the first visual representation of the first participant and the second visual representation of the second participant when the first event was detected was a second spatial distribution, different from the first spatial distribution, such as the spatial distribution of the participants as shown in the schematic view in FIG. 17E, the computer system displays, from the current viewpoint of the first user, a second updated spatial arrangement of elements of the real-time communication session that is different from the first spatial arrangement of elements of the real-time communication session and different from the first updated spatial arrangement elements of the real-time communication session (1802e), such as the spatial arrangement 1718b as shown in the schematic view in FIG. 17F. For example, when the computer system detects the first event, the first visual representation of the first participant and the second visual representation of the second participant are located a fourth distance and a fifth distance, respectively, from the current viewpoint of the user, and/or are located a sixth distance from one another, and/or possess a third orientation and a fourth orientation, respectively, relative to the viewpoint of the user. In some embodiments, the fourth distance and the fifth distance are different from the first distance and the second distance, respectively, and the sixth distance is different from the third distance. As similarly discussed above, in the second spatial distribution, the first user occupies a first seat, the first participant occupies a second seat, and the second participant occupies a third seat in the three-dimensional environment (e.g., where the current viewpoint of the user is located at the first seat). In some embodiments, the current viewpoint of the user, the first location of the first visual representation and the second location of the second visual representation are arranged according to a first shape having one or more third characteristics (e.g., a circular or oval shape having a third radius, different from the first radius above) while having the second spatial distribution. In some embodiments, when the computer system detects the reset event discussed above, the viewpoint of the user of the computer system has moved relative to the first participant and the second participant in the three-dimensional environment (e.g., such that the user, the first participant, and the second participant are in the second spatial distribution), which, in response to detecting the reset event, causes the second updated spatial arrangement to be displayed relative to the updated current viewpoint of the user. In some embodiments, when the first computer system resets the spatial distribution of the one or more participants in the real-time communication session that results in the second updated spatial arrangement, as similarly described above, the computer system updates the seat within the three-dimensional environment which the first user occupies. For example, the computer system selects an unoccupied seat, such as a fourth seat, within the three-dimensional environment that causes the first visual representation of the first participant and/or the second visual representation of the second participant to shift locations in the three-dimensional environment relative to a new viewpoint of the user (e.g., as viewed from the user's new seat in the three-dimensional environment, such as the fourth seat discussed above). In some embodiments, the current viewpoint of the first user, the third updated location of the first visual representation, and the fourth updated location of the second visual representation are arranged according to the first shape having one or more fourth characteristics (e.g., a circular or oval shape having a fourth radius, different from the third radius above) or a second shape (e.g., a rectangular, triangular, or other shape), different from the first shape. In some embodiments, in response to detecting the first event, when displaying the one or more users in the fourth spatial distribution, the first visual representation of the first participant and the second visual representation of the second participant are located a fourth updated distance and a fifth updated distance, respectively, from the current viewpoint of the user, and/or are located a sixth updated distance from one another. For example, in the second updated spatial arrangement, the first visual representation of the first participant and the second visual representation of the second participant are located closer to or farther from the current viewpoint of the first user than in the first spatial arrangement, and/or the first visual representation of the first participant and the second visual representation of the second participant are located closer together or farther apart than in the first spatial arrangement. In some embodiments, in response to detecting the first event, when displaying the one or more participants in the second updated spatial arrangement, the first visual representation of the first participant is displayed with a third updated orientation and the second visual representation of the second participant is displayed with a fourth updated orientation relative to the current viewpoint of the first user. For example, in the second updated spatial arrangement, the first visual representation of the first participant and the second visual representation of the second participant are oriented to face in different directions relative to the current viewpoint of the user than in the first spatial arrangement (and optionally different from the first updated orientation and the second updated orientation discussed above with reference to the first updated spatial arrangement). Resetting a spatial distribution of one or more users in a real-time communication session, including updating locations at which visual representations of one or more users are displayed in a three-dimensional environment, in response to detecting a request to reset the spatial distribution reduces the number of inputs needed to manually move the viewpoint(s) of the user(s) within the real-time communication session and/or enables the spatial distribution to be reset automatically, thereby improving user-device interaction.

In some embodiments, detecting the first event includes detecting an indication of a change in a number of participants in the real-time communication session (e.g., the number of participants included in the plurality of participants) (e.g., as similarly discussed above with reference to step(s) 1802), such as detecting a fourth participant join the real-time communication session as discussed with reference to FIG. 17B. In some embodiments, as similarly discussed above with reference to step(s) 1802, the reset event occurs when a third participant (e.g., a fourth user of a fourth computer system) joins the real-time communication session or one of the first participant and the second participant leaves the real-time communication session. In some embodiments, the spatial arrangement of the elements (e.g., visual representations and/or virtual content) in the real-time communication changes in the three-dimensional environment when the number of the plurality of participants in the real-time communication session changes because a number of visual representations of the participants in the three-dimensional environment changes. For example, if the third participant discussed above joins the real-time communication session, the computer system updates the three-dimensional environment to include a third visual representation of the third participant, which includes updating the spatial arrangement (e.g., to the first updated spatial arrangement or the second updated spatial arrangement depending on the spatial distribution when the third participant joined, as similarly discussed above with reference to step(s) 1802) to accommodate the display of the third visual representation. In some embodiments, if a participant (e.g., the first participant or the second participant) leaves the real-time communication session, the computer system updates the three-dimensional environment to no longer include the visual representation of the participant (e.g., the first visual representation of the first participant or the second visual representation of the second participant), which includes updating the spatial arrangement, as similarly discussed above, after the visual representation of the participant is no longer displayed. Resetting a spatial distribution of one or more users in a real-time communication session, including updating locations at which visual representations of one or more users are displayed in a three-dimensional environment, in response to detecting a change in a number of the one or more users in the real-time communication session reduces the number of inputs needed to manually move the viewpoint(s) of the user(s) within the real-time communication session and/or enables the spatial distribution to be reset automatically, thereby improving user-device interaction.

In some embodiments, detecting the first event includes detecting, via the one or more input devices, user input corresponding to the request to reset the spatial distribution of one or more participants in the real-time communication session, such as selection of button 1731b or selection of option 1715 as shown in FIGS. 17C and 17C1. For example, as similarly discussed above with reference to step(s) 1802, the first event includes user input directed to a selectable option that is displayed in the three-dimensional environment and that is selectable to reset the spatial distribution of the one or more participants in the real-time communication session. In some embodiments, the user input includes an air gesture performed by a hand of the user of the computer system. For example, the computer system detects an air pinch gesture or an air tap gesture while attention (e.g., including gaze) of the user is directed to the selectable option. In some embodiments, the first event includes user input directed to a hardware button of the one or more input devices in communication with the computer system. For example, the computer system detects a press of a physical button of the computer system that is selectable to reset the spatial distribution of the one or more participants in the real-time communication session. Resetting a spatial distribution of one or more users in a real-time communication session, including updating locations at which visual representations of one or more users are displayed in a three-dimensional environment, in response to detecting user input corresponding to a request to reset the spatial distribution reduces the number of inputs needed to manually move the viewpoint(s) of the user(s) within the real-time communication session and/or enables the spatial distribution to be reset automatically, thereby improving user-device interaction.

In some embodiments, in response to detecting the first event, displaying the respective updated spatial arrangement of the elements of the real-time communication session includes, in accordance with the determination that the spatial distribution of the first visual representation of the first participant and the second visual representation of the second participant when the first event was detected was the first spatial distribution, displaying, in the first updated spatial arrangement of elements of the real-time communication session, the first visual representation of the first participant at a first updated location and the second visual representation of the second participant at a second updated location, wherein the first updated location, the second updated location, and the current viewpoint of the user are determined relative to a first estimated center of the first spatial distribution, such as positioning the first visual representation 1706, the second visual representation 1708, and the viewpoint of user 1704 based on estimated center 1719 as shown in the schematic view in FIG. 17D. In some embodiments, before detecting the first event, the first estimated center of the first spatial distribution is estimated based on the first location at which the first visual representation of the first participant is displayed, the second location at which the second visual representation of the second participant is displayed, and the current viewpoint of the user. In some embodiments, when the computer system detects the first event, the computer system updates the three-dimensional environment from the current viewpoint of the user such that, in the first updated spatial arrangement, the first visual representation of the first participant and the second visual representation of the second participant visually appear to be approximately the same distance from the estimated center of the elements of the real-time communication session. For example, when the computer system displays the first updated spatial arrangement of the elements of the real-time communication session, a distance between the first updated location and the first estimated center, a distance between the second updated location and the first estimated center, and a distance between the current viewpoint and the first estimated center are approximately the same in the three-dimensional environment.

In some embodiments, in accordance with the determination that the spatial distribution of the first visual representation of the first participant and the second visual representation of the second participant when the first event was detected was the second spatial distribution, the computer system displays, in the second updated spatial arrangement of elements of the real-time communication session, the first visual representation of the first participant at a third updated location, different from the first updated location, and the second visual representation of the second participant at a fourth updated location, different from the second updated location, wherein the third updated location, the fourth updated location, and the current viewpoint of the user are determined relative to a second estimated center of the second spatial distribution (e.g., different from the first estimated center of the first spatial distribution), such as positioning the first visual representation 1706, the second visual representation 1708, and the viewpoint of user 1704 based on estimated center 1719 as shown in the schematic view in FIG. 17F. In some embodiments, as similarly discussed above, before detecting the first event, the second estimated center of the second spatial distribution is estimated based on the first location at which the first visual representation of the first participant is displayed, the second location at which the second visual representation of the second participant is displayed, and the current viewpoint of the user. In some embodiments, when the computer system detects the first event, the computer system updates the three-dimensional environment from the current viewpoint of the user such that, in the second updated spatial arrangement, the first visual representation of the first participant and the second visual representation of the second participant visually appear to be approximately the same distance from the estimated center of the elements of the real-time communication session. For example, when the computer system displays the second updated spatial arrangement of the elements of the real-time communication session, a distance between the third updated location and the second estimated center, a distance between the fourth updated location and the second estimated center, and a distance between the current viewpoint and the second estimated center are approximately the same in the three-dimensional environment. Resetting a spatial distribution of one or more users in a real-time communication session, including updating locations at which visual representations of one or more users are displayed in a three-dimensional environment, based on an estimated center of the spatial distribution in response to detecting a request to reset the spatial distribution reduces the number of inputs needed to manually arrange the viewpoint(s) of the user(s) within the real-time communication session around the estimated center and/or enables the one or more users to automatically be arranged around the estimated center, thereby improving user-device interaction and user-user interaction in the real-time communication session.

In some embodiments, in response to detecting the first event, displaying the respective updated spatial arrangement of the elements of the real-time communication session includes, in accordance with the determination that the spatial distribution of the first visual representation of the first participant and the second visual representation of the second participant when the first event was detected was the first spatial distribution (e.g., in which the first visual representation and the second visual representation are adjacently positioned), displaying, in the first updated spatial arrangement of elements of the real-time communication session, the first visual representation of the first participant at a first updated location and the second visual representation of the second participant at a second updated location, wherein the current viewpoint of the user is offset a first distance (e.g., a predefined distance) from a line (e.g., a non-visual/non-displayed line) between the first updated location and the second updated location, such as display of the first visual representation 1706 and the second visual representation 1708 along a line that is offset from the current viewpoint of the user 1704 by a first distance as shown in the schematic view in FIG. 17A. For example, when the computer system displays the first updated spatial arrangement of the elements of the real-time communication session in response to detecting the first event, the computer system repositions the first visual representation of the first participant and the second visual representation of the second participant in the three-dimensional environment relative to the current viewpoint of the user. In some embodiments, the current viewpoint of the user is positioned at the first distance to be perpendicular/normal to (e.g., within a threshold amount of being perpendicular to, such as 0, 1, 3, 5, 10, 15, 20, or 30 degrees) the line between the first updated location and the second updated location. In some embodiments, a distance (e.g., a distance of the line discussed above) between the first visual representation and the second visual representation is maintained when the computer system displays the first updated spatial arrangement of the elements of the real-time communication session. Accordingly, in the first updated spatial arrangement of the elements of the real-time communication session, the current viewpoint of the user is positioned the first distance from a center of the line between the first updated location and the second updated location in the three-dimensional environment (e.g., a line spanning the second distance that intersects the line between the first updated location and the second updated location forms a right angle with the line between the first updated location and the second updated location). For example, from the current viewpoint of the user, the first visual representation of the first participant and the second visual representation of the second participant are offset to the right and the left of the user's forward-facing direction, optionally by the same distance. In some embodiments, the distance between the first updated location and the second updated location remains unchanged when the first spatial distribution is reset because the first updated location and the second updated location are not caused to be changed in response to user input by the first participant and the second participant. For example, when the first event is detected, the first participant and the second participant in the real-time communication session do not move in their respective three-dimensional environments, such that the first visual representation and the second visual representation remain displayed the same distance apart.

In some embodiments, in accordance with the determination that the spatial distribution of the first visual representation of the first participant and the second visual representation of the second participant when the first event was detected was the second spatial distribution (e.g., in which the first visual representation and the second visual representation are adjacently positioned), the computer system displays, in the second updated spatial arrangement of elements of the real-time communication session, the first visual representation of the first participant at a third updated location, different from the first updated location, and the second visual representation of the second participant at a fourth updated location, different from the second updated location, wherein the current viewpoint of the user is offset a second distance (e.g., different from the first distance) from a line between the third updated location and the fourth updated location, such as display of the first visual representation 1706 and the second visual representation 1708 along a line that is offset from the current viewpoint of the user 1704 by a second distance as shown in the schematic view in FIG. 17B. For example, when the computer system displays the second updated spatial arrangement of the elements of the real-time communication session in response to detecting the first event, the computer system repositions the first visual representation of the first participant and the second visual representation of the second participant in the three-dimensional environment relative to the current viewpoint of the user. In some embodiments, a distance (e.g., a distance of the line discussed above) between the first visual representation and the second visual representation is maintained when the computer system displays the second updated spatial arrangement of the elements of the real-time communication session. Accordingly, in the second updated spatial arrangement of the elements of the real-time communication session, the current viewpoint of the user is positioned the second distance from a center of the line between the third updated location and the fourth updated location in the three-dimensional environment (e.g., a line spanning the second distance that intersects the line between the third updated location and the fourth updated location forms a right angle with the line between the third updated location and the fourth updated location). For example, from the current viewpoint of the user, the first visual representation of the first participant and the second visual representation of the second participant are offset to the right and the left of the user's forward-facing direction, optionally by the same distance. Resetting a spatial distribution of one or more users in a real-time communication session, including updating locations at which visual representations of one or more users are displayed in a three-dimensional environment, based on locations of the one or more visual representations in response to detecting a request to reset the spatial distribution reduces the number of inputs needed to manually move the viewpoint(s) of the user(s) within the real-time communication session and/or enables one or more users to automatically be positioned in front of the current viewpoint of the user, thereby improving user-device interaction and user-user interaction in the real-time communication session.

In some embodiments, in response to detecting the first event, displaying the respective updated spatial arrangement of the elements of the real-time communication session includes, in accordance with the determination that the spatial distribution of the first visual representation of the first participant and the second visual representation of the second participant when the first event was detected was the first spatial distribution (e.g., in which the first visual representation and the second visual representation are adjacently positioned), displaying, in the first updated spatial arrangement of elements of the real-time communication session, the first visual representation of the first participant at a first updated location and the second visual representation of the second participant at a second updated location, wherein the first updated location and the second updated location are positioned (optionally within 0.1, 0.5, 1, 3, 5, 10, 15, or 25% of both being) a first distance from the current viewpoint of the user (e.g., the first updated location and the second updated location are approximately equidistant from the current viewpoint of the user in the first updated spatial arrangement), such as display of the first visual representation 1706 and the second visual representation 1708 at a first distance from the current viewpoint of the user 1704 as shown in the schematic view in FIG. 17D. For example, if the number of the plurality of participants in the real-time communication session is three, in the first updated spatial arrangement of the elements of the real-time communication session, the first visual representation of the first participant, the second visual representation of the second participant and the current viewpoint of the user form a first triangular arrangement of elements (e.g., similar to an isosceles triangle). In some embodiments, from the current viewpoint of the user, the first visual representation of the first participant and the second visual representation of the second participant are offset to the right and the left of the user's forward-facing direction by the first distance.

In some embodiments, in accordance with the determination that the spatial distribution of the first visual representation of the first participant and the second visual representation of the second participant when the first event was detected was the second spatial distribution (e.g., in which the first visual representation and the second visual representation are adjacently positioned), the computer system displays, in the second updated spatial arrangement of elements of the real-time communication session, the first visual representation of the first participant at a third updated location, different from the first updated location, and the second visual representation of the second participant at a fourth updated location, different from the second updated location, wherein the third updated location and the fourth updated location are positioned a second distance (e.g., different from the first distance, such as optionally within 0.1, 0.5, 1, 3, 5, 10, 15, or 25% of both being)) from the current viewpoint of the user (e.g., the third updated location and the fourth updated location are approximately equidistant from the current viewpoint of the user in the second updated spatial arrangement), such as display of the first visual representation 1706 and the second visual representation 1708 at a second distance from the current viewpoint of the user 1704 as shown in the schematic view in FIG. 17F. For example, as similarly discussed above, if the number of the plurality of participants in the real-time communication session is three, in the second updated spatial arrangement of the elements of the real-time communication session, the first visual representation of the first participant, the second visual representation of the second participant and the current viewpoint of the user form a second triangular arrangement of elements (e.g., similar to an isosceles triangle), different from the first triangular arrangement above. In some embodiments, as similarly discussed above, from the current viewpoint of the user, the first visual representation of the first participant and the second visual representation of the second participant are offset to the right and the left of the user's forward-facing direction by the second distance. Resetting a spatial distribution of one or more users in a real-time communication session, including updating locations at which visual representations of one or more users are displayed in a three-dimensional environment to be equidistant from a current viewpoint of the user, in response to detecting a request to reset the spatial distribution reduces the number of inputs needed to manually move the viewpoint(s) of the user(s) within the real-time communication session to be equidistant from the current viewpoint and/or enables one or more users to automatically be positioned in front of the current viewpoint of the user, thereby improving user-device interaction and user-user interaction in the real-time communication session.

In some embodiments, in response to detecting the first event, displaying the respective updated spatial arrangement of the elements of the real-time communication session includes, in accordance with the determination that the spatial distribution of the first visual representation of the first participant and the second visual representation of the second participant when the first event was detected was the first spatial distribution, displaying, in the first updated spatial arrangement of elements of the real-time communication session, the first visual representation of the first participant at a first updated location and the second visual representation of the second participant at a second updated location in a field of view of the three-dimensional environment from the current viewpoint of the user (e.g., the first updated location of the first visual representation and the second updated location of the second visual representation are positioned within the user's field of view after the reset event is detected), such as displaying the first visual representation 1706 and the second visual representation 1708 in the field of view of the user 1704 as shown in the schematic view in FIG. 17D. For example, the computer system selects an orientation for the current viewpoint of the user that causes the current viewpoint to be angled towards the first updated location and the second updated location at which the first visual representation and the second visual representation are displayed, such that the first updated location and the second updated location are in the field of view of the user. In some embodiments, when the first event is detected, one or more of the first visual representation of the first participant and the second visual representation of the second participant are in the field of view of the three-dimensional environment from the current viewpoint of the user in the first spatial distribution (e.g., but displayed in locations that are different from the first updated location and the second updated location). In some embodiments, when the first event is detected, one or more of the first visual representation of the first participant and the second visual representation of the second participant are outside of the field of view of the three-dimensional environment from the current viewpoint in the first spatial distribution.

In some embodiments, in accordance with the determination that the spatial distribution of the first visual representation of the first participant and the second visual representation of the second participant when the first event was detected was the second spatial distribution, the computer system displays, in the second updated spatial arrangement of elements of the real-time communication session, the first visual representation of the first participant at a third updated location, different from the first updated location, and the second visual representation of the second participant at a fourth updated location, different from the second updated location, in the field of view of the three-dimensional environment from the current viewpoint of the user (e.g., the third updated location of the first visual representation and the fourth updated location of the second visual representation are positioned within the user's field of view after the reset event is detected), such as displaying the first visual representation 1706 and the second visual representation 1708 in the field of view of the user 1704 as shown in the schematic view in FIG. 17F. For example, the computer system selects an orientation for the current viewpoint of the user that causes the current viewpoint to be angled towards the third updated location and the fourth updated location at which the first visual representation and the second visual representation are displayed, such that the third updated location and the fourth updated location are in the field of view of the user. In some embodiments, when the first event is detected, one or more of the first visual representation of the first participant and the second visual representation of the second participant are in the field of view of the three-dimensional environment from the current viewpoint of the user in the second spatial distribution (e.g., but displayed in locations that are different from the third updated location and the fourth updated location). In some embodiments, when the first event is detected, one or more of the first visual representation of the first participant and the second visual representation of the second participant are outside of the field of view of the three-dimensional environment from the current viewpoint in the second spatial distribution. Resetting a spatial distribution of one or more users in a real-time communication session, including updating locations at which visual representations of one or more users are displayed in a three-dimensional environment, based on locations of the visual representations of the one or more users in the three-dimensional environment in response to detecting a request to reset the spatial distribution reduces the number of inputs needed to manually move the viewpoint(s) of the user(s) within the real-time communication session and/or enables the spatial distribution to be reset automatically, without the need for further input to allow the user to interact with the other users in the real-time communication session, thereby improving user-device interaction.

In some embodiments, the plurality of participants in the real-time communication session includes a third participant, wherein a third visual representation (e.g., third visual representation 1710 in FIG. 17B) of the third participant is displayed at a third location, different from the first location and the second location, in the three-dimensional environment in the first spatial arrangement of the elements in the real-time communication session. For example, as similarly described above with reference to step(s) 1802, the third participant corresponds to a fourth user of a fourth computer system, different from the computer system, who is participating in the real-time communication session. In some embodiments, the third visual representation of the third participant is similar to the first visual representation and the second visual representation discussed above with reference to step(s) 1802.

In some embodiments, in the first spatial distribution, the first location (e.g., the location of the first visual representation 1706 in FIG. 17E) is spaced apart from the second location (e.g., the location of the second visual representation 1708 in FIG. 17E) by a first distance, the first location is spaced apart from the third location by a second distance, smaller than the first distance by more than a threshold amount (e.g., a threshold distance, such as 0.05, 0.1, 0.25, 0.5, 0.75, 1, 1.5, 2, or 3 m, a threshold arc length in degrees, such as 1, 2, 3, 4, 5, 10, 15, 20, 25, 30, or 40 degrees, relative to an estimated center of the first spatial distribution (e.g., such as the estimated center discussed above), or a threshold percentage, such as 0.1, 0.5, 0.75, 1, 2, 5, 10, 15, 17, or 20 percent), and the second location is spaced apart from the third location (e.g., the location of the third visual representation 1710 in FIG. 17E) by a third distance, smaller than the first distance by more than the threshold distance. For example, while the computer system is displaying the three-dimensional environment and before detecting the first event, if the plurality of participants in the real-time communication session has the first spatial distribution, the first visual representation of the first participant is spaced apart from the second visual representation of the second participant by the first distance, the first visual representation is spaced apart from the third visual representation of the third participant by the second distance, and the second visual representation is spaced apart from the third visual representation by the third distance (e.g., irrespective of the current viewpoint of the user).

In some embodiments, in the second spatial distribution, the first location (e.g., the location of the first visual representation 1706 in FIG. 17G) is spaced apart from the third location (e.g., the location of the third visual representation 1710 in FIG. 17G) by a fourth distance, the first location is spaced apart from the second location (e.g., the location of the second visual representation 1708 in FIG. 17G) by a fifth distance, smaller than the fourth distance by more than the threshold distance, and the second location is spaced apart from the third location by a sixth distance, smaller than the fourth distance by more than the threshold amount. For example, while the computer system is displaying the three-dimensional environment and before detecting the first event, if the plurality of participants in the real-time communication session has the second spatial distribution, the first visual representation of the first participant is spaced apart from the third visual representation of the third participant by the fourth distance, the first visual representation is spaced apart from the second visual representation of the second participant by the fifth distance, and the second visual representation is spaced apart from the third visual representation by the sixth distance (e.g., irrespective of the current viewpoint of the user).

In some embodiments, in response to detecting the first event, displaying the respective updated spatial arrangement of the elements of the real-time communication session includes, in accordance with the determination that the spatial distribution of the first visual representation of the first participant, the second visual representation of the second participant, and the third visual representation of the third participant when the first event was detected was the first spatial distribution, displaying content from a current viewpoint of the user, wherein the current viewpoint is positioned between the first updated location and the second updated location, such as positioning the current viewpoint of the user 1704 between the first visual representation 1706 and the second visual representation 1708 as shown in the schematic view in FIG. 17F. In some embodiments, the computer system displays the first visual representation of the first participant at a first updated location, the second visual representation of the second participant at a second updated location, and the third visual representation of the third participant at a third updated location from the current viewpoint in the first updated spatial arrangement of elements in the real-time communication session. For example, from the current viewpoint of the user, the first visual representation of the first participant and the second visual representation of the second participant are displayed on either side of the user (e.g., the current viewpoint is positioned at a seat that is between the first participant and the second participant as similarly discussed above with reference to step(s) 1802). In some embodiments, in response to detecting the first event, the computer system identifies the largest gap (e.g., seat) between adjacent participants (e.g., represented by the visual representations) in the three-dimensional environment. As discussed above, in the first spatial distribution, the gap (e.g., separation) between the first location and the second location, which is equal to the first distance, is optionally the largest gap in the three-dimensional environment. In some embodiments, after identifying the largest gap (e.g., seat) in the first spatial distribution, the computer system determines whether the largest gap is larger than any other gaps by more than the threshold amount discussed above. For example, as discussed above, the first distance is larger than the second distance and the first distance is larger than the third distance by more than the threshold distance and/or the threshold degrees above in the first spatial distribution. In some embodiments, because the gap between the first location and the second location, which is equal to the first distance, is the largest gap in the first spatial distribution and is larger than the other gaps, which are equal to the second distance and the third distance, by more than the threshold amount, the computer system selects the gap between the first location and the second location as the seat at which the current viewpoint is positioned in the first updated spatial arrangement of the elements of the real-time communication session. Accordingly, in some embodiments, from the current viewpoint of the user in the first updated spatial arrangement, the first updated location and the second updated location are positioned on either side of the current viewpoint in the three-dimensional environment. In some embodiments, when the computer system displays the first updated spatial arrangement of elements of the real-time communication session, the first visual representation of the first participant and the second visual representation of the second participant remain displayed spaced apart by the first distance discussed above from the current viewpoint. Similarly, the first visual representation of the first participant remains spaced apart from the third visual representation of the third participant by the second distance, and the second visual representation of the second participant remains spaced apart from the third visual representation of the third participant by the third distance discussed above from the current viewpoint.

In some embodiments, in accordance with the determination that the spatial distribution of the first visual representation of the first participant and the second visual representation of the second participant when the first event was detected was the second spatial distribution, the computer system displays updated content from a current viewpoint of the user, wherein the current viewpoint is positioned between the fourth updated location and the sixth updated location, such as positioning the current viewpoint of the user 1704 between the first visual representation 1706 and the third visual representation 1710 as shown in the schematic view in FIG. 17H. In some embodiments, the computer system displays the first visual representation of the first participant at a fourth updated location, the second visual representation of the second participant at a fifth updated location, and the third visual representation of the third participant at a sixth updated location from the current viewpoint of the user in the second updated spatial arrangement of elements of the real-time communication session. For example, from the current viewpoint of the user, the first visual representation of the first participant and the third visual representation of the third participant are displayed on either side of the user (e.g., the current viewpoint is positioned at a seat that is between the first participant and the third participant as similarly discussed above with reference to step(s) 1802). In some embodiments, in response to detecting the first event, the computer system identifies the largest gap (e.g., seat) between adjacent participants (e.g., represented by the visual representations) in the three-dimensional environment. As discussed above, in the second spatial distribution, the gap (e.g., separation) between the first location and the third location, which is equal to the fourth distance, is optionally the largest gap in the three-dimensional environment. In some embodiments, after identifying the largest gap (e.g., seat) in the second spatial distribution, the computer system determines whether the largest gap is larger than any other gaps by more than the threshold amount discussed above. For example, as discussed above, the fourth distance is larger than the fifth distance and the fourth distance is larger than the sixth distance by more than the threshold distance and/or the threshold degrees above in the second spatial distribution. In some embodiments, because the gap between the first location and the third location, which is equal to the fourth distance, is the largest gap in the second spatial distribution and is larger than the other gaps, which are equal to the fifth distance and the sixth distance, by more than the threshold amount, the computer system selects the gap between the first location and the third location as the seat at which the current viewpoint is positioned in the second updated spatial arrangement of the elements of the real-time communication session. Accordingly, in some embodiments, from the current viewpoint of the user in the first updated spatial arrangement, the fourth updated location and the sixth updated location are positioned on either side of the current viewpoint in the three-dimensional environment. In some embodiments, when the computer system displays the second updated spatial arrangement of elements of the real-time communication session, the first visual representation of the first participant and the third visual representation of the third participant remain displayed spaced apart by the third distance discussed above from the current viewpoint. Similarly, the first visual representation of the first participant remains spaced apart from the second visual representation of the second participant by the fifth distance, and the second visual representation of the second participant remains spaced apart from the third visual representation of the third participant by the sixth distance discussed above from the current viewpoint. Resetting a spatial distribution of one or more users in a real-time communication session, including updating locations at which visual representations of one or more users are displayed in a three-dimensional environment, based on spatial openings between the visual representations of the one or more users in response to detecting a request to reset the spatial distribution enables the current viewpoint to be positioned in a spatial opening automatically, which helps avoid potential spatial conflicts with the visual representations of the one or more users, thereby improving user-device interaction.

In some embodiments, the plurality of participants in the real-time communication session includes a third participant, wherein a third visual representation (e.g., the third visual representation 1710 in FIG. 17B) of the third participant is displayed at a third location, different from the first location and the second location, in the three-dimensional environment in the first spatial arrangement of the elements in the real-time communication session (e.g., as similarly described above). In some embodiments, in the first spatial distribution, the first location (e.g., the location of the first visual representation 1706 in FIG. 17I) is spaced apart from the second location (e.g., the location of the second visual representation 1708 in FIG. 17I) by a first distance, the first location is spaced apart from the third location (e.g., the location of the third visual representation 1710 in FIG. 17I) by a second distance that is smaller than the first distance by less than a threshold amount (e.g., a threshold distance, such as 0.05, 0.1, 0.25, 0.5, 0.75, 1, 1.5, 2, or 3 m, a threshold arc length in degrees, such as 1, 2, 3, 4, 5, 10, 15, 20, 25, 30, or 40 degrees, relative to an estimated center of the first spatial distribution (e.g., such as the estimated center discussed above), or a threshold percentage, such as 0.1, 0.5, 0.75, 1, 2, 5, 10, 15, 17, or 20 percent), and the second location is spaced apart from the third location by a third distance that is smaller than the first distance by less than the threshold distance. For example, while the computer system is displaying the three-dimensional environment and before detecting the first event, if the plurality of participants in the real-time communication session has the first spatial distribution, the first visual representation of the first participant is spaced apart from the second visual representation of the second participant by the first distance, the first visual representation is spaced apart from the third visual representation of the third participant by the second distance, and the second visual representation is spaced apart from the third visual representation by the third distance (e.g., irrespective of the current viewpoint of the user).

In some embodiments, in the second spatial distribution, the first location (e.g., the location of the first visual representation 1706 in FIG. 17K) is spaced apart from the third location (e.g., the location of the third visual representation 1710 in FIG. 17K) by a fourth distance, the first location is spaced apart from the second location (e.g., the location of the second visual representation 1708 in FIG. 17K) by a fifth distance that is smaller than the fourth distance by less than the threshold amount, and the second location is spaced apart from the third location by a sixth distance that is smaller than the fourth distance by less than the threshold distance. For example, while the computer system is displaying the three-dimensional environment and before detecting the first event, if the plurality of participants in the real-time communication session has the second spatial distribution, the first visual representation of the first participant is spaced apart from the third visual representation of the third participant by the fourth distance, the first visual representation is spaced apart from the second visual representation of the second participant by the fifth distance, and the second visual representation is spaced apart from the third visual representation by the sixth distance (e.g., irrespective of the current viewpoint of the user).

In some embodiments, in response to detecting the first event, displaying the respective updated spatial arrangement of the elements of the real-time communication session includes, in accordance with the determination that the spatial distribution of the first visual representation of the first participant, the second visual representation of the second participant, and the third visual representation of the third participant when the first event was detected was the first spatial distribution and that a separation (e.g., a gap or open seat) between the first location and the second location is closer to the current viewpoint than a separation between the first location and the third location and a separation between the second location and the third location when the first event was detected, displaying content from a current viewpoint of the user, wherein the current viewpoint is positioned between the first updated location and the second updated location, such as positioning the current viewpoint of the user 1704 between the first visual representation 1706 and the second visual representation 1708 as shown in the schematic view in FIG. 17J. In some embodiments, the computer system displays, in the first updated spatial arrangement of elements of the real-time communication session, the first visual representation of the first participant at a first updated location, the second visual representation of the second participant at a second updated location, and the third visual representation of the third participant at a third updated location from the current viewpoint of the user. For example, from the current viewpoint of the user, the first visual representation of the first participant and the second visual representation of the second participant are displayed on either side of the user (e.g., the current viewpoint is positioned at a seat that is between the first participant and the second participant as similarly discussed above with reference to step(s) 1802). In some embodiments, in response to detecting the first event, the computer system identifies the largest gap (e.g., seat) between adjacent participants (e.g., represented by the visual representations) in the three-dimensional environment. As discussed above, in the first spatial distribution, the gap (e.g., separation) between the first location and the second location, which is equal to the first distance, is optionally the largest gap in the three-dimensional environment. However, because the first distance is larger than the second distance and the third distance discussed above by less than the threshold distance, the computer system optionally determines whether the separation between the first location and the second location is closer to the current viewpoint of the user than the separation between the first location and the third location and the separation between the second location and the third location. In some embodiments, as discussed above, because the separation between the first location and the second location is closer to the current viewpoint than the separation between the first location and the third location and the separation between the second location and the third location, the computer system selects the separation between the first location and the second location as the seat at which the current viewpoint is positioned in the first updated spatial arrangement of the elements of the real-time communication session. Accordingly, in some embodiments, from the current viewpoint of the user in the first updated spatial arrangement, the first updated location and the second updated location are positioned on either side of the current viewpoint in the three-dimensional environment. In some embodiments, when the computer system displays the first updated spatial arrangement of elements of the real-time communication session, the first visual representation of the first participant and the second visual representation of the second participant remain displayed spaced apart by the first distance discussed above from the current viewpoint. Similarly, the first visual representation of the first participant remains spaced apart from the third visual representation of the third participant by the second distance, and the second visual representation of the second participant remains spaced apart from the third visual representation of the third participant by the third distance discussed above from the current viewpoint. In some embodiments, in accordance with a determination that the separation between the first location and the third location is closer to the viewpoint of the user than the separation between the second location and the third location, the current viewpoint of the user in the first updated spatial arrangement is positioned between the first updated location and the second updated location. In some embodiments, in accordance with a determination that the separation between the second location and the third location is closer to the viewpoint of the user than the separation between the first location and the second location and the separation between the first location and the third location, the current viewpoint of the user in the first updated spatial arrangement is positioned between the second updated location and the third updated location.

In some embodiments, in accordance with the determination that the spatial distribution of the first visual representation of the first participant and the second visual representation of the second participant when the first event was detected was the second spatial distribution and that the separation (e.g., a gap or open seat) between the first location and the third location is closer to the current viewpoint than the separation between the first location and the second location and the separation between the second location and the third location when the first event was detected, the computer system displays updated content from the current viewpoint of the user, wherein the current viewpoint is positioned between the fourth updated location and the sixth updated location, such as positioning the current viewpoint of the user 1704 between the first visual representation 1706 and the third visual representation 1708 as shown in the schematic view in FIG. 17L. In some embodiments, the computer system displays, in the second updated spatial arrangement of elements of the real-time communication session, the first visual representation of the first participant at a fourth updated location, the second visual representation of the second participant at a fifth updated location, and the third visual representation of the third participant at a sixth updated location from the current viewpoint of the user. For example, from the current viewpoint of the user, the first visual representation of the first participant and the third visual representation of the third participant are displayed on either side of the user (e.g., the current viewpoint is positioned at a seat that is between the first participant and the third participant as similarly discussed above with reference to step(s) 1802). In some embodiments, as similarly discussed above, in response to detecting the first event, the computer system identifies the largest gap (e.g., seat) between adjacent participants (e.g., represented by the visual representations) in the three-dimensional environment. As discussed above, in the second spatial distribution, the gap (e.g., separation) between the first location and the third location, which is equal to the fourth distance, is optionally the largest gap in the three-dimensional environment. However, because the fourth distance is larger than the fifth distance and the sixth distance discussed above by less than the threshold distance, the computer system optionally determines whether the separation between the first location and the third location is closer to the current viewpoint of the user than the separation between the first location and the second location and the separation between the second location and the third location. In some embodiments, as discussed above, because the separation between the first location and the third location is closer to the current viewpoint than the separation between the first location and the second location and the separation between the second location and the third location, the computer system selects the separation between the first location and the third location as the seat at which the current viewpoint is positioned in the second updated spatial arrangement of the elements of the real-time communication session. Accordingly, in some embodiments, from the current viewpoint of the user in the second updated spatial arrangement, the fourth updated location and the sixth updated location are positioned on either side of the current viewpoint in the three-dimensional environment. In some embodiments, when the computer system displays the second updated spatial arrangement of elements of the real-time communication session, the first visual representation of the first participant and the third visual representation of the third participant remain displayed spaced apart by the third distance discussed above from the current viewpoint. Similarly, the first visual representation of the first participant remains spaced apart from the second visual representation of the second participant by the fifth distance, and the second visual representation of the second participant remains spaced apart from the third visual representation of the third participant by the sixth distance discussed above from the current viewpoint. In some embodiments, in accordance with a determination that the separation between the first location and the third location is closer to the viewpoint of the user than the separation between the second location and the third location, the current viewpoint of the user in the first updated spatial arrangement is positioned between the fourth updated location and the fifth updated location. In some embodiments, in accordance with a determination that the separation between the second location and the third location is closer to the viewpoint of the user than the separation between the first location and the second location and the separation between the first location and the third location, the current viewpoint of the user in the first updated spatial arrangement is positioned between the fifth updated location and the sixth updated location. Resetting a spatial distribution of one or more users in a real-time communication session, including updating locations at which visual representations of one or more users are displayed in a three-dimensional environment, based on spatial openings between the visual representations of the one or more users relative to a current viewpoint of the user in response to detecting a request to reset the spatial distribution enables the current viewpoint to be positioned in a spatial opening that is closest to the current viewpoint automatically, which reduces the discontinuity in presentation of the three-dimensional environment relative to the viewpoint and/or helps avoid potential spatial conflicts with the visual representations of the one or more users, thereby improving user-device interaction.

In some embodiments, the plurality of participants in the real-time communication session includes a third participant, wherein a third visual representation (e.g., third visual representation 1710 in FIG. 17B) of the third participant is displayed at a third location, different from the first location and the second location, in the three-dimensional environment in the first spatial arrangement of the elements in the real-time communication session (e.g., as similarly discussed above with reference to the third participant above). In some embodiments, in the first spatial distribution, the first location (e.g., the location of the first visual representation 1706 in FIG. 17I) is spaced apart from the second location (e.g., the location of the second visual representation 1708 in FIG. 17I) by a first distance, the first location is spaced apart from the third location (e.g., the location of the third visual representation 1710 in FIG. 17I) by a second distance, and the second location is spaced apart from the third location by a third distance, wherein the first distance is larger than the second distance by at least a threshold amount (e.g., a threshold distance, such as 0.05, 0.1, 0.25, 0.5, 0.75, 1, 1.5, 2, or 3 m, a threshold arc length in degrees, such as 1, 2, 3, 4, 5, 10, 15, 20, 25, 30, or 40 degrees, relative to an estimated center of the first spatial distribution (e.g., such as the estimated center discussed above), or a threshold percentage, such as 0.1, 0.5, 0.75, 1, 2, 5, 10, 15, 17, or 20 percent), and the second distance is larger than the third distance (e.g., and the first distance is larger than the third distance by more than the threshold amount). For example, while the computer system is displaying the three-dimensional environment and before detecting the first event, if the plurality of participants in the real-time communication session has the first spatial distribution, the first visual representation of the first participant is spaced apart from the second visual representation of the second participant by the first distance, the first visual representation is spaced apart from the third visual representation of the third participant by the second distance, and the second visual representation is spaced apart from the third visual representation by the third distance (e.g., irrespective of the current viewpoint of the user).

In some embodiments, in the second spatial distribution, the first location (e.g., the location of the first visual representation 1706 in FIG. 17K) is spaced apart from the third location (e.g., the location of the third visual representation 1710 in FIG. 17K) by a fourth distance, the first location is spaced apart from the second location (e.g., the location of the second visual representation 1708 in FIG. 17K) by a fifth distance, and the second location is spaced apart from the third location by a sixth distance, wherein the fourth distance is larger than the fifth distance by at least the threshold amount, and the fifth distance is larger than the sixth distance (e.g., and the fourth distance is larger than the sixth distance by more than the threshold amount). For example, while the computer system is displaying the three-dimensional environment and before detecting the first event, if the plurality of participants in the real-time communication session has the second spatial distribution, the first visual representation of the first participant is spaced apart from the third visual representation of the third participant by the fourth distance, the first visual representation is spaced apart from the second visual representation of the second participant by the fifth distance, and the second visual representation is spaced apart from the third visual representation by the sixth distance (e.g., irrespective of the current viewpoint of the user).

In some embodiments, in response to detecting the first event, displaying the respective updated spatial arrangement of the elements of the real-time communication session includes, in accordance with the determination that the spatial distribution of the first visual representation of the first participant, the second visual representation of the second participant, and the third visual representation of the third participant when the first event was detected was the first spatial distribution, displaying content from the current viewpoint of the user, wherein the current viewpoint is positioned between the first updated location and the second updated location, such as positioning the current viewpoint of the user 1704 between the first visual representation 1706 and the second visual representation 1708 as shown in the schematic view in FIG. 17J. In some embodiments, the computer system displays, in the first updated spatial arrangement of elements of the real-time communication session, the first visual representation of the first participant at a first updated location, the second visual representation of the second participant at a second updated location, and the third visual representation of the third participant at a third updated location from the current viewpoint of the user. For example, from the current viewpoint of the user, the first visual representation of the first participant and the second visual representation of the second participant are displayed on either side of the user (e.g., the current viewpoint is positioned at a seat that is between the first participant and the second participant as similarly discussed above with reference to step(s) 1802). In some embodiments, in response to detecting the first event, the computer system identifies the largest gap (e.g., seat) between adjacent participants (e.g., represented by the visual representations) in the three-dimensional environment. As discussed above, in the first spatial distribution, the gap (e.g., separation) between the first location and the second location, which is equal to the first distance, is optionally the largest gap in the three-dimensional environment. In some embodiments, after identifying the largest gap (e.g., seat) in the first spatial distribution, the computer system determines whether the largest gap is larger than the next largest gap by more than the threshold amount discussed above. For example, as discussed above, the first distance is larger than the second distance, which is the length of the next largest gap in the first spatial distribution, by more than the threshold distance and/or the threshold degrees above. In some embodiments, because the gap between the first location and the second location, which is equal to the first distance, is the largest gap in the first spatial distribution and is larger than the next largest gap, which is equal to the second distance, by more than the threshold amount, the computer system selects the gap between the first location and the second location as the seat at which the current viewpoint is positioned in the first updated spatial arrangement of the elements of the real-time communication session. Accordingly, in some embodiments, from the current viewpoint of the user in the first updated spatial arrangement, the first updated location and the second updated location are positioned on either side of the current viewpoint in the three-dimensional environment. In some embodiments, when the computer system displays the first updated spatial arrangement of elements of the real-time communication session, the first visual representation of the first participant and the second visual representation of the second participant remain displayed spaced apart by the first distance discussed above from the current viewpoint. Similarly, the first visual representation of the first participant remains spaced apart from the third visual representation of the third participant by the second distance, and the second visual representation of the second participant remains spaced apart from the third visual representation of the third participant by the third distance discussed above from the current viewpoint.

In some embodiments, in accordance with the determination that the spatial distribution of the first visual representation of the first participant and the second visual representation of the second participant when the first event was detected was the second spatial distribution, the computer system displays updated content from the current viewpoint of the user, wherein the current viewpoint is positioned between the fourth updated location and the sixth updated location, such as positioning the current viewpoint of the user 1704 between the first visual representation 1706 and the third visual representation 1710 as shown in FIG. 17L. In some embodiments, the computer system displays, in the second updated spatial arrangement of elements of the real-time communication session, the first visual representation of the first participant at a fourth updated location, the second visual representation of the second participant at a fifth updated location, and the third visual representation of the third participant at a sixth updated location from the current viewpoint of the user. For example, from the current viewpoint of the user, the first visual representation of the first participant and the third visual representation of the third participant are displayed on either side of the user (e.g., the current viewpoint is positioned at a seat that is between the first participant and the third participant as similarly discussed above with reference to step(s) 1802). In some embodiments, as similarly discussed above, in response to detecting the first event, the computer system identifies the largest gap (e.g., seat) between adjacent participants (e.g., represented by the visual representations) in the three-dimensional environment. As discussed above, in the second spatial distribution, the gap (e.g., separation) between the first location and the third location, which is equal to the fourth distance, is optionally the largest gap in the three-dimensional environment. In some embodiments, after identifying the largest gap (e.g., seat) in the second spatial distribution, the computer system determines whether the largest gap is larger than the next largest gap by more than the threshold amount discussed above. For example, as discussed above, the fourth distance is larger than the fifth distance, which is the length of the next largest gap in the second spatial distribution, by more than the threshold distance and/or the threshold degrees above. In some embodiments, because the gap between the first location and the second location, which is equal to the fourth distance, is the largest gap in the second spatial distribution and is larger than the next largest gap, which is equal to the fifth distance, by more than the threshold amount, the computer system selects the gap between the first location and the third location as the seat at which the current viewpoint is positioned in the first updated spatial arrangement of the elements of the real-time communication session. Accordingly, in some embodiments, from the current viewpoint of the user in the second updated spatial arrangement, the fourth updated location and the sixth updated location are positioned on either side of the current viewpoint in the three-dimensional environment. In some embodiments, when the computer system displays the second updated spatial arrangement of elements of the real-time communication session, the first visual representation of the first participant and the third visual representation of the third participant remain displayed spaced apart by the third distance discussed above from the current viewpoint. Similarly, the first visual representation of the first participant remains spaced apart from the second visual representation of the second participant by the fifth distance, and the second visual representation of the second participant remains spaced apart from the third visual representation of the third participant by the sixth distance discussed above from the current viewpoint. Resetting a spatial distribution of one or more users in a real-time communication session, including updating locations at which visual representations of one or more users are displayed in a three-dimensional environment, based on spatial openings between the visual representations of the one or more users relative to a current viewpoint of the user in response to detecting a request to reset the spatial distribution enables the current viewpoint to be positioned in a spatial opening that is largest of the spatial openings automatically, which helps avoid potential spatial conflicts with the visual representations of the one or more users, thereby improving user-device interaction.

In some embodiments, in the first spatial distribution, the first location is a first distance from a first estimated center of the first spatial distribution and the second location is a second distance (e.g., different from the first distance) from the first estimated center (e.g., when the first event is detected), such as estimated center 1719 in the schematic view in FIGS. 17C and 17C1. In some embodiments, the first estimated center of the first spatial distribution has one or more characteristics of the estimated center discussed above. In some embodiments, in the second spatial distribution, the first location is a third distance (e.g., different from the first distance) from a second estimated center of the second spatial distribution (e.g., different from the first estimated center) and the second location is a fourth distance (e.g., different from the second distance and the third distance) from the second estimated center (e.g., when the first event is detected), such as estimated center 1719 in FIG. 17E. In some embodiments, the second estimated center of the second spatial distribution has one or more characteristics of the estimated centers discussed above.

In some embodiments, in response to detecting the first event, displaying the respective updated spatial arrangement of the elements of the real-time communication session includes, in accordance with the determination that the spatial distribution of the first visual representation of the first participant and the second visual representation of the second participant when the first event was detected was the first spatial distribution, displaying content from the current viewpoint of the user, wherein the current viewpoint is positioned a first updated distance from the first estimated center of the first spatial distribution that is based on the first distance and the second distance, such as an updated distance between the current viewpoint of the user 1704 and the estimated center 1719 as shown in the schematic view in FIG. 17D. In some embodiments, the computer system displays, in the first spatial arrangement of elements of the real-time communication session, the first visual representation of the first participant at a first updated location and the second visual representation of the second participant at a second updated location from the current viewpoint. For example, the first updated distance is equal or proportional to the first distance and/or the second distance. In some embodiments, the first updated distance is determined by estimating (e.g., calculating) an average of the first distance and the second distance from the first estimated center of the first spatial distribution. In some embodiments, as similarly discussed above, when the computer system detects the first event, the computer system updates the three-dimensional environment from the current viewpoint of the user such that, in the first updated spatial arrangement, the first visual representation of the first participant and the second visual representation of the second participant visually appear to be approximately the same distance from the estimated center of the elements of the real-time communication session. For example, when the computer system displays the first updated spatial arrangement of the elements of the real-time communication session, a distance between the first updated location and the first estimated center, a distance between the second updated location and the first estimated center, and a distance between the current viewpoint and the first estimated center are approximately the same in the three-dimensional environment.

In some embodiments, in accordance with the determination that the spatial distribution of the first visual representation of the first participant and the second visual representation of the second participant when the first event was detected was the second spatial distribution, the computer system displays updated content from the current viewpoint of the user, wherein the current viewpoint is positioned a second updated distance (e.g., different from the first updated distance) from the estimated center of the second spatial distribution that is based on the third distance and the fourth distance, such as updated distance 1711 between the current viewpoint of the user 1704 and the estimated center 1719 as shown in the schematic view in FIG. 17F. In some embodiments, the computer system displays, in the second updated spatial arrangement of elements of the real-time communication session, the first visual representation of the first participant at a third updated location, different from the first updated location, and the second visual representation of the second participant at a fourth updated location, different from the second updated location from the current viewpoint. For example, the second updated distance is equal or proportional to the third distance and/or the fourth distance. In some embodiments, the second updated distance is determined by estimating (e.g., calculating) an average of the third distance and the fourth distance from the estimated center of the second spatial distribution. In some embodiments, as similarly discussed above, when the computer system detects the first event, the computer system updates the three-dimensional environment from the current viewpoint of the user such that, in the second updated spatial arrangement, the first visual representation of the first participant and the second visual representation of the second participant visually appear to be approximately the same distance from the estimated center of the elements of the real-time communication session. For example, when the computer system displays the second updated spatial arrangement of the elements of the real-time communication session, a distance between the third updated location and the second estimated center, a distance between the fourth updated location and the second estimated center, and a distance between the current viewpoint and the second estimated center are approximately the same in the three-dimensional environment. Resetting a spatial distribution of one or more users in a real-time communication session, including updating locations at which visual representations of one or more users are displayed in a three-dimensional environment, based on an average of distances of the visual representations of the one or more users relative to an estimated center of the spatial distribution in response to detecting a request to reset the spatial distribution reduces the number of inputs needed to manually arrange the viewpoint(s) of the user(s) within the real-time communication session around the estimated center and/or enables the one or more users to automatically be arranged around the estimated center, thereby improving user-device interaction and user-user interaction in the real-time communication session.

In some embodiments, the plurality of participants in the real-time communication session includes a third participant, wherein a third visual representation (e.g., third visual representation 1710 in FIG. 17B) of the third participant is displayed at a third location, different from the first location and the second location, in the three-dimensional environment in the first spatial arrangement of the elements in the real-time communication session (e.g., as similarly described above). In some embodiments, in the first spatial distribution, the first location (e.g., the location of the first visual representation 1706 in FIG. 17K) is spaced apart from the second location (e.g., the location of the second visual representation 1708 in FIG. 17K) by a first distance, the first location is spaced apart from the third location (e.g., the location of the third visual representation 1710 in FIG. 17K) by a second distance, and the second location is spaced apart from the third location by a third distance, wherein the first distance is larger than the second distance by less than a threshold amount (e.g., a threshold distance, such as 0.05, 0.1, 0.25, 0.5, 0.75, 1, 1.5, 2, or 3 m, a threshold arc length in degrees, such as 1, 2, 3, 4, 5, 10, 15, 20, 25, 30, or 40 degrees, relative to an estimated center of the first spatial distribution (e.g., such as the estimated center discussed above), or a threshold percentage, such as 0.1, 0.5, 0.75, 1, 2, 5, 10, 15, 17, or 20 percent). For example, while the computer system is displaying the three-dimensional environment and before detecting the first event, if the plurality of participants in the real-time communication session has the first spatial distribution, the first visual representation of the first participant is spaced apart from the second visual representation of the second participant by the first distance, the first visual representation is spaced apart from the third visual representation of the third participant by the second distance, and the second visual representation is spaced apart from the third visual representation by the third distance (e.g., irrespective of the current viewpoint of the user).

In some embodiments, in the second spatial distribution, the first location (e.g., the location of the first visual representation 1706 in FIG. 17I) is spaced apart from the third location (e.g., the location of the third visual representation 1710 in FIG. 17I) by a fourth distance, the first location is spaced apart from the second location (e.g., the location of the second visual representation 1708 in FIG. 17I) by a fifth distance, and the second location is spaced apart from the third location by a sixth distance, the fourth distance is larger than the fifth distance by less than the threshold amount. For example, while the computer system is displaying the three-dimensional environment and before detecting the first event, if the plurality of participants in the real-time communication session has the second spatial distribution, the first visual representation of the first participant is spaced apart from the third visual representation of the third participant by the fourth distance, the first visual representation is spaced apart from the second visual representation of the second participant by the fifth distance, and the second visual representation is spaced apart from the third visual representation by the sixth distance (e.g., irrespective of the current viewpoint of the user).

In some embodiments, in response to detecting the first event, displaying the respective updated spatial arrangement of the elements of the real-time communication session includes, in accordance with the determination that the spatial distribution of the first visual representation of the first participant, the second visual representation of the second participant, and the third visual representation of the third participant when the first event was detected was the first spatial distribution and that a separation (e.g., a gap or open seat) between the first location and the second location is farther from the current viewpoint than a separation between the first location and the third location and a separation between the second location and the third location when the first event was detected, displaying content from the current viewpoint of the user, wherein the current viewpoint is positioned between a first updated location and a third updated location, such as positioning the current viewpoint of the user 1704 between the first visual representation 1706 and the third visual representation 1710 as shown in the schematic view in FIG. 17L. In some embodiments, the computer system displays, in the first updated spatial arrangement of elements of the real-time communication session, the first visual representation of the first participant at the first updated location, the second visual representation of the second participant at a second updated location, and the third visual representation of the third participant at the third updated location from the current viewpoint of the user. For example, from the current viewpoint of the user, the first visual representation of the first participant and the third visual representation of the third participant are displayed on either side of the user (e.g., the current viewpoint is positioned at a seat that is between the first participant and the third participant as similarly discussed above with reference to step(s) 1802). In some embodiments, in response to detecting the first event, the computer system identifies the largest gap (e.g., seat) between adjacent participants (e.g., represented by the visual representations) in the three-dimensional environment. As discussed above, in the first spatial distribution, the gap (e.g., separation) between the first location and the second location, which is equal to the first distance, is optionally the largest gap in the three-dimensional environment. However, because the first distance is larger than the second distance discussed above by less than the threshold distance, the computer system optionally determines whether the separation between the first location and the second location is closer to the current viewpoint of the user than the separation between the first location and the third location. In some embodiments, as discussed above, because the separation between the first location and the second location is not closer to the current viewpoint than the separation between the first location and the third location, the computer system selects the separation between the first location and the third location as the seat at which the current viewpoint is positioned in the first updated spatial arrangement of the elements of the real-time communication session. Accordingly, in some embodiments, from the current viewpoint of the user in the first updated spatial arrangement, the first updated location and the third updated location are positioned on either side of the current viewpoint in the three-dimensional environment. In some embodiments, when the computer system displays the first updated spatial arrangement of elements of the real-time communication session, the first visual representation of the first participant and the second visual representation of the second participant remain displayed spaced apart by the first distance discussed above from the current viewpoint. Similarly, the first visual representation of the first participant remains spaced apart from the third visual representation of the third participant by the second distance, and the second visual representation of the second participant remains spaced apart from the third visual representation of the third participant by the third distance discussed above from the current viewpoint. In some embodiments, in accordance with a determination that the separation between the first location and the third location is farther from the viewpoint of the user than the separation between the first location and the second location, the current viewpoint of the user in the first updated spatial arrangement is positioned between the first updated location and the second updated location, as similarly described above with reference to selecting a spatial opening that is closest to the current viewpoint of the user.

In some embodiments, in accordance with the determination that the spatial distribution of the first visual representation of the first participant and the second visual representation of the second participant when the first event was detected was the second spatial distribution and that the separation (e.g., a gap or open seat) between the first location and the third location is farther from the current viewpoint than the separation between the first location and the second location and the separation between the second location and the third location when the first event was detected, the computer system displays updated content from the current viewpoint of the user wherein the current viewpoint is positioned between a fourth updated location and a fifth updated location, such as positioning the current viewpoint of the user 1704 between the first visual representation 1706 and the second visual representation 1708 as shown in the schematic view in FIG. 17J. In some embodiments, the computer system displays, in the second updated spatial arrangement of elements of the real-time communication session, the first visual representation of the first participant at the fourth updated location, the second visual representation of the second participant at the fifth updated location, and the third visual representation of the third participant at a sixth updated location from the current viewpoint of the user. For example, from the current viewpoint of the user, the first visual representation of the first participant and the second visual representation of the second participant are displayed on either side of the user (e.g., the current viewpoint is positioned at a seat that is between the first participant and the second participant as similarly discussed above with reference to step(s) 1802). In some embodiments, as similarly discussed above, in response to detecting the first event, the computer system identifies the largest gap (e.g., seat) between adjacent participants (e.g., represented by the visual representations) in the three-dimensional environment. As discussed above, in the second spatial distribution, the gap (e.g., separation) between the first location and the third location, which is equal to the fourth distance, is optionally the largest gap in the three-dimensional environment. However, because the fourth distance is larger than the fifth distance discussed above by less than the threshold distance, the computer system optionally determines whether the separation between the first location and the third location is closer to the current viewpoint of the user than the separation between the first location and the second location. In some embodiments, as discussed above, because the separation between the first location and the third location is not closer to the current viewpoint than the separation between the first location and the second location, the computer system selects the separation between the first location and the second location as the seat at which the current viewpoint is positioned in the second updated spatial arrangement of the elements of the real-time communication session. Accordingly, in some embodiments, from the current viewpoint of the user in the second updated spatial arrangement, the fourth updated location and the fifth updated location are positioned on either side of the current viewpoint in the three-dimensional environment. In some embodiments, when the computer system displays the second updated spatial arrangement of elements of the real-time communication session, the first visual representation of the first participant and the third visual representation of the third participant remain displayed spaced apart by the third distance discussed above from the current viewpoint. Similarly, the first visual representation of the first participant remains spaced apart from the second visual representation of the second participant by the fifth distance, and the second visual representation of the second participant remains spaced apart from the third visual representation of the third participant by the sixth distance discussed above from the current viewpoint. In some embodiments, in accordance with a determination that the separation between the first location and the second location is farther from the viewpoint of the user than the separation between the first location and the third location, the current viewpoint of the user in the first updated spatial arrangement is positioned between the fourth updated location and the fifth updated location, as similarly described above with reference to selecting a spatial opening that is closest to the current viewpoint of the user. Resetting a spatial distribution of one or more users in a real-time communication session, including updating locations at which visual representations of one or more users are displayed in a three-dimensional environment, based on spatial openings between the visual representations of the one or more users relative to a current viewpoint of the user in response to detecting a request to reset the spatial distribution enables the current viewpoint to be positioned in a spatial opening that is closest to the current viewpoint automatically, which reduces the discontinuity in presentation of the three-dimensional environment relative to the viewpoint and/or helps avoid potential spatial conflicts with the visual representations of the one or more users, thereby improving user-device interaction.

In some embodiments, the plurality of participants in the real-time communication session includes a third participant, wherein a third visual representation (e.g., third visual representation 1710 in FIG. 17B) of the third participant is displayed at a third location, different from the first location and the second location, in the three-dimensional environment in the first spatial arrangement of the elements in the real-time communication session (e.g., as similarly discussed above with reference to step(s) 1802). In some embodiments, in the first spatial distribution, the first location (e.g., the location of the first visual representation 1706 in FIG. 17M), the second location (e.g., the location of the second visual representation 1708 in FIG. 17M), and the third location (e.g., the location of the third visual representation 1710 in FIG. 17M) are at least partially linearly arranged (e.g., within a threshold amount of being linearly arranged (e.g., along a line), such as within 1, 2, 5, 10, 15, 20, 25, or 30 degrees of being linearly arranged, or within 0.1, 0.25, 0.5, 0.75, 1, 1.5, 2, or 3 m of the first location, the second location, and/or the third location being linearly arranged) relative to a line (e.g., a line that is displayed or is not displayed in the three-dimensional environment that passes by or through the first, second and/or third locations) from the current viewpoint, such as line 1718c in FIG. 17M, wherein the first visual representation of the first participant, the second visual representation of the second participant, and the third visual representation of the third participant have an average orientation directed toward a first direction corresponding to a first side (e.g., first side 1713a in FIG. 17M) of the line from the current viewpoint, such as a direction that is toward virtual object 1726 as shown in the schematic view in FIG. 17M. For example, while the computer system is displaying the three-dimensional environment and before detecting the first event, if the plurality of participants in the real-time communication session has the first spatial distribution, the first visual representation of the first participant, the second visual representation, and the third visual representation are arranged at least partially along a line in the three-dimensional environment from the current viewpoint (e.g., in front of content, such as an application window), in which at least one of the participants is facing in a different direction in the three-dimensional environment than others of the plurality of participants. In some embodiments, in the first spatial distribution, a majority of participants of the plurality of participants in the real-time communication session is facing in the first direction in the three-dimensional environment relative to the current viewpoint of the user. In some embodiments, in the first spatial distribution, all of the participants in the real-time communication session are facing in the first direction in the three-dimensional environment relative to the current viewpoint of the user.

In some embodiments, in the second spatial distribution, the first location (e.g., the location of the first visual representation 1706 in FIG. 17O), the second location (e.g., the location of the second visual representation 1708 in FIG. 17O), and the third location (e.g., the location of the third visual representation 1710 in FIG. 17O) are at least partially linearly arranged relative to the line (e.g., the line 1718c in FIG. 17O) from the current viewpoint, wherein the first visual representation of the first participant, the second visual representation of the second participant, and the third visual representation of the third participant have an average orientation directed toward a second direction (e.g., opposite to the first direction) corresponding to a second side (e.g., second side 1713b in FIG. 17O) of the line (e.g., different from (e.g., opposite to) the first side of the line) from the current viewpoint (e.g., as similarly discussed above), such as a direction that is away from the virtual object 1726 as shown in the schematic view in FIG. 17O. In some embodiments, in the second spatial distribution, a majority of participants of the plurality of participants in the real-time communication session is facing in the second direction in the three-dimensional environment relative to the current viewpoint of the user. In some embodiments, in the second spatial distribution, all of the participants in the real-time communication session are facing in the second direction in the three-dimensional environment relative to the current viewpoint of the user.

In some embodiments, in response to detecting the first event, displaying the respective updated spatial arrangement of the elements of the real-time communication session includes, in accordance with the determination that the spatial distribution of the first visual representation of the first participant, the second visual representation of the second participant, and the third visual representation of the third participant when the first event was detected was the first spatial distribution, displaying content from the current viewpoint of the user, wherein the current viewpoint is oriented to face in the first direction corresponding to the first side of the line in the three-dimensional environment, such as positioning the current viewpoint of the user 1704 on the first side 1713a of the line 1718c and orienting the current viewpoint of the user 1704 to face toward the virtual object 1726 as shown in the schematic view in FIG. 17N. In some embodiments, the computer system displays, in the first updated spatial arrangement of elements of the real-time communication session, the first visual representation of the first participant at a first updated location, the second visual representation of the second participant at a second updated location, and the third visual representation of the third participant at a third updated location from the current viewpoint of the user. In some embodiments, in the first updated spatial arrangement, the current viewpoint of the user is positioned at least partially along a linear line with (e.g., adjacent to) the first visual representation of the first participant, the second visual representation of the second participant and the third visual representation of the third participant in the three-dimensional environment from the current viewpoint of the user (e.g., the current viewpoint is positioned at a seat that is linearly arranged with the first participant, the second participant, and the third participant as similarly discussed above with reference to step(s) 1802). In some embodiments, when the computer system displays the first updated spatial arrangement of elements of the real-time communication session, the computer system determines the orientation of the current viewpoint of the user relative to the other elements in the real-time communication session based on an average direction in which the plurality of participants in the real-time communication session is facing when the first event is detected. For example, as discussed above, because the majority of the plurality of the participants in the real-time communication session is facing the first direction in the three-dimensional environment when the first event is detected, the average direction is the first direction. Accordingly, in some embodiments, after detecting the first event, the computer system displays the first updated spatial arrangement such that the current viewpoint of the user is facing the first direction in the three-dimensional environment.

In some embodiments, in accordance with the determination that the spatial distribution of the first visual representation of the first participant and the second visual representation of the second participant when the first event was detected was the second spatial distribution, the computer system displays updated content from the current viewpoint of the user, wherein the current viewpoint is oriented to face in the second direction corresponding to the second side of the line in the three-dimensional environment, such as positioning the current viewpoint of the user 1704 on the second side 1713b of the line 1718c and orienting the current viewpoint of the user 1704 to face away from the virtual object 1726 as shown in the schematic view in FIG. 17P. In some embodiments, the computer system displays, in the second updated spatial arrangement of elements of the real-time communication session, the first visual representation of the first participant at a fourth updated location, the second visual representation of the second participant at a fifth updated location, and the third visual representation of the third participant at a sixth updated location from the current viewpoint of the user. In some embodiments, in the second updated spatial arrangement, the current viewpoint of the user is positioned at least partially along a linear line with (e.g., adjacent to) the first visual representation of the first participant, the second visual representation of the second participant and the third visual representation of the third participant in the three-dimensional environment from the current viewpoint of the user, as similarly discussed above. In some embodiments, in the second updated spatial arrangement, the visual representation(s) to which the current viewpoint is adjacent in the three-dimensional environment is different from the visual representation(s) to which the current viewpoint is adjacent in the three-dimensional environment in the first updated spatial arrangement. For example, the order in which the plurality of participants in the real-time communication session is arranged along the line in the three-dimensional environment is different between the first updated spatial arrangement and the second updated spatial arrangement. Additionally, in some embodiments, as similarly discussed above, because the majority of the plurality of the participants in the real-time communication session is facing the second direction in the three-dimensional environment when the first event is detected, the average direction is the second direction. Accordingly, in some embodiments, after detecting the first event, the computer system displays the second updated spatial arrangement such that the current viewpoint of the user is facing the second direction in the three-dimensional environment. Resetting a spatial distribution of one or more users in a real-time communication session, including updating locations at which visual representations of one or more users are displayed in a three-dimensional environment, based on an average direction in which the visual representations of the one or more users is facing in response to detecting a request to reset the spatial distribution reduces the number of inputs needed to manually move the current viewpoint of the user to face toward the average direction and/or enables the current viewpoint to be oriented to face toward the average direction automatically, which helps facilitate user experience of and/or user interaction with content or other elements located in the average direction relative to the one or more users in the three-dimensional environment, thereby improving user-device interaction.

It should be understood that the particular order in which the operations in method 1800 have been described is merely exemplary and is not intended to indicate that the described order is the only order in which the operations could be performed. One of ordinary skill in the art would recognize various ways to reorder the operations described herein.

FIGS. 19A-19L illustrate examples of a computer system facilitating updates of a spatial arrangement of participants in a real-time communication session in a three-dimensional environment based on shared content in accordance with some embodiments.

FIG. 19A illustrates a computer system 101 (e.g., tablet, smartphone, wearable computer, or head mounted device) (e.g., an electronic device) displaying, via a display generation component (e.g., display generation component 120 of FIG. 1 such as a computer display, touch screen, or one or more display modules of a head mounted device), a three-dimensional environment 1902 (e.g., an AR, AV, VR, MR, or XR environment) from a viewpoint of the user of the computer system 101 (e.g., tablet, smartphone, wearable computer, or head mounted device) (e.g., facing the back wall of the physical environment in which computer system 101 (e.g., tablet, smartphone, wearable computer, or head mounted device) is located). In some embodiments, computer system 101 (e.g., tablet, smartphone, wearable computer, or head mounted device) includes a display generation component (e.g., a computer display, touch screen, or display module of a head mounted device) and a plurality of image sensors (e.g., image sensors 314 of FIG. 3). The image sensors optionally include one or more of a visible light camera, an infrared camera, a depth sensor, or any other sensor the computer system 101 (e.g., tablet, smartphone, wearable computer, or head mounted device) would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user).

As shown in FIG. 19A, computer system 101 (e.g., tablet, smartphone, wearable computer, or head mounted device) captures one or more images of the physical environment around computer system 101 (e.g., tablet, smartphone, wearable computer, or head mounted device) (e.g., operating environment 100), including one or more objects in the physical environment around computer system 101. In some embodiments, computer system 101 (e.g., tablet, smartphone, wearable computer, or head mounted device) displays representations of the physical environment in three-dimensional environment 1902 (e.g., an AR, AV, VR, MR, or XR environment). For example, three-dimensional environment 1902 (e.g., an AR, AV, VR, MR, or XR environment) includes a representation of a coffee table 1922, which is optionally a representation of a physical coffee table in the physical environment. As shown in the schematic view of the three-dimensional environment 1902 (e.g., an AR, AV, VR, MR, or XR environment), the physical environment also includes a potted plant 1924, which is not currently visible in the three-dimensional environment 1902 (e.g., an AR, AV, VR, MR, or XR environment) from the current viewpoint of the user of the computer system 101.

In FIG. 19A, three-dimensional environment 1902 (e.g., an AR, AV, VR, MR, or XR environment) also includes one or more virtual objects. For example, as shown in FIG. 19A, the computer system 101 (e.g., tablet, smartphone, wearable computer, or head mounted device) is displaying virtual object 1960 in the three-dimensional environment 1902 (e.g., an AR, AV, VR, MR, or XR environment). In some embodiments, the virtual object 1960 is or includes one or more of user interfaces of an application (e.g., an application running on the computer system 101) containing content (e.g., quick look windows displaying photographs, playback user interface displaying content, and/or web-browsing user interface displaying text), three-dimensional objects (e.g., virtual clocks, virtual balls, and/or virtual cars) or any other element displayed by computer system 101 (e.g., tablet, smartphone, wearable computer, or head mounted device) that is not included in the physical environment of display generation component 120. Additionally, in some embodiments, the virtual object 1960 is a private object in the three-dimensional environment 1902 (e.g., an AR, AV, VR, MR, or XR environment). For example, the virtual object 1960 is associated with an application that is running privately/locally on the computer system 101 (e.g., tablet, smartphone, wearable computer, or head mounted device) and is only viewable by and interactive to the user of the computer system 101.

In some embodiments, the user of the computer system 101 (e.g., tablet, smartphone, wearable computer, or head mounted device) is participating in a real-time communication session with a plurality of users. Details regarding the real-time communication session are provided below with reference to method 2000. In the example of FIG. 19A, the user of the computer system 101 (e.g., tablet, smartphone, wearable computer, or head mounted device) is in the real-time communication session with a first participant (e.g., a second user of a second computer system) and a second participant (e.g., a third user of a third computer system). In some embodiments, as shown in FIG. 19A, while the user of the computer system 101 (e.g., tablet, smartphone, wearable computer, or head mounted device) is in the real-time communication session with the first participant and the second participant, the computer system 101 (e.g., tablet, smartphone, wearable computer, or head mounted device) displays a first visual representation 1906 of the first participant and a second visual representation 1908 of the second participant in the three-dimensional environment 1902 (e.g., an AR, AV, VR, MR, or XR environment). Details regarding the first visual representation 1906 and the second visual representation 1908 are provided below with reference to method 2000. Referring to the schematic view of the three-dimensional environment 1902 (e.g., an AR, AV, VR, MR, or XR environment) in FIG. 19A, the user of the computer system 101 (e.g., tablet, smartphone, wearable computer, or head mounted device) (and thus the viewpoint of the user) is represented by representation of user 1904.

In some embodiments, as shown in FIG. 19A, the user of the computer system 101, the first participant, and the second participant are participating in a shared activity in the real-time communication session. For example, as shown in FIG. 19A, the user of the computer system 101, the first participant, and the second participant are participating in a game activity in the three-dimensional environment 1902 (e.g., an AR, AV, VR, MR, or XR environment). In some embodiments, as shown in FIG. 19A, the game activity is associated with virtual object 1946, which is a shared object in the three-dimensional environment 1902 (e.g., an AR, AV, VR, MR, or XR environment). For example, the virtual object 1946 is associated with an application that is running on the computer system 101, the second computer system of the second user, and the third computer system of the third user, such that the virtual object 1946 is viewable by and/or interactive to the user, the second user, and the third user. Additionally, in some embodiments, the virtual object 1946 is associated with a spatial template in the three-dimensional environment 1902 (e.g., an AR, AV, VR, MR, or XR environment) according to which the participants in the real-time communication session are arranged in the three-dimensional environment 1902 (e.g., an AR, AV, VR, MR, or XR environment). For example, in FIG. 19A, the virtual object 1946 is associated with a plurality of predefined seats that are able to be occupied by users in the real-time communication session. In some embodiments, a respective user is assigned a particular seat within the spatial template (e.g., based on a context of the game activity, such as the user's turn in the game or a team on which the user is a part in the game). In some embodiments, as shown in the schematic view of the three-dimensional environment 1902 (e.g., an AR, AV, VR, MR, or XR environment) in FIG. 19A, the viewpoint of the user of the computer system 101 (e.g., tablet, smartphone, wearable computer, or head mounted device) is positioned at a first seat relative to the virtual object 1946, the first visual representation 1906 of the first participant is positioned at a second seat relative to the virtual object 1946, and the second visual representation 1908 of the second participant is positioned at a third seat relative to the virtual object 1946. Additional details regarding spatial templates in real-time communication sessions are provided above with reference to method 1200.

In some embodiments, while the user of the computer system 101, the first participant, and the second participant are in the real-time communication session, the viewpoint of the user of the computer system 101, the first visual representation 1906, the second visual representation 1908, and the virtual object 1946 have a first spatial arrangement within the three-dimensional environment 1902 (e.g., an AR, AV, VR, MR, or XR environment). For example, as shown in the schematic view of the three-dimensional environment 1902 (e.g., an AR, AV, VR, MR, or XR environment) in FIG. 19A, the first visual representation 1906 is located at a first location relative to the viewpoint of the user 1904, the second visual representation 1908 is located at a second location, different from the first location, relative to the viewpoint of the user 1904, and the virtual object 1946 is located at a third location, different from the first location and the second location, relative to the viewpoint of the user 1904. In some embodiments, as shown in the schematic view of the three-dimensional environment 1902 (e.g., an AR, AV, VR, MR, or XR environment) in FIG. 19A, the spatial arrangement of the viewpoint of the user 1904, the first visual representation 1906, the second visual representation 1908, and the virtual object 1946 is determined based on (e.g., according to) the spatial template discussed above. For example, the first location of the first visual representation 1906 corresponds to the second seat associated with the virtual object 1946 discussed above and the second location of the second visual representation 1908 corresponds to the third seat associated with the virtual object 1946 discussed above.

In the schematic view of the three-dimensional environment 1902 (e.g., an AR, AV, VR, MR, or XR environment) of FIG. 19A, the physical environment of the display generation component 120 (and thus the physical environment of the user of the computer system 101) is bounded/represented by rectangle 1900. For example, within the rectangle 1900, the locations of any physical objects in the physical environment and/or orientations of any physical objects, such as the coffee table 1922 and the potted plant 1924, relative to the viewpoint of the user of the computer system 101 (e.g., tablet, smartphone, wearable computer, or head mounted device) are updated as the user of the computer system 101 (e.g., tablet, smartphone, wearable computer, or head mounted device) moves and/or changes orientation within the physical environment. In the example of FIG. 19A, in the physical environment (e.g., represented by the rectangle 1900) of the user, the potted plant 1924 is located to the left of the user 1904 (e.g., outside the field of view of the user 1904) and the coffee table 1922 is located forward and to the right of the user 1904. Accordingly, as illustrated herein, the representation of the user 1904 within the rectangle 1900 reflects the user's physical position and/or orientation relative to the physical environment of the computer system 101.

From FIGS. 19A-19B, the computer system 101 (e.g., tablet, smartphone, wearable computer, or head mounted device) detects movement of the viewpoint of the user of the computer system 101 (e.g., tablet, smartphone, wearable computer, or head mounted device) relative to the three-dimensional environment 1902 (e.g., an AR, AV, VR, MR, or XR environment). For example, as shown in the schematic view in FIG. 19B, the user 1904 has moved (e.g., walked) in the physical environment of the user, such that, in the three-dimensional environment 1902 (e.g., an AR, AV, VR, MR, or XR environment), the viewpoint of the user 1904 is moved/shifted away from the other participants and the virtual object 1946 in the real-time communication session (e.g., referred to herein as “the group”). In some embodiments, as similarly discussed above, the user of the computer system 101 (e.g., tablet, smartphone, wearable computer, or head mounted device) has an updated position and/or orientation relative to the physical environment, as indicated by the updated position and/or orientation of the representation of the user 1904 in the rectangle 1900 in FIG. 19B. As shown in FIG. 19B, after the movement of the user, a representation of the potted plant 1924 is visible in the field of view of the user of the computer system 101. Additionally, as shown in the schematic view in FIG. 19B, the seat associated with the virtual object 1946 that was previously occupied by the user 1904 (e.g., prior to the movement of the viewpoint) is indicated by label “A” in the spatial template.

In some embodiments, as shown in FIG. 19B, when the viewpoint of the user changes in accordance with the movement of the user in the physical environment, the group is no longer visible in the user's field of view. For example, as shown in FIG. 19B, the three-dimensional environment 1902 (e.g., an AR, AV, VR, MR, or XR environment) relative to the current viewpoint of the user no longer includes the visual representations 1906-1908 and the virtual object 1946. Accordingly, in some embodiments, it is desirable to provide functionality that enables the user to reset the spatial arrangement discussed above, such that the virtual elements (e.g., the visual representations 1906-1908 and the virtual object 1946) are redisplayed relative to the current viewpoint of the user in the three-dimensional environment 1902 (e.g., an AR, AV, VR, MR, or XR environment).

In FIG. 19B, the computer system 101 (e.g., tablet, smartphone, wearable computer, or head mounted device) detects an event corresponding to a request to reset the spatial arrangement of the virtual elements in the three-dimensional environment 1902 (e.g., an AR, AV, VR, MR, or XR environment). In some embodiments, as shown in FIG. 19B, detecting the event includes detecting a selection (e.g., a press) of a physical button of the computer system, such as selection of button 1931b provided by hand 1903a. In some embodiments, detecting the event includes detecting a selection of a selectable option displayed via the display generation component 120. For example, as shown in FIG. 19B, the computer system 101 (e.g., tablet, smartphone, wearable computer, or head mounted device) detects an air gesture (e.g., an air pinch gesture, an air tap or touch gesture) provided by hand 1905a while attention (e.g., gaze 1921) is directed toward selectable option 1915 that is selectable to reset the spatial arrangement relative to the current viewpoint of the user.

In some embodiments, as shown in FIG. 19C, in response to detecting the event, the computer system 101 (e.g., tablet, smartphone, wearable computer, or head mounted device) updates the spatial arrangement of the virtual elements in the three-dimensional environment 1902 (e.g., an AR, AV, VR, MR, or XR environment), such that the group is redisplayed relative to the current viewpoint of the user 1904. For example, as indicated by the rectangle 1900, when the computer system 101 (e.g., tablet, smartphone, wearable computer, or head mounted device) updates the spatial arrangement, the visual representations 1906-1908 and the virtual object 1946 are displayed at updated locations in the three-dimensional environment 1902 (e.g., an AR, AV, VR, MR, or XR environment) from the current viewpoint of the user 1904 within the physical environment. As shown in the schematic view of FIG. 19C, the visual representations 1906-1908 and the virtual object 1946 are moved in the three-dimensional environment 1902 (e.g., an AR, AV, VR, MR, or XR environment) to be located in front of the user 1904, while the user 1904 maintains their same location and orientation relative to the physical objects in the physical environment (e.g., the potted plant 1924 and the coffee table 1922) shown in FIG. 19B, as indicated by the position and/or orientation of the user 1704, the coffee table 1922, and the potted plant 1924 in the rectangle 1900 in FIG. 19C.

In some embodiments, when the computer system 101 (e.g., tablet, smartphone, wearable computer, or head mounted device) updates the spatial arrangement in the three-dimensional environment 1902 (e.g., an AR, AV, VR, MR, or XR environment), the computer system 101 (e.g., tablet, smartphone, wearable computer, or head mounted device) positions the viewpoint of the user 1904 at a location within the spatial arrangement that corresponds to the assigned seat (e.g., the first seat discussed above) of the user 1904 within the spatial template associated with the virtual object 1946. For example, the computer system 101 (e.g., tablet, smartphone, wearable computer, or head mounted device) selects a reset location for the viewpoint of the user 1904 based on the assigned seat for the user 1904 in the spatial template in the three-dimensional environment 1902 (e.g., an AR, AV, VR, MR, or XR environment). In FIG. 19B, when the event discussed above is detected by the computer system 101, the assigned seat (e.g., labeled A) for the user is unoccupied (e.g., by another participant) in the three-dimensional environment 1902 (e.g., an AR, AV, VR, MR, or XR environment). Accordingly, as shown in FIG. 19C, when the computer system 101 (e.g., tablet, smartphone, wearable computer, or head mounted device) resets the spatial arrangement in the three-dimensional environment 1902 (e.g., an AR, AV, VR, MR, or XR environment), the computer system 101 (e.g., tablet, smartphone, wearable computer, or head mounted device) positions the current viewpoint of the user at the user's previous seat (e.g., labeled A) within the spatial template associated with the virtual object 1946 (e.g., positioned between the first visual representation 1906 and the second visual representation 1908), as opposed to another available seat (e.g., a different seat), such as the seat labeled “B” in FIG. 19C (e.g., because the seat labeled B is not the user's assigned seat in the spatial template).

Additionally, in some embodiments, as shown in FIG. 19C, when the computer system 101 (e.g., tablet, smartphone, wearable computer, or head mounted device) resets the spatial arrangement in the three-dimensional environment 1902 (e.g., an AR, AV, VR, MR, or XR environment) as discussed above, the computer system 101 (e.g., tablet, smartphone, wearable computer, or head mounted device) moves the virtual object 1960 (e.g., the private object) in the three-dimensional environment 1902 (e.g., an AR, AV, VR, MR, or XR environment). In some embodiments, as shown in the schematic view in FIG. 19C, when the spatial arrangement is updated from the current viewpoint of the user 1904, the computer system 101 (e.g., tablet, smartphone, wearable computer, or head mounted device) positions the virtual object 1960 at an updated location (e.g., a third updated location) in the three-dimensional environment 1902 (e.g., an AR, AV, VR, MR, or XR environment) such that the virtual object 1960 is displayed at a same location and with a same orientation relative to the viewpoint of the user 1904 as before the event is detected in FIG. 19B. For example, the computer system 101 (e.g., tablet, smartphone, wearable computer, or head mounted device) moves the virtual object 1960 with the virtual object 1946 and the visual representations 1906-1908 in the three-dimensional environment 1902 (e.g., an AR, AV, VR, MR, or XR environment), as shown in FIG. 19C.

Attention is now directed to additional and/or alternative embodiments of resetting the spatial arrangement of the virtual elements in the real-time communication session based on the display of shared content in the real-time communication session. It should be understood that the above description of the physical environment of the user, which is represented by the rectangle 1900 in FIGS. 19A-19C, and changes in the position and/or the orientation of the user 1904 relative to the physical environment applies analogously to the additional and/or alternative embodiments discussed below. Particularly, when the computer system 101 (e.g., tablet, smartphone, wearable computer, or head mounted device) resets the spatial arrangement relative to the viewpoint of the user 1904, the user's position and/or orientation remains unchanged relative to the physical environment, and only physical movements and/or rotations of the user in the physical environment cause the position and/or orientation of the user 1904 to be changed/updated relative to the physical environment (e.g., including the physical objects in the physical environment). For brevity, the full details are not repeated here or in the following examples.

Alternatively to the instance described above, in some embodiments, as shown in FIG. 19D, when the viewpoint of the user changes relative to the three-dimensional environment 1902 (e.g., an AR, AV, VR, MR, or XR environment) (e.g., and the user 1904 has moved away from the group as shown in the schematic view), the computer system 101 (e.g., tablet, smartphone, wearable computer, or head mounted device) detects that the second visual representation 1908 has also moved to a new location within the spatial arrangement in the three-dimensional environment 1902 (e.g., an AR, AV, VR, MR, or XR environment) (and optionally to another seat within the spatial template associated with the virtual object 1946). For example, the third user of the third computer system has moved in their respective physical environment, which causes the second visual representation 1908 to be moved in the three-dimensional environment 1902 (e.g., an AR, AV, VR, MR, or XR environment) accordingly.

In some embodiments, when the computer system 101 (e.g., tablet, smartphone, wearable computer, or head mounted device) detects the event discussed above with reference to FIG. 19B, the computer system 101 (e.g., tablet, smartphone, wearable computer, or head mounted device) selects a reset location for the viewpoint of the user that is based on the assigned seat for the user within the spatial template associated with the virtual object 1946, as previously discussed above. In some embodiments, as shown in FIG. 19D, when the event is detected, the computer system 101 (e.g., tablet, smartphone, wearable computer, or head mounted device) determines that the user's previous location in the spatial arrangement is now occupied by the second visual representation 1908 (e.g., caused by the movement of the second user as discussed above), such that the assigned seat for the user within the spatial template is now occupied by the second participant in the real-time communication session. Accordingly, in some embodiments, as shown in the lower schematic view in FIG. 19D, when the computer system 101 (e.g., tablet, smartphone, wearable computer, or head mounted device) updates the spatial arrangement, the computer system 101 (e.g., tablet, smartphone, wearable computer, or head mounted device) selects a reset location for the viewpoint of the user 1904 that is near the previous location of the user 1904 in the spatial arrangement. For example, as shown in the lower schematic view in FIG. 19D, the computer system 101 (e.g., tablet, smartphone, wearable computer, or head mounted device) positions the viewpoint of the user 1904 adjacent to (e.g., to the left of) the second visual representation 1908 in the spatial arrangement, such that the viewpoint of the user 1904 is positioned proximate to the user's assigned seat within the spatial template associated with the virtual object 1946, as opposed to positioning the viewpoint of the user 1904 at a location corresponding to another seat in the spatial template, such as seat labeled B or seat labeled “C” in the upper schematic view in FIG. 19D.

In some embodiments, as shown in FIG. 19D, when the computer system 101 (e.g., tablet, smartphone, wearable computer, or head mounted device) positions the viewpoint of the user 1904 adjacent to the second visual representation 1908 in the three-dimensional environment 1902 (e.g., an AR, AV, VR, MR, or XR environment), the computer system 101 (e.g., tablet, smartphone, wearable computer, or head mounted device) places the viewpoint of the user 1904 at a location that is at least a threshold distance (e.g., 0.1, 0.5, 0.75, 1, 1.5, 2, 3, or 5 m) from the second visual representation 1908. In some embodiments, as discussed in more detail with reference to method 2000, the computer system 101 (e.g., tablet, smartphone, wearable computer, or head mounted device) determines the threshold distance based on a personal boundary distance associated with the second visual representation 1908 and/or a predefined distance within which a visual appearance of the second visual representation 1908 is changed in the three-dimensional environment 1902 (e.g., an AR, AV, VR, MR, or XR environment). Additionally, as shown in FIG. 19D and as similarly discussed above, in the lower schematic view, when the computer system 101 (e.g., tablet, smartphone, wearable computer, or head mounted device) resets the spatial arrangement relative to the current viewpoint of the user 1904, the computer system 101 (e.g., tablet, smartphone, wearable computer, or head mounted device) moves the virtual object 1960 (e.g., the private object) with the virtual object 1946 and the visual representations 1906-1908, such that the virtual object 1960 is displayed at a same location and with a same orientation relative to the viewpoint of the user 1904 as before the event is detected in the upper schematic view in FIG. 19D.

Alternatively, in some embodiments, as shown in FIG. 19E, the three-dimensional environment 1902 (e.g., an AR, AV, VR, MR, or XR environment) does not include a private object (e.g., such as the virtual object 1960 discussed above). For example, as shown in FIG. 19E, while the user 1904 is positioned in their assigned seat within the spatial template associated with the virtual object 1946, the computer system 101 (e.g., tablet, smartphone, wearable computer, or head mounted device) is not displaying a virtual object that is private to the user 1904 in the three-dimensional environment 1902 (e.g., an AR, AV, VR, MR, or XR environment).

In FIG. 19F, after the user 1904 has moved away from a location in the spatial arrangement that corresponds to the user's assigned seat within the spatial template, the computer system 101 (e.g., tablet, smartphone, wearable computer, or head mounted device) detects an input corresponding to a request to display a private object in the three-dimensional environment 1902 (e.g., an AR, AV, VR, MR, or XR environment). For example, in FIG. 19F and as similarly discussed above, the user 1904 has moved (e.g., walked) in the physical environment of the user, such that, in the three-dimensional environment 1902 (e.g., an AR, AV, VR, MR, or XR environment), the viewpoint of the user 1904 is moved/shifted away from the other participants and the virtual object 1946 in the real-time communication session (e.g., the seat associated with the virtual object 1946 that was previously occupied by the user 1904 (e.g., prior to the movement of the viewpoint) is indicated by label “A” in the spatial template). As shown in FIG. 19F, after the movement of the user, the computer system 101 (e.g., tablet, smartphone, wearable computer, or head mounted device) detects a selection of selectable option 1927 in window 1926 for displaying a private object in the three-dimensional environment 1902 (e.g., an AR, AV, VR, MR, or XR environment). For example, as shown in FIG. 19F, the computer system 101 (e.g., tablet, smartphone, wearable computer, or head mounted device) detects an air gesture (e.g., an air pinch gesture, an air tap or touch gesture) while the gaze 1921 is directed toward the selectable option 1927 in the three-dimensional environment 1902 (e.g., an AR, AV, VR, MR, or XR environment).

FIG. 19F1 illustrates similar and/or the same concepts as those shown in FIG. 19F (with many of the same reference numbers). It is understood that unless indicated below, elements shown in FIG. 19F1 that have the same reference numbers as elements shown in FIGS. 19A-19L have one or more or all of the same characteristics. FIG. 19F1 includes computer system 101, which includes (or is the same as) display generation component 120. In some embodiments, computer system 101 and display generation component 120 have one or more of the characteristics of computer system 101 shown in FIGS. 19A-19L and display generation component 120 shown in FIGS. 1 and 3, respectively, and in some embodiments, computer system 101 and display generation component 120 shown in FIGS. 19A-19L have one or more of the characteristics of computer system 101 and display generation component 120 shown in FIG. 19F1.

In FIG. 19F1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 19A-19L.

In FIG. 19F1, display generation component 120 is illustrated as displaying content that optionally corresponds to the content that is described as being displayed and/or visible via display generation component 120 with reference to FIGS. 19A-19L. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 19F1.

Display generation component 120 has a field of view (e.g., a field of view captured by external image sensors 314b and 314c and/or visible to the user via display generation component 120) that corresponds to the content shown in FIG. 19F1. Because display generation component 120 is optionally a head-mounted device, the field of view of display generation component 120 is optionally the same as or similar to the field of view of the user.

In FIG. 19F1, the user is depicted as performing an air pinch gesture (e.g., with hand 1905b) to provide an input to computer system 101 to provide a user input directed to content displayed by computer system 101. Such depiction is intended to be exemplary rather than limiting; the user optionally provides user inputs using different air gestures and/or using other forms of input as described with reference to FIGS. 19A-19L.

In some embodiments, computer system 101 responds to user inputs as described with reference to FIGS. 19A-19L.

In the example of FIG. 19F1, because the user's hand is within the field of view of display generation component 120, it is visible within the three-dimensional environment. That is, the user can optionally see, in the three-dimensional environment, any portion of their own body that is within the field of view of display generation component 120. It is understood than one or more or all aspects of the present disclosure as shown in, or described with reference to FIGS. 19A-19L and/or described with reference to the corresponding method(s) are optionally implemented on computer system 101 and display generation unit 120 in a manner similar or analogous to that shown in FIG. 19F1.

In some embodiments, as shown in FIG. 19G, in response to detecting the selection of the selectable option 1927, the computer system 101 (e.g., tablet, smartphone, wearable computer, or head mounted device) displays virtual object 1928 in the three-dimensional environment 1902 (e.g., an AR, AV, VR, MR, or XR environment). In some embodiments, the virtual object 1928 is a private object in the three-dimensional environment 1902 (e.g., an AR, AV, VR, MR, or XR environment), as similarly discussed above. In some embodiments, the virtual object 1928 corresponds to an application window that is displaying one or more user interfaces and/or other content that is viewable by and interactive to the user of the computer system 101.

In FIG. 19G, after displaying the virtual object 1928 in the three-dimensional environment 1902 (e.g., an AR, AV, VR, MR, or XR environment), the computer system 101 (e.g., tablet, smartphone, wearable computer, or head mounted device) detects an event corresponding to a request to reset a spatial arrangement of the virtual elements in the three-dimensional environment 1902 (e.g., an AR, AV, VR, MR, or XR environment). For example, as shown in FIG. 19G and as similarly discussed above, the computer system 101 (e.g., tablet, smartphone, wearable computer, or head mounted device) detects a press of the button 1931b provided by hand 1903b.

In some embodiments, as shown in FIG. 19H and as similarly discussed above, in response to detecting the event, the computer system 101 (e.g., tablet, smartphone, wearable computer, or head mounted device) updates the spatial arrangement of the virtual elements relative to the current viewpoint of the user, such that the group is redisplayed relative to the current viewpoint of the user 1904. For example, as similarly discussed above, when the computer system 101 (e.g., tablet, smartphone, wearable computer, or head mounted device) updates the spatial arrangement, the visual representations 1906-1908 and the virtual object 1946 are displayed at updated locations in the three-dimensional environment 1902 (e.g., an AR, AV, VR, MR, or XR environment) from the current viewpoint of the user 1904. Additionally, in some embodiments, when the computer system 101 (e.g., tablet, smartphone, wearable computer, or head mounted device) updates the spatial arrangement in the three-dimensional environment 1902 (e.g., an AR, AV, VR, MR, or XR environment), the computer system 101 (e.g., tablet, smartphone, wearable computer, or head mounted device) positions the viewpoint of the user 1904 at a location within the spatial arrangement that corresponds to the assigned seat (e.g., the first seat discussed above) of the user 1904 within the spatial template associated with the virtual object 1946. For example, in FIG. 19G, when the event discussed above is detected by the computer system 101, the assigned seat (e.g., labeled A) for the user is unoccupied (e.g., by another participant) in the three-dimensional environment 1902 (e.g., an AR, AV, VR, MR, or XR environment). Accordingly, as shown in FIG. 19G, when the computer system 101 (e.g., tablet, smartphone, wearable computer, or head mounted device) resets the spatial arrangement in the three-dimensional environment 1902 (e.g., an AR, AV, VR, MR, or XR environment), the computer system 101 (e.g., tablet, smartphone, wearable computer, or head mounted device) positions the current viewpoint of the user at the user's previous seat (e.g., labeled A) within the spatial template associated with the virtual object 1946 (e.g., positioned adjacent to the second visual representation 1908).

In some embodiments, as shown in FIG. 19H, when the computer system 101 (e.g., tablet, smartphone, wearable computer, or head mounted device) resets the spatial arrangement in the three-dimensional environment 1902 (e.g., an AR, AV, VR, MR, or XR environment) in the manner discussed above, the computer system 101 (e.g., tablet, smartphone, wearable computer, or head mounted device) forgoes moving the virtual object 1928 (e.g., the private object) relative to the current viewpoint of the user 1904. For example, in FIG. 19G, when the event is detected, the viewpoint of the user 1904 is positioned at the same location at which the viewpoint of the user 1904 was positioned when the virtual object 1928 was first displayed (e.g., in response to the computer system 101 (e.g., tablet, smartphone, wearable computer, or head mounted device) detecting the selection of the selectable option 1927 in FIG. 19F). Accordingly, in some embodiments, as shown in the schematic view of FIG. 19H, the virtual object 1928 remains displayed at the same location and/or with the same orientation relative to the current viewpoint of the user 1904 and the other virtual elements (e.g., the virtual representations 1906-1908 and the virtual object 1946) are moved in the three-dimensional environment 1902 (e.g., an AR, AV, VR, MR, or XR environment) relative to the current viewpoint of the user 1904.

Alternatively, in some embodiments, as shown in FIG. 19I, when the event discussed above is detected, the viewpoint of the user 1904 has moved/shifted relative to the three-dimensional environment 1902 (e.g., an AR, AV, VR, MR, or XR environment) (e.g., the user 1904 has moved away from the group as shown in the schematic view) after the computer system 101 (e.g., tablet, smartphone, wearable computer, or head mounted device) displays the virtual object 1928 in the three-dimensional environment 1902 (e.g., an AR, AV, VR, MR, or XR environment). For example, as shown in FIG. 19I, the user 1904 has moved away from the location in the physical environment at which the input for displaying the virtual object 1928 in the three-dimensional environment was detected (e.g. represented by location 1952). In some embodiments, the computer system 101 (e.g., tablet, smartphone, wearable computer, or head mounted device) detects the event discussed above while the user 1904 is no longer positioned at the location 1952, as shown in the schematic view in FIG. 19I.

In some embodiments, when the computer system 101 (e.g., tablet, smartphone, wearable computer, or head mounted device) detects the event discussed above with reference to FIG. 19G, the computer system 101 (e.g., tablet, smartphone, wearable computer, or head mounted device) selects a reset location for the viewpoint of the user that is based on the assigned seat for the user within the spatial template associated with the virtual object 1946, as previously discussed above. In some embodiments, as shown in FIG. 19J and as similarly discussed above, the computer system 101 (e.g., tablet, smartphone, wearable computer, or head mounted device) positions the viewpoint of the user 1904 at a location relative to the virtual object 1946 that corresponds to the user's assigned seat within the spatial template (e.g., the seat labeled A in FIG. 19I), such that, when the spatial arrangement is reset, the viewpoint of the user 1904 is positioned adjacent to the second visual representation 1908 relative to the virtual object 1946.

Additionally, in some embodiments, as similarly discussed above, as shown in FIG. 19J, when the computer system 101 (e.g., tablet, smartphone, wearable computer, or head mounted device) resets the spatial arrangement in the three-dimensional environment 1902 (e.g., an AR, AV, VR, MR, or XR environment) in the manner discussed above, the computer system 101 (e.g., tablet, smartphone, wearable computer, or head mounted device) moves the virtual object 1928 (e.g., the private object) relative to the current viewpoint of the user 1904. For example, in FIG. 19I, as discussed above, when the event is detected, the viewpoint of the user 1904 is positioned at a location that is different from the location 1952 at which the viewpoint of the user 1904 was positioned when the virtual object 1928 was first displayed (e.g., in response to the computer system 101 (e.g., tablet, smartphone, wearable computer, or head mounted device) detecting the selection of the selectable option 1927 in FIG. 19F). Accordingly, in some embodiments, as shown in the schematic view of FIG. 19J, the virtual object 1928 is displayed at a different location and/or with a different orientation relative to the current viewpoint of the user 1904 and the virtual object 1928 is displayed at a same location and/or with a same orientation relative to the virtual object 1946 when the spatial arrangement is reset.

In some embodiments, the user of the computer system 101, the first participant, and the second participant are participating in a shared activity in the real-time communication session that is not associated with a spatial template having assigned seats. For example, as shown in FIG. 19K, in the upper schematic view, the three-dimensional environment 1902 (e.g., an AR, AV, VR, MR, or XR environment) includes virtual object 1930 (e.g., an application window displaying one or more user interfaces, such as a media player or playback user interface), which is a shared object as similarly discussed above. In some embodiments, the virtual object 1930 is associated with a spatial template in which the participants are arranged according to a line or arc 1918, as shown in FIG. 19K. In some embodiments, the viewpoint of the user 1904, the first visual representation 1906, and the second visual representation 1908 are positioned at locations in the three-dimensional environment 1902 (e.g., an AR, AV, VR, MR, or XR environment) that correspond to seats within the spatial template (e.g., seats along the line 1918). In some embodiments, the seats are not assigned to particular users in the real-time communication session.

In the lower schematic view in FIG. 19K, the computer system 101 (e.g., tablet, smartphone, wearable computer, or head mounted device) detects movement of the viewpoint of the user 1904. For example, as similarly discussed above, the user moves within the physical environment surrounding the computer system 101, which causes the viewpoint of the user in the three-dimensional environment 1902 (e.g., an AR, AV, VR, MR, or XR environment) to change accordingly (e.g., in response to the computer system 101 (e.g., tablet, smartphone, wearable computer, or head mounted device) being moved with the user in the physical environment). In FIG. 19K, after detecting the movement of the viewpoint of the user 1904, the computer system 101 (e.g., tablet, smartphone, wearable computer, or head mounted device) detects an event corresponding to a request to reset the spatial arrangement of the virtual elements relative to the current viewpoint of the user 1904. For example, in the lower schematic view in FIG. 19K, after the user 1904 has moved away from the visual representations 1906-1908 and the virtual object 1930, the computer system 101 (e.g., tablet, smartphone, wearable computer, or head mounted device) detects selection of the button 1931b or the selectable option 1915 discussed previously above with reference to FIG. 19B.

In some embodiments, as shown in the lower schematic view in FIG. 19K, when the viewpoint of the user changes relative to the three-dimensional environment 1902 (e.g., an AR, AV, VR, MR, or XR environment) (e.g., and the user 1904 has moved away from the visual representations 1906-1908 and the virtual object 1930 as discussed above), the computer system 101 (e.g., tablet, smartphone, wearable computer, or head mounted device) detects that the second visual representation 1908 has also moved to a new location within the spatial arrangement in the three-dimensional environment 1902 (e.g., an AR, AV, VR, MR, or XR environment) (and optionally to another seat within the spatial template associated with the virtual object 1946). For example, the third user of the third computer system has moved in their respective physical environment, which causes the second visual representation 1908 to be moved in the three-dimensional environment 1902 (e.g., an AR, AV, VR, MR, or XR environment) accordingly.

In some embodiments, when the computer system 101 (e.g., tablet, smartphone, wearable computer, or head mounted device) detects the event similarly discussed above with reference to FIG. 19B, the computer system 101 (e.g., tablet, smartphone, wearable computer, or head mounted device) selects a reset location for the viewpoint of the user that is based on availability of seats within the spatial template associated with the virtual object 1930. In some embodiments, as shown in the lower schematic view in FIG. 19K, when the event is detected, the computer system 101 (e.g., tablet, smartphone, wearable computer, or head mounted device) determines that the user's previous location in the spatial arrangement is now occupied by the second visual representation 1908 (e.g., caused by the movement of the second user as discussed above), such that the seat that was previously occupied by the user within the spatial template is now occupied by the second participant in the real-time communication session. Accordingly, in some embodiments, as shown in in FIG. 19L, when the computer system 101 (e.g., tablet, smartphone, wearable computer, or head mounted device) updates the spatial arrangement, the computer system 101 (e.g., tablet, smartphone, wearable computer, or head mounted device) selects a reset location for the viewpoint of the user 1904 that corresponds to an available (e.g., unoccupied) seat within the spatial template associated with the virtual object 1930. For example, as shown in the schematic view in FIG. 19L, the computer system 101 (e.g., tablet, smartphone, wearable computer, or head mounted device) positions the viewpoint of the user 1904 between the first visual representation and the second visual representation 1908 in the spatial arrangement, such that the viewpoint of the user 1904 is positioned at the seat in the spatial template previously occupied by the second participant (e.g., seat labeled “B” in the lower schematic view in FIG. 19K).

FIG. 20 is a flowchart illustrating a method 2000 of facilitating updates of a spatial arrangement of participants in a real-time communication session in a three-dimensional environment based on shared content in accordance with some embodiments. In some embodiments, the method 2000 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 2000 is governed by instructions that are stored in a non-transitory computer-readable storage medium and that are executed by one or more processors of a computer system, such as the one or more processors 202 of computer system 101 (e.g., tablet, smartphone, wearable computer, or head mounted device) (e.g., control unit 110 in FIG. 1A). Some operations in method 2000 are, optionally, combined and/or the order of some operations is, optionally, changed.

In some embodiments, method 2000 is performed at a computer system in communication with a display generation component and one or more input devices. For example, a mobile device (e.g., a tablet, a smartphone, a media player, or a wearable device), or a computer or other electronic device. In some embodiments, the first computer system has one or more characteristics of computer systems in methods 800, 1000, 1200, 1400, 1600, and/or 1800. In some embodiments, the display generation component has one or more characteristics of the display generation component in methods 800, 1000, 1200, 1400, 1600, and/or 1800. In some embodiments, the one or more input devices have one or more characteristics of the one or more input devices in methods 800, 1000, 1200, 1400, 1600, and/or 1800.

In some embodiments, while a three-dimensional environment (e.g., three-dimensional environment 1902 (e.g., an AR, AV, VR, MR, or XR environment) in FIG. 19A) is visible via the display generation component from a current viewpoint of a user of the computer system (e.g., the three-dimensional environment is generated, displayed, or otherwise caused to be viewable by the device (e.g., a computer-generated reality (CGR) environment such as a virtual reality (VR) environment, a mixed reality (MR) environment, and/or an augmented reality (AR) environment)), and while the user of the computer system is in a real-time communication session with a first participant, different from the user, (e.g., a user of a second computer system, different from the computer system), the computer system displays (2002a), via the display generation component, a first spatial arrangement of elements of the real-time communication session (e.g., locations of one or more representations of other participants and/or shared content relative to the current viewpoint of the user) including displaying a first visual representation (e.g., first visual representation 1906) of the first participant at a first location in the three-dimensional environment relative to the current viewpoint of the user. In some embodiments, the three-dimensional environment has one or more characteristics of the three-dimensional environment in methods 800, 1000, 1200, 1400, 1600, and/or 1800. In some embodiments, the real-time communication session has one or more characteristics of the real-time communication session in methods 800, 1000, 1200, 1400, 1600, and/or 1800. In some embodiments, the first visual representation of the first participant is a virtual avatar corresponding to the first participant. In some embodiments, the visual representation of the first participant has one or more characteristics of the visual representations in methods 800, 1000, 1200, 1400, 1600, and/or 1800.

In some embodiments, while displaying the first visual representation of the first participant at the first location relative to the current viewpoint of the user, the computer system detects (2002b) a first event corresponding to a request to reset a spatial distribution of one or more participants in the real-time communication session, such as a selection of button 1931b provided by hand 1903a as shown in FIG. 19B. For example, the computer system detects a first event corresponding to a request to rearrange the three-dimensional environment relative to the current viewpoint of the user, which includes changing the locations at which the first visual representation of the first participant is displayed, such that the user has a new viewpoint within the three-dimensional environment. In some embodiments, detecting the first event includes detecting input provided by the user. For example, the computer system detects the input via a hardware control (e.g., a physical button or dial) of the computer system, such as a press, click, and/or rotation of the hardware control. In some embodiments, the computer system detects the input via a user interface element, such as a selectable option, that is displayed in the three-dimensional environment. For example, the computer system detects a selection of a selectable option that is selectable to request to reset the spatial distribution of one or more participants, such as an air pinch gesture directed to the selectable option and/or an air tap or touch gesture directed to the selectable option, optionally while attention of the user is directed to the selectable option, and/or interaction with a hardware input device (e.g., a controller including buttons, joysticks, and/or dials) that is in communication with the computer system. In some embodiments, detecting the first event has one or more characteristics of detecting events (e.g., corresponding to requests to reset spatial distributions and/or recenter) as described in methods 800, 1000, 1200, 1400, 1600, and/or 1800.

In some embodiments, in response to detecting the first event corresponding to a request to reset a spatial distribution of one or more participants in the real-time communication session, the computer system displays (2002c) a respective updated spatial arrangement of the participants in the real-time communication session, including, in accordance with a determination that the user and the first participant are participating in a shared activity associated with a respective object (e.g., a virtual object that is displayed at a respective location in the three-dimensional environment) within the real-time communication session, such as virtual object 1946 associated with a shared game activity as described with reference to FIG. 17B, displaying, from the current viewpoint of the user, a first updated spatial arrangement of elements of the real-time communication session that is different from the first spatial arrangement of elements of the real-time communication session (2002d) (e.g., an updated spatial arrangement that includes displaying the first visual representation of the first participant at a first updated location relative to the current viewpoint of the user), such as moving the first visual representation 1906 relative to the current viewpoint of the user 1904 as shown in the schematic view of the three-dimensional environment in FIGS. 17C and 17C1. For example, the computer system resets the spatial distribution of the one or more participants in the real-time communication session as described above with reference to method 1800. In some embodiments, when the electronic device detects the first event discussed above, the viewpoint of the user of the electronic device has moved relative to the first participant in the three-dimensional environment (e.g., such that the user and the first participant are in a different spatial distribution), which, in response to detecting the first event, causes the first updated spatial arrangement to be displayed relative to the updated current viewpoint of the user. In some embodiments, the shared activity corresponds to a shared application experience within the real-time communication session. In some embodiments, the shared activity is a shared game in the real-time communication session that corresponds to a shared video game application, and the respective object is a virtual user interface associated with the shared game. For example, the respective object is a virtual game board (e.g., virtual chessboard, checkerboard, or other game board), a virtual arcade board (e.g., a virtual game board), and/or other virtual user interface that is configured to be interacted with and/or viewed by one or more participants in the real-time communication session. In some embodiments, the shared activity is shared content in the real-time communication session that corresponds to a shared content provider application, such as a media provider application, a web-browsing application, a music player application, and/or a word processing application, that is displaying the shared content (e.g., video, images, text, and/or other content) via the respective object. For example, the respective object is a virtual window that is displaying/presenting the shared content that is configured to be interacted with and/or viewed by one or more participants in the real-time communication session (e.g., via their respective computer systems in their respective three-dimensional environments from their respective viewpoints into the three-dimensional environment). In some embodiments, the respective three-dimensional environments of the one or more users in the real-time communication session include the same respective object, such as a same virtual environment, while optionally including other objects that are not associated with the shared activity (e.g., private applications, such as private windows, private virtual environments, and/or other private experiences). In some such embodiments, the respective computer systems of the one or more users in the real-time communication session present different and/or independent views of the shared activity (e.g., the respective object) in their respective three-dimensional environments. In some embodiments, while the respective object that is associated with the shared activity is displayed in the three-dimensional environment, interactions directed to the respective object provided by the one or more participants in the real-time communications session cause (e.g., depending on the input) the respective object to be updated in response to the interactions. For example, if the computer system detects the user provide user input directed to the respective object for moving the respective object relative to the current viewpoint of the user, in response to the user input, the computer system moves the respective object in accordance with the user input in the three-dimensional environment, and because the respective object is shared between the user and the first participant, the first participant would also see the respective object move in their three-dimensional environment (e.g., due to movement of the respective object by the second computer system associated with the first participant). Accordingly, as discussed herein, in some embodiments, changes to one or more visual characteristics of the respective object (e.g., visual appearance, display location, size, color, and/or content of the respective object) are reflected by all of the computer systems with which the respective object is shared. In some embodiments, the shared activity has one or more characteristics of the shared activities described above with reference to methods 1000 and/or 1200.

In some embodiments, in accordance with a determination that the first user and the first participant are not participating in the shared activity associated with the respective object within the real-time communication session (e.g., are not participating in any shared activity or are participating in a different shared activity), the computer system displays (2002e), from the current viewpoint of the user, a second updated spatial arrangement of elements of the real-time communication session that is different from the first spatial arrangement and the first updated spatial arrangement of elements of the real-time communication session (e.g., an updated spatial arrangement that includes displaying the first visual representation of the first participant at a second updated location relative to the current viewpoint of the user that is different from the first updated location above), as similarly described with reference to FIG. 19C. For example, the three-dimensional environment does not include the respective object that is associated with the shared activity discussed above. In some embodiments, the respective object is associated with a private activity in the three-dimensional environment. For example, the respective object includes content (e.g., such as content discussed above) that is private to the user of the computer system, and the content is thus not configured to be interacted with and/or visible to the first participant (e.g., at the second computer system). In some embodiments, while the respective object is associated with the private activity in the three-dimensional environment, only the user is able to interact with and view the content of the respective object. In some embodiments, when the electronic device detects the first event discussed above, the viewpoint of the user of the electronic device has moved relative to the first participant in the three-dimensional environment (e.g., such that the user and the first participant are in a different spatial distribution), which, in response to detecting the first event, causes the second updated spatial arrangement to be displayed relative to the updated current viewpoint of the user. In some embodiments, when the computer system detects the first event, the first visual representation of the first participant is located the first distance at the first location from the current viewpoint of the user and the respective object is located a third distance from the current viewpoint. As similarly discussed above, when the first event is detected, the user occupies a first seat and the first participant occupies a second seat in the real-time communication session in the three-dimensional environment (e.g., where the current viewpoint of the user is located at the first seat). However, because the first user and the first participant are not participating in the shared activity, the first seat and the second seat are optionally not arranged relative to the respective object in the three-dimensional environment. Rather, the first viewpoint of the first user and the first location of the first visual representation are optionally arranged according to a first shape having one or more first characteristics (e.g., a circular or oval shape having a first radius), where the respective object is not necessarily occupying a center of the arrangement. For example, the respective object is displayed relative to the first seat of the user in the real-time communication session. In some embodiments, when the computer system resets the spatial distribution of the one or more participants in the real-time communication session, as similarly described above, the computer system updates the seat within the three-dimensional environment which the user occupies. For example, the computer system selects an unoccupied seat, such as a third seat, within the three-dimensional environment that causes the first visual representation of the first participant to shift location in the three-dimensional environment relative to a new viewpoint of the user (e.g., as viewed from the user's new seat in the three-dimensional environment, such as the third seat discussed above). In some embodiments, the current viewpoint of the first user and the second updated location of the first visual representation are arranged according to the first shape having one or more second characteristics (e.g., a circular or oval shape having a second radius, different from the first radius above) or a second shape (e.g., a rectangular, triangular, or other shape), different from the first shape, where, again, the respective object is not necessarily occupying a center of the arrangement. In some embodiments, when the three-dimensional environment is displayed from the current viewpoint of the user, the respective object moves with the first user, such that the respective object remains a same distance (e.g., the respective distance) and/or orientation relative to the user from the current viewpoint. For example, the respective object moves with the user from the first seat to the third seat within the real-time communication session because the respective object is private to the user. In some embodiments, in response to detecting the first event, after resetting the spatial distribution of the one or more participants in the real-time communication session, the first visual representation of the first participant is located a first updated distance at the second updated location from the current viewpoint of the user and the respective object is located the respective distance from the current viewpoint. For example, after the spatial distribution is reset, the first visual representation of the first participant is located closer to or farther from the current viewpoint of the user than from the previous viewpoint and/or is rotated from the current viewpoint compared to the previous viewpoint, but the respective object remains at the same distance and/or orientation from the current viewpoint of the user as the previous viewpoint. In some embodiments, resetting the spatial distribution in the manners described above has one or more characteristics of resetting the spatial distribution as described in methods 1400, 1600, and/or 1800. Resetting a spatial distribution of one or more users in a real-time communication session, including updating locations at which visual representations of one or more users are displayed in a three-dimensional environment, based on whether the one or more users are participating in a shared activity in the real-time communication session reduces the number of inputs needed to manually move the viewpoint(s) of the user(s) within the real-time communication session relative to the shared activity and/or enables the spatial distribution to be reset relative to the shared activity automatically, thereby improving user-device interaction.

In some embodiments, the user and the first participant are participating in the shared activity associated with the respective object (e.g., a virtual object that is displayed at a respective location in the three-dimensional environment) within the real-time communication session (e.g., as similarly discussed above with reference to step(s) 2002). In some embodiments, in the first spatial arrangement of the elements of the real-time communication session, the current viewpoint of the user is positioned at a second location relative to the respective object, wherein the second location does not correspond to a respective slot (e.g., a seat or position within a template of seats or positions, as described herein) in a respective template (e.g., a pre-determined template and/or a dynamically generated template, as similarly described in method 1200) associated with the shared activity, such as the position of the user 1904 shown in the schematic view in FIG. 19B. In some embodiments, the slots in the respective template have one or more characteristics of the slots discussed in method 1200. For example, as similarly discussed above with reference to step(s) 2002, the respective object that is associated with the shared activity is associated with a plurality of predefined seats for the participants within the respective template in the real-time communication session. In some embodiments, the predefined seats are locations relative to the respective object at which the participants in the real-time communication session are able to be positioned in the three-dimensional environment. For example, the current viewpoint of the user is positioned at the second location before detecting the first event, where the second location optionally does not correspond to a first seat of the predefined of seats associated with the respective object. Additionally, in some embodiments, in the first spatial arrangement of the elements of the real-time communication session, the first visual representation of the first participant is displayed at the first location that corresponds to a second seat of the predefined seats associated with the respective object. In some embodiments, as discussed in more detail below, a number and/or a spatial arrangement of the predefined seats associated with the respective object are determined based on a type of shared activity that the participants in the real-time communication system are interacting with. In some embodiments, as similarly discussed with reference to method 1800, a respective seat of the predefined seats is “occupied” if a user in the real-time communication session is positioned at the respective seat (e.g., the current viewpoint of the user of the computer system is positioned at the respective seat or a visual representation of a participant (e.g., the first visual representation of the first participant) in the real-time communication session is displayed at the respective seat). Accordingly, in some embodiments, the first location relative to the respective object (e.g., the second seat of the predefined seats) is occupied by the first participant in the real-time communication session. In some embodiments, a single user/participant is able to occupy a seat that is associated with the respective object at any given time (e.g., two users optionally cannot concurrently occupy the same seat). In some embodiments, a respective seat of the predefined seats is “unoccupied” if no user in the real-time communication session is positioned at the respective seat (e.g., a particular location associated with the respective object).

In some embodiments, in response to detecting the first event corresponding to a request to reset a spatial distribution of one or more participants in the real-time communication session, displaying the first updated spatial arrangement of elements of the real-time communication session includes, in accordance with a determination that the user of the computer system is assigned to a first slot in the respective template associated with the shared activity and that one or more placement criteria are satisfied, positioning the current viewpoint at a second updated location that corresponds to the first slot, such as positioning the current viewpoint of the user 1904 at seat labeled “A” as shown in the schematic view in FIG. 19C. In some embodiments, in accordance with a determination that the user of the computer system is assigned to a second slot, different from the first slot, in the respective template and that the one or more placement criteria are satisfied, the computer system positions the current viewpoint at a third updated location, different from the second updated location, corresponding to the second slot, such as positioning the current viewpoint of the user 1904 at seat labeled “A” as shown in the schematic view in FIG. 19H. For example, when the first event is detected, the current viewpoint of the user is no longer positioned at the predefined seat for the user within the respective template. In some embodiments, the current viewpoint of the user has moved/shifted in response to movement of the user within the physical environment surrounding the computer system, which causes the computer system to move accordingly. In some embodiments, the one or more placement criteria relate to seat occupancy within the respective template, as discussed in more detail below. In some embodiments, in response to detecting the first event, the computer system updates the spatial arrangement of the elements of the real-time communication session such that the current viewpoint of the user is repositioned at an updated location that corresponds to the user's assigned seat (e.g., slot) within the respective template. For example, if the user is assigned to the first slot in the respective template, the computer system positions the current viewpoint of the user at the second updated location in the three-dimensional environment, and if the user is assigned to the second slot in the respective template, the computer system positions the current viewpoint at the third updated location. Accordingly, in some embodiments, when the spatial distribution of the one or more participants in the real-time communication session is reset, if the shared activity is associated with a spatial template, the current viewpoint of the user is positioned at a seat of the predefined seats that is assigned to the user within the spatial template. Resetting a spatial distribution of one or more users in a real-time communication session, including updating locations at which visual representations of one or more users are displayed in a three-dimensional environment, to positions relative to an object associated with a shared activity if the one or more users are participating in the shared activity in the real-time communication session reduces the number of inputs needed to manually move the viewpoint(s) of the user(s) within the real-time communication session relative to the shared activity and/or enables the spatial distribution to be reset relative to the shared activity automatically, thereby improving user-device interaction.

In some embodiments, the one or more placement criteria include a criterion that is satisfied in accordance with a determination that a respective slot that is assigned to the user of the computer system in the respective template is unoccupied (e.g., by another participant in the real-time communication session, as similarly described above with reference to the predefined seats associated with the respective object), such as seat labeled A in the schematic view in FIG. 19B being unoccupied by the first visual representation 1906. In some embodiments, in response to detecting the first event corresponding to a request to reset a spatial distribution of one or more participants in the real-time communication session, displaying the first updated spatial arrangement of elements of the real-time communication session includes, in accordance with a determination that the user of the computer system is assigned to the first slot in the respective template associated with the shared activity and that the one or more placement criteria are not satisfied (e.g., because second visual representation 1908 of a second participant is occupying the user's assigned seat labeled A as shown in the schematic view in FIG. 19D), positioning the current viewpoint at a fourth updated location, different from the second updated location, that corresponds to a third slot, different from the first slot, in the respective template, wherein the fourth updated location is within a threshold distance (e.g., 0.1, 0.25, 0.5, 0.75, 0.9, 1, 1.5, 2, 3, or 5 m) of the second updated location, such as positioning the current viewpoint of the user 1904 proximate to the second visual representation 1908 as shown in the schematic view in FIG. 19D. For example, the computer system positions the current viewpoint of the user to be at a different seat than their previous (e.g., assigned) seat of the predefined seats associated with the respective object if the user's previous is occupied. In some embodiments, the fourth updated location is selected to be near the second updated location (e.g., adjacent to the second updated location). For example, the fourth updated location corresponds to a seat that is nearest to (e.g., adjacent to) the user's previous seat of the predefined seats associated with the respective object in the real-time communication session.

In some embodiments, in accordance with a determination that the user of the computer system is assigned to the second slot in the respective template and that the one or more placement criteria are not satisfied, the computer system positions the current viewpoint at a fifth updated location, different from the third updated location, that corresponds to a fourth slot, different from the second slot, in the respective template, wherein the fifth updated location is within the threshold distance of the third updated location, as similarly described with reference to the schematic view of FIG. 19D. In some embodiments, the fifth updated location is selected to be near the third updated location (e.g., adjacent to the third updated location). For example, the fifth updated location corresponds to a seat that is nearest to (e.g., adjacent to) the user's previous seat of the predefined seats associated with the respective object in the real-time communication session. Resetting a spatial distribution of one or more users in a real-time communication session, including updating locations at which visual representations of one or more users are displayed in a three-dimensional environment, to previous positions relative to an object associated with a shared activity reduces the number of inputs needed to manually move the viewpoint(s) of the user(s) within the real-time communication session relative to the shared activity and/or enables the spatial distribution to be reset relative to the shared activity automatically, while avoiding potential spatial conflict between the visual representations, thereby improving user-device interaction.

In some embodiments, the threshold distance is determined based on a size (e.g., radius/diameter, length, width, and/or area) of a predefined boundary surrounding a participant in the real-time communication session that restricts proximity of other participants to the participant in the real-time communication session, such as a personal boundary surrounding the second visual representation 1908 in the schematic view of FIG. 19D. For example, the threshold distance is selected such that, when the current viewpoint of the user is positioned at the fourth updated location or the fifth updated location relative to the respective object, the current viewpoint of the user is outside of the predefined boundary surrounding the participant (e.g., represented by their visual representation, such as the first visual representation of the first participant). In some embodiments, the threshold distance overlaps with and/or corresponds to (e.g., is equal to) the size of the predefined boundary. In some embodiments, the threshold distance is measured relative to the predefined boundary. In some embodiments, the predefined boundary is not necessarily displayed in the three-dimensional environment. In some embodiments, the predefined boundary has one or more characteristics of personal boundaries described in method 800. Resetting a spatial distribution of one or more users in a real-time communication session, including updating locations at which visual representations of one or more users are displayed in a three-dimensional environment, to positions based on personal boundary distances relative to an object associated with a shared activity reduces the number of inputs needed to manually move the viewpoint(s) of the user(s) within the real-time communication session relative to the shared activity and/or enables the spatial distribution to be reset relative to the shared activity automatically, while avoiding potential spatial conflict between the visual representations, thereby improving user-device interaction.

In some embodiments, the threshold distance is determined based on a minimum distance (e.g., 0.001, 0.01, 0.1, 0.25, 0.5, 0.75, or 1 m) relative to the current viewpoint of the user within which a visual representation of a participant (e.g., such as the first visual representation of the first participant) is displayed with a reduced degree of visual prominence, such as the second visual representation 1908 in the schematic view in FIG. 19D. For example, if the computer system detects at least a portion of the visual representation of the participant within the minimum distance relative to the current viewpoint of the user, the computer system changes a visual appearance of the visual representation to have a reduced degree of visual prominence. In some embodiments, changing the visual appearance of a visual representation of a participant to have a reduced degree of visual prominence has one or more characteristics of the same in method 800. Accordingly, when the computer system displays the first updated spatial arrangement of the elements of the real-time communication session in response to detecting the first event, the computer system optionally repositions the current viewpoint of the user relative to the respective object to be at least the minimum distance from adjacent visual representations of participants in the real-time communication session, such that the visual representations are not displayed with a changed visual appearance having a reduced degree of visual prominence in the three-dimensional environment. Resetting a spatial distribution of one or more users in a real-time communication session, including updating locations at which visual representations of one or more users are displayed in a three-dimensional environment, to positions based on a minimum distance relative to the current viewpoint of the user reduces the number of inputs needed to manually move the viewpoint(s) of the user(s) within the real-time communication session outside of the minimum distance and/or enables the spatial distribution to be reset based on the minimum distance automatically, while avoiding potential spatial conflict between the visual representations, thereby improving user-device interaction.

In some embodiments, in response to detecting the first event corresponding to a request to reset a spatial distribution of one or more participants in the real-time communication session, displaying the first updated spatial arrangement of elements of the real-time communication session includes, in accordance with a determination that the first spatial arrangement of the elements of the real-time communication session is arranged according to a respective template (e.g., a pre-determined template and/or a dynamically generated template, as similarly described in method 1200) in the three-dimensional environment, positioning the current viewpoint of the user at a second updated location corresponding to a first slot in the respective template, such as positioning the current viewpoint of the user 1904 at the seat labeled A as shown in the schematic view in FIG. 19C. For example, as previously discussed above, if the participants in the real-time communication session are participating in the shared activity, the three-dimensional environment includes a respective object that is optionally associated with predefined seats at which the users in the real-time communication session are configured to be positioned in the three-dimensional environment. In some embodiments, when the first event is detected, the computer system positions the current viewpoint of the user at the second updated location that corresponds to an available (e.g., unoccupied, as similarly discussed above) seat (e.g. slot) within the respective template. In some embodiments, if there are multiple unoccupied seats that are associated with the respective object, the computer system selects the second updated location based on one or more selection criteria as discussed in more detail below.

In some embodiments, in accordance with a determination that the first spatial arrangement of the elements of the real-time communication session is not arranged according to the respective template in the three-dimensional environment, such as the first visual representation 1906 being positioned according to a line 1918 as shown in the schematic view in FIG. 19K, the computer system positions the current viewpoint of the user at a third updated location that does not correspond to a respective slot in the respective template (e.g., or any template), such as positioning the current viewpoint of the user 1904 along the line 1918 as shown in the schematic view in FIG. 19L. For example, the third updated location does not correspond to an available seat (e.g., slot) within the respective template. In some embodiments, if the first spatial arrangement is not arranged according to the respective template in the three-dimensional environment, the computer system positions the current viewpoint at the third updated location based on a spatial arrangement of the users, a spatial distribution of the users, and/or a number of users in the real-time communication session, as discussed in more detail below. Resetting a spatial distribution of one or more users in a real-time communication session, including updating locations at which visual representations of one or more users are displayed in a three-dimensional environment, to unoccupied positions relative to an object associated with a shared activity reduces the number of inputs needed to manually move the viewpoint(s) of the user(s) within the real-time communication session relative to the shared activity and/or enables the spatial distribution to be reset relative to the shared activity automatically, while avoiding potential spatial conflict between the visual representations, thereby improving user-device interaction

In some embodiments, the second updated location is selected in accordance with a determination that the second updated location satisfies one or more selection criteria, as similarly described with reference to FIG. 19C. In some embodiments, as discussed in more detail below, the one or more selection criteria are based on one or more characteristics of the shared activity. For example, the computer system selects a seat that is associated with the respective object at which to position the current viewpoint of the user in the first updated spatial arrangement based on a type of the shared activity that the users are participating in in the real-time communication session. In some embodiments, in accordance with a determination that a third updated location satisfies the one or more selection criteria, and the second updated location does not satisfy the one or more selection criteria, the computer system selects the third updated location as the position of the current viewpoint of the user when the spatial distribution is reset. Resetting a spatial distribution of one or more users in a real-time communication session, including updating locations at which visual representations of one or more users are displayed in a three-dimensional environment, to unoccupied positions relative to an object associated with a shared activity that satisfy one or more selection criteria reduces the number of inputs needed to manually move the viewpoint(s) of the user(s) within the real-time communication session relative to the shared activity and/or enables the spatial distribution to be reset relative to the shared activity automatically, thereby improving user-device interaction.

In some embodiments, satisfaction of the one or more selection criteria is based on one or more characteristics of the shared activity, as similarly described with reference to FIG. 19C. In some embodiments, the one or more characteristics include a type of activity that is shared in the real-time communication session, which controls a size of the respective object, the content of the respective object, a number of predefined seats associated with the respective object, and/or a spatial arrangement of the participants relative to the respective object (e.g., a circular arrangement around the respective object or a linear or curved arrangement that faces the respective object). For example, as similarly discussed above with reference to step(s) 2002, if the shared activity is a game activity, the respective object is an interactive gameboard user interface that is associated with the game activity. In some embodiments, the game is played in turns (e.g., each user or teams of users participate in the game sequentially, going back and forth between users or teams). In some embodiments, the user's turn defines the user's seat relative to the respective object. For example, if the user's interactive game pieces are positioned along a first portion of the respective object (e.g., a first edge of a horizontally oriented game board), the user's seat is positioned in front of or near the first portion of the respective object. Accordingly, in some embodiments, when the computer system resets the spatial distribution of the one or more participants in the real-time communication session, the computer system selects an available (e.g., unoccupied) seat of the predefined seats that is closest to the user's interactive game pieces. As another example, if the shared activity is a movie watching experience, the respective object is a user interface of a media player application that is displaying the movie. In some embodiments, when the computer system resets the spatial distribution of the one or more participants in the real-time communication session, the computer system selects an available seat of the predefined seats that is most centrally located relative to the respective object, such that the user may enjoy the best view (e.g., most unobscured view and/or a view that is most oriented toward the viewpoint of the user of the views provided by the predefined seats). In some embodiments, a particular seat of the predefined seats does not satisfy the one or more selection criteria if another seat of the predefined seats is more suited to the user's experience of the shared activity according to the one or more characteristics above is available. Resetting a spatial distribution of one or more users in a real-time communication session, including updating locations at which visual representations of one or more users are displayed in a three-dimensional environment, to unoccupied positions relative to an object associated with a shared activity based on one or more characteristics of the shared activity reduces the number of inputs needed to manually move the viewpoint(s) of the user(s) within the real-time communication session relative to the shared activity and/or enables the spatial distribution to be reset relative to the shared activity automatically, thereby improving user-device interaction.

In some embodiments, the second updated location is selected in accordance with a determination that the second updated location is the closest location of the plurality of predefined locations relative to the current viewpoint of the user when the first event is detected, such as the seat labeled A being closer to the current viewpoint of the user 1904 than the seat labeled “B” in the schematic view in FIG. 19B. For example, when the computer system resets the spatial distribution of the one or more participants in the real-time communication session, the computer system identifies a seat of the predefined seats associated with the respective object that is closest to the current viewpoint of the user when the first event is detected. In some embodiments, as discussed in more detail later below, the second updated location is the closest available (e.g., unoccupied) location of the plurality of predefined locations associated with the respective object relative to the current viewpoint of the user when the first event is detected. In some embodiments, in accordance with a determination that a third updated location, different from the second updated location, is the closest location of the plurality of predefined locations relative to the current viewpoint of the user when the first event is detected, the computer system selects the third updated location (e.g., instead of the second updated location). Resetting a spatial distribution of one or more users in a real-time communication session, including updating locations at which visual representations of one or more users are displayed in a three-dimensional environment, to a position relative to an object associated with a shared activity that is closest to the current viewpoint of the user reduces the number of inputs needed to manually move the viewpoint(s) of the user(s) within the real-time communication session relative to the shared activity and/or enables the spatial distribution to be reset relative to the shared activity automatically, which helps reduce a change in a spatial context of the three-dimensional environment relative to the current viewpoint, thereby improving user-device interaction.

In some embodiments, the one or more placement criteria include a criterion that is satisfied in accordance with a determination that a respective slot that is assigned to the user of the computer system in the respective template is unoccupied (e.g., by another participant in the real-time communication session, as similarly described above with reference to the predefined seats associated with the respective object). In some embodiments, in response to detecting the first event corresponding to a request to reset a spatial distribution of one or more participants in the real-time communication session, displaying the first updated spatial arrangement of elements of the real-time communication session includes, in accordance with a determination that the user of the computer system is assigned to the first slot in the respective template associated with the shared activity and that the one or more placement criteria are not satisfied (e.g., because the second visual representation 1908 of the second participant is occupying the user's previous seat as shown in the schematic view in FIG. 19K), positioning the current viewpoint at a fourth updated location, different from the second updated location, that corresponds to a third slot, different from the first slot, in the respective template, such as positioning the current viewpoint of the user 1904 at available seat labeled B as shown in the schematic view in FIG. 19L. For example, the computer system positions the current viewpoint of the user to be at a different seat than their previous (e.g., assigned) seat of the predefined seats associated with the respective object if the user's previous is occupied. In some embodiments, the fourth updated location is selected irrespective of its proximity to the second updated location (e.g., corresponding to the user's assigned seat), so long as the fourth updated location corresponds to a seat in the respective template that is unoccupied by another user/participant.

In some embodiments, in accordance with a determination that the user of the computer system is assigned to the second slot in the respective template and that the one or more placement criteria are not satisfied, the computer system positions the current viewpoint at a fifth updated location, different from the third updated location, that corresponds to a fourth slot, different from the second slot, in the respective template, as similarly described with reference to FIG. 19L. In some embodiments, the fifth updated location is selected irrespective of its proximity to the third updated location (e.g., corresponding to the user's assigned seat), so long as the fifth updated location corresponds to a seat in the respective template that is unoccupied by another user/participant. Resetting a spatial distribution of one or more users in a real-time communication session, including updating locations at which visual representations of one or more users are displayed in a three-dimensional environment, to previous positions relative to an object associated with a shared activity reduces the number of inputs needed to manually move the viewpoint(s) of the user(s) within the real-time communication session relative to the shared activity and/or enables the spatial distribution to be reset relative to the shared activity automatically, while avoiding potential spatial conflict between the visual representations, thereby improving user-device interaction.

In some embodiments, in accordance with a determination that the shared activity is a first type of activity, the respective template is a first template that includes a respective slot that is assigned to the user of the computer system, such as the spatial template associated with the virtual object 1946 as described with reference to FIG. 19A. For example, the first type of activity is a shared activity that requires/includes direct interaction from the one or more participants in the real-time communication session with the respective object associated with the shared activity. As an example, the first type of activity is a game activity, optionally involving a game board or other interactive user interface that has a (e.g., flat) top surface (e.g., such that the respective object is horizontally oriented in the three-dimensional environment). Particularly, the first type of activity is a game activity that requires the one or more participants in the real-time communication session to participate in the game by taking turns (e.g., taking turns individually or in teams). Accordingly, the respective object is optionally associated with a first plurality of predefined locations within the first template in which the participants in the real-time communication session are particularly arranged relative to the respective object to facilitate improved interaction with the game (e.g., direct or indirect interaction with the respective object), such as by positioning each user near/in front of their own set of game pieces and/or positioning users on a team with/near other users on the team. For example, in the first template, the first plurality of predefined locations (e.g., first predefined seats) is arranged around the respective object, such as arranged in a circle, a triangle, a rectangle, a square, and/or other shape.

In some embodiments, in accordance with a determination that the shared activity is a second type of activity, different from the first type of activity, the respective template is a second template, different from the first template, that does not include a respective slot assigned to the user of the computer system, such as the spatial template associated with the virtual object 1930 as described with reference to FIG. 19K. For example, the second type of activity is a shared activity that does not necessarily include direct interaction from the one or more participants in the real-time communication session with the respective object associated with the shared activity. As an example, the second type of activity is a movie watching activity, optionally involving a playback user interface that is displaying the movie or other user interface that has a front-facing surface (e.g., such that the respective object is vertically oriented in the three-dimensional environment). Particularly, the second type of activity is a movie watching activity that does not require the one or more participants in the real-time communication session to provide input directed to the playback user interface, other than viewing (e.g., actively or passively) the movie that is being displayed in the playback user interface. Accordingly, the respective object is optionally associated with a second plurality of predefined locations within the second template in which the participants in the real-time communication session are not necessarily particularly arranged relative to the respective object, since viewing the movie in the playback user interface does not require users to be placed at particular positions relative to the respective object (e.g., the playback user interface) to facilitate improved viewing experiences for the users. For example, when displaying the first updated spatial arrangement according to the second template, the second plurality of predefined locations (e.g., second predefined seats) is arranged in an arc and/or along a line in front of the respective object and the user of the computer system is not assigned to a particular location of the second plurality of predefined locations. Resetting a spatial distribution of one or more users in a real-time communication session, including updating locations at which visual representations of one or more users are displayed in a three-dimensional environment, to positions relative to an object associated with a shared activity that are determined based on whether the shared activity has predefined positions in the three-dimensional environment reduces the number of inputs needed to manually move the viewpoint(s) of the user(s) within the real-time communication session based on the type of the shared activity and/or enables the spatial distribution to be reset relative to the shared activity based on the type of the shared activity automatically, while avoiding potential spatial conflict between the visual representations, thereby improving user-device interaction.

In some embodiments, displaying, from the current viewpoint of the user, the first updated spatial arrangement of elements of the real-time communication session that is different from the first spatial arrangement of elements of the real-time communication session includes, in accordance with a determination that the shared activity is a first type of activity (e.g., such as one of the first types of activities discussed below), displaying, from the current viewpoint of the user, the first visual representation of the first participant at a first updated location relative to the respective object in the three-dimensional environment, such as movement of the first visual representation 1906 relative to the current viewpoint of the user 1904 as shown in the schematic view in FIG. 19C. In some embodiments, in accordance with a determination that the shared activity is a second type of activity (e.g., such as one of the second types of activities discussed below), different from the first type of activity, the computer system displays, from the current viewpoint of the user, the first visual representation of the first participant at a third updated location, different from the first updated location, relative to the respective object, such as the movement of the first visual representation 1906 relative to the current viewpoint of the user 1904 as shown in the schematic view in FIG. 19L. In some embodiments, in response to detecting the first event, in accordance with the determination that the first user and the first participant are participating in the shared activity associated with the respective object, the computer system updates the spatial arrangement of the user of the computer system, the first participant, and/or other participants participating in the real-time communication session based on the type of activity (e.g., the type of content) that is being displayed in the three-dimensional environment. For example, as similarly described in method 1200, the first type of activity is associated with a first template in which the first visual representation of the first participant is displayed at the first updated location within the first template from the current viewpoint. In some embodiments, the second type of activity is associated with a second template, different from the first template, in which the first visual representation of the first participant is displayed at the third updated location within the second template from the current viewpoint. In some embodiments, updating the spatial arrangement of the participants in the real-time communication session based on the type of shared activity and/or content that is displayed in the three-dimensional environment in the real-time communication session has one or more characteristics of the same in method 1200. Resetting a spatial distribution of one or more users in a real-time communication session, including updating locations at which visual representations of one or more users are displayed in a three-dimensional environment, based on a type of a shared activity that is displayed in the three-dimensional environment reduces the number of inputs needed to manually move the viewpoint(s) of the user(s) within the real-time communication session based on the type of the shared activity and/or enables the spatial distribution to be reset relative to the shared activity based on the type of the shared activity automatically, while avoiding potential spatial conflict between the visual representations, thereby improving user-device interaction.

In some embodiments, the first type of activity corresponds to a group activity that includes interaction with horizontally oriented content (e.g., the virtual object 1946 in FIG. 19A) by the one or more participants (e.g., including the user of the computer system) in the real-time communication session. In some embodiments, the second type of activity corresponds to a non-group activity and/or an activity that does not include direct interaction with the horizontally oriented content by the one or more participants in the real-time communication session. For example, as similarly discussed above, the respective object corresponds to a game board (or other user interface) around which the participants in the real-time communication session are arranged/positioned for viewing and/or interacting with a top (e.g., flat) surface of the game board. In some embodiments, the second type of activity corresponds to a group activity that includes interaction with vertically oriented content by the one or more participants. For example, as similarly discussed above, the respective object corresponds to an application window (or similar user interface) in front of which the participants in the real-time communication session are arranged/positioned for viewing a front surface of the application window. Resetting a spatial distribution of one or more users in a real-time communication session, including updating locations at which visual representations of one or more users are displayed in a three-dimensional environment, based on a type of a shared activity that is displayed in the three-dimensional environment reduces the number of inputs needed to manually move the viewpoint(s) of the user(s) within the real-time communication session based on the type of the shared activity and/or enables the spatial distribution to be reset relative to the shared activity based on the type of the shared activity automatically, while avoiding potential spatial conflict between the visual representations, thereby improving user-device interaction.

In some embodiments, the first type of activity corresponds to a conversational activity among the one or more participants in the real-time communication session, wherein one or more participants are non-spatial participants in the real-time communication session, as similarly described with reference to the FIG. 11 series. For example, the one or more participants in the real-time communication session are arranged as a conversational group, without necessarily viewing and/or interacting with content in the three-dimensional environment. In some embodiments, one of the one or more participants (e.g., such as the first participant) in the real-time communication session is a non-spatial participant, such that the respective object corresponds to a two-dimensional representation of the second user that is displayed within a virtual canvas. In some embodiments, the virtual canvas is vertically oriented. In some embodiments, the non-spatial participant has one or more characteristics of non-spatial participants discussed in methods 800, 1000, and/or 1200. In some embodiments, in the first spatial arrangement, the participants, including the non-spatial participant(s), are arranged in a particular shape (e.g., circle, triangle, rectangle, and/or square) such that the participants are angled toward the center of the shape. In some embodiments, the spatial participants in the real-time communication session are angled to face toward the virtual canvas within which the non-spatial participant(s) are displayed. In some embodiments, the second type of activity corresponds to a conversational activity in which all the participants in the real-time communication session are spatial participants (e.g., represented by the visual representations discussed previously above with reference to step(s) 2002). In some such embodiments, the respective object associated with the shared activity is one of the visual representations of the participants or is other content that is shared in the real-time communication session, such as a user interface, a game board, or other types of content discussed herein above. Resetting a spatial distribution of one or more users in a real-time communication session, including updating locations at which visual representations of one or more users are displayed in a three-dimensional environment, based on a type of a shared activity that is displayed in the three-dimensional environment reduces the number of inputs needed to manually move the viewpoint(s) of the user(s) within the real-time communication session based on the type of the shared activity and/or enables the spatial distribution to be reset relative to the shared activity based on the type of the shared activity automatically, while avoiding potential spatial conflict between the visual representations, thereby improving user-device interaction.

In some embodiments, the first type of activity corresponds to a group activity that includes interaction with vertically oriented (optionally two-dimensional) content (e.g., the virtual object 1930 in FIG. 19K) by the one or more participants (e.g., including the user of the computer system) in the real-time communication session. For example, the respective object is a vertically oriented window or other container that is displaying a user interface, such as a playback user interface, a web browsing user interface, a notetaking or presentation user interface, and/or a messaging user interface. In some embodiments, in the first spatial arrangement, the one or more participants are arranged in front of a front-facing surface of the respective object, rather than arranged in a shape (e.g., circle or triangle) around the respective object as is the case for a horizontally oriented object. In some embodiments, the second type of activity corresponds to a non-group activity and/or an activity that does not include direct interaction with the vertically oriented content by the one or more participants in the real-time communication session. For example, the second type of activity corresponds to a group activity that includes interaction with horizontally oriented content by the one or more participants. Resetting a spatial distribution of one or more users in a real-time communication session, including updating locations at which visual representations of one or more users are displayed in a three-dimensional environment, based on a type of a shared activity that is displayed in the three-dimensional environment reduces the number of inputs needed to manually move the viewpoint(s) of the user(s) within the real-time communication session based on the type of the shared activity and/or enables the spatial distribution to be reset relative to the shared activity based on the type of the shared activity automatically, while avoiding potential spatial conflict between the visual representations, thereby improving user-device interaction.

In some embodiments, displaying the respective updated spatial arrangement of the participants in the real-time communication session includes, in accordance with the determination that the first user and the first participant are not participating in the shared activity associated with the respective object within the real-time communication session, displaying, from the current viewpoint of the user, the second updated spatial arrangement of elements of the real-time communication session based on a quantity of the one or more participants in the real-time communication session, as similarly described with reference to the FIG. 13 series. In some embodiments, in response to detecting the first event, in accordance with the determination that the first user and the first participant are not participating in the shared activity associated with the respective object, the computer system updates the spatial arrangement of the user of the computer system, the first participant, and/or other participants participating in the real-time communication session based on a total number of participants in the real-time communication session. For example, in accordance with a determination that the quantity of the one or more participants in the real-time communication session is a first quantity, the computer system displays, from the current viewpoint of the user, the first visual representation of the first participant at a first updated location in the three-dimensional environment. In some embodiments, in accordance with a determination that the quantity of the one or more participants in the real-time communication session is a second quantity, different from the first quantity, the computer system displays, from the current viewpoint of the user, the first visual representation of the first participant at a third updated location, different from the first updated location. In some embodiments, updating the spatial arrangement of the participants in the real-time communication session based on the quantity of participants in the real-time communication session has one or more characteristics of the same in method 1400. Resetting a spatial distribution of one or more users in a real-time communication session, including updating locations at which visual representations of one or more users are displayed in a three-dimensional environment, based on a number of participants in the real-time communication session reduces the number of inputs needed to manually move the viewpoint(s) of the user(s) within the real-time communication session based on the number of participants and/or enables the spatial distribution to be reset based on the number of participants automatically, thereby improving user-device interaction.

In some embodiments, displaying the respective updated spatial arrangement of the participants in the real-time communication session includes, in accordance with the determination that the first user and the first participant are not participating in the shared activity associated with the respective object within the real-time communication session, displaying, from the current viewpoint of the user, the second updated spatial arrangement of elements of the real-time communication session based on a grouping arrangement of the one or more participants in the real-time communication session, as similarly described with reference to the FIG. 15 series. In some embodiments, in response to detecting the first event, in accordance with the determination that the first user and the first participant are not participating in the shared activity associated with the respective object, the computer system updates the spatial arrangement of the user of the computer system, the first participant, and/or other participants participating in the real-time communication session based on a grouping of participants in the real-time communication session. For example, the grouping arrangement includes a spatial distribution of the participants relative to one another and/or the three-dimensional environment, such as an arrangement where groups of participants are relatively close together, and/or a spatial profile (e.g., shape) of groups of participants within the three-dimensional environment. In some embodiments, in accordance with a determination that the grouping arrangement of the one or more participants in the real-time communication session is a first grouping arrangement, the computer system displays, from the current viewpoint of the user, the first visual representation of the first participant at a first updated location in the three-dimensional environment. In some embodiments, in accordance with a determination that the grouping arrangement of the one or more participants in the real-time communication session is a second grouping arrangement, different from the first grouping arrangement, the computer system displays, from the current viewpoint of the user, the first visual representation of the first participant at a third updated location, different from the first updated location. In some embodiments, updating the spatial arrangement of the participants in the real-time communication session based on the grouping of the participants in the real-time communication session has one or more characteristics of the same in method 1600. Resetting a spatial distribution of one or more users in a real-time communication session, including updating locations at which visual representations of one or more users are displayed in a three-dimensional environment, based on a grouping arrangement of participants in the real-time communication session reduces the number of inputs needed to manually move the viewpoint(s) of the user(s) within the real-time communication session based on the grouping arrangement and/or enables the spatial distribution to be reset based on the grouping arrangement automatically, thereby improving user-device interaction.

In some embodiments, displaying the respective updated spatial arrangement of the participants in the real-time communication session includes, in accordance with the determination that the first user and the first participant are not participating in the shared activity associated with the respective object within the real-time communication session, displaying, from the current viewpoint of the user, the second updated spatial arrangement of elements of the real-time communication session based on a spatial distribution of the one or more participants in the real-time communication session, as similarly described with reference to the FIG. 17 series. In some embodiments, in response to detecting the first event, in accordance with the determination that the first user and the first participant are not participating in the shared activity associated with the respective object, the computer system updates the spatial arrangement of the user of the computer system, the first participant, and/or other participants participating in the real-time communication session based on a spatial distribution of participants in the real-time communication session. For example, the spatial distribution of the participants relative to one another and/or the three-dimensional environment corresponds to positions of the participants (e.g., their corresponding visual representations) and/or distances between the participants of the real-time communication session within the three-dimensional environment. In some embodiments, in accordance with a determination that the spatial distribution of the one or more participants in the real-time communication session is a first spatial distribution, the computer system displays, from the current viewpoint of the user, the first visual representation of the first participant at a first updated location in the three-dimensional environment. In some embodiments, in accordance with a determination that the spatial distribution of the one or more participants in the real-time communication session is a second spatial distribution, different from the first spatial distribution, the computer system displays, from the current viewpoint of the user, the first visual representation of the first participant at a third updated location, different from the first updated location. In some embodiments, updating the spatial arrangement of the participants in the real-time communication session based on the spatial distribution of the participants in the real-time communication session has one or more characteristics of the same in method 1800. Resetting a spatial distribution of one or more users in a real-time communication session, including updating locations at which visual representations of one or more users are displayed in a three-dimensional environment, based on a spatial distribution of participants in the real-time communication session reduces the number of inputs needed to manually move the viewpoint(s) of the user(s) within the real-time communication session based on the spatial distribution and/or enables the spatial distribution to be reset automatically, thereby improving user-device interaction.

In some embodiments, the user and the first participant are participating in the shared activity associated with the respective object within the real-time communication session (e.g., when the first event is detected, as similarly discussed above with reference to step(s) 2002). In some embodiments, the first location of the first visual representation of the first participant in the three-dimensional environment in the first spatial arrangement of the elements of the real-time communication session is a first location relative to the respective object, such as the location of the first visual representation 1906 relative to the virtual object 1946 in FIG. 19A.

In some embodiments, displaying, from the current viewpoint of the user, the first updated spatial arrangement of the elements of the real-time communication session includes maintaining the first visual representation of the first participant at the first location relative to the respective object, such as maintaining the first visual representation 1906 at the same location relative to the virtual object 1946 as shown in the schematic view in FIG. 19C. For example, in response to detecting the first event, the computer system maintains display of the first visual representation of the first participant at the same location relative to the respective object as before the first event was detected. In some embodiments, if the real-time communication session includes a second participant (e.g., a third user of a third computer system), such that a second visual representation of the second participant is displayed at a second location in the three-dimensional environment relative to the respective object, when the computer system detects the first event, the computer system maintains display, from the current viewpoint of the user, of the second visual representation of the second participant at the second location relative to the respective object. It should be understood that, in response to detecting the first event, though the locations of the visual representations of the participants in the real-time communication session relative to the respective object are maintained, the location of the viewpoint of the user optionally changes relative to the respective object in the three-dimensional environment when the first updated spatial arrangement is displayed. Maintaining display, from a current viewpoint of the user, of visual representations of one or more users in a real-time communication session, at same locations relative to an object associated with a shared activity after resetting a spatial distribution of the one or more users in the real-time communication session reduces the number of inputs needed to manually move the viewpoint(s) of the user(s) within the real-time communication session relative to the object and/or enables a spatial context of the elements in the three-dimensional environment relative to the current viewpoint of the user to be maintained automatically, thereby improving user-device interaction.

In some embodiments, displaying the first spatial arrangement of the elements of the real-time communication session includes displaying a first object, different from the respective object, in the three-dimensional environment, wherein the first object is associated with a private activity of the user, such as virtual object 1960 in FIG. 19A. For example, the first object is associated with an application that is private to the user of the computer system (e.g., the first object is not configured to be viewable and/or interactive to other participants in the real-time communication session). In some embodiments, the first object has one or more characteristics of private objects as described in methods 800, 1000, 1200, 1400, and/or 1600.

In some embodiments, the user and the first participant are participating in the shared activity associated with the respective object (e.g., a virtual object that is displayed at a respective location in the three-dimensional environment) within the real-time communication session. In some embodiments, the first object is displayed a first distance from the respective object from the current viewpoint of the user, such as a distance between the virtual object 1960 and the virtual object 1946 in the schematic view of FIG. 19B. For example, the first object is displayed at a second location relative to the respective object in the three-dimensional environment when the first event is detected.

In some embodiments, in response to detecting the first event corresponding to a request to reset a spatial distribution of one or more participants in the real-time communication session, displaying the first updated spatial arrangement of the elements of the real-time communication session includes maintaining display of the first object the first distance from the respective object from the current viewpoint, such as maintaining display of the virtual object 1960 at the same distance relative to the virtual object 1946 as shown in the schematic view in FIG. 19C. For example, from the current viewpoint of the user, when the first updated spatial arrangement of the elements of the real-time communication session is displayed in the three-dimensional environment, the first object is moved/shifted with the respective object in response to detecting the first event, such that the first object remains displayed at the second location relative to the respective object in the three-dimensional environment. Accordingly, in some embodiments, when the spatial distribution is reset while the participants are participating in the shared activity, the relative spatial arrangement of the first object to the respective object is maintained. Maintaining display, from a current viewpoint of the user, of a private application in a real-time communication session at a same distance relative to an object associated with a shared activity after resetting a spatial distribution of the one or more users in the real-time communication session reduces the number of inputs needed to manually move the private object within the real-time communication session after the spatial distribution is reset and/or enables a spatial context of the elements in the three-dimensional environment relative to the current viewpoint of the user to be maintained automatically, thereby improving user-device interaction.

In some embodiments, the first object has a first orientation relative to the respective object from the current viewpoint of the user in the three-dimensional environment, such as the orientation of the virtual object 1960 relative to the virtual object 1946 shown in the schematic view in FIG. 19B. For example, a front-facing surface of the first object has a first angle offset relative to a portion of (a surface of, an edge of, and/or a center of) the respective object from the current viewpoint of the user. In some embodiments, from the current viewpoint, the first orientation causes the front-facing surface of the first object to be curved rightward, leftward or to be parallel to the portion of the respective object in the three-dimensional environment.

In some embodiments, in response to detecting the first event corresponding to a request to reset a spatial distribution of one or more participants in the real-time communication session, displaying the first updated spatial arrangement of elements of the real-time communication session includes maintaining a spatial arrangement of the first object with the first orientation relative to the respective object from the current viewpoint, such as maintaining display of the virtual object 1960 with the same orientation relative to the virtual object 1946 as shown in the schematic view in FIG. 19C. For example, from the current viewpoint of the user, when the first updated spatial arrangement of the elements of the real-time communication session is displayed in the three-dimensional environment, the front-facing surface of the first object is not rotated relative to the respective object in response to detecting the first event, such that the first object remains displayed with the first orientation relative to the respective object in the three-dimensional environment. It should be understood that when the computer system resets the spatial distribution in the real-time communication session, though the orientation of the first object optionally changes (e.g., the front-facing surface of the first object rotates) relative to the current viewpoint of the user, the orientation relative to the portion of the respective object remains unchanged as discussed above. Accordingly, in some embodiments, when the spatial distribution is reset while the participants are participating in the shared activity, the relative spatial arrangement of the first object to the respective object is maintained. Maintaining display, from a current viewpoint of the user, of a private application in a real-time communication session with a same orientation relative to an object associated with a shared activity after resetting a spatial distribution of the one or more users in the real-time communication session reduces the number of inputs needed to manually rotate the private object within the real-time communication session after the spatial distribution is reset and/or enables a spatial context of the elements in the three-dimensional environment relative to the current viewpoint of the user to be maintained automatically, thereby improving user-device interaction.

In some embodiments, the respective object has a first orientation relative to the current viewpoint of the user in the three-dimensional environment, such as the orientation of the virtual object 1928 relative to the virtual object 1946 in the schematic view in FIG. 19G. For example, a front-facing surface or edge of the respective object has a first angle offset relative to the current viewpoint of the user before the first event is detected. In some embodiments, the first orientation causes the front-facing surface of the first object to be curved rightward, leftward or to be parallel to the current viewpoint of the user in the three-dimensional environment.

In some embodiments, in response to detecting the first event corresponding to a request to reset a spatial distribution of one or more participants in the real-time communication session, displaying the first updated spatial arrangement of elements of the real-time communication session includes displaying the respective object with a second orientation relative to the current viewpoint, such as displaying the virtual object 1928 with an updated orientation relative to the virtual object 1946 as shown in the schematic view in FIG. 19H. For example, from the current viewpoint of the user, when the first updated spatial arrangement of the elements of the real-time communication session is displayed in the three-dimensional environment, the respective object is displayed with an orientation that causes the front-facing surface or edge of the respective object to be angled such that the current viewpoint of the user is facing toward the respective object. In some embodiments, the current viewpoint of the user is already angled to be facing toward the respective object in the three-dimensional environment when the first event is detected. In some such embodiments, the first orientation is the same as the second orientation from the current viewpoint of the user. In some embodiments, when the first event is detected, if the current viewpoint of the user is not angled to be facing toward the respective object in the three-dimensional environment, the computer system shifts and/or rotates the respective object in the three-dimensional environment to have the second orientation, such that the current viewpoint of the user in the first updated spatial arrangement is angled to face toward the respective object in the three-dimensional environment. Orienting a current viewpoint of the user in a real-time communication session to have an orientation that is angled toward an object that is associated with a shared activity in the real-time communication session after resetting a spatial distribution of one or more users in the real-time communication session reduces the number of inputs needed to manually rotate the object within the real-time communication session after the spatial distribution is reset and/or enables the current viewpoint of the user to be oriented toward the object in the three-dimensional environment automatically, thereby improving user-device interaction.

In some embodiments, displaying the first spatial arrangement of the elements of the real-time communication session includes displaying a first object, different from the respective object, in the three-dimensional environment, wherein the first object is associated with a private activity of the user (e.g., such as the first object previously discussed above), such as the virtual object 1928 in FIG. 19G. In some embodiments, the user and the first participant are participating in the shared activity associated with the respective object (e.g., a virtual object that is displayed at a respective location in the three-dimensional environment) within the real-time communication session (e.g., as similarly discussed above with reference to step(s) 2002). In some embodiments, the first object is displayed a first distance from the current viewpoint of the user in the three-dimensional environment, such as the distance between the virtual object 1928 and the current viewpoint of the user 1904 in the schematic view in FIG. 19G. For example, the first object is displayed at a second location that is the first distance relative to the current viewpoint in the three-dimensional environment when the first event is detected.

In some embodiments, in response to detecting the first event corresponding to a request to reset a spatial distribution of one or more participants in the real-time communication session, displaying the first updated spatial arrangement of elements of the real-time communication session includes maintaining a spatial arrangement of the first object the first distance from the current viewpoint in the three-dimensional environment, such as maintaining the virtual object 1928 at the same distance from the current viewpoint of the user 1904 as shown in the schematic view in FIG. 19H. For example, when the first updated spatial arrangement of the elements of the real-time communication session is displayed in the three-dimensional environment, the first object is moved/shifted in the three-dimensional environment in response to detecting the first event, such that the first object remains displayed at the second location relative to the current viewpoint in the three-dimensional environment. Accordingly, in some embodiments, when the spatial distribution is reset while the participants are participating in the shared activity, the relative spatial arrangement of the first object to the respective object is maintained. Maintaining display of a private application in a real-time communication session at a same distance relative to a current viewpoint of a user in the real-time communication session after resetting a spatial distribution of the one or more users in the real-time communication session reduces the number of inputs needed to manually move the private object within the real-time communication session after the spatial distribution is reset and/or enables a spatial context of the elements in the three-dimensional environment relative to the current viewpoint of the user to be maintained automatically, thereby improving user-device interaction.

In some embodiments, displaying the first spatial arrangement of the elements of the real-time communication session includes displaying a first object, different from the respective object, in the three-dimensional environment, wherein the first object is associated with a private activity of the user (e.g., such as the first object previously discussed above), such as the virtual object 1960 in FIG. 19A, and the current viewpoint of the user is positioned at a second location relative to the respective object of a plurality of predefined locations associated with the respective object in the three-dimensional environment in the first spatial arrangement of the elements of the real-time communication session, such as the location of the current viewpoint of the user 1904 relative to the virtual object 1946 as shown in the schematic view in FIG. 19A, wherein the second location corresponds to a first slot in a template associated with the shared activity (e.g., such as one of the templates discussed previously above). In some embodiments, the first location relative to the respective object in the three-dimensional environment corresponds to an assigned seat for the user of the computer system, as similarly discussed above with reference to the predefined seats associated with the respective object. In some embodiments, the first location relative to the respective object corresponds to a seat that is occupied by the user of the computer system, but that is not necessarily assigned to the user of the computer system.

In some embodiments, in response to detecting the first event corresponding to a request to reset a spatial distribution of one or more participants in the real-time communication session, the computer system displays the respective updated spatial arrangement of the participants in the real-time communication session, including, in accordance with a determination that the user and the first participant are participating in the shared activity associated with the respective object (e.g., a virtual object that is displayed at a respective location in the three-dimensional environment) within the real-time communication session and that, when the first event was detected, the first object was positioned at a third location (e.g., the location of the virtual object 1960 in the schematic view in FIG. 19A) relative to the respective object in response to detecting respective input that corresponds to a request to position the first object at the third location relative to the respective object while the current viewpoint was positioned at the second location, and the current viewpoint is positioned at a fourth location relative to the respective object when the first event is detected (e.g., the location of the current viewpoint of the user 1904 in the schematic view in FIG. 19B), different from the second location, displaying, from the current viewpoint of the user, the first updated spatial arrangement of elements of the real-time communication session, including maintaining a spatial arrangement the first object relative to the respective object from the current viewpoint while moving both the first object and the respective object relative to the current viewpoint of the user, such as moving the virtual object 1960 and the virtual object 1946 relative to the current viewpoint of the user 1904 as shown in the schematic view in FIG. 19C. For example, before the first event was detected, the computer system detects respective input that corresponds to a request to position the first object at the third location in the three-dimensional environment. In some embodiments, the respective input corresponds to initiating display of the first object in the three-dimensional environment. For example, the computer system detects, via the one or more input devices, a selection (e.g., an air pinch gesture, an air tap or touch gesture, and/or selection of a button on a hardware input device of the computer system) of a user interface element (e.g., a selectable option, an icon, and/or an image) that is associated with the first object. In some embodiments, in response to detecting the selection of the user interface element, the computer system displays the first object at the third location in the three-dimensional environment. In some embodiments, the respective input corresponds to movement of the first object to the third location after the first object is already displayed in the three-dimensional environment. For example, when the first object is first (e.g., initially) displayed in the three-dimensional environment, the first object is displayed at a second location, different from the third location, relative to the respective object. Accordingly, in some embodiments, the respective input includes a selection, such as one of the selection inputs discussed above, directed to the first object, followed by movement of a hand of the user of the computer system and/or movement of a hardware input device (e.g., controller) in communication with the computer system, that causes the computer system to move the first object to the third location in the three-dimensional environment. In some embodiments, the respective input discussed above is detected while the current viewpoint of the user is not positioned at their assigned seat associated with the respective object within the template, such as the assigned seat described above with reference to the predefined seats associated with the respective object. In some embodiments, while the first object is displayed at the third location relative to the respective object in the three-dimensional environment, in response to detecting the first event, the computer system maintains display of the first object at the third location relative to the respective object from the current viewpoint. For example, when the computer system moves the respective object in the three-dimensional environment from the current viewpoint of the user in the first updated spatial arrangement in response to detecting the first event, the first object is moved/shifted in the three-dimensional environment, such that the first object remains displayed at the third location relative to the respective object in the three-dimensional environment. Maintaining display, from a current viewpoint of the user, of a private application in a real-time communication session at a same location relative to an object associated with a shared activity after resetting a spatial distribution of the one or more users in the real-time communication session reduces the number of inputs needed to manually move the private object within the real-time communication session after the spatial distribution is reset and/or enables a spatial context of the elements in the three-dimensional environment relative to the current viewpoint of the user to be maintained automatically, thereby improving user-device interaction.

In some embodiments, displaying the first spatial arrangement of the elements of the real-time communication session includes displaying a first object, different from the respective object, in the three-dimensional environment, wherein the first object is associated with a private activity of the user (e.g., such as the first object discussed previously above), such as the virtual object 1928 in FIG. 19G, and before detecting the first event, the current viewpoint of the user is positioned at a fourth location (e.g., the location of the current viewpoint of the user 1904 as shown in the schematic view in FIGS. 19F and 19F1) relative to the respective object in the three-dimensional environment in the first spatial arrangement of the elements of the real-time communication session, wherein the fourth location is different from a second location (e.g., seat labeled “A” in the schematic view in FIGS. 19F and 19F1) of a plurality of predefined locations associated with the respective object, and the second location corresponds to a first slot in a template associated with the shared activity (e.g., such as one of the templates discussed previously above). In some embodiments, the second location relative to the respective object in the three-dimensional environment does not correspond to an assigned seat for the user of the computer system or a seat that was previously occupied by the user within the template. For example, as discussed previously above with reference to the predefined seats associated with the respective object, the user of the computer system is assigned a seat at which the viewpoint of the user is positioned relative to the respective object in the three-dimensional environment. In some embodiments, the user has moved in the physical environment surrounding the display generation component, such that the current viewpoint of the user in the first spatial arrangement is no longer positioned at the assigned seat (or their previously occupied seat) for the user relative to the respective object in the three-dimensional environment. For example, the user is positioned at a different seat of the predefined seats associated with the respective object or is positioned at a location in space that does not correspond to any seat of the predefined seats.

In some embodiments, in response to detecting the first event corresponding to a request to reset a spatial distribution of one or more participants in the real-time communication session, the computer system displays the respective updated spatial arrangement of the participants in the real-time communication session, including, in accordance with a determination that the user and the first participant are participating in the shared activity associated with the respective object (e.g., a virtual object that is displayed at a respective location in the three-dimensional environment) within the real-time communication session and that, when the first event was detected, the first object was positioned at a third location (e.g., the location of the virtual object 1928 in the schematic view in FIG. 19G) relative to the current viewpoint in response to detecting respective input that corresponds to a request to position the first object at the third location relative to the current viewpoint while the current viewpoint was positioned at the fourth location (e.g., the current location of the viewpoint of the user 1904 in the schematic view in FIG. 19G), and the current viewpoint is positioned at the fourth location relative to the respective object when the first event is detected, displaying, from the current viewpoint of the user, the first updated spatial arrangement of elements of the real-time communication session, including maintaining a spatial arrangement of the first object relative to the current viewpoint (e.g., keeping the first object at the third location relative to the current viewpoint while changing a spatial arrangement of the first object relative to the respective object) while changing a spatial arrangement of the first object relative to the respective object from the current viewpoint, such as moving the virtual object 1928 relative to the virtual object 1946 as shown in the schematic view in FIG. 19H. In some embodiments, the respective input for positioning the first object at the third location relative to the respective object is the same as or similar to the respective input discussed above for positioning the first object at the third location relative to the respective object in the three-dimensional environment. In some embodiments, the computer system detects the respective input while the viewpoint of the user is positioned at a location in the three-dimensional environment that does not correspond to their assigned seat or their previously occupied seat relative to the respective object in the template. In some embodiments, while the first object is displayed at the third location relative to the current viewpoint of the user in the three-dimensional environment, in response to detecting the first event, the computer system moves/shifts the respective object relative to the first object from the current viewpoint when changing the spatial arrangement of the first object relative to the respective object from the current viewpoint. For example, the first object remains displayed at the same location in the three-dimensional environment relative to the current viewpoint when the spatial distribution is reset but is moved relative to the respective object in the three-dimensional environment, such that the first object remains displayed at the third location in the three-dimensional environment relative to the respective object. Maintaining display, from a current viewpoint of the user, of a private application in a real-time communication session at a same location relative to the current viewpoint of the user after resetting a spatial distribution of one or more users in the real-time communication session reduces the number of inputs needed to manually move the private object within the real-time communication session after the spatial distribution is reset and/or enables a spatial context of the elements in the three-dimensional environment relative to the current viewpoint of the user to be maintained automatically, thereby improving user-device interaction.

In some embodiments, displaying the first spatial arrangement of the elements of the real-time communication session includes displaying a first object, different from the respective object, in the three-dimensional environment, wherein the first object is associated with a private activity of the user (e.g., such as the first object discussed previously above), such as the virtual object 1928 in FIG. 19G, and before detecting the first event, the current viewpoint of the user is positioned at a fourth location (e.g., the location of the current viewpoint of the user 1904 in the schematic view in FIG. 19G) relative to the respective object in the three-dimensional environment in the first spatial arrangement of the elements of the real-time communication session, wherein the fourth location is different from a second location (e.g., the seat labeled A in the schematic view in FIG. 19G) of a plurality of predefined locations associated with the respective object, and the second location corresponds to a first slot in a template associated with the shared activity (e.g., such as one of the templates discussed previously above). In some embodiments, the second location relative to the respective object in the three-dimensional environment does not correspond to an assigned seat for the user of the computer system or a seat that was previously occupied by the user in the spatial template, as similarly discussed with reference to the second location above.

In some embodiments, in response to detecting the first event corresponding to a request to reset a spatial distribution of one or more participants in the real-time communication session, the computer system displays the respective updated spatial arrangement of the participants in the real-time communication session, including, in accordance with a determination that the user and the first participant are participating in the shared activity associated with the respective object (e.g., a virtual object that is displayed at a respective location in the three-dimensional environment) within the real-time communication session and that, when the first event was detected, the first object was positioned at a third location (e.g., the location of the virtual object 1928 in the schematic view in FIG. 19G) relative to the respective object in response to detecting respective input that corresponds to a request to position the first object at the third location relative to the respective object while the current viewpoint was positioned at the fourth location (e.g., the location 1952 in the schematic view in FIG. 19I), and the current viewpoint is positioned at a fifth location (e.g., the location of the current viewpoint of the user 1904 in the schematic view in FIG. 19I), different from the fourth location, relative to the respective object when the first event is detected, displaying, from the current viewpoint of the user, the first updated spatial arrangement of elements of the real-time communication session, including maintaining a spatial arrangement of the first object relative to the respective object from the current viewpoint while moving both the first object and the respective object relative to the current viewpoint of the user, such as moving the virtual object 1946 and the virtual object 1928 relative to the current viewpoint of the user 1904 as shown in the schematic view in FIG. 19J. In some embodiments, the respective input for positioning the first object at the third location relative to the respective object is the same as or similar to the respective input discussed above for positioning the first object at the third location relative to the respective object in the three-dimensional environment. In some embodiments, the computer system detects the respective input while the viewpoint of the user is positioned at a location (e.g., the fourth location) in the three-dimensional environment that does not correspond to their assigned seat or their previously occupied seat relative to the respective object within the template. Additionally, in some embodiments, the computer system detects the first event while the viewpoint of the user is no longer positioned at the fourth location in the three-dimensional environment. For example, when the first event is detected, the user of the computer system has moved in the physical environment surrounding the display generation component, such that the current viewpoint of the user is moved from the fourth location to the fifth location relative to the respective object in the three-dimensional environment. In some embodiments, while the first object is displayed at the third location relative to the respective object in the three-dimensional environment, in response to detecting the first event, the computer system moves/shifts the first object and the respective object relative to the current viewpoint of the user. For example, the first object remains displayed at the same location relative to the respective object in the three-dimensional environment when the spatial distribution is reset but is moved with the respective object relative to the current viewpoint of the user in the three-dimensional environment, such that the respective object and the first object are both positioned in front of the user (e.g., in the user's field of view of the three-dimensional environment). Maintaining display, from a current viewpoint of the user, of a private application in a real-time communication session at a same location relative to an object that is associated with a shared activity in the real-time communication session after resetting a spatial distribution of one or more users in the real-time communication session reduces the number of inputs needed to manually move the private object within the real-time communication session after the spatial distribution is reset and/or enables a spatial context of the elements in the three-dimensional environment relative to the current viewpoint of the user to be maintained automatically, thereby improving user-device interaction.

It should be understood that the particular order in which the operations in method 2000 have been described is merely exemplary and is not intended to indicate that the described order is the only order in which the operations could be performed. One of ordinary skill in the art would recognize various ways to reorder the operations described herein.

In some embodiments, aspects/operations of methods 800, 1000, 1200, 1400, 1600, 1800, and/or 2000 may be interchanged, substituted, and/or added between these methods. For example, the three-dimensional environments of methods 800, 1000, 1200, 1400, 1600, 1800, and/or 2000, the virtual content of methods 800, 1000, 1200, 1400, 1600, 1800, and/or 2000, the spatial templates of methods 800, 1000, 1200, 1400, 1600, 1800, and/or 2000, the real-time communication sessions of methods 800, 1000, 1200, 1400, 1600, 1800, and/or 2000, and/or updating spatial arrangements of participants in methods 800, 1000, 1200, 1400, 1600, 1800, and/or 2000 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1. A method comprising:
at a first computer system in communication with one or more inputs devices and a display generation component:
while a three-dimensional environment of a user of the first computer system is visible via the display generation component, and while the user is in a real-time communication session with a second user, different from the user:
displaying, via the display generation component, a visual representation of a participant within the three-dimensional environment, wherein a respective portion of the visual representation has a first visual appearance including a first degree of visual prominence;
while displaying the visual representation of the participant with the respective portion of the visual representation having the first visual appearance, obtaining information about a first event corresponding to a request to move the respective portion of the visual representation of the participant to a respective position within the three-dimensional environment;
in response to obtaining information about the first event corresponding to the request to move the respective portion of the visual representation of the participant to the respective position within the three-dimensional environment:
in accordance with a determination that the first event satisfies one or more first criteria, including a criterion that is satisfied when the respective position within the three-dimensional environment is within a first threshold distance of a viewpoint of the user in the three-dimensional environment, changing a visual appearance of the respective portion of the visual representation of the participant to have a second visual appearance, different from the first visual appearance, wherein the second visual appearance includes a second degree of visual prominence less than the first degree of visual prominence; and
in accordance with a determination that the first event does not satisfy the one or more first criteria, forgoing the changing of the visual appearance of the respective portion of the visual representation of the participant to have the second visual appearance.

2. The method of claim 1, further comprising:
in response to obtain the information about the first event, and in accordance with the determination that the first event does not satisfy the one or more first criteria, maintaining the visual appearance of the respective portion of the visual representation of the participant as having the first visual appearance.

3. The method of claim 1, further comprising:
in response to obtaining the information about the first event corresponding to the request to move the respective portion of the visual representation of the participant to the respective position within the three-dimensional environment and in accordance with a determination the respective position satisfies the one or more first criteria:
in accordance with a determination that the respective portion of the visual representation of the participant is a first portion of the visual representation of the participant, maintaining a visual appearance of a second portion of the visual representation of the participant, different from the first portion of the visual representation, as having the first visual appearance, wherein the second portion of the visual representation is further than the first threshold distance of the viewpoint of the user in the three-dimensional environment; and
in accordance with a determination that the respective portion of the visual representation of the participant is the second portion of the visual representation of the participant, maintaining the visual appearance of the first portion of the visual representation of the participant as having the first visual appearance, wherein the first portion of the visual representation is further than the first threshold distance of the viewpoint of the user in the three-dimensional environment.

4. The method of claim 1, further comprising:
in response to obtaining the information about the first event corresponding to the request to move the respective portion of the visual representation of the participant to the respective position within the three-dimensional environment and in accordance with the determination that the one or more first criteria are satisfied:
in accordance with a determination that the respective portion of the visual representation of the participant is a first portion of the visual representation of the participant, changing a visual appearance of a second portion of the visual representation of the participant, different from the first portion of the visual representation of the participant, to have the second visual appearance, wherein the first portion of the visual representation is further than the first threshold distance from the viewpoint of the user in the three-dimensional environment; and
in accordance with a determination that the respective portion of the visual representation of the participant is the second portion of the visual representation of the participant, maintaining the visual appearance of the first portion of the visual representation of the participant as having the first visual appearance, wherein the first portion of the visual representation is further than the first threshold distance from the viewpoint of the user in the three-dimensional environment.

5. The method of claim 4, wherein:
before obtaining the information about the first event, the visual representation of the user is a first visual representation, and
changing the visual appearance of the first portion and the second portion of the visual representation of the participant to have the second visual appearance includes replacing the first visual representation with a second visual representation, different from the first visual representation.

6. The method of claim 5, wherein the first visual representation has a first degree of spatial fidelity, and the second visual representation has a second degree of spatial fidelity, relatively less than the first degree of spatial fidelity.

7. The method of claim 5, wherein the first visual representation includes a plurality of different representations of different body parts corresponding to a plurality of body parts of the participant, and the second visual representation does not include representations of different body parts.

8. The method of claim 5, further comprising:
while the visual representation is the first visual representation, and in response to obtaining the information about the first event, changing a spatial relationship between the first portion of the first visual representation of the participant and the second portion of the first visual representation of the participant in accordance with the information about the first event; and
while the visual representation of the participant is the second visual representation, wherein the first portion and the second portion of the second visual representation of the participant have a first spatial relationship, obtaining information about a second event, different from the first event, corresponding to a second request, different from the first request, to move the second visual representation of the participant to an updated position within the three-dimensional environment; and in response to the obtaining of the information about the second event, moving the second visual representation of the participant in accordance with the information about the second event while maintaining the first spatial relationship between the first portion and the second portion of the second visual representation of the participant.

9. The method of claim 5, further comprising:
while the visual representation is the second visual representation and while the viewpoint of the user is a first viewpoint, detecting, via the one or more input devices, a second event, different from the first event, including a change of the viewpoint of the user within the three-dimensional environment from the first viewpoint to a second viewpoint, different from the first viewpoint; and
in response to detecting the second event:
in accordance with a determination that the second event does not satisfy the one or more first criteria based on the second viewpoint being further than the first threshold distance from the respective portion of the visual representation of the participant, changing the visual representation of the participant to be the first visual representation; and
in accordance with a determination that the second event satisfies the one or more criteria, maintaining the visual representation of the participant as the second visual representation.

10. The method of claim 5, further comprising:
while the visual representation is the second visual representation and the viewpoint of the user is a first viewpoint, obtaining information about a second event, different from the first event, corresponding to a second request, different from the request, to move the respective portion of the visual representation of the participant to an updated position within the three-dimensional environment; and
in response to obtaining the information about the second event:
in accordance with a determination that the second event does not satisfy the one or more criteria, based on the updated position being further than the first threshold distance from the first viewpoint of the user, changing the visual representation of the participant to be the first visual representation; and
in accordance with a determination that the second event satisfies the one or more criteria, maintaining the visual representation of the participant as the second visual representation.

11. The method of claim 5, further comprising:
while displaying the visual representation of the participant that is the second visual representation with a respective degree of visual prominence, detecting, via the one or more input devices, a second event, different from the first event, including a change of the viewpoint of the user relative to the three-dimensional environment from a first viewpoint to a second viewpoint, different from the first viewpoint; and
in response to detecting the second event:
in accordance with a determination that the second event satisfies one or more second criteria, including a criterion that is satisfied when the respective portion of the visual representation of the participant is within a second threshold distance, different from the first threshold distance, of the second viewpoint of the user, reducing the respective degree of visual prominence of the respective portion of the visual representation of the participant; and
in accordance with a determination that the second event does not satisfy the one or more second criteria, forgoing reducing the visual prominence of the respective portion of the visual representation of the participant.

12. The method of claim 1, wherein the first threshold distance is less than a length corresponding to a length a physical arm of a human.

13. The method of claim 1, wherein:
in accordance with a determination that an orientation between an orientation of the viewpoint of the user and the respective position within the three-dimensional environment is within a first range of orientations, the first threshold distance is a first distance, and
in accordance with a determination that the orientation between the viewpoint of the user and the respective position is within a second range of orientations, different from the first range of orientations, the first threshold distance is a second distance, different from the first distance.

14. The method of claim 1, further comprising:
while displaying a first portion of the visual representation of the participant with a respective degree of visual prominence, wherein the first portion of the visual representation of the participant corresponds to a representation of a physical hand of the participant, obtaining information about a second event corresponding to relative movement between a representation of a physical hand of the user and the respective portion of the representation of the participant; and
in response to obtaining the information about the second event, in accordance with a determination that in response to the relative movement between the representation of the physical hand of the user and the first portion of the representation of the participant, the representation of the physical hand of the user has a spatial conflict with the respective portion of the representation of the participant, maintaining display of the first portion of the visual representation of the participant with the respective degree of visual prominence.

15. The method of claim 1, further comprising:
while displaying the visual representation of the participant including displaying the respective portion of the visual representation of the participant with the first visual appearance, detecting, via the one or more input devices, a second event, different from the first event, including a change of the viewpoint of the user relative to the three-dimensional environment from a first viewpoint to a second viewpoint, different from the first viewpoint; and
in response to detecting the second event:
in accordance with a determination that the second event satisfies the one or more first criteria, because the second viewpoint is within the first threshold distance from the respective portion of the visual representation of the participant, changing the visual appearance of the respective portion of the visual representation of the participant to have the second visual appearance; and
in accordance with a determination that the second event does not satisfy the one or more first criteria, because the second viewpoint is outside of the first threshold distance from the respective portion of the visual representation of the participant, forgoing the changing of the visual appearance of the respective portion of the visual representation of the participant to have the second visual appearance.

16. The method of claim 15, wherein:
before obtaining the information about the second event, the visual representation of the user is a first visual representation, and
changing the visual appearance of the respective portion of the visual representation of the participant to have the second visual appearance includes replacing the first visual representation with a second visual representation, different from the first visual representation.

17. The method of claim 15, in response to obtaining the information about the second event:
in accordance with a determination that the one or more first criteria are satisfied and the respective portion of the visual representation of the participant is a first portion of the visual representation of the participant, changing a visual appearance of a second portion of the visual representation of the participant, different from the first portion of the visual representation of the participant, to have the second visual appearance, wherein the first portion of the visual representation is further than the first threshold distance of the viewpoint of the user in the three-dimensional environment; and
in accordance with a determination that the one or more first criteria are satisfied and the respective portion of the visual representation of the participant is the second portion of the visual representation of the participant, maintaining the visual appearance of the first portion of the visual representation of the participant as having the first visual appearance, wherein the first portion of the visual representation is further than the first threshold distance of the viewpoint of the user in the three-dimensional environment.

18. The method of claim 1, further comprising:
while displaying the visual representation of the participant in the three-dimensional environment, presenting spatialized audio corresponding to respective audio obtained from the participant as if emanating from a respective position within the three-dimensional environment, wherein the respective position corresponds to a position of the visual representation of the participant.

19. The method of claim 18, further comprising:
while displaying the visual representation of the participant in the three-dimensional environment at a first position within the three-dimensional environment and from the respective position of the spatialized audio is a second position corresponding to the first position within the three-dimensional environment, obtaining information about a second event, different from the first event, including a change in proximity between the viewpoint of the user and the visual representation of the participant; and
in response to obtaining the information about the second event:
in accordance with a determination that the change in proximity satisfies one or more second criteria, including a criterion that is satisfied when the viewpoint of the user is within a second threshold distance of a position corresponding to the visual representation of the participant in the three-dimensional environment, forgoing presenting the spatialized audio corresponding to the participant as if emanating from a third position in the three-dimensional environment corresponding to the position corresponding to the visual representation of the participant; and
in accordance with a determination that the viewpoint of the user is outside of the second threshold distance of the position corresponding to the visual representation of the participant in the three-dimensional environment, presenting the spatialized audio corresponding to the participant as if emanating from the third position in the three-dimensional environment corresponding to the position corresponding to the visual representation of the participant.

20. The method of claim 19, wherein the second event includes movement of the viewpoint of the user, and forgoing presenting the spatialized audio corresponding to the participant as if emanating from the third position in the three-dimensional environment includes changing a position of the spatialized audio to an updated position outside of the second threshold distance of the viewpoint of the user.

21. The method of claim 20, wherein the updated position of the spatialized audio is further away from a floor of the three-dimensional environment of the user than a position of the spatialized audio before obtaining the information about the second event.

22. The method of claim 20, wherein the forgoing of presenting the spatialized audio corresponding to the participant as if emanating from the third position in the three-dimensional environment includes changing a position of the spatialized audio to an updated position outside of the second threshold distance of the viewpoint of the user, the method further comprising:
while proximity between the viewpoint of the user and the visual representation of the participant satisfy the one or more second criteria and while forgoing the presenting of the spatialized audio corresponding to the participant as if emanating from the third position in the three-dimensional environment, obtaining information about a third event, different from the first event and the second event, including a reduction in proximity between the viewpoint of the user and the visual representation of the participant; and
in response to obtaining the information about the third event:
in accordance with a determination that the third event satisfies the one or more second criteria, changing the position of the spatialized audio to a second updated position outside of the second threshold distance of the viewpoint of the user in accordance with the reduction in proximity; and
in accordance with a determination that the third event does not satisfy the one or more criteria, forgoing the changing of the position of the spatialized audio to the second updated position outside of the second threshold distance of the viewpoint of the user.

23. The method of claim 19, wherein forgoing presenting the spatialized audio corresponding to the participant as if emanating from the third position in the three-dimensional environment includes presenting the spatialized audio with reduced fidelity.

24. The method of claim 19, wherein in a view of the real-time communication session from a perspective of a second participant, that includes a second three-dimensional environment:
in response to the second event and in accordance with the determination that the change in proximity satisfies the one or more second criteria, the spatialized audio corresponding to the participant is presented as if emanating from a position in the second three-dimensional environment corresponding to a position corresponding to the visual representation of the participant in the second three-dimensional environment, wherein the position corresponding to the spatialized audio in the second three-dimensional environment and the position corresponding to the visual representation of the participant in the second three-dimensional environment are within the second threshold distance of each other.

25. The method of claim 1, wherein:
the first threshold distance is one of a plurality of threshold distances associated with changing the visual appearance of the respective portion of the visual representation of the participant, and
the plurality of threshold distances includes a second threshold distance and a third threshold distance.

26. The method of claim 25, wherein the first threshold distance corresponds to a furthest threshold distance of the plurality of threshold distances relative to the viewpoint of the user, and the second degree of visual prominence includes less opacity of the respective portion of the visual representation of the participant than the first degree of visual prominence.

27. The method of claim 25, wherein:
the visual representation of the participant is a first visual representation before obtaining the information about the first event, the method further comprising:
in response to obtaining information about the first event corresponding to the request to move the respective portion of the visual representation of the participant to the respective position within the three-dimensional environment:
in accordance with a determination that the first event satisfies one or more second criteria, including a criterion that is satisfied when the respective position within the three-dimensional environment is within a second threshold distance of a viewpoint of the user in the three-dimensional environment, wherein the second threshold distance is a threshold distance of the plurality of threshold distances that is smaller than the first threshold distance, replacing the first visual representation of the participant with a second visual representation of the participant, different from the first visual representation.

28. The method of claim 25, the method further comprising:
in response to obtaining information about the first event corresponding to the request to move the respective portion of the visual representation of the participant to the respective position within the three-dimensional environment:
in accordance with a determination that the first event satisfies one or more second criteria, including a criterion that is satisfied when the respective position within the three-dimensional environment is within a second threshold distance of a viewpoint of the user in the three-dimensional environment, wherein the second threshold distance is a threshold distance of the plurality of threshold distances that is smaller than the first threshold distance, ceasing display of the visual representation of the participant.

29. The method of claim 1, further comprising: while displaying, via the display generation component, a visual representation of a second participant, different from the participant, within the three-dimensional environment concurrently with the visual representation of the participant, obtaining information about a second event, different from the first event, corresponding to a request to move the visual representation of the participant relative to the visual representation of the second participant in the three-dimensional environment; and
in response to obtaining the information about the second event:
in accordance with a determination that the second event satisfies one or more second criteria, including a criterion that is satisfied when the visual representation of the participant and the visual representation of the second participant are within a second threshold distance of one another:
changing a visual appearance of a first portion of the visual representation of the participant and changing a visual appearance of a first portion of the visual representation of the second participant; and
in accordance with a determination that the second event does not satisfy the one or more second criteria, forgoing the changing of the visual appearance of the first portion of the visual representation of the participant and the visual appearance of the first portion of the visual representation of the second participant.

30. The method of claim 29, wherein:
changing the visual appearance of the first portion of the visual representation of the second participant includes ceasing display of the first portion of the visual representation of the participant, and
changing the visual appearance of the first portion of the visual representation of the second participant includes ceasing display of the first portion of the visual representation of the second participant.

31. The method of claim 29, wherein:
changing the visual appearance of the first portion of the visual representation of the second participant includes reducing a degree of visual prominence of the first portion of the visual representation of the participant, and
changing the visual appearance of the first portion of the visual representation of the second participant includes reducing a degree of visual prominence of the first portion of the visual representation of the second participant.

32. The method of claim 29, wherein:
changing the visual appearance of the first portion of the visual representation of the second participant includes replacing the visual representation of the participant with a replacement visual representation of the participant, and
changing the visual appearance of the first portion of the visual representation of the second participant includes replacing the visual representation of the second participant with a replacement visual representation of the second participant.

33. The method of claim 1, wherein the one or more first criteria include a criterion that is satisfied when a user setting included in a user account associated with the first computer system is enabled.

34. The method of claim 1, wherein the first threshold distance is adjustable in response to user input.

35. The method of claim 1, the method further comprising:
obtaining information about a second event, different from the first event, including movement of a hand of the user of the first computer system, or corresponding to a request to move the respective portion of the visual representation of the participant such that a position corresponding to the hand of the user and a position of the respective portion of the visual representation of the participant correspond to a same position within the three-dimensional environment; and
in response to obtaining the information about the second event, displaying, via the display generation component, an animation in the three-dimensional environment visually indicating a simulated contact between the hand of the user and the respective portion of the visual representation of the participant, wherein animation is different from an animation of movement of the respective portion of the visual representation of the participant.

36. A first computer system in communication with a display generation component and one or more input devices, the first computer system comprising:
one or more processors;
memory; and
one or more programs, wherein the one or more programs are stored in the memory and configured to be executed by the one or more processors, the one or more programs including instructions for:
while a three-dimensional environment of a user of the first computer system is visible via the display generation component, and while the user is in a real-time communication session with a second user, different from the user:
displaying, via the display generation component, a visual representation of a participant within the three-dimensional environment, wherein a respective portion of the visual representation has a first visual appearance including a first degree of visual prominence;
while displaying the visual representation of the participant with the respective portion of the visual representation having the first visual appearance, obtaining information about a first event corresponding to a request to move the respective portion of the visual representation of the participant to a respective position within the three-dimensional environment;
in response to obtaining information about the first event corresponding to the request to move the respective portion of the visual representation of the participant to the respective position within the three-dimensional environment:
in accordance with a determination that the first event satisfies one or more first criteria, including a criterion that is satisfied when the respective position within the three-dimensional environment is within a first threshold distance of a viewpoint of the user in the three-dimensional environment, changing a visual appearance of the respective portion of the visual representation of the participant to have a second visual appearance, different from the first visual appearance, wherein the second visual appearance includes a second degree of visual prominence less than the first degree of visual prominence; and
in accordance with a determination that the first event does not satisfy the one or more first criteria, forgoing the changing of the visual appearance of the respective portion of the visual representation of the participant to have the second visual appearance.

37. A non-transitory computer readable storage medium storing one or more programs, the one or more programs comprising instructions, which when executed by one or more processors of a first computer system in communication with a display generation component and one or more input devices, cause the first computer system to perform a method comprising:
while a three-dimensional environment of a user of the first computer system is visible via the display generation component, and while the user is in a real-time communication session with a second user, different from the user:
displaying, via the display generation component, a visual representation of a participant within the three-dimensional environment, wherein a respective portion of the visual representation has a first visual appearance including a first degree of visual prominence;
while displaying the visual representation of the participant with the respective portion of the visual representation having the first visual appearance, obtaining information about a first event corresponding to a request to move the respective portion of the visual representation of the participant to a respective position within the three-dimensional environment;
in response to obtaining information about the first event corresponding to the request to move the respective portion of the visual representation of the participant to the respective position within the three-dimensional environment:
in accordance with a determination that the first event satisfies one or more first criteria, including a criterion that is satisfied when the respective position within the three-dimensional environment is within a first threshold distance of a viewpoint of the user in the three-dimensional environment, changing a visual appearance of the respective portion of the visual representation of the participant to have a second visual appearance, different from the first visual appearance, wherein the second visual appearance includes a second degree of visual prominence less than the first degree of visual prominence; and
in accordance with a determination that the first event does not satisfy the one or more first criteria, forgoing the changing of the visual appearance of the respective portion of the visual representation of the participant to have the second visual appearance.

38-211. (canceled)
